(19) United States
(12) Patent Application Publication
(10) Pub. No.: US 2003/0232288 A1
(43) Pub. Date: Dec. 18, 2003

(54) Photothermographic material and method of thermal development of the same

(76) Inventors: Yutaka Oka, Kanagawa (JP); Tomoyuki Ohzeki, Kanagawa (JP); Katsutoshi Yamane, Kanagawa (JP); Seiichi Yamamoto, Kanagawa (JP); Sumito Yamada, Kanagawa (JP); Hiroyuki Mifune, Kanagawa (JP); Tadashi Inaba, Kanagawa (JP); Kohzaburoh Yamada, Kanagawa (JP); Katsuyuki Watanabe, Kanagawa (JP)

Correspondence Address: Michael P. Eddy, c/o Yumi Yerks, Apartment #412-North, 2111 Jefferson Davis Highway, Arlington, VA, 22202, US

(21) Appl. No.: 10/285,644

(22) Filed: Nov. 1, 2002

(30) Foreign Application Priority Data
Nov. 5, 2001 (JP) 2001-339636
Nov. 8, 2001 (JP) 2001-342983
Nov. 9, 2001 (JP) 2001-344727
Nov. 29, 2001 (JP) 2001-364512
Mar. 29, 2002 (JP) 2002-96660
Mar. 29, 2002 (JP) 2002-97920

(51) Int. Cl. G03C 1/005; G03C 1/09; G03C 1/34; G03C 1/498; G03C 1/76

(52) U.S. Cl. 430/350; 430/568; 430/614; 430/605; 430/603; 430/567; 430/523

(57) ABSTRACT

Disclosed are photothermographic materials having, on a support, a layer that contains at least a photosensitive silver halide, a non-photosensitive organic silver salt, a reducing agent and a binder, in which the mean silver iodide content of the photosensitive silver halide falls between 5 and 100 mol %, preferably between 40 and 100 mol %.

### BACKGROUND OF THE INVENTION

1. Field of the Invention

The present invention relates to a photothermographic material and a method of thermal development of it. Precisely, the invention relates to a photothermographic material of which the advantages are that the printout images formed thereon are fogged little and the raw film storage stability thereof is good, and to a photothermographic material which comprises a silver halide emulsion having a silver iodide content and of which the advantages are that its sensitivity is extremely high and its image storability after developed is good, especially that its high sensitivity is supported by its low Dmin and high Dmax. The invention also relates to a method of thermal development of such a photothermographic material.

2. Description of the Related Art

In the field of photographic films for medical treatment, these days much desired is reducing the wastes of processing solutions for environmental protection and space saving. In that situation, required are techniques with photothermographic materials for medical diagnosis and photomechanical process capable of being efficiently exposed with laser image setters or laser imagers to form sharp and clear monochromatic images of high resolution. Such photothermographic materials could provide users with more simple photothermographic systems not requiring solution-type processing chemicals and therefore not polluting the environment.

The same applies to the field of ordinary photo-imaging materials, which, however, shall differ from those in the field of medical treatment. Specifically, photo-images for medical treatment must clarify the details of body parts and therefore must have sharp and good image quality with fine graininess. In addition, for easy diagnosis thereon, preferred are cold black images in the field of medical treatment. At present, various types of hard copy systems with pigment and dye, for example, ink jet printers and electrophotographic systems are available for ordinary image-forming systems. However, no one knows satisfactory systems for forming photo-images enough for medical treatment.

On the other hand, photothermographic systems with organic silver salts used therein are described, for example, in U.S. Pat. Nos. 3,152,904 and 3,457,075, and in B. Shely's “Thermally Processed Silver Systems” (Imaging Processes and Materials, Neblette, 8th Ed., compiled by Sturge, V. Walworth & A. Shepp, page 2, 1996).

In general, photothermographic materials have a photosensitive layer with a catalytically active amount of a photocatalyst (e.g., silver halide), a reducing agent, a reducible silver salt (e.g., organic silver salt), and optionally a toning agent for controlling silver tones being dispersed in a binder matrix in the layer. Photothermographic materials of that type are, after having been imagewise exposed, heated at a high temperature (for example, at 80° C. or higher) to form black silver images through redox reaction between the silver halide or the reducible silver salt (serving as an oxidizing agent) and the reducing agent therein. In these, the redox reaction is accelerated by the catalytic action of the latent image of the exposed silver halide. Therefore, the black silver images are formed in the exposed area of the materials. This technique is disclosed in many references such as typically U.S. Pat. No. 2,910,377 and JP-B 43-4924, and an image-forming system with a photothermographic material for medical treatment, Fuji Medical Dry Imager FM-DPL has went on the market.

For producing thermal image-forming systems with organic silver salts therein, known are a method of using a solvent in forming the photosensitive layer therein, and a method of coating the substrate with a coating liquid that contains an aqueous dispersion of polymer particles serving as an essential binder, followed by drying it. The latter method does not require solvent recovery and therefore the equipment for it is simple. For these reasons, the latter method is favorable to industrial scale mass-production of the image-forming systems.

Not requiring image fixation after development, one serious problem with such image-forming systems with organic silver salts therein is that their image storability after development is not good, especially their printout images are often faded or fogged when left exposed to light. To solve the problem of printout image fogging, a method of using AgI formed through conversion of organic silver salts is disclosed in U.S. Pat. No. 6,143,488 and EP 0922995. However, the method disclosed of converting organic silver salts with iodine could not still satisfactorily improve the sensitivity of the photothermographic material to be in the image-forming systems, and it is not effective for planning practicable systems.

Other photothermographic materials that comprise AgI are described, for example, in WO97-48014, WO 48015, U.S. Pat. No. 6,165,705, JP-A 8-297345 and Japanese Patent 2,785,129, but their sensitivity and fogging resistance are not still on a satisfactory level and all these are not practicable for laser exposure. Given that situation, desired is developing a method of more effectively using silver halides having such a high silver iodide content in practicable photothermographic materials.

Some means of increasing the sensitivity of silver iodide photographic emulsions are described in the Journal of Photographic Science, Vol. 8, page 119, 1960, ibid., Vol. 28, page 163, 1980; and in Photographic Science and Engineering, Vol. 5, page 216, 1961. For example, known is a method of sensitizing the photographic emulsions by dipping them in a halogen receptor such as sodium sulfite, pyrogallol or hydroquinone or in an aqueous solution of silver nitrate, or a method of sensitizing them with sulfur at pAg of 7.5. However, as in Examples shown hereinunder, the sensitizing effect of the halogen receptor is extremely low and is therefore unsatisfactory for photothermographic materials to which the invention is directed. Accordingly, it is desired to develop a technique effective for significantly increasing the sensitivity of photothermographic materials having a high silver iodide content.

JP-A 8-272024 discloses a technique of increasing the sensitivity of silver iodobromide emulsions having a low silver iodide content for color negative emulsions to be processed through liquid development or for emulsions for X-ray exposure, in which is specifically used a compound having a silver halide-adsorbing group and a reducing group or its precursor.

However, in such silver halide photographic materials to be processed through liquid development, the silver halide is generally reduced with a developing agent (reducing agent) that is in the processing liquid to thereby form a silver image, or the side-produced oxidation product of the developing agent is used for color image formation. Anyhow, in these, the basic reaction is reduction of silver halides with a developing agent. On the other hand, in photothermographic materials, the silver halide is only to form a latent image through exposure to light, and it is not reduced by the reducing agent in the materials. In such photothermographic materials, not the non-photosensitive organic silver salts but the silver ions applied thereto are reduced. The reducing agent for liquid development is an ionic reducing agent of, for example, hydroquinones or p-phenylenediamines, but that for photothermographic materials is generally a hindered phenol derivative known as a radical reactant.

As in the above, photographic materials for liquid development and photothermographic materials quite differ in point of the mechanism of development reaction (reduction) to occur therein, and in point of the series of compounds to be used for them. Accordingly, it should not be said that the compounds effective for liquid development are all the time directly effective for photothermographic materials. For example, the compounds described in the above-mentioned JP-A 8-272024 are not expected at all for photothermographic materials, and, needless-to-say, no one knows the applicability of the compounds to photothermographic materials with a high silver iodide emulsion therein and it is impossible for any one to expect the effect of the compounds in photothermographic materials.

As an ultra-hard image-forming agent for forming ultra-hard images, known are adsorbing group-having acylhydrazines. It is known that such adsorbing group-having acylhydrazines are effective for forming ultra-hard images also in photothermographic materials. This is because of the action of such acylhydrazines for infection development, and such acylhydrazines are effective for forming ultra-hard images in photothermographic materials but the graininess of the images formed is not good. Therefore, using such acylhydrazines in processing photothermographic materials will be suitable for processing them for making printing plates but is unsuitable at all for processing them for use in medical diagnosis. Accordingly, such adsorbing group-having acylhydrazines are unsuitable for the object of increasing the sensitivity of photographic silver halides having a high silver iodide content for forming high-quality images.

On the other hand, the recent tendency in the art is toward further small-sized exposure devices for thermal image-forming systems with organic silver salts therein, and it is much desired to further increase the sensitivity of photosensitive silver halides for the systems. After thermally developed, the density of the image area of thermal image-forming systems with organic silver salts therein often increases if the exposed photographic materials receive light while they are stored. For solving the problem in printout failure, it is known that reducing the photosensitive silver halide content of the photographic materials is effective.

However, the reduction in the photosensitive silver halide content of the photographic materials results in the reduction in the sensitivity of the photographic materials themselves and therefore the reduction in the maximum density of the images formed on the materials. Given that situation, it is desired to more effectively improve the storability of processed photothermographic materials not by the means of reducing the photosensitive silver halide content of the materials.

### SUMMARY OF THE INVENTION

The object of the present invention is to provide a high-sensitivity silver halide photothermographic material having a high silver iodide content and capable of forming high-quality images; to provide such a photothermographic material of which the advantages are that the maximum density of the images formed thereon is satisfactorily high, the raw film storage stability thereof is good, and the material is fogged little after thermally developed; to provide such a photothermographic material of which the advantages are that the optical image storability thereof is good after thermally developed, and the images formed thereon have a lowered Dmin and an increased Dmax; to provide such a silver halide photothermographic material of which the advantages are that it is rapidly developed and is stable irrespective of the time for development, and it gives images of good printout quality; and to provide a method of thermal development of such a photothermographic material.

The object of the invention is attained by the photothermographic material and the method of thermal development of it mentioned below.

A first embodiment of the present invention is a photothermographic material comprising a support having thereon a layer including at least a non-photosensitive organic silver salt, a photosensitive silver halide, a reducing agent and a binder; wherein the photosensitive silver halide has a mean silver iodide content of 5 to 100 mol % and further comprising at least one compound of the following general formula (I):

(X)ₖ—(L)ₘ—(A—B)ₙ General formula (I)

wherein X represents a silver halide-adsorbing group or a light-absorbing group that has at least one atom each of N, S, P, Se and Te; L represents a (k+n)-valent linking group having at least one atom each of C, N, S and O; A represents an electron-donating group; B represents a leaving group or a hydrogen group; A—B is oxidized and then cleaved or deprotonated to generate a radical A; k represents an integer from 0 to 3; m represents 0 or 1; n represents 1 or 2; and when k=0 and n=1, then m=0.

A second embodiment of the present invention is the photothermographic material, according to the first embodiment, wherein the mean silver iodide content of the silver halide is 10 to 100 mol %.

A third embodiment of the pesent invention is the photothermographic material, according to the first embodiment, wherein the mean silver iodide content of the silver halide is 40 to 100 mol %.

A fourth embodiment of the pesent invention is the photothermographic material, according to the first embodiment, wherein the photosensitive silver halide comprises a mean grain size of 5 to 80 nm.

A fifth embodiment of the pesent invention is the photothermographic material, according to the first embodiment, wherein the mean grain size of the silver halide is 5 to 70 nm.

A sixth embodiment of the pesent invention is the photothermographic material, according to the first embodiment, wherein the silver halide grains have a direct transition absorption derived from the high silver iodide crystal structure therein.

A seventh embodiment of the pesent invention is a method of thermal development of a photothermographic material, which comprises a support having thereon a layer including at least a non-photosensitive organic silver salt, a photosensitive silver halide, a reducing agent and a binder; wherein the photosensitive silver halide has a mean silver iodide content of 5 to 100 mol %, and which further comprises at least one compound of the following general formula (I), wherein the highest temperature at thermal development of the photothermographic material is 100 to 120° C.

(X)ₖ—(L)ₘ—(A—B)ₙ General formula (I)

wherein X represents a silver halide-adsorbing group or a light-absorbing group that has at least one atom each of N, S, P, Se and Te; L represents a (k+n)-valent linking group having at least one atom each of C, N, S and O; A represents an electron-donating group; B represents a leaving group or a hydrogen group; A—B is oxidized and then cleaved or deprotonated to generate a radical A; k represents an integer from 0 to 3; m represents 0 or 1; n represents 1 or 2; and when k=0 and n=1, then m=0;

An eighth embodiment of the pesent invention is the method of thermal development of the photothermographic material according to the seventh embodiment, wherein the highest temperature when thermally developing the photothermographic material is 105 to 1 15° C.

A ninth embodiment of the pesent invention is the method of thermal development of the photothermographic material according to the seventh embodiment, wherein the photothermographic material is thermally developed by being conveyed through a thermal development zone that comprises from 2 to 6 plate heaters for thermal development and by being kept in contact with the plate heaters in that zone.

A tenth embodiment of the pesent invention is the method of thermal development of the photothermographic material according to the seventh embodiment, wherein the mean grain size of the silver halide is 5 to 70 nm.

An eleventh embodiment of the pesent invention is the method of thermal development of the photothermographic material according to the seventh embodiment, wherein the mean grain size of the silver halide is 5 to 70 nm.

A twelfth embodiment of the pesent invention is a photothermographic material comprising a support having thereon a photosensitive silver halide, a non-photosensitive organic silver salt, a thermal-developing agent and a binder; wherein the photosensitive silver halide has a silver iodide content of 40 to 100 mol % and includes a metal selected from the elements of Groups 3 to 10 of the Periodic Table.

A thirteenth embodiment of the pesent invention is the photothermographic material, according to the twelfth embodiment, wherein the metal is selected from the group consisting of iron, nickel, cobalt, ruthenium, rhodium, rhenium, osmium, iridium, palladium, platinum, gold, silver, copper and zinc.

A fourteenth embodiment of the pesent invention is the photothermographic material, according to the twelfth embodiment, wherein the metal comprises a metal complex.

A fifteenth embodiment of the pesent invention is the photothermographic material, according to the fourteenth embodiment, wherein the metal complex is a quadridentate metal complex having 4 ligands.

A sixteenth embodiment of the pesent invention is the photothermographic material, according to the twelfth embodiment, wherein the metal complex is a quadridentate metal complex with a metal selected from the group consisting of iron, nickel, cobalt, ruthenium, rhodium, rhenium, osmium, iridium, palladium, platinum, gold, silver, copper and zinc.

A seventeenth embodiment of the pesent invention is the photothermographic material, according to the twelfth embodiment, wherein the iodide content of the photosensitive silver halide is 90 to 100 mol %.

An eighteenth embodiment of the pesent invention is a photothermographic material comprising a support having thereon an image-forming layer including at least a non-photosensitive organic silver salt, a photosensitive silver halide, a reducing agent and a binder; and further comprising a compound having a silver halide-adsorbing group and a reducing group or a precursor thereof.

A ninteenth embodiment of the pesent invention is the photothermographic material, according to the eighteenth embodiment, wherein the compound having a silver halide-adsorbing group and a reducing group is represented by the following general formula (I″):

A—(W)n—B General formula (I″)

wherein A represents an atomic group that contains a silver halide-adsorbing group; W represents a divalent linking group; n indicates 0 or 1; and B represents a reducing group.

A twentieth embodiment of the pesent invention is the photothermographic material, according to the ninteenth embodiment, wherein the adsorbing group in general formula (I″) is selected from the group consisting of a mercapto group, a thione group and an imino silver forming group.

A twenty-first embodiment of the pesent invention is the photothermographic material, according to the ninteenth embodiment, wherein the reducing group in general formula (I″) is selected from the group consisting of a formyl group, an amino group, an acetylene group, a propargyl group, an alkylmercapto group and an arylmercapto group. A twenty-second embodiment of the pesent invention is the photothermographic material, according to the ninteenth embodiment, wherein the reducing group in general formula (I″) is any one selected from the following groups represented by (B₁) to (B₃):

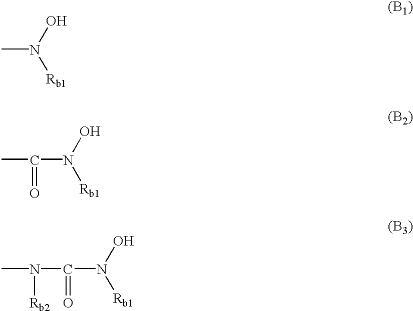

wherein R_{b1} and Rb₂ each independently represent a hydrogen atom, an alkyl group, an alkenyl group, an alkynyl group, an aryl group or a heterocyclic group.

A twenty-third embodiment of the pesent invention is the photothermographic material, according to the ninteenth embodiment, wherein the reducing group in general formula (I″) is derived from any one of reductones, phenols, naphthols, phenylenediamines, and 1-phenyl-3-pyrazolidones.

A twenty-fourth embodiment of the pesent invention is the photothermographic material, according to the eighteenth embodiment, wherein the precursor comprises a compound that generates a mercapto group.

A twenty-fifth embodiment of the pesent invention is the photothermographic material, according to the eighteenth embodiment, wherein the precursor is selected from the group consisting of thiazoliums, thiazolines, thiazolidines and disulfides.

A twenty-sixth embodiment of the pesent invention is the photothermographic material, according to the eighteenth embodiment, wherein the silver halide emulsion is chemically sensitized through at least any one of chalcogen sensitization, gold sensitization and reduction sensitization.

A twenty-seventh embodiment of the pesent invention is the photothermographic material, according to the twenth-sixth embodiment, wherein the silver halide is chemically sensitized at Ag of not more than 7.

A twenty-eighth embodiment of the pesent invention is the photothermographic material, according to the twenth-sixth embodiment, wherein the chalcogen sensitization is at least one selected from the group consisting of tellurium sensitization, selenium sensitization and sulfur sensitization.

A twenty-ninth embodiment of the pesent invention is the photothermographic material, according to the eighteenth embodiment, wherein the silver iodide content of the silver halide photographic emulsion is 80 mol % to 100 mol %.

A thirtieth embodiment of the pesent invention is the photothermographic material, according to the eighteenth embodiment, wherein the silver iodide content of the silver halide photographic emulsion is 90 mol % to 100 mol %.

A thirty-first embodiment of the pesent invention is the photothermographic material, according to the eighteenth embodiment, wherein the silver halide grains have an epitaxially-formed part, and the part includes any of silver bromide and silver chloride.

A thirty-second embodiment of the pesent invention is the photothermographic material, according to the eighteenth embodiment, wherein the silver halide grains have any one of dislocation lines and lattice defects.

A thirty-third embodiment of the pesent invention is the photothermographic material, according to the eighteenth embodiment, wherein the grain size of the silver halide grains is 5 nm to 0.1 μm.

A thirty-fourth embodiment of the pesent invention is the photothermographic material, according to the eighteenth embodiment, wherein the grain size of the silver halide grains is 5 nm to 0.055 nm.

A thirty-fifth embodiment of the pesent invention is the photothermographic material, according to the eighteenth embodiment, wherein the photothermographic material is exposed to laser rays.

A thirty-sixth embodiment of the present invention is a photothermographic material comprising a support having thereon at least one image-forming layer including at least a non-photosensitive organic silver salt, a photosensitive silver halide, a reducing agent and a binder; and further comprising at least one non-image-recording protective layer on the far side of the support relative to the image-forming layer; wherein the silver halide comprises a silver iodide content of 5 mol % to 100 mol % and is chemically sensitized through at least any one of gold sensitization, chalcogen sensitization and reduction sensitization.

A thirty-seventh embodiment of the present invention is the photothermographic material according to the thirty-sixth embodiment, wherein the silver iodide content of the photosensitive silver halide is 40 mol % to 100 mol %.

A thirty-eighth embodiment of the present invention is the photothermographic material according to the thirty-sixth embodiment, wherein the silver iodide content of the photosensitive silver halide is 90 mol % to 100 mol %.

A thirty-ninth embodiment of the present invention is the photothermographic material according to the thirty-sixth embodiment, wherein the grain size of the photosensitive silver halide is 5 nm to 90 nm.

A fortieth embodiment of the present invention is the photothermographic material according to the thirty-sixth embodiment, wherein the coating amount of the photosensitive silver halide is at most 10 mol % relative to one mol of the non-photosensitive organic silver salt therein.

A forty-first embodiment of the present invention is the photothermographic material according to the thirty-sixth embodiment, wherein the photosensitive silver halide grains are formed and chemically sensitized in the absence of the organic silver salt.

A forty-second embodiment of the present invention is the photothermographic material according to the thirty-sixth embodiment, for which the peak wavelength of the laser rays is 600 nm to 900 nm.

A forty-third embodiment of the present invention is the photothermographic material according to the thirty-sixth embodiment, for which the peak wavelength of the laser rays is 300 nm to 500 nm.

A forty-fourth embodiment of the present invention is a photothermographic material comprising a support having thereon at least a photosensitive silver halide, a non-photosensitive organic silver salt, a reducing agent and a binder; wherein the mean silver iodide content of the photosensitive silver halide is 5 mol % to 100 mol %, wherein the non-photosensitive organic silver salt is prepared from an organic acid including at least behenic acid and erucic acid, and the erucic acid content of the non-photosensitive organic silver salt is 1×10⁻⁶ mol % to 10 mol % relative to the number of mols of the whole organic acid.

A forty-fifth embodiment of the present invention is a photothermographic material comprising a support having thereon at least one image-forming layer including at least one organic silver salt and at least one silver halide, and having thereon at least one non-image-recording protective layer on the far side of the support relative to the image-forming layer, which is exposed to laser rays; wherein the mean silver iodide content of the silver halide is 40 mol % to 100 mol %.

A forty-sixth embodiment of the present invention is the photothermographic material according to the forty-fifth embodiment, wherein the grain size of the silver halide is 5 nm to 90 nm.

A forty-seventh embodiment of the present invention is the photothermographic material according to the forty-fifth embodiment, wherein the silver halide grains have a core/shell structure, the silver iodide content of the shell is higher than that of the core, and the silver iodide content of the shell is 80 mol % to 100 mol %.

The forty-eighth embodiment of the present invention is the photothermographic material according to the forty-fifth embodiment, wherein the silver halide grains are formed and chemically sensitized in the absence of the organic silver salt.

The forty-ninth embodiment of the present invention is the photothermographic material according to the forty-fifth embodiment, wherein the coating amount of the silver halide in the image-forming layer is 0.5 mol % to 12 mol % relative to the organic silver salt therein.

The fiftieth embodiment of the present invention is the photothermographic material according to the forty-fifth embodiment, for which the peak wavelength of the laser rays is 600 nm to 900 nm.

The fifty-first embodiment of the present invention is the photothermographic material according to the forty-fifth embodiment, for which the peak wavelength of the laser rays is 300 nm to 500 nm.

The fifty-second embodiment of the present invention is the photothermographic material according to the forty-fifth embodiment, wherein the image-forming layer is formed by applying a coating liquid onto the support, and the coating liquid for the image-forming layer includes at least 30% by weight of water and a polymer dispersed to be latex therein.

The fifty-third embodiment of the present invention is the photothermographic material according to the twelfth embodiment, wherein the support further having thereon an organic polyhalogen compound.

The fifth-fourth embodiment of the present invention is the photothermographic material according to the eighteenth embodiment, wherein the silver iodide content of the silver halide is 40 mol % to 100 mol %.

The fifty-fifth embodiment of the present invention is the photothermographic material according to the thirty-sixth embodiment, wherein the support further having thereon an organic polyhalogen compound.

### BRIEF DESCRIPTION OF THE DRAWINGS

FIG. 1 shows the light absorbance curve of a silver iodide emulsion preferred for the photosensitive silver halide for use in the twelfth embodiment of the present invention.

### DESCRIPTION OF THE PREFERRED EMBODIMENTS

### Photothermographic Material, and Method of Thermal Development Thereof

First Embodiment of Photothermographic Material

The first embodiment of the photothermographic material of the pesent invention is described below.

A first embodiment of the present invention is a photothermographic material comprising a support having thereon a layer including at least a non-photosensitive organic silver salt, a photosensitive silver halide, a reducing agent and a binder, wherein the photosensitive silver halide has a mean silver iodide content of 5 to 100 mol % and further comprising at least one compound of the following general formula (I) mentioned below.

It is a matter of importance that the halogen composition of the photosensitive silver halide to be used in the first embodiment of the invention is a high silver iodide emulsion of which the silver iodide content falls between 5 mol % and 100 mol %. In general, the sensitivity of silver halides having such a high silver iodide content is low and the utility value thereof is therefore low.

Preferably, a part of the silver halide in the first embodiment of the invention has a phase capable of absorbing light through direct transition. It is well known that high silver iodide grains having a hexagonal-system wurtzite structure of a cubic-system zinc-blend structure realize light absorption through direct transition in the wavelength range of from 350 nm to 450 nm in which the silver halide grains are exposed to light. However, the sensitivity of the silver halide having such an absorption structure is generally low, and the utility value thereof in the field of photography is therefore low.

Through our studies, we, the present inventors have found that, when a compound of formula (I) as in the first embodiment of the invention is used in a photothermographic material that contains a non-photosensitive organic silver salt and a thermal developer, then the material may have a high sensitivity even though the photosensitive silver halide therein has a high silver iodide content, and may form sharp images.

Our studies have revealed that the grain size of the silver halide grains in the material is preferably at most 80 nm, more preferably 5 nm to 80 nm and especially preferably 5 nm to 70 nm. Containing such small-size silver halide grains, the advantages of the material of the invention are more remarkable.

The contents of the invention are described in more detail hereinunder.

<Compound of Formula (I)>

First described is the compound of formula (I) that shall be in the photothermographic material of the first embodiment of the invention.

In formula (I), X represents a silver halide-adsorbing group or a light-absorbing group that has at least one atom of N, S, P, Se and Te.

Preferably, X is a silver halide-adsorbing group that has at least one atom of N, S, P, Se and Te and has a silver ion ligand structure. The silver halide-adsorbing group that has such a silver ion ligand structure includes, for example, those of general formulae mentioned below.

—G¹—Z¹—Y¹ General Formula (X-1)

wherein G¹ represents a divalent linking group, such as a substituted or unsubstituted alkylene, alkenylene, alkynylene or arylene group, SO₂, or a divalent heterocyclic group; Z¹ represents an atom or S, Se or Te; Y¹ represents a hydrogen atom, or a counter ion necessary in dissociation of Z¹ such as a sodium, potassium, lithium or ammonium ion.

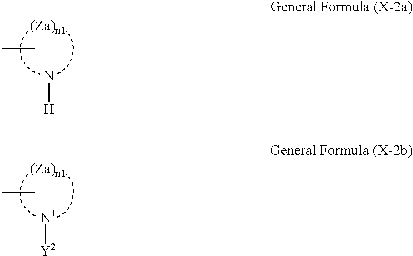

The groups of formulae (X-2a) and (X-2b) have a 5- to 7-memberfed hetero ring or unsaturated ring. Za represents an atom of O, N, S, Se or Te; n¹ indicates an integer of from 0 to 3; and Y² represents a hydrogen atom, an alkyl group, an alkenyl group, an alkynyl group, or an aryl group.

—Y³—(Z²)n²—Y⁴ General Formula (X-3)

wherein Z² represents an atom of S, Se or Te; n² indicates an integer of from 1 to 3; Y³ represents a divalent linking group, such as an alkylene group, an alkenylene group, an alkynylene group, an arylene group, or a divalent heterocyclic group; and Y⁴ represents an alkyl group, an aryl group, or a heterocyclic group.

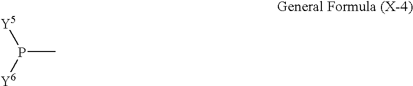

wherein Y⁵ and Y⁶ each independently represent an alkyl group, an alkenyl group, an arylene group, or a heterocyclic group.

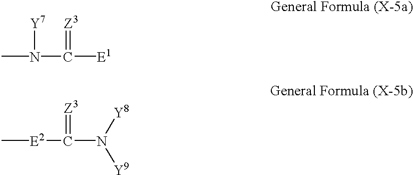

wherein Z³ represents an atom of S, Se or Te; E¹ represents a hydrogen atom, NH₂, NHY¹⁰, N(Y¹⁰)₂, NHN(Y¹⁰)₂, OY¹⁰ or SY¹⁰; E² represents a divalent linking group such as NH, NY¹⁰, NHNY¹⁰, O or S; Y⁷, Y⁸ and Y⁹ each independently represent a hydrogen atom, an alkyl group, an alkenyl group, an aryl group, or a heterocyclic group; Y⁸ and Y⁹ may be bonded to each other to form a ring; Y¹⁰ represents a hydrogen atom, an alkyl group, an alkenyl group, an aryl group, or a heterocyclic group. 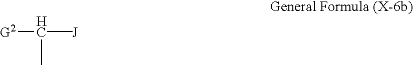 —Y¹¹—C≡H General Formula (X-6a)

wherein Y¹¹ represents a divalent linking group such as an alkylene group, an alkenylene group, an alkynylene group, an arylene group or a divalent heterocyclic group; G² and J each independently represent COOY¹², SO₂Y¹², COY¹², SOY¹², CN, CHO or NO₂; and Y¹² represents an alkyl group, an alkenyl group, or an aryl group.

Formula (X-1) is described in detail. In the formula, the linking group for G¹ includes, for example, a substituted or unsubstituted, linear or branched alkylene group having from 1 to 20 carbon atoms (e.g., methylene, ethylene, trimethylene, propylene, tetramethylene, hexamethylene, 3-oxapentylene, 2-hydroxyrimethylene), a substituted or unsubstituted cyclic alkylene group having from 3 to 18 carbon atoms (e.g., cyclopropylene, cyclopentylene, cyclohexylene), a substituted or unsubstituted alkenylene group having from 2 to 20 carbon atoms (e.g., ethene, 2-butenylene) an alkynylene group having from 2 to 10 carbon atoms (e.g., ethynylene), a substituted or unsubstituted arylene group having from 6 to 20 carbon atoms (e.g., unsubstituted p-phenylene, unsubstituted 2,5-naphthylene).

The group SO₂ for G¹ in the formula may be —SO₂— alone, but including —SO₂— bonded to a substituted or unsubstituted, linear or branched alkylene group having from 1 to 10 carbon atoms, a substituted or unsubstituted cyclic alkylene group having from 3 to 6 carbon atoms, or an alkenylene group having from 2 to 10 carbon atoms.

The divalent heterocyclic group for G¹ in the formula includes may be unsubstituted or substituted with an alkylene group, an alkenylene group, an arylene group or a heterocyclic group, or may be benzo-condensed or naphtho-condensed (e.g., 2,3-tetrazole-diyl, 1,3-triazole-diyl, 1,2-imidazole-diyl, 3,5-oxadiazole-diyl, 2,4-thiadiazole-diyl, 1,5-benzimidazole-diyl, 2,5-benzothiazole-diyl, 2,5-benzoxazole-diyl, 2,5-pyrimidine-diyl, 3-phenyl-2,5-tetrazole-diyl, 2,5-pyridine-diyl, 2,4-furan-diyl, 1,3-piperidine-diyl, 2,4-morpholine-diyl).

In the formula, the alkylene group, the alkenylene group, the alkynylene group, the arylene group, the group SO₂ or the divalent heterocyclic group for G¹ may be substituted. Examples of the substituent by which the groups may be substituted are mentioned below. The substituent mentioned below is herein referred to as “substituent Y”.

The substituent includes, for example, a halogen atom (e.g., fluorine, chlorine, bromine), an alkyl group (e.g., methyl, ethyl, isopropyl, n-propyl, tert-butyl), an alkenyl group (e.g., allyl, 2-butenyl), an alkynyl group (e.g., propargyl), an aralkyl group (e.g., benzyl), an aryl group (e.g., phenyl, naphthyl, 4-methylphenyl), a heterocyclic group (e.g., pyridyl, furyl, imidazolyl, piperidinyl, morpholyl), an alkoxy group (e.g., methoxy, ethoxy, butoxy, 2-ethylhexyloxy, ethoxyethoxy, methoxyethoxy), an aryloxy group (e.g., phenoxy, 2-naphthyloxy), an amino group (e.g., unsubstituted amino, dimethylamino, diethylamino, dipropylamino, dibutylamino, ethylamino, anilino), an acylamino group (e.g., acetylamino, benzoylamino), an ureido group (e.g., unsubstituted ureido, N-methylureido), an urethane group (e.g., methoxycarbonylamino, phenoxycarbonylamino), a sulfonylamino group (e.g., methylsulfonylamino, phenylsulfonylamino), a sulfamoyl group (e.g., unsubstituted sulfamoyl, N,N-dimethylsulfamoyl, N-phenylsulfamoyl), a carbamoyl group (e.g., unsubstituted carbamoyl, N,N-diethylcarbamoyl, N-phenylcarbamoyl), a sulfonyl group (e.g., mesyl, tosyl), a sulfinyl group (e.g., methylsulfinyl, phenylsulfinyl), an alkyloxycarbonyl group (e.g., methoxycarbonyl, ethoxycarbonyl), an aryloxycarbonyl group (e.g., phenoxycarbonyl), an acyl group (e.g., acetyl, benzoyl, formyl, pivaloyl), an acyloxy group (e.g., acetoxy, benzoyloxy), a phosphoramido group (e.g., N,N-diethylphosphoramido), a cyano group, a sulfo group, a thiosulfonyl group, a sulfinyl group, a carboxyl group, a hydroxyl group, a phosphono group, a nitro group, an ammonio group, a phosphonio group, a hydrazino group, a thiazolino group. In case where the group has two or more substituents, they may be the same or different. The substituents for these groups may be further substituted.

Preferred examples of formula (X-1) are mentioned below.

Preferably in formula (X-1), G¹ is a substituted or unsubstituted arylene group having from 6 to 10 carbon atoms, or a 5- to 7-membered heterocyclic group that is unsubstituted or bonded to an alkylene or arylene group, or is benzo-condensed or naphtho-condensed; Z¹ is S or Se; and Y¹ is a hydrogen atom or a sodium or potassium ion.

More preferably, G¹ is a substituted or unsubstituted arylene group having from 6 to 8 carbon atoms, o a 5- or 6-membefred heterocyclic group that is bonded to an arylene group or is benzo-condensed. Most preferably, it is a 5- or 6-membered heterocyclic group that is bonded to an arylene group or is benzo-condensed. Even more preferably, Z¹ is S, and Y¹ is a hydrogen atom or a sodium ion.

Formulae (X-2a) and (X-2b) are described in detail.

The alkyl group, the alkenyl group and the alkynyl group for Y² in the formula include, for example, a substituted or unsubstituted, linear or branched alkyl group having from 1 to 10 carbon atoms (e.g., methyl, ethyl, isopropyl, n-propyl, n-butyl, tert-butyl, 2-pentyl, n-hexyl, n-octyl, tert-octyl, 2-ethylhexyl, 2-hydroxyethyl, 1-hydroxyethyl, diethylaminoethyl, n-butoxypropyl, methoxymethyl), a substituted or unsubstituted cyclic alkyl group having from 3 to 6 carbon atoms (e.g., cyclopropyl, cyclopentyl, cyclohexyl), an alkenyl group having from 2 to 10 carbon atoms (e.g., allyl, 2-butenyl, 3-pentenyl), an alkynyl group having from 2 to 10 carbon atoms (e.g., propargyl, 3-pentynyl), an aralkyl group having from 6 to 12 carbon atoms (e.g., benzyl). The aryl group for it is, for example, a substituted or unsubstituted aryl group having from 6 to 12 carbon atoms (e.g., hydroxyphenyl, 4-methylhydroxyphenyl). Y² may be substituted with any of the substituents Y.

Preferred examples of formulae (X-2a) and (X-2b) are mentioned below.

Preferably in the formulae, Y² is a hydrogen atom, a substituted or unsubstituted alkyl group having from 1 to 6 carbon atoms, or a substituted or unsubstituted aryl group having from 6 to 10 carbon atoms; Za is O, N or S; and n¹ is from 1 to 3.

More preferably, Y² is a hydrogen atom or an alkyl group having from 1 to 4 carbon atoms; Za is N or S; and n¹ is 2 or 3.

Formula (X-3) is described in detail.

The linking group for Y³ in the formula includes, for example, a substituted or unsubstituted, linear or branched alkylene group having from 1 to 20 carbon atoms (e.g., methylene, ethylene, trimethylene, isopropylene, tetramethylene, hexamethylene, 3-oxapentylene, 2-hydroxytrimethylene), a substituted or unsubstituted cyclic alkylene group having from 3 to 18 carbon atoms (e.g., cyclopropylene, cyclopentylene, cyclohexylene), a substituted or unsubstituted alkenylene group having from 2 to 20 carbon atoms (e.g., ethene, 2-butenylene), an alkynylene group having from 2 to 10 carbon atoms (e.g., ethynylene), a substituted or unsubstituted arylene group having from 6 to 20 carbon atoms (e.g., unsubstituted p-phenylene, unsubstituted 2,5-naphthylene). The heterocyclic group for it may be unsubstituted or substituted with an alkylene group, alkenylene group or an arylene group, or further with an additional heterocyclic group (e.g., 2,5-pyridine-diyl, 3-phenyl-2,5-pyridine-diyl, 1,3-piperidine-diyl, 2,4-morpholine-diyl).

The alkyl group for Y⁴ in the formula includes, for example, a substituted or unsubstituted, linear or branched alkyl group having from 1 to 10 carbon atoms (e.g., methyl, ethyl, isopropyl, n-propyl, n-butyl, tert-butyl, 2-penthyl, n-hexyl, n-octyl, tert-octyl, 2-ethylhexyl, 2-hydroxyethyl, 1-hydroxyethyl, diethylaminoethyl, dibutylaminoethyl, n-butoxymethyl, methoxymethyl), a substituted or unsubstituted cyclic alkyl group having from 3 to 6 carbon atoms (e.g., cyclopropyl, cyclopentyl, cyclohexyl). The aryl group for it is, for example, a substituted or unsubstituted aryl group having from 6 to 12 carbon atoms (e.g., unsubstituted phenyl, 2-methylphenyl).

The heterocyclic group for it may be unsubstituted or substituted with an alkyl group, an alkenyl group or an aryl group or further with an additional heterocyclic group (e.g., pyridyl, 3-phenylpyridyl, piperidyl, morpholyl).

Y⁴ may be substituted with any of the substituents Y.

Preferred examples of formula (X-3) are mentioned below.

Preferably in the formula, Y³ is a substituted or unsubstituted alkylene group having from 1 to 6 carbon atoms, or a substituted or unsubstituted arylene group having from 6 to 10 carbon atoms; Y⁴ is a substituted or unsubstituted alkyl group having from 1 to 6 carbon atoms, or a substituted or unsubstituted aryl group having from 6 to 10 carbon atoms; Z² is S or Se; and n² is 1 or 2.

More preferably, Y³ is an alkylene group having from 1 to 4 carbon atoms; Y⁴ is an alkyl group having from 1 to 4 carbon atoms; Z² is S; and n² is 1.

Next described in detail is formula (X-4).

In the formula, the alkyl group and the alkenyl group for Y⁵ and Y⁶ include, for example, a substituted or unsubstituted, linear or branched alkyl group having from 1 to 10 carbon atoms (e.g., methyl, ethyl, isopropyl, n-propyl, n-butyl, tert-butyl, 2-pentyl, n-hexyl, n-octyl, tert-octyl, 2-ethylhexyl, hydroxymethyl, 2-hydroxyethyl, 1-hydroxyethyl, diethylaminoethyl, dibutylaminoethyl, n-butoxymethyl, n-butoxypropyl, methoxymethyl), a substituted or unsubstituted cyclic alkyl group having from 3 to 6 carbon atoms (e.g., cyclopropyl, cyclopentyl, cyclohexyl), and an alkenyl group having from 2 to 10 carbon atoms (e.g., allyl, 2-butenyl, 3-pentenyl). The aryl group for them may be, for example, a substituted or unsubstituted aryl group having from 6 to 12 carbon atoms (e.g., unsubstituted phenyl, 4-methylphenyl); and the heterocyclic group may be unsubstituted or substituted with any of an alkylene group, an alkenylene group, an arylene group and an additional heterocyclic group (e.g., pyridyl, 3-phenylpyridyl, furyl, piperidyl, morpholino).

In the formula, Y⁵ and Y⁶ may be substituted with any of the substituents Y.

Preferred examples of formula (X-4) are mentioned below.

Preferably in the formula, Y⁵ and Y⁶ each are a substituted or unsubstituted alkyl group having from 1 to 6 carbon atoms, or a substituted or unsubstituted aryl group having from 6 to 10 carbon atoms.

More preferably, Y⁵ and Y⁶ each are an aryl group having from 6 to 8 carbon atoms.

Formulae (X-5a) and (X-5b) are described in detail. In these formulae, the group E¹ includes, for example, NH₂, NHCH₃, NHC₂H₅, NHPh, N(CH₃)₂, N(Ph)₂, NHNHC₃H₇, NHNHPh, OC₄H₉, OPh and SCH₃; and E² includes, for example, NH, NCH₃, NC₂H₅, NPh, NHNC₃H₇, and NHNPh. “Ph” herein indicates a phenyl group.

In formulae (X-5a) and (X-5b), the alkyl group and the alkenyl group for Y⁷, Y⁸ and Y⁹ include, for example, a substituted or unsubstituted, linear or branched alkyl group having from 1 to 10 carbon atoms (e.g., methyl, ethyl, isopropyl, n-propyl, n-butyl, tert-butyl, 2-pentyl, n-hexyl, n-octyl, tert-octyl, 2-ethylhexyl, hydroxymethyl, 2-hydroxyethyl, 1-hydroxyethyl, diethylaminoethyl, dibutylaminoethyl, n-butoxymethyl, n-butoxypropyl, methoxymethyl), a substituted or unsubstituted cyclic alkyl group having from 3 to 6 carbon atoms (e.g., cyclopropyl, cyclopentyl, cyclohexyl), and an alkenyl group having from 2 to 10 carbon atoms (e.g., allyl, 2-butenyl, 3-pentenyl). The aryl group for them may be, for example, a substituted or unsubstituted aryl group having from 6 to 12 carbon atoms (e.g., unsubstituted phenyl, 4-methylphenyl). The heterocyclic group for them may be unsubstituted or substituted with any of an alkylene group, an alkenylene group, an arylene group and an additional heterocyclic group (e.g., pyridyl, 3-phenylpyridyl, furyl, piperidyl, morpholyl).

In the formulae, Y⁷, Y⁸ and Y⁹ may be substituted with any of the substituents Y.

Preferred examples of formulae (X-5a) and (X-5b) are mentioned below.

Preferably in these formulae, El is an alkyl-substituted or unsubstituted amino or alkoxy group; E² is an alkyl-substituted or unsubstituted amino-linking group; Y⁷, Y⁸ and Y⁹ each are a substituted or unsubstituted alkyl group having group 1 to 6 carbon atoms, or a substituted or unsubstituted arylene group having from 6 to 10 carbon atoms; and Z³ is S or Se.

More preferably, E¹ is an alkyl-substituted or unsubstituted amino group; E² is an alkyl-substituted or unsubstituted amino-linking group; Y⁷, Y⁸ and Y⁹ each are a substituted or unsubstituted alkyl group having group 1 to 4 carbon atoms; and Z³ is S.

Formulae (X-6a) and (X-6b) are described in detail.

In these formulae, the groups G² and J include, for example, COOCH₃, COOC₃H₇, COOC₆H₁₃, COOPh, SO₂CH₃, SO₂C₄H₉, COC₂H₅, COPh, SOCH₃, SOPh, CN, CHO and NO₂.

In these formulae, the linking group for Y¹¹ includes, for example, a substituted or unsubstituted, linear or branched alkylene group having from 1 to 20 carbon atoms (e.g., methylene, ethylene, trimethylene, propylene, tetramethylene, hexamethylene, 3-oxapentylene, 2-hydroxytrimethylene), a substituted or unsubstituted cyclic alkylene group having from 3 to 18 carbon atoms (e.g., cyclopropylene, cyclopentylene, cyclohexylene), a substituted or unsubstituted alkenylene group having from 2 to 20 carbon atoms (e.g., ethene, 2-butenylene), an alkynylene group having from 2 to 10 carbon atoms (e.g., ethynylene), and a substituted or unsubstituted arylene group having from 6 to 20 carbon atoms (e.g., unsubstituted p-phenylene, unsubstituted 2,5-naphthylene).

In these formulae, the divalent heterocyclic group for Y¹¹ may be unsubstituted or substituted with any of an alkylene group, an alkenylene group, an arylene group and an additional heterocyclic group (e.g., 2,5-pyridine-diyl, 3-phenyl-2,5-pyridine-diyl, 2,4-furan-diyl, 1,3-piperidine-diyl, 2,4-morpholine-diyl).

In these formulae, Y¹¹ may be substituted with any of the substituents Y.

Preferred examples of formulae (X-6a) and (X-6b) are mentioned below.

Preferably in these formulae, G² and J each are a carboxylate or carbonyl residue having from 2 to 6 carbon atom; and Y¹¹ is a substituted or unsubstituted alkylene group having from 1 to 6 carbon atoms, or a substituted or unsubstituted arylene group having from 6 to 10 carbon atoms.

More preferably, G² and J each are a carboxylate residue having from 2 to 4 carbon atom; and Y¹¹ is a substituted or unsubstituted alkylene group having from 1 to 4 carbon atoms, or a substituted or unsubstituted arylene group having from 6 to 8 carbon atoms.

The silver halide-adsorbing group for X is more preferably any of formulae (X-1), (X-2a), (X-2b), (X-3), (X-5a), (X-5b), (X-4), (X-6a) and (X-6b) in that order.

The light-absorbing group for X in formula (I) is described in detail.

The light-absorbing group for X in formula (I) may be represented, for example, by the following general formula:

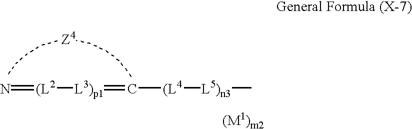

wherein Z⁴ represents an atomic group necessary for forming a 5- or 6-membered, nitrogen-containing hetero ring; L², L³, L⁴ and L⁵ each represent a methine group; p¹ indicates 0 or 1; n³ falls between 0 and 3; M¹ represents a charge-equilibrating counter ion; and m² indicates a number necessary for neutralizing the charge of the molecule, falling between 0 and 10.

In the formula, the 5- or 6-membered, nitrogen-containing hetero ring for Z⁴ includes, for example, thiazoline, thiazole, benzothiazole, oxazoline, oxazole, benzoxazole, selenazoline, selenazole, benzoselenazole, 3,3-dialkylindolenine (e.g., 3,3-dimethylindolenine), imidazoline, imidazole, benzimidazole, 2-pyridine, 4-pyridine, 2-quinoline, 4-quinoline, 1-isoquinoline, 3-isoquinoline, imidazo[4,5-b]quinoxaline, oxadiazole, thiadiazole, tetrazole and pyrimidine nuclei.

The 5- or 6-membered, nitrogen-containing hetero ring for Z⁴ may be substituted with any of the substituents Y.

In the formula, L², L³, L⁴ and L⁵ each independently represent a methine group. The methine group for L², L³, L⁴ and L⁵ may be substituted. The substituent includes, for example, a substituted or unsubstituted alkyl group having from 1 to 15 carbon atoms (e.g., methyl, ethyl, 2-carboxyethyl), a substituted or unsubstituted aryl group having from 6 to 20 carbon atoms (e.g., phenyl, o-carboxyphenyl), a substituted or unsubstituted heterocyclic group having from 3 to 20 carbon atoms (e.g., N,N-diethylbarbituric residue), a halogen atom (e.g., chlorine, bromine, fluorine, iodine), an alkoxy group having from 1 to 15 carbon atoms (e.g., methoxy, ethoxy), an alkylthio group having from 1 to 15 carbon atoms (e.g., methylthio, ethylthio), an arylthio group having from 6 to 20 carbon atoms (e.g., phenylthio), and an amino group having from 0 to 15 carbon atoms (e.g., N,N-diphenylamino, N-methyl-N-phenylamino, N-methylpiperazino).

The methine group for these may form a ring together with the other methine group, or may also form a ring together with the other part of the formula.

In the formula, M¹ indicates the presence of a cation or anion optionally necessary for neutralizing the ionic charge of the light-absorbing group. Typical examples of the cation are inorganic cations such as hydrogen ion (H⁺) and alkali metal ions (e.g., sodium ion, potassium ion, lithium ion); and organic cations such as ammonium ions (e.g., ammonium ion, tetraalkylammonium ions, pyridinium ion, ethylpyridinium ion). The anion may also be any of an inorganic anion or an organic anion, including, for example, halide ions (e.g., fluoride ion, chloride ion, iodide ion), substituted arylsulfonate ions (e.g., p-toluenesulfonate ion, p-chlorobenzenesulfonate ion), aryldisulfonate ions (e.g., 1,3-benzenedisulfonate ion, 1,5-naphthalenedisulfonate ion, 2,6-naphthalenedisulfonate ion), alkylsulfate ions (e.g., methylsulfate ion), sulfate ion, thiocyanate ion, perchlorate ion, tetrafluoroborate ion, picrate ion, acetate ion, and trifluoromethanesulfonate ion. For the light-absorbing group, also usable are ionic polymers or counter-charged groups.

In this description, the sulfo group is represented by SO₃—, and the carboxyl group is by CO₂—; and when the counter ion is a hydrogen ion, they may be represented by SO₃H and CO₂H, respectively.

In the formula, m² indicates a number necessary for neutralizing the charge of the molecule. In case where the group of the formula is to indicate an internal salt, m is 0.

Preferred examples of formula (X-7) are mentioned below.

Preferably in formula (X-7), Z⁴ indicates a benzoxazole nucleus, a benzothiazole nucleus, a benzimidazole nucleus or a quinoline nucleus; L², L³, L⁴ and L⁵ each represent an unsubstituted methine group; p¹ is 0; and n³ is 1 or 2.

More preferably, Z⁴ indicates a benzoxazole nucleus or a benzothiazole nucleus, and n³ is 0. Even more preferably, Z⁴ is a benzothiazole nucleus.

In formula (I), k is preferably 0 or 1, more preferably 1.

Examples of X in formula (I) are mentioned below, to which, however, X employable in the first embodiment of the invention is not limited.

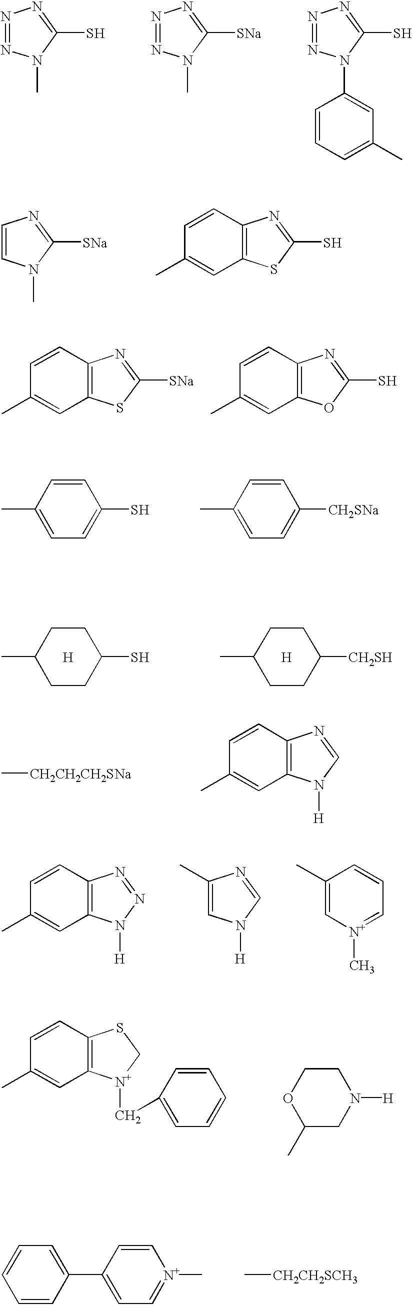

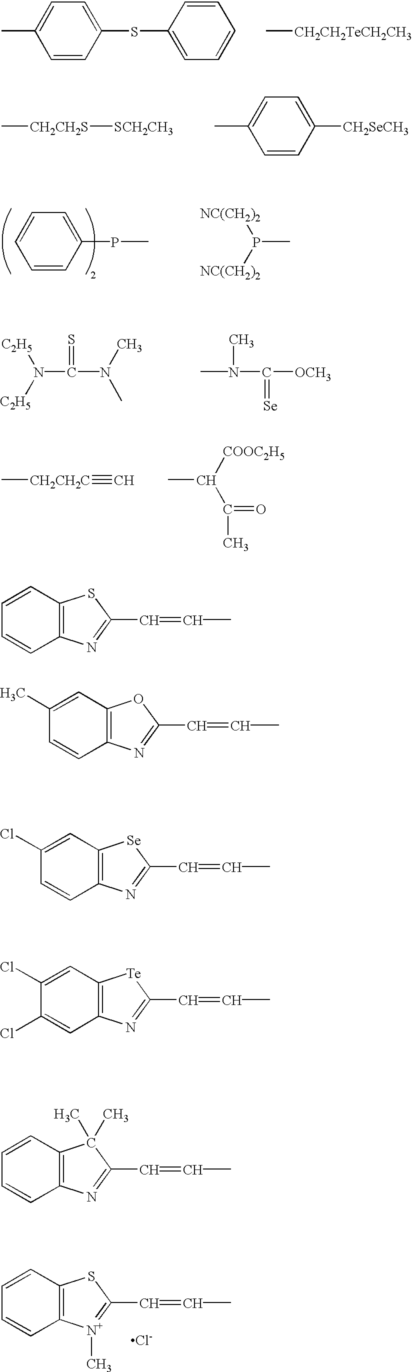

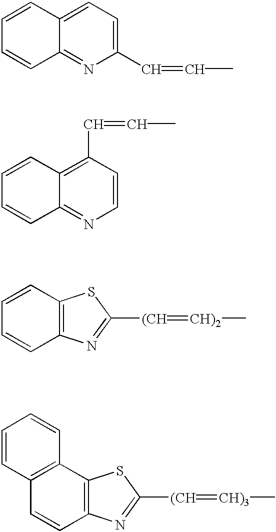

The linking group for L in formula (I) is described in detail.

The linking group for L in formula (I) includes, for example, a substituted or unsubstituted, linear or branched alkylene group having from 1 to 20 carbon atoms (e.g., methylene, ethylene, trimethylene, propylene, tetramethylene, hexamethylene, 3-oxapentylene, 2-hydroxytrimethylene), a substituted or unsubstituted cyclic alkylene group having from 3 to 18 carbon atoms (e.g., cyclopropylene, cyclopentylene, cyclohexylene), a substituted or unsubstituted alkenylene group having from 2 to 20 carbon atoms (e.g., ethene, 2-butenylene), an alkynylene group having from 2 to 10 carbon atoms (e.g., ethynylene), a substituted or unsubstituted arylene group having from 6 to 20 carbon atoms (e.g., unsubstituted p-phenylene, unsubstituted 2,5-naphthylene), a heterocyclic linking group (e.g., 2,6-pyridine-diyl), a carbonyl group, a thiocarbonyl group, an imido group, a sulfonyl group, a sulfonyloxy group, an ester group, a thioester group, an amido group, an ether group, a thioether group, an amino group, an ureido group, a thioureido group, a thiosulfonyl group. These linking groups may be bonded to each other to form linking groups of different types.

L may be substituted with any of the substituents Y.

Preferably, the linking group L is an unsubstituted alkylene group having from 1 to 10 carbon atoms, or an alkylene group having from 1 to 10 carbon atoms and bonded to any of an amino group, an amido group, a thioether group, an ureido group or a sulfonyl group. More preferably, it is an unsubstituted alkylene group having from 1 to 6 carbon atoms, or an alkylene group having from 1 to 6 carbon atoms and bonded to any of an amino group, an amido group or a thioether group.

In formula (I), m is preferably 0 or 1, more preferably 1.

The electron-donating group A is described in detail.

In formula (I), the moiety (A—B) is, after oxidized or fragmented, releases an electron to form a radical A•, and the radical A• is then oxidized to release an electron. The reaction process to enhance the sensitivity of the photothermographic material of the invention is shown below.

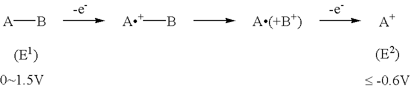

In the compound of formula (I), A is electron-donating group. Preferably, therefore, the compound is so designed that the substituents on the aromatic group of any structure therein satisfy the electron-rich condition of A therein. For example, in case where the aromatic ring in the compound does not satisfy the electron-rich condition of A, it is desirable to introduce an electron-donating group into it; but on the contrary, in case where the aromatic ring has too many electrons like anthracene, it is desirable to introduce an electron-attracting group into it. In any case, it is desirable that the oxidation potential of the compound is well controlled in that manner.

Preferably, the group A is represented by any of the following general formulae (A-1), (A-2) and (A-3):

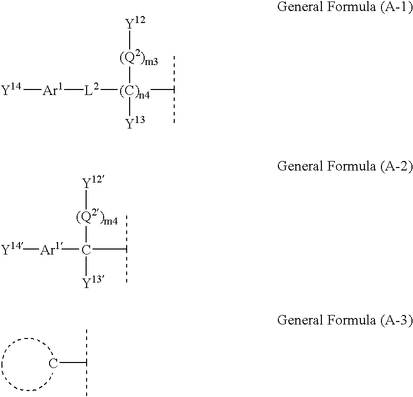

In formulae (A-1) and (A-2), Y¹², Y¹², Y¹³ and Y¹³ each independently represent a hydrogen atom, or a substituted or unsubstituted alkyl, aryl, alkylene or arylene group; Y¹⁴ and Y¹⁴ each independently represent an alkyl group, COOH, a halogen atom, N(Y¹⁵)₂, OY¹⁵, SY¹⁵, CHO, COY¹⁵, COOY¹⁵, CONHY¹⁵, CON(Y¹⁵)₂, SO₃Y¹⁵, SO₂NHY¹⁵, SO₂NY¹⁵, SO₂Y¹⁵, SOY¹⁵, or CSY¹⁵; Ar¹ and Ar^{1′} each independently represent an aryl group or a heterocyclic group; Y¹² and Y¹³, Y¹² and Ar¹, Y^{12′} and Y^{13′} and Y^{12′} and Ar^{1′} may be bonded to each other to form a ring; Q² and Q^{2′} each independently represent O, S, Se or Te; m³ and m⁴ each independently indicate 0 or 1; n⁴ falls between 1 and 3; L² represents N—R, N—Ar, O, S or Se, optionally having a 5- to 7-membered hetero ring or unsaturated ring; and Y¹⁵ represents a hydrogen atom, an alkyl group or an aryl group. The cyclic structure of formula (A-3) indicates a substituted or unsubstituted, 5- to 7-membered unsaturated ring or hetero ring.

Formulae (A-1), (A-2) and (A-3) are described in detail. In these formulae, the alkyl group for Y^{12′}, Y^{12′}, Y¹³ and Y^{13′} includes, for example, a substituted or unsubstituted, linear or branched alkyl group having from 1 to 10 carbon atoms (e.g., methyl, ethyl, isopropyl, n-propyl, n-butyl, tert-butyl, 2-pentyl, n-hexyl n-octyl, tert-octyl, 2-ethylhexyl, 2-hydroxyethyl, 1-hydroxyethyl, diethylaminoethyl, dibutylaminoethyl, n-butoxymethyl, methoxymethyl), a substituted or unsubstituted cyclic alkyl group having from 3 to 6 carbon atoms (e.g., cyclopropyl, cyclopentyl, cyclohexyl). The aryl group for them may be, for example, a substituted or unsubstituted aryl group having from 6 to 12 carbon atoms (e.g., unsubstituted phenyl, 2-methylphenyl).

The alkylene group may be, for example, a substituted or unsubstituted, linear or branched alkylene group having from 1 to 10 carbon atoms (e.g., methylene, ethylene, trimethylene, tetramethylene, methoxyethylene); and the arylene group may be, for example, a substituted or unsubstituted arylene group having from 6 to 12 carbon atoms (e.g., unsubstituted phenylene, 2-methylphenylene, naphthylene).

In formulae (A-1) and (A-2), the groups Y¹⁴ and Y^{14′} include, for example, an alkyl group (e.g., methyl, ethyl, isopropyl, n-propyl, n-butyl, 2-pentyl, n-hexyl, n-octyl, 2-ethylhexyl, 2-hydroxyethyl, n-butoxymethyl), COOH, a halogen atom (e.g., fluorine, chlorine, bromine), OH, N(CH₃)₂, NPh₂, OCH₃, OPh, SCH₃, SPh, CHO, COCH₃, COPh, COOC₄H₉, COOCH₃, CONHC₂H₅, CON(CH₃)₂, SO₃CH₃, SO₃C₃H₇, SO₂NHCH₃, SO₂N(CH₃)₂, SO₂C₂H₅, SOCH₃, CSPh, CSCH₃.

Ar¹ and Ar^{1′} in formulae (A-1) and (A-2) include, for example, a substituted or unsubstituted aryl group having from 6 to 12 carbon atoms (e.g., phenyl, 2-methylphenyl, naphthyl), and a substituted or unsubstituted heterocyclic group (e.g., pyridyl, 3-phenylpyridyl, piperidyl, morpholyl).

L² in formulae (A-1) and (A-2) include, for example, NH, NCH₃, NC₄H₉, NC₃H₇(i), NPh, NPh-CH₃, O, S, Se, Te.

The cyclic structure of formula (A-3) includes an unsaturated 5- to 7-membered ring and a hetero ring (e.g., furyl, piperidyl, morpholyl). Y¹², Y¹³, Y¹⁴, Ar¹, L², Y^{12′} Y^{13′} Y^{14′}, Ar^{1′} in formulae (A-1) and (A-2), and the cyclic structure of formula (A-3) may be substituted with any of the substituents Y.

Preferred examples of formulae (A-1), (A-2) and (A-3) are mentioned below.

Preferably in formulae (A-1) and (A-2), Y¹², Y^{12′} Y¹³ and Y^{13′} each independently represent a substituted or unsubstituted alkyl or alkylene group having from 1 to 6 carbon atoms, or a substituted or unsubstituted aryl group having from 6 to 10 carbon atoms; Y¹⁴ and Y^{14′} each are a substituted or unsubstituted alkyl group having from 1 to 6 carbon atoms, an amino group mono- or di-substituted with alkyl group(s) having from 1 to 4 carbon atoms, a carboxyl group, a halogen atom, or a carboxylate residue having from 1 to 4 carbon atoms; Ar¹ and Ar^{1′} each are a substituted or unsubstituted aryl group having from 6 to 10 carbon atoms; Q² and Q² each are O, S or Se; m³ and m⁴ each are 0 or 1; n⁴ falls between 1 and 3; and L² is an alkyl-substituted amino group having from 0 to 3 carbon atoms.

Preferably, the cyclic structure of formula (A-3) is a 5- to 7-membered hetero ring.

More preferably in formulae (A-1) and (A-2), Y¹², Y^{12′} Y¹³ and Y^{13′} each independently represent a substituted or unsubstituted alkyl or alkylene group having from 1 to 4 carbon atoms; Y⁴ and Y^{14′} each are an unsubstituted alkyl group having from 1 to 4 carbon atoms, or a monoamino-substituted or diamino-substituted alkyl group having from 1 to 4 carbon atoms; Ar¹ and Ar^{1′} each are a substituted or unsubstituted aryl group having from 6 to 10 carbon atoms; Q² and Q^{2′} each are O or S; m³ and m⁴ are both 0; n⁴ is 1; and L² is an alkyl-substituted amino group having from 0 to 3 carbon atoms.

Also more preferably, the cyclic structure of formula (A-3) is a 5- or 6-membered hetero ring.

In formula (I), when X is represented by any of formula (A-1) or (A-2), the moiety of A bonding to X or L is selected from Y¹², Y¹³, Ar¹, Y^{12′}, Y^{13′} and Ar^{1′}.

Examples of A in formula (I) are mentioned below, to which, however, A employable in the first embodiment of the invention is not limited.

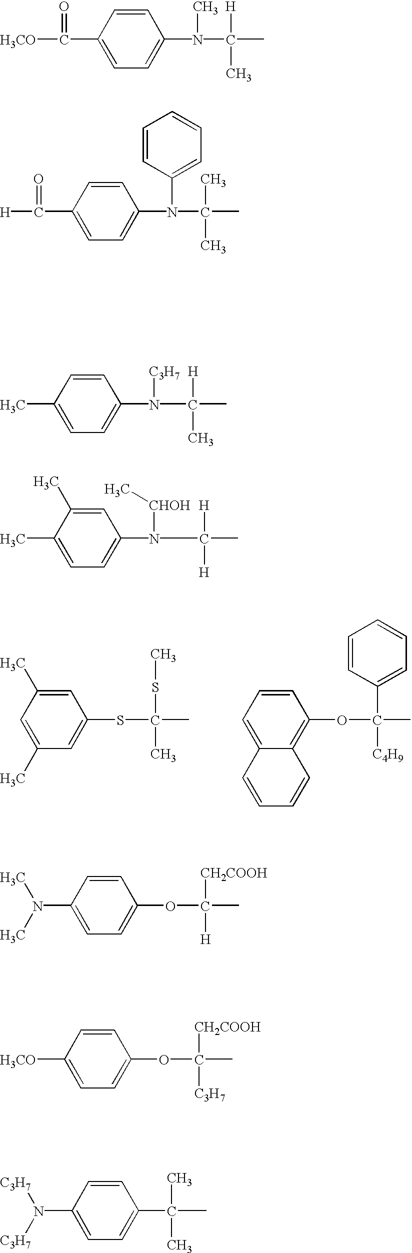

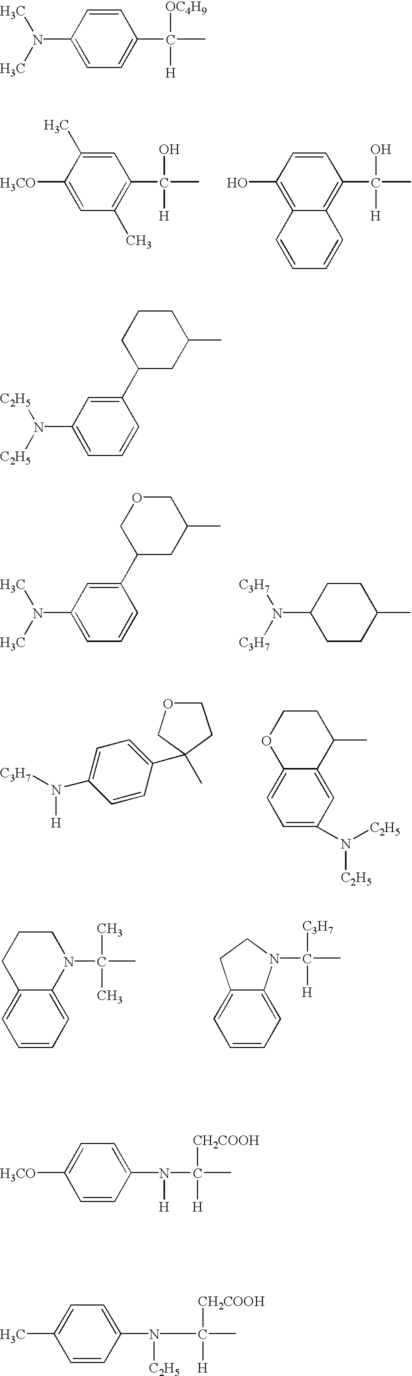

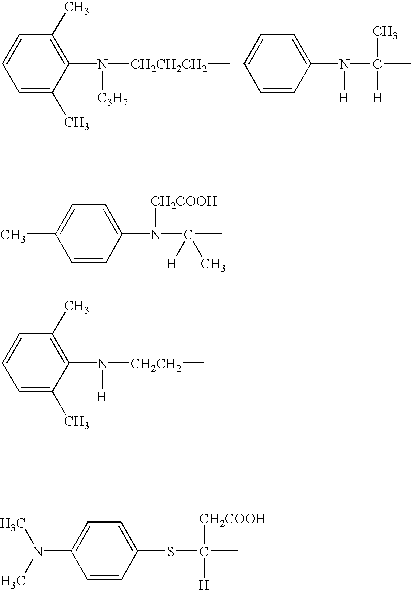

B in formula (I) is described in detail.

In case where B is a hydrogen atom, the compound of formula (I) is, after oxidized, deprotonated by the internal base to give a radical A•.

Preferably, B is a hydrogen atom or a group represented by any of the following general formulae (B-1), (B-2) and (B-3):

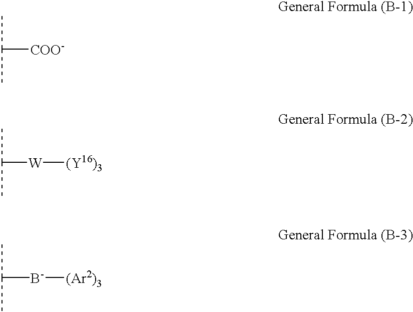

In formulae (B-1), (B-2) and (B-3), W represents Si, Sn or Ge; each Y¹⁶ independently represents an alkyl group; and each Ar² independently represents an aryl group.

The group of formula (B-2) or (B-3) may be bonded to the adsorbing group X in formula (I).

Formulae (B-1), (B-2) and (B-3) are described in detail. In these formulae, the alkyl group for Y¹⁶ includes, for example, a substituted or unsubstituted, linear or branched alkyl group having from 1 to 6 carbon atoms (e.g., methyl, ethyl, isopropyl, n-propyl, n-butyl, tert-butyl, 2-pentyl, n-hexyl, n-octyl, tert-octyl, 2-ethylhexyl, 2-hydroxyethyl, 1-hydroxyethyl, n-butoxyethyl, methoxymethyl), and a substituted or unsubstituted aryl group having from 6 to 12 carbon atoms (e.g., phenyl, 2-methylphenyl). Y¹⁶ and Ar² in formulae (B-1), (B-2) and (B-3) may be substituted with any of the substituents Y.

Preferred examples of formulae (B-1), (B-2) and (B-3) are mentioned below.

Preferably in formulae (B-2) and (B-3), Y¹⁶ is a substituted or unsubstituted alkyl group having from 1 to 4 carbon atoms; Ar² is a substituted or unsubstituted aryl group having from 6 to 10 carbon atoms; and W is Si or Sn.

More preferably in formulae (B-2) and (B-3), Y¹⁶ is a substituted or unsubstituted alkyl group having from 1 to 3 carbon atoms; Ar² is a substituted or unsubstituted aryl group having from 6 to 8 carbon atoms; and W is.

Of formulae (B-1), (B-2) and (B-3), most preferred are COO^{- of formula (B-}1), and Si—(Y16)₃ of formula (B-2).

Preferably in formula (1), n is 1.

Examples of (A—B) in formula (I) are mentioned below, to which, however, (A—B) employable in the first embodiment of the invention is not limited.

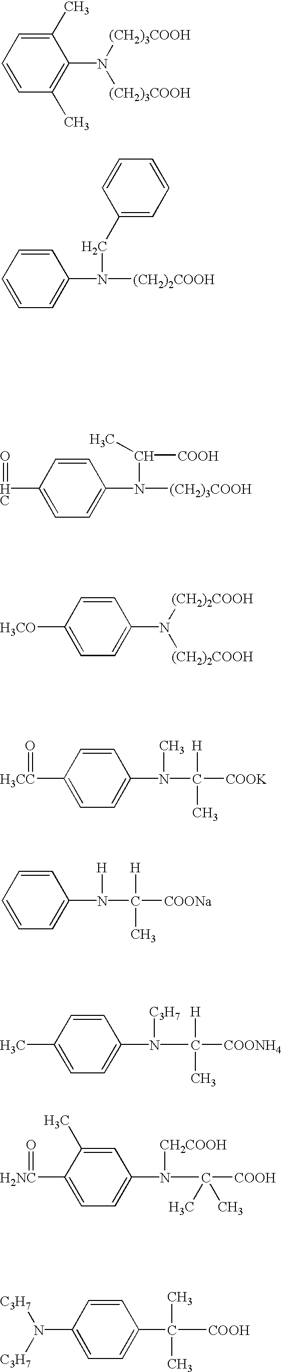

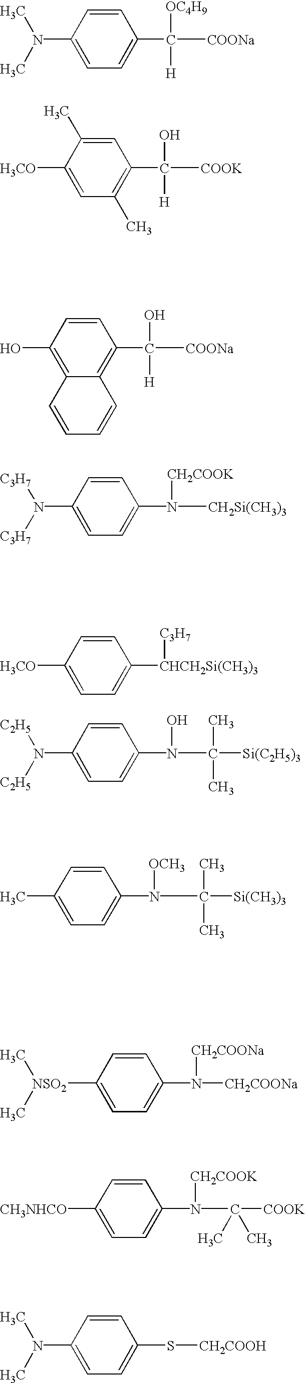

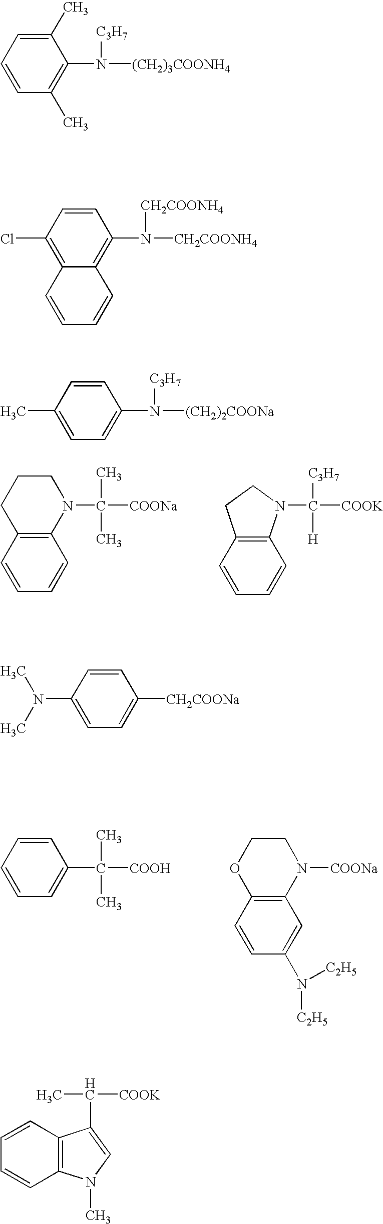

The counter ion necessary for the charge balance of (A—B) in formula (I) includes, for example, sodium, potassium, triethylammonium, diisopropylammonium, tetrabutylammonium and tetramethylguanidinium ions.

Preferably, the oxidation potential of (A—B) falls between 0 and 1.5 V, more preferably between 0 and 1.0 V, even more preferably between 0.3 and 1.0 V.

Also preferably, the oxidation potential of the radical A•(E₂) resulting from the bond cleavage reaction falls between −0.6 and −2.5 V, more preferably between −0.9 and −2 V, even more preferably between −0.9 and −1.6 V.

The oxidation potential may be measured as follows:

E¹ may be measured through cyclic voltammetry. Concretely, the electron donor A is dissolved in a solution of water 80%/20% (by volume) that contains acetonitrile/0.1 M lithium perchlorate. A glassy carbon disc is used for the working electrode; a platinum wire is for the counter electrode; and a saturated calomel electrode (SCE) is for the reference electrode. At 25° C., this is measured at a potential scanning speed of 0.1 V/sec. The ratio of oxidation potential/SCE is read at the peak of the cyclic voltammetric curve. The value El of the compound (A—B) is described in EP 93,731A1.

The oxidation potential of the radical is measured through transitional electrochemical and pulse-radiation decomposition. This is reported in J. Am. Chem. Soc., 1988, 110, 132; ibid., 1974, 96, 1287; and ibid., 1974, 96, 1295.

Examples of the compound of formula (I) are mentioned below, to which, however, the compounds employable in the first embodiment of the invention are not limited.

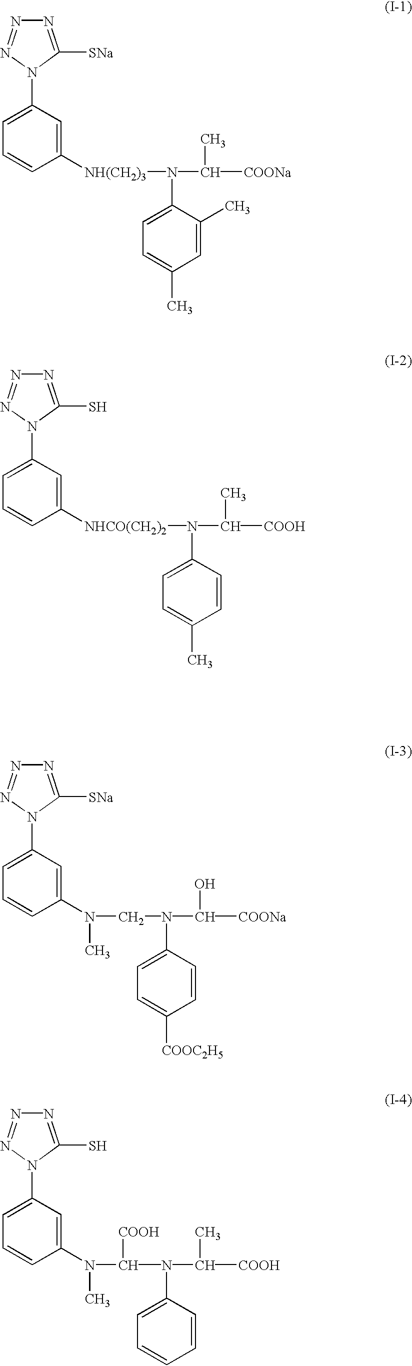

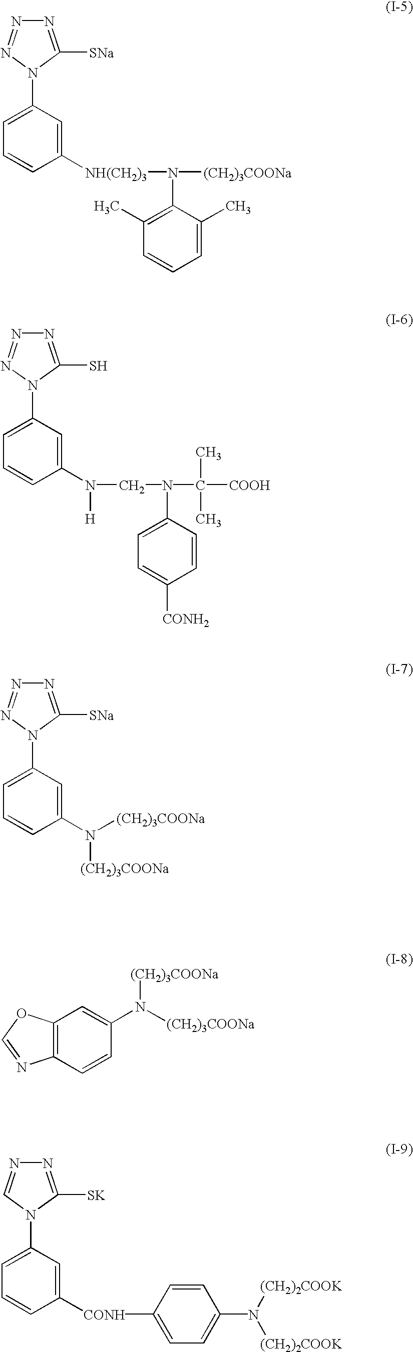

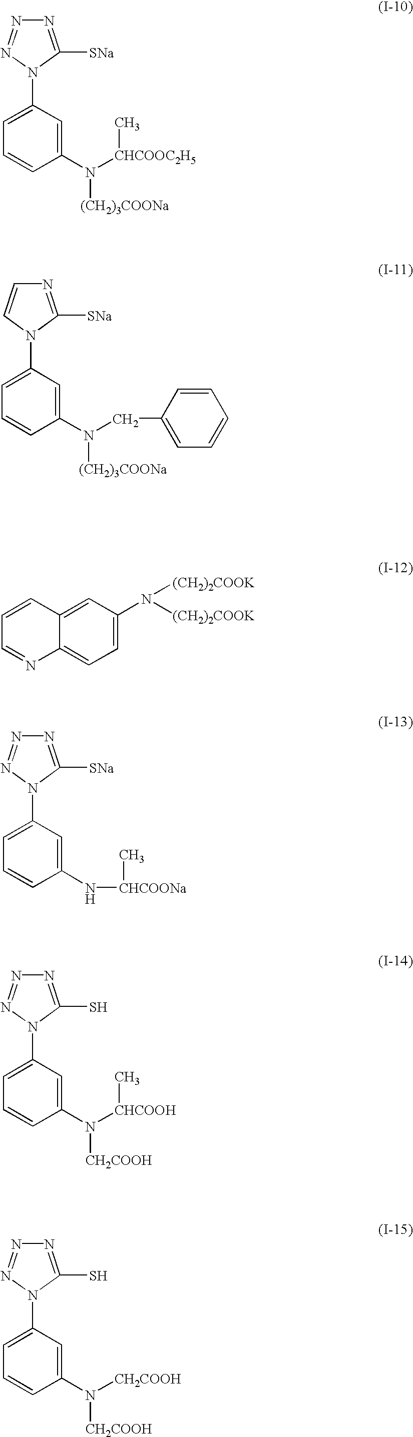

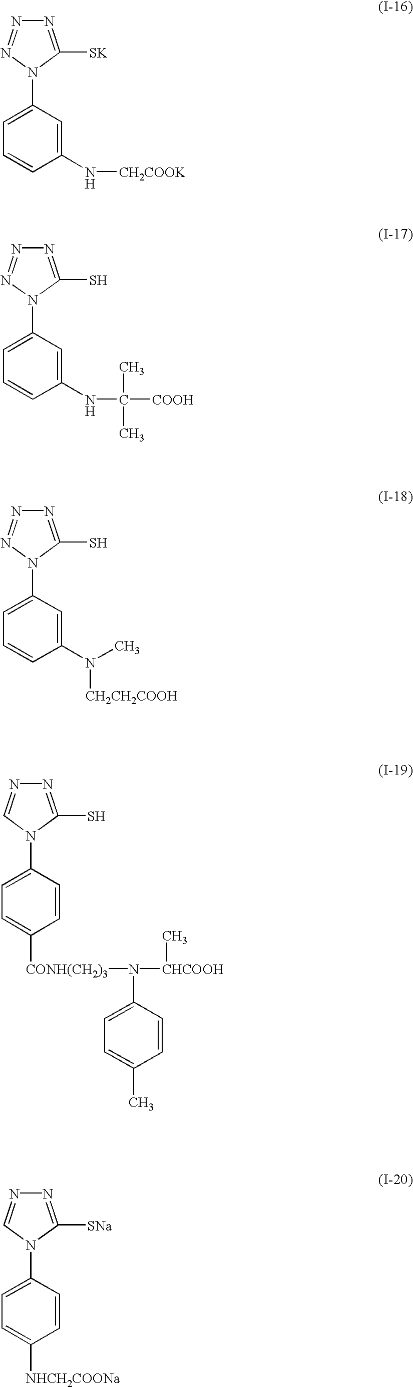

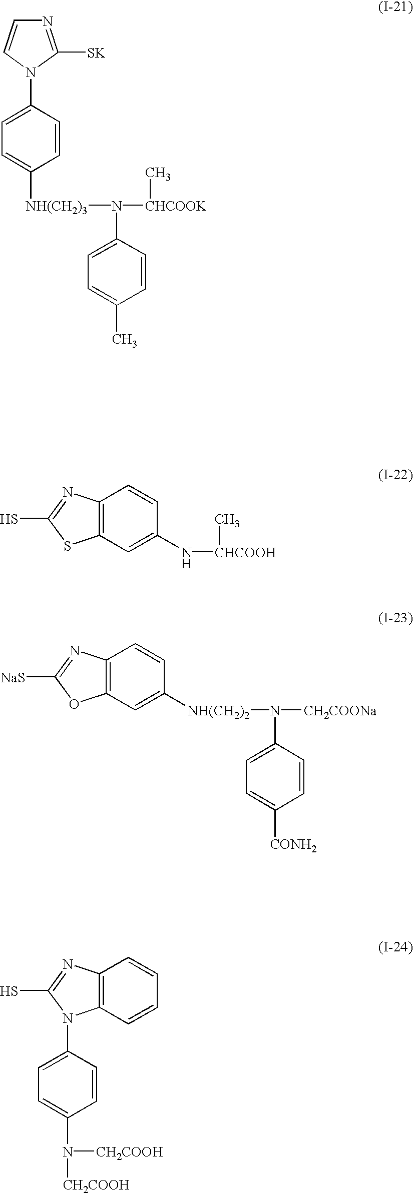

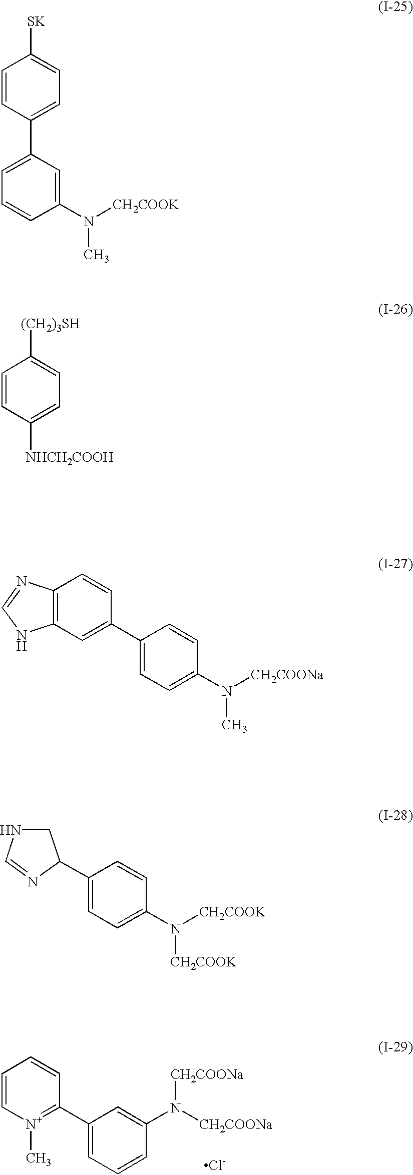

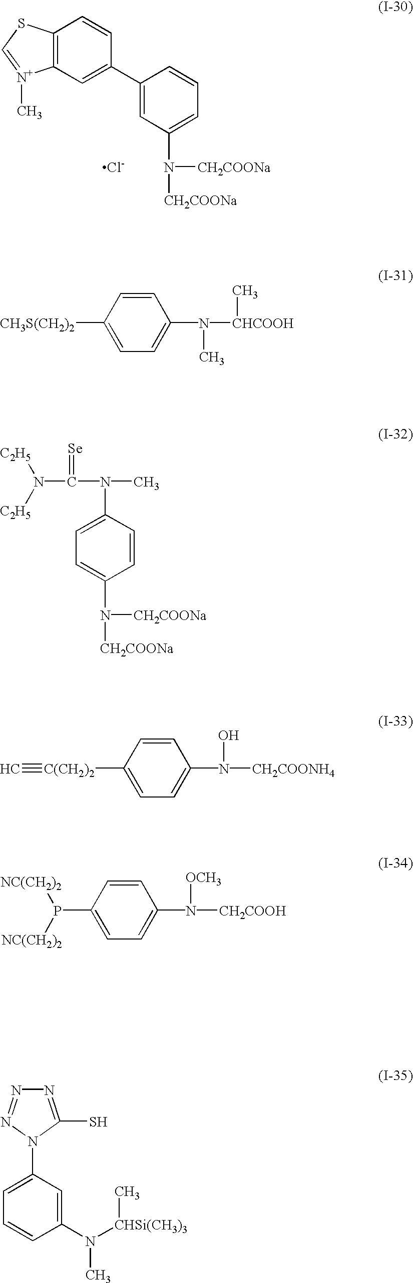

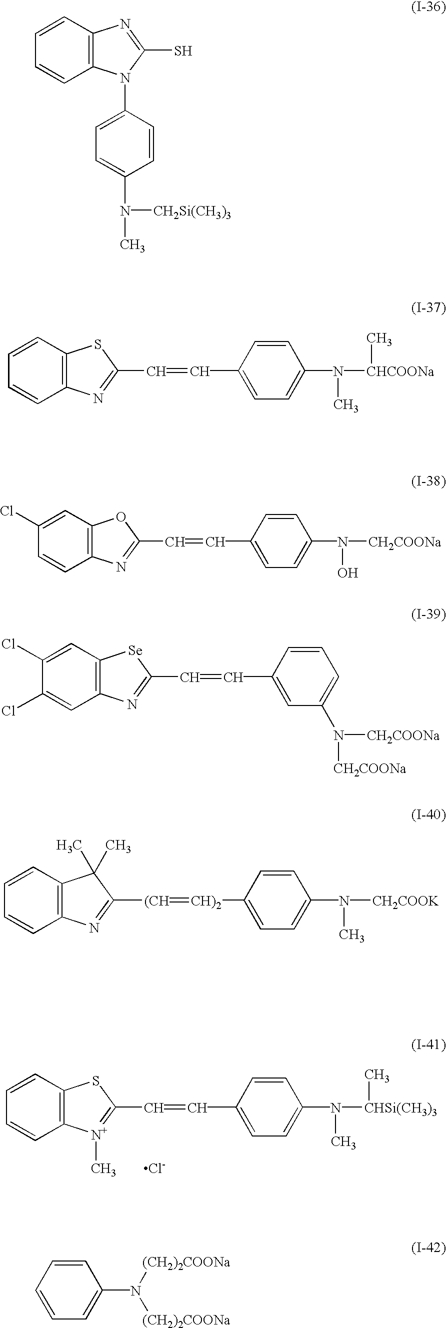

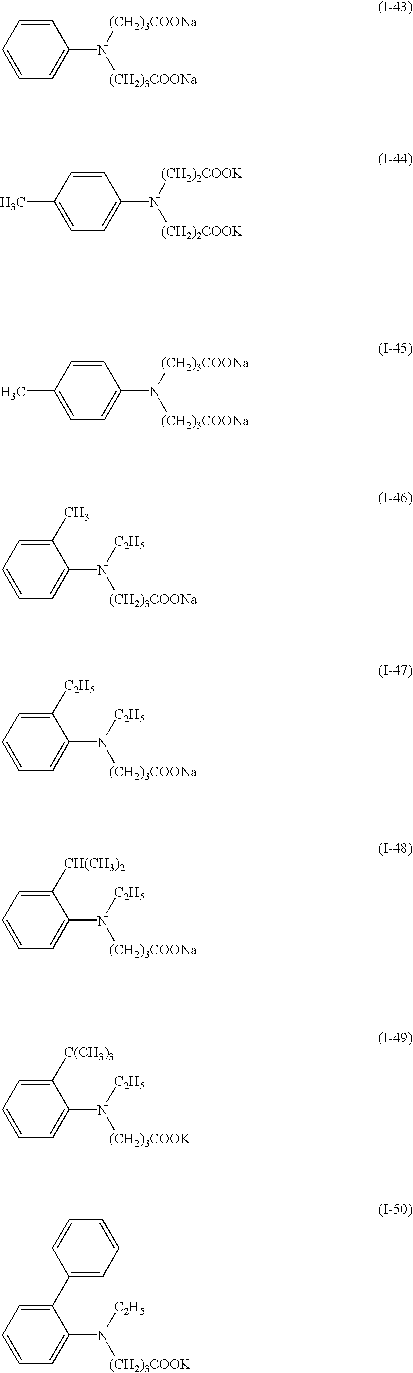

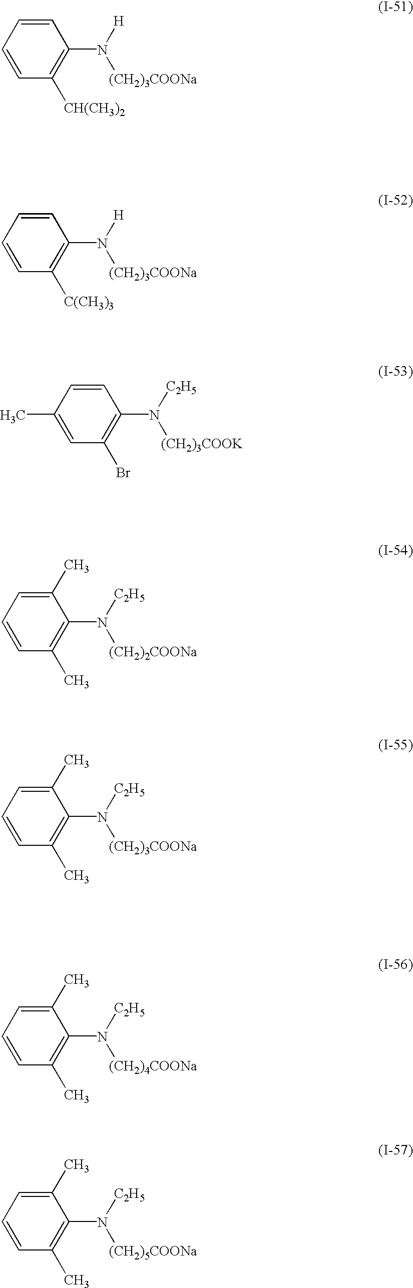

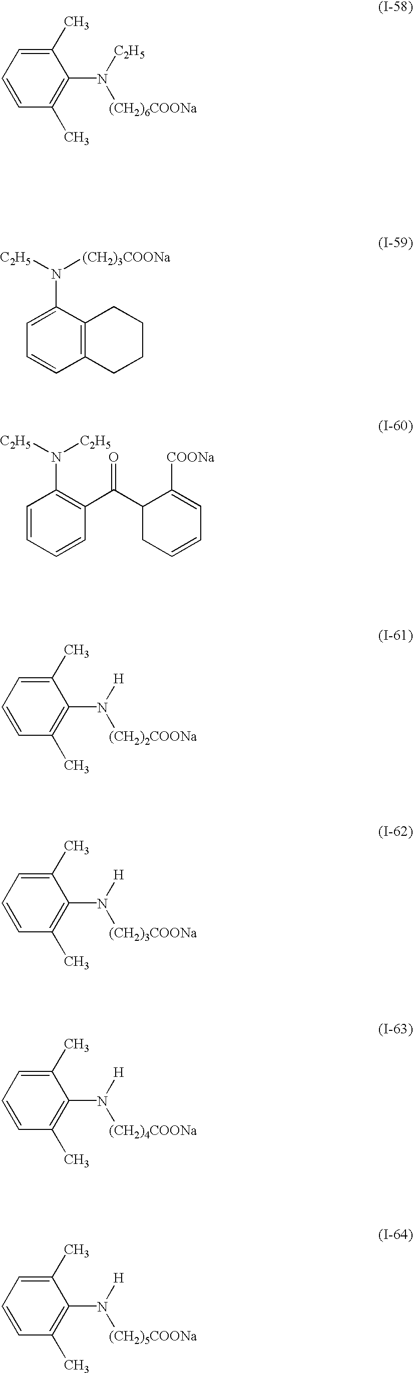

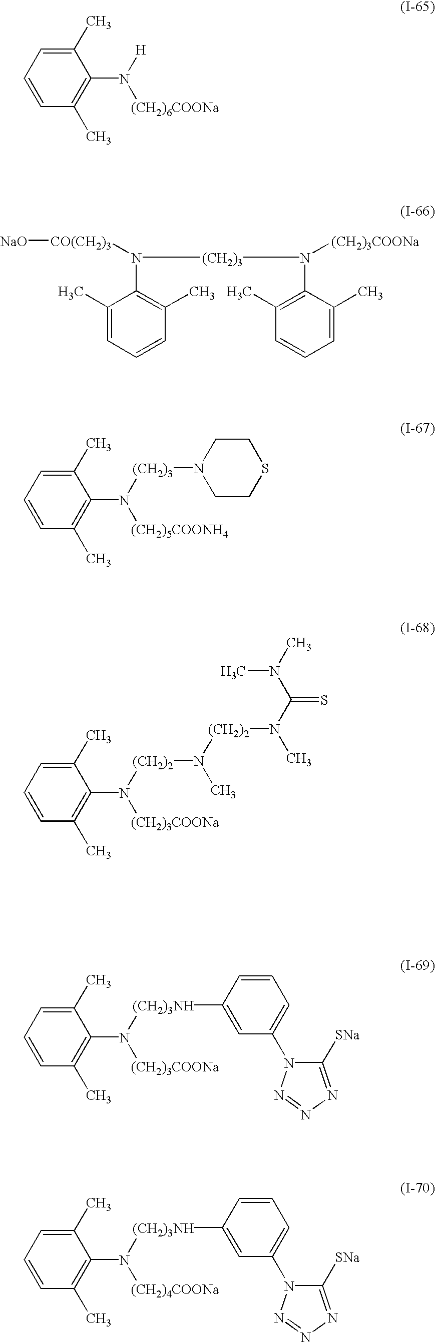

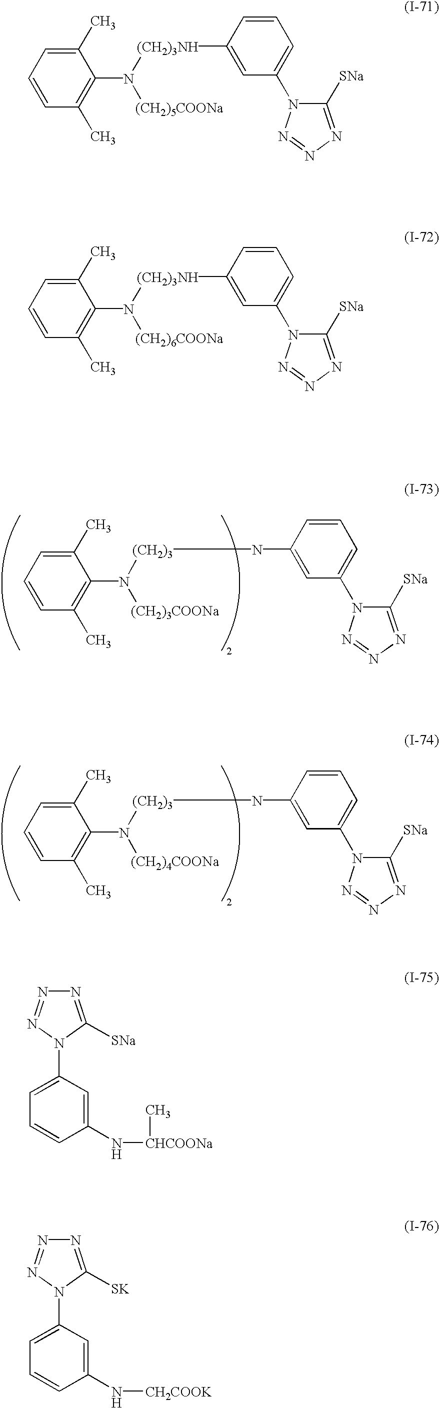

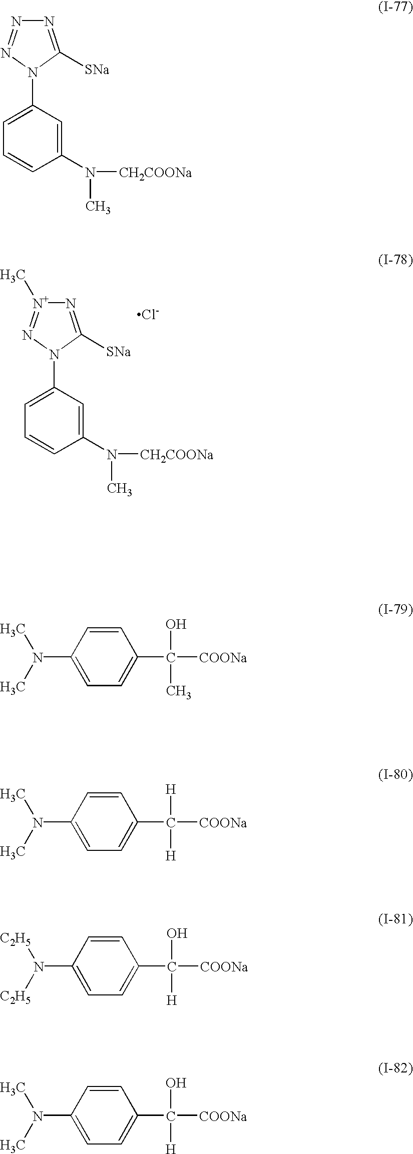

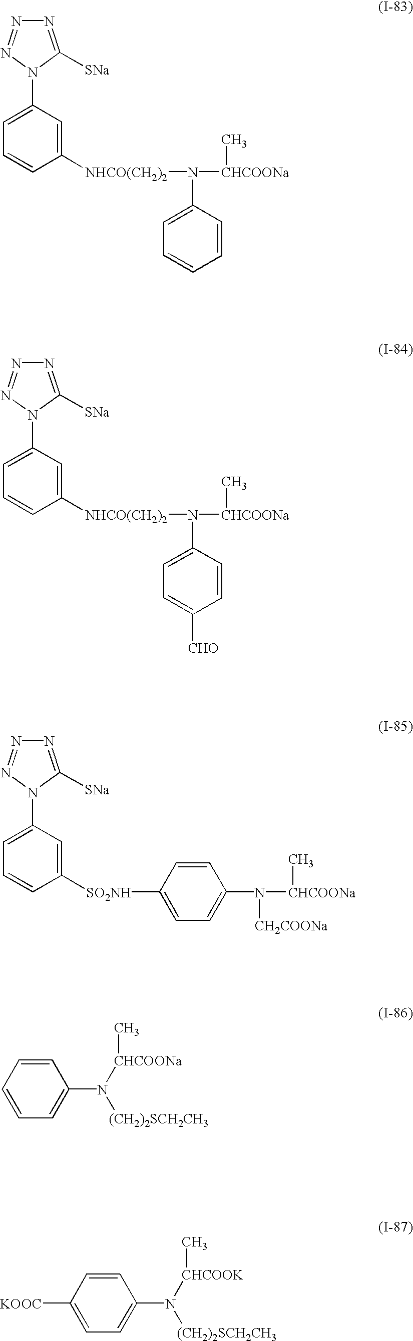

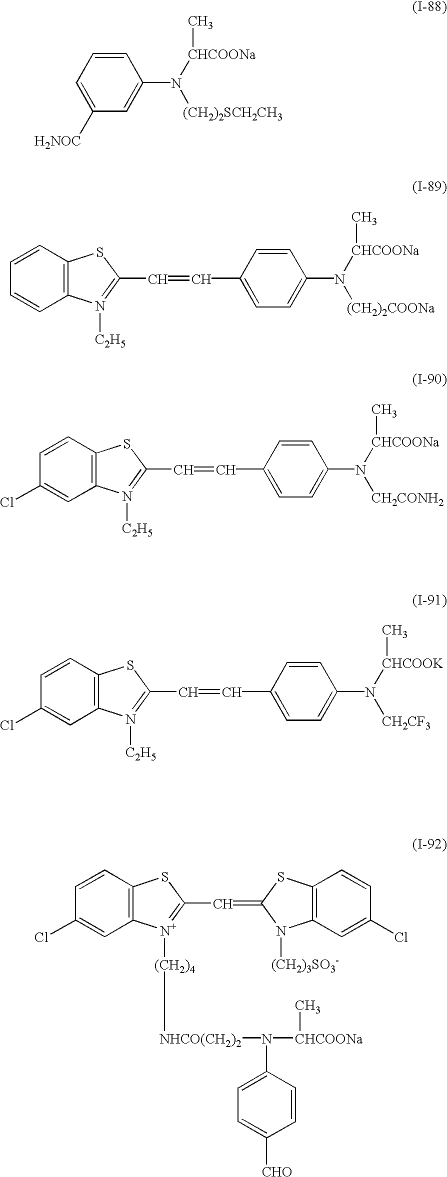

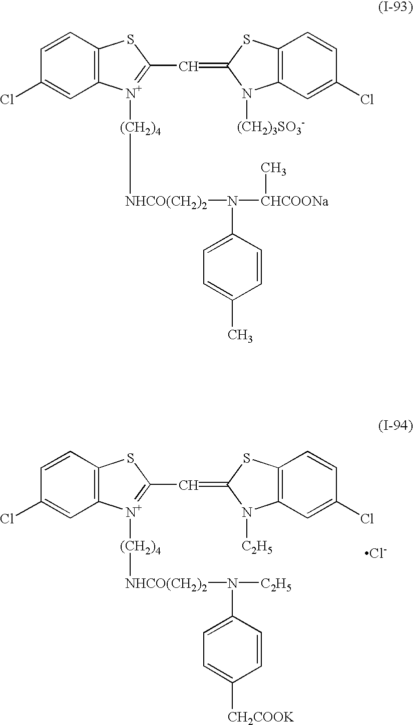

For their production, the compounds of formula (I) may be produced according to the methods described in, for example, U.S. Pat. Nos. 5,747,235, 5,747,235, EP 786,692A1, 893,731A1, 893,732A1, and WO99/05570, or according to those similar to the methods.

In producing the photothermographic material of the first embodiment of the invention, the compound of formula (I) may be added to the material in any stage, for example, while the coating emulsion for the material is prepared, or while the material is produced. Concretely, it may be added in any step of grain formation, de-salting or chemical sensitization, or even prior to emulsion coating. In these steps, the compound may be added twice or more.

Preferably, the compound of formula (I) is added, after dissolved in water or a water-soluble solvent such as methanol or ethanol or in a mixed solvent of these. In case where the compound is dissolved in water, the pH of the solution may be high for the compounds having a higher degree of solubility in water at a higher pH. In that case, however, the pH of the solution may be lowered for the compounds having a higher degree of solubility in water at a lower pH.

Preferably, the compound of formula (I) is in the image-forming layer (emulsion layer) of the photothermographic material. If desired, it may also be in the protective layer and/or the interlayer of the material so that the compound may diffuse in the image-forming layer while the layers are formed. The time for adding the compound of formula (I) is not specifically defined, irrespective of before and after addition of a sensitizing dye to the image-forming layer. Preferably, the compound of formula (I) is added to the silver halide-containing image-forming layer of the material, and its amount falls between 1×10⁻⁹ and 5×10⁻¹ mols, more preferably between 1×10⁻⁸ and 2×10⁻¹ mols per mol of the silver halide in the layer.

<Photosensitive Silver Halide>

The photosensitive silver halide for use in the first embodiment of the invention is described in detail.

<<Halogen Composition>>

Preferably, the mean silver iodide content of the photosensitive silver halide for use in the first embodiment of the invention falls between 5 and 100 mol %, more preferably between 10 and 100 mol %, even more preferably between 70 and 100 mol %, most preferably between 90 and 100 mol %.

Regarding the halogen composition distribution in each silver halide grain, the composition may be uniform throughout the grain, or may stepwise vary, or may continuously vary. Core/shell structured silver halide grains are also preferred for use herein. Preferably, the core/shell structure of the grains has from 2 to 5 layers, more preferably from 2 to 4 layers.

Solid solution of halogen compositions other than iodine is limited. However, the iodine content of core/shell structured silver halide grains as above or of conjugate structured silver halide grains can be controlled in any desired manner.

Preferably, the photosensitive silver halide in the first embodiment of the invention has a direct transition absorption derived from the silver iodide crystal structure therein, in a wavelength range of from 350 nm to 450 nm. Silver halides having such a direct transition for light absorption can be readily differentiated from any others by analyzing them as to whether to not they show an exciton absorption caused by their direction transition at around 400 nm to 430 nm.

The high silver iodide phase of such a type of direct transition light absorption may exist alone in the silver halide emulsion for use herein, but may be conjugated with any other silver halide phase having an indirect transition absorption in a wavelength range of from 350 nm to 450 nm, for example, with silver bromide, silver chloride, silver bromoiodide, silver chloroiodide or their mixed crystals. Any of these are preferred for use herein.

As so mentioned above, the silver halide grains for use herein may preferably have a core/shell structure. Also preferably, the grains may have an amorphous structure through iodine ion conversion.

In any case, it is desirable that the halogen composition of the silver halide grains has a total silver iodide content of from 5 to 100 mol %. More preferably, the silver iodide content of the grains falls between 10 and 100 mol %, even more preferably between 40 and 100 mol %, still more preferably between 70 and 100 mol %, most preferably between 90 and 100 mol %.

The silver halide phase of the type of direct transition light absorption generally absorbs much light, but as compared with other silver halide phases of the other type of indirect transition light absorption that absorb only a little light, its sensitivity is low and therefore its industrial use has not heretofore been taken into much consideration.

We, the present inventors have found that, when the silver halide phase of that type of direct transition light absorption is combined with at least one compound of formula (I), then its sensitivity is increased. On the basis of this finding, we have completed the first embodiment of the invention.

<<Grain Size>>

More preferably, the photosensitive silver halide in the first embodiment of the invention has a mean grain size of from 5 nm to 80 nm for more effectively attaining its effect. We, the present inventors have found that, especially when the silver halide grains having the phase that has a direct transition absorption have a grain size of not larger than 80 nm and are small, then their sensitivity is more increased.

Even more preferably, the mean grain size of the photosensitive silver halide falls between 5 nm and 70 nm, still more preferably between 10 nm and 50 nm. The grain size referred to herein is meant to indicate the diameter of the circular image having the same area as the projected area of each silver halide grain (for tabular grains, the main face of each grain is projected to determine the projected area of the grain). The data of all the silver halide grains thus analyzed are averaged to obtain the mean grain size thereof. The mean grain size may be hereinafter referred to simply as “grain size”.

<<Method of Forming Grains>>

Methods of forming the photosensitive silver halide are well known in the art, for example, as in Research Disclosure 17029 (June 1978), and U.S. Pat. No. 3,700,458, and any known method is employable in the invention. Concretely, a silver source compound and a halogen source compound are added to gelatin or any other polymer solution to prepare a photosensitive silver halide, and it is then mixed with an organic silver salt. This method is preferred for the invention. Also preferred are the method described in JP-A 119374/1999, paragraphs [0217] to [0244]; and the methods described in JP-A 11-352627 and 2000-347335.

<<Grain Morphology>>

Silver halide grains generally have different types of morphology, including, for example, cubic grains, octahedral grains, tabular grains, spherical grains, rod-like grains, and potato-like grains. In the first embodiment of the invention, cubic silver halide grains are especially preferred. Also preferred are corner-rounded silver halide grains. The surface index (Miller index) of the outer surface of the photosensitive silver halide grains for use herein is not specifically defined, but is desirably such that the proportion of {100} plane, which ensures higher spectral sensitization when it has adsorbed a color-sensitizing dye, in the outer surface is larger. Preferably, the proportion of {100} plane in the outer surface is at least 50%, more preferably at least 65%, even more preferably at least 80%. The Miller index indicated by the proportion of {100} plane can be identified according to the method described by T. Tani in J. Imaging Sci., 29, 165 (1985), based on the adsorption dependency of sensitizing dye onto {111} plane and {100} plane.

<<Heavy Metal>>

In the first embodiment of the invention, preferred are silver halide grains having a hexacyano-metal complex in their outermost surface. Preferred examples of the hexacyano-metal complex are [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻. Of those, hexacyano-Fe complexes are more preferred in the first embodiment of the invention.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions.

The hexacyano-metal complex may be added to silver halide grains in the form of a solution thereof in water or in a mixed solvent of water and an organic solvent miscible with water (for example, alcohols, ethers, glycols, ketones, esters, amides), or in the form of a mixture thereof with gelatin.

The amount of the hexacyano-metal complex to be added to the silver halide grains preferably falls between 1×10⁻⁵ mols and 1×10⁻² mols, per mol of silver of the grains, more preferably between 1×10⁻⁴ mols and 1×10⁻³ mols.

In order to make the hexacyano-metal complex exist in the outermost surfaces of the silver halide grains, the complex is added to an aqueous silver nitrate solution from which are formed the silver halide grains, after the solution has been added to a reaction system to give the grains but before the grains having been formed are finished for chemical sensitization such as chalcogen sensitization with sulfur, selenium or tellurium or noble metal sensitization with gold or the like, or is directly added to the grains while they are rinsed or dispersed but before they are finished for such chemical sensitization. To prevent the silver halide grains formed from growing too much, it is desirable that the hexacyano-metal metal complex is added to the grains immediately after they are formed. Preferably, the complex is added thereto before the grains formed are finished for post-treatment.

Adding the hexacyano-metal complex to the silver halide grains may be started after 96% by weight of the total of silver nitrate, from which are formed the grains, has been added to a reaction system to give the grains, but is preferably started after 98% by weight of silver nitride has been added thereto, more preferably after 99% by weight thereof has been added thereto.

The hexacyano-metal complex added to the silver halide grains after an aqueous solution of silver nitrate has been added to the reaction system to give the grains but just before the grains are completely formed is well adsorbed by the grains formed, and may well exist in the outermost surfaces of the grains. Most of the complex added in that manner forms a hardly-soluble salt with the silver ions existing in the surfaces of the grains. The silver salt of hexacyano-iron(II) is more hardly soluble than AgI, and the fine grains formed are prevented from re-dissolving and aggregating into large grains. Accordingly, the intended fine silver halide grains having a small grain size can be formed.

The photosensitive silver halide grains for use in the first embodiment of the invention may contain a metal or metal complex of Groups 8 to 10 of the Periodic Table (including Groups 1 to 18). The metal of Groups 8 to 10, or the center metal of the metal complex is preferably rhodium, ruthenium or iridium. In this embodiment, one metal complex may be used alone, or two or more metal complexes of one and the same type of metal or different types of metals may also be used as combined. The metal or metal complex content of the grains preferably falls between 1×10⁻⁹ mols and 1×10⁻³ mols per mol of silver of the grains. Such heavy metals and metal complexes, and methods of adding them to the silver halide grains are described in, for example, JP-A 7-225449, JP-A 11-65021, paragraphs [0018] to [0024], and JP-A 11-119374, paragraphs [0227] to [0240].

The metal atoms (e.g., in [Fe(CN)₆]⁴⁻) that may be added to the silver halide grains for use in the first embodiment of the invention, as well as the methods of desalting or chemical sensitization of the silver halide emulsions are described, for example, in JP-A 11-84574, paragraphs [0046] to [0050], JP-A 11-65021, paragraphs [0025] to [0031], and JP-A 11-119374, paragraphs [0242] to [0250].

<<Gelatin>>

Gelatin of different types may be used in preparing the photosensitive silver halide emulsions for use in the first embodiment of the invention. For better dispersion of the photosensitive silver halide emulsion in an organic silver salt-containing coating liquid in producing the photothermographic material of the invention, preferred is low-molecular gelatin having a molecular weight of from 500 to 60,000. The low-molecular gelatin of the type may be used in forming the silver halide grains or in dispersing the grains after the grains have been desalted. Preferably, it is used in dispersing the grains after they have been desalted.

<<Sensitizing Dye>>

The photothermographic material of the first embodiment of the invention may contain a sensitizing dye. Usable herein are sensitizing dyes which, after adsorbed by the silver halide grains, can spectrally sensitize the grains within a desired wavelength range. Depending on the spectral characteristics of the light source to be used for exposure, favorable sensitizing dyes having good spectral sensitivity are selected for use in the photothermographic material. For the details of sensitizing dyes usable herein and methods for adding them to the photothermographic material, referred to are paragraphs [0103] to [0109] in JP-A 11-65021; compounds of formula (II) in JP-A 10-186572; dyes of formula (I) and paragraph [0106] in JP-A 11-119374; dyes described in U.S. Pat. Nos. 5,510,236, 3,871,887 (Example 5); dyes described in JP-A 2-96131,59-48753; from page 19, line 38 to page 20, line 35 in EP Laid-Open 0803764A1; Japanese Patent Application Nos. 2000-86865, 2000-102560 and 2000-205399. One or more such sensitizing dyes may be used herein either singly or as combined. Regarding the time at which the sensitizing dye is added to the silver halide emulsion in the invention, it is desirable that the sensitizing dye is added thereto after the desalting step but before the coating step, more preferably after the desalting step but before the chemical ripening step.

The amount of the sensitizing dye to be in the photothermographic material of the first embodiment of the invention varies, depending on the sensitivity and the fogging resistance of the material. In general, it preferably falls between 10⁻⁶ and 1 mol, more preferably between 10⁻⁴ and 10⁻¹ mols, per mol of the silver halide in the image-forming layer of the material.

For its better spectral sensitization, the photothermographic material of the first embodiment of the invention may contain a supersensitizer. For the supersensitizer, for example, usable are the compounds described in EP Laid-Open 587,338, U.S. Pat. Nos. 3,877,943, 4,873,184, and JP-A 5-341432, 11-109547 and 10-111543.

<<Chemical Sensitization>>

Preferably, the photosensitive silver halide grains for use in the first embodiment of the invention are chemically sensitized with, for example, sulfur, selenium or tellurium. For such sulfur, selenium or tellurium sensitization, any known compounds are usable. For example, preferred are the compounds described in JP-A 7-128768. The grains for use in the first embodiment of the invention are especially preferably sensitized with tellurium, for which more preferred are the compounds described in JP-A 11-65021, paragraph [0030], and the compounds of formulae (II), (III) and (IV) given in JP-A 5-313284.

Preferably, the photosensitive silver halide grains for use in the first embodiment of the invention are chemically sensitized with gold alone or with gold combined with chalcogen. Gold in the gold sensitizer for them preferably has a valence of +1 or +3. Any ordinary gold compounds for gold sensitization are usable herein. Preferred examples of the gold sensitizer for use herein are chloroauric acid, bromoauric acid, potassium chloroaurate, potassium bromoaurate, auric trichloride, potassium auric thiocyanate, potassium iodoaurate, tetracyanoauric acid, ammonium aurothiocyanate, pyridyltrichlorogold. Also preferred for use herein are the gold sensitizers described in U.S. Pat. No. 5,858,637, and Japanese Patent Application No. 2001-79450.

In the first embodiment of the invention, the photosensitive silver halide grains may be chemically sensitized in any stage after their formation but before their coating. For example, they may be chemically sensitized after desalted, but (1) before spectral sensitization, or (2) along with spectral sensitization, or (3) after spectral sensitization, or (4) just before coating.

The amount of the sulfur, selenium or tellurium sensitizer for such chemical sensitization in the first embodiment of the invention varies, depending on the type of the silver halide grains to be sensitized therewith and the condition for chemically ripening the grains, but may fall generally between 10⁻⁸ and 10⁻² mols, preferably between 10⁻⁷ and 10⁻³ mols or so, per mol of the silver halide.

The amount of the gold sensitizer to be added to the silver halide grains also varies depending on various conditions. In general, it may fall between 10⁻⁷ and 10⁻³ mols, preferably between 10⁻⁶ and 5×10⁻⁴ mols, per mol of the silver halide.

Though not specifically defined, the condition for chemical sensitization in the first embodiment of the invention may be such that the pH falls between 5 and 8, the pAg falls between 6 and 11, and the temperature falls between 40 and 95° C. or so.

If desired, a thiosulfonic acid compound may be added to the silver halide emulsions for use in the first embodiment of the invention, according to the method described in EP Laid-Open 293,917.

Preferably, the photosensitive silver halide grains in the first embodiment of the invention are processed with a reducing agent. Concretely, preferred examples of compounds for such reduction sensitization are ascorbic acid, thiourea dioxide, as well as stannous chloride, aminoimimomethanesulfinic acid, hydrazine derivatives, borane compounds, silane compounds and polyamine compounds. The reduction sensitizer may be added to the grains in any stage of preparing the photosensitive emulsions including the stage of grain growth to just before coating the emulsions. Preferably, the emulsions are subjected to such reduction sensitization while they are kept ripened at a pH of 7 or more and at a pAg of 8.3 or less. Also preferably, they may be subjected to reduction sensitization while the grains are formed with a single addition part of silver ions being introduced thereinto.

The photothermographic material of the first embodiment of the invention may contain only one type or two or more different types of photosensitive silver halide grains (these will differ in their mean grain size, halogen composition or crystal habit, or in the condition for their chemical sensitization), either singly or as combined. Combining two or more types of photosensitive silver halide grains differing in their sensitivity will enable to control the gradation of the images to be formed in the photothermographic material.

For the technique relating to it, referred to are JP-A 57-119341, 53-106125, 47-3929, 48-55730, 46-5187, 50-73627, 57-150841. The sensitivity difference between the combined silver halide grains is preferably such that the respective emulsions differ from each other at least by 0.2 logE.

<<Amount of Silver Halide in Photothermographic Material>>

The amount of the photosensitive silver halide to be in the photothermographic material of this embodiment is, in terms of the amount of silver per m² of the material, preferably from 0.03 to 0.6 g/m², more preferably from 0.07 to 0.4 g/m², most preferably from 0.05 to 0.3 g/m². Relative to one mol of the organic silver salt therein, the amount of the photosensitive silver halide grains to be in the material preferably falls between 0.01 mols and 0.3 mols, more preferably between 0.02 mols and 0.2 mols, even more preferably between 0.03 mols and 0.15 mols.

<<Mode of Mixing Photosensitive Silver Halide and Organic Silver Salt>>

Regarding the method and the condition for mixing the photosensitive silver halide grains and an organic silver salt having been prepared separately, for example, employable is a method of mixing them in a high-performance stirrer, a ball mill, a sand mill, a colloid mill, a shaking mill, a homogenizer or the like; or a method of adding the photosensitive silver halide grains having been prepared to the organic silver salt being prepared, in any desired timing to produce the organic silver salt mixed with the silver halide grains.

Preferably, the silver halide for use in the first embodiment of the invention is formed in the absence of the organic silver salt as in the manner as above. Mixing two or more different types of aqueous, organic silver salt dispersions with two or more different types of aqueous, photosensitive silver salt dispersions is also preferred for suitably controlling the photographic properties of the photothermographic material of this embodiment.

<<Mode of Mixing Photosensitive Silver Halide in Coating Liquid>>

The preferred time at which the silver halide grains are added to the coating liquid which is to form the image-forming layer on the support of the photothermographic material of the first embodiment of the invention may fall between 180 minutes before coating the liquid and a time just before the coating, more preferably between 60 minutes before the coating and 10 seconds before it. However, there is no specific limitation thereon, so far as the method and the condition employed for adding the grains to the coating liquid ensure the advantages of the first embodiment of the invention.

Concretely for mixing them, employable is a method of adding the grains to the coating liquid in a tank in such a controlled manner that the mean residence time for the grains in the tank, as calculated from the amount of the grains added and the flow rate of the coating liquid to a coater, could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<<Gradation and Mean Contrast>>

The image gradation of the photothermographic material is not specifically defined, but is preferably such that the mean contrast of the images formed on the material to have a density of from 1.5 to 3.0 falls between 1.5 and 10, in order that the material produces better results of this embodiment.

The mean image contrast referred to herein is represented by the degree of inclination of the line drawn to connect the optical density 1.5 and the optical density 3.0 on the characteristic curve in a graph that indicates the image characteristic of the processed photothermographic material. In the graph, the horizontal axis indicates the logarithmic number of the amount of laser to which the material is exposed for image formation, and the vertical axis indicates the optical density of the image formed on the laser-exposed and thermally-developed material.

Preferably, the mean image contrast falls between 1.5 and 10 for sharp letters and images, more preferably between 2.0 and 7, even more preferably between 2.5 and 6.

<Non-photosensitive Organic Silver Salt>

The organic silver salt for use in the first embodiment of the invention is relatively stable to light, but, when heated at 80° C. or higher in the presence of an exposed photocatalyst (e.g., latent image of photosensitive silver halide) and a reducing agent, it forms a silver image. The organic silver salt may be any and every organic substance that contains a source having the ability to reduce silver ions.

Some non-photosensitive organic silver salts of that type are described, for example, in JP-A 10-62899, paragraphs [0048] to [0049]; EP Laid-Open 0803764A1, from page 18, line 24 to page 19, line 37; EP Laid-Open 0962812A1; JP-A 11-349591, 2000-7683, 2000-72711. Preferred for use herein are silver salts of organic acids, especially silver salts of long-chain (C10 to C30, preferably C15 to C28) aliphatic carboxylic acids. Preferred examples of silver salts of such fatty acids are silver behenate, silver arachidate, silver stearate, silver oleate, silver laurate, silver caproate, silver myristate, silver palmitate, and their mixtures.

Of those, especially preferred for use in the first embodiment of the invention are silver salts of fatty acids having a silver behenate content of at least 50 mol %, more preferably at least 80 mol %, even more preferably at least 90 mol %.

The organic silver salt for use in the first embodiment of the invention is not specifically defined for its morphology, and may be in any form of acicular, rod-like, tabular or scaly solids.

Scaly organic silver salts are preferred in the first embodiment of the invention. Also preferred are short acicular grains having a ratio of major axis to minor axis of at most 5, or rectangular-parallelepiped or cubic grains, or amorphous grains such as potato-like grains. These organic silver grains are characterized in that they are fogged little through thermal development as compared with long acicular grains having a ratio of major axis to minor axis of more than 5.

In this description, the scaly organic silver salts are defined as follows: A sample of an organic silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average)≧1.5 are scaly. For scaly grains, preferably, 30≧x (average)≧1.5, more preferably 20≧x (average)≧2.0. In this connection, the value x of acicular (needle-like) grains falls within a range of 1≦x (average)≦1.5.

In the scaly grains, it is understood that a corresponds to the thickness of tabular grains of which the main plane is represented by b×c. In the scaly organic silver salt grains for use herein, a (average) preferably falls between 0.01 μm and 0.23 μm, more preferably between 0.1 μm and 0.20 μm; and c/b (average) preferably falls between 1 and 6, more preferably between 1.05 and 4, even more preferably between 1.1 and 3, still more preferably between 1.1 and 2.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its morphology, a dispersion of the organic silver salt may be analyzed on its image taken by the use of a transmission electronic microscope.

Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%.

Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained.

For preparing and dispersing the organic silver salts for use in the first embodiment of the invention, employable is any known method. For it, for example, referred to are JP-A 10-62899; EP Laid-Open 0803763A1 and 962812A1; JP-A 11-349591, 2000-7683, 2000-72711; and Japanese Patent Application Nos. 11-348228, 11-348229, 11-348230, 11-203413, 2000-90093, 2000-195621, 2000-191226, 2000-213813, 2000-214155, 2000-191226.

It is desirable that the organic silver salt is dispersed substantially in the absence of a photosensitive silver salt, since the photosensitive silver salt, if any in the dispersing system, will be fogged and its sensitivity will be significantly lowered.

For the photothermographic material of the first embodiment of the invention, it is desirable that the amount of the photosensitive silver salt that may be in the aqueous dispersion of the organic silver salt is at most 0.1 mol % relative to one mol of the organic silver salt therein, and it is more desirable that any photosensitive silver salt is not forcedly added to the aqueous dispersion.

In the first embodiment of the invention, an aqueous dispersion of the organic silver salt may be mixed with an aqueous dispersion of the photosensitive silver salt to prepare the photothermographic material. The blend ratio of the organic silver salt to the photosensitive silver salt in the mixture may be suitably determined depending on the object of the invention. Preferably, the blend ratio of the photosensitive silver salt to the organic silver salt in the mixture falls between 1 and 30 mol %, more preferably between 2 and 20 mol %, even more preferably between 3 and 15 mol %.

Mixing two or more different types of aqueous, organic silver salt dispersions with two or more different types of aqueous, photosensitive silver salt dispersions is preferred for controlling the photographic properties of the resulting mixture.

The amount of the organic silver salt to be in the photothermographic material of the first embodiment of the invention is not specifically defined, and may be any desired one. Preferably, the amount of the salt falls between 0.1 and 5 g/m², more preferably between 0.3 and 3 g/m², even more preferably between 0.5 and 2 g/m² in terms of the amount of silver in the salt.

<Reducing Agent>

The photothermographic material of the first embodiment of the invention preferably contains a thermal developing agent that serves as a reducing agent for the organic silver salt therein. The reducing agent for the organic silver salt may be any and every substance capable of reducing silver ions into metal silver, but is preferably an organic substance.

Some examples of the reducing agent are described in JP-A 11-65021, paragraphs [0043] to [0045], and in EP Laid-Open 0803764A 1, from page 7, line 34 to page 18, line 12.

Especially preferred for the reducing agent in the first embodiment of the invention are hindered phenol-type reducing agents and bisphenol-type reducing agents that have an ortho-positioned substituent relative to the phenolic hydroxyl group therein, and more preferred are compounds of the following general formula (R):

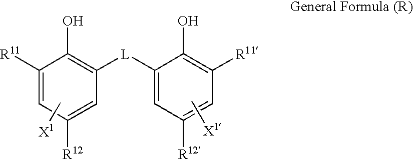

In formula (R), R¹¹ and R^{11′} each independently represent an alkyl group having from 1 to 20 carbon atoms; R¹² and R^{12 ′} each independently represent a hydrogen atom, or a substituent substitutable to the benzene ring; L represents —S— or —CHR¹³—; R¹³ represents a hydrogen atom, or an alkyl group having from 1 to 20 carbon atoms; X¹ and X^{1′} each independently represent a hydrogen atom, or a substituent substitutable to the benzene ring.

Formula (R) is described in detail.

R¹¹ and R^{11′} each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, an ureido group, an urethane group, and a halogen atom.

R¹² and R^{12′} each independently represent a hydrogen atom, or a substituent substitutable to the benzene ring; X¹ and X^{1′} each independently represent a hydrogen atom, or a substituent substitutable to the benzene ring. Preferred examples of the substituent substitutable to the benzene ring are an alkyl group, an aryl group, a halogen atom, an alkoxy group, and an acylamino group.

L represents a group of —S— or —CHR¹³—. R¹³ represents a hydrogen atom or an alkyl group having from 1 to 20 carbon atoms. The alkyl group may be substituted.

Specific examples of the unsubstituted alkyl group for R¹³ are methyl, ethyl, propyl, butyl, heptyl, undecyl, isopropyl, 1-ethylpentyl and 2,4,4-trimethylpentyl groups. For the substituent for the substituted alkyl group for it, referred to are those mentioned hereinabove for the substituted alkyl group for R¹¹.

For R¹¹ and R^{11′}, preferred is a secondary or tertiary alkyl group having from 3 to 15 carbon atoms. Concretely, preferred examples of the alkyl group are isopropyl, isobutyl, t-butyl, t-amyl, t-octyl, cyclohexyl, cyclopentyl, 1-methylcyclohexyl and 1-methylcyclopropyl groups.

For R¹¹ and R^{11′}, more preferred is a tertiary alkyl group having from 4 to 12 carbon atoms; even more preferred is any of t-butyl, t-amyl and 1-methylcycohexyl groups; and most preferred is a t-butyl group.

Preferably, R¹² and R^{12′} each are an alkyl group having from 1 to 20 carbon atoms, concretely including, for example, methyl, ethyl, propyl, butyl, isopropyl, tert-butyl, tert-amyl, cyclohexyl, 1-methylcyclohexyl, benzyl, methoxymethyl and methoxyethyl groups. For these, more preferred are methyl, ethyl, propyl, isopropyl and tert-butyl groups.

Also preferably, X¹ and X^{1′} each are a hydrogen atom, a halogen atom or an alkyl group; and more preferably, they are both hydrogen atoms.

L is preferably —CHR¹³—.

Also preferably, R¹³ is a hydrogen atom, or an alkyl group having from 1 to 15 carbon atoms. Preferred examples of the alkyl group are methyl, ethyl, propyl, isopropyl and 2,4,4-trimethylpentyl groups. More preferably, R¹³ is a hydrogen atom, a methyl group, an ethyl group, a propyl group or an isopropyl group.

In case where R¹³ is a hydrogen atom, R¹² and R^{12′} each are preferably an alkyl group having from 2 to 5 carbon atoms, more preferably an ethyl or propyl group, most preferably, they are both ethyl groups.

In case where R¹³ is a primary or secondary alkyl group having from 1 to 8 carbon atoms, R¹² and R^{12′} are preferably both methyl groups. The primary or secondary alkyl group having from 1 to 8 carbon atoms for R¹³ is preferably a methyl, ethyl, propyl or isopropyl group, more preferably a methyl, ethyl or propyl group.

In case where R¹¹,R^{11′}, R¹² and R^{12′} are all methyl groups, R¹³ is preferably a secondary alkyl group. The secondary alkyl group for R¹³ is preferably an isopropyl, isobutyl or 1-ethylpentyl group, more preferably an isopropyl group.

Depending on the combination of R¹¹,R^{11′}, R¹², R^{12′} and R¹³ therein, the reducing agents differ in their thermal developability and in the tone of developed silver. Combining two or more different types of reducing agents enables to control the developability and the developed silver tone. Depending on their object, therefore, combining them will be preferred in the invention.

Examples of the compounds of formula (R) and other reducing agents for use in the first embodiment of the invention are mentioned below, to which, however, the invention of this embodiment is not limited.

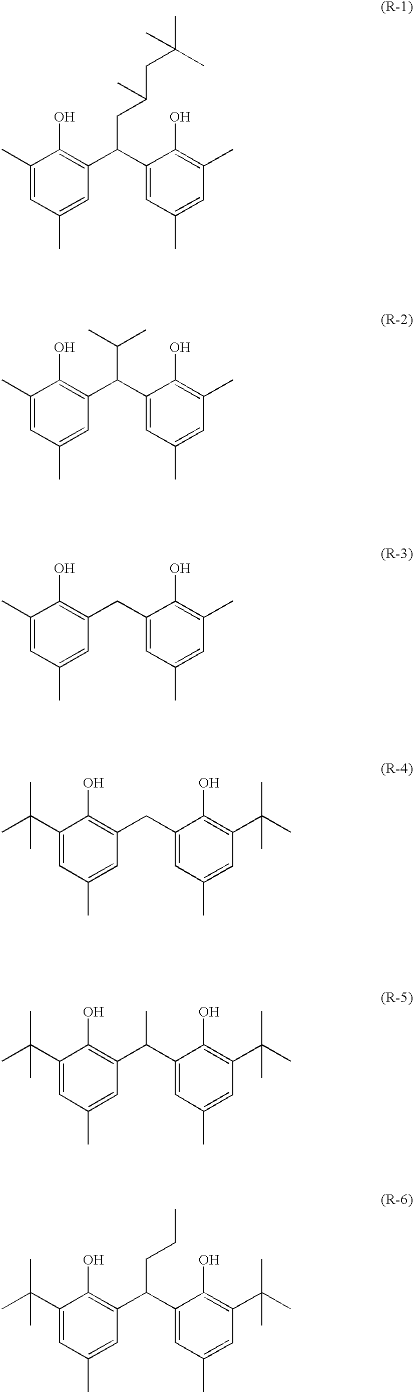

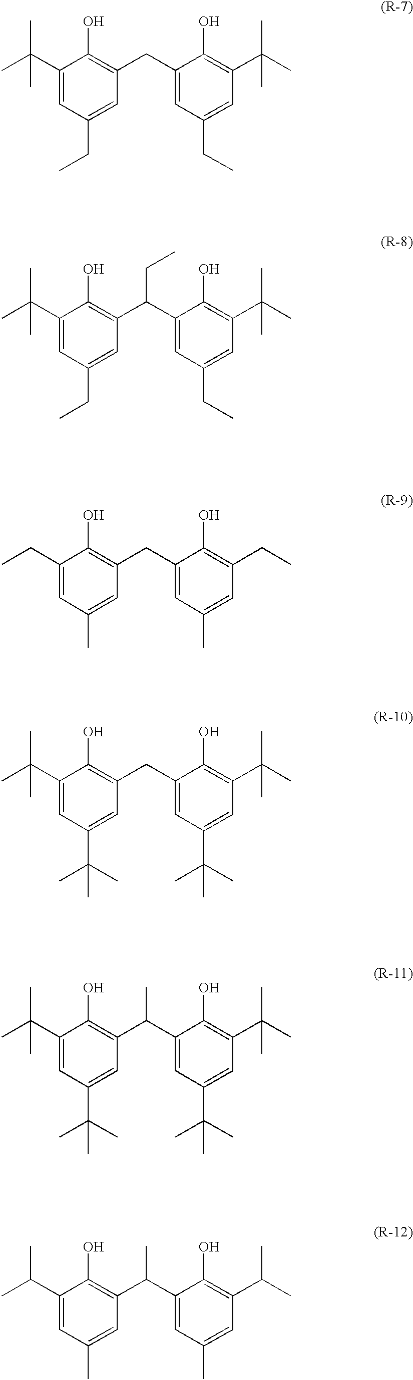

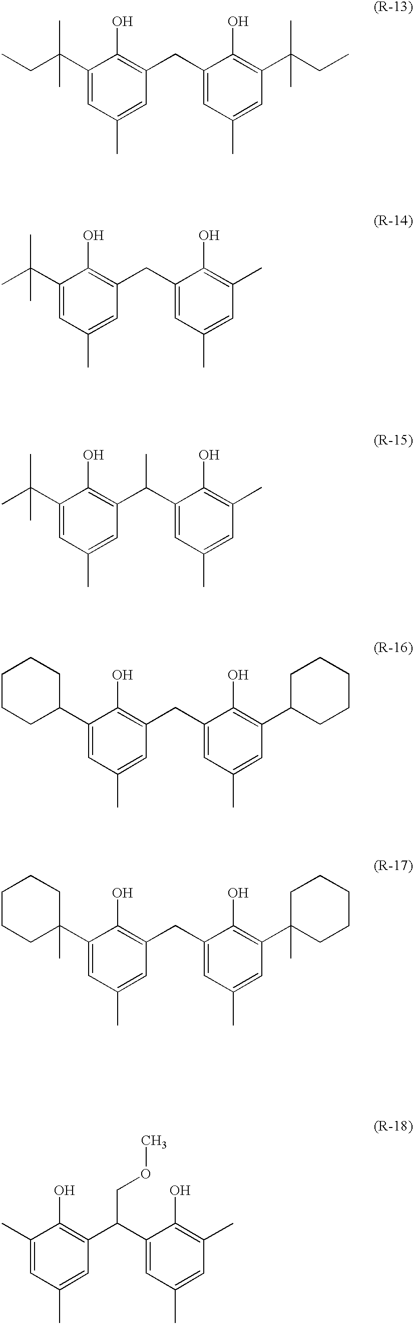

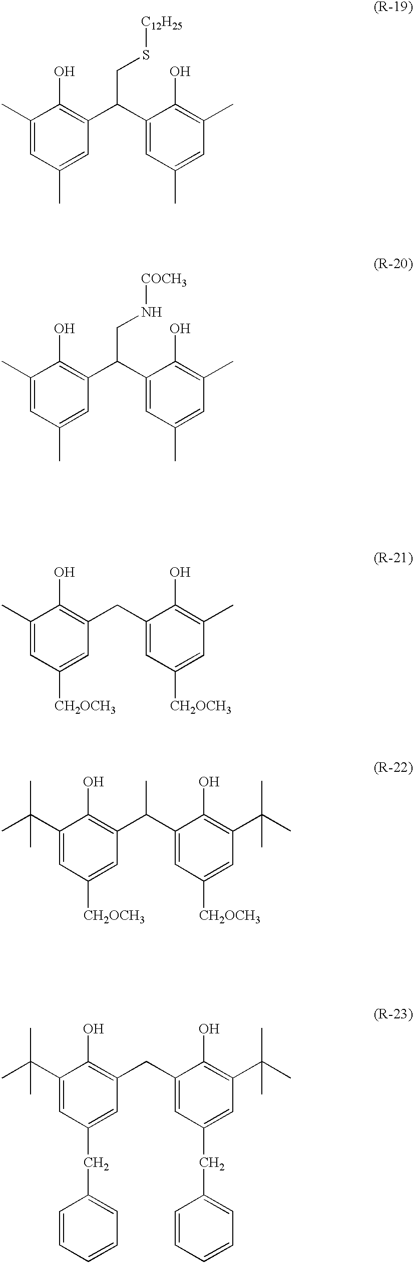

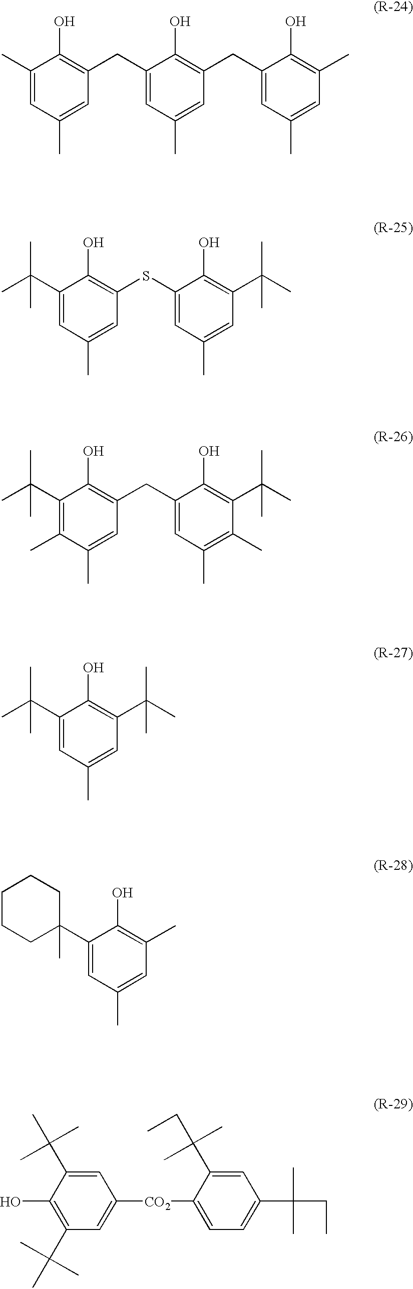

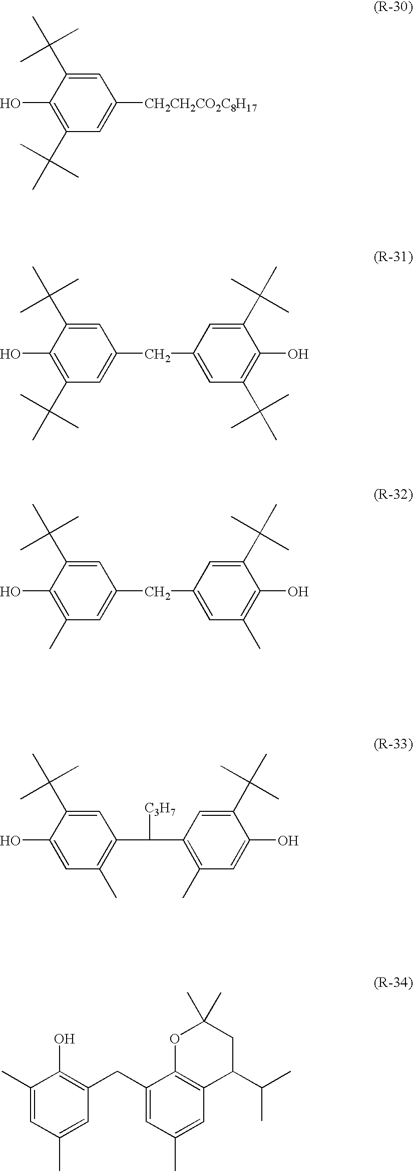

Preferably, the amount of the reducing agent to be in the photothermographic material of the first embodiment of the invention falls between 0.1 and 3.0 g/m², more preferably between 0.2 and 1.5 g/m², even more preferably between 0.3 and 1.0 g/m².

Also preferably, the amount of the reducing agent to be in the material falls between 5 and 50 mol %, more preferably between 8 and 30 mol %, even more preferably between 10 and 20 mol % per mol of silver existing in the face of the image-forming layer of the material.

The reducing agent may be in any form of solution, emulsified dispersion or fine solid particle dispersion, and may be added to the coating liquid in any known method so as to be incorporated into the photothermographic material of the invention.

One well known method of emulsifying the reducing agent to prepare its dispersion comprises dissolving the reducing agent in an auxiliary solvent such dibutyl phthalate, tricresyl phosphate, glyceryl triacetate, diethyl phthalate or the like oily solvent, or in ethyl acetate or cyclohexanone, followed by mechanically emulsifying it into a dispersion.

For preparing a fine solid particle dispersion of the reducing agent, for example, employable is a method that comprises dispersing a powder of the reducing agent in water or in any other suitable solvent by the use of a ball mill, a colloid mill, a shaking ball mill, a sand mill, a jet mill or a roller mill, or ultrasonically dispersing it therein to thereby prepare the intended solid dispersion of the reducing agent. In this method, optionally used is a protective colloid (e.g., polyvinyl alcohol), and a surfactant (e.g., anionic surfactant such as sodium triisopropylnaphthalenesulfonate—this is a mixture of the salts in which the three isopropyl groups are all in different positions). In these mills, generally used are beads of zirconia or the like that serve as a dispersion medium. Zr or the like may dissolve out of the beads and will often contaminate the dispersion formed. Though varying depending on the dispersion condition, the contaminant content of the dispersion formed may generally fall between 1 ppm and 1000 ppm. So far as the Zr content of the photothermographic material finally fabricated herein is not larger than 0.5 mg per gram of silver in the material, the contaminant will cause no practical problem.

Preferably, the aqueous dispersion contains a preservative (e.g., sodium benzoisothiazolinone).

<Development Accelerator>

Preferably, the photothermographic material of the first embodiment of the invention contains a development accelerator. Preferred examples of the development accelerator are sulfonamidophenol compounds of formula (A) in JP-A 2000-267222 and 2000-330234; hindered phenol compounds of formula (II) in JP-A 2001-92075; compounds of formula (I) in JP-A 10-62895 and 11-15116; hydrazine compounds of formula (I) in Japanese Patent Application No. 2001-074278; and phenol or naphthol compounds of formula (2) in Japanese Patent Application No. 2000-76240. The amount of the development accelerator to be in the material may fall between 0.1 and 20 mol %, but preferably between 0.5 and 10 mol %, more preferably between 1 and 5 mol % relative to the reducing agent therein. The development accelerator may be introduced into the material like the reducing agent thereinto. Preferably, however, it is added to the material in the form of its solid dispersion or emulsified dispersion. In case where it is added to the material in the form of its emulsified dispersion, the emulsified dispersion thereof is preferably prepared by emulsifying and dispersing the development accelerator in a mixed solvent of a high-boiling point solvent that is solid at room temperature and an auxiliary solvent having a low boiling point; or the emulsified dispersion is preferably an oilless dispersion with no high-boiling-point solvent therein.

Of the development accelerators mentioned above, especially preferred for use in the first embodiment of the invention are hydrazine compounds of formula (I) described in Japanese Patent Application No. 2001-074278, and phenol or naphthol compounds of formula (2) described in Japanese Patent Application No. 2000-76240.

Preferred examples of the development accelerators for use in the first embodiment of the invention are mentioned below, to which, however, this embodiment is not limited.

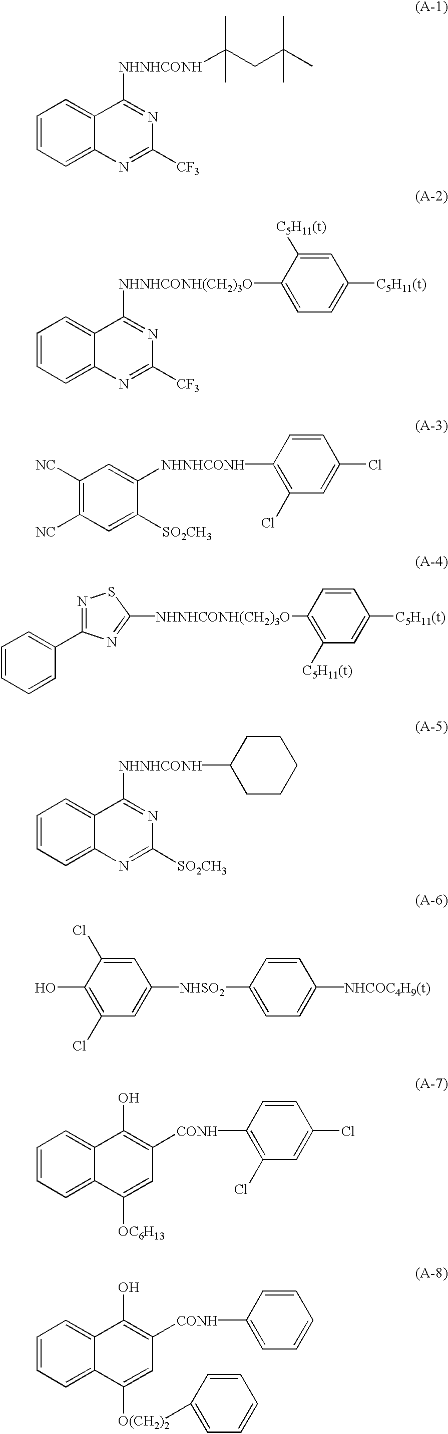

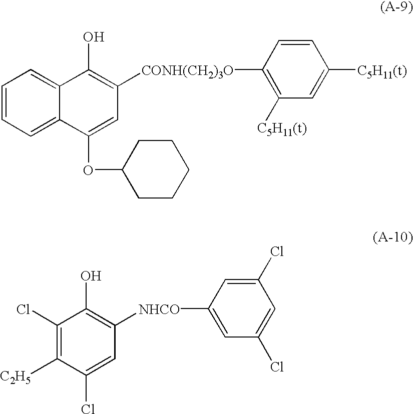

<Hydrogen Bonding Type Compound>

A Hydrogen bonding type compound may be in the photothermographic material of the first embodiment of the invention, and the compound is described.

In case where the reducing agent in the first embodiment of the invention has an aromatic hydroxyl group (—OH), especially when it is any of the above-mentioned bisphenols, the reducing agent is preferably combined with a non-reducing compound that has a group capable of forming a hydrogen bond with the group in the reducing agent.

The group capable of forming a hydrogen bond with the hydroxyl group or the amino group in the reducing agent includes, for example, a phosphoryl group, a sulfoxide group, a sulfonyl group, a carbonyl group, an amido group, an ester group, an urethane group, an ureido group, a tertiary amino group, and a nitrogen-containing aromatic group.

Of those, preferred are a phosphoryl group, a sulfoxide group, an amido group (not having a group of >N—H but is blocked to form >N—Ra, in which Ra is a substituent except H), an urethane group (not having a group of >N—H but is blocked to form >N—Ra, in which Ra is a substituent except H), an ureido group (not having a group of >N—H but is blocked to form >N—Ra, in which Ra is a substituent except H).

Especially preferred examples of the Hydrogen bonding type compound for use in the first embodiment of the invention are those of the following general formula (D):

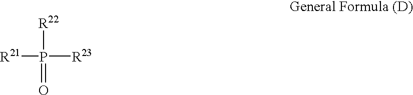

In formula (D), R²¹ to R²³ each independently represent an alkyl group, an aryl group, an alkoxy group, an aryloxy group, an amino group or a heterocyclic group. These may be unsubstituted or substituted.

The substituents for the substituted groups for R²¹ to R²³ are, for example, a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. Of the substituents, preferred are an alkyl group and an aryl group; and more preferred are methyl, ethyl, isopropyl, t-butyl, t-octyl, phenyl, 4-alkoxyphenyl and 4-acyloxyphenyl groups.

The alkyl group for R²¹ to R²³ includes, for example, methyl, ethyl, butyl, octyl, dodecyl, isopropyl, t-butyl, t-amyl, t-octyl, cyclohexyl, 1-methylcyclohexyl, benzyl, phenethyl and 2-phenoxypropyl groups.

The aryl group for these includes, for example, phenyl, cresyl, xylyl, naphthyl, 4-t-butylphenyl, 4-t-octylphenyl, 4-anisidyl and 3,5-dichlorophenyl groups.

The alkoxy group for these includes, for example, methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups.

The aryloxy group for these includes, for example, phenoxy, cresyloxy, isopropylphenoxy, 4-t-butylphenoxy, naphthoxy and biphenyloxy groups. The amino group for these includes, for example, dimethylamino, diethylamino, dibutylamino, dioctylamino, N-methyl-N-hexylamino, dicyclohexylamino, diphenylamino and N-methyl-N-phenylamino groups.

For R²¹ to R²³, preferred are an alkyl group, an aryl group, an alkoxy group and an aryloxy group. From the viewpoint of the advantages of the first embodiment of the invention, it is preferable that at least one of R²¹ to R²³ is an alkyl group or an aryl group, and it is more desirable that at least two of them are any of an alkyl group and an aryl group. Even more preferably, R²¹ to R²³ are the same as the compounds of the type are inexpensive.

Specific examples of the compounds of formula (D) and other Hydrogen bonding type compounds usable in the first embodiment of the invention are mentioned below, to which, however, this embodiment is not limited.

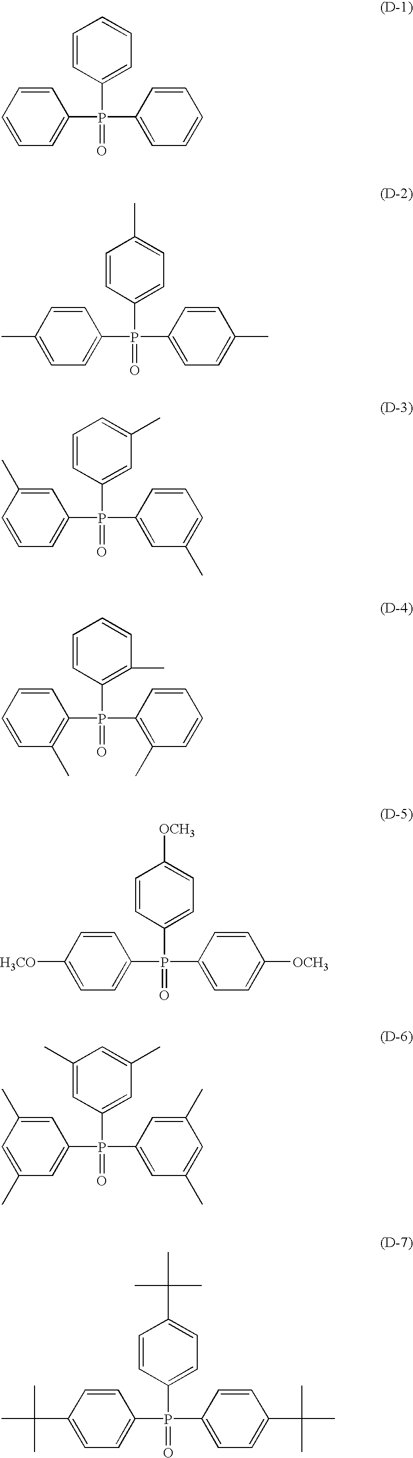

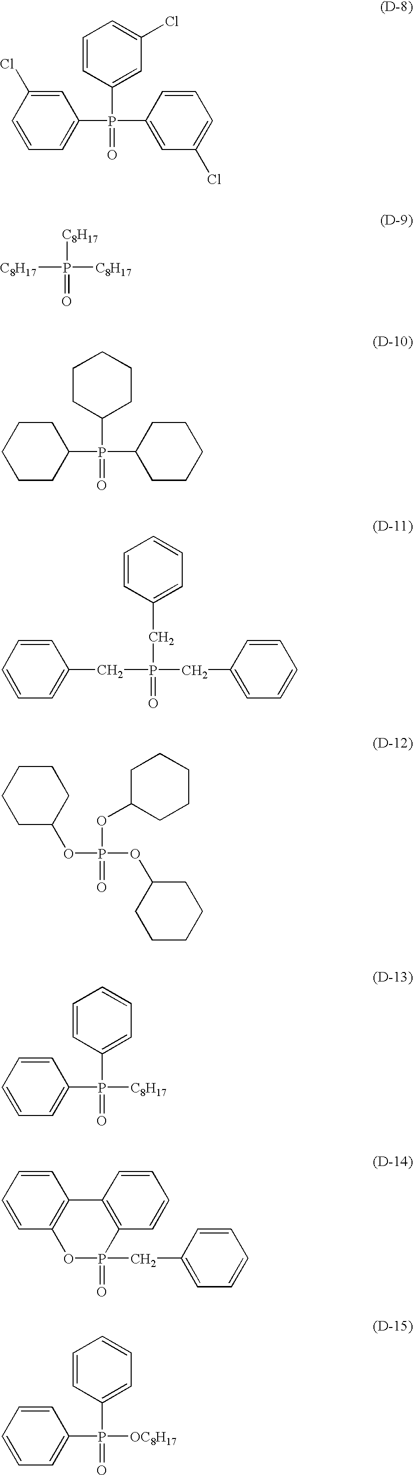

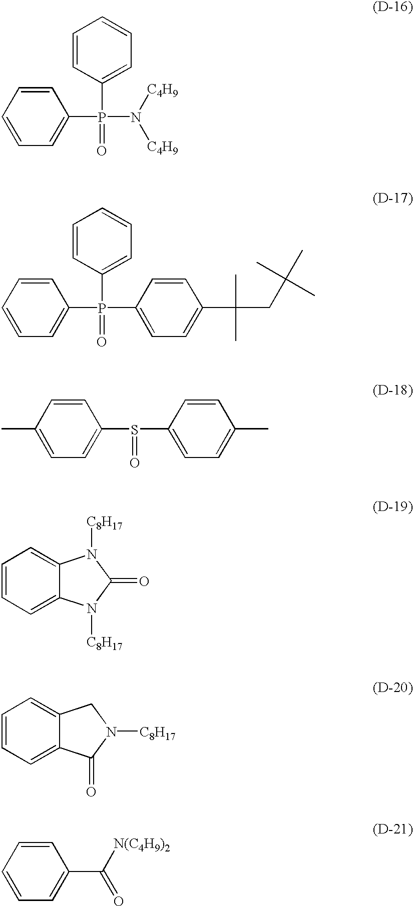

Apart from the above, other Hydrogen bonding type compounds such as those described in EP 1096310 and in Japanese Patent Application Nos. 2000-270498 and 2001-124796 are also usable herein.

Like the reducing agent mentioned above, the compound of formula (D) may be added to the coating liquid for the photothermographic material of the first embodiment of the invention, for example, in the form of its solution, emulsified dispersion or solid particle dispersion. In its solution, the compound of formula (D) may form a hydrogen-bonding complex with a compound having a phenolic hydroxyl group or an amino group. Depending on the combination of the reducing agent and the compound of formula (D) for use herein, the complex may be isolated as its crystal. Thus isolated, the crystal powder may be formed into its solid particle dispersion, and the dispersion is especially preferred for use herein for stabilizing the photothermographic material of the first embodiment of the invention. As the case may be, the reducing agent and the compound of formula (D) may be mixed both in powder optionally along with a suitable dispersant added thereto in a sand grinder mill or the like to thereby form the intended complex in the resulting dispersion. The method is also preferred in this embodiment.

Preferably, the amount of the compound of formula (D) to be added to the reducing agent in this embodiment falls between 1 and 200 mol %, more preferably between 10 and 150 mol %, even more preferably between 30 and 100 mol % relative to the reducing agent.

<Binder>

The photothermographic material of first embodiment of the invention contains a binder, and the binder is described below.

The binder to be in the organic silver salt-containing layer in the first embodiment of the invention may be polymer of any type, but is preferably transparent or semitransparent and is generally colorless. For it, for example, preferred are natural resins, polymers and copolymers; synthetic resins, polymers and copolymers; and other film-forming media. More concretely, they include, for example, gelatins, rubbers, poly(vinyl alcohols), hydroxyethyl celluloses, cellulose acetates, cellulose acetate butyrates, poly(vinylpyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal), poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). The binder may be prepared from water or an organic solvent or an emulsion through microencapsulation.

The glass transition point of the binder to be in the organic silver salt-containing layer in the first embodiment of the invention preferably falls between 10° C. and 80° C. (the binder of the type will be hereinafter referred to as a high-Tg binder), more preferably between 15° C. and 70° C., even more preferably between 25° C. and 65° C.

In this description, Tg is calculated according to the following equation:

1/Tg=Σ(Xi/Tgi)

The polymer of which the glass transition point Tg is calculated as in the above comprises n's monomers copolymerized (i indicates the number of the monomers copolymerized, falling between 1 and n); Xi indicates the mass fraction of i'th monomer (ΣXi=1); Tgi indicates the glass transition point (in terms of the absolute temperature) of the homopolymer of i'th monomer alone; and Σ indicates the sum total of i falling between 1 and n. For the glass transition point (Tgi) of the homopolymer of each monomer alone, referred to is the description in Polymer Handbook (3rd edition) (written by J. Brandrup, E. H. Immergut (Wiley-Interscience, 1989)).

One and the same polymer may be used for the binder, but, if desired, two or more different types of polymers may be combined for it. For example, a polymer having a glass transition point of 20° C. or higher and a polymer having a glass transition point of lower than 20° C. may be combined. In case where at least two polymers that differ in Tg are blended for use herein, it is desirable that the weight-average Tg of the resulting blend falls within the range defined as above.

In the first embodiment of the invention, it is desirable that the organic silver salt-containing layer is formed by applying a coating liquid, in which at least 30% by weight of the solvent is water, onto the support followed by drying it.

In case where the organic silver salt-containing layer in the first embodiment of the invention is formed by using such a coating liquid in which at least 30% by weight of the solvent is water, followed by drying it, and in case where the binder in the organic silver salt-containing layer is soluble or dispersible in an aqueous solvent (watery solvent), especially when the binder in the organic silver salt-containing layer is a polymer latex that has an equilibrium water content at 25° C. and 60% RH of at most 2% by weight, the photothermographic material having the layer of the type enjoys better properties. Most preferably, the binder for use in this embodiment is so designed that its ionic conductivity is at most 2.5 mS/cm. For preparing the binder of the type, for example, employable is a method of preparing a polymer for the binder followed by purifying it through a functional membrane for fractionation.

The aqueous solvent in which the polymer binder is soluble or dispersible is water or a mixed solvent of water and at most 70% by weight of a water-miscible organic solvent.

The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” referred to herein can apply also to polymer systems in which the polymer is not thermodynamically dissolved but is seemingly dispersed.

The “equilibrium water content at 25° C. and 60% RH” referred to herein for polymer latex is represented by the following equation, in which W₁ indicates the weight of a polymer in humidity-conditioned equilibrium at 25° C. and 60% RH, and W₀ indicates the absolute dry weight of the polymer at 25° C.

Equilibrium water content at 25° C. and 60% RH={(W₁−W₀)/W₀}×100 (wt. %)

For the details of the definition of water content and the method for measuring it, for example, referred to is Polymer Engineering, Lecture 14, Test Methods for Polymer Materials (by the Polymer Society of Japan, Chijin Shokan Publishing).

Preferably, the equilibrium water content at 25° C. and 60% RH of the binder polymer for use in the first embodiment of the invention is at most 2% by weight, more preferably from 0.01 to 1.5% by weight, even more preferably from 0.02 to 1% by weight.

Polymers that serve as the binder in the first embodiment of the invention are preferably dispersible in aqueous solvents. Polymer dispersions include, for example, a type of hydrophobic polymer latex with water-insoluble fine polymer particles being dispersed, and a type of molecular or micellar polymer dispersion with polymer molecules or micelles being dispersed. Any of these may be employed herein, but preferred is polymer latex dispersion.

The particles in the polymer dispersions may have a mean particle size falling between 1 and 50000 nm, but preferably between 5 and 1000 nm, more preferably between 10 and 500 nm, even more preferably between 50 and 200 nm. The particle size distribution of the dispersed polymer particles is not specifically defined. For example, the dispersed polymer particles may have a broad particle size distribution, or may have a narrow particle size distribution of monodispersion. Combining two or more different types of mono-dispersed polymer particles both having a narrow particle size distribution is preferred for suitably controlling the physical properties of the coating liquids for use herein.

For the photothermographic material of the first embodiment of the invention, favorably used are hydrophobic polymers that are dispersible in aqueous media. The hydrophobic polymers of the type include, for example, acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked ones. They may be homopolymers from one type of monomer, or copolymers from two or more different types of monomers. The copolymers may be random copolymers or block copolymers.

The polymers for use herein preferably have a number-average molecular weight falling between 5000 and 1000000, more preferably between 10000 and 200000. Polymers having a too small molecular weight are unfavorable to the invention, since the mechanical strength of the emulsion layer comprising such a polymer is low; but others having a too large molecular weight are also unfavorable since their workability into films is not good. Especially preferred for use herein is crosslinked polymer latex.

Preferred examples of polymer latex for use herein are mentioned below, to which, however, the first embodiment of the invention is not limited.

The following examples are expressed by the constituent monomers, in which each numeral parenthesized indicates the proportion, in terms of % by weight, of the monomer unit, and the molecular weight of each constituent monomer is in terms of the number-average molecular weight thereof. Polyfunctional monomers form a crosslinked structure in polymer latex comprising them, to which, therefore, the concept of molecular weight does not apply. The polymer latex of the type is referred to as “crosslinked”, and the molecular weight of the constituent monomers is omitted. Tg indicates the glass transition point of the polymer latex.

P-1: Latex of -MMA(70)-EA(27)-MAA(3)-(molecular weight 37000, Tg 61° C.)

P-2: Latex of -MMA(70)-2EHA(20)-St(5)-AA(5)-(molecular weight 40000, Tg 59° C.)

P-3: Latex of -St(50)-Bu(47)-MMA(3)-(crosslinked, Tg −17° C.)

P-4: Latex of -St(68)-Bu(29)-AA(3)-(crosslinked, Tg 17° C.)

P-5: Latex of -St(71)-Bu(26)-AA(3)-(crosslinked, Tg 24° C.)

P-6: Latex of -St(70)-Bu(27)-IA(3)-(crosslinked)

P-7: Latex of -St(75)-Bu(24)-AA(l)-(crosslinked, Tg 29° C.)

P-8: Latex of -St(60)-Bu(35)-DVB(3)-MAA(2)-(crosslinked)

P-9: Latex of -St(70)-Bu(25)-DVB(2)-AA(3)-(crosslinked)

P-10: Latex of -VC(50)-MMA(20)-EA(20)-AN-(5)-AA(5)-(molecular weight 80000)

P-11: Latex of -VDC(85)-MMA(5)-EA(5)-MAA(5)-(molecular weight 67000)

P-12: Latex of -Et(90)-MAA(10)-(molecular weight 12000)

P-13: Latex of -St(70)-2EHA(27)-AA(3)-(molecular weigh: 130000, Tg 43° C.)

P-14: Latex of -MMA(63)-EA(35)-AA(2)-(molecular weight 33000, Tg 47° C.)

P-15: Latex of -St(70.5)-Bu(26.5)-AA(3)-(crosslinked, Tg 23° C.)

P-16: Latex of -St(69.5)-Bu(27.5)-AA(3)-(crosslinked, Tg 20.5° C.)

Abbreviations of the constituent monomers are as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The polymer latexes mentioned above are available on the market. Some commercial products employable herein are mentioned below. Examples of acrylic polymers are CEBIAN A-4635, 4718, 4601 (all from Daicel Chemical Industries), and Nipol Lx811, 814, 821, 820, 857 (all from Nippon Zeon); examples of poly(esters) are FINETEX ES650, 611, 675, 850 (all from Dai-Nippon Ink & Chemicals), and WD-size, WMS (both from Eastman Chemical); examples of poly(urethanes) are HYDRAN AP10, 20, 30, 40 (all from Dai-Nippon Ink & Chemicals); examples of rubbers are LACSTAR 7310K, 3307B, 4700H, 7132C (all from Dai-Nippon Ink & Chemicals), and Nipol Lx416, 410, 438C, 2507 (all from Nippon Zeon); examples of poly(vinyl chlorides) are G351, G576 (both from Nippon Zeon); examples of poly(vinylidene chlorides) are L502, L513 (both from Asahi Kasei); and examples of poly(olefins) are CHEMIPEARL S120, SA100 (both from Mitsui Petrochemical).

These polymer latexes may be used either singly or as combined in any desired manner.

For the polymer latex for use in the first embodiment of the invention, especially preferred is styrene-butadiene copolymer latex. In the styrene-butadiene copolymer, the ratio of styrene monomer units to butadiene monomer units preferably falls between 40/60 and 95/5 by weight. Also preferably, the styrene monomer units and the butadiene monomer units account for from 60 to 99% by weight of the copolymer. Still preferably, the polymer latex for use in the first embodiment of the invention contains from 1 to 6% by weight, more preferably from 2 to 5% by weight of acrylic acid or methacrylic acid relative to the sum of styrene and butadiene therein. Even more preferably, the polymer latex for use in the first embodiment of the invention contains acrylic acid.

Preferred examples of the styrene-butadiene-acid copolymer latex for use in the first embodiment of the invention are the above-mentioned P-3 to P-8, and commercial products, LACSTAR-3307B, 7132C, and Nipol Lx416.

The styrene-butadiene-acid copolymer latex of the type preferably has Tg falling between 10° C. and 30° C., more preferably between 17° C. and 25° C.

The organic silver salt-containing layer of the photothermographic material of the first embodiment of the invention may optionally contain a hydrophilic polymer such as gelatin, polyvinyl alcohol, methyl cellulose, hydroxypropyl cellulose or carboxymethyl cellulose. The amount of the hydrophilic polymer that may be in the layer is preferably at most 30% by weight, more preferably at most 20% by weight of all the binder in the organic silver salt-containing layer.

Preferably, the polymer latex as above is used in forming the organic silver salt-containing layer (that is, the image-forming layer) of the photothermographic material of the first embodiment of the invention. Concretely, the amount of the binder in the organic silver salt-containing layer is such that the ratio by weight of total binder/organic silver salt falls between 1/10 and 10/1, more preferably between 1/3 and 5/1, even more preferably between 1/1 and 3/1.

The organic silver salt-containing layer is a photosensitive layer (emulsion layer) generally containing a photosensitive silver salt, that is, a photosensitive silver halide. In the layer, the ratio by weight of total binder/silver halide preferably falls between 5 and 400, more preferably between 10 and 200.

The overall amount of the binder in the image-forming layer of the photothermographic material of the first embodiment of the invention preferably falls between 0.2 and 30 g/m², more preferably between 1 and 15 g/m², even more preferably between 2 and 10 g/m². The image-forming layer in this embodiment may optionally contain a crosslinking agent, and a surfactant which is for improving the coatability of the coating liquid for the layer.

<Solvent Preferred for Coating Liquid>

Preferably, the solvent for the coating liquid for the organic silver salt-containing layer of the photothermographic material of the first embodiment of the invention is an aqueous solvent that contains at least 30% by weight of water. The solvent referred to herein is meant to indicate both solvent and dispersion medium for simple expression.

Except water, the other components of the aqueous solvent may be any organic solvents that are miscible with water, including, for example, methyl alcohol, ethyl alcohol, isopropyl alcohol, methyl cellosolve, ethyl cellosolve, dimethylformamide, ethyl acetate. The water content of the solvent for the coating liquid is preferably at least 50% by weight, more preferably at least 70% by weight.

Preferred examples of the solvent composition are water alone, water/methyl alcohol=90/10, water/methyl alcohol=70/30, water/methyl alcohol/dimethylformamide=80/15/5, water/methyl alcohol/ethyl cellosolve=85/10/5, water/methyl alcohol/isopropyl alcohol=85/10/5. The ratio is by weight.

<Antifoggant and Others>

Antifoggants usable in the first embodiment of the invention are described.

For the antifoggants, stabilizers and stabilizer precursors employable in this embodiment, referred to are the compounds in JP-A 10-62899, paragraph [0070]; EP Laid-Open 0803764A1, from page 20, line 57 to page 21, line 7; JP-A 9-281637, 9-329864, and also referred to are the compounds in U.S. Pat. Nos. 6,083,681, 6,083,681, and EP 1048975.

Antifoggants preferred for use in the first embodiment of the invention are organic halides. These are described, for example, in JP-A 11-65021, paragraphs [0111] to [0112]. Especially preferred are organic halogen compounds of formula (P) in JP-A 2000-284399; organic polyhalogen compounds of formula (II) in JP-A 10-339934; and organic polyhalogen compounds in JP-A 2001-31644 and 2001-33911.

Organic polyhalogen compounds preferred for use in the first embodiment of the invention are described concretely. Preferably, the polyhalogen compounds for use in the first embodiment of the invention are represented by the following general formula (H):

Q—(Y)n—C(Z₁)(Z₂)X General Formula (H)

wherein Q represents an alkyl, aryl or heterocyclic group; Y represents a divalent linking group; n indicates O or 1; Z₁ and Z₂ each represent a halogen atom; and X represents a hydrogen atom or an electron-attracting group.

In formula (H), Q is preferably a phenyl group substituted with an electron-attracting group having a positive Hammett's substituent constant σₚ. For the Hammett's substituent constant, referred to is, for example, Journal of Medicinal Chemistry, 1973, Vol. 16, No. 11, 1207-1216.

Examples of the electron-attracting group of the type are a halogen atom (fluorine atom with σₚ of 0.06, chlorine atom with σₚ of 0.23, bromine atom with σₚ of 0.23, iodine atom with σₚ of 0.18), a trihalomethyl group (tribromomethyl with σₚ of 0.29, trichloromethyl with σₚ of 0.33, trifluoromethyl with σₚ of 0.54), a cyano group (with σₚ of 0.66), a nitro group (with σₚ of 0.78), an aliphatic, aryl or heterocyclic sulfonyl group (e.g., methanesulfonyl with σₚ of 0.72), an aliphatic, aryl or heterocyclic acyl group (e.g., acetyl with σₚ of 0.50, benzoyl with σₚ of 0.43), an alkynyl group (e.g., C≡CH with σₚ of 0.23), an aliphatic, aryl or heterocyclic oxycarbonyl group (e.g., methoxycarbonyl with σₚ of 0.45, phenoxycarbonyl with σₚ of 0.44), a carbamoyl group (with σₚ of 0.36), a sulfamoyl group (with σₚ of 0.57), a sulfoxide group, a heterocyclic group, and a phosphoryl group. The σₚ value of the electron-attracting group preferably falls between 0.2 and 2.0, more preferably between 0.4 and 1.0.

Of the preferred examples of the electron-attracting group mentioned above, more preferred are a carbamoyl group, an alkoxycarbonyl group, an alkylsulfonyl group and an alkylphosphoryl group, and most preferred is a carbamoyl group.

In formula (H), X is preferably an electron-attracting group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group. Even more preferably, it is a halogen atom. For the halogen atom for X, preferred are chlorine, bromine and iodine atoms, more preferred are chlorine and bromine atoms, and even more preferred is a bromine atom.

In formula (H), Y is preferably —C(═O)—, —SO— or —SO₂—, more preferably —C(═O)— or —SO₂—, even more preferably —SO₂—. n is 0 or 1, but preferably 1.

Specific examples of the compounds of formula (H) for use in the first embodiment of the invention are mentioned below.

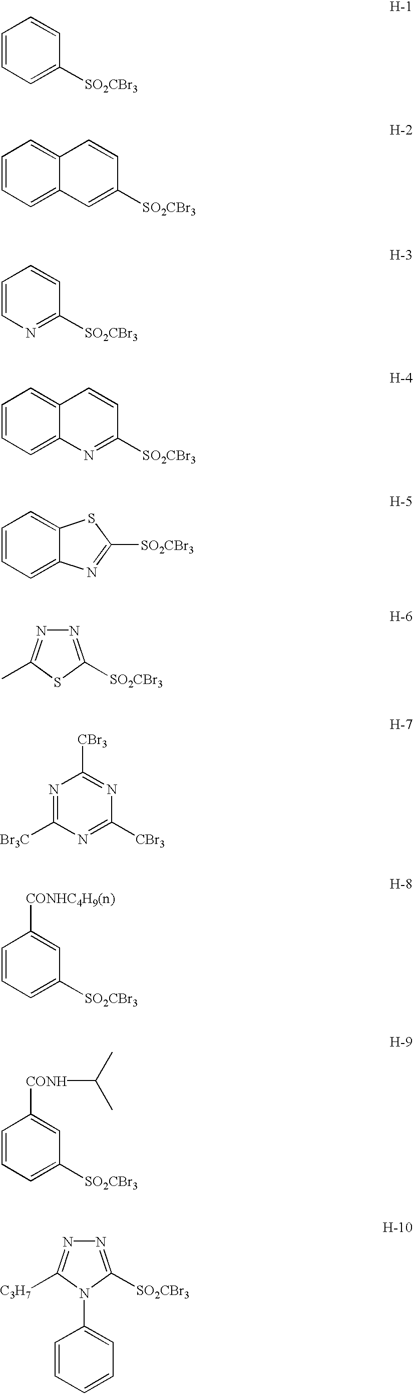

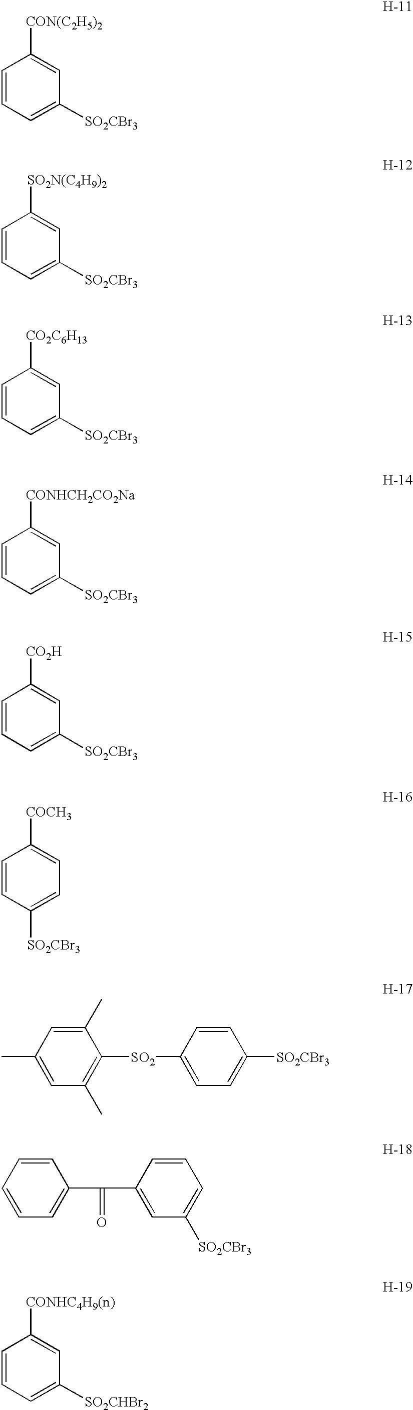

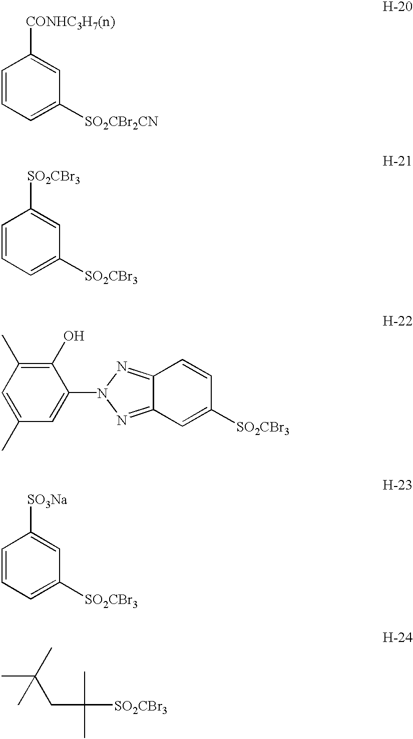

Preferably, the amount of the compound of formula (H) to be in the photothermographic material of the first embodiment of the invention falls between 1×10⁻⁴ and 0.5 mols, more preferably between 10⁻³ and 0.1 mols, even more preferably between 5×10⁻⁴ and 0.05 mols per mol of the non-photosensitive silver salt in the image-forming layer of the material.

The antifoggant may be incorporated into the photothermographic material of the first embodiment of the invention in the same manner as that mentioned hereinabove for incorporating the reducing agent thereinto. Preferably, the organic polyhalogen compound is in the form of a fine solid particle dispersion when it is incorporated into the material.

<Other Antifoggants>

Other antifoggants usable herein are mercury(II) salts as in JP-A 11-65021, paragraph [0113]; benzoic acids as in JP-A 11-65021, paragraph [0114]; salicylic acid derivatives as in JP-A 2000-206642; formalin scavenger compounds of formula (S) in JP-A 2000-221634; triazine compounds claimed in claim 9 in JP-A 11-352624; compounds of formula (III) in JP-A 6-11791; and 4-hydroxy-6-methyl-1,3,3a,7-tetrazaindene.

The photothermographic material of the first embodiment of the invention may also contain an azolium salt serving as an antifoggant. The azolium salt includes, for example, compounds of formula (XI) in JP-A 59-193447, compounds as in JP-B 55-12581, and compounds of formula (II) in JP-A 60-153039. The azolium salt may be present in any site of the photothermographic material, but is preferably in a layer adjacent to the photosensitive layer in the material. More preferably, it is added to the organic silver salt-containing layer of the material.

Regarding the time at which the azolium salt is added to the material, it may be added to the coating liquid at any stage of preparing the liquid. In case where it is to be present in the organic silver salt-containing layer, the azolium salt may be added to any of the reaction system to prepare the organic silver salt or the reaction system to prepare the coating liquid at any stage of preparing them. Preferably, however, it is added to the coating liquid after the stage of preparing the organic silver salt and just before the stage of coating the liquid. The azolium salt to be added may be in any form of powder, solution or fine particle dispersion. It may be added along with other additives such as sensitizing dye, reducing agent and toning agent, for example, in the form of their solution.

The amount of the azolium salt to be added to the photothermographic material of the first embodiment of the invention is not specifically defined, but preferably falls between 1×10⁻⁶ mols and 2 mols, more preferably between 1×10⁻³ mols and 0.5 mols per mol of silver in the material.

<Other Additives>

<<Mercapto, Disulfide and Thione Compounds>>

The photothermographic material of the first embodiment of the invention may optionally contain any of mercapto compounds, disulfide compounds and thione compounds which are for retarding, promoting or controlling the developability of the material, or for enhancing the spectral sensitivity thereof, or for improving the storage stability thereof before and after development. For the additive compounds, for example, referred to are JP-A 10-62899, paragraphs [0067] to [0069]; compounds of formula (I) in JP-A 10-186572, and their examples in paragraphs [0033] to [0052]; and EP Laid-Open 0803764A1, page 20, lines 36 to 56. Above all, preferred are mercapto-substituted heteroaromatic compounds such as those in JP-A 9-297367, 9-304875, 2001-100358, and in Japanese Patent Application Nos. 2001-104213 and 2001-104214.

<<Toning Agent>>

Adding a toning agent to the photothermographic material of the first embodiment of the invention is preferred. Examples of the toning agent usable herein are described in JP-A 10-62899, paragraphs [0054] to [0055], EP Laid-Open 0803764A1, page 21, lines 23 to 48; and JP-A 2000-356317; and Japanese Patent Application No. 2000-187298. Especially preferred for use herein are phthalazinones (phthalazinone, phthalazinone derivatives and their metal salts, e.g., 4-(1-naphthyl)phthalazinone, 6-chlorophthalazinone, 5,7-dimethoxyphthalazinone, 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives and their salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); combinations of phthalazines and phthalic acids. More preferred are combinations of phthalazines and phthalic acids. Above all, especially preferred are a combination of 6-isopropylphthalazine and phthalic acid or 4-methylphthalic acid.

<<Plasticizer, Lubricant>>

Plasticizers and lubricants that may be in the photosensitive layer of the photothermographic material of the first embodiment of the invention are described in, for example, JP-A 11-65021, paragraph [0117]. Lubricants that may be in the layer are also described in JP-A 11-84573, paragraphs [0061] to [0064], and JP-A 11-106881, paragraphs [0049] to [0062].

<<Dye, Pigment>>

The photosensitive layer in the first embodiment of the invention may contain various types of dyes and pigments (e.g., C.I. Pigment Blue 60, C.I. Pigment Blue 64, C.I. Pigment Blue 15:6) for improving the image tone, for preventing interference fringes during laser exposure, and for preventing irradiation. The details of such dyes and pigments are described in, for example, WO98/36322, and JP-A 10-268465 and 11-338098.

<<Super-hardener>>

For forming super-hard images suitable to printing plates, a super-hardener is preferably added to the image-forming layer of the photothermographic material. For such super-hardeners for forming super-hard images, methods of using them, and their amounts applicable to the invention, for example, referred to are JP-A 11-65021, paragraph [0118]; JP-A 11-223898, paragraphs [0136] to [0193]; compounds of formula (H), those of formulae (1) to (3) and those of formulae (A) and (B) in JP-A 2000-284399; compounds of formulae (III) to (V) in Japanese Patent Application No. 11-91652, especially concrete compounds in [Formula 21] to [Formula 24] therein. For hardening promoters also applicable to the invention, referred to are JP-A 11-65021, paragraph [0102]; and JP-A 11-223898, paragraphs [0194] to [0195].

In case where formic acid or its salt is used for a strong foggant in the invention, it may be added to the photosensitive silver halide-containing, image-forming layer of the material, and its amount is preferably at most 5 mmols, more preferably at most 1 mmol per mol of silver in the layer.

In case where a super-hardener is used in the photothermographic material of the first embodiment of the invention, it is preferably combined with an acid formed through hydration of diphosphorus pentoxide or its salt.

The acid to be formed through hydration of diphosphorus pentoxide and its salts include, for example, metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts).

For the acid to be formed through hydration of diphosphorus pentoxide and its salts, preferred for use herein are orthophosphoric acid (and its salts), and hexametaphosphoric acid (and its salts).

Concretely, their salts are sodium orthophosphate, sodium dihydrogen-orthophosphate, sodium hexametaphosphate, and ammonium hexametaphosphate.

The amount of the acid to be formed through hydration of diphosphorus pentoxide or its salt to be used herein (that is, the amount thereof to be in the unit area, one m², of the photothermographic material) may be any desired one and may be defined in any desired manner depending on the sensitivity, the fogging resistance and other properties of the material. Preferably, however, it falls between 0.1 and 500 mg/m², more preferably between 0.5 and 100 mg/m².

<<Preparation of Coating Liquid>>

In the first embodiment of the invention, the coating liquid for the image-forming layer is prepared preferably at a temperature falling between 30° C. and 65° C., more preferably between 35° C. and lower than 60° C., even more preferably between 35° C. and 55° C. Also preferably, the coating liquid for the image-forming layer is kept at a temperature falling between 30° C. and 65° C. just after addition of polymer latex thereto.

<Layer Constitution>

One or more image-forming layers are formed on one support to produce the photothermographic material of the first embodiment of the invention. In case where the material has one image-forming layer, the layer must contain an organic silver salt, a photosensitive silver halide, a reducing agent and a binder, and may contain optional additives such as a toning agent, a coating aid and other auxiliary agents. In case where the material has two or more image-forming layers, the first image-forming layer (in general, this is directly adjacent to the support) must contain an organic silver salt and a photosensitive silver halide, and the second image-forming layer or the two layers must contain the other ingredients.

The photothermographic material for multi-color expression of the invention may have combinations of these two layers for the respective colors, or may contain all the necessary ingredients in a single layer, for example, as in U.S. Pat. No. 4,708,928. For the photothermographic material of a type containing multiple dyes for multi-color expression, the individual emulsion layers are differentiated and spaced from the others via a functional or non-functional barrier layer between the adjacent emulsion layers, for example, as in U.S. Pat. No. 4,460,681.

In general, the photothermographic material has non-photosensitive layers in addition to photosensitive layers. Depending on their positions, the non-photosensitive layers are classified into (1) a protective layer to be disposed on a photosensitive layer (remoter from the support than the photosensitive layer); (2) an interlayer to be disposed between adjacent photosensitive layers or between a photosensitive layer and a protective layer; (3) an undercoat layer to be disposed between a photosensitive layer and a support; (4) a back layer to be disposed on a support opposite to a photosensitive layer. The layers (1) and (2) are filter layers that are in the photothermographic material. The layers (3) and (4) are antihalation layers in the material.

<<Surface Protective Layer>>

The photothermographic material of the first embodiment of the invention may have a surface protective layer for preventing the image-forming layer from being blocked. The surface protective layer may have a single-layered or multi-layered structure. The details of the surface protective layer are described, for example, in JP-A 11-65021, paragraphs [0119] to [0120], and in Japanese Patent Application No. 2000-171936.

Gelatin is preferred for the binder in the surface protective layer in the first embodiment of the invention, but for it, polyvinyl alcohol (PVA) is also usable alone or combined with gelatin. Gelatin for use herein may be inert gelatin (e.g., Nitta Gelatin 750), or gelatin phthalide (e.g., Nitta Gelatin 801).

Examples of PVA usable herein are described in, for example, JP-A 2000-171936, paragraphs [0009] to [0020]. Preferred example of PVA for use herein are completely saponified PVA-105; partially saponified PVA-205, PVA-355; and modified polyvinyl alcohol, MP-203 (all commercial products of Kuraray). The polyvinyl alcohol content (per m² of the support) of one protective layer preferably falls between 0.3 and 4.0 g/m², more preferably between 0.3 and 2.0 g/m².

In case where the photothermographic material of the first embodiment of the invention is used in the field of printing that require high-level dimensional stability, it is desirable to use a polymer latex in the surface protective layer or the back layer of the material.

The polymer latex for that purpose is described in, for example, Synthetic Resin Emulsions (by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); and Chemistry of Synthetic Latexes (by Sohichi Muroi, the Polymer Publishing Association of Japan, 1970). Concretely, it includes, for example, methyl methacrylate (33.5 wt. %)/ethyl acrylate (50 wt. %)/methacrylic acid (16.5 wt. %) copolymer latex; methyl methacrylate (47.5 wt. %)/butadiene (47.5 wt. %)/itaconic acid (5 wt. %) copolymer latex; ethyl acrylate/methacrylic acid copolymer latex; methyl methacrylate (58.9 wt. %)/2-ethylhexyl acrylate (25.4 wt. %)/styrene (8.6 wt. %)/2-hydroxyethyl methacrylate (5.1 wt. %)/acrylic acid (2.0 wt. %) copolymer latex; and methyl methacrylate (64.0 wt. %)/styrene (9.0 wt. %)/butyl acrylate (20.0 wt. %)/2-hydroxyethyl methacrylate (5.0 wt. %)/acrylic acid (2.0 wt. %) copolymer latex.

To the binder for the surface protective layer in this embodiment, for example, applicable are the polymer latex combinations as in Japanese Patent Application No. 11-6872; the techniques as in Japanese Patent Application No. 11-143058, paragraphs [0021] to [0025]; the techniques as in Japanese Patent Application No. 11-6872, paragraphs [0027] to [0028]); and the techniques as in Japanese Patent Application No. 10-199626, paragraphs [0023] to [0041].

The ratio of the polymer latex in the surface protective layer preferably falls between 10% by weight and 90% by weight, more preferably between 20% by weight and 80% by weight of all the binder in the layer.

The overall binder content (including water-soluble polymer and latex polymer, per m² of the support) of one protective layer preferably falls between 0.3 and 5.0 g/m², more preferably between 0.3 and 2.0 g/m².

<<Antihalation Layer>>

Preferably, the photothermographic material of the first embodiment of the invention has an antihalation layer remoter from the light source to which it is exposed than its photosensitive layer.

The details of the antihalation layer are described in, for example, JP-A 11-65021, paragraphs [0123] to [0124]; JP-A 11-223898, 9-230531, 10-36695, 10-104779, 11-231457, 11-352625, 11-352626.

The antihalation layer contains an antihalation dye capable of absorbing the light to which the photothermographic material is exposed. In this embodiment, the photothermographic material is exposed to laser rays having a peak wavelength range of from 350 nm to 440 nm. Therefore, it is desirable that the antihalation dye to be in the antihalation layer of the material may absorb the light falling within that wavelength range.

In case where visible light-absorbing dyes are used for antihalation in this embodiment, it is desirable that the dyes used are substantially decolored after image formation on the material, for which, for example, usable are decoloring agents that have the ability to decolor the dyes when heated in the step of thermal development. Preferably, a thermal decoloring dye and a base precursor are added to the non-photosensitive layers so that the layers containing them may function as antihalation layers. The details of this technique are described in, for example, JP-A 11-231457.

The amount of the decoloring dye to be added shall be determined, depending on the use of the dye. In general, its amount is so determined that the dye added could ensure an optical density (absorbance), measured at an intended wavelength, of larger than 1.0. The optical density preferably falls between 0.15 and 2, more preferably between 0.2 and 1. The amount of the dye capable of ensuring the optical density falling within the range may be generally from 0.001 to 1 g/m² or so.

Decoloring the dyes in the photothermographic material in that manner can lower the optical density of the material to 0.1 or less after thermal development. Two or more different types of decoloring dyes may be in the thermodecoloring recording material or the photothermographic material. Similarly, two or more different types of base precursors may be in the material.

In the thermodecoloring material of the type that contains a decoloring dye and a base precursor, it is desirable in view of the thermodecoloring ability of the material that the base precursor therein is combined with a substance which, when mixed with the base precursor, can lower the melting point of the mixture by at most 3° C. (e.g., diphenyl sulfone, 4-chlorophenyl(phenyl) sulfone, 2-naphtyl benzoate), for example, as in JP-A 11-352626.

<<Back Layer>>

For the details of the back layer applicable to the first embodiment of the invention, referred to is JP-A 11-65021, paragraphs [0128] to [0130].

In the first embodiment of the invention, a coloring agent that has an absorption maximum in the range falling between 300 and 450 nm may be added to the photothermographic material for improving the silver tone and the image stability of the material. The coloring agent is described in, for example, JP-A 62-210458, 63-104046, 63-1003235, 63-208846, 63-306436, 63-314535, 01-61745, and Japanese Patent Application No. 11-276751.

In general, the amount of the coloring agent to be added to the material falls between 0.1 mg/m² and 1 g/m². Preferably, it is added to the back layer that is opposite to the photosensitive layer of the material.

Preferably, the photothermographic material of the first embodiment of the invention has, on one surface of its support, at least one photosensitive layer that contains a photosensitive silver halide emulsion, and has a back layer on the other surface thereof. This is referred to as a single-sided photothermographic material.

<<Matting Agent>>

Also preferably, the photothermographic material of the first embodiment of the invention contains a matting agent which is for improving the transferability of the material. Matting agents are described in JP-A 11-65021, paragraphs [0126] to [0127]. The amount of the matting agent to be added to the photothermographic material preferably falls between 1 and 400 mg/m², more preferably between 5 and 300 mg/m² of the material.

Regarding its morphology, the matting agent to be used in the first embodiment of the invention may be shaped or amorphous, but is preferably shaped. More preferably, it is spherical. The mean grain size of the spherical matting agent preferably falls between 0.5 and 10 μm, more preferably between 1.0 and 8.0 μm, even more preferably between 2.0 and 6.0 μm. The size distribution fluctuation coefficient thereof is preferably at most 50%, more preferably at most 40%, even more preferably at most 30%. The fluctuation coefficient is represented by (grain size standard deviation)/(mean grain size)×100. Combining two different types of matting agents both having a small size distribution fluctuation coefficient is preferred for use in this embodiment. Concretely, the ratio of the mean grain size of the two matting agents combined is larger than 3.

The degree to which the emulsion surface of the photothermographic material of this embodiment is matted is not specifically defined, so far as the matted layer surface is free from star dust trouble, but is preferably such that the Beck's smoothness of the matted surface could fall between 30 seconds and 2000 seconds, more preferably between 40 seconds and 1500 seconds. The Beck's smoothness is readily obtained according to JIS P8119 (method of testing surface smoothness of paper and paper boards with Beck tester), and to TAPPI Standard T479.

Regarding the matting degree of the back layer of the photothermographic material of the first embodiment of the invention, the Beck's smoothness of the matted back layer preferably falls between 10 seconds and 1200 seconds, more preferably between 20 seconds and 800 seconds, even more preferably between 40 seconds and 500 seconds.

Preferably, the photothermographic material of the first embodiment of the invention contains such a matting agent in the outermost surface layer, or in a layer functioning as an outermost surface layer, or in a layer nearer to the outermost surface. Also preferably, it may contain a matting agent in a layer functioning as a protective layer.

<<pH of Film Surface>>

Also preferably, the surface of the photothermographic material of the first embodiment of the invention has a pH of at most 7.0, more preferably at most 6.6, before developed under heat. The lowermost limit of the pH is not specifically defined, but may be at least 3 or so. Most preferably, the pH range falls between 4 and 6.2.

For controlling the surface pH of the photothermographic material, employable are nonvolatile acids, for example, organic acids such as phthalic acid derivatives, or sulfuric acid, or nonvolatile bases such as ammonia. These are preferred as effective for reducing the surface pH of the material. Especially preferred for the surface pH-lowering agent is ammonia, as it is highly volatile, and therefore can be readily removed while the coating liquids containing it are coated and surely before thermal development.

Also preferred is combining ammonia with a nonvolatile base such as sodium hydroxide, potassium hydroxide or lithium hydroxide. For measuring the surface pH of the photothermographic material, referred to is the description in Japanese Patent Application No. 11-87297, paragraph [0123].

<<Hardening Agent>>

A hardening agent may be added to the photosensitive layer, the protective layer, the back layer and other layers constituting the photothermographic material of the first embodiment of the invention. The details of the hardening agent applicable to the invention are described in T. H. James' The Theory of the Photographic Process, 4th Ed. (Macmillan Publishing Co., Inc., 1977), pp. 77-87. For example, preferred for use herein are chromium alum, 2,4-dichloro-6-hydroxy-s-triazine sodium salt, N,N-ethylenebis(vinylsulfonacetamide), N,N-propylenebis(vinylsulfonacetamide); as well as polyvalent metal ions described on page 78 of that reference; polyisocyanates described in U.S. Pat. No. 4,281,060 and JP-A 6-208193; epoxy compounds described in U.S. Pat. No. 4,791,042; and vinylsulfone compounds described in JP-A 62-89048.

The hardening agent is added to the coating liquids in the form of its solution. The time at which the solution is added to the coating liquid for the protective layer may fall between 180 minutes before coating the liquid and a time just before the coating, preferably between 60 minutes before the coating and 10 seconds before it. However, there is no specific limitation thereon, so far as the method and the condition employed for adding the hardening agent to the coating liquid ensure the advantages of the first embodiment of the invention.

Concretely for adding it, employable is a method of mixing a hardening agent with a coating liquid in a tank in such a controlled manner that the mean residence time for the agent as calculated from the amount of the agent added and the flow rate of the coating liquid to a coater could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<<Surfactants>>

Surfactants applicable to the photothermographic material of the first embodiment of the invention are described in JP-A 11-65021, paragraph [0132].

In the first embodiment of the invention, preferably used are fluorine-containing surfactants. Examples of fluorine-containing surfactants are given, for example, in JP-A 10-197985, 2000-19680 and 2000-214554. Also preferred for use herein are fluorine-containing polymer surfactants such as those in JP-A 9-281636. In the first embodiment of the invention, especially preferred are fluorine-containing surfactants described in Japanese Patent Application No. 2000-206560.

Solvents applicable to the first embodiment of the invention are described in JP-A 11-65021, paragraph [0133]; supports applicable thereto are in the same but in paragraph [0134]; antistatic and electroconductive layers applicable thereto are in the same but in paragraph [0135]; methods of forming color images applicable thereto are in the same but in paragraph [0136]; lubricants applicable thereto are in JP-A 11-84573, paragraphs [0061]to [0064] and in Japanese Patent Application No. 11-106881, paragraphs [0049] to [0062].

<<Electroconductive Layer>>

Preferably, the photothermographic material of the first embodiment of the invention has an electroconductive layer with a metal oxide therein. For the electroconductive material for the electroconductive layer, preferred are metal oxides which are specifically so processed that they have oxygen defects and/or different metal atoms introduced thereinto to increase their electroconductivity.

Preferred examples of the metal oxides are ZnO, TiO₂ and SnO₂. To ZnO, preferably added is any of Al or In; to SnO₂, any of Sb, Nb, P or halogen elements; and TiO₂, any of Nb or Ta. Especially preferred is SnO₂ with Sb added thereto.

Preferably, the amount of the different atom to be added to the metal oxide falls between 0.01 and 30 mol %, more preferably between 0.1 and 10 mol %. Regarding their morphology, the metal oxides may be spherical, acicular or tabular, but they are preferably acicular grains having a ratio of major axis/minor axis of at least 2.0, more preferably from 3.0 to 50 as their electroconductivity is high.

The amount of the metal oxide to be in the layer preferably falls between 1 mg/m² and 1000 mg/m², more preferably between 10 mg/m² and 500 mg/m², even more preferably between 20 mg/m² and 200 mg/m². In the first embodiment of the invention, the electroconductive layer may be formed on any side of emulsion-coated face or back face, but is preferably formed between the support and the back layer. Specific examples of the electroconductive layer applicable to the first embodiment of the invention are described in, for example, JP-A 7-295146 and 11-223901.

<<Support>>

Various supports are employable in the photothermographic material of the first embodiment of the invention. They include, for example, polyesters such as polyethylene terephthalate (PET), polyethylene naphthalate; cellulose nitrate, cellulose esters, polyvinyl acetal, syndiotactic polystyrene, polycarbonates; and paper of which both surfaces are coated with polyethylene.

Preferably, the support of the photothermographic material of this embodiment is undercoated, for example, with a water-soluble polyester as in JP-A 11-84574; a styrene-butadiene copolymer as in JP-A 10-186565; or a vinylidene chloride copolymer as in JP-A 2000-39684 or in Japanese Patent Application No. 11-106881, paragraphs [0063] to [0080].

For the transparent supports for the photothermographic material, preferred are biaxially-stretched films of polyesters, especially polyethylene terephthalate heated at a temperature falling between 130 and 185° C. The heat treatment is for removing the internal strain that may remain in the biaxially-stretched films and for preventing the film supports from being thermally shrunk during thermal development of the material. In case where the photothermographic material is for medical treatment, the transparent support for it may be colored with a blue dye (for example, with Dye-1 used in the examples in JP-A 8-240877), or may not be colored.

For the antistatic layer and the undercoat layer to be formed in the photothermographic material of the first embodiment of the invention, for example, referred to are the techniques disclosed in JP-A 56-143430, 56-143431, 58-62646, 56-120519, 11-84573, paragraphs [0040] to [0051]; U.S. Pat. No. 5,575,957; and JP-A 11-223898, paragraphs [0078] to [0084].

Preferably, the photothermographic material is of a monosheet type. The monosheet type does not require any additional sheet to receive images thereon, but may directly form images on itself.

<<Other Additives>>

The photothermographic material may optionally contain an antioxidant, a stabilizer, a plasticizer, a UV absorbent or a coating aid. Such additives may be in any of the photosensitive layers or the non-photosensitive layers of the material. For the additives, for example, referred to are WO98/36322, EP 803764A1, JP-A 10-186567 and 10-18568.

<Fabrication of Photothermographic Material>

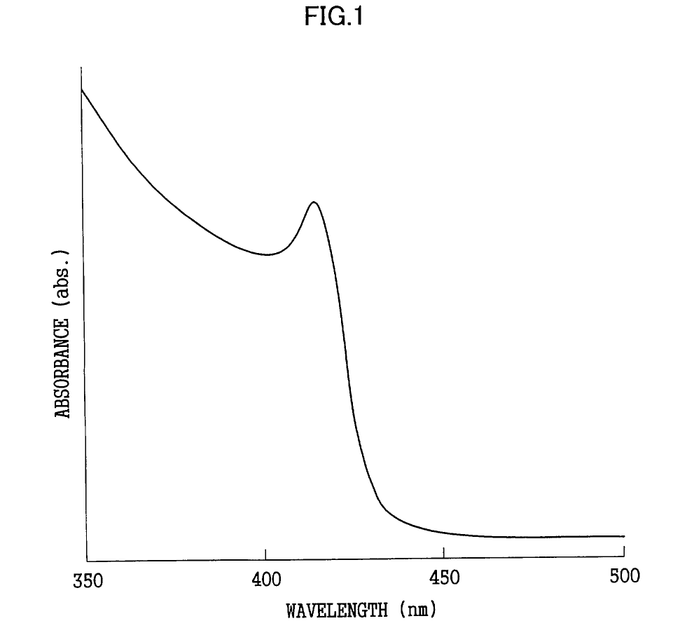

To fabricate the photothermographic material of the first embodiment of the invention, the coating liquids may be applied onto a support in any desired manner. Concretely, various types of coating techniques are employable herein, including, for example, extrusion coating, slide coating, curtain coating, dipping, knife coating, and flow coating. Various types of hoppers for extrusion coating employable herein are described in U.S. Pat. No. 2,681,294. Preferred for the photothermographic material is extrusion coating or slide coating described in Stephen F. Kistler & Petert M. Schweizer's Liquid Film Coating (Chapman & Hall, 1997), pp. 399-536. More preferred is slide coating. One example of the shape of a slide coater for slide coating is in FIG. 11b-1, on page 427 of that reference. If desired, two or more layers may be formed at the same time, for example, according to the methods described from page 399 to page 536 of that reference, or to the methods described in U.S. Pat. No. 2,761,791 and BP 837,095.

Preferably, the coating liquid for the organic silver salt-containing layer in the first embodiment of the invention is a thixotropic flow. For it, referred to is the technique described in JP-A 11-52509.

Preferably, the coating liquid for the organic silver salt-containing layer in the first embodiment of the invention has a viscosity falling between 400 mPa·s and 100,000 mPa·s, more preferably between 500 mPa·s and 20,000 mPa·s, at a shear rate of 0.1 sec⁻¹. Also preferably, the viscosity falls between 1 mPa·s and 200 mPa·s, more preferably between 5 mPa·s and 80 mPa·s, at a shear rate of 1000 sec⁻¹.

Other techniques applicable to the photothermographic material of the first embodiment of the invention are, for example, in EP 803764A1, EP 883022A1, WO98/36322; JP-A 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420; and Japanese Patent Application Nos. 2000-187298, 2000-10229, 2000-47345, 2000-206642, 2000-98530, 2000-98531, 2000-113059, 2000-112060, 2000-112104, 2000-112064, 2000-171936.

<Packaging Material for Photothermographic Material>

Preferably, the photothermographic material of the first embodiment of the invention is wrapped with a material of low oxygen and/or moisture permeability for preventing its photographic properties from varying and for preventing it from curling or from having a curled habit while stored as raw films.

Preferably, the oxygen permeability at 25° C. of the packaging material for use herein is at most 50 ml/atm·m²·day, more preferably at most 10 ml/atm·m²·day, even more preferably at most 1.0 ml/atm·m²·day. Also preferably, the moisture permeability thereof is at most 10 g/atm·m²·day, more preferably at most 5 g/atm·m²·day, even more preferably at most 1 g/atm·m²·day.

Preferred examples of the packaging material of low oxygen and/or moisture permeability for use herein are described, for example, in JP-A 8-254793, 2000-206653.

<Exposure and Thermal Development>

A seventh embodiment of the pesent invention is a method of thermal development of a photothermographic material, which comprises a support having thereon a layer including at least a non-photosensitive organic silver salt, a photosensitive silver halide, a reducing agent and a binder; wherein the photosensitive silver halide has a mean silver iodide content of 5 to 100 mol %, and which further comprises at least one compound of the following general formula (I), wherein the highest temperature at thermal development of the photothermographic material is 100 to 120° C.

(X)ₖ—(L)ₘ—(A—B)ₙ General formula (I)

wherein X represents a silver halide-adsorbing group or a light-absorbing group that has at least one atom each of N, S, P, Se and Te; L represents a (k+n)-valent linking group having at least one atom each of C, N, S and O; A represents an electron-donating group; B represents a leaving group or a hydrogen group; A—B is oxidized and then cleaved or deprotonated to generate a radical A; k represents an integer from 0 to 3; m represents 0 or 1; n represents 1 or 2; and when k=0 and n=1, then m=0;

In the method of the present invention, the highest temperature of thermal development of the photothermographic material is preferably 105 to 115° C.

In the method of the present invention, preferably, the photothermographic material is thermally developed while being conveyed through a thermal development zone that comprises from 2 to 6 plate heaters for thermal development and while being kept in contact with the plate heaters in that zone.

In the method of the present invention, the mean grain size of the silver halide is preferably 5 to 80 nm, more preferably 5 nm to 70 nm.

The photothermographic material of the first embodiment of the invention may be developed in any manner. In general, after having been imagewise exposed, it is developed under heat. Preferably, the temperature for the thermal development falls between 80 and 250° C., more preferably between 100 and 140° C., even more preferably between 100 and 120° C., most preferably between 105 and 115° C. The time for the development preferably falls between 1 and 60 seconds, more preferably between 5 and 25 seconds, even more preferably between 7 and 15 seconds.

For thermal development for the photothermographic material, employable is any of a drum heater system or a plate heater system, but preferred is a plate heater system. For the plate heater system for the material, preferred is the method described in JP-A 11-133572. The plate heater system described therein is for thermal development of photothermographic materials, in which a photothermographic material having been exposed to have a latent image thereon is brought into contact with a heating unit in the zone for thermal development to thereby convert the latent image into a visible image. In this, the heating unit comprises a plate heater, and multiple presser rolls are disposed in series on one surface of the plate heater. The exposed photothermographic material is passed between the multiple pressure rolls and the plate heater, whereby it is developed under heat. The plate heater is sectioned into 2 to 6 stages, and it is desirable that the temperature of the top stage is kept lower by 1 to 10° C. or so than that of the others.

For example, four pairs of plate heaters of which the temperature is independently controllable may be used, and they are set at 112° C., 119° C., 121° C. and 120° C. The system of the type is described in JP-A 54-30032. In the plate heater system, water and organic solvent that remain in the photothermographic material being processed can be removed out of the material. In this, in addition, the support of the photothermographic material rapidly heated is prevented from being deformed.

Preferably, the photothermographic material of the first embodiment of the invention is exposed to high-intensity light of at least 1 mW/mm² within a short period of time. The sensitivity of the photothermographic material of this embodiment that contains a high-iodide silver halide emulsion and a non-photosensitive organic silver salt is enough for exposure to such high-intensity light. For the photothermographic material of this embodiment, exposure to high-intensity light is preferred to exposure to low-intensity light in point of the sensitivity of the material.

More preferably, the intensity of light to which the material is exposed falls between 2 mW/mm² and 50 mW/mm², even more preferably between 10 mW/mm² and 50 mW/mm².

The light source for the photothermographic material of this embodiment may be any and every one of the type, for which, however, preferred are laser rays as producing better results.

For the laser rays to which the photothermographic material of the first embodiment of the invention is exposed, preferred are gas lasers (Ar⁺, He—Ne), YAG lasers, color lasers, or semiconductor lasers. Also employable is a combination of semiconductor lasers and secondary harmonics generators. Especially preferred are gas or semiconductor lasers for red to infrared emission. Also preferred are semiconductor lasers for blue to violet emission. One example of high-power semiconductor lasers for blue to violet emission that are employable herein is a Nichia Chemical's semiconductor laser, NLHV300E.

One example of laser imagers for medical treatment equipped with an exposure unit and a thermal development unit that are applicable to this embodiment of the invention is Fuji Medical Dry Laser Imager FM-DP L.

The system FM-DP L is described in Fuji Medical Review No. 8, pp. 39-55. Needless-to-say, the technique disclosed therein is applicable to laser imagers for the photothermographic material of the first embodiment of the invention. In addition, the photothermographic material of this embodiment can be processed in the laser imager in the AD Network which Fuji Medical System has proposed for a network system under DICOM Standards.

The photothermographic material of the first embodiment of the invention forms a monochromatic image based on silver, and is favorable for use in medical diagnosis, industrial photography, printing, and COM.

Twelfth Embodiment of Photothermographic Material

The twelfth embodiment of the photothermographic material of the invention is described below.

The twelfth embodiment of the pesent invention is a photothermographic material comprising a support having thereon a photosensitive silver halide, a non-photosensitive organic silver salt, a thermal-developing agent and a binder; wherein the photosensitive silver halide has a silver iodide content of 40 to 100 mol % and includes a metal selected from the elements of Groups 3 to 10 of the Periodic Table.

<Photosensitive Silver Halide>

The photosensitive silver halide for use in the twelfth embodiment of the invention is described.

<<Halogen Composition>>

For its halogen composition, the photosensitive silver halide for use in the twelfth embodiment of the invention may be any of silver bromoiodide, silver bromochloroiodide and silver iodide.

The silver iodide content of the photosensitive silver halide falls between 40 and 100 mol %, preferably between 70 and 100 mol %, more preferably between 90 and 100 mol %.

<<Method of Forming Grains>>

Preferably, the photosensitive silver halide is in grains in its emulsion.

For forming the photosensitive silver halide grains, for example, employable are the methods described in Research Disclosure 17029 (June 1978), and U.S. Pat. No. 3,700,458. Concretely, a silver source compound and a halogen source compound are added to gelatin or any other polymer solution to prepare a photosensitive silver halide, and it is then mixed with an organic silver salt. Also preferred for forming them are the method described in JP-A 11-119374, paragraphs [0217] to [0244]; and the methods described in Japanese Patent Application Nos. 11-98708 and 2000-42336.

<<Grain Size>>

Preferably, the photosensitive silver halide grains are smaller for preventing the images formed with them from becoming cloudy. Concretely, the grain size of the photosensitive silver halide grains may be at most 0.20 μm, but preferably between 0.01 and 0.15 μm, more preferably between 0.02 and 0.10 μm. The grain size referred to herein is meant to indicate the diameter of the circular image having the same area as the projected area of each photosensitive silver halide grain (for tabular grains, the main face of each grain is projected to determine the projected area of the grain).

<<Grain Morphology>>

Photosensitive silver halide grains generally have different types of morphology, including, for example, cubic grains, octahedral grains, tabular grains, spherical grains, rod-like grains, and potato-like grains. In the twelfth embodiment of the invention, cubic silver halide grains are especially preferred. Also preferred are corner-rounded silver halide grains.

Regarding the halogen composition distribution in each photosensitive silver halide grain, the composition may be or may not be uniform throughout the grain, or may stepwise vary, or may continuously vary.

Core shell structured photosensitive silver halide grains are preferred for use herein. Preferably, the core/shell structure of the grains has from 2 to 5 layers, more preferably from 2 to 4 layers. Also preferred are photosensitive silver halide grains of silver chloride, silver bromide or silver bromochloride with silver iodide localized on their surfaces.

Preferably, the photosensitive silver halide for use in the twelfth embodiment of the invention has a direct transition absorption derived from the silver iodide crystal structure therein, in a wavelength range of from 350 nm to 450 nm. Photosensitive silver halides having such a direct transition for light absorption can be readily differentiated from any others by analyzing them as to whether to not they show an exciton absorption caused by their direction transition at around 400 nm to 430 nm.

FIG. 1 shows the light absorbance curve of a silver iodide emulsion preferred for the photosensitive silver halide for use in the twelfth embodiment of the invention. From FIG. 1, it is understood that the silver iodide emulsion has an exciton absorption caused by the direction transition absorption of silver iodide at around 420 nm.

<<Metal>>

The photosensitive silver halide for use in the twelfth embodiment of the invention contains a metal. The metal is selected from the elements of Groups 3 to 10 of the Periodic Table. Examples of the metal are transition metals including, for example, titanium, vanadium, manganese, iron, ruthenium, osmium, cobalt, rhodium, iridium, nickel, palladium, platinum, copper, silver, gold, zinc and cadmium. Of those metals, preferred are iron, nickel, cobalt, ruthenium, rhodium, rhenium, osmium, iridium, palladium, platinum, gold, silver, copper and zinc; and more preferred are nickel, cobalt, palladium, platinum, and zinc.

Preferably, the metal is in the form of its complex in the photosensitive silver halide. The metal complex is, for example, represented by the following general formula (I′):

(Z1)ₙ[M(L1)ₖ₁(L2)ₖ₂](Z2)ₘ General Formula (I′)

wherein M represents a center metal; L1 and L2 each independently represent a ligand; Z1 represents a counter cation; Z2 represents a counter anion; k1 and k2 each indicate the number of the ligands (an integer of from 0 to 6); k1+k2 falls between 2 and 6, but is preferably 4; and m and n each indicate the number of Z1 and Z2, respectively, necessary for neutralizing the overall charge of the metal complex.

In formula (I′), the center metal for M is a metal selected from the elements of Groups 3 to 10 of the Periodic Table.

For example, it includes transition metals such as titanium, vanadium, manganese, iron, ruthenium, osmium, cobalt, rhodium, iridium, nickel, palladium, platinum, copper, silver, gold, zinc and cadmium. Of those metals, preferred are iron, nickel, cobalt, ruthenium, rhodium, rhenium, osmium, iridium, palladium, platinum, gold, silver, copper and zinc; and more preferred are nickel, cobalt, palladium, platinum, and zinc.

The ligand for L1 and L2 includes, for example, neutral ligands such as carbonyl, aqua, amine, triphenylphosphine; anionic ligands such as halogen atoms, cyano, nitro, hydride, nirito, sulfito, amido, azido, cyanato, thiocyan; and organic ligands such as pyridine, pyrazine, pyridazine, pyrimidine, bipyridine, pyrazole, imidazole, phenanthroline, benzimidazole and their derivatives. The organic ligand is a compound having a linear or cyclic hydrocarbon skeleton structure in which a part of the carbon or hydrogen atoms are optionally substituted with any other atom or atomic group.

The counter cation for Z1 includes, for example, proton, ammonium ion; alkali metal ions such as sodium and potassium ions; and alkaline earth metal ions such as calcium ion. Z1 is preferably a sodium or potassium ion. The counter anion for Z2 includes, for example, halide ions such as chloride ion (Cl⁻), bromide ion (Br⁻), iodide ion (I⁻); and nitrate ion, p-toluenesulfonate ion, perchlorate ion, and sulfate ion. For Z2, preferred are halide ions.

Specific examples of the metal complexes of formula (I′) are mentioned below.

I′-1: K₄[Fe(CN)₆]

I′-2: K₃[Fe(CN)₆]

I′-3: K₄[Ru(CN)₆]

I′-4: K₄[Os(CN)₆]

I′-6: K₃[Rh(CN)₆]

I′-7: K₃[Ir(CN)₆]

I′-8: K₃[Cr(CN)₆]

I′-9: K₃[Re(CN)₆]

I′-10: K₂[Rh(H₂O)Cl₅]

I′-11: K₃[RhCl₆]

I′-12: K₃[RuCl₆]

I′-13: K₃[ReCl₆]

I′-14: K₃[RuBr₆]

I′-15: K₃[OSCl₆]

I′-16: K₃[CrCl₆]

I′-17: K₂[IrCl₆]

I′-18: K₃[IrCl₆]

I′-19: K₃[RhBr₆]

I′-20: K₂[Ru(H₂O)Cl₅]

I′-21: K₂[Pd(CN)₄]

I′-22: K₂[PdCl₄]

I′-23: K₂[PdBr₄]

I′-24: K₂[Pd(NO₂)₄]

I′-25: K₂[Pd(SCN)₄]

I′-26: K₂[Pt(CN)₄]

I′-27: K₂[PtCl₄]

I′-28: K₂[PtBr₄]

I′-29: K₂[PtI₄]

I′-30: K₂[Pt(NO₂)₄]

I′-31: K₂[Pt(SCN)₄]

I′-32: K₂[Pt(NO₂)₂(NH₃)₂]

I′-33: trans-[PtCl₂(NH₃)₂]

I′-34: cis-[PtCl₂(NH₃)₂]

I′-35: K₂[Co(NCO)₄]

I′-36: K₂[CoCl₄]

I′-37: [CoCl₂(H₂O)₂]

I′-38: K₂[Ni(CN)₄]

I′-39: K₂[NiCl₄]

I′-40: K₂[Ni(SCN)₄]

I′-41: K[Au(CN)₄]

I′-42: K[AuCl₄]

I′-43: K[AUI₄]

I′-44: K[Pt(CN)₃(py)] (py is pyridine.)

I′-45: K[Pd(CN)₃(pY)]

I′-46: K[Pt(CN)₂(bpy)] (bpy is 2,2′-bipyridine.)

I′-47: K[Pd(CN)₂(bpy)]

I′-48: K[Pt(CN)₃(pyz)] (pyz is pyrazine.)

I′-49: K[Pd(CN)₃(PYZ)]

I′-50: [Pt(CN)(py)₃]Cl

I′-51: [Pt(CN)(pyz)3]C

I′-52: [Pt(pyz)₂Cl₂]

I′-53: [Fe(py)₄Cl₂]

I′-54: K₄[Pd(py)₂Cl₂]

I′-55: [Co(py)₂Cl₂]

I′-56: [Ag(py)₄Cl₂]

I′-57: K[Pt(CN)₃(pY)]

I′-58: K[Zn(CN)₃(PY)]

I′-59: [Zn(CN)₂(bpy)]

I′-60: [Zn(CN)₂Cl₂]

I′-61: K[Zn(CN)₃(PYZ)]

I′-62: K₂[Zn(CN)₄]

I′-63: K₂[ZnCl₄]

I′-64: K₂[ZnI₄]

I′-65: K₂[Cu(CN)₃(PY)]

I′-66: K[Cu(CN)₂(bpy)]

I′-67: K₃[Cu(CN)₂Cl₂]

I′-68: K₂[Cu(CN)₃(pYz)]

I′-69: K₃[Cu(CN)₄]

I′-70: K₃[CUCl₄]

I′-71: K₃[CUI₄]

I′-72: K[Au(CN)₂(bpy)]

I′-73: K₃[Au(CN)₂Cl₂]

I′-74: K₂[Au(CN)₃(pYz)]

I′-75: K[PtCl₂(Im)₂] (Im is imidazole.)

I′-76: [ZnCl₂(Im)₂]

I′-77: K[PdCl(Im)₃]

I′-78: K₂[PdCl₂(Im)₂]

I′-79: K₂[CUCl₂(Im)2]

I′-80: K[AuCl₂(Im)₂]

I′-81: K[CoCl₃(Im)]

I′-82: [CoCl₂(Im)₂]

I′-83: [CoCl(Im)₃]Cl

I′-84: [Co(Im)₄]Cl₂

I′-85: K[Co(CN)₃(Im)]

I′-86: [Co(CN)₂(Im)₂]

I′-87: [Co(CN)(Im)3]Cl

I′-88: [CoCl₂(bim)₂] (bim is benzimidazole.)

I′-89: [CoCl(bim)₃]Cl

I′-90: [Co(bim)₄]Cl₂

I′-9 1: K[Pt(CN)₂(phen)] (phen is 1,10-phenanthroline.)

I′-92: [Zn(CN)₂(phen)]

I′-93: K[Cu(CN)₂(phen)]

I′-94: K[Au(CN)₂(phen)]

I′-95: K[Co(CN)₂(phen)]

One and the same metal complex, or two or more different types of metal complexes of different metals may be used herein, either singly or as combined.

The metal complex concentration in the photosensitive silver halide for use herein is not specifically defined, falling, for example, between 1×10⁻³ and 1×10⁻² mol/mol of silver, preferably between 1×10⁻⁶ and 1×10⁻³ mol/mol of silver,

The doped amount of the metal complex in the photosensitive silver halide and the doping rate therein may be quantified by analyzing the doped complex for the center atom thereof, for example, through atomic absorption spectrometry, ICP (inductively coupled plasma spectrometry) or ICPMS (inductively coupled plasma mass spectrometry).

For the metals and the metal complexes for use herein, referred to are those described in, for example, JP-A 7-225449; JP-A 11-65021, paragraphs [0018] to [0024]; JP-A 11-119374, paragraphs [0227] to [0240]. For the method of adding the metal and the metal complex to the photosensitive silver halide, referred to are those described in, for example, JP-A 7-225449; JP-A 11-65021, paragraphs [0018] to [0024]; JP-A 11-119374, paragraphs [0227] to [0240].

For the methods of desalting and chemical sensitization of the photosensitive silver halide emulsions for use in the twelfth embodiment of the invention, referred to are those described in, for example, JP-A 11-84574, paragraphs [0046] to [0050]; JP-A 11-65021, paragraphs [0025] to [0031]; JP-A 11-119374, paragraphs [0242] to [0250].

<<Gelatin>>

Preferably, the photosensitive silver halide for use in the twelfth embodiment of the invention contain gelatin. Gelatin of different types may be used in preparing the halide emulsions. Gelatin must be kept well dispersed in the organic silver salt-containing coating liquid of the photosensitive silver halide emulsion, and its molecular weight may falls between 10,000 and 1,000,000, preferably between 50,000 and 500,000 in terms of the mean molecular weight thereof. Gelatin phthalide is also preferred for use herein.

In case where a low-molecular gelatin is used herein, it may be dispersed in the coating liquid during grain formation or after desalting, but is preferably dispersed therein after desalting.

<<Sensitizing Dye>>

The photothermographic material of the twelfth embodiment of the invention may contain a sensitizing dye. For the details of the sensitizing dye usable in this embodiment, referred to are those described in the section of the first embodiment of the invention.

The photothermographic material of the twelfth embodiment of the invention may contain a supersensitizer for further enhancing the spectral sensitivity of the material. For the details of the supersensitizer usable in this embodiment, referred to are those described in the section of the first embodiment hereinabove. One or more different types of supersensitizers may be used herein either singly or as combined.

<<Chemical Sensitization>>

Preferably, the photothermographic material of the twelfth embodiment of the invention is chemically sensitized with any of sulfur, selenium or tellurium. For the details of sulfur, selenium or tellurium sensitization applicable to this embodiment, referred to are those described in the section of the first embodiment hereinabove.

Concretely, for the details of the time of chemical sensitization, the amount of the sulfur sensitizer, selenium sensitizer and tellurium sensitizer for the sulfur, selenium or tellurium sensitization, the mode of gold sensitization, the condition (pH, pAg, temperature) for the chemical sensitization, and the mode of adding thiosulfonic acid compounds, referred to are those described in the section of the first embodiment hereinabove.

The photosensitive silver halide for use in the twelfth embodiment of the invention may be sensitized through reduction sensitization with a reduction sensitizer. For the reduction sensitizer, preferred are ascorbic acid, thiourea dioxide, stannous chloride, aminoimimomethanesulfinic acid, hydrazine derivatives, borane compounds, silane compounds and polyamine compounds.

The reduction sensitizer may be added to the silver halide grains in any stage of preparing the photosensitive silver halide emulsions including the stage of grain growth to just before coating the emulsions.

Preferably, the emulsions are subjected to such reduction sensitization while they are kept ripened at a pH of 7 or more and at a pAg of 8.3 or less. Also preferably, they may be subjected to reduction sensitization while the grains are formed with a single addition part of silver ions being introduced thereinto.

When the photosensitive silver halide is formed into its emulsion in the twelfth embodiment of the invention, it is desirable that an FED sensitizer (fragmentable electron donating sensitizer) of a compound capable of generating two electrons from one photon is added to the emulsion. For the FED sensitizer for use herein, preferred are the compounds described in U.S. Pat. Nos. 5,747,235, 5,747,236, 6,054,260, 5,994,051, and Japanese Patent Application No. 2001-86161.

The amount of the FED sensitizer to be added to the emulsion varies, depending on various condition, but may generally fall between 10⁻⁷ and 10⁻¹ mols, but preferably between 10⁻⁶ and 5×10⁻² mols per mol of the silver halide in the emulsion.

Adding the FED sensitizer to the photosensitive silver halide emulsion may be effected in any stage of preparing the emulsion including the stage of grain growth to just before coating the emulsion.

The photothermographic material of the twelfth embodiment of the invention may contain only one type or two or more different types of photosensitive silver halide grains (these will differ in their mean grain size, halogen composition or crystal habit, or in the condition for their chemical sensitization), either singly or as combined. Combining two or more types of photosensitive silver halide grains differing in their sensitivity will enable to control the gradation of the images to be formed in the photothermographic material. The sensitivity difference between the combined silver halide grains is preferably such that the respective emulsions differ from each other at least by 0.2 logE. For the technique relating to it, referred to are JP-A 57-119341, 53-106125, 47-3929, 48-55730, 46-5187, 50-73627, 57-150841.

<<Amount of Photosensitive Silver Halide in Photothermographic Material>>

The amount of the photosensitive silver halide grains to be in the photothermographic material of this embodiment is, in terms of the amount of silver per m² of the material, preferably from 0.03 to 0.6 g/m², more preferably from 0.07 to 0.4 g/m², most preferably from 0.05 to 0.3 g/m². Relative to one mol of the organic silver salt therein, the amount of the photosensitive silver halide grains to be in the material preferably falls between 0.01 mols and 0.5 mols, more preferably between 0.02 mols and 0.3 mols, even more preferably between 0.03 mols and 0.2 mols.

<<Mode of Mixing Photosensitive Silver Halide and Organic Silver Salt>>

Regarding the method and the condition for mixing the photosensitive silver halide grains and an organic silver salt having been prepared separately (the organic silver salt is described hereinunder), for example, employable is a method of mixing them in a high-performance stirrer, a ball mill, a sand mill, a colloid mill, a shaking mill, a homogenizer or the like; or a method of adding the photosensitive silver halide grains having been prepared to the organic silver salt being prepared, in any desired timing to produce the organic silver salt mixed with the silver halide grains. However, there is no specific limitation thereon, so far as the methods employed ensure the advantages of the twelfth embodiment of the invention. Mixing two or more different types of aqueous, organic silver salt dispersions with two or more different types of aqueous, photosensitive silver salt dispersions is preferred for suitably controlling the photographic properties of the photothermographic material of the invention.

<<Mode of Mixing Photosensitive Silver Halide in Coating Liquid>>

The preferred time at which the photosensitive silver halide grains are added to the coating liquid which is to form the image-forming layer on the support of the photothermographic material of the invention may fall between 180 minutes before coating the liquid and a time just before the coating, preferably between 60 minutes before the coating and 10 seconds before it. However, there is no specific limitation thereon, so far as the method and the condition employed for adding the grains to the coating liquid ensure the advantages of the twelfth embodiment of the invention. Concretely for mixing them, employable is a method of adding the grains to the coating liquid in a tank in such a controlled manner that the mean residence time for the grains in the tank, as calculated from the amount of the grains added and the flow rate of the coating liquid to a coater, could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<Non-Photosensitive Organic Silver Salt>

For the details of the non-photosensitive organic silver salt for use in this embodiment, referred to are those described in the section of the first embodiment of the invention.

Concretely, specific examples of the silver salts of fatty acids for use herein are silver lignocerate, silver behenate, silver arachidate, silver stearate, silver oleate, silver laurate, silver caproate, silver myristate, silver palmitate, silver erucate, and their mixtures.

<Reducing Agent>

The photothermographic material of the twelfth embodiment of the invention preferably contains a thermal developing agent (this is hereinafter referred to as “reducing agent”) for the organic silver salt therein. For the details of the reducing agent usable in this embodiment, referred to are those described in the section of the first embodiment of the invention.

<Development Accelerator>

Specific examples of the development accelerator for use in the twelfth embodiment of the invention are mentioned below [(A′-1) to (A′-10)], to which, however, this embodiment is not limited.

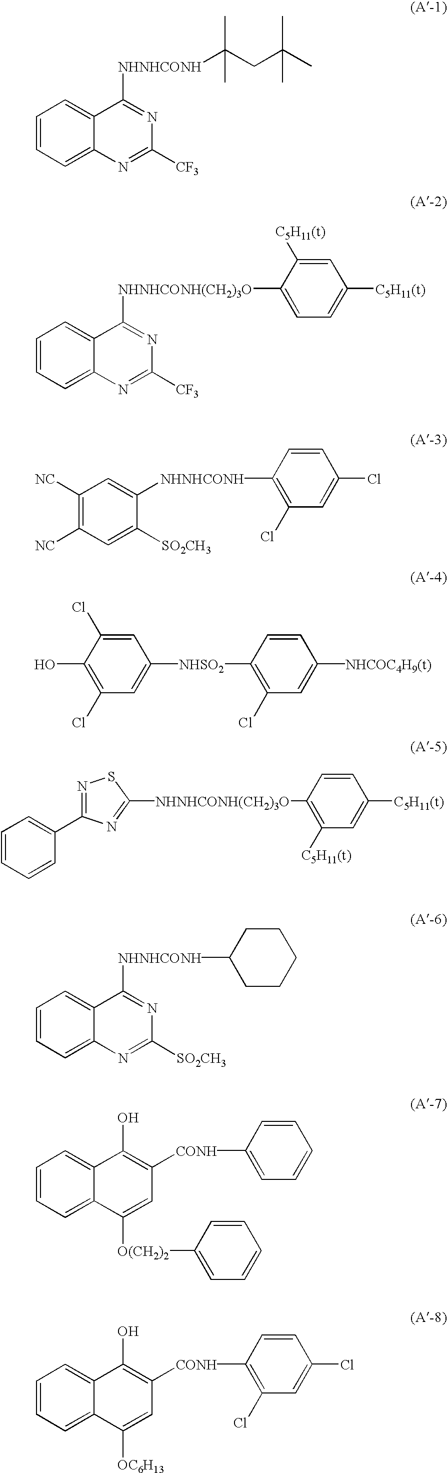

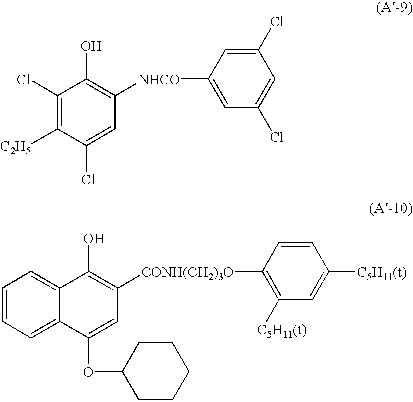

<Hydrogen Bonding Type Compound>

In case where the reducing agent in the twelfth embodiment of the invention has an aromatic hydroxyl group (—OH), especially when it is any of the above-mentioned bisphenols, the reducing agent is preferably combined with a non-reducing compound that has a group capable of forming a hydrogen bond with the group in the reducing agent. The non-reducing compound is hereinafter referred to as “Hydrogen bonding type compound”. For the details of the Hydrogen bonding type compound usable in this embodiment, referred to are those described in the section of the first embodiment of the invention.

<Binder>

In the twelfth embodiment of the invention, the non-photosensitive organic silver salt-containing layer formed on the support preferably contains a binder. For the details of the binder usable in this embodiment, referred to are those described in the section of the first embodiment of the invention.

<Solvent Preferred for Coating Liquid>

The solvent for the coating liquid for the organic silver salt-containing layer of the photothermographic material of the twelfth embodiment of the invention is not specifically defined, and any of water and organic solvents such as those mentioned below are usable for it. Preferably, however, the solvent is an aqueous solvent that contains at least 30% by weight of water. The solvent referred to herein is meant to indicate both solvent and dispersion medium for simple expression.

For the details of the solvents except water, including the preferred water content and the preferred solvent composition, referred to are those described in the section of the first embodiment of the invention.

<Antifoggant and Others>

In the twelfth embodiment of the invention, usable are an antifoggant, a stabilizer and a stabilizer precursor. For the details of the antifoggant, stabilizer and stabilizer precursor, including the description and specific examples of organic polyhalogen compounds serving as an antifoggant and those of other antifoggants and azolium salts, referred to is the description relating to them given in the section of the first embodiment of the invention.

<Other Additives>

<<Mercapto, Disulfide and Thione Compounds>>

The photothermographic material of the twelfth embodiment of the invention may optionally contain any of mercapto compounds, disulfide compounds and thione compounds which are for retarding, promoting or controlling the developability of the material, or for enhancing the spectral sensitivity thereof, or for improving the storage stability thereof before and after development. For the details of the mercapto compounds, disulfide compounds and thione compounds usable in this embodiment, referred to are those described in the section of the first embodiment of the invention.

<<Toning Agent>>

The photothermographic material of the twelfth embodiment of the invention may optionally contain a toning agent. For the details of the toning agent usable in this embodiment, referred to are those described in the section of the first embodiment of the invention.

<<Plasticizer, Lubricant>>

In its photosensitive layer, the photothermographic material of the twelfth embodiment of the invention may optionally contain a plasticizer and a lubricant. For the details of the plasticizer and the lubricant usable in this embodiment, referred to are those described in the section of the first embodiment of the invention.

<<Super-Hardener>>

In its photosensitive layer, the photothermographic material of the twelfth embodiment of the invention may optionally contain a super-hardener. For the details of the super-hardener usable in this embodiment, referred to are those described in the section of the first embodiment of the invention.

In its photosensitive layer, the photothermographic material of the twelfth embodiment of the invention may optionally contain a hardening promoter. For the details of the hardening promoter usable in this embodiment, referred to are those described in the section of the first embodiment of the invention.

The photothermographic material of the twelfth embodiment of the invention may optionally contain formic acid or its salt that serves as a strong foggant. In case where the material contains such a strong foggant, formic acid or its salt, it is desirable that at most 5 mmols, preferably at most 1 mmol of the strong foggant is added to the side of the material on which is formed a photosensitive silver halide-containing, image-forming layer.

In case where a super-hardener is used in the photothermographic material of the twelfth embodiment of the invention, it is preferably combined with an acid formed through hydration of diphosphorus pentoxide or its salt. For the details of the acid formed through hydration of diphosphorus pentoxide or its salt usable in this embodiment, referred to are those described in the section of the first embodiment of the invention.

<Preparation of Coating Liquid>

For the details of the preparation of the coating liquids for use in this embodiment, referred to are those described in the section of the first embodiment of the invention.

<Layer Constitution>

For the details of the layer constitution (surface protective layer, antihalation layer, back layer, matting agent, film surface pH, hardening agent, surfactant, electroconductive layer, support, other additives) in this embodiment, referred to are those described in the section of the first embodiment of the invention.

<Fabrication of Photothermographic Material>

For the details of the mode of fabricating of the photothermographic material of this embodiment, referred to are those described in the section of the first embodiment of the invention.

<Packaging Material for Photothermographic Material>

Preferably, the photothermographic material of the twelfth embodiment of the invention is wrapped with a material of low oxygen and/or moisture permeability for preventing its photographic properties from varying and for preventing it from curling or from having a curled habit while stored as raw films. For the details of the packaging material for use in this embodiment (including the preferred data of oxygen permeability and moisture permeability of the packaging material and the preferred examples of the material), referred to are those described in the section of the first embodiment of the invention.

<Exposure and Thermal Development>

For the details of the mode of exposure to light and thermal development of the photothermographic material of this embodiment, referred to are those described in the section of the first embodiment of the invention.

The photothermographic material of the twelfth embodiment of the invention forms a monochromatic image based on silver, and is favorable for use in medical diagnosis, industrial photography, printing, and COM.

Eighteenth Embodiment of Photothermographic Material

The eighteenth embodiment of the photothermographic material of the invention is described below.

The eighteenth embodiment of the pesent invention is a photothermographic material comprising a support having thereon an image-forming layer including at least a non-photosensitive organic silver salt, a photosensitive silver halide, a reducing agent and a binder; and further comprising a compound having a silver halide-adsorbing group and a reducing group or a precursor thereof.

Preferably, the material may have a surface protective layer on the image-forming layer, and may have a back layer and a back protective layer on the side opposite to the image-forming layer.

Image-Forming Layer

<Compound Having a Silver Halide-Adsorbing Group and a Reducing Group>

The compound having a silver halide-adsorbing group and a reducing group, which is for use in the eighteenth embodiment of the invention, is described in detail.

Concretely, the compound having a silver halide-adsorbing group and a reducing group is represented, for example, by the following general formula (I″):

A—(W)n—B General Formula (I″)

wherein A represents an atomic group that contains a silver halide-adsorbing group; W represents a divalent linking group; n indicates 0 or 1; and B represents a reducing group.

Formula (I″) is described in detail.

In formula (I″), the atomic group that contains a silver halide-adsorbing group for A concretely includes mercapto compounds (e.g., mercaptotetrazole, mercaptotriazole, mercaptoimidazole, mercaptothiadiazole, mercaptoxadiazole, mercaptobenzothiazole, mercaptobenzoxazole, mercaptobenzimidazole, mercaptotetrazaindene, mercaptopyridyl, mercaptoalkyl and mercaptophenyl groups), thione compounds (e.g., thiazoline-2-thione, imidazoline-2-thione, benzimidazoline-2-thione, benzothiazoline-2-thione, thiourea and thioamido groups), imino silver-forming compounds (e.g., benzotriazole, tetrazole, hydroxytetrazaindene and benzimidazole groups), benzothiazole compounds, benzimidazole compounds and benzoxazole compounds. Above all, preferred are mercapto compounds and thione compounds.

In formula (I″), the divalent linking group for W is composed of any of carbon, hydrogen, oxygen, nitrogen and sulfur atoms, concretely representing an alkylene group having from 1 to 20 carbon atoms (e.g., methylene, ethylene, trimethylene, tetramethylene, hexamethylene), an arylene group having from 6 to 20 carbon atoms (e.g., phenylene, naphthylene), —CONR₁—, —SO₂NR₂—, —O—, —S—, —NR₃—, —NR₄CO—, —NR₅SO₂—, —NR₆CONR₇—, —COO—or —OCO—. R₁, R₂, R₃, R₄, R₅, R₆ and R₇ each represent a hydrogen atom, an aliphatic group or an aromatic group.

In formula (I″), the aliphatic group for R₁, R₂, R₃, R₄, R₅, R₆ and R₇ is preferably a linear, branched or cyclic alkyl, alkenyl, alkynyl or aralkyl group having from 1 to 30 carbon atoms, more preferably from 1 to 20 carbon atoms. Examples of the alkyl, alkenyl, alkynyl and aralkyl groups are methyl, ethyl, isopropyl, t-butyl, n-octyl, n-decyl, n-hexadecyl, cyclopropyl, cyclopentyl, cyclohexyl, allyl, 2-butenyl, 3-pentenyl, propargyl, 3-pentynyl and benzyl groups.

In formula (I″), the aromatic group for R₁, R₂, R₃, R₄, R₅, R₆ and R₇ is preferably a monocyclic or condensed cyclic aryl group having from 6 to 30 carbon atoms, more preferably from 6 to 20 carbon atoms, and is, for example, a phenyl or naphthyl group.

The groups mentioned above may be combined to form a divalent linking group.

In formula (I″), the reducing group for B may be any and every functional group capable of reducing silver halides. Concretely, it includes, for example, a formyl group, an amino group, a triple bond-having group such as acetylene or propargyl group, an alkylmercapto group, an arylmercapto group and groups of general formulae (B₁) to (B₃) mentioned below, as well as groups derived from any of reductones, phenols, naphthols, phenylenediamines and 1-phenyl-3-pyrazolidones that will be mentioned hereinunder. Above all, it is preferably a formyl group, an amino group, a triple bond-having group, a group of formulae (B₁) to (B₃), or a group derived from any of reductones, phenols, naphthols, phenylenediamines and 1-phenyl-3-pyrazolidones.

Precursors of the compounds having such a silver halide-adsorbing group and a reducing group include, for example, those capable of releasing an adsorbing mercapto group and a reducing formyl group through hydrolysis, such as thiazoliums (including benzothiazoliums and naphthothiazoliums), thiazolines and thiazolidines; and disulfide compounds having a reducing group, of which the disulfide group is cleaved to give an adsorbing mercapto group. For the precursors, preferred are those capable of releasing the compound of formula (I″) when added to silver halide emulsions, and thiazoliums having a triple bond-having substituent.

Specific examples of the compounds for use in the eighteenth embodiment of the invention, which have any of a formyl group, an amino group, a triple bond-having group, an alkylmercapto group or an arylmercapto group that serves as a reducing group. However, the eighteenth embodiment of the invention is not limited to these examples.

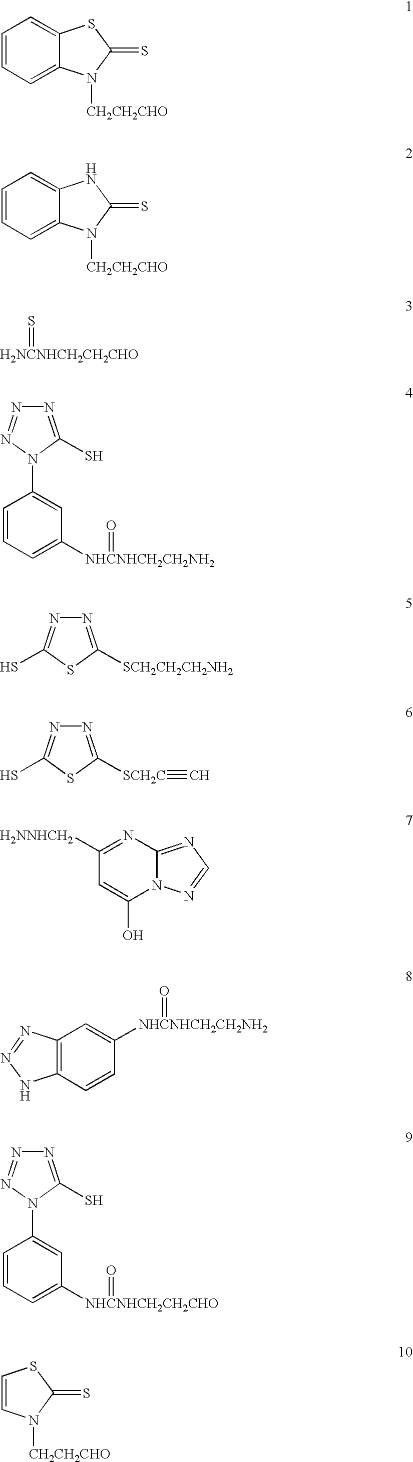

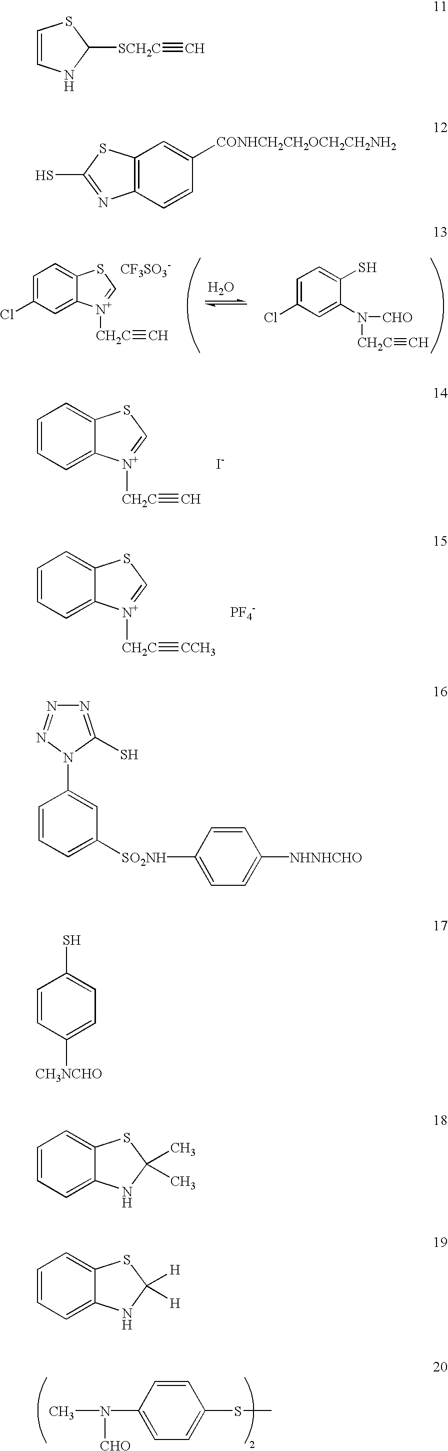

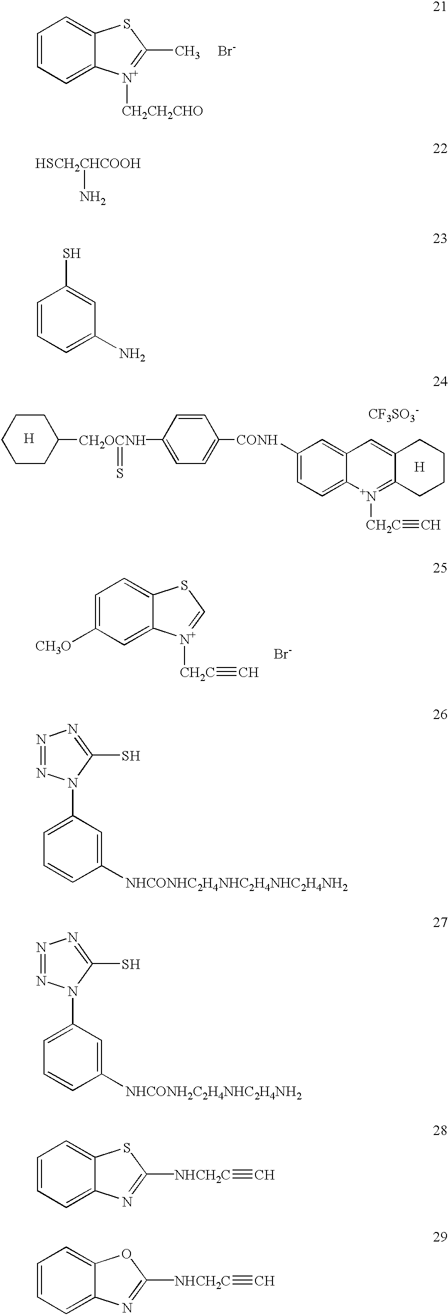

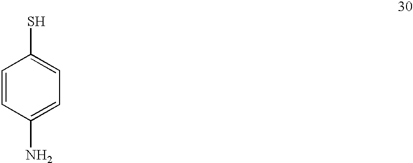

Other preferred examples of the compounds having a silver halide-adsorbing group and a reducing group that are for use in the eighteenth embodiment of the invention are compounds having any of the following groups (B₁) to (B₃) for the reducing group of formula (I″). In the groups (B₁) to (B₃), R_{b1} and R_{b2} each independently represent a hydrogen atom, an alkyl group, an alkenyl group, an alkynyl group, an aryl group or a heterocyclic group.

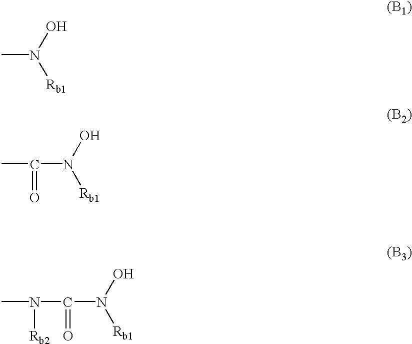

The alkyl group for R_{b1} and R_{b2} in (B₁) to (B₃) is preferably a substituted or unsubstituted alkyl group having from 1 to 20 carbon atoms (e.g., methyl, ethyl, n-propyl, i-propyl, cyclopropyl, i-butyl, cyclohexyl, t-octyl, decyl, dodecyl, hexadecyl, benzyl), more preferably an unsubstituted linear alkyl group, most preferably a methyl group.

The alkenyl group for R_{b1} and R_{b2} is preferably a substituted or unsubstituted alkenyl group having from 2 to 20 carbon atoms (e.g., vinyl, allyl, 2-butenyl, oleyl, i-propenyl), more preferably an unsubstituted linear alkenyl group, most preferably an allyl group.

The alkenyl group for R_{b1} and R_{b2} is preferably a substituted or unsubstituted alkynyl group having from 2 to 20 carbon atoms (e.g., ethynyl, propargyl, trimethylsilylethynyl), more preferably an unsubstituted linear alkynyl group.

The aryl group for R_{b1} and R_{b2} is preferably a substituted or unsubstituted aryl group having from 6 to 20 carbon atoms (e.g., phenyl, naphthyl), more preferably a substituted or unsubstituted phenyl group.

The heterocyclic group for R_{b1} and R_{b2} is preferably a divalent group derived from a 5-membered or 6-membered, substituted or unsubstituted, aromatic or non-aromatic heterocyclic compound by removing one hydrogen atom from it (e.g., 2-furyl, 2-thienyl, 2-pyrimidinyl, 2-benzothiazoyl), more preferably an aromatic heterocyclic group. These groups may be substituted.

R_{b1} is preferably a hydrogen atom or an alkyl group, more preferably an alkyl group, even more preferably a methyl group.

R_{b2} is preferably a hydrogen atom or an alkyl group, more preferably a hydrogen atom.

Still other preferred examples of the compounds having a silver halide-adsorbing group and a reducing group that are for use in the eighteenth embodiment of the invention are compounds having, for the reducing group of formula (I″), a group derived from any of reductones, phenols, naphthols, phenylenediamines and 1-phenyl-3-pyrazolidones. The phenols for these include, for example, hydroxybenzenes, dihydroxybenzenes, polyhydroxybenzenes (e.g., pyrogallol), aminophenols, and sulfonamidophenols. The naphthols include, for example, 1,4-naphthols and 1,5-naphthols. The groups derived from these compounds by removing one hydrogen atom from the benzene ring thereof may be the reducing groups in the eighteenth embodiment of the invention. In the reducing groups of the type, the position at which one hydrogen atom has been removed from the compounds to give the groups shall be the bonding site of each group.

Of the reducing groups mentioned above, preferred for use herein are those derived from any of phenols, phenylenediamines and 1-phenyl-3-pyrazolidones.

Preferred examples of the compounds in which the reducing group is a group of formulae (B₁) to (B₃) or a group derived from any of reductones, phenols, naphthols, phenylenediamines and 1-phenyl-3-pyrazolidones are mentioned below [Compounds (I″-1) to (I″-77)], to which, however, the eighteenth embodiment of the invention is not limited.

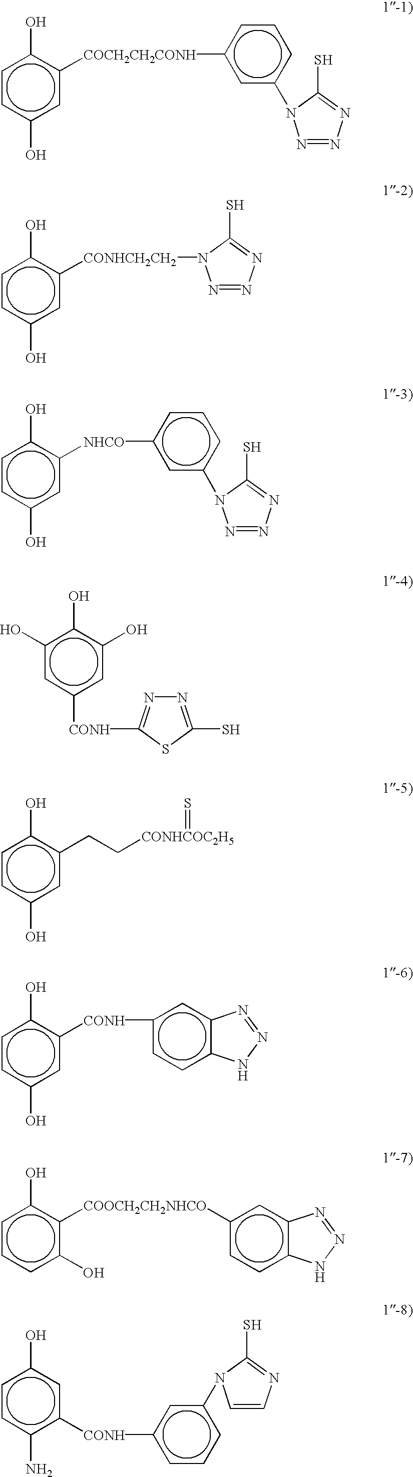

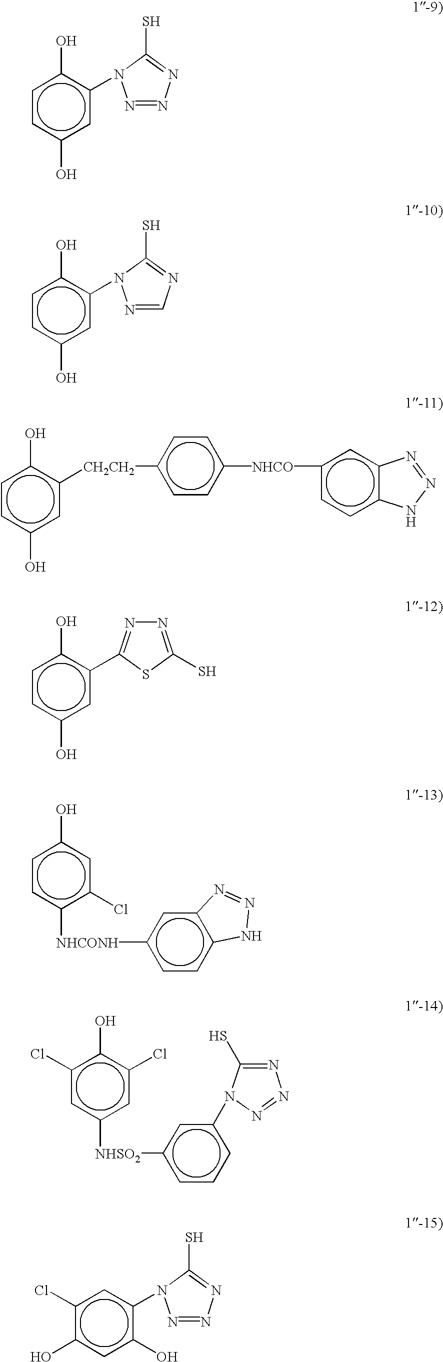

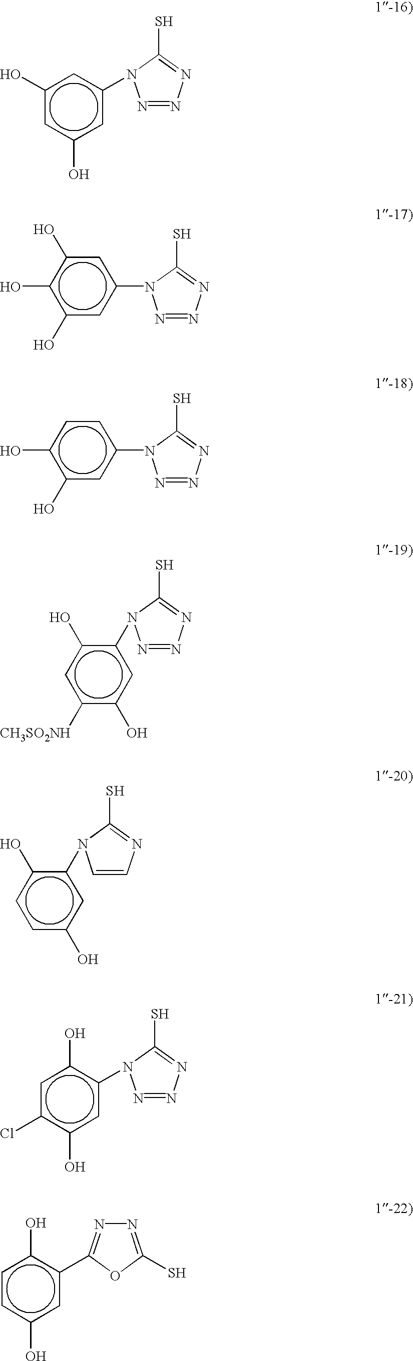

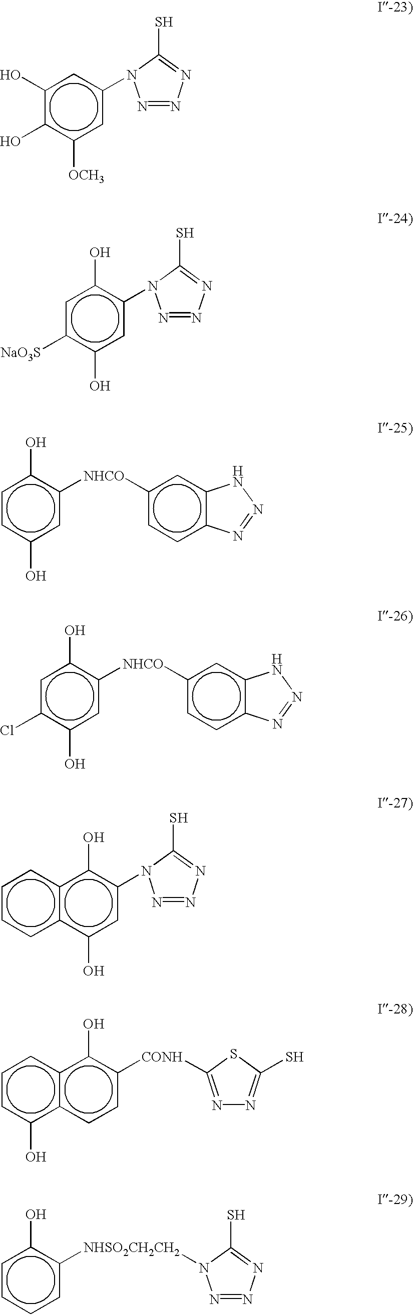

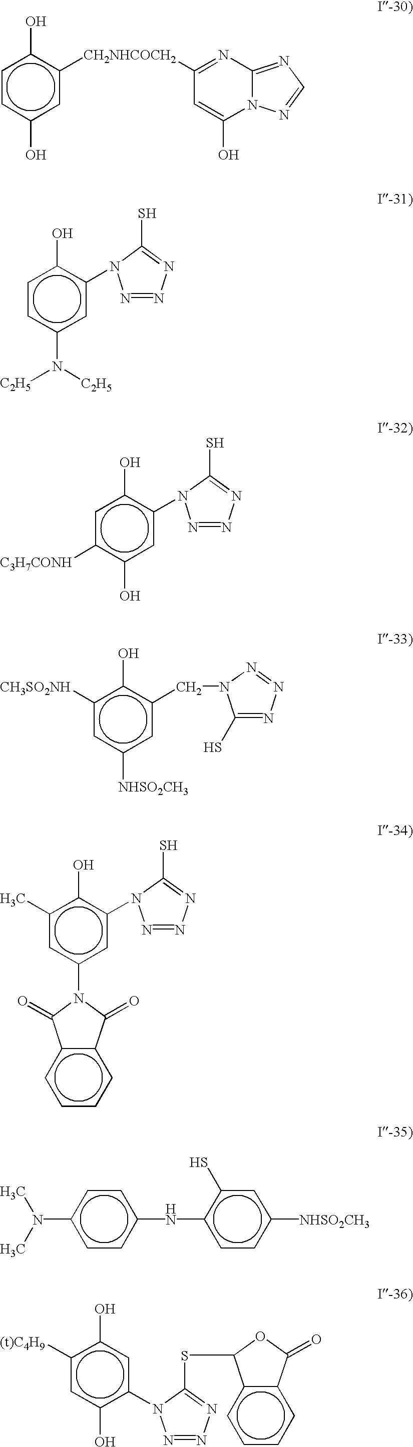

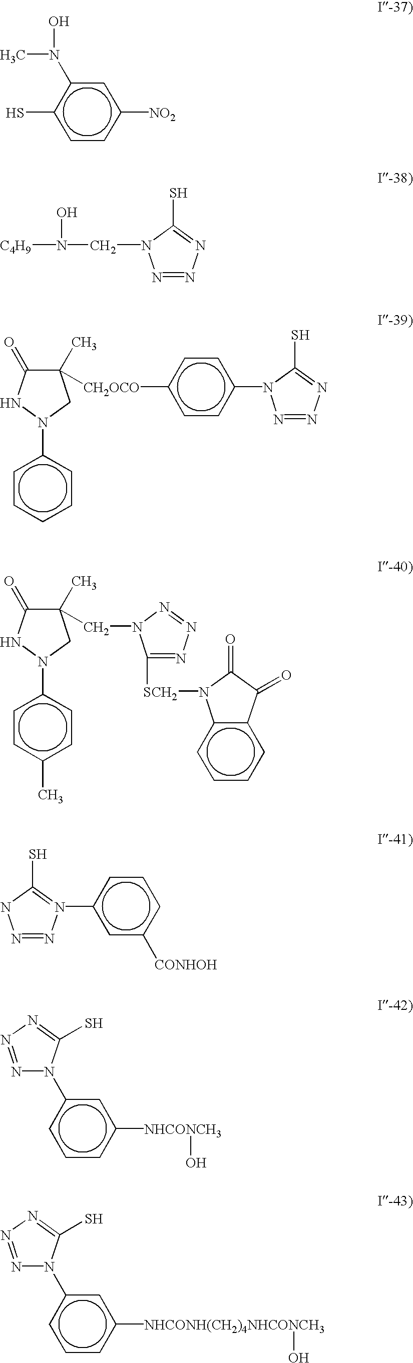

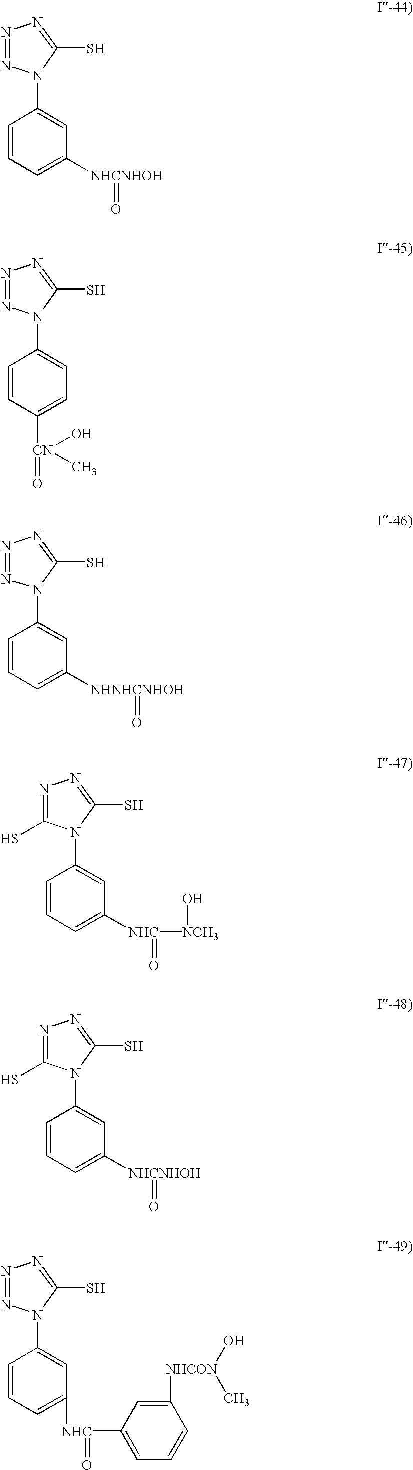

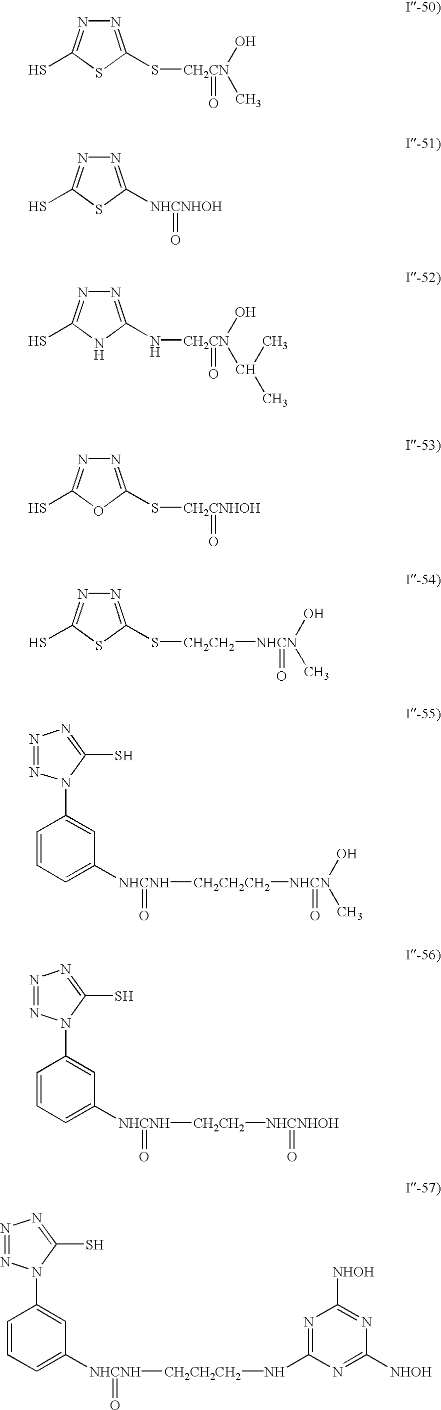

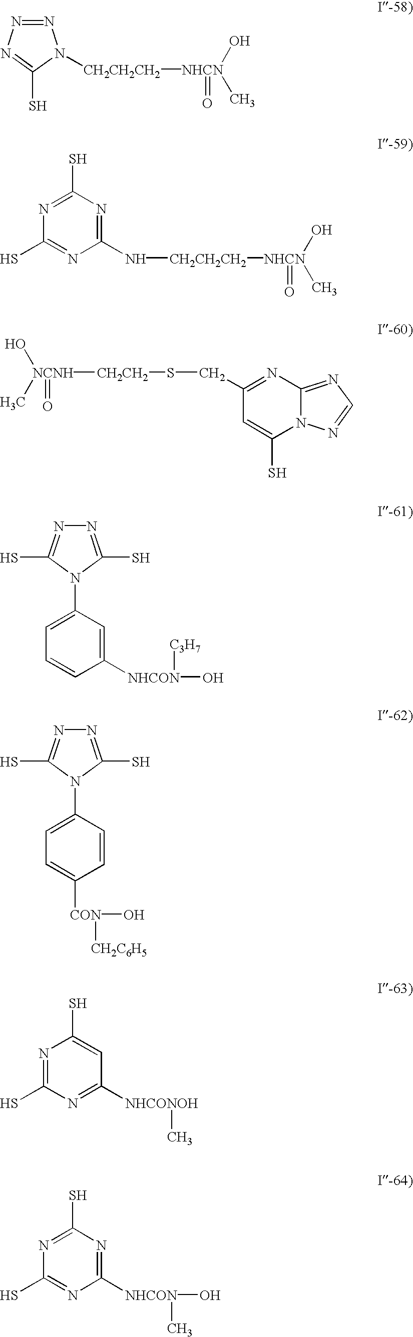

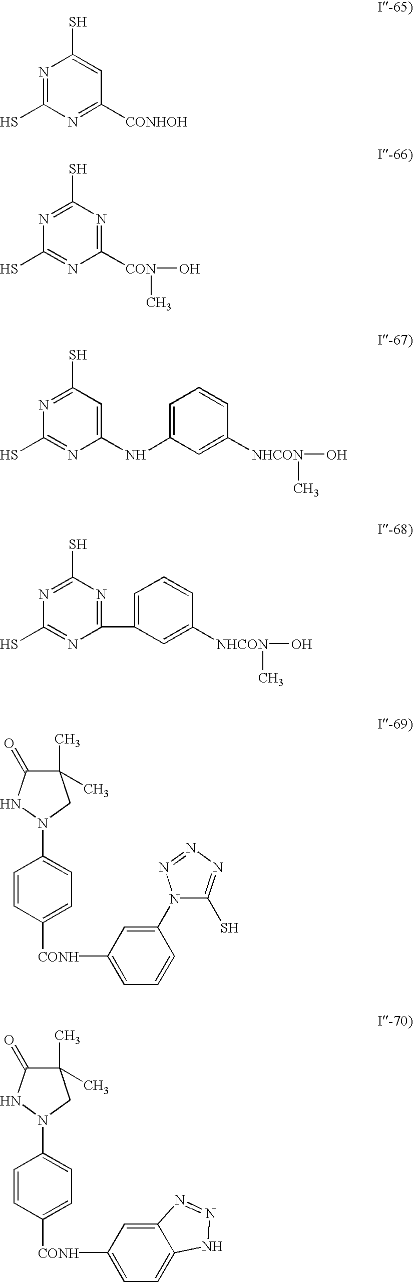

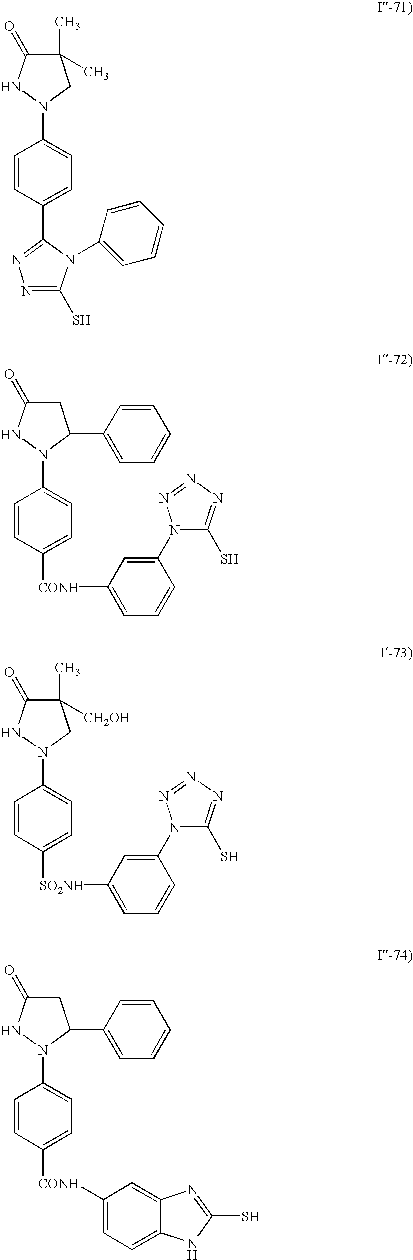

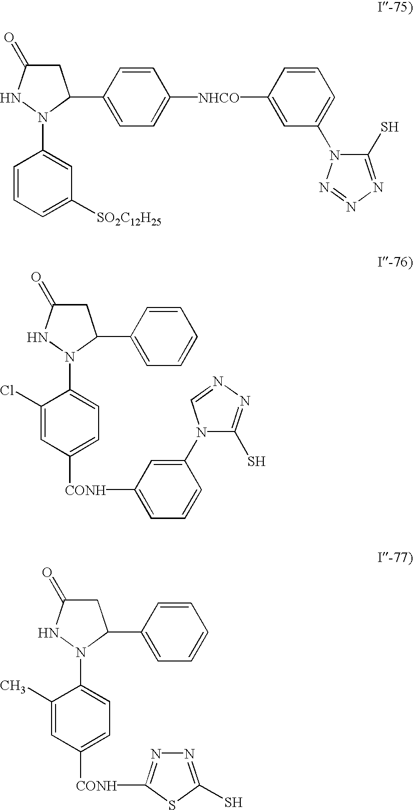

The above-mentioned compounds may be produced with reference to the methods described in JP-A 61-90153 and 4-368935 or to the methods described in patent publications that are referred to therein. Specifically, the compounds having a hydroxylamine partial structure may be produced according to two different methods. One method comprises reacting a divalent linking group moiety with an adsorbing group followed by further reacting a hydroxyamine moiety with it; and the other method comprises reacting a divalent linking group with a hydroxylamine moiety followed by further reacting an adsorbing group with it. Of the two, preferred is the former. Anyhow, the compounds may be produced according to ordinary techniques of organic synthesis.

The amount of the compound of formula (I″) to be in the photothermographic material of this embodiment varies, depending on the silver halide grains to be in the material, but may fall generally between 10-6 and 1 mol, preferably between 10⁻⁵ and 10⁻¹ mols, more preferably between 10⁻⁴ and 10⁻² mols per mol of the silver halide in the material.

In the eighteenth embodiment of the invention, the compound may be added to the material in the form of its solution in a solvent, for example, water or an organic solvent miscible with water and not having any negative influence on the photographic properties of the material—the organic solvent may be selected from alcohols, glycols, ketones, esters, amides and the like—or in the form of its solid dispersion.

The time at which the compound of formula (I″) is added to the photothermographic material of the eighteenth embodiment of the invention may be any stage after the formation of the grains for the high silver iodide emulsions but before coating the emulsions. Preferably, however, the compound is added thereto during the stage before the start of chemical sensitization of the grains and just before coating the emulsions. Especially preferably, it is added thereto just before coating the emulsions.

<Photosensitive Silver Halide Grain>

The photosensitive silver halide for use in the eighteenth embodiment of the invention is described in detail.

<<Halogen Composition>>

It is a matter of importance that the photosensitive silver halide for use in the eighteenth embodiment of the invention has a high silver iodide content falling between 40 mol % and 100 mol %. The other halogen composition except silver iodide is not specifically defined, but is preferably selected from silver chloride, silver bromide, silver thiocyanate, silver phosphate and other organic silver salts. Especially preferably, it is silver bromide or silver chloride. Using the silver halide composition having such a high silver iodide content has made it possible to design the photothermographic material of this embodiment that has the advantages of good image storability after thermal development and good fogging resistance in exposure to light.

More preferably, the silver iodide content of the silver halide for use herein falls 80 mol % and 100 mol %, even more preferably between 85 mol % and 100 mol %, still more preferably between 90 mol % and 100 mol % for better light-fast image storability of the processed material.

Regarding the halogen composition distribution in each silver halide grain, the composition may be uniform throughout the grain, or may stepwise vary, or may continuously vary. Core/shell structured silver halide grains are also preferred for use herein. Preferably, the core/shell structure of the grains has from 2 to 5 layers, more preferably from 2 to 4 layers. Also preferred are core/shell structured silver halide grains in which the core is of a high silver iodide composition or the shell is of a high silver iodide composition. A technique of localizing silver chloride or silver bromide epitaxially grown on the surfaces of silver halide grains is also preferably employed herein.

<<Grain Size>>

The grain size is a matter of great importance for the high silver iodide composition for use in the eighteenth embodiment of the invention. Using too large silver halide grains results in the increase in the coating amount of the silver halide necessary for attaining the intended maximum image density. We, the present inventors have found that, if the coating amount of the high silver iodide emulsion for use in this embodiment increases, it significantly detracts from the developability of the photothermographic material and lowers the sensitivity thereof, and, in addition, it detracts from the image density stability relative to the time for developing the material. In this connection, we have also found that silver halide grains larger than a predetermined level could not form high density images with a predetermined development time. On the other hand, we have further found that, when the coating amount of the silver iodide-rich emulsion is limited, then the developability of the photothermographic material is good.

Accordingly, the grain size of the silver iodide-rich grains must be far smaller than that of conventional silver bromide grains or silver bromoiodide grains having a low iodide content in order that the silver iodide-rich grains attain a satisfactory maximum optical density. Therefore in this embodiment of the invention, the grain size of the silver halide preferably falls between 5 nm and 70 nm, more preferably between 5 nm and 55 nm, even more preferably between 10 nm and 45 nm. The grain size referred to herein is meant to indicate the diameter of the circular image having the same area as the projected area of each silver halide grain analyzed through electromicroscopy.

<<Coating Amount of Silver Halide Grains Photothermographic Material>>

Preferably, the coating amount of the silver halide grains of that type falls between 0.5 mol % and 15 mol %, more preferably between 0.5 mol % and 12 mol %, even more preferably not larger than 10 mol % per mol of silver in the non-photosensitive organic silver salt that will be described hereinunder. Still more preferably, it falls between 1 mol % and 9 mol %, further more preferably between 1 mol % and 7 mol %. As so mentioned above, the silver iodide-rich silver halide composition for use herein significantly retards the developability of the photothermographic material containing it, if its coating amount is too large. To solve the problem, we, the present inventors have found that suitably selecting the coating amount of the silver iodide-rich silver halide composition to fall within the range as above is a matter of great importance.

<<Method of Forming Grains>>

Methods of forming the photosensitive silver halide are well known in the art, for example, as in Research Disclosure 17029 (June 1978), and U.S. Pat. No. 3,700,458, and any known method is employable in the invention. Concretely, a silver source compound and a halogen source compound are added to gelatin or any other polymer solution to prepare a photosensitive silver halide, and it is then mixed with an organic silver salt. Also preferred are the method described in JP-A 11-119374, paragraphs [0217] to [0244]; and the methods described in JP-A 11-352627 and Japanese Patent Application No. 2000-42336.

<<Grain Morphology>>

Silver halide grains generally have different types of morphology, including, for example, cubic grains, octahedral grains, tetradecahedral grains, dodecahedral grains, tabular grains, spherical grains, rod-like grains, and potato-like grains. Of those, dodecahedral grains, tetradecahedral grains and tabular grains are preferred. The silver iodide-rich silver halide grains for use in the eighteenth embodiment of the invention have some complicated morphology. For one preferred morphology of the grains for use in this embodiment, referred to are conjugate grains as in R. L. Jenkins et al's Journal of Photo. Sci., Vol. 28 (1980), page 164, FIG. 1. Also preferred are tabular grains as in FIG. 1 of that literature. Still preferred are corner-rounded silver halide grains. The surface index (Miller index) of the outer surface of the photosensitive silver halide grains for use in this embodiment is not specifically defined, but is desirably such that the proportion of {100} plane, which ensures higher spectral sensitization when it has adsorbed a color-sensitizing dye, in the outer surface is larger. Preferably, the proportion of {100} plane in the outer surface is at least 50%, more preferably at least 65%, even more preferably at least 80%. The Miller index indicated by the proportion of {100} plane can be identified according to the method described by T. Tani in J. Imaging Sci., 29, 165 (1985), based on the adsorption dependency of sensitizing dye onto {111} plane and {100} plane.

<<Heavy Metal>>

Silver halide grains having a hexacyano-metal complex in their outermost surfaces are preferred for use in the eighteenth embodiment of the invention. Preferred examples of the hexacyano-metal complex are [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻. Of those, more preferred are hexacyano-Fe complexes for use in this embodiment.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions. For the details of the hexacyano-metal complexes and the metals of Groups 8 to 10 of the Periodic Table and their metal complexes that may be added to the photosensitive silver halide grains for use in this embodiment, referred to are those described in the section of the first embodiment of the invention.

<<Gelatin>>

For the details of gelatin usable in the photosensitive silver halide emulsions in this embodiment, referred to are those described in the section of the first embodiment of the invention.

<<Chemical Sensitization>>

The photosensitive silver halide for use in the eighteenth embodiment of the invention may undergo no chemical sensitization, but is preferably subjected to at least one chemical sensitization of chalcogen sensitization, gold sensitization or reduction sensitization. The chalcogen sensitization includes sulfur sensitization, selenium sensitization and tellurium sensitization.

In sulfur sensitization, used is an unstable sulfur compound, for example, as in P. Grafkides' Chimie et Physique Photographique (published by Paul Montel, 1987, Ed. 5) and Research Disclosure, Vol. 307, No. 307105.

Concretely, known sulfur compounds such as thiosulfates (e.g., hypo), thioureas (e.g., diphenylthiourea, triethylthiourea, N-ethyl-N′-(4-methyl-2-thiazolyl)thiourea, carboxymethyltrimethylthiourea), thioamides (e.g., thioacetamide), rhodanines (e.g., diethylrhodanine, 5-benzylidene-N-ethylrhodanine), phosphine sulfides (e.g., trimethylphosphine sulfide), thiohydantoins, 4-oxo-oxazolyline-2-thiones, disulfides and polysulfides (e.g., dimorpholine disulfide, cystine, 1,2,3,5,6-pentathiepane), polythionates, and sulfur element, as well as active gelatin are usable. In particular, thiosulfates, thioureas and rhodanines are preferred.

For selenium sensitization, used is an unstable selenium compound, for example, as in JP-B 43-13489, 44-15748; JP-A 4-25832, 4-109340, 4-271341, 5-40324, 5-11385; and Japanese Patent Application Nos. 4-202415, 4-330496, 4-333030, 5-4203, 5-4204, 5-106977, 5-236583, 5-241642, 5-286916.

Concretely usable are colloidal metal selenium, selenoureas (e.g., N,N-dimethylselenourea, trifluoromethylcarbonyl-trimethylselenourea, acetyl-trimethylselenourea), selenamides (e.g., selenamide, N,N-diethylphenylselenamide), phosphine selenides (e.g., triphenylphosphine selenide, pentafluorophenyl-triphenylphosphine selenide), selenophosphates (e.g., tri-p-tolyl selenophosphate, tri-n-butyl selenophosphate), selenoketones (e.g., selenobenzophenone), isoselenocyanates, selenocarboxylic acids, selenoesters, and diaceylselenides. Also usable are non-unstable selenium compounds such as selenious acid, selenocyanates, selenazoles and selenides, as in JP-B 46-4553 and 52-34492. Especially preferred are phosphine selenides, selenoureas and selenocyanates.

In tellurium sensitization, used is an unstable tellurium compound, for example, as in JP-A 4-224595, 4-271341, 4-333043, 5-303157, 6-27573, 6-175258, 6-180478, 6-208186, 6-208184, 6-317867, 7-140579, 7-301879, 7-301880.

Concretely usable are phosphine tellurides (e.g., butyl-diisopropylphosphine telluride, tributylphosphine telluride, tributoxyphosphine telluride, ethoxy-diphenylphosphine telluride), diacyl (di)tellurides (e.g., bis(diphenylcarbamoyl) ditelluride, bis(N-phenyl-N-methylcarbamoyl) ditelluride, bis(N-phenyl-N-methylcarbamoyl) telluride, bis(N-phenyl-N-benzylcarbamoyl) telluride, bis(ethoxycarbonyl) telluride), telluroureas (e.g., N,N′-dimethylethylenetellurourea, N,N′-diphenylethylenetellurourea), telluramides, and telluro-esters. Especially preferred are diacyl (di)tellurides and phosphine tellurides; and more preferred are the compounds described in JP-A 11-65021, paragraphs [0030], and the compounds of formulae (II), (III) and (IV) in JP-A 5-313284.

For the chalcogen sensitization in the eighteenth embodiment of the invention, preferred are selenium sensitization and tellurium sensitization; and more preferred is tellurium sensitization.

For gold sensitization, used is a gold sensitizer, for example, as in P. Grafkides' Chimie et Physique Photographique (published by Paul Montel, 1987, Ed. 5) and Research Disclosure, Vol. 307, No. 307105. Concretely usable are chloroauric acid, potassium chloroaurate, potassium aurithiocyanate, gold sulfide, and gold selenide. In addition to these, also usable are noble metal salts with platinum, palladium or iridium except gold, for example, as in P. Grafkides' Chimie et Physique Photographique (published by Paul Montel, 1987, Ed. 5) and Research Disclosure, Vol. 307, No. 307105.

Gold sensitization may be effected alone, but is preferably combined with chalcogen sensitization. Concretely, the combination includes gold-sulfur sensitization, gold-selenium sensitization, gold-tellurium sensitization, gold-sulfur-selenium sensitization, gold-sulfur-tellurium sensitization, gold-selenium-tellurium sensitization, and gold-sulfur-selenium-tellurium sensitization.

In the eighteenth embodiment of the invention, the silver halides may be chemically sensitized in any stage after their formation but before their coating. For example, they may be chemically sensitized after desalted, but (1) before spectral sensitization, or (2) along with spectral sensitization, or (3) after spectral sensitization, or (4) just before coating.

The amount of the chalcogen sensitizer for use in the eighteenth embodiment of the invention varies, depending on the type of the silver halide grains to be sensitized therewith and the condition for chemically ripening the grains, but may fall generally between 10⁻⁸ and 10⁻¹ mols, preferably between 10⁻⁷ and 10⁻² mols or so, per mol of the silver halide.

The amount of the gold sensitizer for use in the eighteenth embodiment of the invention also varies depending on various conditions. In general, it may fall between 10⁻⁷ and 10⁻² mols, preferably between 10⁻⁶ and 5×10⁻³ mols, per mol of the silver halide. The ambient condition for chemical sensitization of the emulsions in the eighteenth embodiment of the invention is not defined at all. In general, the pAg is at most 8, preferably at most 7.0, more preferably at most 6.5, even more preferably at most 6.0, but is at least 1.5, preferably at least 2.0, more preferably at least 2.5; the pH falls between 3 and 10, preferably between 4 and 9; and the temperature falls between 20 and 95° C., preferably between 25 and 80° C. or so.

In the eighteenth embodiment of the invention, the chalcogen sensitization and the gold sensitization may be combined with reduction sensitization. Preferably, the chalcogen sensitization is combined with reduction sensitization. Preferred compounds for the reduction sensitization are ascorbic acid, thiourea dioxide and dimethylaminoborane, as well as stannous chloride, aminoiminomethanesulfinic acid, hydrazine derivatives, borane compounds, silane compounds and polyamine compounds. The reduction sensitizer may be added to the grains in any stage of preparing the photosensitive emulsions including the stage of grain growth to just before coating the emulsions. Preferably, the emulsions are subjected to such reduction sensitization while they are kept ripened at a pH of 8 or more and at a pAg of 4 or less. Also preferably, they may be subjected to reduction sensitization while the grains are formed with a single addition part of silver ions being introduced thereinto.

The amount of the reduction sensitizer varies depending on various conditions. In general, it may fall between 10⁻⁷ and 10⁻¹ mols, preferably between 10⁻⁶ and 5×10⁻² mols, per mol of the silver halide to be sensitized therewith.

Preferably, the photosensitive silver halide emulsions for use in the eighteenth embodiment of the invention contain an FED sensitizer (fragmentable electron donating sensitizer) of a compound capable of generating two electrons from one photon. For the FED sensitizer for use herein, preferred are the compounds described in U.S. Pat. Nos. 5,413,909, 5,482,825, 5,747,235, 5,747,236, 6,054,260, 5,994,051, and Japanese Patent Application No. 2001-86161. The FED sensitizer may be added to the grains in any stage of preparing the photosensitive emulsions including the stage of grain growth to just before coating the emulsions. The amount of the FED sensitizer to be added to the emulsion varies, depending on various condition, but may generally fall between 10⁻⁷ and 10⁻¹ mols, but preferably between 10⁻⁶ and 5×10⁻² mols per mol of the silver halide in the emulsion.

If desired, a thiosulfonic acid compound may be added to the silver halide emulsions for use in the eighteenth embodiment of the invention, for example, according to the method described in EP Laid-Open 293,917.

Preferably, the photosensitive silver halide grains for use in the eighteenth embodiment of the invention are subjected to at least one chemical sensitization of gold sensitization and chalcogen sensitization for planning photothermographic materials of high sensitivity.

<<Sensitizing Dye>>

The photothermographic material of the eighteenth embodiment of the invention may contain a sensitizing dye. Sensitizing dyes that are preferably selected for use herein are those which, after adsorbed by the silver halide grains, can spectrally sensitize the grains within a desired wavelength range and of which the spectral sensitivity well corresponds to the spectral characteristics of the light source to which the photothermographic material that contains the sensitizing dye is exposed. Preferably, the photothermographic material of the eighteenth embodiment of the invention is so spectrally sensitized with the sensitizing dye therein that its spectral sensitivity peak may fall between 600 nm and 900 nm or between 300 nm and 500 nm. For the details of sensitizing dyes usable herein and methods for adding them to the photothermographic material, referred to are paragraphs [0103] to [0109] in JP-A 11-65021; compounds of formula (II) in JP-A 10-186572; dyes of formula (I) and paragraph [0106] in JP-A 11-119374; dyes described in U.S. Pat. Nos. 5,510,236, 3,871,887 (Example 5); dyes described in JP-A 2-96131, 59-48753; from page 19, line 38 to page 20, line 35 in EP Laid-Open 0803764A1; Japanese Patent Application Nos. 2000-86865, 2000-102560 and 2000-205399. One or more such sensitizing dyes may be used herein either singly or as combined.

The amount of the sensitizing dye to be in the photothermographic material of the eighteenth embodiment of the invention may be varied to a desired one, depending on the sensitivity and the fogging resistance of the material. In general, it preferably falls between 10⁻¹ and 1 mol, more preferably between 10⁻⁴ and 10⁻¹ mols, per mol of the silver halide in the image-forming layer of the material.

For its better spectral sensitization, the photothermographic material of the eighteenth embodiment of the invention may contain a supersensitizer. For the supersensitizer, for example, usable are the compounds described in EP Laid-Open 587,338, U.S. Pat. Nos. 3,877,943, 4,873,184, and JP-A 5-341432, 11-109547 and 10-111543.

<<Combination of Silver Halides>>

The photothermographic material of the eighteenth embodiment of the invention may contain only one type or two or more different types of photosensitive silver halide grains (these will differ in their mean grain size, halogen composition or crystal habit, or in the condition for their chemical sensitization), either singly or as combined. Combining two or more types of photosensitive silver halide grains differing in their sensitivity will enable to control the gradation of the images to be formed in the photothermographic material. For the technique relating to it, referred to are JP-A 57-119341, 53-106125, 47-3929, 48-55730, 46-5187, 50-73627, 57-150841. The sensitivity difference between the combined silver halide grains is preferably such that the respective emulsions differ from each other at least by 0.2 logE.

<<Mode of Mixing Photosensitive Silver Halide and Organic Silver Salt>>

Preferably, the photosensitive silver halide grains for use in the eighteenth embodiment of the invention are formed in the absence of a non-photosensitive organic silver salt, and are chemically sensitized. This is because silver halides prepared by adding a halogenating agent to an organic silver salt could not have high sensitivity.

For mixing the silver halide and an organic silver salt having been prepared separately, for example, employable is a method of mixing them in a high-performance stirrer, a ball mill, a sand mill, a colloid mill, a shaking mill, a homogenizer or the like; or a method of adding the photosensitive silver halide having been prepared to the organic silver salt being prepared, in any desired timing to produce the organic silver salt mixed with the photosensitive silver halide. Any of these methods produces the advantages of the eighteenth embodiment of the invention.

<<Mode of Mixing Photosensitive Silver Halide in Coating Liquid>>

The preferred time at which the silver halide grains are added to the coating liquid which is to form the image-forming layer on the support of the photothermographic material of the eighteenth embodiment of the invention may fall between 180 minutes before coating the liquid and a time just before the coating, more preferably between 60 minutes before the coating and 10 seconds before it. However, there is no specific limitation thereon, so far as the method and the condition employed for adding the grains to the coating liquid ensure the advantages of the eighteenth embodiment of the invention. Concretely for mixing them, employable is a method of adding the grains to the coating liquid in a tank in such a controlled manner that the mean residence time for the grains in the tank, as calculated from the amount of the grains added and the flow rate of the coating liquid to a coater, could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<Non-Photosensitive Organic Silver Salt>

The non-photosensitive organic silver salt for use in the eighteenth embodiment of the invention is relatively stable to light, but, when heated at 80° C. or higher in the presence of an exposed photosensitive silver halide and a reducing agent, it forms a silver image. The organic silver salt may be any and every organic substance that contains a source having the ability to reduce silver ions. Some non-photosensitive organic silver salts of that type are described, for example, in JP-A 10-62899, paragraphs [0048] to [0049]; EP Laid-Open 0803764A1, from page 18, line 24 to page 19, line 37; EP Laid-Open 0962812A1; JP-A 11-349591, 2000-7683, 2000-72711. Preferred for use herein are silver salts of organic acids, especially silver salts of long-chain (C10 to C30, preferably C15 to C28) aliphatic carboxylic acids. Preferred examples of organic silver salts are silver behenate, silver arachidate, silver stearate, silver oleate, silver laurate, silver caproate, silver myristate, silver palmitate, and their mixtures. Of those, especially preferred for use in the eighteenth embodiment of the invention are organic silver salts having a silver behenate content of from 50 mol % to 100 mol %. More preferably, the silver behenate content of the salts falls between 75 mol % and 98 mol %.

The organic silver salt for use in the eighteenth embodiment of the invention is not specifically defined for its morphology, and may be in any form of acicular, rod-like, tabular or scaly solids.

Scaly organic silver salts are preferred in the eighteenth embodiment of the invention. In this description, the scaly organic silver salts are defined as follows: A sample of an organic silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average)≧1.5 are scaly. For scaly grains, preferably, 30≧x (average)>1.5, more preferably 20≧x (average)≧2.0. In this connection, the value x of acicular (needle-like) grains falls within a range of 1≦x (average)<1.5.

In the scaly grains, it is understood that a corresponds to the thickness of tabular grains of which the main plane is represented by b×c. In the scaly organic silver salt grains for use herein, a (average) preferably falls between 0.01 μm and 0.3 μm, more preferably between 0.1 μm and 0.23 μm; and c/b (average) preferably falls between 1 and 6, more preferably between 1 and 4, even more preferably between 1 and 3, still more preferably between 1 and 2.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its morphology, a dispersion of the organic silver salt may be analyzed on its image taken by the use of a transmission electronic microscope. Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%. Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained.

For preparing and dispersing the organic silver salts for use in the eighteenth embodiment of the invention, employable is any known method. For it, for example, referred to are JP-A 10-62899; EP Laid-Open 0803763A1 and 0962812A1; JP-A 11-349591, 2000-7683, 2000-72711, 2001-163827, 2001-163889, 2001-163890, 11-203413; and Japanese Patent Application Nos. 2000-90093, 2000-195621, 2000-191226, 2000-213813, 2000-214155, 2000-191226.

In the eighteenth embodiment of the invention, an aqueous dispersion of an organic silver salt may be mixed with an aqueous dispersion of a photosensitive silver salt to prepare the coating liquid for the photothermographic material. Mixing two or more different types of aqueous, organic silver salt dispersions with two or more different types of aqueous, photosensitive silver salt dispersions is preferred for suitably controlling the photographic properties of the photothermographic material of this embodiment.

In the eighteenth embodiment of the invention, the amount of the organic silver salt to be used may be any desired one. Preferably, it falls between 0.1 and 5 g/m², more preferably between 1 and 3 g/m², even more preferably between 1.2 and 2.5 g/m² in terms of silver in the salt.

<Reducing Agent>

The photothermographic material of the eighteenth embodiment of the invention contains a reducing agent for the organic silver salt therein. The reducing agent may be any and every substance capable of reducing silver ions into metal silver, but is preferably an organic substance. Some examples of the reducing agent are described in JP-A 11-65021, paragraphs [0043] to [0045], and in EP Laid-Open 0803764, from page 7, line 34 to page 18, line 12.

Especially preferred for the reducing agent in the eighteenth embodiment of the invention are hindered phenol-type reducing agents and bisphenol-type reducing agents that have an ortho-positioned substituent relative to the phenolic hydroxyl group therein, and more preferred are compounds of the following general formula (R′):

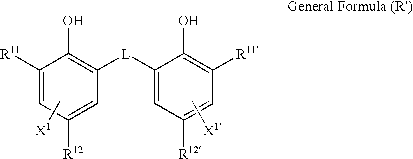

In formula (R′), R¹¹ and R^{11′} each independently represent an alkyl group having from 1 to 20 carbon atoms; R¹² and R^{12′} each independently represent a hydrogen atom, or a substituent substitutable to the benzene ring; L represents —S— or —CHR¹³—; R¹³ represents a hydrogen atom, or an alkyl group having from 1 to 20 carbon atoms; X¹ and X^{1′} each independently represent a hydrogen atom, or a substituent substitutable to the benzene ring.

The substituents in formula (R′) are described.

1) R¹¹ and R^{11′}

R¹¹ and R^{11′} each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, and a halogen atom.

2) R¹² and R^{12′}, X¹ and X^{1′}

R¹² and R^{12′} each independently represent a hydrogen atom, or a substituent substitutable to the benzene ring. X¹ and X^{1′} each independently represent a hydrogen atom, or a substituent substitutable to the benzene ring. Preferred examples of the substituent substitutable to the benzene ring are an alkyl group, an aryl group, a halogen atom, an alkoxy group, and an acylamino group.

3) L

L represents a group of —S— or —CHR¹³—. R¹³ represents a hydrogen atom or an alkyl group having from 1 to 20 carbon atoms. The alkyl group may be substituted.

Specific examples of the unsubstituted alkyl group for R¹³ are methyl, ethyl, propyl, butyl, heptyl, undecyl, isopropyl, 1-ethylpentyl and 2,4,4-trimethylpentyl groups.

For the substituent for the substituted alkyl group for R¹³, referred to are those mentioned hereinabove for the substituted alkyl group for R¹¹. Concretely, it includes a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

4) Preferred substituents

For R¹¹ and R^{11′}, preferred is a secondary or tertiary alkyl group having from 3 to 15 carbon atoms. Concretely, preferred examples of the alkyl group are isopropyl, isobutyl, t-butyl, t-amyl, t-octyl, cyclohexyl, cyclopentyl, 1-methylcyclohexyl and 1-methylcyclopropyl groups. For R¹¹ and R^{11′}, more preferred is a tertiary alkyl group having from 4 to 12 carbon atoms; even more preferred is any of t-butyl, t-amyl and 1-methylcycohexyl groups; and most preferred is a t-butyl group.

Preferably, R¹² and R^{12′} each are an alkyl group having from 1 to 20 carbon atoms, concretely including, for example, methyl, ethyl, propyl, butyl, isopropyl, tert-butyl, tert-amyl, cyclohexyl, 1-methylcyclohexyl, benzyl, methoxymethyl and methoxyethyl groups. For these, more preferred are methyl, ethyl, propyl, isopropyl and tert-butyl groups.

Also preferably, X¹ and X^{1′} each are a hydrogen atom, a halogen atom or an alkyl group; and more preferably, they are both hydrogen atoms.

L is preferably —CHR¹³—.

Also preferably, R¹³ is a hydrogen atom, or an alkyl group having from 1 to 15 carbon atoms. Preferred examples of the alkyl group are methyl, ethyl, propyl, isopropyl and 2,4,4-trimethylpentyl groups. More preferably, R¹³ is a hydrogen atom, a methyl group, a propyl group or an isopropyl group.

In case where R¹³ is a hydrogen atom, R¹² and R^{12′} each are preferably an alkyl group having from 2 to 5 carbon atoms, more preferably an ethyl or propyl group, most preferably, they are both ethyl groups.

In case where R¹³ is a primary or secondary alkyl group having from 1 to 8 carbon atoms, R¹² and R^{12′} are preferably both methyl groups. The primary or secondary alkyl group having from 1 to 8 carbon atoms for R¹³ is preferably a methyl, ethyl, propyl or isopropyl group, more preferably a methyl, ethyl or propyl group.

In case where R¹¹,R^{11′}, R¹² and R^{12′} are all methyl groups, R¹³ is preferably a secondary alkyl group. The secondary alkyl group for R¹³ is preferably an isopropyl, isobutyl or 1-ethylpentyl group, more preferably an isopropyl group.

Depending on the combination of R¹¹, R^{11′}, R¹² and R^{12′} and R¹³ therein, the reducing agents differ in their thermal developability. Combining two or more different types of reducing agents enables to control the thermal developability of the combined ones. Depending on their object, therefore, combining them will be preferred in the invention.

Examples of the compounds of formula (R′) for use in the eighteenth embodiment of the invention are mentioned below, to which, however, the invention of this embodiment is not limited.

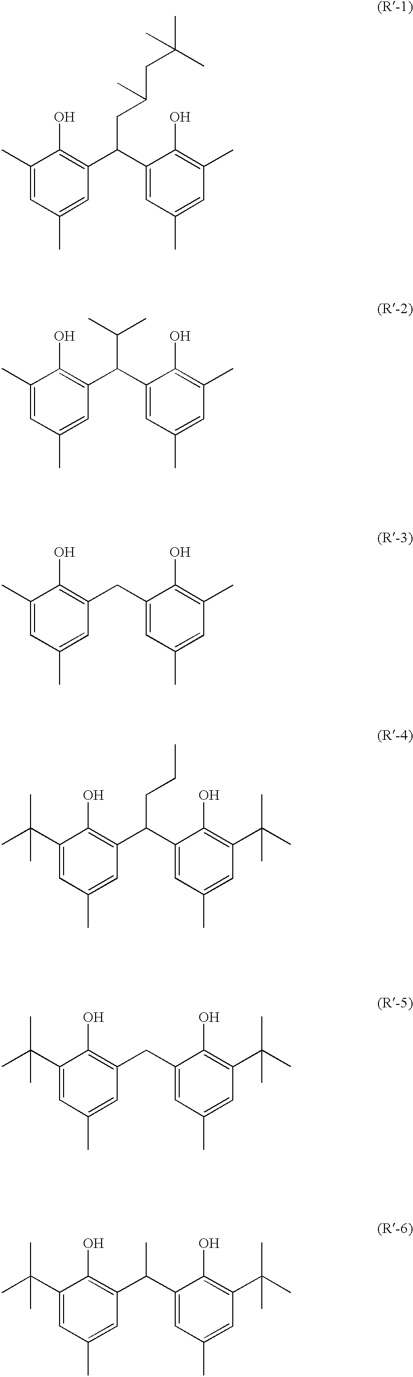

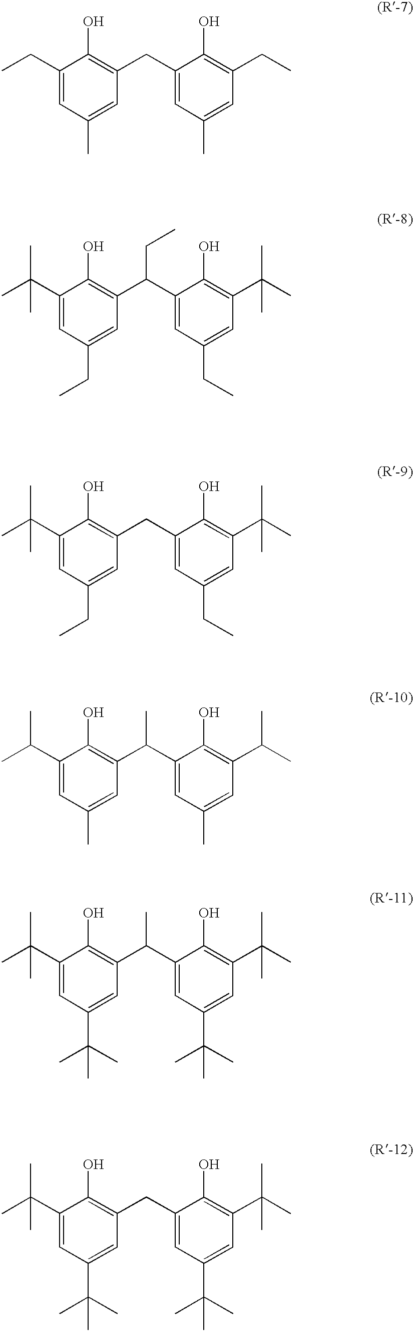

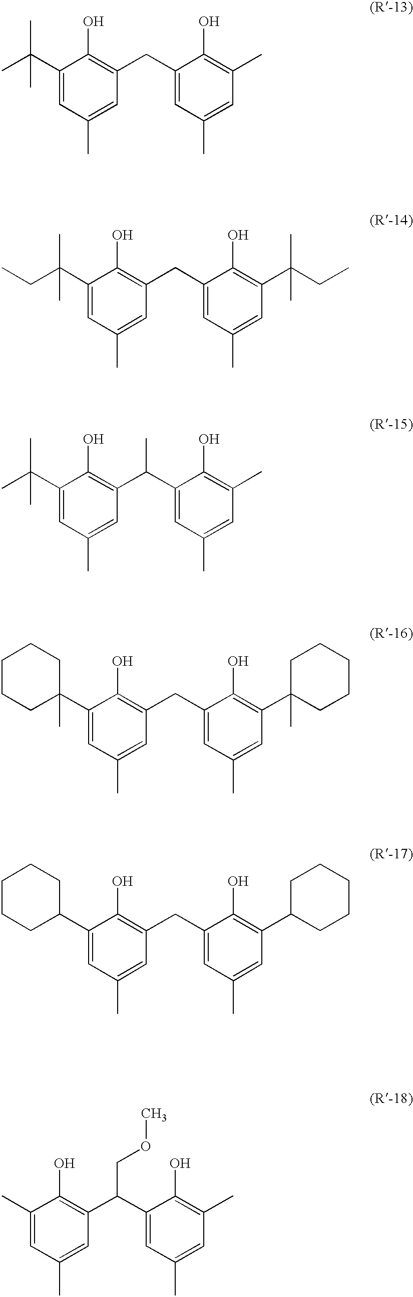

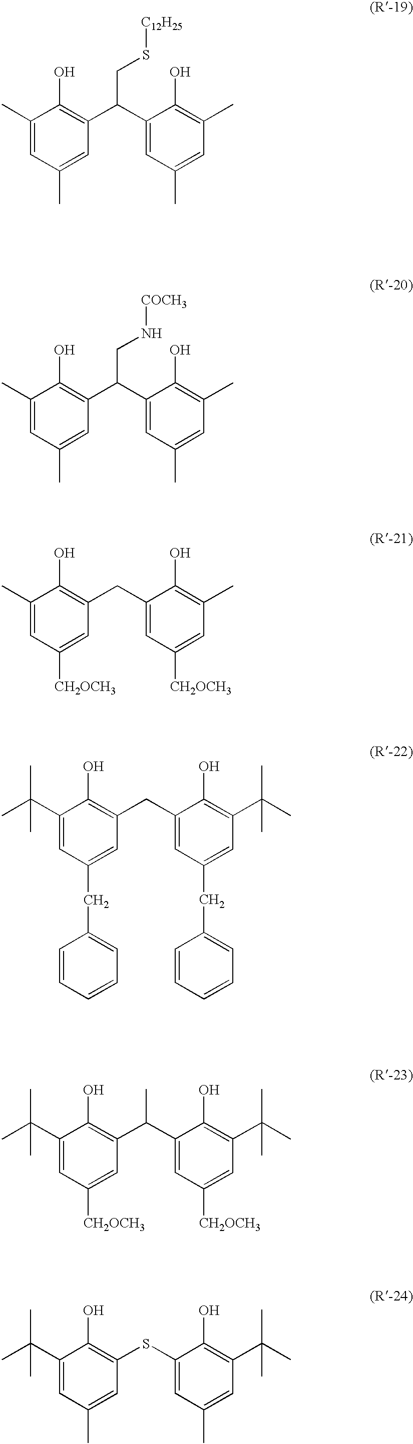

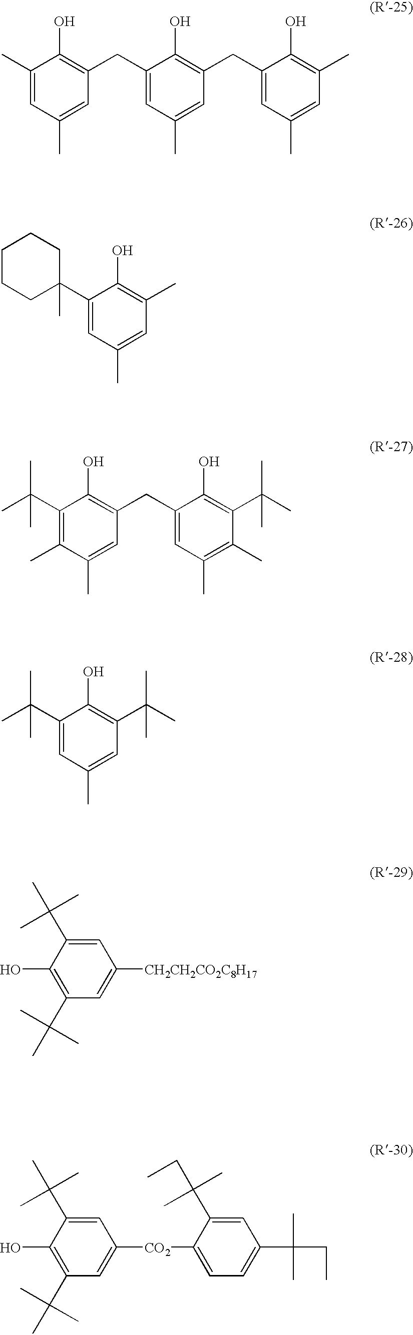

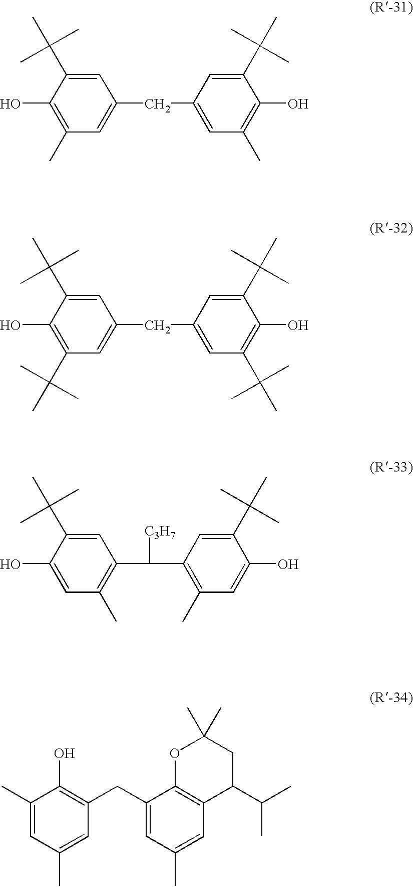

Especially preferred are Compounds (R′-1) to (R′-20).

Preferably, the amount of the reducing agent to be in the photothermographic material of the eighteenth embodiment of the invention falls between 0.01 and 5.0 g/m², more preferably between 0.1 and 3.0 g/m². Also preferably, the amount of the reducing agent to be in the material falls between 5 and 50 mol %, more preferably between 10 and 40 mol % per mol of silver existing in the face of the image-forming layer of the material.

In the eighteenth embodiment of the invention, the reducing agent may be added to the image-forming layer that contains an organic silver salt and a photosensitive silver halide, and to its neighboring layers, but is preferably added to the image-forming layer.

In this embodiment, the reducing agent may be in any form of solution, emulsified dispersion or fine solid particle dispersion, and may be added to the coating liquid in any known method so as to be incorporated into the photothermographic material of the invention.

One well known method of emulsifying the reducing agent to prepare its dispersion comprises dissolving the reducing agent in an auxiliary solvent such dibutyl phthalate, tricresyl phosphate, glyceryl triacetate, diethyl phthalate or the like oily solvent, or in ethyl acetate or cyclohexanone, followed by mechanically emulsifying it into a dispersion.

For preparing a fine solid particle dispersion of the reducing agent, for example, employable is a method that comprises dispersing a powder of the reducing agent in water or in any other suitable solvent by the use of a ball mill, a colloid mill, a shaking ball mill, a sand mill, a jet mill or a roller mill, or ultrasonically dispersing it therein to thereby prepare the intended solid dispersion of the reducing agent. For this, preferred is a sand mill. In this method, optionally used is a protective colloid (e.g., polyvinyl alcohol), and a surfactant (e.g., anionic surfactant such as sodium triisopropylnaphthalenesulfonate—this is a mixture of the salts in which the three isopropyl groups are all in different positions). If desired, the aqueous dispersion may contain a preservative (e.g., sodium benzoisothiazolinone).

Especially preferably, the reducing agent is in the form of its solid particle dispersion having a mean particle size of from 0.01 μm to 10 μm, desirably from 0.05 μm to 5 μm, more desirably from 0.1 μm to 1 μm. In this embodiment, it is also desirable that the other solid dispersions have a mean particle size falling within the range.

<Development Accelerator>

Preferably, the photothermographic material of the eighteenth embodiment of the invention contains a development accelerator. Preferred examples of the development accelerator are sulfonamidophenol compounds of formula (A) in JP-A 2000-267222 and 2000-330234; hindered phenol compounds of formula (II) in JP-A 2001-92075; compounds of formula (I) in JP-A 10-62895 and 11-15116; hydrazine compounds of formula (D) in JP-A 2002-156727 and formula (I) in Japanese Patent Application No. 2001-074278; and phenol or naphthol compounds of formula (2) in JP-A 2001-264929. The amount of the development accelerator to be in the material may fall between 0.1 and 20 mol %, but preferably between 0.5 and 10 mol %, more preferably between 1 and 5 mol % relative to the reducing agent therein. The development accelerator may be introduced into the material like the reducing agent thereinto.

Of the development accelerators mentioned above, especially preferred for use in the eighteenth embodiment of the invention are hydrazine compounds of formula (D) described in JP-A 2002-156727, and phenol or naphthol compounds of formula (2) described in JP-A 2001-264929.

Compounds of the following general formulae (A″-1) and (A″-2) are especially preferred for the development accelerator for the eighteenth embodiment of the invention.

Q1—NHNH—Q2 General Formula (A″-1)

wherein Q1 represents an aromatic or heterocyclic group that bonds to —NHNH—Q2 via its carbon atom; Q2 represents a carbamoyl group, an acyl group, an alkoxycarbonyl group, an aryloxycarbonyl group, a sulfonyl group or a sulfamoyl group.

In formula (A″-1), the aromatic or heterocyclic group for Q1 is preferably a 5- to 7-membered unsaturated ring. Preferred examples of the ring are benzene, pyridine, pyrazine, pyrimidine, pyridazine, 1,2,4-triazine, 1,3,5-triazine, pyrrole, imidazole, pyrazole, 1,2,3-triazole, 1,2,4-triazole, tetrazole, 1,3,4-thiadiazole, 1,2,4-thiadiazole, 1,2,5-thiadiazole, 1,3,4-oxadiazole, 1,2,4-oxadiazole, 1,2,5-oxadiazole, thiazole, oxazole, isothiazole, isoxazole and thiophene rings, and their condensed rings.

These rings may be substituted. In case where they have two or more substituents, the substituents may be the same or different. Examples of the substituents are a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. If possible, the substituents may be further substituted with any other substituents. Preferred examples of the additional substituents for them are a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group for Q2 preferably has from 1 to 50 carbon atoms, more preferably from 6 to 40 carbon atoms, including, for example, unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl and N-benzylcarbamoyl groups.

The acyl group for Q2 preferably has from 1 to 50 carbon atoms, more preferably from 6 to 40 carbon atoms, including, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl and 2-hydroxymethylbenzoyl groups. The alkoxycarbonyl group for Q2 preferably has from 2 to 50 carbon atoms, more preferably from 6 to 40 carbon atoms, including, for example, methoxycarbonyl, ethoxycarbonyl, isobutyloxycarbonyl, cyclohexyloxycarbonyl, decyloxycarbonyl and benzyloxycarbonyl groups.

The aryloxycarbonyl group for Q2 preferably has from 7 to 50 carbon atoms, more preferably from 7 to 40 carbon atoms, including, for example, phenoxycarbonyl, 4-octyloxyphenoxycarbonyl, 2-hydroxymethylphenoxycarbonyl and 4-dodecyloxyphenoxycarbonyl groups. The sulfonyl group for Q2 preferably has from 1 to 50 carbon atoms, more preferably from 6 to 40 carbon atoms, including, for example, methylsulfonyl, butylsulfonyl, octylsulfonyl, 2-hexadecylsulfonyl, 3-dodecyloxypropylsulfonyl, 2-octyloxy-5-tert-octylphenylsulfonyl and 4-dodecyloxyphenylsulfonyl groups.

The sulfamoyl group for Q2 preferably has from 0 to 50 carbon atoms, more preferably from 6 to 40 carbon atoms, including, for example, unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl and N-(2-tetradecyloxyphenyl)sulfamoyl groups. At its substitutable position, the group Q2 may be further substituted with any of the substituents mentioned hereinabove for the 5- to 7-membered unsaturated ring for Q1. In case where the group Q2 has two or more substituents, the substituents may be the same or different.

Preferred examples of the compounds of formula (A″-1) are mentioned below. Q1 is preferably a 5- or 6-membered unsaturated ring, more preferably any of benzene, pyrimidine, 1,2,3-triazole, 1,2,4-triazole, tetrazole, 1,3,4-thiadiazole, 1,2,4-thiadiazole, 1,3,4-oxadiazole, 1,2,4-oxadiazole, thiazole, oxazole, isothiazole and isoxazole rings. Also preferably, these rings may be condensed with a benzene or unsaturated hetero ring to form condensed rings. Q2 is preferably a carbamoyl group, more preferably that having a hydrogen atom bonding to the nitrogen atom therein.

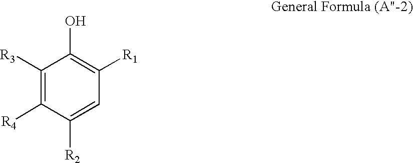

In formula (A″-2), R₁ represents an alkyl group, an acyl group, an acylamino group, a sulfonamido group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group, or a carbonate group; and R₃ and R₄ each represent a group substitutable to the benzene ring, for which referred to are the examples of the substituent mentioned hereinabove for formula (A″-1). R₃ and R₄ may bond to each other to form a condensed ring.

Preferably, R₁ is an alkyl group having from 1 to 20 carbon atoms (e.g., methyl, ethyl, isopropyl, butyl, tert-octyl, cyclohexyl), an acylamino group (e.g., acetylamino, benzoylamino, methylureido, 4-cyanophenylureido), a carbamoyl group (e.g., n-butylcarbamoyl, N,N-diethylcarbamoyl, phenylcarbamoyl, 2-chlorophenylcarbamoyl, 2,4-dichlorophenylcarbamoyl), and is more preferably an acylamino group (including ureido and urethane groups).

Also preferably R₂ is a halogen atom (more preferably, chlorine or bromine), an alkoxy group (e.g., methoxy, butoxy, n-hexyloxy, n-decyloxy, cyclohexyloxy, benzyloxy), or an aryloxy group (e.g., phenoxy, naphthoxy).

Also preferably, R₃ is a hydrogen atom, a halogen atom, or an alkyl group having from 1 to 20 carbon atoms, most preferably a halogen atom. R₄ is preferably a hydrogen atom, an alkyl group, or an acylamino group, more preferably an alkyl group or an acylamino group. For the preferred examples of these groups, referred to are those mentioned hereinabove for R₁. In case where R₄ is an acylamino group, it may bond to R₃ to form a carbostyryl ring.

In case where R₃ and R₄ in formula (A″-2) bond to each other to form a condensed ring, the condensed ring is especially preferably a naphthalene ring. The naphthalene ring may be substituted. For the substituents for the ring, referred to are those mentioned hereinabove for formula (A″-1). In case where the compounds of formula (A″-2) are naphthol compounds, R₁ therein is preferably a carbamoyl group, more preferably a benzoyl group. In those, R₂ is preferably an alkoxy group or an aryloxy group, more preferably an alkoxy group.

Preferred examples of the development accelerators for use in the eighteenth embodiment of the invention are mentioned below, to which, however, this embodiment is not limited.

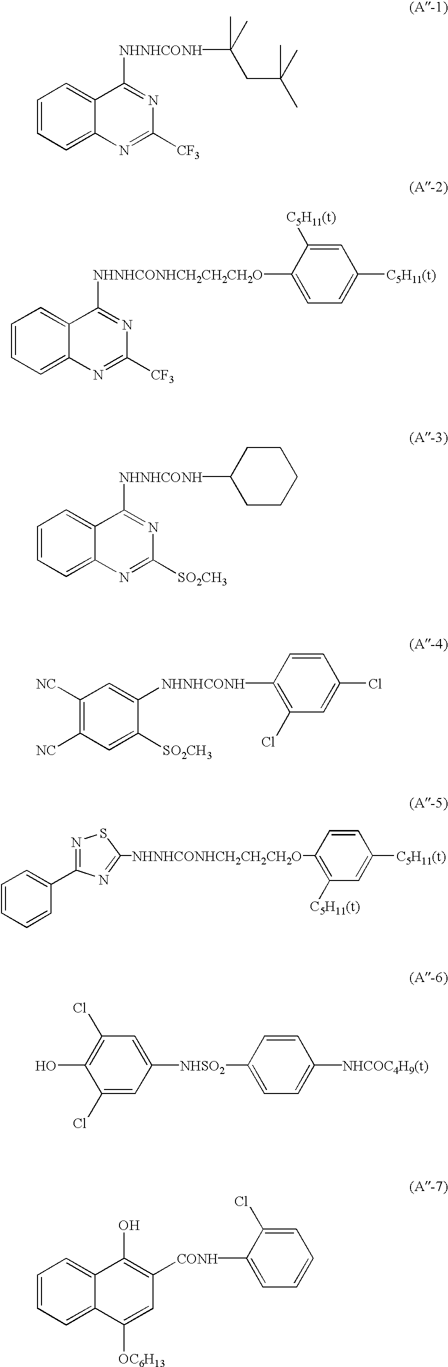

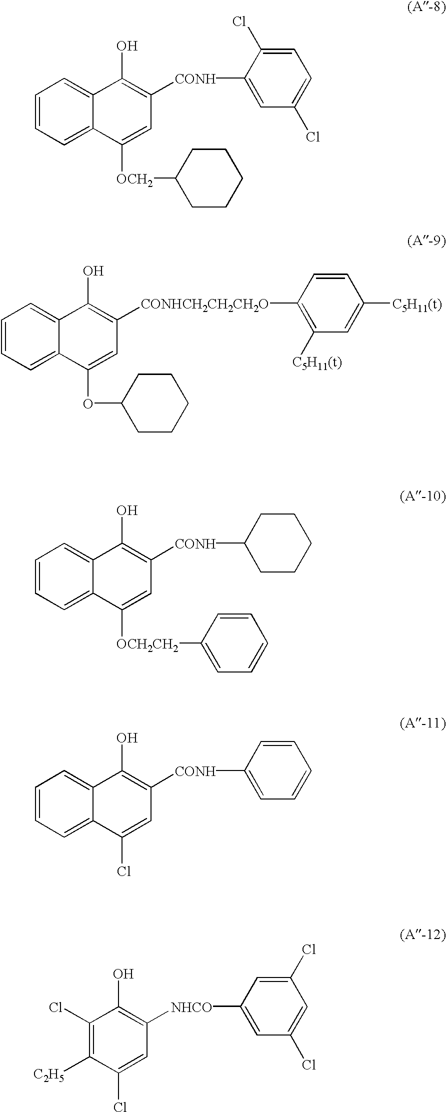

<Hydrogen Bonding Type Compound>

A Hydrogen bonding type compound may be in the photothermographic material of the eighteenth embodiment of the invention, and the compound is described.

In case where the reducing agent in the eighteenth embodiment of the invention has an aromatic hydroxyl group (—OH), especially when it is any of the above-mentioned bisphenols, the reducing agent is preferably combined with a non-reducing compound that has a group capable of forming a hydrogen bond with the group in the reducing agent.

The group capable of forming a hydrogen bond with the hydroxyl group or the amino group in the reducing agent includes, for example, a phosphoryl group, a sulfoxide group, a sulfonyl group, a carbonyl group, an amido group, an ester group, an urethane group, an ureido group, a tertiary amino group, and a nitrogen-containing aromatic group. Of those, preferred are a phosphoryl group, a sulfoxide group, an amido group (not having a group of >N—H but is blocked to form >N—Ra, in which Ra is a substituent except H), an urethane group (not having a group of >N—H but is blocked to form >N—Ra, in which Ra is a substituent except H), an ureido group (not having a group of >N—H but is blocked to form >N—Ra, in which Ra is a substituent except H).

Especially preferred examples of the Hydrogen bonding type compound for use in the eighteenth embodiment of the invention are those of the following general formula (D′):

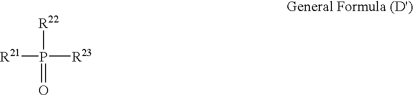

In formula (D′), R²¹ to R²³ each independently represent an alkyl group, an aryl group, an alkoxy group, an aryloxy group, an amino group or a heterocyclic group. These may be unsubstituted or substituted.

The substituents for the substituted groups for R²¹ to R²³ are, for example, a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. Of the substituents, preferred are an alkyl group and an aryl group, including, for example, methyl, ethyl, isopropyl, t-butyl, t-octyl, phenyl, 4-alkoxyphenyl and 4-acyloxyphenyl groups.

The alkyl group for R²¹ to R²³ includes, for example, methyl, ethyl, butyl, octyl, dodecyl, isopropyl, t-butyl, t-amyl, t-octyl, cyclohexyl, 1-methylcyclohexyl, benzyl, phenethyl and 2-phenoxypropyl groups.

The aryl group for these includes, for example, phenyl, cresyl, xylyl, naphthyl, 4-t-butylphenyl, 4-t-octylphenyl, 4-anisidyl and 3,5-dichlorophenyl groups.

The alkoxy group for these includes, for example, methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups.

The aryloxy group for these includes, for example, phenoxy, cresyloxy, isopropylphenoxy, 4-t-butylphenoxy, naphthoxy and biphenyloxy groups.

The amino group for these includes, for example, dimethylamino, diethylamino, dibutylamino, dioctylamino, N-methyl-N-hexylamino, dicyclohexylamino, diphenylamino and N-methyl-N-phenylamino groups.

For R²¹ to R²³, preferred are an alkyl group, an aryl group, an alkoxy group and an aryloxy group. From the viewpoint of the advantages of the eighteenth embodiment of the invention, it is preferable that at least one of R²¹ to R²³ is an alkyl group or an aryl group, and it is more desirable that at least two of them are any of an alkyl group and an aryl group. Even more preferably, R²¹ to R²³ are the same as the compounds of the type are inexpensive.

Specific examples of the compounds of formula (D′) and other Hydrogen bonding type compounds usable in the eighteenth embodiment of the invention are mentioned below, to which, however, this embodiment is not limited.

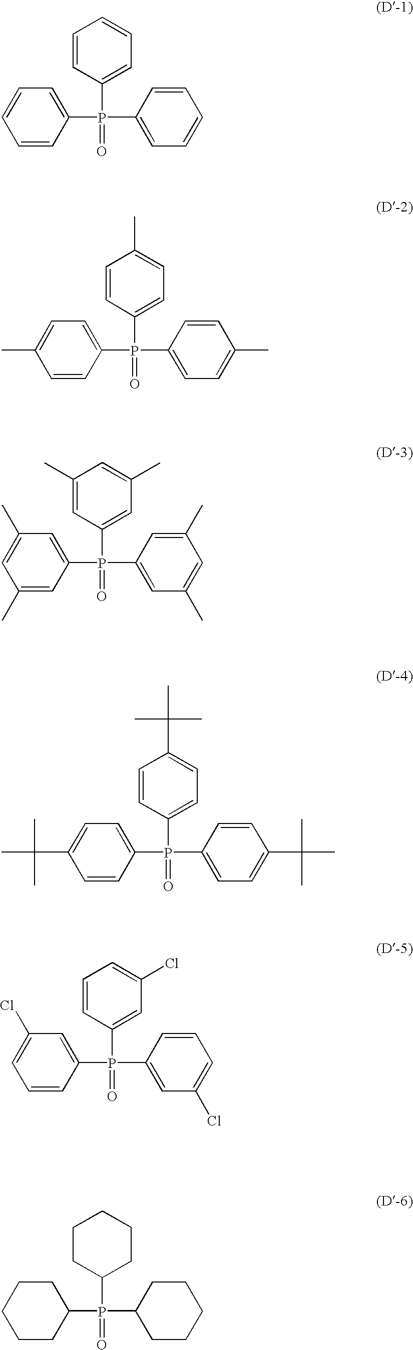

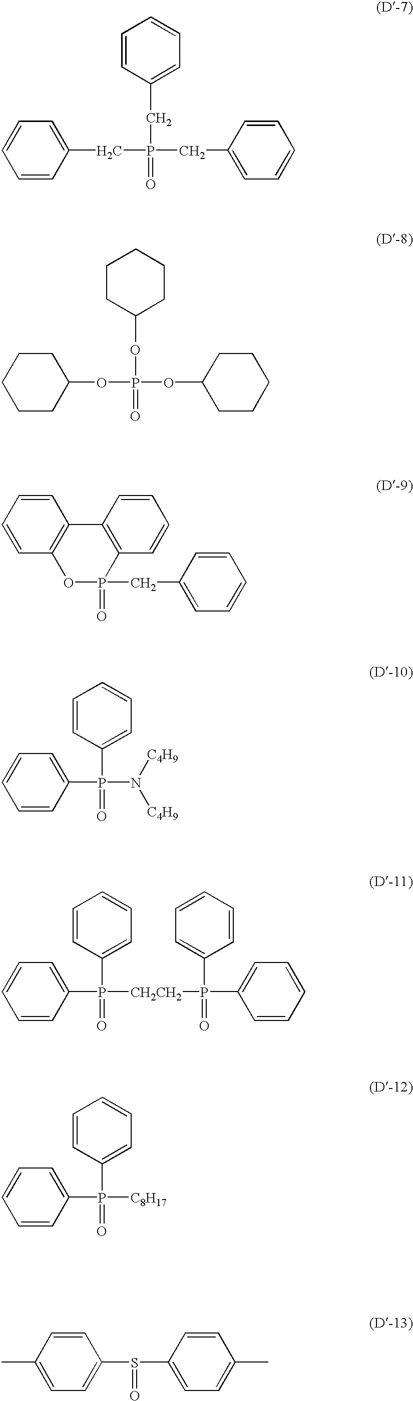

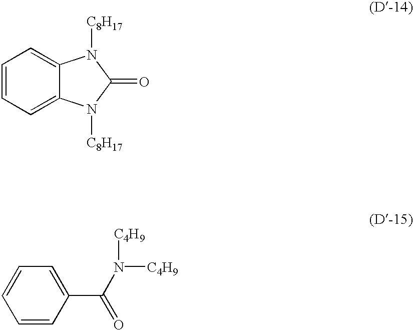

Apart from the above, other Hydrogen bonding type compounds such as those described in EP 1096310, JP-A 2002-156727 and Japanese Patent Application No. 2001-124796 are also usable herein.

Like the reducing agent mentioned above, the Hydrogen bonding type compound may be added to the coating liquid for the photothermographic material of the eighteenth embodiment of the invention, for example, in the form of its solution, emulsified dispersion or solid particle dispersion. In its solution, the compound may form a hydrogen-bonding complex with a compound having a phenolic hydroxyl group. Depending on the combination of the reducing agent and the compound of formula (A) for use in this embodiment, the complex may be isolated as its crystal.

Thus isolated, the crystal powder may be formed into its solid particle dispersion, and the dispersion is especially preferred for use herein for stabilizing the photothermographic material of the eighteenth embodiment of the invention. As the case may be, the reducing agent and the Hydrogen bonding type compound may be mixed both in powder optionally along with a suitable dispersant added thereto in a sand grinder mill or the like to thereby form the intended complex in the resulting dispersion. The method is also preferred in this embodiment.

Preferably, the amount of the Hydrogen bonding type compound to be added to the reducing agent in this embodiment falls between 1 and 200 mol %, more preferably between 10 and 150 mol %, even more preferably between 30 and 100 mol % relative to the reducing agent.

<Binder>

For the details of the binder to be in the organic silver salt-containing layer in this embodiment, referred to are those described in the section of the first embodiment of the invention.

<Solvent Preferred for Coating Liquid>

For the details of the solvent for the coating liquid to form the organic silver salt-containing layer in the photothermographic material of this embodiment, referred to are those described in the section of the first embodiment of the invention.

<Antifoggant>

For the antifoggant for the eighteenth embodiment of the invention, preferred are compounds of formula (H):

Q—(Y)n—C(Z₁)(Z₂)X General Formula (H)

For the details of the compound of formula (H) for use in this embodiment, referred to are those described in the section of the first embodiment of the invention.

Preferably, the amount of the compound of formula (H) to be in the photothermographic material of the eighteenth embodiment of the invention falls between 10⁻⁴ and 0.8 mols, more preferably between 10⁻³ and 0.1 mols, even more preferably between 5×10⁻³ and 0.05 mols per mol of the non-photosensitive silver salt in the image-forming layer of the material.

In particular, since a silver iodide-rich silver halide emulsions are used in this embodiment, it is a matter of great importance to add the compound of formula (H) to the photothermographic material for ensuring the fogging resistance of the material. Most preferably, the amount of the compound to be added to the material falls between 5×10⁻³ and 0.03 mols.

In this embodiment, the compound of formula (H) may be added to the photothermographic material like the reducing agent thereto.

Preferably, the compounds of formula (H) have a melting point not higher than 200° C., more preferably not higher than 170° C.

For other organic polyhalogen compounds usable in the eighteenth embodiment of the invention, referred to are those disclosed in JP-A 11-65021, paragraphs [0111] to [0112]. In particular, the organic halogen compounds of formula (P) in Japanese Patent Application No. 11-87297, the organic polyhalogen compounds of formula (II) in JP-A 10-339934, and the organic polyhalogen compounds described in Japanese Patent Application No. 11-205330 are preferred for use in this embodiment.

<Other Antifoggants>

For the details of other antifoggants employable in this embodiment, referred to are those described in the section of the first embodiment of the invention. Especially for the details of azolium salts employable in this embodiment, also referred to are those described in the section of the first embodiment of the invention.

<Other Additives>

For the details of other additives (mercapto compounds, disulfide compounds, thione compounds, toning agents, plasticizers, lubricants, dyes, pigments, super-hardeners) that are employable in this embodiment, referred to are those described in the section of the first embodiment of the invention.

<<Preparation of Coating Liquid>>

In the eighteenth embodiment of the invention, the coating liquid for the image-forming layer is prepared preferably at a temperature falling between 30° C. and 65° C., more preferably between 35° C. and lower than 60° C., even more preferably between 35° C. and 55° C. Also preferably, the coating liquid for the image-forming layer is kept at a temperature falling between 30° C. and 65° C. just after addition of polymer latex thereto.

<Layer Constitution>

The photothermographic material of the eighteenth embodiment of the invention may have non-photosensitive layers in addition to image-forming layers. Depending on their positions, the non-photosensitive layers are classified into (a) a surface protective layer to be disposed on an image-forming layer (remoter from the support than the image-forming layer); (b) an interlayer to be disposed between adjacent image-forming layers or between an image-forming layer and a protective layer; (c) an undercoat layer to be disposed between an image-forming layer and a support; (d) a back layer to be disposed on a support opposite to an image-forming layer.

In this embodiment, the photothermographic material may optionally have additional layers serving as an optical filter. The layers (a) and (b) may be those serving as an optical filter. The layers (c) and (d) may be antihalation layers in the material.

<<Surface Protective Layer>>

The photothermographic material of the eighteenth embodiment of the invention may have a surface protective layer for preventing the image-forming layer from being blocked. The surface protective layer may have a single-layered or multi-layered structure. The details of the surface protective layer are described, for example, in JP-A 11-65021, paragraphs [0119] to [0120], and in Japanese Patent Application No. 2000-171936.

Gelatin is preferred for the binder in the surface protective layer in this embodiment of the invention, but for it, polyvinyl alcohol (PVA) is also usable alone or combined with gelatin. Gelatin for use herein may be inert gelatin (e.g., Nitta Gelatin 750), or gelatin phthalide (e.g., Nitta Gelatin 801). Examples of PVA usable herein are described in, for example, JP-A 2000-171936, paragraphs [0009] to [0020]. Preferred example of PVA for use herein are completely saponified PVA-105; partially saponified PVA-205, PVA-355; and modified polyvinyl alcohol, MP-203 (all commercial products of Kuraray). The polyvinyl alcohol content (per m² of the support) of one protective layer preferably falls between 0.3 and 4.0 g/m², more preferably between 0.3 and 2.0 g/m².

The overall binder content (including water-soluble polymer and latex polymer, per m² of the support) of one protective layer preferably falls between 0.3 and 5.0 g/m², more preferably between 0.3 and 2.0 g/m².

<<Antihalation Layer>>

For the details of the antihalation layer to be in the photothermographic material of this embodiment, referred to are those described in the section of the first embodiment of the invention.

<<Back Layer>>

For the details of the back layer to be in the photothermographic material of this embodiment, referred to are those described in the section of the first embodiment of the invention.

<<Matting Agent>>

For the details of the matting agent for use in this embodiment, referred to are those described in the section of the first embodiment of the invention.

<<Polymer Latex>>

If desired, polymer latex may be added to the surface protective layer and the back layer of the photothermographic material of the eighteenth embodiment of the invention.

The polymer latex that is employable herein is described in, for example, Synthetic Resin Emulsions (by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); and Chemistry of Synthetic Latexes (by Sohichi Muroi, the Polymer Publishing Association of Japan, 1970). Concretely, it includes, for example, methyl methacrylate (33.5 wt. %)/ethyl acrylate (50 wt. %)/methacrylic acid (16.5 wt. %) copolymer latex; methyl methacrylate (47.5 wt. %)/butadiene (47.5 wt. %)/itaconic acid (5 wt. %) copolymer latex; ethyl acrylate/methacrylic acid copolymer latex; methyl methacrylate (58.9 wt. %)/2-ethylhexyl acrylate (25.4 wt. %)/styrene (8.6 wt. %)/2-hydroxyethyl methacrylate (5.1 wt. %)/acrylic acid (2.0 wt. %) copolymer latex; and methyl methacrylate (64.0 wt. %)/styrene (9.0 wt. %)/butyl acrylate (20.0 wt. %)/2-hydroxyethyl methacrylate (5.0 wt. %)/acrylic acid (2.0 wt. %) copolymer latex.

The ratio of the polymer latex in the surface protective layer or the back layer preferably falls between 10% by weight and 90% by weight, more preferably between 20% by weight and 80% by weight of all the binder (including water-soluble binder and latex polymer) in the layer.

<<pH of Film Surface>>

For the details of the pH of the film surface in this embodiment, referred to are those described in the section of the first embodiment of the invention.

<<Hardening Agent>>

For the details of hardening agent for use in this embodiment, referred to are those described in the section of the first embodiment of the invention.

<<Surfactant and Others>>

For the details of the surfactant and others for use in this embodiment, referred to are those described in the section of the first embodiment of the invention.

<<Antistatic Agent>>

The photothermographic material of the eighteenth embodiment of the invention may have an antistatic layer that contains any of various known metal oxides or electroconductive polymers. In this, the antistatic layer may serve also as the back layer and the back surface protective layer mentioned above, or may be provided separately from them. For the details of the antistatic layer, for example, referred to are the techniques disclosed in JP-A 11-65021, paragraph [0135]; JP-A 56-143430, 56-143431, 58-62646, 56-120519; JP-A 11-84573, paragraphs [0040] to [0051]; U.S. Pat. No. 5,575,957; and JP-A 11-223898, paragraphs [0078] to [0084].

<<Support>>

Transparent supports are preferred for the photothermographic material of this embodiment is transparent. For the transparent supports, preferred are biaxially-stretched films of polyesters, especially polyethylene terephthalate heated at a temperature falling between 130 and 185° C. The heat treatment is for removing the internal strain that may remain in the biaxially-stretched films and for preventing the film supports from being thermally shrunk during thermal development of the material.

In case where the photothermographic material is for medical treatment, the transparent support for it may be colored with a blue dye (for example, with Dye-1 used in the examples in JP-A 8-240877), or may not be colored.

Some examples of the supports are given in JP-A 11-65021, paragraph [0134].

Preferably, the supports are undercoated, for example, with a water-soluble polyester as in JP-A 11-84574; a styrene-butadiene copolymer as in JP-A 10-186565; or a vinylidene chloride copolymer as in JP-A 2000-39684 or in Japanese Patent Application No. 11-106881, paragraphs [0063] to [0080].

<<Other Additives>>

For the details of other additives usable in this embodiment, referred to are those described in the section of the first embodiment of the invention.

<Fabrication of Photothermographic Material>

For the details of the mode of fabricating the photothermographic material of this embodiment, referred to are those described in the section of the first embodiment of the invention.

<Packaging Material for Photothermographic Material>

For the details of the packaging material for the photothermographic material of this embodiment, referred to are those described in the section of the first embodiment of the invention.

<<Color Image Formation>>

The photothermographic material for multi-color expression of the invention may have combinations of two layers for the respective colors, or may contain all the necessary ingredients in a single layer, for example, as in U.S. Pat. No. 4,708,928.

For the photothermographic material of a type containing multiple dyes for multi-color expression, the individual photosensitive emulsion layers are differentiated and spaced from the others via a functional or non-functional barrier layer between the adjacent layers, for example, as in U.S. Pat. No. 4,460,681.

<Exposure and Thermal Development>

The photothermographic material of the eighteenth embodiment of the invention may be exposed in any manner, but is preferably exposed to laser rays. One problem with the silver iodide-rich silver halide emulsion as in this embodiment is that its sensitivity is low. However, the problem of low sensitivity with it is solved by exposing it to high-intensity light such as laser rays for image recoding, and, in addition, it has been found that images can be recorded on the photothermographic material of this embodiment and the energy for image recording on the material may be lower. By exposing the material to such high-intensity light for a short period of time, images can be well written on the material and the material ensures the intended sensitivity.

In particular, for forming images having a maximum density (Dmax) on the material, the preferred quantity of light to which the material is exposed falls between 0.1 W/mm² and 100 W/mm², more preferably between 0.5 W/mm² and 50 W/mm², most preferably between 1 W/mm² and 50 W/mm².

For the laser rays to which the photothermographic material of the eighteenth embodiment of the invention is exposed, preferred are gas lasers (Ar⁺, He—Ne), YAG lasers, color lasers, or semiconductor lasers. Also employable is a combination of semiconductor lasers and secondary harmonics generators. The lasers preferred for use in this embodiment shall be determined in accordance with the light absorption peak wavelength of the spectral sensitizing dyes in the photothermographic material. Preferred for the photothermographic material of this embodiment are He—Ne lasers for red to IR emission; semiconductor lasers for red emission; Ar⁺, He—Ne or He—Cd lasers for blue to green emission; and semiconductor lasers for blue emission. With the recent development of SHG (second harmonic generator)-integrated semiconductor laser modules and semiconductor lasers for blue emission, laser output devices for emission of light of short wavelength have become specifically noticed in the art. Semiconductor lasers for blue emission enable fine image recording and increase recording density. In addition, their life is long and their output is stable. Accordingly, it is expected that the demand for the semiconductor lasers of the type will much increase in the art. The peak wavelength of the laser rays for use in this embodiment preferably falls between 300 nm and 500 nm, more preferably between 400 nm and 500 nm. Also preferably, it falls between 600 nm and 900 nm, more preferably between 620 nm and 850 nm.

In addition, laser rays that multiply oscillate in the machine direction through high-frequency superimposition are also preferred for use in this embodiment.

The photothermographic material of the eighteenth embodiment of the invention may be developed in any manner. In general, after having been imagewise exposed, it is developed under heat. Preferably, the temperature for the thermal development falls between 80 and 250° C., more preferably between 100 and 140° C.

The time for the development preferably falls between 1 and 60 seconds, more preferably between 5 and 30 seconds, even more preferably between 5 and 20 seconds.

For thermal development for the photothermographic material of this embodiment, preferred is a plate heater system. For the plate heater system for the material, preferred is the method described in JP-A 11-133572. The plate heater system described therein is for thermal development of photothermographic materials, in which a photothermographic material having been exposed to have a latent image thereon is brought into contact with a heating unit in the zone for thermal development to thereby convert the latent image into a visible image. In this, the heating unit comprises a plate heater, and multiple presser rolls are disposed in series on one surface of the plate heater. The exposed photothermographic material is passed between the multiple pressure rolls and the plate heater, whereby it is developed under heat. The plate heater is sectioned into 2 to 6 stages, and it is desirable that the temperature of the top stage is kept lower by 1 to 10° C. or so than that of the others.

The plate heater system of the type is described in JP-A 54-30032. In the system, water and organic solvent that remain in the photothermographic material being processed can be removed out of the material. In this, in addition, the support of the photothermographic material rapidly heated is prevented from being deformed.

One example of laser imagers for medical treatment equipped with an exposure unit and a thermal development unit that are applicable to this embodiment of the invention is Fuji Medical Dry Laser Imager FM-DP L. The system FM-DP L is described in Fuji Medical Review No. 8, pp. 39-55. The technique disclosed therein is applicable to this embodiment of the invention. In addition, the photothermographic material of this embodiment can be processed in the laser imager in the AD Network which Fuji Medical System has proposed for a network system under DICOM Standards.

In the photothermographic material of this embodiment, used is a silver iodide-rich photographic emulsion. The material forms a monochromatic image based on silver, and is favorable for use in medical diagnosis, industrial photography, printing, and COM.

Thirty-Sixth Embodiment of Photothermographic Material

Next described in detail is the photothermographic material of the thirty-sixth embodiment of the invention.

The thirty-sixth embodiment of the present invention is a photothermographic material comprising a support having thereon at least one image-forming layer including at least a non-photosensitive organic silver salt, a photosensitive silver halide, a reducing agent and a binder; and further comprising at least one non-image-recording protective layer on the far side of the support relative to the image-forming layer; wherein the silver halide comprises a silver iodide content of 5 mol % to 100 mol % and is chemically sensitized through at least any one of gold sensitization, chalcogen sensitization and reduction sensitization.

<Photosensitive Silver Halide>

The photosensitive silver halide for use in the thirty-sixth embodiment of the invention is described.

<<Halogen Composition>>

It is a matter of importance that the photosensitive silver halide composition for use in the thirty-sixth embodiment of the invention has a high silver iodide content of from 5 mol % to 100 mol %. The other silver halide than silver iodide in the composition is not specifically defined, and may be selected from silver chloride and silver bromide. Preferably, it is silver bromide. With such a high silver iodide emulsion therein, it is possible to design the intended photothermographic material of this embodiment of which the advantages are that the image storability after development is good, especially the image formed thereon is fogged little even left exposed to light. Preferably, the silver iodide content of the silver halide composition for the photothermographic material falls between 40 mol % and 100 mol %, more preferably between 70 mol % and 100 mol %, even more preferably between 80 mol % and 100 mol %, still more preferably between 90 mol % and 100 mol % in view of the light-fast image storability of the processed material.

Regarding the halogen composition distribution in each silver halide grain, the composition may be uniform throughout the grain, or may stepwise vary, or may continuously vary. Core/shell structured silver halide grains are preferred for use herein. Preferably, the core/shell structure of the grains has from 2 to 5 layers, more preferably from 2 to 4 layers. Also preferred are core/shell structured silver halide grains in which the core is of a high silver iodide composition or the shell is of a high silver iodide composition. A technique of localizing silver bromide in the surfaces of silver halide grains is also preferably employed herein.

<<Grain Size>>

The grain size of the photosensitive silver halide for use in the thirty-sixth embodiment of the invention preferably falls between 5 nm and 90 nm. Too large silver halide grains are unfavorable to this embodiment since their amount necessary for attaining the intended maximum optical density shall increase. We, the present inventors have found that, if the coating amount of the silver iodide-rich silver halide emulsion for use in this embodiment increases, it significantly detracts from the developability of the photothermographic material and lowers the sensitivity thereof, and, in addition, it detracts from the image density stability relative to the time for developing the material. In this connection, we have also found that silver halide grains larger than a predetermined level could not form high density images with a predetermined development time. On the other hand, we have further found that, when the coating amount of the silver iodide-rich emulsion is limited, then the developability of the photothermographic material is good. Accordingly, the grain size of the silver iodide-rich grains must be as small as possible for attaining the intended maximum optical density. Therefore in this embodiment of the invention, the grain size of the silver halide preferably falls between 5 nm and 70 nm, more preferably between 5 nm and 55 nm, even more preferably between 10 nm and 45 nm. The grain size referred to herein is meant to indicate the diameter of the circular image having the same area as the projected area of each silver halide grain analyzed through electromicroscopy. The data of all the silver halide grains thus analyzed are averaged to obtain the mean grain size thereof.

Preferably, the coating amount of the silver halide grains in the photothermographic material of this embodiment falls between 0.5 mol % and 15 mol %, more preferably between 0.5 mol % and 12 mol %, even more preferably not larger than 10 mol %. Still more preferably, it falls between 1 mol % and 9 mol %, further more preferably between 1 mol % and 7 mol % relative to the molar amount of silver in the organic silver salt in the material. The organic silver salt will be described hereinunder. In this embodiment, it is a matter of great importance to specifically define the coating amount of the silver halide to be in the photothermographic material for evading the problem of development failure with the silver iodide-rich silver halide emulsion in the material.

<<Method of Forming Grains>>

Methods of forming the photosensitive silver halide are well known in the art, for example, as in Research Disclosure 17029 (June 1978), and U.S. Pat. No. 3,700,458, and any known method is employable in the invention. Concretely, a silver source compound and a halogen source compound are added to gelatin or any other polymer solution to prepare a photosensitive silver halide, and it is then mixed with an organic silver salt. This method is preferred for the invention. Also preferred are the method described in JP-A 11-119374, paragraphs [0217] to [0244]; and the methods described in JP-A 11-352627 and Japanese Patent Application No. 2000-42336.

<<Grain Morphology>>

Silver halide grains generally have different types of morphology, including, for example, cubic grains, octahedral grains, tabular grains, spherical grains, rod-like grains, and potato-like grains, but the high silver iodide grains for use in the thirty-sixth embodiment of the invention have some complicated morphology. For one preferred morphology of the grains for use in this embodiment, referred to are conjugate grains as in R. L. Jenkins et al's Journal of Photo. Sci., Vol. 28 (1980), page 164, FIG. 1. Also preferred are tabular grains as in FIG. 1 of that literature. Still preferred are corner-rounded silver halide grains. The surface index (Miller index) of the outer surface of the photosensitive silver halide grains for use herein is not specifically defined, but is desirably such that the proportion of {100} plane, which ensures higher spectral sensitization when it has adsorbed a color-sensitizing dye, in the outer surface is larger. Preferably, the proportion of {100} plane in the outer surface is at least 50%, more preferably at least 65%, even more preferably at least 80%. The Miller index indicated by the proportion of {100} plane can be identified according to the method described by T. Tani in J. Imaging Sci., 29, 165 (1985), based on the adsorption dependency of sensitizing dye onto {111} plane and {100} plane.

<<Heavy Metal>>

Silver halide grains having a hexacyano-metal complex in their outermost surfaces are preferred for use in the thirty-sixth embodiment of the invention. Preferred examples of the hexacyano-metal complex are [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻. Of those, more preferred are hexacyano-Fe complexes.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions.

The hexacyano-metal complex may be added to silver halide grains in the form of a solution thereof in water or in a mixed solvent of water and an organic solvent miscible with water (for example, alcohols, ethers, glycols, ketones, esters, amides), or in the form of a mixture thereof with gelatin.

The amount of the hexacyano-metal complex to be added to the silver halide grains preferably falls between 1×10⁻⁵ mols and 1×10⁻³ mols, per mol of silver of the grains, more preferably between 1×10⁻⁴ mols and 1×10⁻³ mols.

In order to make the hexacyano-metal complex exist in the outermost surfaces of the silver halide grains, the complex is added to an aqueous silver nitrate solution from which are formed the silver halide grains, after the solution has been added to a reaction system to give the grains but before the grains having been formed are finished for chemical sensitization such as chalcogen sensitization with sulfur, selenium or tellurium or noble metal sensitization with gold or the like, or is directly added to the grains while they are rinsed or dispersed but before they are finished for such chemical sensitization. To prevent the silver halide grains formed from growing too much, it is desirable that the hexacyano-metal complex is added to the grains immediately after they are formed. Preferably, the complex is added thereto before the grains formed are finished for post-treatment.

Adding the hexacyano-metal complex to the silver halide grains may be started after 96% by weight of the total of silver nitrate, from which are formed the grains, has been added to a reaction system to give the grains, but is preferably started after 98% by weight of silver nitrate has been added thereto, more preferably after 99% by weight thereof has been added thereto.

The hexacyano-metal complex added to the silver halide grains after an aqueous solution of silver nitrate has been added to the reaction system to give the grains but just before the grains are completely formed is well adsorbed by the grains formed, and may well exist in the outermost surfaces of the grains. Most of the complex added in that manner forms a hardly-soluble salt with the silver ions existing in the surfaces of the grains. The silver salt of hexacyano-iron(II) is more hardly soluble than AgI, and the fine grains formed are prevented from re-dissolving and aggregating into large grains. Accordingly, the intended fine silver halide grains having a small grain size can be formed.

The photosensitive silver halide grains for use in the thirty-sixth embodiment of the invention may contain a metal or metal complex of Groups 8 to 10 of the Periodic Table (including Groups 1 to 18). The metal of Groups 8 to 10, or the center metal of the metal complex is preferably rhodium, ruthenium or iridium. In the invention of this embodiment, one metal complex may be used alone, or two or more metal complexes of one and the same type of metal or different types of metals may also be used herein as combined. The metal or metal complex content of the grains preferably falls between 1×10⁻⁹ mols and 1×10⁻³ mols per mol of silver of the grains. Such heavy metals and metal complexes, and methods of adding them to the silver halide grains are described in, for example, JP-A 7-225449, JP-A 11-65021, paragraphs [0018] to [0024], and JP-A 11-119374, paragraphs [0227] to [0240].

The metal atoms (e.g., in [Fe(CN)₆]⁴⁻) that may be added to the silver halide grains for use in the thirty-sixth embodiment of the invention, as well as the methods of desalting or chemical sensitization of the silver halide emulsions are described, for example, in JP-A 11-84574, paragraphs [0046] to [0050], JP-A 11-65021, paragraphs [0025] to [0031], and JP-A 11-119374, paragraphs [0242] to [0250].

<<Gelatin>>

Gelatin of different types may be used in preparing the photosensitive silver halide emulsions for use in the thirty-sixth embodiment of the invention. For better dispersion of the photosensitive silver halide emulsion in an organic silver salt-containing coating liquid in producing the photothermographic material of the invention, preferred is low-molecular gelatin having a molecular weight of from 500 to 60,000. The low-molecular gelatin of the type may be used in forming the silver halide grains or in dispersing the grains after the grains have been desalted. Preferably, it is used in dispersing the grains after they have been desalted.

<<Sensitizing Dye>>

The photothermographic material of the thirty-sixth embodiment of the invention may contain a sensitizing dye. Usable herein are sensitizing dyes which, after adsorbed by the silver halide grains, can spectrally sensitize the grains within a desired wavelength range. Depending on the spectral characteristics of the light source to be used for exposure, favorable sensitizing dyes having good spectral sensitivity are selected for use in the photothermographic material of the invention of this embodiment. Preferably, the photothermographic material of this embodiment is spectrally sensitized to have a spectral sensitivity peak within a range of from 600 nm to 900 nm, or within a range of from 300 nm to 500 nm. For the details of sensitizing dyes usable herein and methods for adding them to the photothermographic material of this embodiment, referred to are paragraphs [0103] to [0109] in JP-A 11-6501; compounds of formula (II) in JP-A 10-186572; dyes of formula (I) and paragraph [0106] in JP-A 11-119374; dyes described in U.S. Pat. Nos. 5,510,236, 3,871,887 (Example 5); dyes described in JP-A 2-96131, 59-48753; from page 19, line 38 to page 20, line 35 in EP Laid-Open 0803764A1; Japanese Patent Application Nos. 2000-86865, 2000-102560 and 2000-205399. One or more such sensitizing dyes may be used herein either singly or as combined. Regarding the time at which the sensitizing dye is added to the silver halide emulsion in the thirty-sixth embodiment of the invention, it is desirable that the sensitizing dye is added thereto after the desalting step but before the coating step, more preferably after the desalting step but before the chemical ripening step.

The amount of the sensitizing dye to be in the photothermographic material of the thirty-sixth embodiment of the invention varies, depending on the sensitivity and the fogging resistance of the material. In general, it preferably falls between 10⁻⁶ and 1 mol, more preferably between 10⁻⁴ and 10⁻¹ mols per mol of the silver halide in the photosensitive layer of the material.

For its better spectral sensitization, the photothermographic material of the thirty-sixth embodiment of the invention may contain a supersensitizer. For the supersensitizer, for example, usable are the compounds described in EP Laid-Open 587,338, U.S. Pat. Nos. 3,877,943, 4,873,184, and JP-A 5-341432, 11-109547 and 10-111543.

<<Chemical Sensitization>>

The photosensitive silver halide grains for use in the thirty-sixth embodiment of the invention must undergo chemical sensitization through at least any one of gold sensitization, chalcogen sensitization or reduction sensitization for planning the intended photothermographic material of high sensitivity.

Chalcogen sensitization includes sulfur sensitization, selenium sensitization and tellurium sensitization. Many compounds are known for chalcogen sensitization such as sulfur sensitization, selenium sensitization and tellurium sensitization. For example, the compounds described in JP-A 7-128768 are usable for such chalcogen sensitization. In the thirty-sixth embodiment of the invention, preferred is tellurium sensitization, for which more preferred are the compounds described in JP-A 11-65021, paragraph [0030], and the compounds of formulae (II), (III) and (IV) given in JP-A 5-313284.

Gold in the gold sensitizer for use in this embodiment preferably has a valence of +1 or +3. Any ordinary gold compounds for gold sensitization are usable herein. Preferred examples of the gold sensitizer for use herein are chloroauric acid, bromoauric acid, potassium chloroaurate, potassium bromoaurate, auric trichloride, potassium auric thiocyanate, potassium iodoaurate, tetracyanoauric acid, ammonium aurothiocyanate, pyridyltrichlorogold. Also preferred for use herein are the gold sensitizers described in U.S. Pat. No. 5,858,637, and Japanese Patent Application No. 2001-79450.

Ascorbic acid, aminoiminomethanesulfinic acid, hydrazine derivatives, borane compounds, silane compounds and polyamine compounds are preferred for reduction sensitization in this embodiment. The reduction sensitizer may be added to the grains in any stage of preparing the photosensitive emulsions including the stage of grain growth to just before coating the emulsions. Preferably, the emulsions are subjected to such reduction sensitization while they are kept ripened at a pH of 7 or more and at a pAg of 8.3 or less. Also preferably, they may be subjected to reduction sensitization while the grains are formed with a single addition part of silver ions being introduced thereinto.

In the thirty-sixth embodiment of the invention, the photosensitive silver halide grains may be chemically sensitized in any stage after their formation but before their coating. For example, they may be chemically sensitized after desalted, but (1) before spectral sensitization, or (2) along with spectral sensitization, or (3) after spectral sensitization, or (4) just before coating. Especially preferably, they are chemically sensitized after spectral sensitization.

The amount of the sulfur, selenium or tellurium sensitizer for chalcogen sensitization in the thirty-sixth embodiment of the invention varies, depending on the type of the silver halide grains to be sensitized therewith and the condition for chemically ripening the grains, but may fall generally between 10⁻⁸ and 10⁻² mols, preferably between 10⁻⁷ and 10⁻³ mols or so, per mol of the silver halide.

The amount of the gold sensitizer to be added to the silver halide grains in this embodiment also varies depending on various conditions. In general, it may fall between 10⁻⁷ and 10⁻³ mols, preferably between 10⁻⁶ and 5×10⁻⁴ mols, per mol of the silver halide.

The amount of the reduction sensitizer to be added to the silver halide grains in this embodiment also varies depending on various conditions. In general, it may fall between 10⁻⁷ and 10⁻¹ mols, preferably between 10⁻⁶ and 5×10⁻² mols, per mol of the silver halide.

Though not specifically defined, the condition for chemical sensitization in the thirty-sixth embodiment of the invention may be such that the pH falls between 5 and 8, the pAg falls between 6 and 11, and the temperature falls between 40 and 95° C. or so.

If desired, a thiosulfonic acid compound may be added to the silver halide emulsions for use in the thirty-sixth embodiment of the invention, according to the method described in EP Laid-Open 293,917.

The photothermographic material of the thirty-sixth embodiment of the invention may contain only one type or two or more different types of photosensitive silver halide grains (these will differ in their mean grain size, halogen composition or crystal habit, or in the condition for their chemical sensitization), either singly or as combined. Combining two or more types of photosensitive silver halide grains differing in their sensitivity will enable to control the gradation of the images to be formed in the photothermographic material. For the technique relating to it, referred to are JP-A 57-119341, 53-106125, 47-3929, 48-55730, 46-5187, 50-73627, 57-150841. The sensitivity difference between the combined silver halide grains is preferably such that the respective emulsions differ from each other at least by 0.2 logE.

Preferably, the photosensitive silver halide grains for use in the thirty-sixth embodiment of the invention are formed in the absence of a non-photosensitive organic silver salt, and are chemically sensitized. This is because silver halides prepared by adding a halogenating agent to an organic silver salt could not have high sensitivity.

For forming the silver halide in the absence of a non-photosensitive organic silver halide, for example, employable is a method of mixing the silver halide and an organic silver salt having been prepared separately in a high-performance stirrer, a ball mill, a sand mill, a colloid mill, a shaking mill, a homogenizer or the like; or a method of adding the photosensitive silver halide having been prepared to the organic silver salt being prepared, in any desired timing to produce the organic silver salt mixed with the photosensitive silver halide. Any of these methods produces the advantages of the thirty-sixth embodiment of the invention.

<<Mode of Mixing Photosensitive Silver Halide in Coating Liquid>>

The preferred time at which the silver halide grains are added to the coating liquid which is to form the image-forming layer on the support of the photothermographic material of the thirty-sixth embodiment of the invention may fall between 180 minutes before coating the liquid and a time just before the coating, more preferably between 60 minutes before the coating and 10 seconds before it. However, there is no specific limitation thereon, so far as the method and the condition employed for adding the grains to the coating liquid ensure the advantages of the thirty-sixth embodiment of the invention. Concretely for mixing them, employable is a method of adding the grains to the coating liquid in a tank in such a controlled manner that the mean residence time for the grains in the tank, as calculated from the amount of the grains added and the flow rate of the coating liquid to a coater, could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<Organic Silver Salt>

The non-photosensitive organic silver salt for use in the thirty-sixth embodiment of the invention is relatively stable to light, but, when heated at 80° C. or higher in the presence of an exposed photocatalyst (e.g., latent image of photosensitive silver halide) and a reducing agent, it forms a silver image. The organic silver salt may be any and every organic substance that contains a source having the ability to reduce silver ions. Some non-photosensitive organic silver salts of that type are described, for example, in JP-A 10-62899, paragraphs [0048] to [0049]; EP Laid-Open 0803764A1, from page 18, line 24 to page 19, line 37; EP Laid-Open 0962812A1; JP-A 11-349591, 2000-7683, 2000-72711. Preferred for use herein are silver salts of organic acids, especially silver salts of long-chain (C10 to C30, preferably C15 to C28) aliphatic carboxylic acids. Preferred examples of organic silver salts are silver behenate, silver arachidate, silver stearate, silver oleate, silver laurate, silver caproate, silver myristate, silver palmitate, and their mixtures. Of those, especially preferred for use in the thirty-sixth embodiment of the invention are organic silver salts having a silver behenate content of from 50 mol % to 100 mol %. More preferably, the silver behenate content of the salts falls between 75 mol % and 98 mol %.

The organic silver salt for use in the thirty-sixth embodiment of the invention is not specifically defined for its morphology, and may be in any form of acicular, rod-like, tabular or scaly solids.

Scaly organic silver salts are preferred in the thirty-sixth embodiment of the invention. In this description, the scaly organic silver salts are defined as follows: A sample of an organic silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average)≧1.5 are scaly. For scaly grains, preferably, 30≧x (average)≧1.5, more preferably 20≧x (average)≧2.0. In this connection, the value x of acicular (needle-like) grains falls within a range of 1≦x (average)<1.5.

In the scaly grains, it is understood that a corresponds to the thickness of tabular grains of which the main plane is represented by b×c. In the scaly organic silver salt grains for use herein, a (average) preferably falls between 0.01 μm and 0.3 μm, more preferably between 0.1 μm and 0.23 μm; and c/b (average) preferably falls between 1 and 6, more preferably between 1.05 and 4, even more preferably between 1.1 and 3, still more preferably between 1.1 and 2.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its morphology, a dispersion of the organic silver salt may be analyzed on its image taken by the use of a transmission electronic microscope. Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%. Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained.

For preparing and dispersing the organic silver salts for use in the thirty-sixth embodiment of the invention, employable is any known method. For it, for example, referred to are JP-A 10-62899; EP Laid-Open 0803763A1 and 0962812A1; JP-A 11-349591, 2000-7683, 2000-72711, 2001-163827, 2001-163889, 2001-163890, 11-203413; and Japanese Patent Application Nos. 2000-90093, 2000-195621, 2000-191226, 2000-213813, 2000-214155, 2000-191226.

In the thirty-sixth embodiment of the invention, an aqueous dispersion of an organic silver salt may be mixed with an aqueous dispersion of a photosensitive silver salt to prepare the coating liquid for the photothermographic material. Mixing two or more different types of aqueous, organic silver salt dispersions with two or more different types of aqueous, photosensitive silver salt dispersions is preferred for suitably controlling the photographic properties of the photothermographic material of this embodiment.

In the thirty-sixth embodiment of the invention, the amount of the organic silver salt to be used may be any desired one. Preferably, it falls between 0.1 and 5 g/m², more preferably between 1 and 3 g/m², even more preferably between 1.2 and 2.5 g/m² in terms of silver in the salt.

<Reducing Agent>

The photothermographic material of the thirty-sixth embodiment of the invention preferably contains a reducing agent for the organic silver salt therein. The reducing agent for the organic silver salt may be any and every substance capable of reducing silver ions into metal silver, but is preferably an organic substance. Some examples of the reducing agent are described in JP-A 11-65021, paragraphs [0043] to [0045], and in EP Laid-Open 0803764, from page 7, line 34 to page 18, line 12.

Especially preferred for the reducing agent in the thirty-sixth embodiment of the invention are hindered phenol-type reducing agents and bisphenol-type reducing agents, and more preferred are compounds of the following general formula (R″):

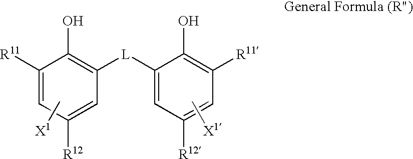

In formula (R″), R¹¹ and R^{11′} each independently represent an alkyl group having from 1 to 20 carbon atoms; R¹² and R^{12′} each independently represent a hydrogen atom, or a substituent substitutable to the benzene ring; L represents —S— or —CHR¹³—; R¹³ represents a hydrogen atom, or an alkyl group having from 1 to 20 carbon atoms; X¹ and X^{1′} each independently represent a hydrogen atom, or a substituent substitutable to the benzene ring.

Formula (R″) is described in detail.

R¹¹ and R^{11′} each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, and a halogen atom.

R¹² and R^{12′} each independently represent a hydrogen atom, or a substituent substitutable to the benzene ring. X¹ and X^{1′} each independently represent a hydrogen atom, or a substituent substitutable to the benzene ring. Preferred examples of the substituent substitutable to the benzene ring are an alkyl group, an aryl group, a halogen atom, an alkoxy group, and an acylamino group.

L represents a group of —S— or —CHR¹³—. R¹³ represents a hydrogen atom, or an alkyl group having from 1 to 20 carbon atoms. The alkyl group may be substituted. Specific examples of the unsubstituted alkyl group for R¹³ are methyl, ethyl, propyl, butyl, heptyl, undecyl, isopropyl, 1-ethylpentyl and 2,4,4-trimethylpentyl groups. For the substituent for the substituted alkyl group for R¹³, referred to are those mentioned hereinabove for the substituted alkyl group for R¹¹. Concretely, it includes a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

For R¹¹ and R^{11′}, preferred is a secondary or tertiary alkyl group having from 3 to 15 carbon atoms. Concretely, preferred examples of the alkyl group are isopropyl, isobutyl, t-butyl, t-amyl, t-octyl, cyclohexyl, cyclopentyl, 1-methylcyclohexyl and 1-methylcyclopropyl groups. For R¹¹ and R^{11′}, more preferred is a tertiary alkyl group having from 4 to 12 carbon atoms; even more preferred is any of t-butyl, t-amyl and 1-methylcycohexyl groups; and most preferred is a t-butyl group.

Preferably, R¹² and R^{12′} each are an alkyl group having from 1 to 20 carbon atoms, concretely including, for example, methyl, ethyl, propyl, butyl, isopropyl, tert-butyl, tert-amyl, cyclohexyl, 1-methylcyclohexyl, benzyl, methoxymethyl and methoxyethyl groups. For these, more preferred are methyl, ethyl, propyl, isopropyl and tert-butyl groups.

Also preferably, X¹ and X^{1′} each are a hydrogen atom, a halogen atom or an alkyl group; and more preferably, they are both hydrogen atoms.

L is preferably —CHR¹³—.

Also preferably, R¹³ is a hydrogen atom, or an alkyl group having from 1 to 15 carbon atoms. Preferred examples of the alkyl group are methyl, ethyl, propyl, isopropyl and 2,4,4-trimethylpentyl groups. More preferably, R¹³ is a hydrogen atom, a methyl group, a propyl group or an isopropyl group.

In case where R¹³ is a hydrogen atom, R¹² and R^{12′} each are preferably an alkyl group having from 2 to 5 carbon atoms, more preferably an ethyl or propyl group, most preferably, they are both ethyl groups.

In case where R¹³ is a primary or secondary alkyl group having from 1 to 8 carbon atoms, R¹² and R^{12′} are preferably both methyl groups. The primary or secondary alkyl group having from 1 to 8 carbon atoms for R¹³ is preferably a methyl, ethyl, propyl or isopropyl group, more preferably a methyl, ethyl or propyl group.

In case where R¹¹, R^{11′}, R¹² and R^{12′} are all methyl groups, R¹³ is preferably a secondary alkyl group. The secondary alkyl group for R¹³ is preferably an isopropyl, isobutyl or 1-ethylpentyl group, more preferably an isopropyl group.

Examples of the compounds of formula (R″) and other reducing agents for use in the thirty-sixth embodiment of the invention are mentioned below, to which, however, the invention of this embodiment is not limited.

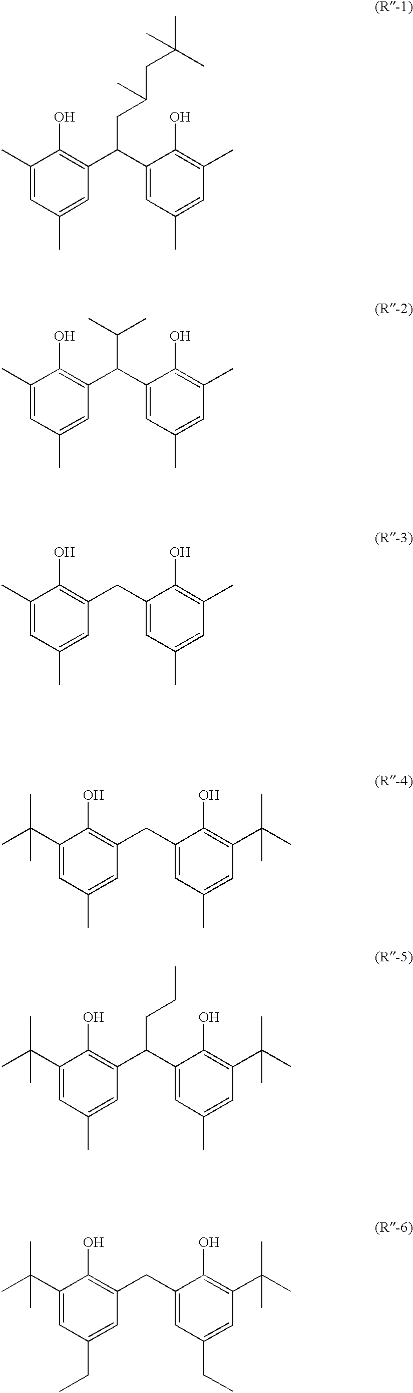

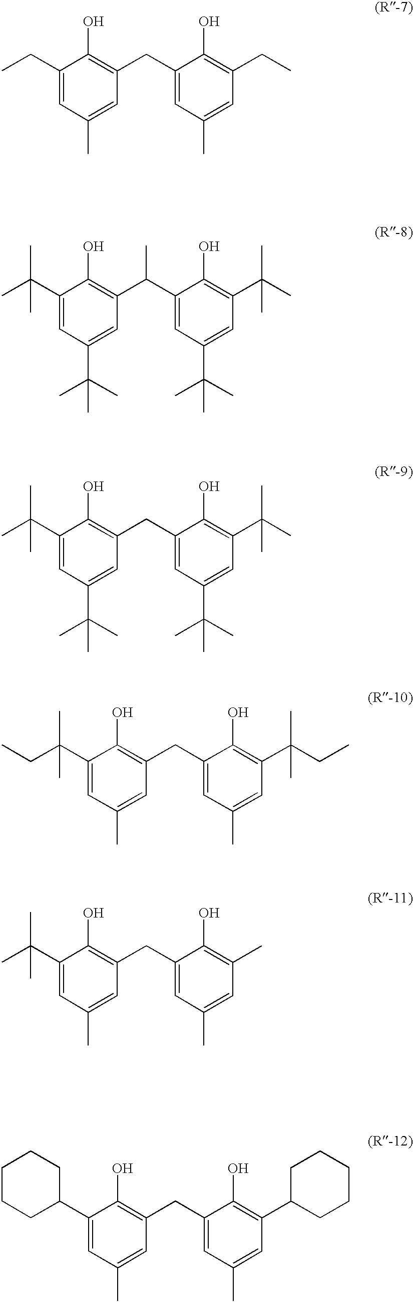

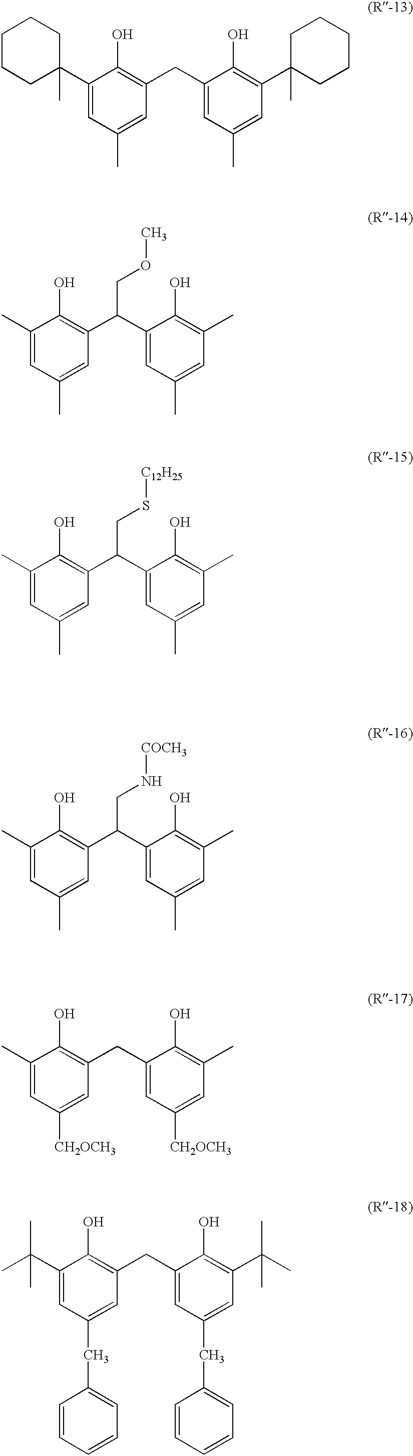

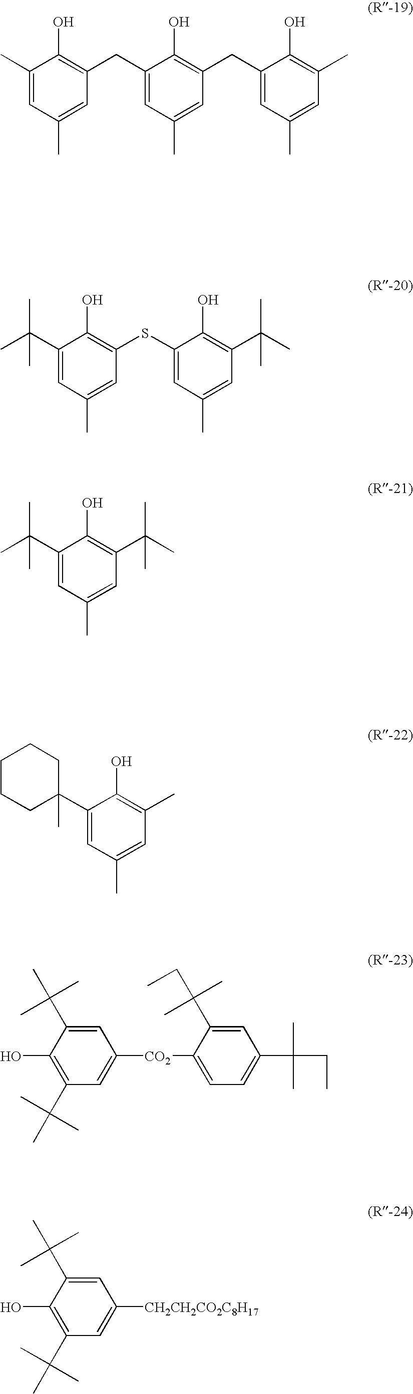

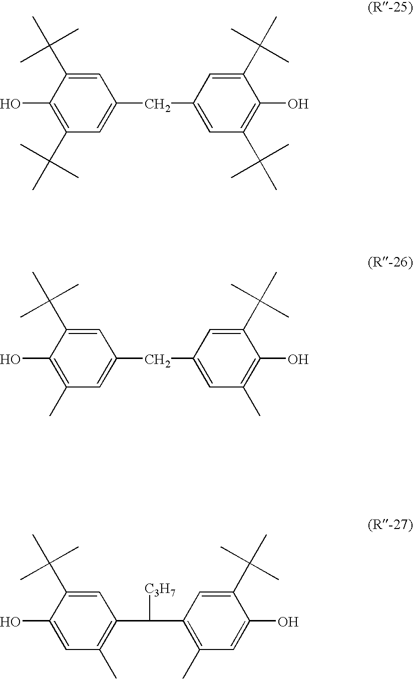

Especially preferred are Compounds (R″-1) to (R″-20).

Preferably, the amount of the reducing agent to be in the photothermographic material of the thirty-sixth embodiment of the invention falls between 0.01 and 5.0 g/m², more preferably between 0.1 and 3.0 g/m². Also preferably, the amount of the reducing agent to be in the material falls between 5 and 50 mol %, more preferably between 10 and 40 mol % per mol of silver existing in the face of the image-forming layer of the material. Preferably, the reducing agent is in the image-forming layer of the material.

In this embodiment, the reducing agent may be in any form of solution, emulsified dispersion or fine solid particle dispersion, and may be added to the coating liquid in any known method so as to be incorporated into the photothermographic material of the invention.

One well known method of emulsifying the reducing agent to prepare its dispersion comprises dissolving the reducing agent in an auxiliary solvent such dibutyl phthalate, tricresyl phosphate, glyceryl triacetate, diethyl phthalate or the like oily solvent, or in ethyl acetate or cyclohexanone, followed by mechanically emulsifying it into a dispersion.

For preparing a fine solid particle dispersion of the reducing agent, for example, employable is a method that comprises dispersing a powder of the reducing agent in water or in any other suitable solvent by the use of a ball mill, a colloid mill, a shaking ball mill, a sand mill, a jet mill or a roller mill, or ultrasonically dispersing it therein to thereby prepare the intended solid dispersion of the reducing agent. In this method, optionally used is a protective colloid (e.g., polyvinyl alcohol), and a surfactant (e.g., anionic surfactant such as sodium triisopropylnaphthalenesulfonate—this is a mixture of the salts in which the three isopropyl groups are all in different positions). If desired, the aqueous dispersion may contain a preservative (e.g., sodium benzoisothiazolinone).

<Development Accelerator>

Preferably, the photothermographic material of the thirty-sixth embodiment of the invention contains a phenol derivative of the following formula (A) that serves as a development accelerator.

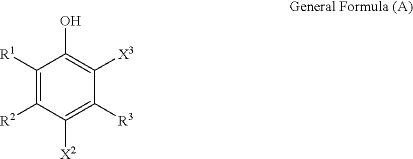

In formula (A), R¹, R², R³, X² and X³ each independently represent a hydrogen atom; a halogen atom; or a substituent that bonds to the benzene ring via a carbon, oxygen, nitrogen, sulfur or phosphorus atom. However, at least one of X² and X³ is a group of —NR⁴R⁵. R⁴ and R⁵ each independently represent a hydrogen atom, an alkyl group, an alkenyl group, an alkynyl group, an aryl group, a heterocyclic group, or a group of —C(═O)—R, —C(═O)—C(═O)—R, —SO₂—R, —SO—R, —P(═O)(R)₂ or —C(═NR′)—R. R and R′ each independently represent a hydrogen atom, or a group selected from an alkyl group, an aryl group, a heterocyclic group, an amino group, an alkoxy group and an aryloxy group. Of the substituents, neighboring ones may bond to each other to form a ring.

<Hydrogen Bonding Type Compound>

In case where the reducing agent in the thirty-sixth embodiment of the invention has an aromatic hydroxyl group (—OH), especially when it is any of the above-mentioned bisphenols, the reducing agent is preferably combined with a non-reducing compound that has a group capable of forming a hydrogen bond with the group in the reducing agent. The group capable of forming a hydrogen bond with the hydroxyl group or the amino group in the reducing agent includes, for example, a phosphoryl group, a sulfoxide group, a sulfonyl group, a carbonyl group, an amido group, an ester group, an urethane group, an ureido group, a tertiary amino group, a nitrogen-containing aromatic group. Of those, preferred are a phosphoryl group, a sulfoxide group, an amido group (not having a group of >N—H but is blocked to form >N—Ra, in which Ra is a substituent except hydrogen), an urethane group (not having a group of >N—H but is blocked to form >N—Ra, in which Ra is a substituent except hydrogen), an ureido group (not having a group of >N—H but is blocked to form >N—Ra, in which Ra is a substituent except hydrogen).

Especially preferred examples of the Hydrogen bonding type compound for use in the thirty-sixth embodiment of the invention are those of the following general formula (D″):

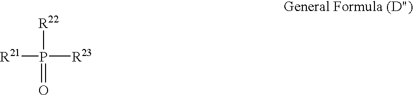

In formula (D″), R²¹ to R²³ each independently represent an alkyl group, an aryl group, an alkoxy group, an aryloxy group, an amino group or a heterocyclic group. These may be unsubstituted or substituted. The substituents for the substituted groups for R²¹ to R²³ are, for example, a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. Of the substituents, preferred are an alkyl group and an aryl group; and more preferred are methyl, ethyl, isopropyl, t-butyl, t-octyl, phenyl, 4-alkoxyphenyl and 4-acyloxyphenyl groups.

The alkyl group for R²¹ to R²³ includes, for example, methyl, ethyl, butyl, octyl, dodecyl, isopropyl, t-butyl, t-amyl, t-octyl, cyclohexyl, 1-methylcyclohexyl, benzyl, phenethyl and 2-phenoxypropyl groups. The aryl group for these includes, for example, phenyl, cresyl, xylyl, naphthyl, 4-t-butylphenyl, 4-t-octylphenyl, 4-anisidyl and 3,5-dichlorophenyl groups. The alkoxy group includes, for example, methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups. The aryloxy group includes, for example, phenoxy, cresyloxy, isopropylphenoxy, 4-t-butylphenoxy, naphthoxy and biphenyloxy groups. The amino group includes, for example, dimethylamino, diethylamino, dibutylamino, dioctylamino, N-methyl-N-hexylamino, dicyclohexylamino, diphenylamino and N-methyl-N-phenylamino groups.

For R²¹ to R²³, preferred are an alkyl group, an aryl group, an alkoxy group and an aryloxy group. From the viewpoint of the advantages of the invention of this embodiment, it is preferable that at least one of R²¹ to R²³is an alkyl group or an aryl group, and it is more desirable that at least two of them are any of an alkyl group and an aryl group. Even more preferably, R²¹ to R²³ are the same as the compounds of the type are inexpensive.

Specific examples of the compounds of formula (D″) and other Hydrogen bonding type compounds usable in the thirty-sixth embodiment of the invention are mentioned below, to which, however, the invention of this embodiment is not limited.

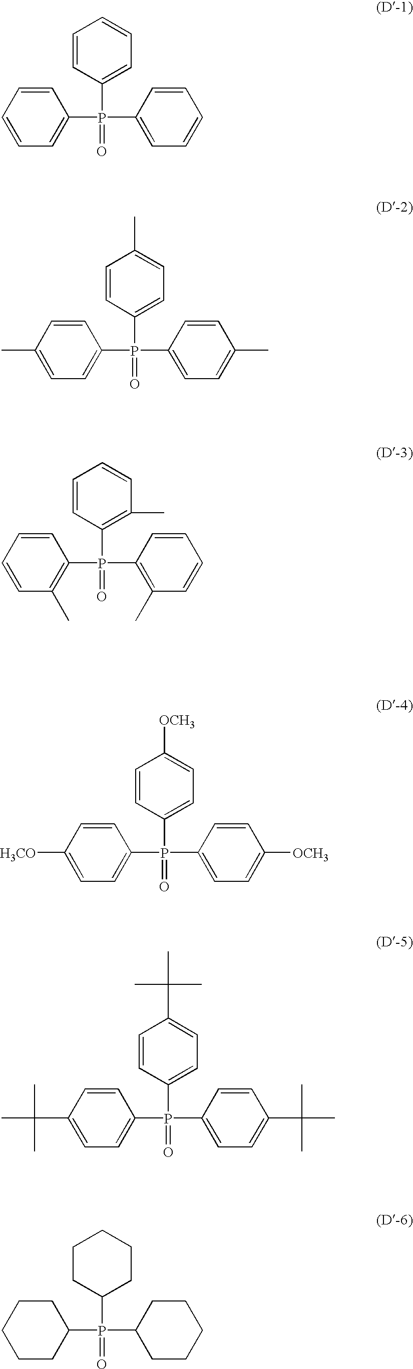

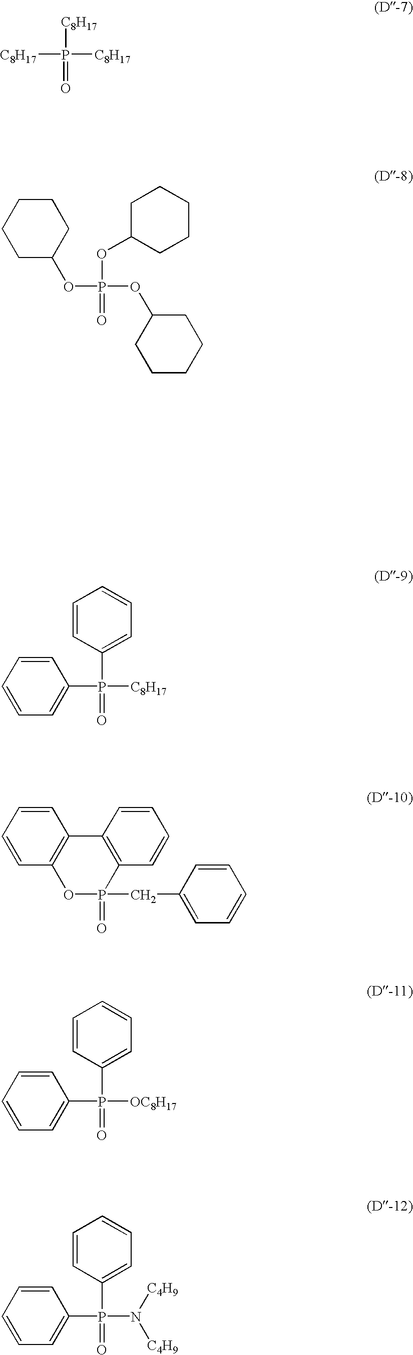

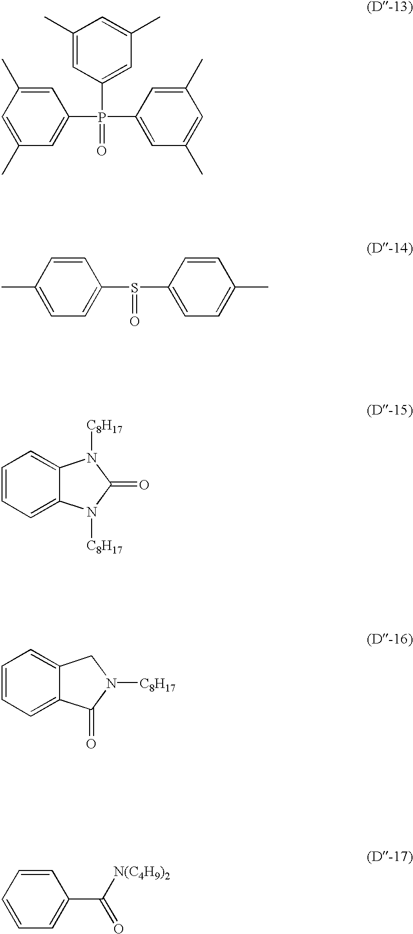

Apart from the above, other Hydrogen bonding type compounds such as those described in Japanese Patent Application Nos. 2000-192191 and 2000-194811 are also usable herein.

Like the reducing agent mentioned above, the compound of formula (D″) may be added to the coating liquid for the photothermographic material of this embodiment, for example, in the form of its solution, emulsified dispersion or solid particle dispersion. In its solution, the compound of formula (D″) may form a hydrogen-bonding complex with a compound having a phenolic hydroxyl group or an amino group. Depending on the combination of the reducing agent and the compound of formula (D″) for use herein, the complex may be isolated as its crystal. Thus isolated, the crystal powder may be formed into its solid particle dispersion, and the dispersion is especially preferred for use herein for stabilizing the photothermographic material of this embodiment. As the case may be, the reducing agent and the compound of formula (D″) may be mixed both in powder optionally along with a suitable dispersant added thereto in a sand grinder mill or the like to thereby form the intended complex in the resulting dispersion. The method is also preferred in the invention of this embodiment.

Preferably, the amount of the compound of formula (D″) to be added to the reducing agent in this embodiment falls between 1 and 200 mol %, more preferably between 10 and 150 mol %, even more preferably between 30 and 100 mol % relative to the reducing agent.

<Binder>

In the thirty-sixth embodiment of the invention, the binder to be n the organic silver salt-containing, image-forming layer may be polymer of any type, but is preferably transparent or semitransparent and is generally colorless. For it, for example, preferred are natural resins, polymers and copolymers; synthetic resins, polymers and copolymers; and other film-forming media. More concretely, they include, for example, gelatins, rubbers, poly(vinyl alcohols), hydroxyethyl celluloses, cellulose acetates, cellulose acetate butyrates, poly(vinylpyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal), poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). The binder may be prepared from water or an organic solvent or an emulsion through microencapsulation.

The glass transition point of the binder to be in the image-forming layer in the thirty-sixth embodiment of the invention preferably falls between 10° C. and 80° C. (the binder of the type will be hereinafter referred to as a high-Tg binder), more preferably between 20° C. and 70° C., even more preferably between 23° C. and 65° C.

In this description, Tg is calculated according to the following equation:

1/Tg=Σ(Xi/Tgi)

The polymer of which the glass transition point Tg is calculated as in the above comprises n's monomers copolymerized (i indicates the number of the monomers copolymerized, falling between 1 and n); Xi indicates the mass fraction of i'th monomer (ΣXi=1); Tgi indicates the glass transition point (in terms of the absolute temperature) of the homopolymer of i'th monomer alone; and Σ indicates the sum total of i falling between 1 and n. For the glass transition point (Tgi) of the homopolymer of each monomer alone, referred to is the description in Polymer Handbook (3rd edition) (written by J. Brandrup, E. H. Immergut (Wiley-Interscience, 1989)).

One and the same polymer may be used for the binder, but, if desired, two or more different types of polymers may be combined for it. For example, a polymer having a glass transition point of 20° C. or higher and a polymer having a glass transition point of lower than 20° C. may be combined. In case where at least two polymers that differ in Tg are blended for use herein, it is desirable that the weight-average Tg of the resulting blend falls within the range defined as above.

In case where the image-forming layer in thirty-sixth embodiment of the invention is formed by using a coating liquid in which at least 30% by weight of the solvent is water, followed by drying it, and in case where the binder in the image-forming layer is soluble or dispersible in an aqueous solvent (watery solvent), especially when the binder in the image-forming layer is a polymer latex that has an equilibrium water content at 25° C. and 60% RH of at most 2% by weight, the photothermographic material having the layer of the type enjoys better properties. Most preferably, the binder for use in this embodiment is so designed that its ionic conductivity is at most 2.5 mS/cm. For preparing the binder of the type, for example, employable is a method of preparing a polymer for the binder followed by purifying it through a functional membrane for fractionation.

The aqueous solvent in which the polymer binder is soluble or dispersible is water or a mixed solvent of water and at most 70% by weight of a water-miscible organic solvent. The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” referred to herein can apply also to polymer systems in which the polymer is not thermodynamically dissolved but is seemingly dispersed.

The “equilibrium water content at 25° C. and 60% RH” referred to herein for polymer latex is represented by the following equation, in which W₁ indicates the weight of a polymer in humidity-conditioned equilibrium at 25° C. and 60% RH, and W₀ indicates the absolute dry weight of the polymer at 25° C.

Equilibrium water content at 25° C. and 60% RH={(W₁−W₀)/W₀}×100 (wt. %)

For the details of the definition of water content and the method for measuring it, for example, referred to is Polymer Engineenring, Lecture 14, Test Methods for Polymer Materials (by the Polymer Society of Japan, Chijin Shokan Publishing).

Preferably, the equilibrium water content at 25° C. and 60% RH of the binder polymer for use in the thirty-sixth embodiment of the invention is at most 2% by weight, more preferably from 0.01 to 1.5% by weight, even more preferably from 0.02 to 1% by weight.

Polymers that serve as the binder in the thirty-sixth embodiment of the invention are preferably dispersible in aqueous solvents. Polymer dispersions include, for example, a type of hydrophobic polymer latex with water-insoluble fine polymer particles being dispersed, and a type of molecular or micellar polymer dispersion with polymer molecules or micelles being dispersed. Any of these is preferred for use herein. The particles in the polymer dispersions preferably have a mean particle size falling between 1 and 50000 nm, more preferably between 5 and 1000 nm or so. The particle size distribution of the dispersed polymer particles is not specifically defined. For example, the dispersed polymer particles may have a broad particle size distribution, or may have a narrow particle size distribution of monodispersion.

In the photothermographic material of this embodiment, favorably used are hydrophobic polymers that are dispersible in aqueous media. The hydrophobic polymers of the type include, for example, acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked ones. They may be homopolymers from one type of monomer, or copolymers from two or more different types of monomers. The copolymers may be random copolymers or block copolymers. The polymers for use herein preferably have a number-average molecular weight falling between 5000 and 1000000, more preferably between 10000 and 200000. Polymers having a too small molecular weight are unfavorable to the invention, since the mechanical strength of the image-forming layer that comprises such a polymer is low; but others having a too large molecular weight are also unfavorable since their workability into films is not good.

<<Method of Producing Latex>>

The high-Tg polymer latex which is preferably used in the thirty-sixth embodiment of the invention may be prepared through any ordinary polymerization such as emulsion polymerization, dispersion polymerization or suspension polymerization. However, since most coating liquids for photographic materials require water for their medium and since water-insoluble substances such as the copolymers of the type are used in the form of their aqueous dispersion, the high-Tg polymer latex for use herein is preferably prepared through emulsion polymerization or dispersion polymerization, more preferably through emulsion polymerization for facilitating the preparation of the coating liquids. In general, the grain size of the latex grains is at most 300 nm, but preferably at most 200 nm, more preferably at most 150 nm.

One example of emulsion polymerization to prepare the intended polymer latex comprises polymerizing monomers in a dispersion medium of water or a mixed solvent of water and a water-miscible organic solvent (e.g., methanol, ethanol, acetone) in such a manner that from 5 to 40% by weight, relative to the dispersion medium, of the monomer mixture is stirred along with from 0.05 to 5% by weight, relative to the monomer mixture, of a polymerization initiator and from 0.1 to 20% by weight of an emulsifier, at 30 to 100° C. or so, preferably at 60 to 90° C. for 3 to 8 hours. In this method, the dispersion medium, the monomer concentration, the amount of the initiator, the amount of the emulsifier, the reaction temperature, the reaction time, the mode of adding the monomers to the system and other conditions shall be suitably determined in consideration of the type of the monomers and of the intended grain size of the polymer latex to be produced.

Preferred examples of the initiator for the emulsion polymerization are inorganic peroxides such as potassium persulfate, sodium persulfate, ammonium persulfate; azonitrile compounds such as sodium asobiscyanovalerate; azoamidine compounds such as 2,2-azobis(2-amidinopropane) dihydrochloride; cyclic azoamidine compounds such as 2,2-azobis[2-(5-methyl-2-imidazolin-2-yl)propane] hydrochloride; and azoamide compounds such as 2,2-azobis{2-methyl-N-[1,1-bis(hydroxymethyl)-2-hydroxyethyl]propionamide}. Of those, especially preferred are potassium persulfate, sodium persulfate and ammonium persulfate.

For the dispersant, employable is any of anionic surfactants, nonionic surfactants, cationic surfactants and ampholytic surfactants, but preferred are anionic surfactants.

The high Tg-polymer latex is easy to produce according to the mode of any ordinary emulsion polymerization. Ordinary emulsion polymerization is described in detail in the following publications.

Synthetic Resin Emulsion (by Taira Okuda & Hiroshi Inagaki, the Polymer Publishing Association of Japan, 1978);

Applications of Synthetic Latexes (by Takaaki Sugimura, Yasuo Kataoka, Sohichi Suzuki & Keiji Kasahara, the Polymer Publishing Association of Japan, 1993);

Chemistry of Synthetic Latexes (by Sohichi Muroi, the Polymer Publishing Association of Japan, 1970).

Some examples of producing the high Tg-polymer latex are mentioned below.

### PRODUCTION EXAMPLE 1

### Production of Compound (P-3)

90 g of styrene, 3 g of acrylic acid, 160 g of distilled water and 2 g of a surfactant (Sanyo Kasei's Sandet-BL) were put in an autoclave of glass (Pressure Glass Industry's TEM-V1000), and stirred therein in a nitrogen atmosphere. Next, the reactor was closed, and 7 g of butadiene was fed thereinto and heated up to 60° C. With that, 10 g of aqueous potassium persulfate solution (5%) was added thereto and the monomers were reacted for 10 hours with stirring. After thus reacted, the reaction mixture was cooled to room temperature, and 60 g of distilled water was added thereto and stirred for 30 minutes to obtain 327 g of a milky liquid latex. Thus obtained, the dispersion is a latex liquid having a nonvolatile content of 30.2% by weight and having a mean particle size of 76 nm. The particle size was measured through dynamic light scattering with a particle analyzer, Coulter's N4.

### PRODUCTION EXAMPLE 2

### Production of Compound (P-7)

A solution of 2 g of a surfactant, sodium dodecylsulfate in 250 ml of distilled water was put into a 500-ml three-neck flask equipped with a condenser tube and a stirrer, and then a mixture of 80 g of styrene, 15 g of 2-ethylhexyl acrylate and 5 g of acrylic acid was added thereto and stirred at 200 rpm in a nitrogen atmosphere. The reaction mixture was heated up to 75° C., to which was added a solution of 0.2 g of potassium persulfate in 10 ml of distilled water, and the monomers were polymerized for 2 hours. Further, a solution of o.2 g of potassium persulfate in 10 ml of distilled water was added to the system, and the monomers were further polymerized for 2 hours. The reaction mixture was cooled to room temperature, and dialyzed through a cellulose membrane of which the fractionation level is for molecules having a molecular weight of 10,000, to thereby remove the excess surfactant and inorganic salts. Thus processed, this was concentrated under reduced pressure and filtered to remove the insoluble matters. Thus was obtained 380 g of a pale milky dispersion. This is a fine latex liquid having a nonvolatile content of 26.3% by weight and having a mean particle size of 66 nm.

The other high-Tg polymer latexes for use in the thirty-sixth embodiment of the invention may be readily produced in the same manner as above.

In this embodiment, the amount of the high Tg-polymer latex to be used falls between 1 g and 20 g per m² of the photothermographic material, more preferably between 1 g and 15 g. Two or more different types of such high-Tg polymer latexes may be combined for use in this embodiment, or the high-Tg polymer latex may be combined with any other latexes or polymer binders not falling within the scope of the high-Tg polymer latex.

<Solvent Preferred for Coating Liquid>

Preferably, the solvent for the coating liquid for the image forming layer of the photothermographic material of the thirty-sixth embodiment of the invention is an aqueous solvent that contains at least 30% by weight of water. The solvent referred to herein is meant to indicate both solvent and dispersion medium for simple expression. Except water, the other components of the aqueous solvent may be any organic solvents that are miscible with water, including, for example, methyl alcohol, ethyl alcohol, isopropyl alcohol, methyl cellosolve, ethyl cellosolve, dimethylformamide, ethyl acetate. The water content of the solvent for the coating liquid is preferably at least 50% by weight, more preferably at least 70% by weight. Preferred examples of the solvent composition are water alone, water/methyl alcohol=90/10, water/methyl alcohol=70/30, water/methyl alcohol/dimethylformamide=80/15/5, water/methyl alcohol/ethyl cellosolve=85/10/5, water/methyl alcohol/isopropyl alcohol =85/10/5. The ratio is by weight.

<Antifoggant>

Antifoggants, stabilizers and stabilizer precursors usable in the thirty-sixth embodiment of the invention are described, for example, in JP-A 10-62899, paragraph [0070]; EP Laid-Open 0803764A1, from page 20, line 57 to page 21, line 7; JP-A 9-281637, 9-329864.

The photothermographic material of this embodiment must contain an organic polyhalogen compound that serves as an antifoggant. Containing a suitable amount of such a polyhalogen compound, the image storability of the photothermographic material is significantly improved. For the polyhalogen compounds for use herein, referred to are those disclosed in JP-A 11-65021, paragraphs [0111] to [0112]. Especially preferred are organic halides of formula (P) in JP-A 2000-284399; organic polyhalogen compounds of formula (II) in JP-A 10-339934; and organic polyhalogen compounds in JP-A 2001-33911.

Polyhalogen Compound

Organic polyhalogen compounds preferred for use in the thirty-sixth embodiment of the invention are described concretely. Preferably, the polyhalogen compounds for use in this embodiment are represented by the following general formula (H):

Q—(Y)n—C(Z₁)(Z₂)X General Formula (H)

wherein Q represents an alkyl, aryl or heterocyclic group; Y represents a divalent linking group; n indicates 0 or 1; Z₁ and Z₂ each represent a halogen atom; and X represents a hydrogen atom or an electron-attracting group.

In formula (H), Q is preferably a phenyl group substituted with an electron-attracting group having a positive Hammett's substituent constant σₚ. For the Hammett's substituent constant, referred to is, for example, Journal of Medicinal Chemistry, 1973, Vol. 16, No. 11, 1207-1216. The electron-attracting group includes, for example, a halogen atom (fluorine atom with σₚ of 0.06, chlorine atom with σₚ of 0.23, bromine atom with σₚ of 0.23, iodine atom with σₚ of 0.18), a trihalomethyl group (tribromomethyl with σₚ of 0.29, trichloromethyl with σₚ of 0.33, trifluoromethyl with up of 0.54), a cyano group (with σₚ of 0.66), a nitro group (with σₚ of 0.78), an aliphatic, aryl or heterocyclic sulfonyl group (e.g., methanesulfonyl with σₚ of 0.72), an aliphatic, aryl or heterocyclic acyl group (e.g., acetyl with σₚ of 0.50, benzoyl with σₚ of 0.43), an alkynyl group (e.g., C≡CH with σₚ of 0.23), an aliphatic, aryl or heterocyclic oxycarbonyl group (e.g., methoxycarbonyl with σₚ of 0.45, phenoxycarbonyl with σₚ of 0.44), a carbamoyl group (with σₚ of 0.36), a sulfamoyl group (with σₚ of 0.57), a sulfoxide group, a heterocyclic group, and a phosphoryl group. The σₚ of the electron-attracting group preferably falls between 0.2 and 2.0, more preferably between 0.4 and 1.0. Of those electron-attracting groups, more preferred are a carbamoyl group, an alkoxycarbonyl group, an alkylsulfonyl group and an alkylphosphoryl group, and most preferred is a carbamoyl group.

In formula (H), X is preferably an electron-attracting group. Concretely, it is more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group. Even more preferably, it is a halogen atom. For the halogen atom for X, preferred are chlorine, bromine and iodine atoms, more preferred are chlorine and bromine atoms, and even more preferred is a bromine atom.

In formula (H), Y is preferably —C(═O)—, —SO— or —SO₂—, more preferably —C(═O)— or —SO₂—, even more preferably SO₂—. n is 0 or 1, but preferably 1.

Specific examples of the compounds of formula (H) for use in the thirty-sixth embodiment of the invention are mentioned below.

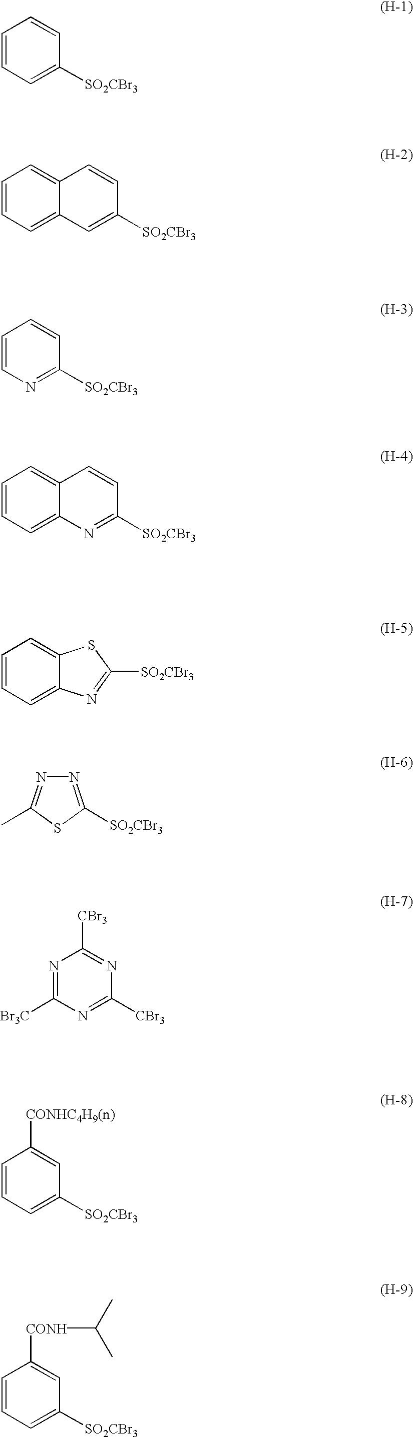

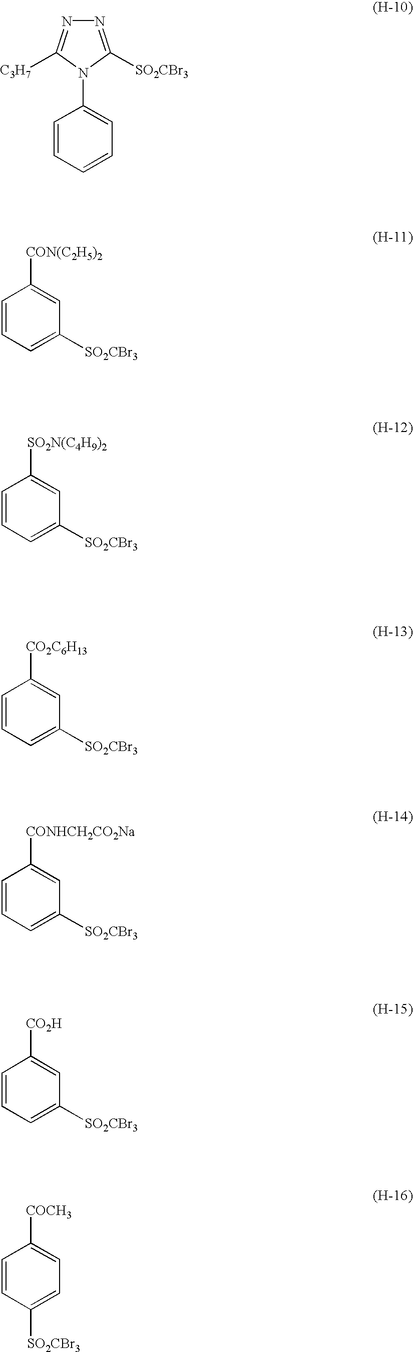

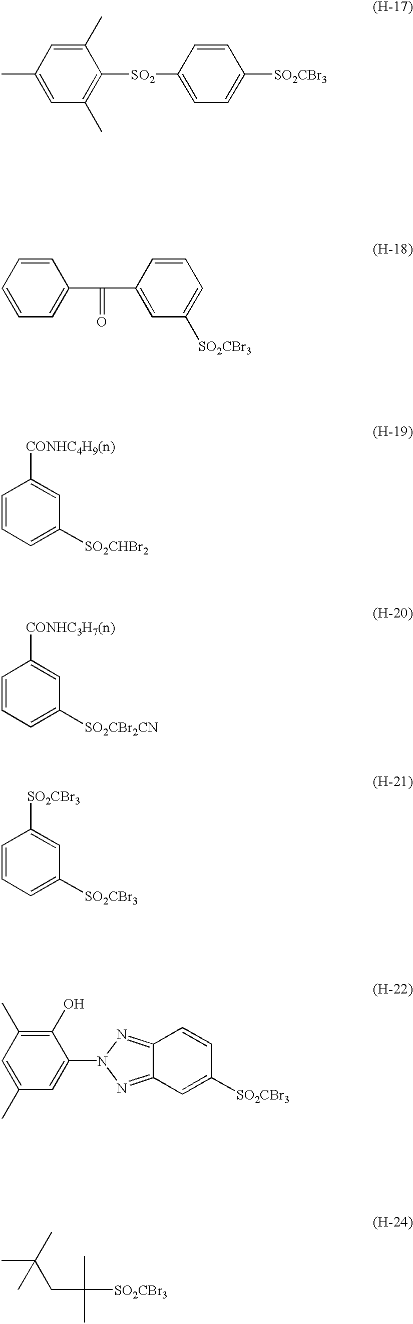

Preferably, the amount of the compound of formula (H) to be in the photothermographic material of the thirty-sixth embodiment of the invention falls between 10⁻³ and 0.8 mols, more preferably between 10⁻³ and 0.1 mols, even more preferably between 5×10⁻³ and 0.05 mols per mol of the non-photosensitive organic silver salt in the image-forming layer of the material.

The amount of the polyhalogen compound to be added to the photothermographic material of the thirty-sixth embodiment of the invention in which is used a silver iodide-rich silver halide emulsion has a significant meaning for ensuring the satisfactory fogging resistance of the material. Especially preferably, therefore, the amount falls between 5×10⁻³ and 0.03 mols per mol of the non-photosensitive silver salt in the material.

The antifoggant may be incorporated into the photothermographic material of this embodiment in the same manner as that mentioned hereinabove for incorporating the reducing agent thereinto. Preferably, the organic polyhalogen compound is in the form of a fine solid particle dispersion when it is incorporated into the material.

<Other Antifoggants>

Other antifoggants usable herein are mercury(II) salts as in JP-A 11-65021, paragraph [0113]; benzoic acids as in JP-A 11-65021, paragraph [0114]; salicylic acid derivatives as in JP-A 2000-206642; formalin scavenger compounds of formula (S) in JP-A 2000-221634; triazine compounds claimed in claim 9 in JP-A 11-352624; compounds of formula (III) in JP-A 6-11791; and 4-hydroxy-6-methyl-1,3,3a,7-tetrazaindene.

The photothermographic material of the thirty-sixth embodiment of the invention may also contain an azolium salt serving as an antifoggant. The azolium salt includes, for example, compounds of formula (XI) in JP-A 59-193447, compounds as in JP-B 55-12581, and compounds of formula (II) in JP-A 60-153039. The azolium salt may be present in any site of the photothermographic material, but is preferably in some layer on the surface of the material on which is present an image-forming layer. More preferably, it is added to the image-forming layer of the material. Regarding the time at which the azolium salt is added to the material, it may be added to the coating liquid at any stage of preparing the liquid. In case where it is to be present in the image-forming layer, the azolium salt may be added to any of the reaction system to prepare the organic silver salt to be in the layer, or the reaction system to prepare the coating liquid at any stage of preparing it. Preferably, however, it is added to the coating liquid after the stage of preparing the organic silver salt and just before the stage of coating the liquid. The azolium salt to be added may be in any form of powder, solution or fine particle dispersion. It may be added along with other additives such as sensitizing dye, reducing agent and toning agent, for example, in the form of their solution. The amount of the azolium salt to be added to the photothermographic material of the thirty-sixth embodiment of the invention is not specifically defined, but preferably falls between 1×10⁻⁶ mols and 2 mols, more preferably between 1×10⁻³ mols and 0.5 mols per mol of silver in the material.

<Other Additives>

<<Mercapto, Disulfide and Thione Compounds>>

The photothermographic material of the thirty-sixth embodiment of the invention may optionally contain any of mercapto compounds, disulfide compounds and thione compounds which are for retarding, promoting or controlling the developability of the material, or for enhancing the spectral sensitivity thereof, or for improving the storage stability thereof before and after development. For the additive compounds, for example, referred to are JP-A 10-62899, paragraphs [0067] to [0069]; compounds of formula (I) in JP-A 10-186572, and their examples in paragraphs [0033] to [0052]; EP Laid-Open 0803764A1, page 20, lines 36 to 56; and Japanese Patent Application No. 11-237670. Above all, preferred are mercapto-substituted heteroaromatic compounds.

<Toning Agent>

Adding a toning agent to the photothermographic material of the thirty-sixth embodiment of the invention is preferred. Examples of the toning agent usable herein are described in JP-A 10-62899, paragraphs [0054] to [0055], EP Laid-Open 0803764A1, page 21, lines 23 to 48; and JP-A 2000-356317; and Japanese Patent Application No. 2000-187298. Preferred for use herein are phthalazinones (phthalazinone, phthalazinone derivatives and their metal salts, e.g., 4-(1-naphthyl)phthalazinone, 6-chlorophthalazinone, 5,7-dimethoxyphthalazinone, 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives and their salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); combinations of phthalazines and phthalic acids. More preferred are combinations of phthalazines and phthalic acids for the silver iodide-rich silver halide composition for use in this embodiment.

The amount of the phthalazines that may be added to the photothermographic material of this embodiment preferably falls between 0.01 mols and 0.3 mols, more preferably between 0.02 mols and 0.2 mols, even more preferably between 0.02 mols and 0.1 mols per mol of the organic silver salt in the material. The amount of the phthalazines added to the material has a significant meaning for solving the problems with the silver iodide-rich silver halide emulsion used herein, or that is, for improving the developability of the emulsion. Containing a suitably selected amount of the phthalazines, the photothermographic material of this embodiment satisfies the requirements of good developability and fogging resistance.

<<Plasticizer, Lubricant>>

Plasticizers and lubricants that may be in the photosensitive layer of the photothermographic material of the first embodiment of the invention are described in, for example, JP-A 11-65021, paragraph [0117]. Lubricants that may be in the layer are also described in JP-A 11-84573, paragraphs [0061] to [0064], and JP-A 11-106881, paragraphs [0049] to [0062].

<<Dye, Pigment>>

The photosensitive layer in the first embodiment of the invention may contain various types of dyes and pigments (e.g., C.I. Pigment Blue 60, C.I. Pigment Blue 64, C.I. Pigment Blue 15:6) for improving the image tone, for preventing interference fringes during laser exposure, and for preventing irradiation. The details of such dyes and pigments are described in, for example, WO98/36322, and JP-A 10-268465 and 11-338098.

<<Super-hardener>>

For forming super-hard images suitable to printing plates, a super-hardener is preferably added to the image-forming layer of the photothermographic material. For such super-hardeners for forming super-hard images, methods of using them, and their amounts applicable to the invention, for example, referred to are JP-A 11-65021, paragraph [0118]; JP-A 11-223898, paragraphs [0136] to [0193]; compounds of formula (H), those of formulae (1) to (3) and those of formulae (A) and (B) in JP-A 2000-284399; compounds of formulae (III) to (V) in Japanese Patent Application No. 11-91652, especially concrete compounds in [Formula 21] to [Formula 24] therein. For hardening promoters also applicable to the invention, referred to are JP-A 11-65021, paragraph [0102]; and JP-A 11-223898, paragraphs [0194] to [0195].

In case where formic acid or its salt is used for a strong foggant in the invention, it may be added to the photosensitive silver halide-containing, image-forming layer of the material, and its amount is preferably at most 5 mmols, more preferably at most 1 mmol per mol of silver in the layer.

In case where a super-hardener is used in the photothermographic material of the first embodiment of the invention, it is preferably combined with an acid formed through hydration of diphosphorus pentoxide or its salt.

The acid to be formed through hydration of diphosphorus pentoxide and its salts include, for example, metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts).

For the acid to be formed through hydration of diphosphorus pentoxide and its salts, preferred for use herein are orthophosphoric acid (and its salts), and hexametaphosphoric acid (and its salts).

Concretely, their salts are sodium orthophosphate, sodium dihydrogen-orthophosphate, sodium hexametaphosphate, and ammonium hexametaphosphate.

The amount of the acid to be formed through hydration of diphosphorus pentoxide or its salt to be used herein (that is, the amount thereof to be in the unit area, one m², of the photothermographic material) may be any desired one and may be defined in any desired manner depending on the sensitivity, the fogging resistance and other properties of the material. Preferably, however, it falls between 0.1 and 500 mg/m², more preferably between 0.5 and 100 mg/m².

<Layer Constitution>

The photothermographic material of the thirty-sixth embodiment of the invention has a non-image-recording surface protective layer on the far side of the support relative to the image-forming layer, for preventing the surface blocking of the image-forming layer. The surface protective layer may have a multi-layered structure. The details of the surface protective layer are described, for example, in JP-A 11-65021, paragraphs [0119] to [0120], and Japanese Patent Application No. 2000-171936.

Gelatin is preferred for the binder in the surface protective layer, but polyvinyl alcohol (PVA) is also usable for it. Combining the two for the binder is also preferred in the invention of this embodiment. Gelatin for use herein may be inert gelatin (e.g., Nitta Gelatin 750), or gelatin phthalide (e.g., Nitta Gelatin 801). For PVA usable herein, referred to are those described in JP-A 2000-171936, paragraphs [0009] to [0020]. Preferred for PVA for use herein are, for example, completely saponified PVA-105; partially saponified PVA-205, PVA-355; and modified polyvinyl alcohol, MP-203 (all commercial products of Kuraray). The polyvinyl alcohol content (per m² of the support) of one surface protective layer preferably falls between 0.3 and 4.0 g/m², more preferably between 0.3 and 2.0 g/m².

In case where the photothermographic material of the thirty-sixth embodiment of the invention is used in the field of printing that require high-level dimensional stability, it is desirable to use a polymer latex in the surface protective layer or the back layer of the material. The polymer latex for that purpose is described in, for example, Synthetic Resin Emulsions (by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); and Chemistry of Synthetic Latexes (by Sohichi Muroi, the Polymer Publishing Association of Japan, 1970). Concretely, it includes, for example, methyl methacrylate (33.5 wt. %)/ethyl acrylate (50 wt. %)/methacrylic acid (16.5 wt. %) copolymer latex; methyl methacrylate (47.5 wt. %)/butadiene (47.5 wt. %)/itaconic acid (5 wt. %) copolymer latex; ethyl acrylate (50 wt. %)/methacrylic acid (50 wt. %) copolymer latex; methyl methacrylate (58.9 wt. %)/2-ethylhexyl acrylate (25.4 wt. %)/styrene (8.6 wt. %)/2-hydroxyethyl methacrylate (5.1 wt. %)/acrylic acid (2.0 wt. %) copolymer latex; and methyl methacrylate (64.0 wt. %)/styrene (9.0 wt. %)/butyl acrylate (20.0 wt. %)/2-hydroxyethyl methacrylate (5.0 wt. %)/acrylic acid (2.0 wt. %) copolymer latex. For the binder for the surface protective layer in this embodiment, for example, referred to are the polymer latex combinations as in Japanese Patent Application No. 11-6872; the techniques as in JP-A 2000-267226, paragraphs [0021] to [0025]; the techniques as in Japanese Patent Application No. 11-6872, paragraphs [0027] to [0028]; and the techniques as in JP-A 2000-19678, paragraphs [0023] to [0041]. The ratio of the polymer latex in the surface protective layer preferably falls between 10% by weight and 90% by weight, more preferably between 20% by weight and 80% by weight of all the binder in the layer.

The overall binder content (including water-soluble polymer and latex polymer, per m² of the support) of one surface protective layer preferably falls between 0.3 and 5.0 g/m², more preferably between 0.3 and 2.0 g/m².

The temperature at which the coating liquid for the image-forming layer in the thirty-sixth embodiment of the invention is prepared preferably falls between 30° C. and 65° C., more preferably between 35° C. and lower than 60° C., even more preferably between 35° C. and 55° C. Also preferably, the temperature of the coating liquid is kept between 30° C. and 65° C. immediately after a polymer latex is added thereto.

One or more image-forming layers are formed on one support to produce the photothermographic material of the thirty-sixth embodiment of the invention. In case where the material has one image-forming layer, the layer comprises an organic silver salt, a photosensitive silver halide, a reducing agent and a binder, optionally containing a toning agent, a coating aid and other auxiliary agents. In case where the material has two or more image-forming layers, the first image-forming layer (in general, this is directly adjacent to the support) must contain an organic silver salt and a photosensitive silver halide, and the second image-forming layer or the two layers must contain the other ingredients. The photothermographic material for multi-color expression of the invention of this embodiment may have combinations of these two layers for the respective colors, or may contain all the necessary ingredients in a single layer, for example, as in U.S. Pat. No. 4,708,928. In the photothermographic material of a type containing multiple dyes for multi-color expression, the individual emulsion layers are generally differentiated and spaced from the others via a functional or non-functional barrier layer between the adjacent emulsion layers, for example, as in U.S. Pat. No. 4,460,681.

The photosensitive layer (image-forming layer) of the photothermographic material of the thirty-sixth embodiment of the invention may contain various types of dyes and pigments (e.g., C.I. Pigment Blue 60, C.I. Pigment Blue 64, C.I. Pigment Blue 15:6) for improving the image tone, for preventing interference fringes during laser exposure, and for preventing irradiation. The details of such dyes and pigments are described in, for example, WO98/36322, and JP-A 10-268465, 11-338098.

In general, the photothermographic material has non-photosensitive layers in addition to photosensitive layers (image-forming layers). Depending on their positions, the non-photosensitive layers are classified into (1) a protective layer to be disposed on a photosensitive layer (remoter from the support than the photosensitive layer); (2) an interlayer to be disposed between adjacent photosensitive layers or between a photosensitive layer and a protective layer; (3) an undercoat layer to be disposed between a photosensitive layer and a support; (4) a back layer to be disposed on a support opposite to a photosensitive layer. The layers (1) and (2) are filter layers that are in the photothermographic material. The layers (3) and (4) are antihalation layers in the material.

The photothermographic material of the thirty-sixth embodiment of the invention may have an antihalation layer remoter from the light source to which it is exposed than its photosensitive layer.

The antihalation layer is described in, for example, JP-A 11-65021, paragraphs [0123] to [0124]; JP-A 11-223898, 9-230531, 10-36695, 10-104779, 11-231457, 11-352625, 11-352626.

The antihalation layer contains an antihalation dye capable of absorbing the light to which the photothermographic material is exposed. In case where the photothermographic material is exposed to IR rays, IR-absorbing dyes may be used for antihalation. In that case, it is desirable that the dyes do not absorb visible light.

On the other hand, in case where visible light-absorbing dyes are used for antihalation, it is desirable that the dyes used are substantially decolored after image formation on the material, for which, for example, usable are decoloring agents that have the ability to decolor the dyes when heated in the step of thermal development. Preferably, a thermal decoloring dye and a base precursor are added to the non-photosensitive layers so that the layers containing them may function as antihalation layers. The details of this technique are described in, for example, JP-A 11-231457.

The amount of the decoloring dye to be added shall be determined, depending on the use of the dye. In general, its amount is so determined that the dye added could ensure an optical density (absorbance), measured at an intended wavelength, of larger than 1.0. The optical density preferably falls between 0.2 and 2. The amount of the dye capable of ensuring the optical density falling within the range may be generally from 0.001 to 1 g/m² or so.

Decoloring the dyes in the photothermographic material in that manner can lower the optical density of the material to 0.1 or less after thermal development. Two or more different types of decoloring dyes may be in the thermodecoloring recording material or the photothermographic material. Similarly, two or more different types of base precursors may be in the material.

In the thermodecoloring material of the type that contains a decoloring dye and a base precursor, it is desirable in view of the thermodecoloring ability of the material that the base precursor therein is combined with a substance which, when mixed with the base precursor, can lower the melting point of the mixture by at most 3° C. (e.g., diphenyl sulfone, 4-chlorophenyl(phenyl) sulfone), for example, as in JP-A 11-352626.

In the thirty-sixth embodiment of the invention, a coloring agent having an absorption maximum in the range falling between 300 and 450 nm may be added to the photothermographic material for improving the silver tone and the image stability of the material. The coloring agent is described in, for example, JP-A 62-210458, 63-104046, 63-1003235, 63-208846, 63-306436, 63-314535, 01-61745, 2001-100363.

In general, the amount of the coloring agent to be added to the material falls between 0.1 mg/m² and 1 g/m². Preferably, it is added to the back layer that is opposite to the photosensitive layer of the material.

Preferably, the photothermographic material of thirty-sixth embodiment of the invention has, on one surface of its support, at least one photosensitive layer (image-forming layer) that contains a photosensitive silver halide emulsion, and has a back layer on the other surface thereof. This is referred to as a single-sided photothermographic material.

Also preferably, the photothermographic material of the thirty-sixth embodiment of the invention contains a matting agent which is for improving the transferability of the material. Matting agents are described in JP-A 11-65021, paragraphs [0126] to [0127]. The amount of the matting agent to be added to the photothermographic material of this embodiment preferably falls between 1 and 400 mg/m², more preferably between 5 and 300 mg/m² of the material.

The degree to which the emulsion surface of the photothermographic material of this embodiment is matted is not specifically defined, so far as the matted layer surface is free from star dust trouble, but is preferably such that the Beck's smoothness of the matted surface could fall between 30 seconds and 2000 seconds, more preferably between 40 seconds and 1500 seconds. The Beck's smoothness is readily obtained according to JIS P8119 (method of testing surface smoothness of paper and paper boards with Beck tester), and to TAPPI Standard T479.

Regarding the matting degree of the back layer of the photothermographic material of the thirty-sixth embodiment of the invention, the Beck's smoothness of the matted back layer preferably falls between 10 seconds and 1200 seconds, more preferably between 20 seconds and 800 seconds, even more preferably between 40 seconds and 500 seconds.

Preferably, the photothermographic material of the thirty-sixth embodiment of the invention contains a matting agent in the outermost surface layer, or in a layer functioning as an outermost surface layer, or in a layer nearer to the outermost surface. Also preferably, it may contain a matting agent in a layer functioning as a protective layer.

The details of the back layer applicable to the thirty-sixth embodiment of the invention are described in JP-A 11-65021, paragraphs [0128] to [0130].

Also preferably, the surface of the photothermographic material of the thirty-sixth embodiment of the invention has a pH of at most 7.0, more preferably at most 6.6, before developed under heat. The lowermost limit of the pH is not specifically defined, but may be at least 3 or so. Most preferably, the pH range falls between 4 and 6.2. For controlling the surface pH of the photothermographic material, employable are nonvolatile acids, for example, organic acids such as phthalic acid derivatives, or sulfuric acid, or nonvolatile bases such as ammonia. These are preferred as effective for reducing the surface pH of the material. Especially preferred for the surface pH-lowering agent is ammonia, as it is highly volatile, and therefore can be readily removed while the coating liquids containing it are coated and surely before thermal development.

Also preferred is combining ammonia with a nonvolatile base such as sodium hydroxide, potassium hydroxide or lithium hydroxide. For measuring the surface pH of the photothermographic material, referred to is the description in JP-A 2000-284399, paragraph [0123].

A hardening agent may be added to the photosensitive layer (image-forming layer), the protective layer, the back layer and other layers constituting the photothermographic material of the thirty-sixth embodiment of the invention. The details of the hardening agent applicable to this embodiment are described in T. H. James' The Theory of the Photographic Process, 4th Ed. (Macmillan Publishing Co., Inc., 1977), pp. 77-87. For example, preferred for use herein are chromium alum, 2,4-dichloro-6-hydroxy-s-triazine sodium salt, N,N-ethylenebis(vinylsulfonacetamide), N,N-propylenebis(vinylsulfonacetamide); as well as polyvalent metal ions described on page 78 of that reference; polyisocyanates described in U.S. Pat. No. 4,281,060 and JP-A 6-208193; epoxy compounds described in U.S. Pat. No. 4,791,042; and vinylsulfone compounds described in JP-A 62-89048.

The hardening agent is added to the coating liquids in the form of its solution. The time at which the solution is added to the coating liquid for the protective layer may fall between 180 minutes before coating the liquid and a time just before the coating, preferably between 60 minutes before the coating and 10 seconds before it. However, there is no specific limitation thereon, so far as the method and the condition employed for adding the hardening agent to the coating liquid ensure the advantages of the invention. Concretely for adding it, employable is a method of mixing a hardening agent with a coating liquid in a tank in such a controlled manner that the mean residence time for the agent as calculated from the amount of the agent added and the flow rate of the coating liquid to a coater could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

Surfactants applicable to the photothermographic material of the thirty-sixth embodiment of the invention are described in JP-A 11-65021, paragraph [0132]; solvents applicable thereto are in the same but in paragraph [0133]; supports applicable thereto are in the same but in paragraph [0134]; antistatic and electroconductive layers applicable thereto are in the same but in paragraph [0135]; methods of forming color images applicable thereto are in the same but in paragraph [0136]; lubricants applicable thereto are in JP-A 11-84573, paragraphs [0061] to [0064] and JP-A 11-106881, paragraphs [0049] to [0062].

The support of the photothermographic material of the thirty-sixth embodiment of the invention is preferably a transparent support. For it, preferred are biaxially-stretched films of polyesters, especially polyethylene terephthalate heated at a temperature falling between 130 and 185° C. The heat treatment is for removing the internal strain that may remain in the biaxially-stretched films and for preventing the film supports from being thermally shrunk during thermal development of the material. In case where the photothermographic material of the invention of this embodiment is for medical treatment, the transparent support for it may be colored with a blue dye (for example, with Dye-1 used in the examples in JP-A 8-240877), or may not be colored. Preferably, the support of the photothermographic material of this embodiment is undercoated, for example, with a water-soluble polyester as in JP-A 11-84574; a styrene-butadiene copolymer as in JP-A 10-186565; or a vinylidene chloride copolymer as in JP-A 2000-39684 and Japanese Patent Application No. 11-106881, paragraphs [0063] to [0080]. For the antistatic layer and the undercoat layer to be formed in the invention of this embodiment, for example, referred to are the techniques disclosed in JP-A 56-143430, 56-143431, 58-62646, 56-120519, 11-84573, paragraphs [0040] to [0051]; U.S. Pat. No. 5,575,957; and JP-A 11-223898, paragraphs [0078] to [0084].

Preferably, the photothermographic material of the thirty-sixth embodiment of the invention is of a monosheet type. The monosheet type does not require any additional sheet to receive images thereon, but may directly form images on itself.

The photothermographic material of the thirty-sixth embodiment of the invention may optionally contain an antioxidant, a stabilizer, a plasticizer, a UV absorbent or a coating aid. Such additives may be in any of the photosensitive layers or the non-photosensitive layers of the material. For the additives, for example, referred to are WO98/36322, EP 803764A1, JP-A 10-186567 and 10-18568.

<Fabrication of Photothermographic Material>

To fabricate the photothermographic material of the thirty-sixth embodiment of the invention, the coating liquids may be applied onto a support in any desired manner. Concretely, various types of coating techniques are employable herein, including, for example, extrusion coating, slide coating, curtain coating, dipping, knife coating, and flow coating. Various types of hoppers for extrusion coating employable herein are described in U.S. Pat. No. 2,681,294. Preferred for the photothermographic material of the invention of this embodiment is extrusion coating or slide coating described in Stephen F. Kistler & Petert M. Schweizer's Liquid Film Coating (Chapman & Hall, 1997), pp. 399-536. More preferred is slide coating. One example of the shape of a slide coater for slide coating is in FIG. 11b-1, on page 427 of that reference. If desired, two or more layers may be formed at the same time, for example, according to the methods described from page 399 to page 536 of that reference, or to the methods described in U.S. Pat. No. 2,761,791 and BP 837,095.

Preferably, the coating liquid for the image-forming layer in the thirty-sixth embodiment of the invention is a thixotropic flow. For it, referred to is the technique described in JP-A 11-52509. Preferably, the coating liquid for the image-forming layer in the invention of this embodiment has a viscosity falling between 400 mPa·s and 100,000 mPa·s, more preferably between 500 mPa·s and 20,000 mPa·s, at a shear rate of 0.1 sec⁻¹. Also preferably, the viscosity falls between 1 mPa·s and 200 mPa·s, more preferably between 5 mPa·s and 80 mPa·s, at a shear rate of 1000 sec⁻¹.

Other techniques applicable to the photothermographic material of the thirty-sixth embodiment of the invention are, for example, in EP 803764A1, EP 883022A1, WO98/36322; JP-A 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420; and Japanese Patent Application Nos. 2000-187298, 2000-10229, 2000-47345, 2000-206642, 2000-98530, 2000-98531, 2000-112059, 2000-112060, 2000-112104, 2000-112064, 2000-171936.

<Packaging Material for Photothermographic Material>

Preferably, the photothermographic material of the thirty-sixth embodiment of the invention is wrapped with a material of low oxygen and/or moisture permeability for preventing its photographic properties from varying and for preventing it from curling or from having a curled habit while stored as raw films. Preferred examples of the packaging material of low oxygen and/or moisture permeability for use herein are described, for example, in JP-A 8-254793, 2000-206653.

<Exposure and Thermal Development>

The photothermographic material of the thirty-sixth embodiment of the invention may be developed in any manner. In general, after having been imagewise exposed, it is developed under heat. Preferably, the temperature for the development falls between 80 and 250° C., more preferably between 100 and 140° C. The time for the development preferably falls between 1 and 60 seconds, more preferably between 5 and 30 seconds, even more preferably between 10 and 20 seconds.

For thermal development for the material, preferred is a plate heater system. For the plate heater system for the material of the invention, preferred is the method described in JP-A 11-133572. The plate heater system described therein is for thermal development of photothermographic materials, in which a photothermographic material having been exposed to have a latent image thereon is brought into contact with a heating unit in the zone for thermal development to thereby convert the latent image into a visible image. In this, the heating unit comprises a plate heater, and multiple presser rolls are disposed in series on one surface of the plate heater. The exposed photothermographic material is passed between the multiple pressure rolls and the plate heater, whereby it is developed under heat. The plate heater is sectioned into 2 to 6 stages, and it is desirable that the temperature of the top stage is kept lower by 1 to 10° C. or so than that of the others. The system is also described in JP-A 54-30032. In the plate heater system, water and organic solvent that remain in the photothermographic material being processed can be removed out of the material. In this, in addition, the support of the photothermographic material rapidly heated is prevented from being deformed.

Laser rays may be used for the light source to which the photothermographic material of the thirty-sixth embodiment of the invention is exposed. One problem with the silver iodide-rich silver halide emulsion to be used in this embodiment is that its sensitivity is low. However, we, the present inventors have found that, when an image is written on the emulsion layer of the photothermographic material of the invention through exposure to high-intensity laser rays, the energy necessary for image formation thereon may be reduced. Accordingly, when an image is written on the layer through exposure to such strong light for a short period of time, the layer ensures the intended sensitivity.

On the surface of the photothermographic material, the quantity of light to which the material is exposed to form thereon an image having a maximum density preferably falls between 0.1 W/mm² and 100 W/mm², more preferably between 0.5 W/mm² and 50 W/mm², even more preferably between 1 W/mm² and 50 W/mm².

For the laser rays to which the photothermographic material of this embodiment is exposed, preferred are gas lasers (Ar⁺, He—Ne), YAG lasers, color lasers, or semiconductor lasers. Also employable is a combination of semiconductor lasers and secondary harmonics generators. The lasers preferred for the photothermographic material of this embodiment shall be defined in accordance with the absorption peak wavelength of the color sensitizing dyes in the material. For example, the lasers preferred for the photothermographic material of this embodiment are He—Ne lasers for red to IR emission, semiconductor lasers for red emission, Ar⁺, He—Ne and He—Cd lasers for blue to green emission, and semiconductor lasers for blue emission. Corresponding to these, the peak wavelength of the laser rays for use herein preferably falls between 600 nm and 900 nm, more preferably between 620 nm and 850 nm. Also preferred are laser rays of which the peak wavelength falls between 300 nm and 500 nm, more preferably between 400 nm and 500 nm.

In addition, laser rays that multiply oscillate in the machine direction through high-frequency superimposition are also preferred for use herein.

One example of laser imagers for medical treatment equipped with an exposure unit and a thermal development unit that are applicable to the invention of this embodiment is Fuji Medical Dry Laser Imager FM-DP L. The system FM-DP L is described in Fuji Medical Review No. 8, pp. 39-55. Needless-to-say, the technique disclosed therein is applicable to laser imagers for the photothermographic material of the thirty-sixth embodiment of the invention. In addition, the photothermographic material of this embodiment can be processed in the laser imager in the AD Network which Fuji Medical System has proposed for a network system under DICOM Standards.

The photothermographic material of the thirty-sixth embodiment of the invention forms a monochromatic image based on silver, and is favorable for use in medical diagnosis, industrial photography, printing, and COM.

Forty-Fourth Embodiment of Photothermographic Material

The forty-fourth embodiment of the invention is described in detail hereinunder.

The forty-fourth embodiment of the present invention is a photothermographic material comprising a support having thereon at least a photosensitive silver halide, a non-photosensitive organic silver salt, a reducing agent and a binder; wherein the mean silver iodide content of the photosensitive silver halide is 5 mol % to 100 mol %, wherein the non-photosensitive organic silver salt is prepared from an organic acid including at least behenic acid and erucic acid, and the erucic acid content of the non-photosensitive organic silver salt is 1×10⁻⁶ mol % to 10 mol % relative to the number of mols of the whole organic acid.

Regarding the halogen composition of the photosensitive silver halide in this embodiment, it is a matter of importance that the silver halide has a silver iodide content of from 5 mol % to 100 mol %. The details of the photosensitive silver halide for use herein are described hereinunder.

In general, the sensitivity of such a silver iodide-rich silver halide emulsion is low and the utility value thereof is therefore low.

Preferably in the forty-fourth embodiment of the invention, a part of the silver halide has a phase capable of absorbing light through direct transition. It is well known that high silver iodide grains having a hexagonal-system wurtzite structure or a cubic-system zinc-blend structure realize light absorption through direct transition in the wavelength range of from 350 nm to 450 nm in which the silver halide grains are exposed to light. However, the sensitivity of the silver halide having such an absorption structure is generally low, and the utility value thereof in the field of photography is therefore low.

Through our studies, we, the present inventors have found that, in a photothermographic material containing a non-photosensitive organic silver salt and a reducing agent, when the non-photosensitive organic silver salt is prepared from an organic acid at least containing behenic acid and erucic acid and when the erucic acid content of the organic silver salt is specifically controlled and further when the material is exposed to high-intensity light of at least 1 mW/mm², then the material may have a high sensitivity even though the photosensitive silver halide therein has a high silver iodide content, and may form sharp images. Our studies have further revealed that the grain size of the silver halide grains in the photothermographic material of this embodiment is preferably at most 80 nm. Containing such small-size silver halide grains, the advantages of the photothermographic material of this embodiment are more remarkable.

The constitutive elements of the photothermographic material of the forty-fourth embodiment of the invention are described in detail hereinunder.

<Photosensitive Silver Halide>

The photosensitive silver halide for use in the forty-fourth embodiment of the invention is described.

<<Halogen Composition>>

The mean silver iodide content of the photosensitive silver halide for use in the forty-fourth embodiment of the invention must fall between 5 mol % and 100 mol %. Preferably, it falls between 10 mol % and 100 mol %, more preferably between 40 mol % and 100 mol %, even more preferably between 70 mol % and 100 mol %, still more preferably between 90 mol % and 100 mol %. Containing such silver iodide-rich silver halide grains, the advantages of the photothermographic material of this embodiment are more remarkable.

Preferably, the silver halide in this embodiment has a direct transition absorption derived from the specific silver iodide crystal structure thereof, in the wavelength range of from 350 nm to 440 nm. Silver halides having such a direct transition for light absorption can be readily differentiated from any others by analyzing them as to whether or not they show an exciton absorption caused by their direction transition at around 400 nm to 430 nm.

The high silver iodide phase of such a type of direct transition light absorption may exist alone in the silver halide emulsion for use herein, but may be conjugated with any other silver halide phase having an indirect transition absorption in a wavelength range of from 350 nm to 440 nm, for example, with silver bromide, silver chloride, silver bromoiodide, silver chloroiodide or their mixed crystals. Any of these are preferred for use herein.

Preferably, the mean silver iodide content of the conjugated grains of that type also falls between 5 mol % and 100 mol % as a whole, more preferably between 10 mol % and 100 mol %, even more preferably between 40 mol % and 100 mol %, still more preferably between 70 mol % and 100 mol %, further more preferably between 90 mol % and 100 mol %.

The silver halide phase of the type of direct transition light absorption generally absorbs much light, but as compared with other silver halide phases of the other type of indirect transition light absorption that absorb only a little light, its sensitivity is low and therefore its industrial use has not heretofore been taken into much consideration.

We, the present inventors have found that, when the specific silver halide composition is used in fabricating the photothermographic material as in this embodiment, then the sensitivity of the material is high when exposed to light falling within a range of from 350 nm to 440 nm and having an intensity of at least 1 mW/mm². The wavelength range of the light to which the material is exposed preferably falls between 350 nm and 430 nm, more preferably between 380 nm and 410 nm. The exposure mode in this embodiment is described in detail with reference to the mode of image formation to be described hereinunder.

<<Grain Size>>

More preferably, the grain size of the photosensitive silver halide for use in the forty-fourth embodiment of the invention falls between 5 nm and 80 nm for producing better results. We, the present inventors have found that the sensitivity of the photothermographic material of this embodiment is higher when the grain size of the silver halide grain in the material is small, concretely at most 80 nm.

More preferably, the grain size of the photosensitive silver halide in this embodiment falls between 5 nm and 60 nm, even more preferably between 10 nm and 50 nm. The grain size referred to herein is meant to indicate the diameter of the circular image having the same area as the projected area of each silver halide grain (for tabular grains, the main face of each grain is projected to determine the projected area of the grain).

<<Method of Forming Grains>>

Methods of forming the photosensitive silver halide are well known in the art, for example, as in Research Disclosure 17029 (June 1978), and U.S. Pat. No. 3,700,458, and any known method is employable in the invention. Concretely, a silver source compound and a halogen source compound are added to gelatin or any other polymer solution to prepare a photosensitive silver halide, and it is then mixed with an organic silver salt. This method is preferred for the invention. Also preferred are the method described in JP-A 11-119374, paragraphs [0217] to [0244]; and the methods described in Japanese Patent Application No. 11-98708 and JP-A 2000-347335.

<<Grain Morphology>>

Silver halide grains generally have different types of morphology, including, for example, cubic grains, octahedral grains, tabular grains, spherical grains, rod-like grains, and potato-like grains. In the forty-fourth embodiment of the invention, cubic silver halide grains are especially preferred. Also preferred are corner-rounded silver halide grains. The surface index (Miller index) of the outer surface of the photosensitive silver halide grains for use herein is not specifically defined, but is desirably such that the proportion of {100} plane, which ensures higher spectral sensitization when it has adsorbed a color-sensitizing dye, in the outer surface is larger. Preferably, the proportion of {100} plane in the outer surface is at least 50%, more preferably at least 65%, even more preferably at least 80%. The Miller index indicated by the proportion of {100} plane can be identified according to the method described by T. Tani in J. Imaging Sci., 29, 165 (1985), based on the adsorption dependency of sensitizing dye onto {111} plane and {100} plane.

<<Heavy Metal>>

In the forty-fourth embodiment of the invention, preferred are silver halide grains having a hexacyano-metal complex in their outermost surface. Preferred examples of the hexacyano-metal complex are [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻. Of those, hexacyano-Fe complexes are more preferred in the forty-fourth embodiment of the invention.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions.

The hexacyano-metal complex may be added to silver halide grains in the form of a solution thereof in water or in a mixed solvent of water and an organic solvent miscible with water (for example, alcohols, ethers, glycols, ketones, esters, amides), or in the form of a mixture thereof with gelatin.

The amount of the hexacyano-metal complex to be added to the silver halide grains preferably falls between 1×10⁻⁵ mols and 1×10⁻² mols, per mol of silver of the grains, more preferably between 1×10⁻⁴ mols and 1×10⁻³ mols.

In order to make the hexacyano-metal complex exist in the outermost surfaces of the silver halide grains, the complex is added to an aqueous silver nitrate solution from which are formed the silver halide grains, after the solution has been added to a reaction system to give the grains but before the grains having been formed are finished for chemical sensitization such as chalcogen sensitization with sulfur, selenium or tellurium or noble metal sensitization with gold or the like, or is directly added to the grains while they are rinsed or dispersed but before they are finished for such chemical sensitization. To prevent the silver halide grains formed from growing too much, it is desirable that the hexacyano-metal complex is added to the grains immediately after they are formed. Preferably, the complex is added thereto before the grains formed are finished for post-treatment.

The photosensitive silver halide grains for use in the forty-fourth embodiment of the invention may contain a metal or metal complex of Groups 8 to 10 of the Periodic Table (including Groups 1 to 18). The metal of Groups 8 to 10, or the center metal of the metal complex is preferably rhodium, ruthenium or iridium. In this embodiment, one metal complex may be used alone, or two or more metal complexes of one and the same type of metal or different types of metals may also be used as combined. The metal or metal complex content of the grains preferably falls between 1×10⁻⁹ mols and 1×10⁻³ mols per mol of silver of the grains. Such heavy metals and metal complexes, and methods of adding them to the silver halide grains are described in, for example, JP-A 7-225449, JP-A 11-65021, paragraphs [0018] to [0024], and JP-A 11-119374, paragraphs [0227] to [0240].

The metal atoms (e.g., in [Fe(CN)₆]⁴⁻) that may be added to the silver halide grains for use in the forty-fourth embodiment of the invention, as well as the methods of desalting or chemical sensitization of the silver halide emulsions are described, for example, in JP-A 11-84574, paragraphs [0046] to [0050], JP-A 11-65021, paragraphs [0025] to [0031], and JP-A 11-119374, paragraphs [0242] to [0250].

<<Gelatin>>

Gelatin of different types may be used in preparing the photosensitive silver halide emulsions for use in the forty-fourth embodiment of the invention. For better dispersion of the photosensitive silver halide emulsion in an organic silver salt-containing coating liquid in producing the photothermographic material of the invention, preferred is low-molecular gelatin having a molecular weight of from 500 to 60,000. The low-molecular gelatin of the type may be used in forming the silver halide grains or in dispersing the grains after the grains have been desalted. Preferably, it is used in dispersing the grains after they have been desalted.

<<Supersensitizer>>

For increasing its intrinsic sensitivity, the photothermographic material of the forty-fourth embodiment of the invention may contain a supersensitizer. For the supersensitizer, for example, usable are the compounds described in EP Laid-Open 587,338, U.S. Pat. Nos. 3,877,943, 4,873,184, and JP-A 5-341432, 11-109547 and 10-111543.

<<Chemical Sensitization>>

Preferably, the photosensitive silver halide grains for use in the forty-fourth embodiment of the invention are chemically sensitized with, for example, sulfur, selenium or tellurium. For such sulfur, selenium or tellurium sensitization, any known compounds are usable. For example, preferred are the compounds described in JP-A 7-128768. The grains for use in the forty-fourth embodiment of the invention are especially preferably sensitized with tellurium, for which more preferred are the compounds described in JP-A 11-65021, paragraph [0030], and the compounds of formulae (II), (III) and (IV) given in JP-A 5-313284.

In the forty-fourth embodiment of the invention, the photosensitive silver halide grains may be chemically sensitized in any stage after their formation but before their coating. For example, they may be chemically sensitized after desalted, but (1) before spectral sensitization, or (2) along with spectral sensitization, or (3) after spectral sensitization, or (4) just before coating.

The amount of the sulfur, selenium or tellurium sensitizer for such chemical sensitization in the forty-fourth embodiment of the invention varies, depending on the type of the silver halide grains to be sensitized therewith and the condition for chemically ripening the grains, but may fall generally between 10⁻⁸ and 10⁻² mols, preferably between 10⁻⁷ and 10⁻³ mols or so, per mol of the silver halide. Though not specifically defined, the condition for chemical sensitization in the forty-fourth embodiment of the invention may be such that the pH falls between 5 and 9, the pAg falls between 5 and 10, and the temperature falls between 40 and 95° C. or so.

If desired, a thiosulfonic acid compound may be added to the silver halide emulsions for use in the forty-fourth embodiment of the invention, according to the method described in EP Laid-Open 293,917.

The photothermographic material of the forty-fourth embodiment of the invention may contain only one type or two or more different types of photosensitive silver halide grains (these will differ in their mean grain size, halogen composition or crystal habit, or in the condition for their chemical sensitization), either singly or as combined. Combining two or more types of photosensitive silver halide grains differing in their sensitivity will enable to control the gradation of the images to be formed in the photothermographic material. For the technique relating to it, referred to are JP-A 57-119341, 53-106125, 47-3929, 48-55730, 46-5187, 50-73627, 57-150841. The sensitivity difference between the combined silver halide grains is preferably such that the respective emulsions differ from each other at least by 0.2 logE.

<<Amount of Silver Halide in Photothermographic Material>>

The amount of the photosensitive silver halide grains to be in the photothermographic material of this embodiment is, in terms of the amount of silver per m² of the material, preferably from 0.03 to 0.6 g/m², more preferably from 0.07 to 0.4 g/m², most preferably from 0.05 to 0.3 g/m². Relative to one mol of the organic silver salt therein, the amount of the photosensitive silver halide grains to be in the material preferably falls between 0.01 mols and 0.3 mols, more preferably between 0.02 mols and 0.2 mols, even more preferably between 0.03 mols and 0.15 mols.

<<Mode of Mixing Photosensitive Silver Halide and Organic Silver Salt>>

Regarding the method and the condition for mixing the photosensitive silver halide grains and an organic silver salt having been prepared separately, for example, preferred is a method of mixing them in a high-performance stirrer, a ball mill, a sand mill, a colloid mill, a shaking mill, a homogenizer or the like; or a method of adding the photosensitive silver halide grains having been prepared to the organic silver salt being prepared, in any desired timing to produce the organic silver salt mixed with the silver halide grains.

Preferably, the photosensitive silver halide for use in the forty-fourth embodiment of the invention is formed in the absence of the organic silver salt as in the manner as above. Mixing two or more different types of aqueous, organic silver salt dispersions with two or more different types of aqueous, photosensitive silver salt dispersions is also preferred for suitably controlling the photographic properties of the photothermographic material of this embodiment.

<<Mode of Mixing Photosensitive Silver Halide in Coating Liquid>>

The preferred time at which the silver halide grains are added to the coating liquid which is to form the image-forming layer on the support of the photothermographic material of the forty-fourth embodiment of the invention may fall between 180 minutes before coating the liquid and a time just before the coating, more preferably between 60 minutes before the coating and 10 seconds before it. However, there is no specific limitation thereon, so far as the method and the condition employed for adding the grains to the coating liquid ensure the advantages of the forty-fourth embodiment of the invention. Concretely for mixing them, employable is a method of adding the grains to the coating liquid in a tank in such a controlled manner that the mean residence time for the grains in the tank, as calculated from the amount of the grains added and the flow rate of the coating liquid to a coater, could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<Non-photosensitive Organic Silver Salt>

The non-photosensitive organic silver salt for use in the forty-fourth embodiment of the invention is described.

The organic silver salt for use in the forty-fourth embodiment of the invention is relatively stable to light, but, when heated at 80° C. or higher in the presence of an exposed photosensitive silver halide and a reducing agent, it functions as a silver ion source and forms a silver image. The organic silver salt may be any and every organic substance that may release silver ions capable of being reduced by a reducing agent.

Some non-photosensitive organic silver salts of that type are described, for example, in JP-A 10-62899, paragraphs [0048] to [0049]); EP Laid-Open 0803764A1, from page 18, line 24 to page 19, line 37; EP Laid-Open 0962812A1; JP-A 11-349591, 2000-7683, 2000-72711. Preferred for use herein are silver salts of organic acids, especially silver salts of long-chain (C10 to C30, preferably C15 to C28) aliphatic carboxylic acids.

Preferred examples of such organic silver salts are silver lignocerate, silver behenate, silver arachidate, silver stearate, silver oleate, silver laurate, silver caproate, silver myristate, silver palmitate, silver erucate and their mixtures.

The forty-fourth embodiment of the invention is characterized in that the organic silver salt to be used therein contains at least silver behenate and silver erucate. Preferably, the silver behenate content of the organic silver salt for use in the forty-fourth embodiment of the invention is at least 50 mol %, more preferably at least 90 mol %, even more preferably at least 95 mol %.

The forty-fourth embodiment of the invention is also characterized in that the erucic acid content of the non-photosensitive organic silver salt to be used therein falls between 10⁻⁶ mol % and 10 mol %, preferably between 10⁻⁶ mol % and 1 mol %, more preferably betwee 10⁻⁶ mol % and 1⁻¹ mol % per mol of all the organic acid to give the non-photosensitive organic silver salt.

The organic silver salt for use in the forty-fourth embodiment of the invention is not specifically defined for its morphology, and may be in any form of acicular, rod-like, tabular or scaly solids.

Scaly organic silver salts are preferred in the forty-fourth embodiment of the invention. Also preferred are short acicular grains having a ratio of major axis to minor axis of at most 5, or rectangular-parallelepiped or cubic grains, or amorphous grains such as potato-like grains. These organic silver grains are characterized in that they are fogged little through thermal development as compared with long acicular grains having a ratio of major axis to minor axis of more than 5. Grains having a ratio of major axis to minor axis of at most 3 are more preferred as the mechanical stability of the coating film with them is better.

In this description, the scaly organic silver salts are defined as follows: A sample of an organic silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average) ≧1.5 are scaly. For scaly grains, preferably, 30≧x (average) ≧1.5, more preferably 20≧x (average) ≧2.0. In this connection, the value x of acicular (needle-like) grains falls within a range of 1≦x (average) <1.5.

In the scaly grains, it is understood that a corresponds to the thickness of tabular grains of which the main plane is represented by b×c. In the scaly organic silver salt grains for use herein, a (average) preferably falls between 0.01 μm and 0.23 μm, more preferably between 0.1 μm and 0.20 μm; and c/b (average) preferably falls between 1 and 6, more preferably between 1.05 and 4, even more preferably between 1.1 and 3.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its morphology, a dispersion of the organic silver salt may be analyzed on its image taken by the use of a transmission electronic microscope. Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%. Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained.

For preparing and dispersing the organic silver salts for use in the forty-fourth embodiment of the invention, employable is any known method. For it, for example, referred to are JP-A 10-62899; EP Laid-Open 0803763A1 and 962812A1; JP-A 11-349591, 2000-7683, 2000-72711; and Japanese Patent Application Nos. 11-348228, 11-348229, 11-348230, 11-203413, 2000-90093, 2000-195621, 2000-191226, 2000-213813, 2000-214155, 2000-191226.

It is desirable that the organic silver salt is dispersed substantially in the absence of a photosensitive silver salt, since the photosensitive silver salt, if any in the dispersing system, will be fogged and its sensitivity will be significantly lowered. For the photothermographic material of the forty-fourth embodiment of the invention, it is desirable that the amount of the photosensitive silver salt that may be in the aqueous dispersion of the organic silver salt is at most 0.1 mol % relative to one mol of the organic silver salt therein, and it is more desirable that any photosensitive silver salt is not forcedly added to the aqueous dispersion.

In the forty-fourth embodiment of the invention, an aqueous dispersion of the organic silver salt may be mixed with an aqueous dispersion of the photosensitive silver salt to prepare the photothermographic material, as so mentioned hereinabove. The blend ratio of the organic silver salt to the photosensitive silver salt in the mixture may be suitably determined depending on the object of the invention. Preferably, the blend ratio of the photosensitive silver salt to the organic silver salt in the mixture falls between 1 and 30 mol %, more preferably between 2 and 20 mol %, even more preferably between 3 and 15 mol %. Mixing two or more different types of aqueous, organic silver salt dispersions with two or more different types of aqueous, photosensitive silver salt dispersions is preferred for controlling the photographic properties of the resulting mixture.

The amount of the organic silver salt to be in the photothermographic material of the forty-fourth embodiment of the invention is not specifically defined, and may be any desired one. Preferably, the overall silver amount including silver halide in the material falls between 0.1 and 5 g/m², more preferably between 0.3 and 3 g/m², even more preferably between 0.5 and 2 g/m². In particular, the overall silver amount therein is preferably at most 1.8 g/m², more preferably at most 1.6 g/m². Containing the preferred reducing agent therein, the photothermographic material of this embodiment ensures a high image density even though its silver amount is low.

The erucic acid and behenic acid content of the organic silver salt in the forty-fourth embodiment of the invention is determined as follows: The organic acid in a sample to be analyzed is esterified by processing it with diazomethane at 40° C. for 30 minutes, and then the resulting ester is quantified through GC-FID. In GC-FID, the column used is DB-1 (30 μm×0.25 mmφ, df=0.25 μm). If the concentration of the organic acid to be quantified is too low, the organic acid is recrystallized in IPA, then the erucic acid having remained in the supernatant is concentrated, and it is quantified.

<Binder>

The binder for use in the forty-fourth embodiment of the invention is described.

The binder to be in the organic silver salt-containing layer in the forty-fourth embodiment of the invention may be polymer of any type, but is preferably transparent or semitransparent and is generally colorless. For it, for example, preferred are natural resins, polymers and copolymers; synthetic resins, polymers and copolymers; and other film-forming media. More concretely, they include, for example, gelatins, rubbers, poly(vinyl alcohols), hydroxyethyl celluloses, cellulose acetates, cellulose acetate butyrates, poly(vinylpyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal), poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). The binder may be prepared from water or an organic solvent or an emulsion through microencapsulation.

The glass transition point Tg of the binder to be in the organic silver salt-containing layer in the forty-fourth embodiment of the invention preferably falls between 0° C. and 80° C., more preferably between 10° C. and 70° C., even more preferably between 15° C. and 65° C.

In this description, Tg is calculated according to the following equation:

1/Tg=Σ(Xi/Tgi)

The polymer of which the glass transition point Tg is calculated as in the above comprises n's monomers copolymerized (i indicates the number of the monomers copolymerized, falling between 1 and n); Xi indicates the mass fraction of with monomer (ΣXi=1); Tgi indicates the glass transition point (in terms of the absolute temperature) of the homopolymer of i'th monomer alone; and Σ indicates the sum total of i falling between 1 and n.

For the glass transition point (Tgi) of the homopolymer of each monomer alone, referred to is the description in Polymer Handbook (3rd edition) (written by J. Brandrup, E. H. Immergut (Wiley-Interscience, 1989)).

One and the same polymer may be used for the binder, but, if desired, two or more different types of polymers may be combined for it. For example, polymer binders that differ in the glass transition point may be combined. In case where at least two polymers that differ in Tg are blended for use herein, it is desirable that the weight-average Tg of the resulting blend falls within the range defined as above.

In the forty-fourth embodiment of the invention, it is desirable that the organic silver salt-containing layer is formed by applying a coating liquid, in which at least 30% by weight of the solvent is water, onto the support followed by drying it.

In case where the organic silver salt-containing layer in the forty-fourth embodiment of the invention is formed by using such a coating liquid in which at least 30% by weight of the solvent is water, followed by drying it, and in case where the binder in the organic silver salt-containing layer is soluble or dispersible in an aqueous solvent (watery solvent), especially when the binder in the organic silver salt-containing layer is a polymer latex that has an equilibrium water content at 25° C. and 60% RH of at most 2% by weight, the photothermographic material having the layer of the type enjoys better properties.

Most preferably, the binder for use in this embodiment is so designed that its ionic conductivity is at most 2.5 mS/cm. For preparing the binder of the type, for example, employable is a method of preparing a polymer for the binder followed by purifying it through a functional membrane for fractionation.

The aqueous solvent in which the polymer binder is soluble or dispersible is water or a mixed solvent of water and at most 70% by weight of a water-miscible organic solvent. The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” referred to herein can apply also to polymer systems in which the polymer is not thermodynamically dissolved but is seemingly dispersed.

The “equilibrium water content at 25° C. and 60% RH” referred to herein for polymer latex is represented by the following equation, in which W₁. indicates the weight of a polymer in humidity-conditioned equilibrium at 25° C. and 60% RH, and W₀ indicates the absolute dry weight of the polymer at 25° C.

Equilibrium water content at 25° C. and 60% RH={(W₁−W₀)/W₀}×100 (wt. %)

For the details of the definition of water content and the method for measuring it, for example, referred to is Polymer Engineering, Lecture 14, Test Methods for Polymer Materials (by the Polymer Society of Japan, Chijin Shokan Publishing).

Preferably, the equilibrium water content at 25° C. and 60% RH of the binder polymer for use in the forty-fourth embodiment of the invention is at most 2% by weight, more preferably from 0.01 to 1.5% by weight, even more preferably from 0.02 to 1% by weight.

Polymers that serve as the binder in the forty-fourth embodiment of the invention are preferably dispersible in aqueous solvents. Polymer dispersions include, for example, a type of hydrophobic polymer latex with water-insoluble fine polymer particles being dispersed, and a type of molecular or micellar polymer dispersion with polymer molecules or micelles being dispersed. Any of these may be employed herein, but preferred is polymer latex dispersion. The particles in the polymer dispersions may have a mean particle size falling between 1 and 50000 nm, but preferably between 5 and 1000 nm, more preferably between 10 and 500 nm, even more preferably between 50 and 200 nm. The particle size distribution of the dispersed polymer particles is not specifically defined. For example, the dispersed polymer particles may have a broad particle size distribution, or may have a narrow particle size distribution of monodispersion. Combining two or more different types of mono-dispersed polymer particles both having a narrow particle size distribution is preferred for suitably controlling the physical properties of the coating liquids for use herein.

For the photothermographic material of the forty-fourth embodiment of the invention, favorably used are hydrophobic polymers that are dispersible in aqueous media. The hydrophobic polymers of the type include, for example, acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked ones. They may be homopolymers from one type of monomer, or copolymers from two or more different types of monomers. The copolymers may be random copolymers or block copolymers. The polymers for use herein preferably have a number-average molecular weight falling between 5000 and 1000000, more preferably between 10000 and 200000. Polymers having a too small molecular weight are unfavorable to the invention, since the mechanical strength of the emulsion layer comprising such a polymer is low; but others having a too large molecular weight are also unfavorable since their workability into films is not good. Especially preferred for use herein is crosslinked polymer latex.

<<Specific Examples of Polymer Latex>>

Preferred examples of polymer latex for use herein are mentioned below.

The following examples are expressed by the constituent monomers, in which each numeral parenthesized indicates the proportion, in terms of % by weight, of the monomer unit, and the molecular weight of each constituent monomer is in terms of the number-average molecular weight thereof. Polyfunctional monomers form a crosslinked structure in polymer latex comprising them, to which, therefore, the concept of molecular weight does not apply. The polymer latex of the type is referred to as “crosslinked”, and the molecular weight of the constituent monomers is omitted. Tg indicates the glass transition point of the polymer latex.

P′-1: Latex of -St(68)-Bu(29)-AA(3)-(crosslinked, Tg 17° C.)

P′-2: Latex of -St(71)-Bu(26)-AA(3)-(crosslinked, Tg 24° C.)

P′-3: Latex of -St(75)-Bu(24)-AA(1)-(crosslinked, Tg 29° C.)

P′-4: Latex of -St(60)-Bu(35)-DVB(3)-MAA(2)-(crosslinked, Tg 6° C.)

P′-5: Latex of -St(70)-Bu(25)-DVB(2)-AA(3)-(crosslinked, Tg 26° C.)

P′-6: Latex of -VDC(85)-MMA(5)-EA(5)-MAA(5)-(molecular weight 67000, Tg−7° C.)

P′-7: Latex of -Et(90)-MAA(10)-(molecular weight 12000, Tg−17° C.)

P′-8: Latex of -St(70)-2EHA(27)-AA(3)-(molecular weigh: 130000, Tg 43° C.)

P′-9: Latex of -St(70.5)-Bu(26.5)-AA(3)-(crosslinked, Tg 23° C.)

P′-10: Latex of -St(69.5)-Bu(27.5)-AA(3)-(crosslinked, Tg 20.5° C.)

Abbreviations of the constituent monomers are as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The polymer latexes mentioned above are available on the market. Some commercial products employable herein are mentioned below. Examples of acrylic polymers are CEBIAN A-4635, 4718, 4601 (all from Daicel Chemical Industries), and Nipol Lx811, 814, 821, 820, 857 (all from Nippon Zeon); examples of poly(esters) are FINETEX ES650, 611, 675, 850 (all from Dai-Nippon Ink & Chemicals), and WD-size, WMS (both from Eastman Chemical); examples of poly(urethanes) are HYDRAN AP10, 20, 40 (all from Dai-Nippon Ink & Chemicals); examples of rubbers are LACSTAR 7310K, 3307B (both from Dai-Nippon Ink &, Chemicals), and Nipol Lx416, 410, 438C (all from Nippon Zeon); examples of poly(vinyl chlorides) are G351, G576 (both from Nippon Zeon); examples of poly(vinylidene chlorides) are L502, L513 (both from Asahi Kasei); and examples of poly(olefins) are CHEMIPEARL S120, SA100 (both from Mitsui Petrochemical).

<<Preferred Polymer Latexes>>

For the polymer latex for use in the forty-fourth embodiment of the invention, especially preferred is styrene-butadiene copolymer latex. In the styrene-butadiene copolymer, the ratio of styrene monomer units to butadiene monomer units preferably falls between 40/60 and 95/5 by weight. Also preferably, the styrene monomer units and the butadiene monomer units account for from 60 to 99% by weight of the copolymer. Still preferably, the polymer latex for use in the forty-fourth embodiment of the invention contains from 1 to 6% by weight, more preferably from 2 to 5% by weight of acrylic acid or methacrylic acid relative to the sum of styrene and butadiene therein. Even more preferably, the polymer latex for use in the forty-fourth embodiment of the invention contains acrylic acid.

The organic silver salt-containing layer (that is, the image-forming layer) of the photothermographic material of the forty-fourth embodiment of the invention may optionally contain a hydrophilic polymer such as gelatin, polyvinyl alcohol, methyl cellulose, hydroxypropyl cellulose or carboxymethyl cellulose. The amount of the hydrophilic polymer that may be in the layer is preferably at most 30% by weight, more preferably at most 20% by weight of all the binder in the organic silver salt-containing layer.

Preferably, the polymer latex as above is used in forming the organic silver salt-containing layer of the photothermographic material of the forty-fourth embodiment of the invention. Concretely, the amount of the binder in the organic silver salt-containing layer is such that the ratio by weight of total binder/organic silver salt falls between 1/10 and 10/1, more preferably between 1/3 and 5/1, even more preferably between 1/1 and 3/1.

The organic silver salt-containing layer is a photosensitive layer (emulsion layer) generally containing a photosensitive silver salt, that is, a photosensitive silver halide. In the layer, the ratio by weight of total binder/silver halide preferably falls between 5 and 400, more preferably between 10 and 200.

The overall amount of the binder in the image-forming layer of the photothermographic material of the forty-fourth embodiment of the invention preferably falls between 0.2 and 30 g/m², more preferably between 1 and 15 g/m², even more preferably between 2 and 10 g/m². The image-forming layer in this embodiment may optionally contain a crosslinking agent, and a surfactant which is for improving the coatability of the coating liquid for the layer.

<Reducing Agent>

The reducing agent for use in the forty-fourth embodiment of the invention is described.

The photothermographic material of the forty-fourth embodiment of the invention contains a reducing agent for the organic silver salt therein. The reducing agent may be any and every substance capable of reducing silver ions into metal silver, but is preferably an organic substance. Some examples of the reducing agent are described in JP-A 11-65021, paragraphs [0043] to [0045], and in EP Laid-Open 0803764A1, from page 7, line 34 to page 18, line 12.

Especially preferred for the reducing agent in the forty-fourth embodiment of the invention are hindered phenol-type reducing agents and bisphenol-type reducing agents that have an ortho-positioned substituent relative to the phenolic hydroxyl group therein, and more preferred are compounds of the following general formula (R′):

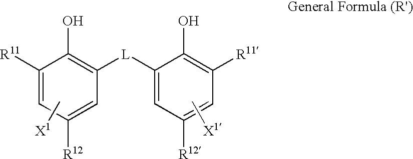

In formula (R′), R¹¹ and R^{11′} each independently represent an alkyl group having from 1 to 20 carbon atoms; R¹² and R^{12′} each independently represent a hydrogen atom, or a substituent substitutable to the benzene ring; L represents —S— or —CHR¹³—; R¹³ represents a hydrogen atom, or an alkyl group having from 1 to 20 carbon atoms; X¹ and X^{1′} each independently represent a hydrogen atom, or a substituent substitutable to the benzene ring.

The substituents in formula (R′) are described.

1) R¹¹ and R^{11′}:

R¹¹ and R^{11′} each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, an ureido group, an urethane group, and a halogen atom.

2) R¹² and R^{12′}, X¹ and X^{1′}:

R¹² and R^{12′} each independently represent a hydrogen atom, or a substituent substitutable to the benzene ring.

X¹ and X^{1′} each independently represent a hydrogen atom, or a substituent substitutable to the benzene ring. Preferred examples of the substituent substitutable to the benzene ring are an alkyl group, an aryl group, a halogen atom, an alkoxy group, and an acylamino group.

3) L:

L represents a group of —S— or —CHR¹³—. R¹³ represents a hydrogen atom or an alkyl group having from 1 to 20 carbon atoms. The alkyl group may be substituted.

Specific examples of the unsubstituted alkyl group for R¹³ are methyl, ethyl, propyl, butyl, heptyl, undecyl, isopropyl, 1-ethylpentyl and 2,4,4-trimethylpentyl groups. For the substituent for the substituted alkyl group for R¹³, referred to are those mentioned hereinabove for the substituted alkyl group for R¹¹.

4) Preferred Substituents:

For R¹¹ and R^{11′}, preferred is a secondary or tertiary alkyl group having from 3 to 15 carbon atoms, concretely including, for example, isopropyl, isobutyl, t-butyl, t-amyl, t-octyl, cyclohexyl, cyclopentyl, 1-methylcyclohexyl and 1-methylcyclopropyl groups. For R¹¹ and R^{11′}, more preferred is a tertiary alkyl group having from 4 to 12 carbon atoms; even more preferred is any of t-butyl, t-amyl and 1-methylcycohexyl groups; and most preferred is a t-butyl group.

Preferably, R¹² and R^{12′} each are an alkyl group having from 1 to 20 carbon atoms, concretely including, for example, methyl, ethyl, propyl, butyl, isopropyl, tert-butyl, tert-amyl, cyclohexyl, 1-methylcyclohexyl, benzyl, methoxymethyl and methoxyethyl groups. For these, more preferred are methyl, ethyl, propyl, isopropyl and tert-butyl groups.

Also preferably, X¹ and X^{1′} each are a hydrogen atom, a halogen atom or an alkyl group; and more preferably, they are both hydrogen atoms.

L is preferably —CHR¹³—.

Also preferably, R¹³ is a hydrogen atom, or an alkyl group having from 1 to 15 carbon atoms. Preferred examples of the alkyl group are methyl, ethyl, propyl, isopropyl and 2,4,4-trimethylpentyl groups. More preferably, R¹³ is a hydrogen atom, a methyl group, a propyl group or an isopropyl group.

In case where R¹³ is a hydrogen atom, R¹² and R^{12′} each are preferably an alkyl group having from 2 to 5 carbon atoms, more preferably an ethyl or propyl group, most preferably, they are both ethyl groups.

In case where R¹³ is a primary or secondary alkyl group having from 1 to 8 carbon atoms, R¹² and R^{12′} are preferably both methyl groups. The primary or secondary alkyl group having from 1 to 8 carbon atoms for R¹³ is preferably a methyl, ethyl, propyl or isopropyl group, more preferably a methyl, ethyl or propyl group.

In case where R¹¹, R^{11′}, R¹² and R^{12′} are all methyl groups, R¹³ is preferably a secondary alkyl group. The secondary alkyl group for R¹³ is preferably an isopropyl, isobutyl or 1-ethylpentyl group, more preferably an isopropyl group.

Depending on the combination of R¹¹, R^{11′}, R¹², R^{12′} and R¹³ therein, the reducing agents differ in their thermal developability and in the tone of developed silver. Combining two or more different types of reducing agents enables to control the developability and the developed silver tone. Depending on their object, therefore, combining them will be preferred in the invention.

Examples of the compounds of formula (R′) and other reducing agents for use in the forty-fourth embodiment of the invention are mentioned below (R′-1 to R′-34), to which, however, the invention of this embodiment is not limited.

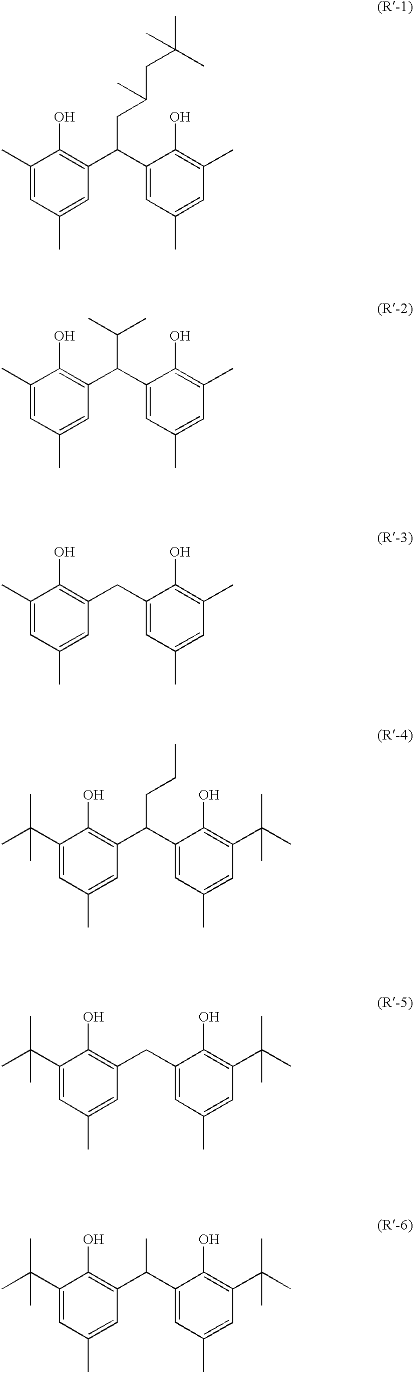

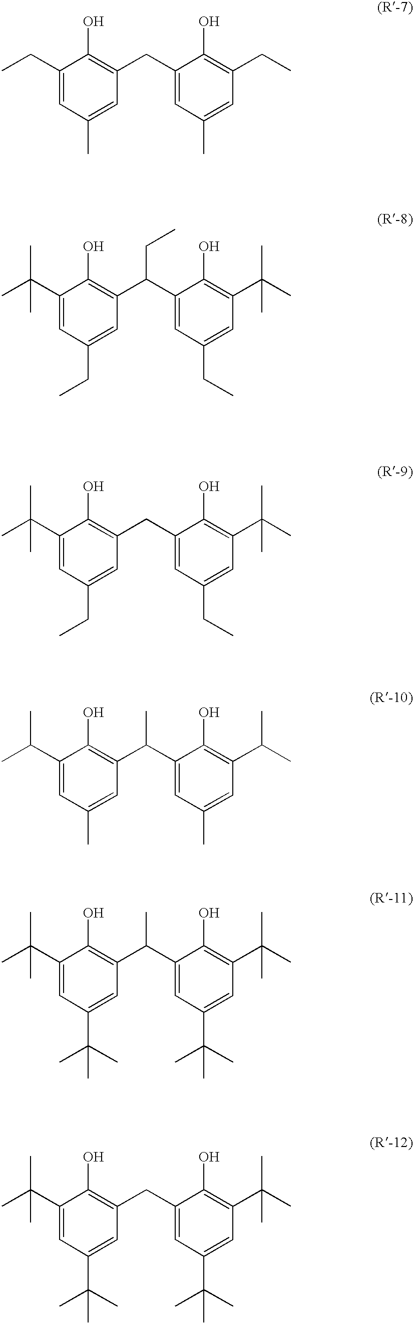

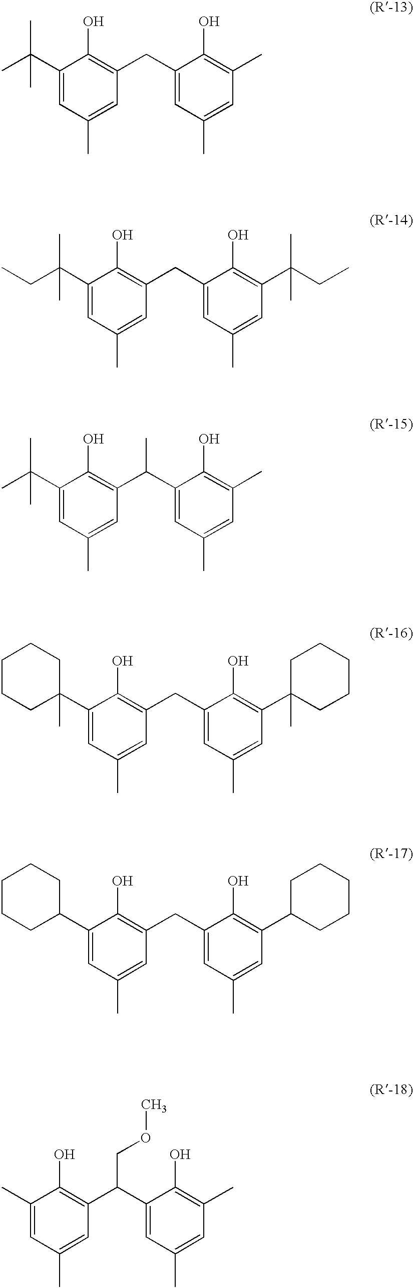

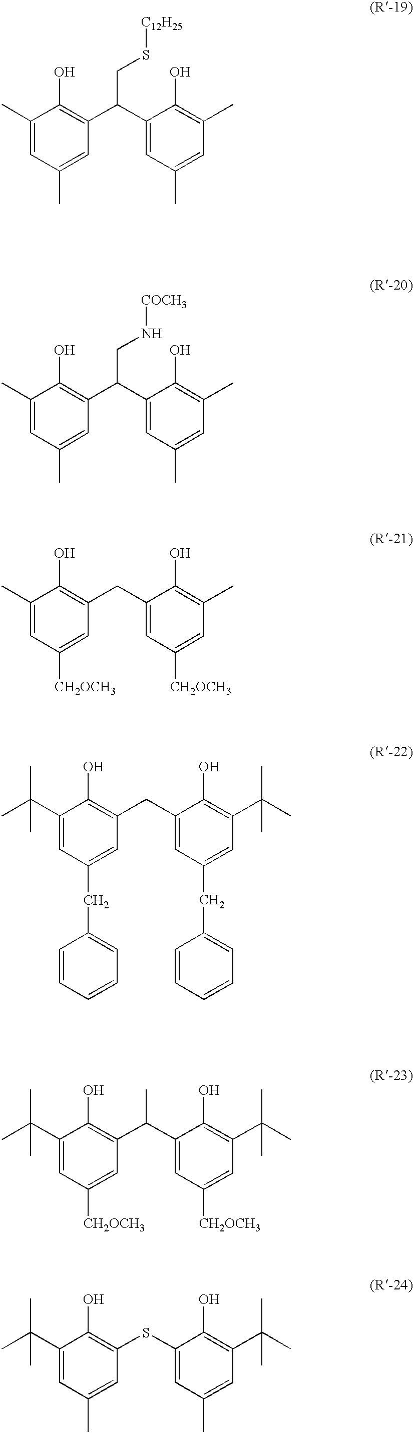

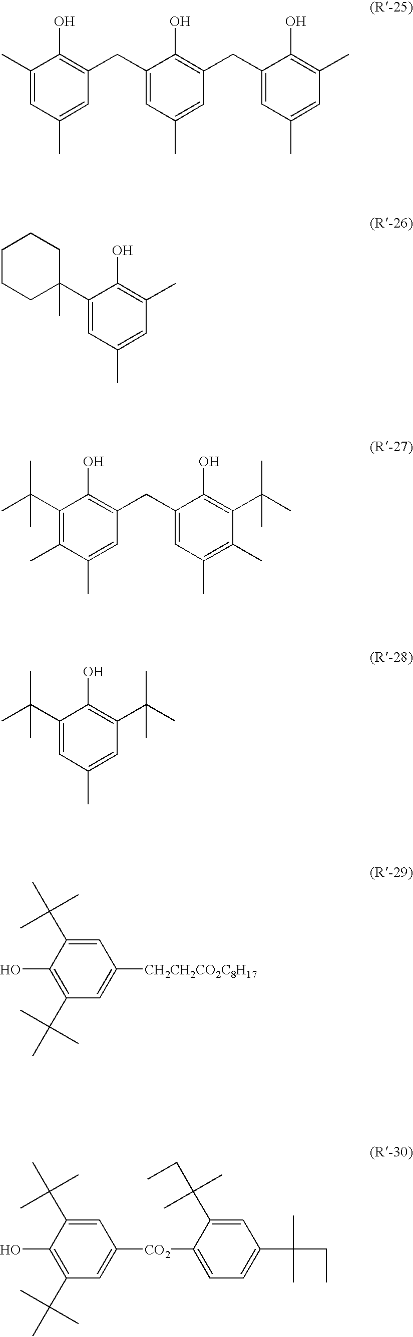

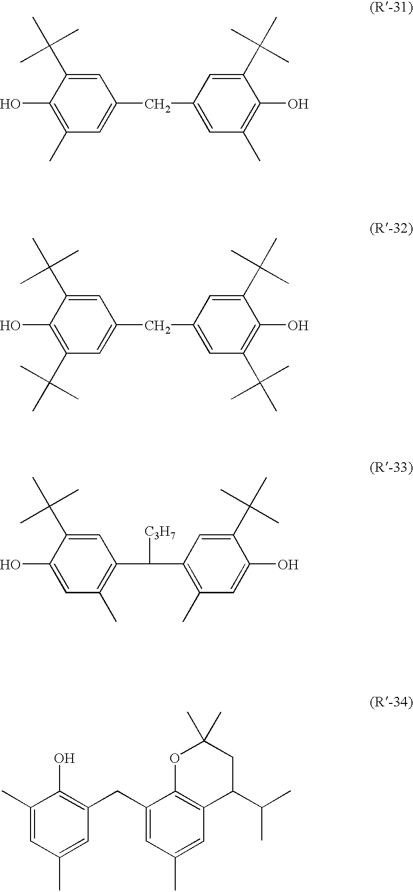

Preferably, the amount of the reducing agent to be in the photothermographic material of the forty-fourth embodiment of the invention falls between 0.1 and 3.0 g/m², more preferably between 0.2 and 1.5 g/m², even more preferably between 0.3 and 1.0 g/m². Also preferably, the amount of the reducing agent to be in the material falls between 5 and 50 mol %, more preferably between 8 and 30 mol %, even more preferably between 10 and 20 mol % per mol of silver existing in the face of the image-forming layer of the material.

Preferably, the reducing agent is in the image-forming layer of the material.

The reducing agent may be in any form of solution, emulsified dispersion or fine solid particle dispersion, and may be added to the coating liquid in any known method so as to be incorporated into the photothermographic material of the invention of this embodiment.

One well known method of emulsifying the reducing agent to prepare its dispersion comprises dissolving the reducing agent in an auxiliary solvent such dibutyl phthalate, tricresyl phosphate, glyceryl triacetate, diethyl phthalate or the like oily solvent, or in ethyl acetate or cyclohexanone, followed by mechanically emulsifying it into a dispersion.

For preparing a fine solid particle dispersion of the reducing agent, for example, employable is a method that comprises dispersing a powder of the reducing agent in water or in any other suitable solvent by the use of a ball mill, a colloid mill, a shaking ball mill, a sand mill, a jet mill or a roller mill, or ultrasonically dispersing it therein to thereby prepare the intended solid dispersion of the reducing agent. In this method, optionally used is a protective colloid (e.g., polyvinyl alcohol), and a surfactant (e.g., anionic surfactant such as sodium triisopropylnaphthalenesulfonate—this is a mixture of the salts in which the three isopropyl groups are all in different positions). In these mills, generally used are beads of zirconia or the like that serve as a dispersion medium. Zr or the like may dissolve out of the beads and will often contaminate the dispersion formed. Though varying depending on the dispersion condition, the contaminant content of the dispersion formed may generally fall between 1 ppm and 1000 ppm. So far as the Zr content of the photothermographic material finally fabricated herein is not larger than 0.5 mg per gram of silver in the material, the contaminant will cause no practical problem. Preferably, the aqueous dispersion contains a preservative (e.g., sodium benzoisothiazolinone).

<Development Accelerator>

Preferably, the photothermographic material of the forty-fourth embodiment of the invention contains a development accelerator. Preferred examples of the development accelerator are sulfonamidophenol compounds of formula (A) in JP-A 2000-267222 and 2000-330234; hindered phenol compounds of formula (II) in JP-A 2001-92075; compounds of formula (I) in JP-A 10-62895 and 11-15116; hydrazine compounds of formula (I) in Japanese Patent Application No. 2001-074278; and phenol or naphthol compounds of formula (2) in Japanese Patent Application No. 2000-76240. The amount of the development accelerator to be in the material may fall between 0.1 and 20 mol %, but preferably between 0.5 and 10 mol %, more preferably between 1 and 5 mol % relative to the reducing agent therein. The development accelerator may be introduced into the material like the reducing agent thereinto. Preferably, however, it is added to the material in the form of its solid dispersion or emulsified dispersion. In case where it is added to the material in the form of its emulsified dispersion, the emulsified dispersion thereof is preferably prepared by emulsifying and dispersing the development accelerator in a mixed solvent of a high-boiling point solvent that is solid at room temperature and an auxiliary solvent having a low boiling point; or the emulsified dispersion is preferably an oilless dispersion with no high-boiling-point solvent therein.

Of the development accelerators mentioned above, especially preferred for use in the forty-fourth embodiment of the invention are hydrazine compounds of formula (I) described in Japanese Patent Application No. 2001-074278, and phenol or naphthol compounds of formula (2) described in Japanese Patent Application No. 2000-76240.

Preferred examples of the development accelerators for use in the forty-fourth embodiment of the invention are mentioned below (A′-1 to A′-7 and A-9 to A′-11), to which, however, this embodiment is not limited.

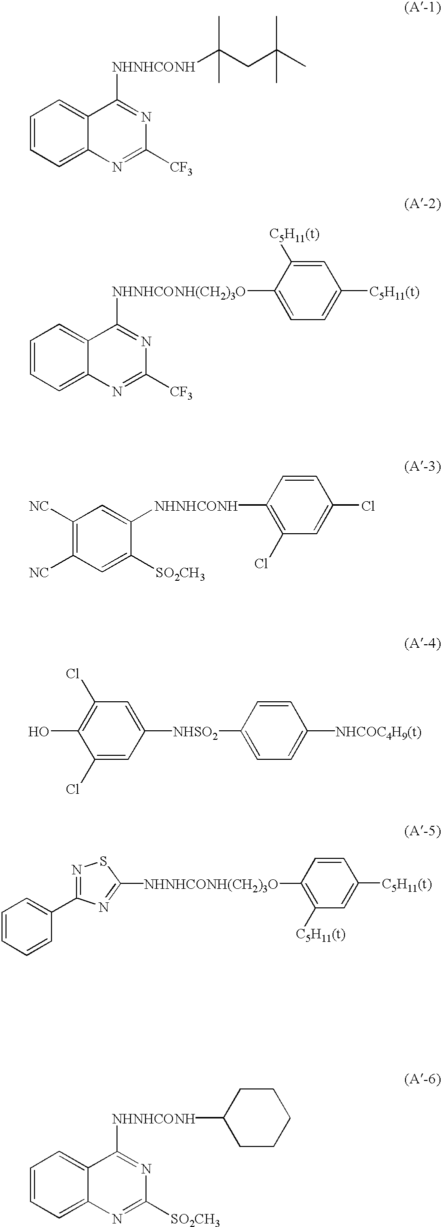

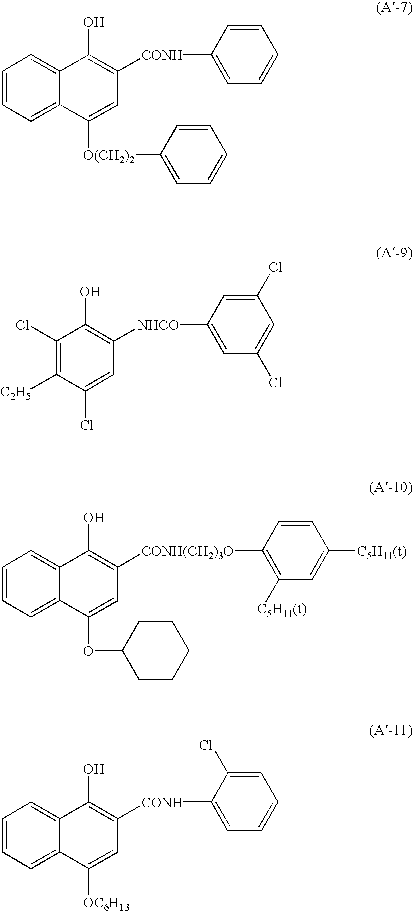

<Hydrogen Bonding Type Compound>

In case where the reducing agent in the forty-fourth embodiment of the invention has an aromatic hydroxyl group (—OH), especially when it is any of the above-mentioned bisphenols, the reducing agent is preferably combined with a non-reducing compound that has a group capable of forming a hydrogen bond with the group in the reducing agent. (The non-reducing compound is hereinafter referred to as “Hydrogen bonding type compound”)

For the details of the Hydrogen bonding type compound and the preferred examples of the Hydrogen bonding type compound for use in this embodiment, referred to are those described in the section of the first embodiment of the invention.

<Antifoggant and Others>

For antifoggants, stabilizers and stabilizer precursors employable in the forty-fourth embodiment of the invention, referred to are the compounds in JP-A 10-62899, paragraph [0070]; EP Laid-Open 0803764A1, from page 20, line 57 to page 21, line 7; JP-A 9-281637, 9-329864, and also referred to are the compounds in U.S. Pat. Nos. 6,083,681, 6,083,681, and EP 1048975.

Antifoggants preferred for use in this embodiment are organic halogen compounds. These are described, for example, in JP-A 11-65021, paragraphs [0111] to [0112]. Especially preferred are organic halogen compounds of formula (P) in JP-A 2000-284399; organic polyhalogen compounds of formula (II) in JP-A 10-339934; and organic polyhalogen compounds in JP-A 2001-31644 and 2001-33911.

Organic polyhalogen compounds preferred for use in the forty-fourth embodiment of the invention are described concretely.

Preferably, the organic polyhalogen compounds for use in this embodiment are represented by the following general formula (H):

Q—(Y)n—C(Z₁)(Z₂)X Gneral Formula (H)

wherein Q represents an alkyl, aryl or heterocyclic group; Y represents a divalent linking group; n indicates 0 or 1; Z₁ and Z₂ each represent a halogen atom; and X represents a hydrogen atom or an electron-attracting group.

In formula (H), Q is preferably a phenyl group substituted with an electron-attracting group having a positive Hammett's substituent constant σₚ. For the Hammett's substituent constant, referred to is, for example, Journal of Medicinal Chemistry, 1973, Vol. 16, No. 11, 1207-1216.

Examples of the electron-attracting group of the type are a halogen atom (fluorine atom with σₚ of 0.06, chlorine atom with σₚ of 0.23, bromine atom with σₚ of 0.23, iodine atom with σₚ of 0.18), a trihalomethyl group (tribromomethyl with σₚ of 0.29, trichloromethyl with σₚ of 0.33, trifluoromethyl with σₚ of 0.54), a cyano group (with σₚ of 0.66), a nitro group (with σₚ of 0.78), an aliphatic, aryl or heterocyclic sulfonyl group (e.g., methanesulfonyl with σₚ of 0.72), an aliphatic, aryl or heterocyclic acyl group (e.g., acetyl with σₚ of 0.50, benzoyl with σₚ of 0.43), an alkynyl group (e.g., C≡CH with σₚ of 0.23), an aliphatic, aryl or heterocyclic oxycarbonyl group (e.g., methoxycarbonyl with σₚ of 0.45, phenoxycarbonyl with σₚ of 0.44), a carbamoyl group (with σₚ of 0.36), a sulfamoyl group (with σₚ of 0.57), a sulfoxide group, a heterocyclic group, and a phosphoryl group. The σₚ value of the electron-attracting group preferably falls between 0.2 and 2.0, more preferably between 0.4 and 1.0.

Of the preferred examples of the electron-attracting group mentioned above, more preferred are a carbamoyl group, an alkoxycarbonyl group, an alkylsulfonyl group and an alkylphosphoryl group, and most preferred is a carbamoyl group.

In formula (H), X is preferably an electron-attracting group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group. Even more preferably, it is a halogen atom.

For the halogen atom for X, preferred are chlorine, bromine and iodine atoms, more preferred are chlorine and bromine atoms, and even more preferred is a bromine atom.

In formula (H), Y is preferably —C(═O)—, —SO— or —SO₂—, more preferably —C(═O)— or —SO₂—, even more preferably —SO₂—. n is 0 or 1, but preferably 1.

Specific examples of the compounds of formula (H) for use in the forty-fourth embodiment of the invention are mentioned below (H-1 to H-24), to which, however, the invention of this embodiment is not limited.

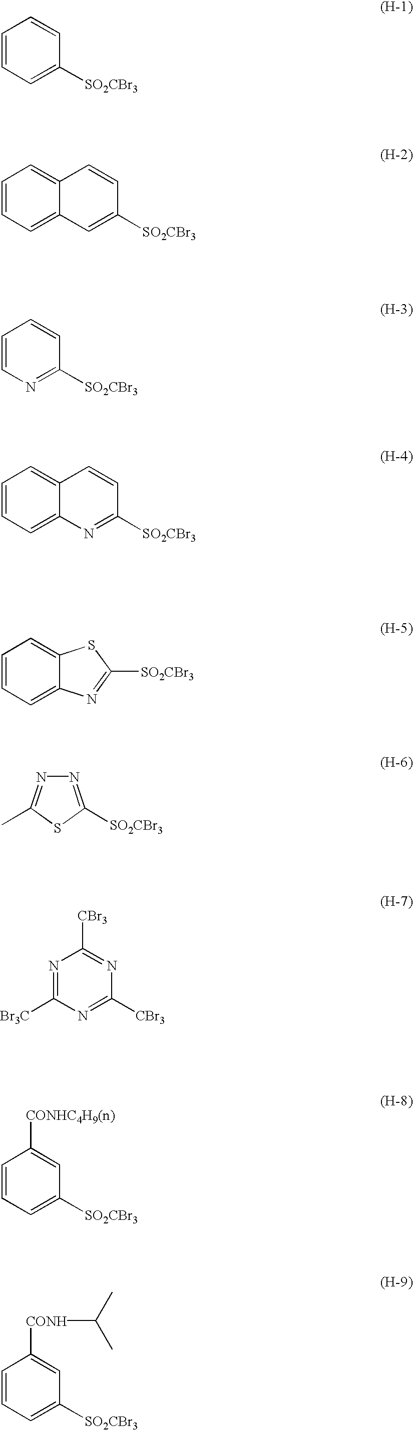

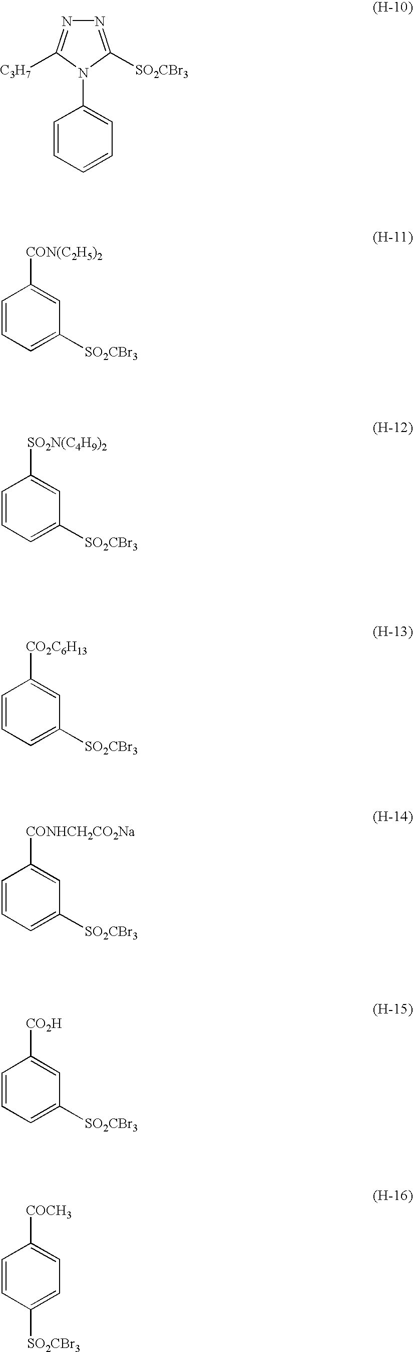

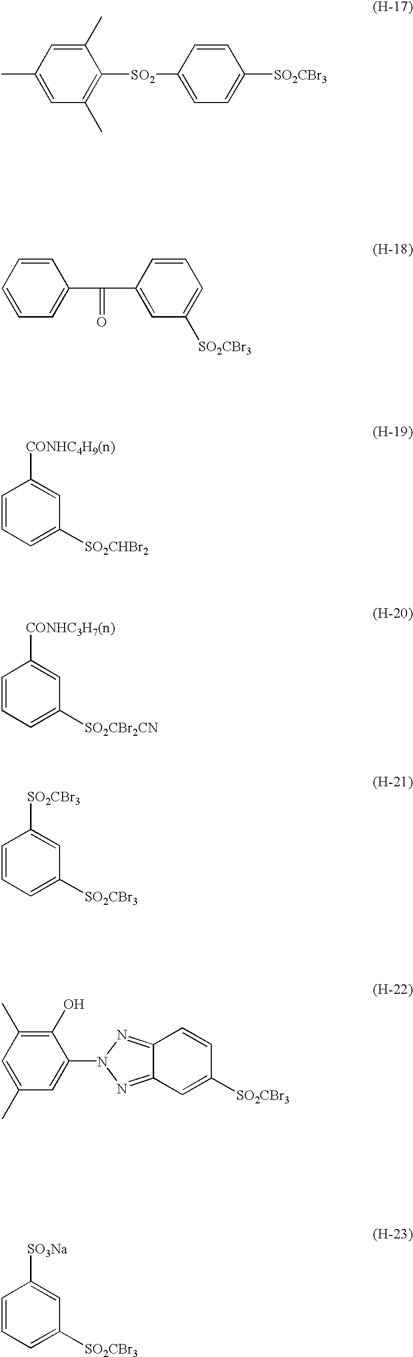

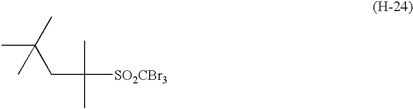

Preferably, the amount of the compound of formula (H) to be in the photothermographic material of the forty-fourth embodiment of the invention falls between 10⁻⁴ and 0.5 mols, more preferably between 10⁻³ and 0.1 mols, even more preferably between 5×10⁻³ and 0.05 mols per mol of the non-photosensitive silver salt in the image-forming layer of the material.

The antifoggant may be incorporated into the photothermographic material of the forty-fourth embodiment of the invention in the same manner as that mentioned hereinabove for incorporating the reducing agent thereinto. Preferably, the organic polyhalogen compound is in the form of a fine solid particle dispersion when it is incorporated into the material.

Preferably, the compounds of formula (H) have a melting point not higher than 200° C., more preferably not higher than 170° C.

<Other Antifoggants>

Other antifoggants usable herein are mercury(II) salts as in JP-A 11-65021, paragraph [0113]; benzoic acids as in JP-A 11-65021, paragraph [0114]; salicylic acid derivatives as in JP-A 2000-206642; formalin scavenger compounds of formula (S) in JP-A 2000-221634; triazine compounds claimed in claim 9 in JP-A 11-352624; compounds of formula (III) in JP-A 6-11791; and 4-hydroxy-6-methyl-1,3,3a,7-tetrazaindene.

The photothermographic material of the forty-fourth embodiment of the invention may also contain an azolium salt serving as an antifoggant. The azolium salt includes, for example, compounds of formula (XI) in JP-A 59-193447, compounds as in JP-B 55-12581, and compounds of formula (II) in JP-A 60-153039. The azolium salt may be present in any site of the photothermographic material, but is preferably in a layer adjacent to the photosensitive layer in the material. More preferably, it is added to the organic silver salt-containing layer of the material. Regarding the time at which the azolium salt is added to the material, it may be added to the coating liquid at any stage of preparing the liquid. In case where it is to be present in the organic silver salt-containing layer, the azolium salt may be added to any of the reaction system to prepare the organic silver salt or the reaction system to prepare the coating liquid at any stage of preparing it. Preferably, however, it is added to the coating liquid after the stage of preparing the organic silver salt and just before the stage of coating the liquid. The azolium salt to be added may be in any form of powder, solution or fine particle dispersion. It may be added along with other additives such as sensitizing dye, reducing agent and toning agent, for example, in the form of their solution. The amount of the azolium salt to be added to the photothermographic material of the forty-fourth embodiment of the invention is not specifically defined, but preferably falls between 1×10⁻⁶ mols and 2 mols, more preferably between 1×10⁻³ mols and 0.5 mols per mol of silver in the material.

<Other Additives>

<Mercapto, Disulfide and Thione Compounds>>

The photothermographic material of the forty-fourth embodiment of the invention may optionally contain any of mercapto compounds, disulfide compounds and thione compounds which are for retarding, promoting or controlling the developability of the material, or for enhancing the spectral sensitivity thereof, or for improving the storage stability thereof before and after development. For the additive compounds, for example, referred to are JP-A 10-62899, paragraphs [0067] to [0069]; compounds of formula (I) in JP-A 10-186572, and their examples in paragraphs [0033] to [0052]; and EP Laid-Open 0803764A1, page 20, lines 36 to 56. Above all, preferred are mercapto-substituted heteroaromatic compounds such as those in JP-A 9-297367, 9-304875, 2001-100358.

<<Toning Agent>>

Adding a toning agent to the photothermographic material of the forty-fourth embodiment of the invention is preferred. Examples of the toning agent usable herein are described in JP-A 10-62899, paragraphs [0054] to [0055]; EP Laid-Open 0803764A1, page 21, lines 23 to 48; JP-A 2000-356317; and Japanese Patent Application No. 2000-187298. Especially preferred for use herein are phthalazinones (phthalazinone, phthalazinone derivatives and their metal salts, e.g., 4-(1-naphthyl)phthalazinone, 6-chlorophthalazinone, 5,7-dimethoxyphthalazinone, 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives and their salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); combinations of phthalazines and phthalic acids. More preferred are combinations of phthalazines and phthalic acids. Above all, especially preferred are a combination of 6-isopropylphthalazine and phthalic acid or 4-methylphthalic acid.

<<Plasticizer, Lubricant>>

Plasticizers and lubricants that may be in the photosensitive layer of the photothermographic material of the forty-fourth embodiment of the invention are described in, for example, JP-A 11-65021, paragraph [0117]. Lubricants that may be in the layer are described in JP-A 11-84573, paragraphs [0061] to [0064], and JP-A 11-106881, paragraphs [0049]to [0062].

<<Dye, Pigment>>

The photosensitive layer in the forty-fourth embodiment of the invention may contain various types of dyes and pigments (e.g., C.I. Pigment Blue 60, C.I. Pigment Blue 64, C.I. Pigment Blue 15:6) for improving the image tone, for preventing interference fringes during laser exposure, and for preventing irradiation. The details of such dyes and pigments are described in, for example, WO98/36322, and JP-A 10-268465 and 11-338098.

<<Super-hardener>>

For forming super-hard images, a super-hardener may be added to the image-forming layer of the photothermographic material of this embodiment. For such super-hardeners, methods of using them, and their amounts applicable to the invention of this embodiment, for example, referred to are JP-A 11-65021, paragraph [0118]; JP-A 11-223898, paragraphs [0136] to [0193]; compounds of formula (H), those of formulae (1) to (3) and those of formulae (A) and (B) in JP-A 2000-284399; compounds of formulae (III) to (V) in Japanese Patent Application No. 11-91652, especially concrete compounds in [Formula 21] to [Formula 24] therein. For hardening promoters also applicable to the invention of this embodiment, referred to are JP-A 11-65021, paragraph [0102]; and JP-A 11-223898, paragraphs [0194] to [0195].

In case where formic acid or its salt is used for a strong foggant in the invention of this embodiment, it may be added to the photosensitive silver halide-containing, image-forming layer of the material, and its amount is preferably at most 5 mmols, more preferably at most 1 mmol per mol of silver in the layer.

In case where a super-hardener is used in the photothermographic material of the forty-fourth embodiment of the invention, it is preferably combined with an acid formed through hydration of diphosphorus pentoxide or its salt. The acid to be formed through hydration of diphosphorus pentoxide and its salts include, for example, metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts). For the acid to be formed through hydration of diphosphorus pentoxide and its salts, preferred for use herein are orthophosphoric acid (and its salts), and hexametaphosphoric acid (and its salts). Concretely, their salts are sodium orthophosphate, sodium dihydrogen-orthophosphate, sodium hexametaphosphate, and ammonium hexametaphosphate.

The amount of the acid to be formed through hydration of diphosphorus pentoxide or its salt to be used herein (that is, the amount thereof to be in the unit area, one m², of the photothermographic material) may be any desired one and may be defined in any desired manner depending on the sensitivity, the fogging resistance and other properties of the material. Preferably, however, it falls between 0.1 and 500 mg/m², more preferably between 0.5 and 100 mg/m².

<Preparation of Coating Liquid>

In the forty-fourth embodiment of the invention, the coating liquid for the image-forming layer is prepared preferably at a temperature falling between 30° C. and 65° C., more preferably between 35° C. and lower than 60° C., even more preferably between 35° C. and 55° C. Also preferably, the coating liquid for the image-forming layer is kept at a temperature falling between 30° C. and 65° C. just after addition of polymer latex thereto.

<Layer Constitution>

One or more image-forming layers are formed on one support to produce the photothermographic material of the forty-fourth embodiment of the invention. In case where the material has one image-forming layer, the layer contains an organic silver salt, a photosensitive silver halide, a reducing agent and a binder, and may contain optional additives such as a toning agent, a coating aid and other auxiliary agents. In case where the material has two or more image-forming layers, the first image-forming layer (in general, this is directly adjacent to the support) must contain an organic silver salt and a photosensitive silver halide, and the second image-forming layer or the two layers must contain the other ingredients. The photothermographic material for multi-color expression of the invention of this embodiment may have combinations of these two layers for the respective colors, or may contain all the necessary ingredients in a single layer, for example, as in U.S. Pat. No. 4,708,928. For the photothermographic material of a type containing multiple dyes for multi-color expression, the individual emulsion layers are differentiated and spaced from the others via a functional or non-functional barrier layer between the adjacent emulsion layers, for example, as in U.S. Pat. No. 4,460,681.

In general, the photothermographic material has non-photosensitive layers in addition to photosensitive layers. Depending on their positions, the non-photosensitive layers are classified into (1) a protective layer to be disposed on a photosensitive layer (remoter from the support than the photosensitive layer); (2) an interlayer to be disposed between adjacent photosensitive layers or between a photosensitive layer and a protective layer; (3) an undercoat layer to be disposed between a photosensitive layer and a support; (4) a back layer to be disposed on a support opposite to a photosensitive layer. The layers (1) and (2) are filter layers that are in the photothermographic material. The layers (3) and (4) are antihalation layers in the material.

Preferably, the photothermographic material of forty-fourth embodiment of the invention has, on one surface of its support, at least one photosensitive layer that contains a photosensitive silver halide emulsion, and has a back layer on the other surface thereof. This is referred to as a single-sided photothermographic material.

Also preferably, the photothermographic material of this embodiment is of a monosheet type. The monosheet type does not require any additional sheet to receive images thereon, but may directly form images on itself.

<<Surface Protective Layer>>

The photothermographic material of the forty-fourth embodiment of the invention may have a surface protective layer for preventing the image-forming layer from being blocked. The surface protective layer may have a single-layered or multi-layered structure. The details of the surface protective layer are described, for example, in JP-A 11-65021, paragraphs [0119] to [0120], and in Japanese Patent Application No. 2000-171936.

Gelatin is preferred for the binder in the surface protective layer in the forty-fourth embodiment of the invention, but for it, polyvinyl alcohol (PVA) is also usable alone or combined with gelatin. Gelatin for use herein may be inert gelatin (e.g., Nitta Gelatin 750), or gelatin phthalide (e.g., Nitta Gelatin 801). Examples of PVA usable herein are described in, for example, JP-A 2000-171936, paragraphs [0009] to [0020]. Preferred example of PVA for use herein are completely saponified PVA-105; partially saponified PVA-205, PVA-355; and modified polyvinyl alcohol, MP-203 (all commercial products of Kuraray). The polyvinyl alcohol content (per m² of the support) of one protective layer preferably falls between 0.3 and 4.0 g/m², more preferably between 0.3 and 2.0 g/m².

<<Antihalation Layer>>

Preferably, the photothermographic material of the forty-fourth embodiment of the invention has an antihalation layer remoter from the light source to which it is exposed than its photosensitive layer.

The details of the antihalation layer are described in, for example, JP-A 11-65021, paragraphs [0123] to [0124]; JP-A 11-223898, 9-230531, 10-36695, 10-104779, 11-231457, 11-352625, 11-352626.

The antihalation layer contains an antihalation dye capable of absorbing the light to which the photothermographic material is exposed. In this embodiment, the photothermographic material is exposed to laser rays having a peak wavelength range of from 350 nm to 440 nm. Therefore, it is desirable that the antihalation dye to be in the antihalation layer of the material may absorb the light falling within that wavelength range.

In case where visible light-absorbing dyes are used for antihalation in this embodiment, it is desirable that the dyes used are substantially decolored after image formation on the material, for which, for example, usable are decoloring agents that have the ability to decolor the dyes when heated in the step of thermal development. Preferably, a thermal decoloring dye and a base precursor are added to the non-photosensitive layers so that the layers containing them may function as antihalation layers. The details of this technique are described in, for example, JP-A 11-231457.

The amount of the decoloring dye to be added shall be determined, depending on the use of the dye. In general, its amount is so determined that the dye added could ensure an optical density (absorbance), measured at an intended wavelength, of larger than 1.0. The optical density preferably falls between 0.15 and 2, more preferably between 0.2 and 1. The amount of the dye capable of ensuring the optical density falling within the range may be generally from 0.001 to 1 g/m² or so.

Decoloring the dyes in the photothermographic material in that manner can lower the optical density of the material to 0.1 or less after thermal development. Two or more different types of decoloring dyes may be in the thermodecoloring recording material or the photothermographic material. Similarly, two or more different types of base precursors may be in the material.

In the thermodecoloring material of the type that contains a decoloring dye and a base precursor, it is desirable in view of the thermodecoloring ability of the material that the base precursor therein is combined with a substance which, when mixed with the base precursor, can lower the melting point of the mixture by at most 3° C. (e.g., diphenyl sulfone, 4-chlorophenyl(phenyl) sulfone, 2-naphtyl benzoate), for example, as in JP-A 11-352626.

<<Back Layer>>

For the details of the back layer applicable to the forty-fourth embodiment of the invention, referred to is JP-A 11-65021, paragraphs [0128] to [0130].

In the forty-fourth embodiment of the invention, a coloring agent that has an absorption maximum in the range falling between 300 and 450 nm may be added to the photothermographic material for improving the silver tone and the image stability of the material. The coloring agent is described in, for example, JP-A 62-210458, 63-104046, 63-103235, 63-208846, 63-306436, 63-314535, 01-61745, 2001-100363.

In general, the amount of the coloring agent to be added to the material falls between 0.1 mg/m² and 1 g/m². Preferably, it is added to the back layer that is opposite to the photosensitive layer of the material.

<<Matting Agent>>

Preferably, the photothermographic material of the forty-fourth embodiment of the invention contains a matting agent which is for improving the transferability of the material. Matting agents are described in JP-A 11-65021, paragraphs [0126] to [0127]. The amount of the matting agent to be added to the photothermographic material preferably falls between 1 and 400 mg/m², more preferably between 5 and 300 mg/m² of the material.

Regarding its morphology, the matting agent to be used in the forty-fourth embodiment of the invention may be shaped or amorphous, but is preferably shaped. More preferably, it is spherical. The mean grain size of the spherical matting agent preferably falls between 0.5 and 10 μm, more preferably between 1.0 and 8.0 μm, even more preferably between 2.0 and 6.0 μm. The size distribution fluctuation coefficient thereof is preferably at most 50%, more preferably at most 40%, even more preferably at most 30%. The fluctuation coefficient is represented by (grain size standard deviation)/(mean grain size)×100. Combining two different types of matting agents both having a small size distribution fluctuation coefficient is preferred for use in this embodiment. Concretely, the ratio of the mean grain size of the two matting agents combined is larger than 3.

The degree to which the emulsion surface of the photothermographic material of this embodiment is matted is not specifically defined, so far as the matted layer surface is free from star dust trouble, but is preferably such that the Beck's smoothness of the matted surface could fall between 30 seconds and 2000 seconds, more preferably between 40 seconds and 1500 seconds. The Beck's smoothness is readily obtained according to JIS P8119 (method of testing surface smoothness of paper and paper boards with Beck tester), and to TAPPI Standard T479.

Regarding the matting degree of the back layer of the photothermographic material of the forty-fourth embodiment of the invention, the Beck's smoothness of the matted back layer preferably falls between 10 seconds and 1200 seconds, more preferably between 20 seconds and 800 seconds, even more preferably between 40 seconds and 500 seconds.

Preferably, the photothermographic material of the forty-fourth embodiment of the invention contains such a matting agent in the outermost surface layer, or in a layer functioning as an outermost surface layer, or in a layer nearer to the outermost surface. Also preferably, it may contain a matting agent in a layer functioning as a protective layer.

<<Polymer Latex>>

In case where the photothermographic material of the forty-fourth embodiment of the invention is used in the field of printing that require high-level dimensional stability, it is desirable to use a polymer latex in the surface protective layer or the back layer of the material. The polymer latex for that purpose is described in, for example, Synthetic Resin Emulsions (by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); and Chemistry of Synthetic Latexes (by Sohichi Muroi, the Polymer Publishing Association of Japan, 1970). Concretely, it includes, for example, methyl methacrylate (33.5 wt. %)/ethyl acrylate (50 wt. %)/methacrylic acid (16.5 wt. %) copolymer latex; methyl methacrylate (47.5 wt. %)/butadiene (47.5 wt. %)/itaconic acid (5 wt. %) copolymer latex; ethyl acrylate/methacrylic acid copolymer latex; methyl methacrylate (58.9 wt. %)/2-ethylhexyl acrylate (25.4 wt. %)/styrene (8.6 wt. %)/2-hydroxyethyl methacrylate (5.1 wt. %)/acrylic acid (2.0 wt. %) copolymer latex; and methyl methacrylate (64.0 wt. %)/styrene (9.0 wt. %)/butyl acrylate (20.0 wt. %)/2-hydroxyethyl methacrylate (5.0 wt. %)/acrylic acid (2.0 wt. %) copolymer latex. To the binder for the surface protective layer in this embodiment, for example, applicable are the polymer latex combinations as in Japanese Patent Application No. 11-6872; the techniques as in Japanese Patent Application No. 11-143058, paragraphs [0021] to [0025]; the techniques as in Japanese Patent Application No. 11-6872, paragraphs [0027] to [0028]; and the techniques as in Japanese Patent Application No. 10-199626, paragraphs [0023] to [0041]. The ratio of the polymer latex in the surface protective layer preferably falls between 10% by weight and 90% by weight, more preferably between 20% by weight and 80% by weight of all the binder in the layer.

The overall binder content (including water-soluble polymer and latex polymer, per m² of the support) of one surface protective layer preferably falls between 0.3 and 5.0 g/m², more preferably between 0.3 and 2.0 g/m².

<<pH of Film Surface>>

Preferably, the surface of the photothermographic material of the forty-fourth embodiment of the invention has a pH of at most 7.0, more preferably at most 6.6, before developed under heat. The lowermost limit of the pH is not specifically defined, but may be at least 3 or so. Most preferably, the pH range falls between 4 and 6.2. For controlling the surface pH of the photothermographic material, employable are nonvolatile acids, for example, organic acids such as phthalic acid derivatives, or sulfuric acid, or volatile bases such as ammonia. These are preferred as effective for reducing the surface pH of the material. Especially preferred for the surface pH-lowering agent is ammonia, as it is highly volatile, and therefore can be readily removed while the coating liquids containing it are coated and surely before thermal development.

Also preferred is combining ammonia with a nonvolatile base such as sodium hydroxide, potassium hydroxide or lithium hydroxide. For measuring the surface pH of the photothermographic material, referred to is the description in Japanese Patent Application No. 11-87297, paragraph [0123].

<<Hardening Agent>>

A hardening agent may be added to the photosensitive layer, the protective layer, the back layer and other layers constituting the photothermographic material of the forty-fourth embodiment of the invention. The details of the hardening agent applicable to the invention of this embodiment are described in T. H. James' The Theory of the Photographic Process, 4th Ed. (Macmillan Publishing Co., Inc., 1977), pp. 77-87. For example, preferred for use herein are chromium alum, 2,4-dichloro-6-hydroxy-s-triazine sodium salt, N,N-ethylenebis(vinylsulfonacetamide), N,N-propylenebis(vinylsulfonacetamide); as well as polyvalent metal ions described on page 78 of that reference; polyisocyanates described in U.S. Pat. No. 4,281,060 and JP-A 6-208193; epoxy compounds described in U.S. Pat. No. 4,791,042; and vinylsulfone compounds described in JP-A 62-89048.

The hardening agent is added to the coating liquids in the form of its solution. The time at which the solution is added to the coating liquid for the protective layer may fall between 180 minutes before coating the liquid and a time just before the coating, preferably between 60 minutes before the coating and 10 seconds before it. However, there is no specific limitation thereon, so far as the method and the condition employed for adding the hardening agent to the coating liquid ensure the advantages of the forty-fourth embodiment of the invention. Concretely for adding it, employable is a method of mixing a hardening agent with a coating liquid in a tank in such a controlled manner that the mean residence time for the agent as calculated from the amount of the agent added and the flow rate of the coating liquid to a coater could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<<Surfactants>>

Surfactants applicable to the photothermographic material of the forty-fourth embodiment of the invention are described in JP-A 11-65021, paragraph [0132].

In the forty-fourth embodiment of the invention, preferably used are fluorine-containing surfactants. Examples of fluorine-containing surfactants are given, for example, in JP-A 10-197985, 2000-19680 and 2000-214554. Also preferred for use herein are fluorine-containing polymer surfactants such as those in JP-A 9-281636. In the forty-fourth embodiment of the invention, especially preferred are fluorine-containing surfactants described in Japanese Patent Application No. 2000-206560.

<<Antistatic Layer or Electroconductive Layer>>

The photothermographic material of the forty-fourth embodiment of the invention may have an antistatic layer or an electroconductive layer. Examples of the layer are described, for example, in JP-A 11-65021, paragraph [0135].

Preferably, the electroconductive layer contains a metal oxide. For the electroconductive material for the electroconductive layer, preferred are metal oxides which are specifically so processed that they have oxygen defects and/or different metal atoms introduced thereinto to increase their electroconductivity. Preferred examples of the metal oxides are ZnO, TiO₂ and SnO₂. To ZnO, preferably added is any of Al or In; to SnO₂, any of Sb, Nb, P or halogen elements; and TiO₂, any of Nb or Ta. Especially preferred is SnO₂ with Sb added thereto. Preferably, the amount of the different atom to be added to the metal oxide falls between 0.01 and 30 mol %, more preferably between 0.1 and 10 mol %. Regarding their morphology, the metal oxides may be spherical, acicular or tabular, but they are preferably acicular grains having a ratio of major axis/minor axis of at least 2.0, more preferably from 3.0 to 50 as their electroconductivity is high. The amount of the metal oxide to be in the layer preferably falls between 1 mg/m² and 1000 mg/m², more preferably between 10 mg/m² and 500 mg/m², even more preferably between 20 mg/m² and 200 mg/m². In the forty-fourth embodiment of the invention, the electroconductive layer may be formed on any side of emulsion-coated face or back face, but is preferably formed between the support and the back layer. Specific examples of the electroconductive layer applicable to the forty-fourth embodiment of the invention are described in, for example, JP-A 7-295146 and 11-223901.

<<Other Additives>>

The photothermographic material may optionally contain an antioxidant, a stabilizer, a plasticizer, a UV absorbent or a coating aid. If desired, a solvent may be added to the material, for example, as in JP-A 11-65021, paragraph [0133]. Such additives may be in any of the photosensitive layers or the non-photosensitive layers of the material. For the additives, for example, referred to are W098/36322, EP 803764A1, JP-A 10-186567 and 10-18568.

For the mode of forming color images on the material, for example, referred to is the description in JP-A 11-65021, paragraph [0136].

<<Support>>

For the transparent supports for the photothermographic material of this embodiment, preferred are biaxially-stretched films of polyesters, especially polyethylene terephthalate heated at a temperature falling between 130 and 185° C. The heat treatment is for removing the internal strain that may remain in the biaxially-stretched films and for preventing the film supports from being thermally shrunk during thermal development of the material.

In case where the photothermographic material is for medical treatment, the transparent support for it may be colored with a blue dye (for example, with Dye-1 used in the examples in JP-A 8-240877), or may not be colored. Examples of the support for use herein are described, for example, in JP-A 11-65021, paragraph [0134].

Preferably, the support of the photothermographic material of this embodiment is undercoated, for example, with a water-soluble polyester as in JP-A 11-84574; a styrene-butadiene copolymer as in JP-A 10-186565; or a vinylidene chloride copolymer as in JP-A 2000-39684 or in Japanese Patent Application No. 11-106881, paragraphs [0063] to [0080]. For the antistatic layer and the undercoat layer to be formed in the photothermographic material of this embodiment, for example, referred to are the techniques disclosed in JP-A 56-143430, 56-143431, 58-62646, 56-120519, 11-84573, paragraphs [0040] to [0051]; U.S. Pat. No. 5,575,957; and JP-A 11-223898, paragraphs [0078] to [0084].

<Fabrication of Photothermographic Material>

To fabricate the photothermographic material of the forty-fourth embodiment of the invention, the coating liquids may be applied onto a support in any desired manner. Concretely, various types of coating techniques are employable herein, including, for example, extrusion coating, slide coating, curtain coating, dipping, knife coating, and flow coating. Various types of hoppers for extrusion coating employable herein are described in U.S Pat. No. 2,681,294. Preferred for the photothermographic material is extrusion coating or slide coating described in Stephen F. Kistler & Petert M. Schweizer's Liquid Film Coating (Chapman & Hall, 1997), pp. 399-536. More preferred is slide coating. One example of the shape of a slide coater for slide coating is in FIG. 11b-1, on page 427 of that reference. If desired, two or more layers may be formed at the same time, for example, according to the methods described from page 399 to page 536 of that reference, or to the methods described in U.S Pat. No. 2,761,791 and BP 837,095.

Preferably, the coating liquid for the organic silver salt-containing layer in the forty-fourth embodiment of the invention is a thixotropic flow. For it, referred to is the technique described in JP-A 11-52509. Preferably, the coating liquid for the organic silver salt-containing layer in the forty-fourth embodiment of the invention has a viscosity falling between 400 mPa·s and 100,000 mPa·s, more preferably between 500 mPa·s and 20,000 mPa·s, at a shear rate of 0.1 sec⁻¹. Also preferably, the viscosity falls between 1 mPa·s and 200 mPa·s, more preferably between 5 mPa·s and 80 mPa·s, at a shear rate of 1000 sec⁻¹.

<Packaging Material for Photothermographic Material>

Preferably, the photothermographic material of the forty-fourth embodiment of the invention is wrapped with a material of low oxygen and/or moisture permeability for preventing its photographic properties from varying and for preventing it from curling or from having a curled habit while stored as raw films. Preferably, the oxygen permeability at 25° C. of the packaging material for use herein is at most 50 ml/atm·m²·day, more preferably at most 10 ml/atm·m²·day, even more preferably at most 1.0 ml/atm·m²·day. Also preferably, the moisture permeability thereof is at most 10 g/atm·m²·day, more preferably at most 5 g/atm.m² day, even more preferably at most 1 g/atm·m²·day. Preferred examples of the packaging material of low oxygen and/or moisture permeability for use herein are described, for example, in JP-A 8-254793, 2000-206653.

<Other Techniques Applicable to This Embodiment>

Other techniques applicable to the photothermographic material of the forty-fourth embodiment of the invention are, for example, in EP 803764A1, EP 883022A1, WO98/36322; JP-A 56-62648, 58-62644) 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420; and Japanese Patent Application Nos. 2000-187298, 2000-10229, 2000-47345, 2000-206642, 2000-98530, 2000-98531, 2000-112059, 2000-112060, 2000-112104, 2000-112064, 2000-171936.

<Exposure and Thermal Development>

The photothermographic material of the forty-fourth embodiment of the invention has, on a support, at least a photosensitive silver halide, a non-photosensitive organic silver salt, a reducing agent and a binder, in which the mean silver iodide content of the photosensitive silver halide falls between 5 mol % and 100 mol %, the non-photosensitive organic silver salt is prepared from an organic acid that contains at least behenic acid and erucic acid, and the erucic acid content of the non-photosensitive organic silver salt falls between 1×10⁻⁶ mol % and 10 ml % relative to the number of mols of all the organic acid. For forming images thereon, it is desirable that the photothermographic material is exposed to light having a peak strength at a wavelength of from 350 nm to 440 nm and having an intensity of at least 1 mW/mm², and then thermally developed.

Thus exposed to such high-intensity light of at least 1 mW/mm² for a short period of time, the photothermographic material of the forty-fourth embodiment of the invention exhibits its good properties. The “light intensity” referred to herein is meant to indicate the quantity of light to which the photothermographic material is exposed to have an optical density of 3.0 after thermal development. Such high-intensity exposure reduces the quantity of light (=light intensity x exposure time) necessary for obtaining the intended optical density, and enables to plan a high-sensitivity photothermographic system.

More preferably, the quantity of light to which the photothermographic material of this embodiment is exposed falls between 2 mW/mm² and 50 mW/mm², even more preferably between 10 mW/mm² and 50 mW/mm².

The light source to which the photothermographic material of this embodiment is exposed may be any and every one that satisfies the requirements as above, for which, however, preferred are laser rays.

For the laser rays to which the photothermographic material of the forty-fourth embodiment of the invention is exposed, preferred are gas lasers (Ar⁺, Kr), YAG lasers, color lasers, or semiconductor lasers. Also employable is a combination of semiconductor lasers and secondary harmonics generators. More are semiconductor lasers for blue to violet emission. One example of high-power semiconductor lasers for blue to violet emission that are employable herein is a Nichia Chemical's semiconductor laser, NLHV300E.

Preferably, the photothermographic material of the forty-fourth embodiment of the invention is exposed to semiconductor lasers capable of emitting light having a peak intensity in a wavelength range of from 380 nm to 410 nm.

The photothermographic material of the forty-fourth embodiment of the invention may be developed in any manner. In general, after having been imagewise exposed, it is developed under heat. Preferably, the temperature for the thermal development falls between 80 and 250° C., more preferably between 100 and 140° C., even more preferably between 110 and 130° C. The time for the development preferably falls between 1 and 60 seconds, more preferably between 3 and 30 seconds, even more preferably between 5 and 25 seconds, still more preferably between 7 and 15 seconds.

For thermal development for the photothermographic material, employable is any of a drum heater system or a plate heater system, but preferred is a plate heater system. For the plate heater system for the material, preferred is the method described in JP-A 11-133572. The plate heater system described therein is for thermal development of photothermographic materials, in which a photothermographic material having been exposed to have a latent image thereon is brought into contact with a heating unit in the zone for thermal development to thereby convert the latent image into a visible image. In this, the heating unit comprises a plate heater, and multiple presser rolls are disposed in series on one surface of the plate heater. The exposed photothermographic material is passed between the multiple pressure rolls and the plate heater, whereby it is developed under heat. The plate heater is sectioned into 2 to 6 stages, and it is desirable that the temperature of the top stage is kept lower by 1 to 10° C. or so than that of the others. For example, four pairs of plate heaters of which the temperature is independently controllable may be used, and they are set at 112° C., 119° C., 121° C. and 120° C. The system of the type is described in JP-A 54-30032. In the plate heater system, water and organic solvent that remain in the photothermographic material being processed can be removed out of the material. In this, in addition, the support of the photothermographic material rapidly heated is prevented from being deformed.

The image gradation of the photothermographic material of the forty-fourth embodiment of the invention is not specifically defined, but is preferably such that the mean contrast of the images formed on the material to have a density of from 1.5 to 3.0 falls between 1.5 and 10, in order that the material produces better results of this embodiment.

The mean image contrast referred to herein is represented by the degree of inclination of the line drawn to connect the optical density 1.5 and the optical density 3.0 on the characteristic curve in a graph that indicates the image characteristic of the processed photothermographic material. In the graph, the horizontal axis indicates the logarithmic number of the amount of laser to which the material is exposed for image formation, and the horizontal axis indicates the optical density of the image formed on the laser-exposed and thermally-developed material.

Preferably, the mean image contrast falls between 1.5 and 10 for sharp letters and images, more preferably between 2.0 and 7, even more preferably between 2.5 and 6.

One example of laser imagers for medical treatment equipped with an exposure unit and a thermal development unit that are applicable to this embodiment of the invention is Fuji Medical Dry Laser Imager FM-DP L. The system FM-DP L is described in Fuji Medical Review No. 8, pp. 39-55. Needless-to-say, the technique disclosed therein is applicable to laser imagers for the photothermographic material of the forty-fourth embodiment of the invention. In addition, the photothermographic material of this embodiment can be processed in the laser imager in the AD Network which Fuji Medical System has proposed for a network system under DICOM Standards.

The photothermographic material of the forty-fourth embodiment of the invention forms a monochromatic image based on silver, and is favorable for use in medical diagnosis, industrial photography, printing, and COM.

Forty-Fifth Embodiment of Photothermographic Material

The forty-fifth embodiment of the photothermographic material of the invention is described in detail.

The forty-fifth embodiment of the present invention is a photothermographic material comprising a support having thereon at least one image-forming layer including at least one organic silver salt and at least one silver halide, and having thereon at least one non-image-recording protective layer on the far side of the support relative to the image-forming layer, which is exposed to laser rays; wherein the mean silver iodide content of the silver halide is 40 mol % to 100 mol %.

<Silver Halide>

The silver halide (hereinafter this may be referred to as “photosensitive silver halide”) to be in the image-forming layer of the photothermographic material of the forty-fifth embodiment of the invention is described.

<<Halogen Composition>>

Regarding the halogen composition thereof, the photosensitive silver halide for use in the photothermographic material of the forty-fifth embodiment of the invention is characterized in that it is a high silver iodide emulsion having an iodide content of from 40 mol % to 100 mol %, or that is, the mean silver iodide content of the silver halide falls between 40 mol % and 100 mol %.

Except silver iodide therein, the silver halide composition smaller than 60 mol % of the photosensitive silver halide is not specifically defined and may be selected from silver chloride and silver bromide, for which, however, preferred is silver bromide.

With such a high silver iodide emulsion therein, it is possible to design the intended photothermographic material of the forty-fifth embodiment of the invention of which the advantages are that the image storability after development is good, especially the image formed thereon is fogged little even left exposed to light.

Preferably, the mean silver iodide content of the silver halide to be in he photothermographic material falls between 70 mol % and 100 mol %, more preferably between 80 mol % and 100 mol %, even more preferably between 90 mol % and 100 mol % in view of the optical image storability of the processed material.

Regarding the halogen composition distribution in each silver halide grain, the composition may be uniform throughout the grain, or may stepwise vary, or may continuously vary.

Core/shell structured silver halide grains are preferred for use herein. Preferably, the core/shell structure of the grains has from 2 to 5 layers, more preferably from 2 to 4 layers.

Also preferred are core/shell structured silver halide grains in which the core is of a high silver iodide composition or the shell is of a high silver iodide composition. Especially preferred are those in which the silver iodide content of the shell is higher than that of the core, and even more preferred are those in which the silver iodide content of the shell falls between 80 mol % and 100 mol %.

A technique of localizing silver bromide in the surfaces of silver halide grains is also preferably employed herein.

<<Grain Size>>

The grain size of the silver halide to be in the high silver iodide emulsion for use in the invention preferably falls between 5 nm and 90 nm.

Too large silver halide grains are unfavorable to the invention since their amount necessary for attaining the intended maximum optical density shall increase. Especially in the invention, increasing the amount of the high silver halide emulsion to be in the photothermographic material detracts from the developability of the material and lowers the sensitivity thereof, and, in addition, it detracts from the image density stability relative to the time for developing the material. Therefore, in the invention, large silver halide grains having a grain size larger than a predetermined level could not give the intended maximum image density within a predetermined period of time for development.

On the other hand, even high silver iodide emulsions may ensure good developability and give images having the intended maximum optical density so far as the size of the silver halide grains therein is reduced to a satisfactory degree and the coating amount of the silver halide is defined within a predetermined range.

Accordingly in the invention, the grain size of the silver halide preferably falls between 5 nm and 70 nm, more preferably between 5 nm and 55 nm, even more preferably between 10 nm and 45 nm.

The grain size referred to herein is meant to indicate the diameter of the circular image having the same area as the projected area of each silver halide grain analyzed through electromicroscopy. The data of all the silver halide grains thus analyzed are averaged to obtain the mean grain size thereof.

Preferably, the coating amount of the silver halide grains in the photothermographic material of the invention falls between 0.5 mol % and 15 mol %, more preferably between 0.5 mol % and 12 mol %, even more preferably between 1 mol % and 9 mol %, still more preferably between 1 mol % and 7 mol % relative to the molar amount of silver in the organic silver salt in the material. The organic silver salt will be described hereinunder.

In the forty-fifth embodiment of the invention, it is a matter of great importance to specifically define the coating amount of the silver halide to be in the photothermographic material for evading the problem of development failure with the high silver iodide emulsion in the material.

<<Method of Forming Grains>>

Methods of forming the photosensitive silver halide are well known in the art, for example, as in Research Disclosure 17029 (June 1978), and U.S Pat. No. 3,700,458, and any known method is employable in the forty-fifth embodiment of the invention. Concretely, a silver source compound and a halogen source compound are added to gelatin or any other polymer solution to prepare a photosensitive silver halide, and it is then mixed with an organic silver salt. This method is preferred for the forty-fifth embodiment of the invention. Also preferred are the method described in JP-A 11-119374, paragraphs [0217] to [0244]; and the methods described in Japanese Patent Application Nos. 11-98708 and 2000-42336.

<<Grain Morphology>>

Silver halide grains generally have different types of morphology, including, for example, cubic grains, octahedral grains, tabular grains, spherical grains, rod-like grains, and potato-like grains, but the high silver iodide grains for use in the forty-fifth embodiment of the invention have some complicated morphology. For one preferred morphology of the grains for use in the forty-fifth embodiment of the invention, referred to are conjugate grains as in R. L. Jenkins et al's Journal of Photo. Sci., Vol. 28 (1980), page 164, FIG. 1. Also preferred are tabular grains as in FIG. 1 of that literature. Still preferred are corner-rounded silver halide grains.

The surface index (Miller index) of the outer surface of the photosensitive silver halide grains for use in the forty-fifth embodiment of the invention is not specifically defined, but is desirably such that the proportion of {100} plane, which ensures higher spectral sensitization when it has adsorbed a color-sensitizing dye, in the outer surface is larger. Preferably, the proportion of {100} plane in the outer surface is at least 50%, more preferably at least 65%, even more preferably at least 80%. The Miller index indicated by the proportion of {100} plane can be identified according to the method described by T. Tani in J. Imaging Sci., 29, 165 (1985), based on the adsorption dependency of sensitizing dye onto {111} plane and {100} plane.

<<Heavy Metal>>

Silver halide grains having a hexacyano-metal complex in their outermost surfaces are preferred for use in the forty-fifth embodiment of the invention. Preferred examples of the hexacyano-metal complex are [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻. Of those, more preferred are hexacyano-Fe complexes.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions.

The hexacyano-metal complex may be added to silver halide grains in the form of a solution thereof in water or in a mixed solvent of water and an organic solvent miscible with water (for example, alcohols, ethers, glycols, ketones, esters, amides), or in the form of a mixture thereof with gelatin.

The amount of the hexacyano-metal complex to be added to the silver halide grains preferably falls between 1×10⁻⁵ mols and 1×10⁻² mols, per mol of silver of the grains, more preferably between 1×10⁻⁴ mols and 1×10⁻³ mols.

In order to make the hexacyano-metal complex exist in the outermost surface of the silver halide grains, the complex is added to an aqueous silver nitrate solution from which are formed the silver halide grains, after the solution has been added to a reaction system to give the grains but before the grains having been formed are finished for chemical sensitization such as chalcogen sensitization with sulfur, selenium or tellurium or noble metal sensitization with gold or the like, or is directly added to the grains while they are rinsed or dispersed but before they are finished for such chemical sensitization. To prevent the silver halide grains formed from growing too much, it is desirable that the hexacyano-metal complex is added to the grains immediately after they are formed. Preferably, the complex is added thereto before the grains formed are finished for post-treatment.

Adding the hexacyano-metal complex to the silver halide grains may be started after 96% by weight of the total of silver nitrate, from which are formed the grains, has been added to a reaction system to give the grains, but is preferably started after 98% by weight of silver nitride has been added thereto, more preferably after 99% by weight thereof has been added thereto.

The hexacyano-metal complex added to the silver halide grains after an aqueous solution of silver nitrate has been added to the reaction system to give the grains but just before the grains are completely formed is well adsorbed by the grains formed, and may well exist in the outermost surfaces of the grains. Most of the complex added in that manner forms a hardly-soluble salt with the silver ions existing in the surfaces of the grains. The silver salt of hexacyano-iron(II) is more hardly soluble than AgI, and the fine grains formed are prevented from re-dissolving and aggregating into large grains. Accordingly, the intended fine silver halide grains having a small grain size can be formed.

The photosensitive silver halide grains for use in the forty-fifth embodiment of the invention may contain a metal or metal complex of Groups 8 to 10 of the Periodic Table (including Groups 1 to 18). The metal of Groups 8 to 10, or the center metal of the metal complex is preferably rhodium, ruthenium or iridium. In the forty-fifth embodiment of the invention, one metal complex may be used alone, or two or more metal complexes of one and the same type of metal or different types of metals may also be used herein as combined.

The metal or metal complex content of the grains preferably falls between 1×10⁻⁹ mols and 1×10⁻³ mols per mol of silver of the grains. Such heavy metals and metal complexes, and methods of adding them to the silver halide grains are described in, for example, JP-A 7-225449, JP-A 11-65021, paragraphs [0018] to [0024], and JP-A 11-119374, paragraphs [0227] to [0240].

The metal atoms (e.g., in [Fe(CN)₆]⁴⁻) that may be added to the photosensitive silver halide grains for use in the forty-fifth embodiment of the invention, as well as the methods of desalting or chemical sensitization of the photosensitive silver halide emulsions are described, for example, in JP-A 11-84574, paragraphs [0046] to [0050], JP-A 11-65021, paragraphs [0025] to [0031], and JP-A 11-119374, paragraphs [0242] to [0250].

<<Gelatin>>

Gelatin of different types may be used in preparing the photosensitive silver halide emulsions for use in the forty-fifth embodiment of the invention. For better dispersion of the photosensitive silver halide emulsion in an organic silver salt-containing coating liquid in producing the photothermographic material of the forty-fifth embodiment of the invention, preferred is low-molecular gelatin having a molecular weight of from 500 to 60,000. The low-molecular gelatin of the type may be used in forming the silver halide grains or in dispersing the grains after the grains have been desalted. Preferably, it is used in dispersing the grains after they have been desalted.

<<Sensitizing Dye>>

The photothermographic material of the forty-fifth embodiment of the invention may contain a sensitizing dye. Usable herein are sensitizing dyes which, after adsorbed by the silver halide grains, can spectrally sensitize the grains within a desired wavelength range. Depending on the spectral characteristics of the light source to be used for exposure, favorable sensitizing dyes having good spectral sensitivity are selected for use in the photothermographic material of the forty-fifth embodiment of the invention.

For the details of sensitizing dyes usable herein and methods for adding them to the photothermographic material of the forty-fifth embodiment of the invention, referred to are paragraphs [0103] to [0109] in JP-A 11-6501; compounds of formula (II) in JP-A 10-186572; dyes of formula (I) and paragraph [0106] in JP-A 11-119374; dyes described in U.S Pat. Nos. 5,510,236, 3,871,887 (Example 5); dyes described in JP-A 2-96131, 59-48753; from page 19, line 38 to page 20, line 35 in EP 0803764A1; Japanese Patent Application Nos. 2000-86865, 2000-102560 and 2000-205399.

One or more such sensitizing dyes may be used herein either singly or as combined. Regarding the time at which the sensitizing dye is added to the silver halide emulsion in the forty-fifth embodiment of the invention, it is desirable that the sensitizing dye is added thereto after the desalting step but before the coating step, more preferably after the desalting step but before the chemical ripening step.

The amount of the sensitizing dye to be in the photothermographic material of the forty-fifth embodiment of the invention varies, depending on the sensitivity and the fogging resistance of the material. In general, it preferably falls between 10⁻⁶ and 1 mol, more preferably between 10⁻⁴ and 10⁻¹ mols, per mol of the silver halide in the photosensitive layer (image-forming layer) of the material.

For its better spectral sensitization, the photothermographic material of the forty-fifth embodiment of the invention may contain a supersensitizer. For the supersensitizer, for example, usable are the compounds described in EP Laid-Open 587,338, U.S. Pat. Nos. 3,877,943, 4,873,184, and JP-A 5-341432, 11-109547 and 10-111543.

<<Chemical Sensitization>>

Preferably, the photosensitive silver halide grains for use in the forty-fifth embodiment of the invention are chemically sensitized with, for example, sulfur, selenium or tellurium. For such sulfur, selenium or tellurium sensitization, any known compounds are usable. For example, preferred are the compounds described in JP-A 7-128768. The grains for use in the forty-fifth embodiment of the invention are especially preferably sensitized with tellurium, for which more preferred are the compounds described in JP-A 11-65021, paragraph [0030], and the compounds of formulae (II), (III) and (IV) given in JP-A 5-313284.

In the forty-fifth embodiment of the invention, the silver halides may be chemically sensitized in any stage after their formation but before their coating. For example, they may be chemically sensitized after desalted, but (1) before spectral sensitization, or (2) along with spectral sensitization, or (3) after spectral sensitization, or (4) just before coating. Especially preferably, the grains are chemically sensitized after spectral sensitization.

The amount of the sulfur, selenium or tellurium sensitizer for such chemical sensitization in the forty-fifth embodiment of the invention varies, depending on the type of the silver halide grains to be sensitized therewith and the condition for chemically ripening the grains, but may fall generally between 10⁻⁸ and 10⁻² mols, preferably between 10⁻⁷ and 10⁻³ mols or so, per mol of the silver halide.

Though not specifically defined herein, the condition for chemical sensitization may be such that the pH falls between 5 and 8, the pAg falls between 6 and 11, and the temperature falls between 40 and 95° C. or so.

If desired, a thiosulfonic acid compound may be added to the silver halide emulsions for use in the forty-fifth embodiment of the invention, according to the method described in EP Laid-Open 293,917.

The photothirmographic material of the forty-fifth embodiment of the invention may contain only one type or two or more different types of photosensitive silver halide grains (these will differ in their mean grain size, halogen composition or crystal habit, or in the condition for their chemical sensitization), either singly or as combined. Combining two or more types of photosensitive silver halide grains differing in their sensitivity will enable to control the gradation of the images to be formed in the photothermographic material. For the technique relating to it, referred to are JP-A 57-119341, 53-106125, 47-3929, 48-55730, 46-5187, 50-73627, 57-150841.

The sensitivity difference between the combined silver halide grains is preferably such that the respective emulsions differ from each other at least by 0.2 logE.

Especially preferably, the silver halide (high silver iodide emulsion) for use in the forty-fifth embodiment of the invention is formed in the absence of the non-photosensitive organic silver salt, and is chemically sensitized in the manner as above.

If the silver halide is formed in the presence of the organic silver salt, its sensitivity will be low.

For forming the silver halide in the absence of the non-photosensitive organic silver salt, for example, employable is a method of mixing the photosensitive silver halide and the organic silver salt that have been prepared separately, in a high-performance stirrer, a ball mill, a sand mill, a colloid mill, a shaking mill, a homogenizer or the like; or a method of adding the photosensitive silver halide grains having been prepared to the organic silver salt being prepared, in any desired timing to produce the organic silver salt mixed with the silver halide grains. Any of these methods produces the advantages of the forty-fifth embodiment of the invention.

<<Mode of Mixing Photosensitive Silver Halide in Coating Liquid>>

The preferred time at which the silver halide grains is added to the coating liquid which is to form the image-forming layer on the support of the photothermographic material of the forty-fifth embodiment of the invention may fall between 180 minutes before coating the liquid and a time just before the coating, more preferably between 60 minutes before the coating and 10 seconds before it. However, there is no specific limitation thereon, so far as the method and the condition employed for adding the grains to the coating liquid ensure the advantages of the forty-fifth embodiment of the invention.

Concretely for mixing them, employable is a method of adding the grains to the coating liquid in a tank in such a controlled manner that the mean residence time for the grains in the tank, as calculated from the amount of the grains added and the flow rate of the coating liquid to a coater, could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

<Organic Silver Salt>

The organic silver salt to be in the image-forming layer of the forty-fifth embodiment of the photothirmographic material of the invention is described.

The organic silver salt for use in the forty-fifth embodiment of the invention is relatively stable to light, but, when heated at 80° C. or higher in the presence of an exposed photocatalyst (e.g., latent image of photosensitive silver halide) and a reducing agent, it forms a silver image. The organic silver salt may be any and every organic substance that contains a source having the ability to reduce silver ions.

Some non-photosensitive organic silver salts of that type are described, for example, in JP-A 10-62899, paragraphs [0048] to [0049]; EP Laid-Open 0803763A1, from page 18 line 24 to page 19, line 37; EP Laid-Open 0962812A1; JP-A 11-349591, 2000-7683, 2000-72711.

Preferred for use herein are silver salts of organic acids, especially silver salts of long-chain (C10 to C30, preferably C15 to C28) aliphatic carboxylic acids. Preferred examples of the organic silver salts are silver behenate, silver arachidate, silver stearate, silver oleate, silver laurate, silver caproate, silver myristate, silver palmitate, and their mixtures. Of those, especially preferred are organic silver salts having a silver behenate content of from 50 mol % to 100 mol %, and more preferred are those having a silver behenate content of from 75 mol % to 98 mol %.

The organic silver salt for use herein is not specifically defined for its morphology, and may be in any form of acicular, rod-like, tabular or scaly solids. Preferably, it is scaly.

Scaly organic silver salts are preferred in the forty-fifth embodiment of the invention, and they are defined as follows: A sample of an organic silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average)≧1.5 are scaly. For scaly grains, preferably, 30≧x (average)≧1.5, more preferably 20≧x (average)≧2.0. In this connection, the value x of acicular (needle-like) grains falls within a range of 1≦x (average)<1.5.

In the scaly grains, it is understood that a corresponds to the thickness of tabular grains of which the main plane is represented by b×c. In the scaly organic silver salt grains for use herein, a (average) preferably falls between 0.01 μm and 0.23 μm, more preferably between 0.1 μm and 0.20 μm; and c/b (average) preferably falls between 1 and 6, more preferably between 1.05 and 4, even more preferably between 1.1 and 3, still more preferably between 1.1 and 2.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its morphology, a dispersion of the organic silver salt may be analyzed on its image taken by the use of a transmission electronic microscope. Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%. Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained.

For preparing and dispersing the organic silver salts for use in the forty-fifth embodiment of the invention, employable is any known method. For it, for example, referred to are JP-A 10-62899; EP Laid-Open 0803763A1 and 962812A1; JP-A 11-349591, 2000-7683,2000-72711; and Japanese Patent Application Nos. 11-348228, 11-348229, 11-348230, 11-203413, 2000-90093, 2000-195621, 2000-191226, 2000-213813, 2000-214155, 2000-191226.

In the forty-fifth embodiment of the invention, an aqueous dispersion of the organic silver salt may be mixed with an aqueous dispersion of the photosensitive silver salt to prepare the photothermographic material. Preferably, at least two different types of aqueous dispersions of organic silver salts are mixed with at least two different types of aqueous dispersions of photosensitive salts for desirably controlling the photographic properties of the photothermographic material to be prepared.

The amount of the organic silver salt to be in the photothermographic material of the forty-fifth embodiment of the invention is not specifically defined, and may be any desired one. Preferably, the amount of the salt falls between 0.1 and 5 g/m², more preferably between 1 and 3 g/m², even more preferably between 1.2 and 2.5 g/m², in terms of the amount of silver in the salt.

<Reducing Agent>

The photothirmographic material of the forty-fifth embodiment of the invention contains a reducing agent for the organic silver salt therein. The reducing agent is described.

The reducing agent for the organic silver salt may be any and every substance capable of reducing silver ions into metal silver, but is preferably an organic substance. Some examples of the reducing agent are described in JP-A 11-65021, paragraphs [0043] to [0045], and in EP Laid-Open 0803764A1, from page 7, line 34 to page 18, line 12.

Especially preferred for use herein are hindered phenol-type reducing agents and bisphenol-type reducing agents, and more preferred are compounds of the following general formula (R″):

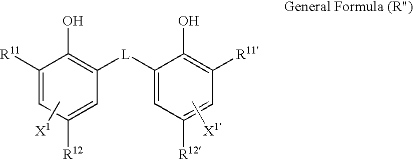

In formula (R″), R¹¹ and R^{11′} each independently represent an alkyl group having from 1 to 20 carbon atoms; R¹² and R^{12′} each independently represent a hydrogen atom, or a substituent substitutable to the benzene ring; L represents —S— or —CHR¹³—; R¹³ represents a hydrogen atom, or an alkyl group having from 1 to 20 carbon atoms; X¹ and X^{1′} each independently represent a hydrogen atom, or a substituent substitutable to the benzene ring.

Formula (R″) is described in detail.

R¹¹ and R^{11′} each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, and a halogen atom.

R¹² and R^{12′} each independently represent a hydrogen atom, or a substituent substitutable to the benzene ring; X¹ and X^{1′} each independently represent a hydrogen atom, or a substituent substitutable to the benzene ring. Preferred examples of the substituent substitutable to the benzene ring are an alkyl group, an aryl group, a halogen atom, an alkoxy group, and an acylamino group.

L represents a group of —S— or —CHR¹³—. R¹³ represents a hydrogen atom or an alkyl group having from 1 to 20 carbon atoms. The alkyl group may be substituted.

Preferred examples of the unsubstituted alkyl group for R¹³ are methyl, ethyl, propyl, butyl, heptyl, undecyl, isopropyl, 1-ethylpentyl and 2,4,4-trimethylpentyl groups.

Like that for R¹¹, the substituent for the alkyl group includes, for example, a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

For R¹¹ and R^{11′}, preferred is a secondary or tertiary alkyl group having from 3 to 15 carbon atoms. Concretely, preferred examples of the alkyl group are isopropyl, isobutyl, t-butyl, t-amyl, t-octyl, cyclohexyl, cyclopentyl, 1-methylcyclohexyl and 1-methylcyclopropyl groups.

For R¹¹ and R^{11′}, more preferred is a tertiary alkyl group having from 4 to 12 carbon atoms; even more preferred is any of t-butyl, t-amyl and 1-methylcycohexyl groups; and most preferred is a t-butyl group.

Preferably, R¹² and R^{12′} each are an alkyl group having from 1 to 20 carbon atoms, concretely including, for example, methyl, ethyl, propyl, butyl, isopropyl, tert-butyl, tert-amyl, cyclohexyl, 1-methylcyclohexyl, benzyl, methoxymethyl and methoxyethyl groups. For these, more preferred are methyl, ethyl, propyl, isopropyl and tert-butyl groups.

Also preferably, X^{1′} and X^{1′} each are a hydrogen atom, a halogen atom or an alkyl group; and more preferably, they are both hydrogen atoms.

L is preferably —CHR¹³—.

Also preferably, R¹³ is a hydrogen atom, or an alkyl group having from 1 to 15 carbon atoms. Preferred examples of the alkyl group are methyl, ethyl, propyl, isopropyl and 2,4,4-trimethylpentyl groups. More preferably, R¹³ is a hydrogen atom, a methyl group, a propyl group or an isopropyl group.

In case where R¹³ is a hydrogen atom, R¹² and R^{12′} each are preferably an alkyl group having from 2 to 5 carbon atoms, more preferably an ethyl or propyl group, most preferably, they are both ethyl groups.

In case where R¹³ is a primary or secondary alkyl group having from 1 to 8 carbon atoms, R¹² and R^{12′} are preferably both methyl groups. The primary or secondary alkyl group having from 1 to 8 carbon atoms for R¹³ is preferably a methyl, ethyl, propyl or isopropyl group, more preferably a methyl, ethyl or propyl group.

In case where R¹¹, R^{11′}, R¹² and R^{12′} are all methyl groups, R¹³ is preferably a secondary alkyl group. The secondary alkyl group for R¹³ is preferably an isopropyl, isobutyl or 1-ethylpentyl group, more preferably an isopropyl group.

Examples of the compounds of formula (R″) and other reducing agents for use in the forty-fifth embodiment of the invention are mentioned below [Compounds (R″-1) to (R″-27)], to which, however, the forty-fifth embodiment of the invention is not limited.

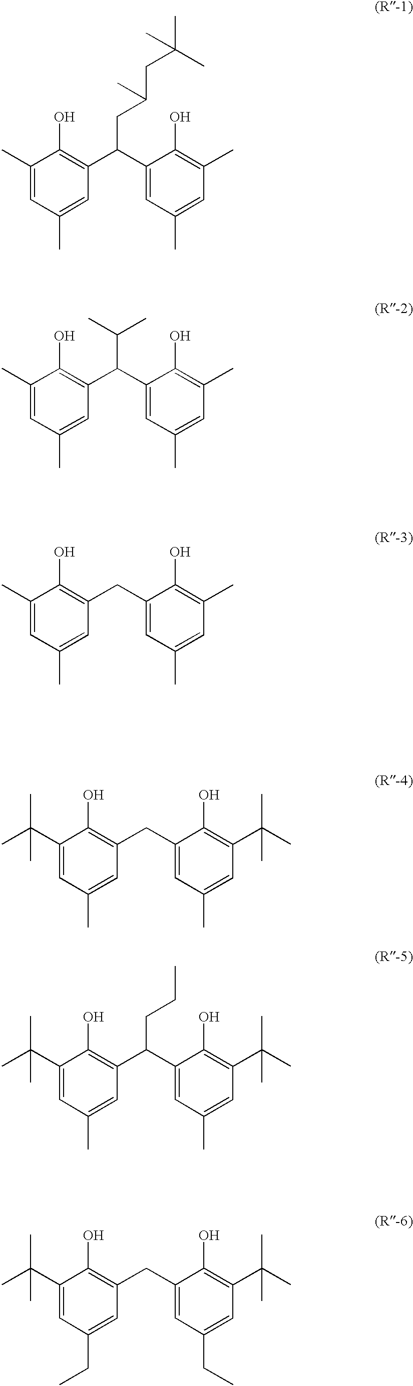

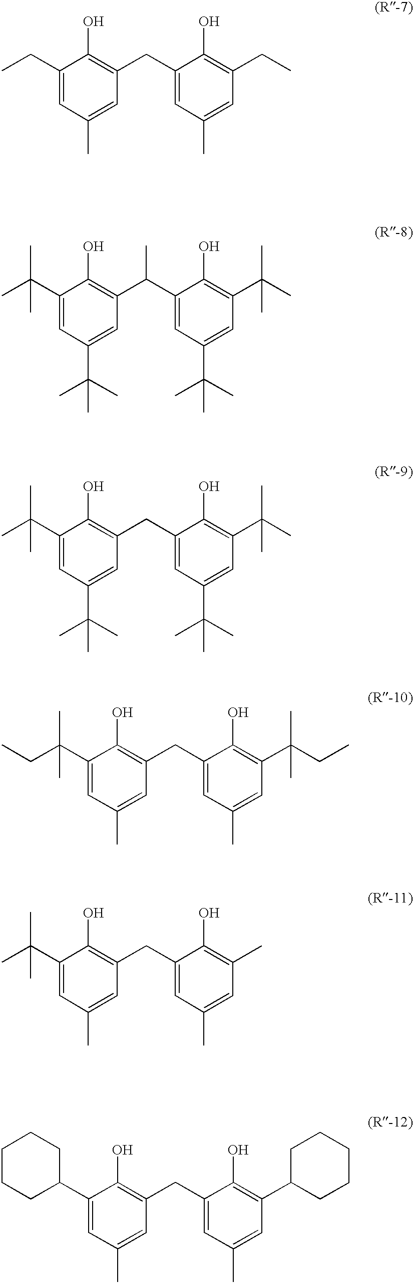

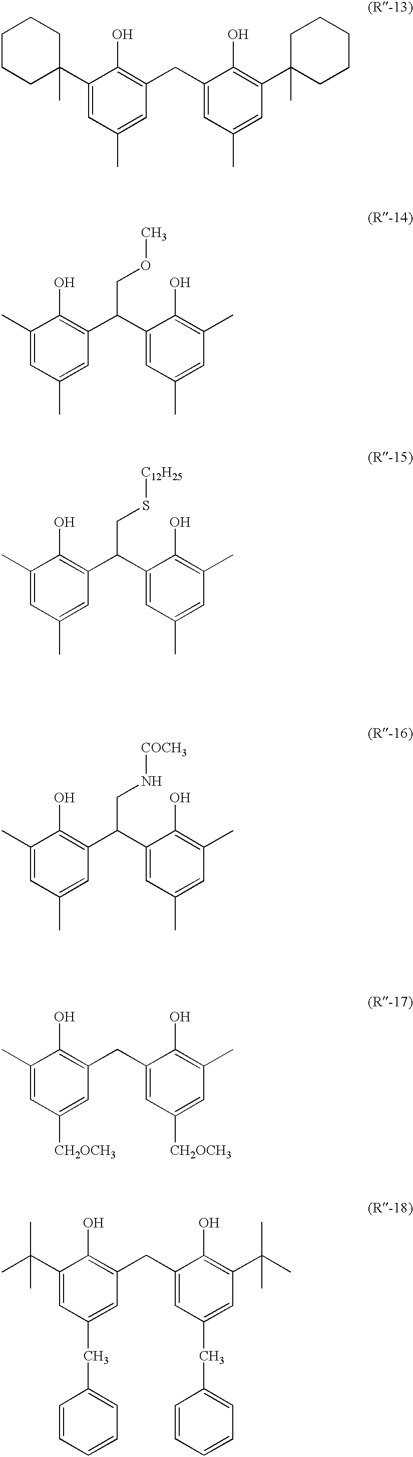

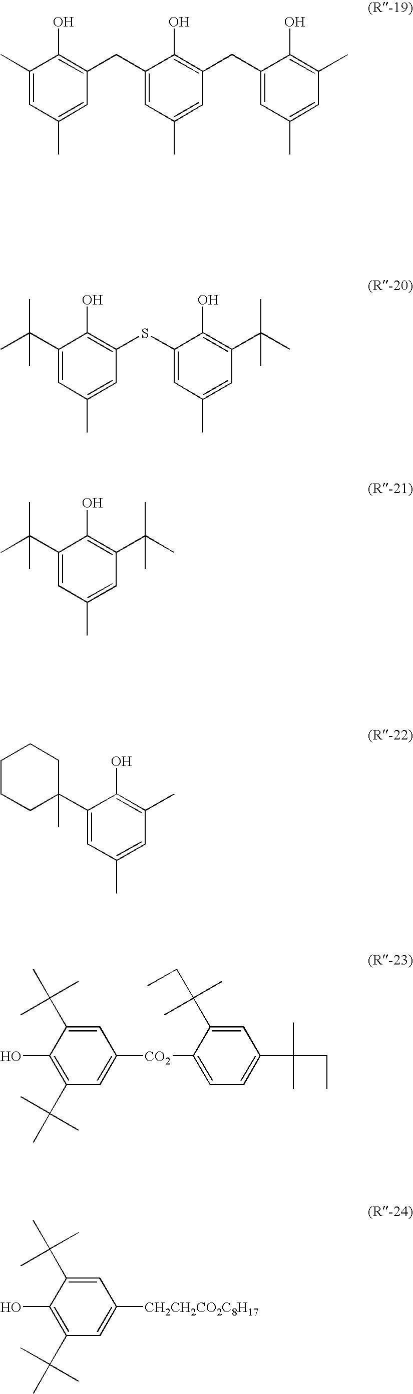

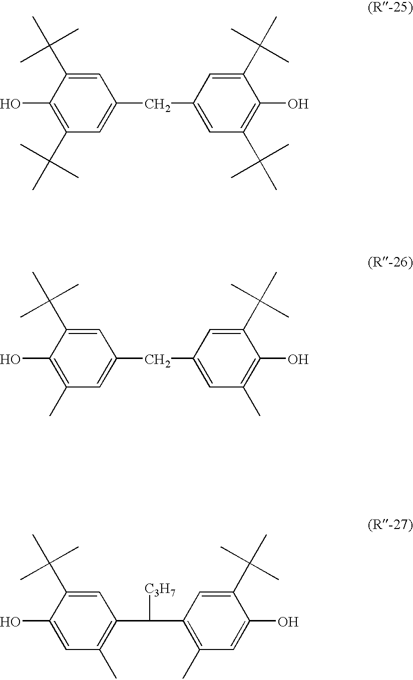

Of the preferred examples of the reducing agents mentioned above, more preferred are Compounds (R″-1) to (R″-20).

One or more different types of the reducing agents may be used in the forty-fifth embodiment of the invention either singly or as combined.

Preferably, the amount of the reducing agent to be in the photothermographic material of the forty-fifth embodiment of the invention falls between 0.01 and 5.0 g/m², more preferably between 0.1 and 3.0 g/m². Also preferably, the amount of the reducing agent to be therein falls between 5 and 50 mol %, more preferably between 10 and 40 mol %, per mol of silver existing in the face of the image-forming layer of the material.

Still preferably, the reducing agent is present in the image-forming layer of the material.

The reducing agent may be in any form of solution, emulsified dispersion or fine solid particle dispersion, and may be added to the coating liquid in any known method so as to be incorporated into the photothermographic material of the forty-fifth embodiment of the invention.

One well known method of emulsifying the reducing agent to prepare its dispersion comprises dissolving the reducing agent in an auxiliary solvent such dibutyl phthalate, tricresyl phosphate, glyceryl triacetate, diethyl phthalate or the like oily solvent, or in ethyl acetate or cyclohexanone, followed by mechanically emulsifying it into a dispersion.

For preparing a fine solid particle dispersion of the reducing agent, for example, employable is a method that comprises dispersing a powder of the reducing agent in water or in any other suitable solvent by the use of a ball mill, a colloid mill, a shaking ball mill, a sand mill, a jet mill or a roller mill, or ultrasonically dispersing it therein to thereby prepare the intended solid dispersion of the reducing agent.

In this method, optionally used is a protective colloid (e.g., polyvinyl alcohol), and a surfactant (e.g., anionic surfactant such as sodium triisopropylnaphthalenesulfonate—this is a mixture of the salts in which the three isopropyl groups are all in different positions). Also if desired, the aqueous dispersion may contain a preservative (e.g., sodium benzoisothiazolinone).

<Development Accelerator>

A phenol derivative of the following general formula (A), which serves as a development accelerator, is preferably used in the photothirmographic material of the forty-fifth embodiment of the invention.

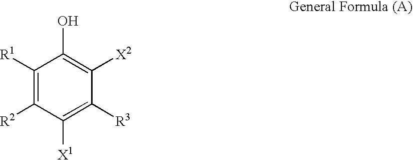

In formula (A), R¹, R², R¹³, X¹ and X² each independently represent a hydrogen atom; a halogen atom; or a substituent that bonds to the benzene ring via a carbon, oxygen, nitrogen, sulfur or phosphorus atom. However, at least one of X¹ and X² is a group of —NR⁴R⁵. R⁴ and R⁵ each independently represent a hydrogen atom, an alkyl group, an alkenyl group, an alkynyl group, an aryl group, a heterocyclic group, or a group of —C(═O)—R, —C(═O)—C(═O)—R, —SO₂—R, —SO—R, —P(═O)(R)₂ or —C(═NR′)—R. R and R′ each independently represent a hydrogen atom, or a group selected from an alkyl group, an aryl group, a heterocyclic group, an amino group, an alkoxy group and an aryloxy group. Of the substituents, neighboring ones may bond to each other to form a ring.

<Hydrogen Bonding Type Compound>

A Hydrogen bonding type compound is also preferably used in the photothirmographic material of the forty-fifth embodiment of the invention.

In case where the reducing agent in the material has an aromatic hydroxyl group (—OH), especially when it is any of the above-mentioned bisphenols, the reducing agent is preferably combined with a non-reducing compound that has a group capable of forming a hydrogen bond with the group in the reducing agent.

The group capable of forming a hydrogen bond with the hydroxyl group or the amino group in the reducing agent includes, for example, a phosphoryl group, a sulfoxide group, a sulfonyl group, a carbonyl group, an amido group, an ester group, an urethane group, an ureido group, a tertiary amino group, a nitrogen-containing aromatic group. Of those, preferred are a phosphoryl group, a sulfoxide group, an amido group (not having a group of >N—H but is blocked to form >N—Ra, in which Ra is a substituent except hydrogen), an urethane group (not having a group of >N—H but is blocked to form >N—Ra, in which Ra is a substituent except hydrogen), an ureido group (not having a group of >N—H but is blocked to form >N—Ra, in which Ra is a substituent except hydrogen).

Especially preferred examples of the Hydrogen bonding type compound for use in the forty-fifth embodiment of the invention are those of the following general formula (D″):

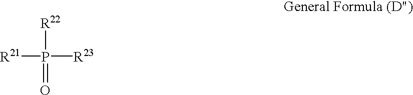

In formula (D″), R², R²² and R²³ each independently represent an alkyl group, an aryl group, an alkoxy group, an aryloxy group, an amino group or a heterocyclic group. These may be unsubstituted or substituted.

The substituents for the substituted groups for R²¹, R²² and R²³ are, for example, a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. Of the substituents, preferred are an alkyl group and an aryl group; and more preferred are methyl, ethyl, isopropyl, t-butyl, t-octyl, phenyl, 4-alkoxyphenyl and 4-acyloxyphenyl groups.

The alkyl group for R²¹, R²² and R²³ includes, for example, methyl, ethyl, butyl, octyl, dodecyl, isopropyl, t-butyl, t-amyl, t-octyl, cyclohexyl, 1-methylcyclohexyl, benzyl, phenethyl and 2-phenoxypropyl groups.

The aryl group for R²¹, R²² and R²³ includes, for example, phenyl, cresyl, xylyl, naphthyl, 4-t-butylphenyl, 4-t-octylphenyl, 4-anisidyl and 3,5-dichlorophenyl groups.

The alkoxy group for R²¹, R²² and R²³ includes, for example, methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups.

The aryloxy group for R²¹, R²² and R²³ includes, for example, phenoxy, cresyloxy, isopropylphenoxy, 4-t-butylphenoxy, naphthoxy and biphenyloxy groups.

The amino group for R²¹, R²² and R²³ includes, for example, dimethylamino, diethylamino, dibutylamino, dioctylamino, N-methyl-N-hexylamino, dicyclohexylamino, diphenylamino and N-methyl-N-phenylamino groups.

The heterocyclic group for R²¹, R²² and R²³ may be saturated or unsaturated, including, for example, pyridyl, quinolyl, pyrazinyl, benzotriazolyl, imidazolyl, benzimidazolyl, hydantoin-1-yl and succinimido groups.

For R²¹, R²² and R²³, preferred are an alkyl group, an aryl group, an alkoxy group and an aryloxy group. From the viewpoint of the advantages of the forty-fifth embodiment of the invention, it is preferable that at least one of them is an alkyl group or an aryl group, and it is more desirable that at least two of them are any of an alkyl group and an aryl group. Even more preferably, R²¹, R²² and R²³ are the same as the compounds of the type are inexpensive.

Specific examples of the compounds of formula (D″) and other Hydrogen bonding type compounds usable in the forty-fifth embodiment of the invention are mentioned below [Compounds (D″-1) to (D″-17)], to which, however, the forty-fifth embodiment of the invention is not limited.

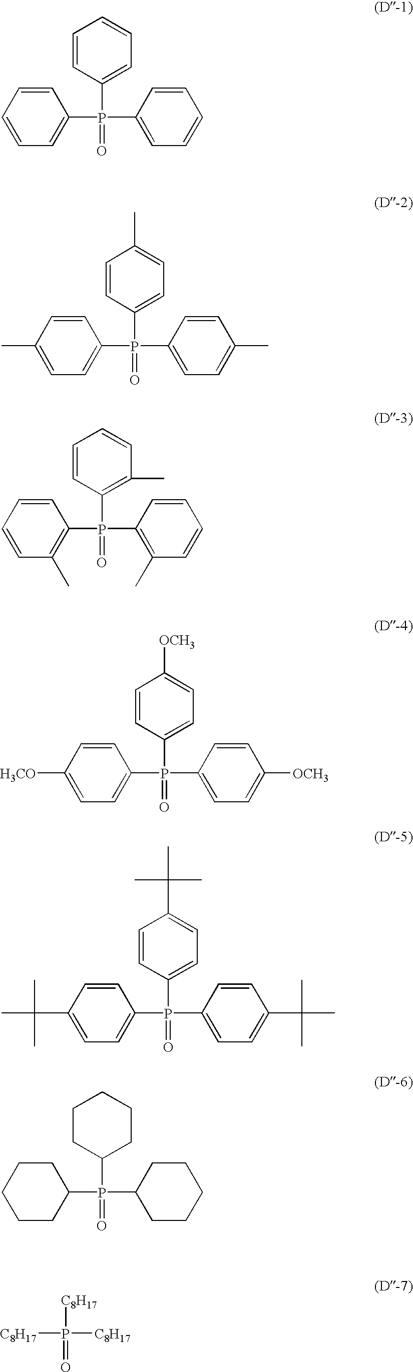

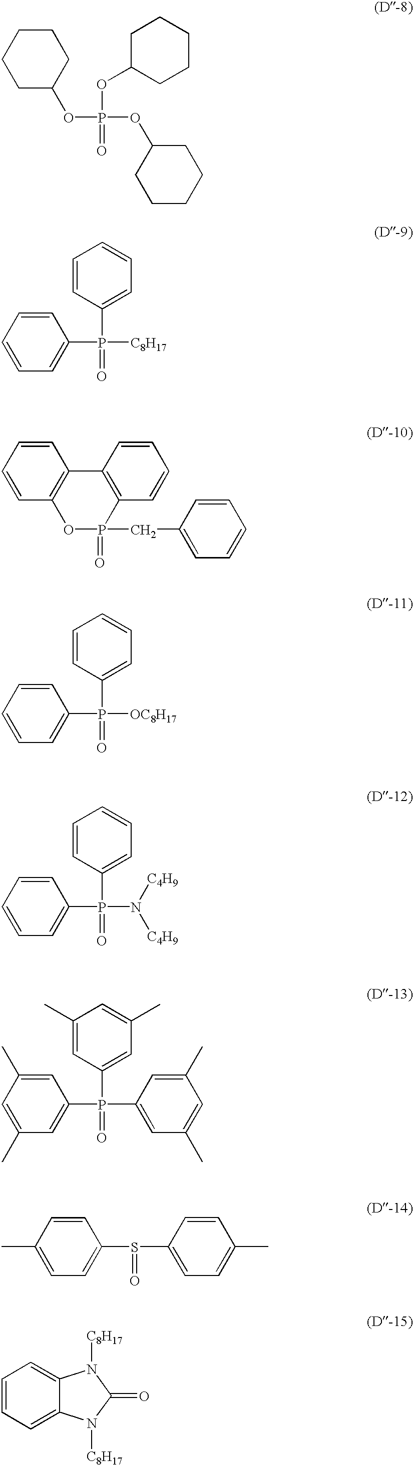

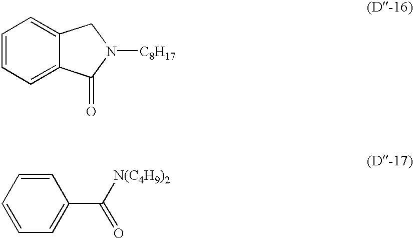

Apart from the above, other Hydrogen bonding type compounds such as those described in Japanese Patent Application Nos. 2000-192191 and 2000-194811 are also usable herein.

Like the reducing agent mentioned above, the compound of formula (D″) may be added to the coating liquid for the photothermographic material of the forty-fifth embodiment of the invention, for example, in the form of its solution, emulsified dispersion or solid particle dispersion. In its solution, the compound of formula (D″) may form a hydrogen-bonding complex with a compound having a phenolic hydroxyl group or an amino group. Depending on the combination of the reducing agent and the compound of formula (D″) for use herein, the complex may be isolated as its crystal. Thus isolated, the crystal powder may be formed into its solid particle dispersion, and the dispersion is especially preferred for use in the forty-fifth embodiment of the invention for stabilizing the photothermographic material of the forty-fifth embodiment of the invention. As the case may be, the reducing agent and the compound of formula (D″) may be mixed both in powder optionally along with a suitable dispersant added thereto in a sand grinder mill or the like to thereby form the intended complex in the resulting dispersion. The method is also preferred in the forty-fifth embodiment of the invention.

Preferably, the amount of the compound of formula (D″) to be added to the reducing agent falls between 1 and 200 mol %, more preferably between 10 and 150 mol %, even more preferably between 30 and 100 mol % relative to the reducing agent.

<Binder>

Preferably, the photothirmographic material of the forty-fifth embodiment of the invention contains a binder in the image-forming layer (organic silver salt-containing layer) thereof. The binder is described below.

The binder may be polymer of any type, but is preferably transparent or semitransparent and is generally colorless. For it, for example, preferred are natural resins, polymers and copolymers; synthetic resins, polymers and copolymers; and other film-forming media. More concretely, they include, for example, gelatins, rubbers, poly(vinyl alcohols), hydroxyethyl celluloses, cellulose acetates, cellulose acetate butyrates, poly(vinylpyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal), poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). The binder may be prepared from water or an organic solvent or an emulsion through microencapsulation.

The glass transition point of the binder to be in the organic silver salt-containing layer (image-forming layer) in the forty-fifth embodiment of the invention preferably falls between 10° C. and 80° C. (the binder of the type will be hereinafter referred to as a high-Tg binder), more preferably between 20° C. and 70° C., even more preferably between 23° C. and 65° C.

In this description, Tg is calculated according to the following equation:

1/Tg=Σ(Xi/Tgi)

The polymer of which the glass transition point Tg is calculated as in the above comprises n's monomers copolymerized (i indicates the number of the monomers copolymerized, falling between 1 and n); Xi indicates the mass fraction of i'th monomer (ΣXi=1); Tgi indicates the glass transition point (in terms of the absolute temperature) of the homopolymer of i'th monomer alone; and Σ indicates the sum total of i falling between 1 and n. For the glass transition point (Tgi) of the homopolymer of each monomer alone, referred to is the description in Polymer Handbook (3rd edition) (written by J. Brandrup, E. H. Immergut (Wiley-Interscience, 1989)).

One and the same polymer may be used for the binder, but, if desired, two or more different types of polymers may be combined for it. For example, a polymer having a glass transition point of 20° C. or higher and a polymer having a glass transition point of lower than 20° C. may be combined.

In case where at least two polymers that differ in Tg are blended for use herein, it is desirable that the weight-average Tg of the resulting blend falls within the range defined as above.

In case where the organic silver salt-containing layer (image-forming layer) in the forty-fifth embodiment of the invention is formed by using a coating liquid in which at least 30% by weight of the solvent is water, followed by drying it, and in case where the binder in the organic silver salt-containing layer is soluble or dispersible in an aqueous solvent (watery solvent), especially when the binder in the organic silver salt-containing layer is a polymer latex that has an equilibrium water content at 25° C. and 60% RH of at most 2% by weight, the photothermographic material having the layer of the type enjoys better properties.

Most preferably, the binder for use in the forty-fifth embodiment of the invention is so designed that its ionic conductivity is at most 2.5 mS/cm. For preparing the binder of the type, for example, employable is a method of preparing a polymer for the binder followed by purifying it through a functional membrane for fractionation.

The aqueous solvent in which the polymer binder is soluble or dispersible is water or a mixed solvent of water and at most 70% by weight of a water-miscible organic solvent. The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” referred to herein can apply also to polymer systems in which the polymer is not thermodynamically dissolved but is seemingly dispersed.

The “equilibrium water content at 25° C. and 60% RH” referred to herein for polymer latex is represented by the following equation, in which W₁ indicates the weight of a polymer in humidity-conditioned equilibrium at 25° C. and 60% RH, and W₀ indicates the absolute dry weight of the polymer at 25° C.

Equilibrium water content at 25° C. and 60% RH={(W₁−W₀)/W₀}×100 (wt. %)

For the details of the definition of water content and the method for measuring it, for example, referred to is Polymer Engineering, Lecture 14, Test Methods for Polymer Materials (by the Polymer Society of Japan, Chijin Shokan Publishing).

Preferably, the equilibrium water content at 25° C. and 60% RH of the binder polymer for use in the forty-fifth embodiment of the invention is at most 2% by weight, more preferably from 0.01 to 1.5% by weight, even more preferably from 0.02 to 1% by weight.

Polymers that serve as the binder in the forty-fifth embodiment of the invention are preferably dispersible in aqueous solvents. Polymer dispersions include, for example, a type of hydrophobic polymer latex with water-insoluble fine polymer particles being dispersed, and a type of molecular or micellar polymer dispersion with polymer molecules or micelles being dispersed. Any of these is preferred for use herein. The particles in the polymer dispersions preferably have a mean particle size falling between 1 and 50000 nm, more preferably between 5 and 1000 nm.

The particle size distribution of the dispersed polymer particles is not specifically defined. For example, the dispersed polymer particles may have a broad particle size distribution, or may have a narrow particle size distribution of monodispersion.

In preferred embodiments of the photothermographic material of the invention, favorably used are hydrophobic polymers that are dispersible in aqueous media. The hydrophobic polymers of the type include, for example, acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked ones. They may be homopolymers from one type of monomer, or copolymers from two or more different types of monomers. The copolymers may be random copolymers or block copolymers. The polymers for use herein preferably have a number-average molecular weight falling between 5000 and 1000000, more preferably between 10000 and 200000. Polymers having a too small molecular weight are unfavorable to the forty-fifth embodiment of the invention, since the mechanical strength of the silver halide emulsion layer comprising such a polymer is low; but others having a too large molecular weight are also unfavorable since their workability into films is not good.

<Examples of Latex>

Preferred examples of polymer latex for use herein are mentioned below. They are expressed by the constituent monomers, in which each numeral parenthesized indicates the proportion, in terms of % by weight, of the monomer unit, and the molecular weight of each constituent monomer is in terms of the number-average molecular weight thereof. Polyfunctional monomers form a crosslinked structure in polymer latex comprising them, to which, therefore, the concept of molecular weight does not apply. The polymer latex of the type is referred to as “crosslinked”, and the molecular weight of the constituent monomers is omitted. Tg indicates the glass transition point of the polymer latex.

P-1: Latex of -MMA(70)-EA(27)-MAA(3)-(molecular weight 37000, Tg 61° C.)

P-2: Latex of -MMA(70)-2EHA(20)-St(5)-AA(5)-(molecular weight 40000, Tg 59° C.)

P-3: Latex of -St(50)-Bu(47)-MMA(3)-(crosslinked, Tg -17° C.)

P-4: Latex of -St(68)-Bu(29)-AA(3)-(crosslinked, Tg 17° C.)

P-5: Latex of -St(71)-Bu(26)-AA(3)-(crosslinked, Tg 24° C.)

P-6: Latex of -St(70)-Bu(27)-IA(3)-(crosslinked)

P-7: Latex of -St(75)-Bu(24)-AA(1)-(crosslinked, Tg 29° C.)

P-8: Latex of -St(60)-Bu(35)-DVB(3)-MAA(2)-(crosslinked)

P-9: Latex of -St(70)-Bu(25)-DVB(2)-AA(3)-(crosslinked)

P-10: Latex of -VC(50)-MMA(20)-EA(20)-AN-(5)-AA(5)-(molecular weight 80000)

P-11: Latex of -VDC(85)-MMA(5)-EA(5)-MAA(5)-(molecular weight 67000)

P-12: Latex of -Et(90)-MAA(10)-(molecular weight 12000)

P-13: Latex of -St(70)-2EHA(27)-AA(3)-(molecular weigh: 130000, Tg 43° C.)

P-14: Latex of -MMA(63)-EA(35)-AA(2)-(molecular weight 33000, Tg 47° C.)

P-15: Latex of -St(70.5)-Bu(26.5)-AA(3)-(crosslinked, Tg 23° C.)

P-16: Latex of -St(69.5)-Bu(27.5)-AA(3)-(crosslinked, Tg 20.5° C.)

Abbreviations of the constituent monomers are as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The polymer latexes mentioned above are available on the market. Some commercial products employable herein are mentioned below. Examples of acrylic polymers are CEBIAN A-4635, 4718, 4601 (all from Daicel Chemical Industries), and Nipol Lx811, 814, 821, 820, 857 (all from Nippon Zeon); examples of poly(esters) are FINETEX ES650, 611, 675, 850 (all from Dai-Nippon Ink & Chemicals), and WD-size, WMS (both from Eastman Chemical); examples of poly(urethanes) are HYDRAN AP10, 20, 30, 40 (all from Dai-Nippon Ink & Chemicals); examples of rubbers are LACSTAR 7310K, 3307B, 4700H, 7132C (all from Dai-Nippon Ink & Chemicals), and Nipol Lx416, 410, 438C, 2507 (all from Nippon Zeon); examples of poly(vinyl chlorides) are G351, G576 (both from Nippon Zeon); examples of poly(vinylidene chlorides) are L502, L513 (both from Asahi Kasei); and examples of poly(olefins) are CHEMIPEARL S120, SA100 (both from Mitsui Petrochemical).

These polymer latexes may be used either singly or as combined in any desired manner. <Preferred Example of Latex>

For the polymer latex for use herein, especially preferred is styrene-butadiene copolymer latex. In the styrene-butadiene copolymer, the ratio of styrene monomer units to butadiene monomer units preferably falls between 40/60 and 95/5 by weight. Also preferably, the styrene monomer units and the butadiene monomer units account for from 60 to 99% by weight of the copolymer. Still preferably, the polymer latex contains from 1 to 6% by weight, more preferably from 2 to 5% by weight of acrylic acid or methacrylic acid relative to the sum of styrene and butadiene. Even more preferably, the polymer latex contains acrylic acid.

Preferred examples of the styrene-butadiene copolymer latex for use in the forty-fifth embodiment of the invention are the above-mentioned P-3 to P-8 and P-15, and commercial products, LACSTAR-3307B, 7132C, and Nipol Lx416.

The organic silver salt-containing layer of the photothermographic material of the forty-fifth embodiment of the invention may optionally contain a hydrophilic polymer such as gelatin, polyvinyl alcohol, methyl cellulose, hydroxypropyl cellulose carboxymethyl cellulose. The amount of the hydrophilic polymer that may be in the layer is preferably at most 30% by weight, more preferably at most 20% by weight of all the binder in the organic silver salt-containing layer.

Preferably, the polymer latex as above is used in forming the organic silver salt-containing layer (that is, the image-forming layer) of the photothermographic material of the forty-fifth embodiment of the invention. Concretely, the amount of the binder in the organic silver salt-containing layer is such that the ratio by weight of total binder/organic silver salt falls between 1/10 and 10/1, more preferably between 1/3 and 5/1, even more preferably between 1/1 and 3/1.

The organic silver salt-containing layer is a photosensitive layer (emulsion layer) generally containing a photosensitive silver salt, that is, a photosensitive silver halide. In the layer, the ratio by weight of total binder/silver halide preferably falls between 5 and 400, more preferably between 10 and 200.

The overall amount of the binder in the image-forming layer of the photothermographic material of the forty-fifth embodiment of the invention preferably falls between 0.2 and 30 g/m², more preferably between 1 and 15 g/m², even more preferably between 2 and 10 g/m². The image-forming layer may optionally contain a crosslinking agent, and a surfactant which is for improving the coatability of the coating liquid for the layer.

<Solvent Preferred for Coating Liquid>

Preferably, the solvent for the coating liquid for the image forming layer (coating liquid for the organic silver salt-containing layer) of the photothirmographic material of the forty-fifth embodiment of the invention is an aqueous solvent that contains at least 30% by weight of water. The solvent referred to herein is meant to indicate both solvent and dispersion medium for simple expression.

Except water, the other components of the aqueous solvent may be any organic solvents that are miscible with water, including, for example, methyl alcohol, ethyl alcohol, isopropyl alcohol, methyl cellosolve, ethyl cellosolve, dimethylformamide, ethyl acetate. The water content of the solvent for the coating liquid is preferably at least 50% by weight, more preferably at least 70% by weight.

Preferred examples of the solvent composition are water alone, water/methyl alcohol=90/10, water/methyl alcohol=70/30, water/methyl alcohol/dimethylformamide=80/15/5, water/methyl alcohol/ethyl cellosolve=85/10/5, water/methyl alcohol/isopropyl alcohol=85/10/5. The ratio is by weight.

<Antifoggant and Others>

Antifoggants, stabilizers and stabilizer precursors usable in the forty-fifth embodiment of the invention are described, for example, in JP-A 10-62899, paragraph [0070]; EP Laid-Open 0803764A1, from page 20, line 57 to page 21, line 7; JP-A 9-281637, 9-329864.

Antifoggants preferred for use in the forty-fifth embodiment of the invention are organic halides. These are described, for example, in JP-A 11-65021, paragraphs [0111] to [0112]. Especially preferred are organic halides of formula (P) in Japanese Patent Application No. 11-87297; organic polyhalogen compounds of formula (II) in JP-A 10-339934; and organic polyhalogen compounds in Japanese Patent Application No. 11-205330.

Organic polyhalogen compounds preferred for use in the forty-fifth embodiment of the invention are described concretely. Preferably, the polyhalogen compounds for use in the forty-fifth embodiment of the invention are represented by the following general formula (H):

General Formula Q—(Y)n—C(Z₁)(Z₂)X (H)

wherein Q represents an alkyl, aryl or heterocyclic group; Y represents a divalent linking group; n indicates 0 or 1; Z₁ and Z₂ each represent a halogen atom; and X represents a hydrogen atom or an electron-attracting group.

In formula (H), Q is preferably a phenyl group substituted with an electron-attracting group having a positive Hammett's substituent constant σₚ. For the Hammett's substituent constant, referred to is, for example, Journal of Medicinal Chemistry, 1973, Vol. 16, No. 11, 1207-1216.

Preferred examples of the electron-attracting group are a halogen atom (fluorine atom with σₚ of 0.06, chlorine atom with σₚ of 0.23, bromine atom with σₚ of 0.23, iodine atom with σₚ of 0.18), a trihalomethyl group (tribromomethyl with σₚ of 0.29, trichloromethyl with σₚ of 0.33, trifluoromethyl with σₚ of 0.54), a cyano group (with σₚ of 0.66), a nitro group (with σₚ of 0.78), an aliphatic, aryl or heterocyclic sulfonyl group (e.g., methanesulfonyl with σₚ of 0.722), an aliphatic, aryl or heterocyclic acyl group (e.g., acetyl with σₚ of 0.50, benzoyl with σₚ of 0.43), an alkynyl group (e.g., C≡CH with σₚ of 0.23), an aliphatic, aryl or heterocyclic oxycarbonyl group (e.g., methoxycarbonyl with σₚ of 0.45, phenoxycarbonyl with σₚ of 0.44), a carbamoyl group (with σₚ of 0.36), a sulfamoyl group (with σₚ of 0.57), a sulfoxide group, a heterocyclic group, and a phosphoryl group.

The σₚ of the electron-attracting group preferably falls between 0.2 and 2.0, more preferably between 0.4 and 1.0.

Of the preferred examples of the electron-attracting group mentioned above, more preferred are a carbamoyl group, an alkoxycarbonyl group, an alkylsulfonyl group and an alkylphosphoryl group, and most preferred is a carbamoyl group.

In formula (H), X is preferably an electron-attracting group. Concretely, it is more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group. Even more preferably, it is a halogen atom.

For the halogen atom for X, preferred are chlorine, bromine and iodine atoms, more preferred are chlorine and bromine atoms, and even more preferred is a bromine atom.

In formula (H), Y is preferably —C(═O)—, —SO— or —SO₂—, more preferably —SO₂—. n is 0 or 1, but preferably 1.

Specific examples of the compounds of formula (H) that are preferred for the antifoggant in the forty-fifth embodiment of the invention are mentioned below [Compounds (H-1) to (H-22) and (H-24)].

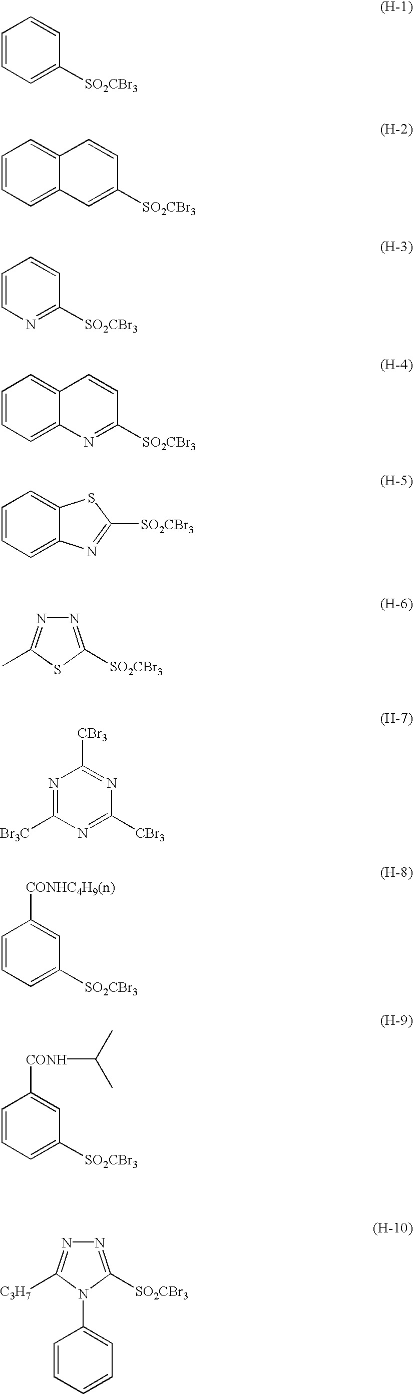

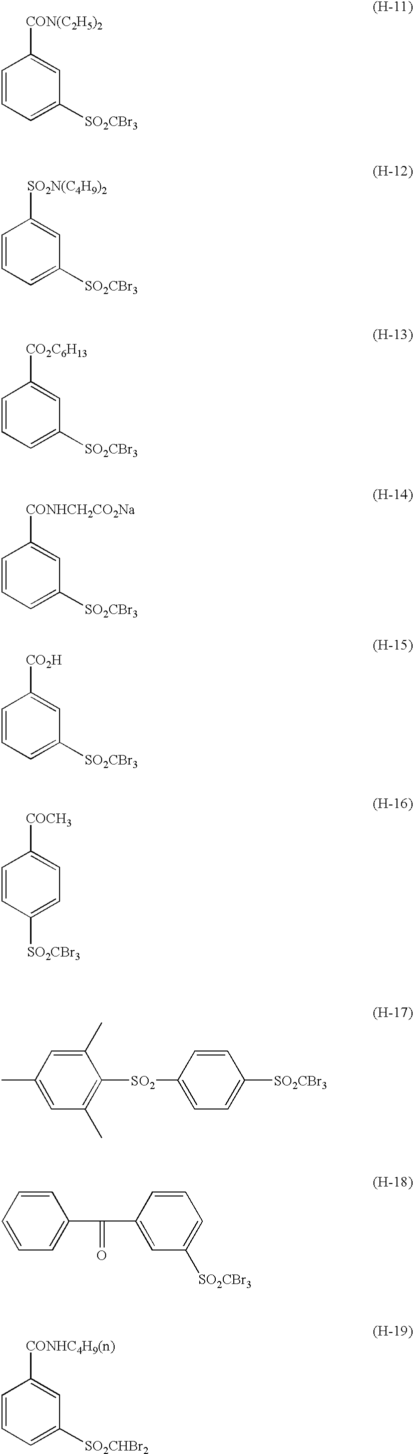

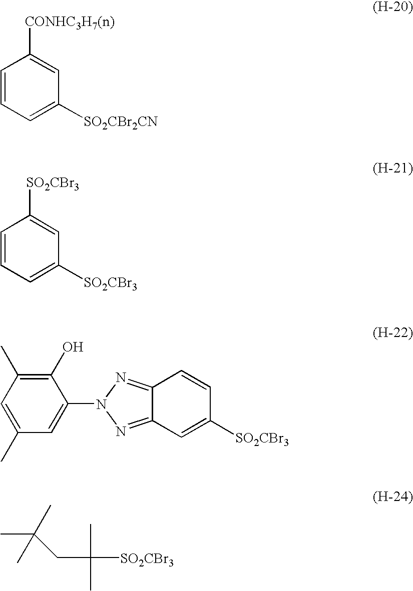

Preferably, the amount of the compound of formula (H) to be in the photothermographic material of the forty-fifth embodiment of the invention falls between 10⁻³ and 0.8 mols, more preferably between 10⁻³ and 0.1 mols, even more preferably between 5×10⁻³ and 0.05 mols per mol of the non-photosensitive organic silver salt in the image-forming layer of the material.

The amount of the polyhalogen compound to be added to the photothirmographic material of the forty-fifth embodiment of the invention in which is used a high silver iodide emulsion has a significant meaning. Especially preferably, therefore, the amount falls between 5×10⁻³ and 0.03 mols per mol of the non-photosensitive silver salt in the material.

The antifoggant may be incorporated into the photothermographic material of the invention in the same manner as that mentioned hereinabove for incorporating the reducing agent thereinto. Preferably, the organic polyhalogen compound is in the form of a fine solid particle dispersion when it is incorporated into the material.

<Other Antifoggants>

Other antifoggants usable herein are mercury(II) salts as in JP-A 11-65021, paragraph [0113]; benzoic acids as in JP-A 11-65021, paragraph [0114]; salicylic acid derivatives as in JP-A 2000-206642; formalin scavenger compounds of formula (S) in JP-A 2000-221634; triazine compounds claimed in claim 9 in JP-A 11-352624; compounds of formula (III) in JP-A 6-11791; and 4-hydroxy-6-methyl-1,3,3a,7-tetrazaindene.

The photothermographic material of the invention may also contain an azolium salt serving as an antifoggant.

The azolium salt includes, for example, compounds of formula (XI) in JP-A 59-193447, compounds as in JP-B 55-12581, and compounds of formula (II) in JP-A 60-153039.

The azolium salt may be present in any site of the photothermographic material, but is preferably in some layer on the surface of the material on which is present a photosensitive layer. More preferably, it is added to the organic silver salt-containing layer of the material.

Regarding the time at which the azolium salt is added to the material, it may be added to the coating liquid at any stage of preparing the liquid. In case where it is to be present in the organic silver salt-containing layer, the azolium salt may be added to any of the reaction system to prepare the organic silver salt or the reaction system to prepare the coating liquid at any stage of preparing them. Preferably, however, it is added to the coating liquid after the stage of preparing the organic silver salt and just before the stage of coating the liquid.

The azolium salt to be added may be in any form of powder, solution or fine particle dispersion. It may be added along with other additives such as sensitizing dye, reducing agent and toning agent, for example, in the form of their solution.

The amount of the azolium salt to be added to the photothermographic material of the invention is not specifically defined, but preferably falls between 1×10⁻⁶ mols and 2 mols, more preferably between 1×10⁻³ mols and 0.5 mols, per mol of silver in the material.

<Other Additives>

<<Mercapto, Disulfide and Thione Compounds>>

The photothermographic material of the invention may optionally contain any of mercapto compounds, disulfide compounds and thione compounds which are for retarding, promoting or controlling the developability of the material, or for enhancing the spectral sensitivity thereof, or for improving the storage stability thereof before and after development. For the additive compounds, for example, referred to are JP-A 10-62899, paragraphs [0067] to [0069]; compounds of formula (I) in JP-A 10-186572, and their examples in paragraphs [0033] to [0052]; EP Laid-Open 0803764A1, page 20, lines 36 to 56; and Japanese Patent Application No. 11-237670.

Above all, preferred are mercapto-substituted heteroaromatic compounds.

<Toning Agent>

Adding a toning agent to the photothermographic material of the invention is preferred. Examples of the toning agent usable herein are described in JP-A 10-62899, paragraphs [0054] to [0055], EP Laid-Open 0803764A1, page 21, lines 23 to 48; and JP-A 2000-356317; and Japanese Patent Application No. 2000-187298.

Preferred for use herein are phthalazinones (phthalazinone, phthalazinone derivatives and their metal salts, e.g., 4-(1-naphthyl)phthalazinone, 6-chlorophthalazinone, 5,7-dimethoxyphthalazinone, 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives and their salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); combinations of phthalazines and phthalic acids. More preferred are combinations of phthalazines and phthalic acids.

The amount of the phthalazines that may be added to the photothermographic material of the invention preferably falls between 0.01 mols and 0.3 mols, more preferably between 0.02 mols and 0.2 mols, even more preferably between 0.02 mols and 0.1 mols per mol of silver behenate in the material. The amount of the phthalazines added to the material has a significant meaning for solving the problems with the high silver iodide emulsion used herein, or that is, for improving the developability of the emulsion. Containing a suitably selected amount of the phthalazines, the photothermographic material of the invention satisfies the requirements of good developability and fogging resistance.

<<Plasticizer, Lubricant>>

Plasticizers and lubricants that may be in the photosensitive layer of the photothermographic material of the first embodiment of the invention are described in, for example, JP-A 11-65021, paragraph [0117]. Lubricants that may be in the layer are also described in JP-A 11-84573, paragraphs [0061] to [0064], and JP-A 11-106881, paragraphs [0049] to [0062].

<<Dye, Pigment>>

The photosensitive layer in the first embodiment of the invention may contain various types of dyes and pigments (e.g., C.I. Pigment Blue 60, C.I. Pigment Blue 64, C.I. Pigment Blue 15:6) for improving the image tone, for preventing interference fringes during laser exposure, and for preventing irradiation. The details of such dyes and pigments are described in, for example, W098/36322, and JP-A 10-268465 and 11-338098.

<<Super-hardener>>

For forming super-hard images suitable to printing plates, a super-hardener is preferably added to the image-forming layer of the photothermographic material. For such super-hardeners for forming super-hard images, methods of using them, and their amounts applicable to the invention, for example, referred to are JP-A 11-65021, paragraph [0118]; JP-A 11-223898, paragraphs [0136] to [0193]; compounds of formula (H), those of formulae (1) to (3) and those of formulae (A) and (B) in JP-A 2000-284399; compounds of formulae (III) to (V) in Japanese Patent Application No. 11-91652, especially concrete compounds in [Formula 21] to [Formula 24] therein. For hardening promoters also applicable to the invention, referred to are JP-A 11-65021, paragraph [0102]; and JP-A 11-223898, paragraphs [0194] to [0195].

In case where formic acid or its salt is used for a strong foggant in the invention, it may be added to the photosensitive silver halide-containing, image-forming layer of the material, and its amount is preferably at most 5 mmols, more preferably at most 1 mmol per mol of silver in the layer.

In case where a super-hardener is used in the photothermographic material of the first embodiment of the invention, it is preferably combined with an acid formed through hydration of diphosphorus pentoxide or its salt.

The acid to be formed through hydration of diphosphorus pentoxide and its salts include, for example, metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts).

For the acid to be formed through hydration of diphosphorus pentoxide and its salts, preferred for use herein are orthophosphoric acid (and its salts), and hexametaphosphoric acid (and its salts).

Concretely, their salts are sodium orthophosphate, sodium dihydrogen-orthophosphate, sodium hexametaphosphate, and ammonium hexametaphosphate.

The amount of the acid to be formed through hydration of diphosphorus pentoxide or its salt to be used herein (that is, the amount thereof to be in the unit area, one m², of the photothermographic material) may be any desired one and may be defined in any desired manner depending on the sensitivity, the fogging resistance and other properties of the material. Preferably, however, it falls between 0.1 and 500 mg/m², more preferably between 0.5 and 100 mg/m².

<Layer Constitution>

The photothirmographic material of the forty-fifth embodiment of the invention has, on a support, at least one image-forming layer that contains at least one organic silver salt and at least one silver halide, and having thereon at least one non-image-recording protective layer on the far side of the support relative to the image-forming layer.

In this, the non-image-recording protective layer (surface protective layer) is for preventing surface blocking of the image-forming layer, and it may have a single-layered structure or a multi-layered structure. The details of the surface protective layer are described, for example, in JP-A 11-65021, paragraphs [0119] to [0120], and Japanese Patent Application No. 2000-171936.

Gelatin is preferred for the binder in the non-image-recording protective layer (surface protective layer), but polyvinyl alcohol (PVA) is also usable for it. Combining the two for the binder is also preferred in the invention.

Gelatin for use herein may be inert gelatin (e.g., Nitta Gelatin 750), or gelatin phthalide (e.g., Nitta Gelatin 801).

For PVA usable herein, referred to are those described in JP-A 2000-171936, paragraphs [0009] to [0020]. Preferred for PVA for use herein are, for example, completely saponified PVA-105; partially saponified PVA-205, PVA-355; and modified polyvinyl alcohol, MP-203 (all commercial products of Kuraray). The polyvinyl alcohol content (per m² of the support) of one non-image-recoding protective layer (surface protective layer) preferably falls between 0.3 and 4.0 g/m², more preferably between 0.3 and 2.0 g/m².

In case where the photothermographic material of the invention is used in the field of printing that require high-level dimensional stability, it is desirable to use a polymer latex in the surface protective layer or the back layer of the material.

The polymer latex for that purpose is described in, for example, Synthetic Resin Emulsions (by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); and Chemistry of Synthetic Latexes (by Sohichi Muroi, the Polymer Publishing Association of Japan, 1970). Concretely, it includes, for example, methyl methacrylate (33.5 wt. %)/ethyl acrylate (50 wt. %)/methacrylic acid (16.5 wt. %) copolymer latex; methyl methacrylate (47.5 wt. %)/butadiene (47.5 wt. %)/itaconic acid (5 wt. %) copolymer latex; ethyl acrylate/methacrylic acid copolymer latex; methyl methacrylate (58.9 wt. %)/2-ethylhexyl acrylate (25.4 wt. %)/styrene (8.6 wt. %)/2-hydroxyethyl methacrylate (5.1 wt. %)/acrylic acid (2.0 wt. %) copolymer latex; and methyl methacrylate (64.0 wt. %)/styrene (9.0 wt. %)/butyl acrylate (20.0 wt. %)/2-hydroxycthyl methacrylate (5.0 wt. %)/acrylic acid (2.0 wt. %) copolymer latex.

For the binder for the non-image-recording protective layer (surface protective layer) in the invention, for example, referred to are the polymer latex combinations as in Japanese Patent Application No. 11-6872; the techniques as in Japanese Patent Application No. 11-143058, paragraphs [0021] to [0025]; the techniques as in Japanese Patent Application No. 11-6872, paragraphs [0027] to [0028]; and the techniques as in Japanese Patent Application No. 10-199626, paragraphs [0023] to [0041]. The ratio of the polymer latex in the surface protective layer preferably falls between 10% by weight and 90% by weight, more preferably between 20% by weight and 80% by weight of all the binder in the layer.

The overall binder content (including water-soluble polymer and latex polymer, per m² of the support) of one surface protective layer preferably falls between 0.3 and 5.0 g/m², more preferably between 0.3 and 2.0 g/m².

The temperature at which the coating liquid for the image-forming layer is prepared preferably falls between 30° C. and 65° C., more preferably between 35° C. and lower than 60° C., even more preferably between 35° C. and 55° C. Also preferably, the temperature of the coating liquid is kept between 30° C. and 65° C. immediately after a polymer latex is added thereto.

One or more image-forming layers are formed on one support to produce the photothermographic material of the invention. In case where the material has one image-forming layer, the layer must contain at least one organic silver salt and at least one photosensitive silver halide along with a reducing agent and a binder, and may contain optional additives such as a toning agent, a coating aid and other auxiliary agents. In case where the material has two or more image-forming layers, the first image-forming layer (in general, this is directly adjacent to the support) must contain an organic silver salt and a photosensitive silver halide, and the second image-forming layer or the two layers must contain the other ingredients.

The photothermographic material for multi-color expression of the invention may have combinations of these two layers for the respective colors, or may contain all the necessary ingredients in a single layer, for example, as in U.S. Pat. No. 4,708,928. For the photothermographic material of a type containing multiple dyes for multi-color expression, the individual emulsion layers are differentiated and spaced from the others via a functional or non-functional barrier layer between the adjacent emulsion layers, for example, as in U.S. Pat. No. 4,460,681.

The photosensitive layer of the photothermographic material of the invention may contain various types of dyes and pigments (e.g., C.I. Pigment Blue 60, C.I. Pigment Blue 64, C.I. Pigment Blue 15:6) for improving the image tone, for preventing interference fringes during laser exposure, and for preventing irradiation. The details of such dyes and pigments are described in, for example, W098/36322, and JP-A 10-268465, 11-338098.

The photothermographic material of the invention may have an antihalation layer remoter from the light source to which it is exposed than its photosensitive layer.

In general, the photothermographic material has non-photosensitive layers in addition to photosensitive layers. Depending on their positions, the non-photosensitive layers are classified into (1) a protective layer to be disposed on a photosensitive layer (remoter from the support than the photosensitive layer); (2) an interlayer to be disposed between adjacent photosensitive layers or between a photosensitive layer and a protective layer; (3) an undercoat layer to be disposed between a photosensitive layer and a support; (4) a back layer to be disposed on a support opposite to a photosensitive layer. The layers (1) and (2) are filter layers that are in the photothermographic material. The layers (3) and (4) are antihalation layers in the material.

The antihalation layers are described in, for example, JP-A 11-65021, paragraphs [0123] to [0124]; JP-A 11-223898,9-230531, 10-36695, 10-104779, 11-231457, 11-352625, 11-352626.

The antihalation layers contain an antihalation dye capable of absorbing the light to which the photothermographic material is exposed. In case where the photothermographic material is exposed to IR rays, IR-absorbing dyes may be used for antihalation. In that case, it is desirable that the dyes do not absorb visible light.

On the other hand, in case where visible light-absorbing dyes are used for antihalation, it is desirable that the dyes used are substantially decolored after image formation on the material, for which, for example, usable are decoloring agents that have the ability to decolor the dyes when heated in the step of thermal development. Preferably, a thermal decoloring dye and a base precursor are added to the non-photosensitive layers so that the layers containing them may function as antihalation layers. The details of this technique are described in, for example, JP-A 11-231457.

The amount of the decoloring dye to be added shall be determined, depending on the use of the dye. In general, its amount is so determined that the dye added could ensure an optical density (absorbance), measured at an intended wavelength, of larger than 1.0. The optical density preferably falls between 0.2 and 2. The amount of the dye capable of ensuring the optical density falling within the range may be generally from 0.001 to 1 g/m² or so.

Decoloring the dyes in the photothermographic material in that manner can lower the optical density of the material to 0.1 or less after thermal development. Two or more different types of decoloring dyes may be in the thermodecoloring recording material or the photothermographic material. Similarly, two or more different types of base precursors may be in the material.

In the thermodecoloring material of the type that contains a decoloring dye and a base precursor, it is desirable in view of the thermodecoloring ability of the material that the base precursor therein is combined with a substance which, when mixed with the base precursor, can lower the melting point of the mixture by at most 3° C. (e.g., diphenyl sulfone, 4-chlorophenyl(phenyl) sulfone), for example, as in JP-A 352626/1999.

In the invention, a coloring agent having an absorption maximum in the range falling between 300 and 450 nm may be added to the photothermographic material for improving the silver tone and the image stability of the material. The coloring agent is described in, for example, JP-A 62-210458, 63-104046, 63-1003235, 63-208846, 63-306436, 63-314535, 01-61745, and Japanese Patent Application No. 11-276751.

In general, the amount of the coloring agent to be added to the material falls between 0.1 mg/m² and 1 g/m². Preferably, it is added to the back layer that is opposite to the photosensitive layer of the material.

Preferably, the photothermographic material of the invention has, on one surface of its support, at least one photosensitive layer that contains a photosensitive silver halide emulsion, and has a back layer on the other surface thereof. This is referred to as a single-sided photothermographic material.

Also preferably, the photothermographic material of the invention contains a matting agent which is for improving the transferability of the material. Matting agents are described in JP-A 11-65021, paragraphs [0126] to [0127]. The amount of the matting agent to be added to the photothermographic material of the invention preferably falls between 1 and 400 mg/m², more preferably between 5 and 300 mg/m² of the material.

The degree to which the emulsion surface of the photothermographic material of the invention is matted is not specifically defined, so far as the matted layer surface is free from star dust trouble, but is preferably such that the Beck's smoothness of the matted surface could fall between 30 seconds and 2000 seconds, more preferably between 40 seconds and 1500 seconds. The Beck's smoothness is readily obtained according to JIS P8119 (method of testing surface smoothness of paper and paper boards with Beck tester), and to TAPPI Standard T479.

Regarding the matting degree of the back layer of the photothermographic material of the invention, the Beck's smoothness of the matted back layer preferably falls between 10 seconds and 1200 seconds, more preferably between 20 seconds and 800 seconds, even more preferably between 40 seconds and 500 seconds.

Preferably, the photothermographic material of the invention contains a matting agent in the outermost surface layer, or in a layer functioning as an outermost surface layer, or in a layer nearer to the outermost surface. Also preferably, it may contain a matting agent in a layer functioning as a protective layer.

The details of the back layer applicable to the invention are described in JP-A 11-65021, paragraphs [0128] to [0130].

Also preferably, the surface of the photothermographic material of the invention has a pH of at most 7.0, more preferably at most 6.6, before developed under heat. The lowermost limit of the pH is not specifically defined, but may be at least 3 or so. Most preferably, the pH range falls between 4 and 6.2.

For controlling the surface pH of the photothermographic material, employable are nonvolatile acids, for example, organic acids such as phthalic acid derivatives, or sulfuric acid, or nonvolatile bases such as ammonia. These are preferred as effective for reducing the surface pH of the material. Especially preferred for the surface pH-lowering agent is ammonia, as it is highly volatile, and therefore can be readily removed while the coating liquids containing it are coated and surely before thermal development.

Also preferred is combining ammonia with a nonvolatile base such as sodium hydroxide, potassium hydroxide or lithium hydroxide. For measuring the surface pH of the photothermographic materials, referred to is the description in Japanese Patent Application No. 11-87297, paragraph [0123].

A hardening agent may be added to the photosensitive layer, the surface protective layer, the back layer and other layers constituting the photothermographic material of the invention. The details of the hardening agent applicable to the invention are described in T. H. James' The Theory of the Photographic Process, 4th Ed. (Macmillan Publishing Co., Inc., 1977), pp. 77-87. For example, preferred for use herein are chromium alum, 2,4-dichloro-6-hydroxy-s-triazine sodium salt, N,N-ethylenebis(vinylsulfonacetamide), N,N-propylenebis(vinylsulfonacetamide); as well as polyvalent metal ions described on page 78 of that reference; polyisocyanates described in U.S. Pat. No. 4,281,060 and JP-A 6-208193; epoxy compounds described in U.S. Pat. No. 4,791,042; and vinylsulfone compounds described in JP-A 62-89048.

The hardening agent is added to the coating liquids in the form of its solution. The time at which the solution is added to the coating liquid for the protective layer may fall between 180 minutes before coating the liquid and a time just before the coating, preferably between 60 minutes before the coating and 10 seconds before it. However, there is no specific limitation thereon, so far as the method and the condition employed for adding the hardening agent to the coating liquid ensure the advantages of the invention.

Concretely for adding it, employable is a method of mixing a hardening agent with a coating liquid in a tank in such a controlled manner that the mean residence time for the agent as calculated from the amount of the agent added and the flow rate of the coating liquid to a coater could be a predetermined period of time; or a method of mixing them with a static mixer, for example, as in N. Harunby, M. F. Edwards & A. W. Nienow's Liquid Mixing Technology, Chap. 8 (translated by Koji Takahasi, published by Nikkan Kogyo Shinbun, 1989).

Surfactants applicable to the photothermographic material of the invention are described in JP-A 11-65021, paragraph [0132]; solvents applicable thereto are in the same but in paragraph [0133]; supports applicable thereto are in the same but in paragraph [0134]; antistatic and electroconductive layers applicable thereto are in the same but in paragraph [0135]; methods of forming color images applicable thereto are in the same but in paragraph [0136]; lubricants applicable thereto are in JP-A 11-84573, paragraphs [0061] to [0064] and JP-A 11-106881, paragraphs [0049] to [0062].

Next described are the supports for the photothermographic material of the invention.

For the transparent supports for the photothermographic material, preferred are biaxially-stretched films of polyesters, especially polyethylene terephthalate heated at a temperature falling between 130 and 185° C. The heat treatment is for removing the internal strain that may remain in the biaxially-stretched films and for preventing the film supports from being thermally shrunk during thermal development of the material.

In case where the photothermographic material of the invention is for medical treatment, the transparent support for it may be colored with a blue dye (for example, with Dye-1 used in the examples in JP-A 8-240877), or may not be colored. Preferably, the support of the photothermographic material of the invention is undercoated, for example, with a water-soluble polyester as in JP-A 11-84574; a styrene-butadiene copolymer as in JP-A 10-186565; or a vinylidene chloride copolymer as in JP-A 2000-39684 and Japanese Patent Application No. 11-106881, paragraphs [0063] to [0080].

For the antistatic layer and the undercoat layer to be formed in the invention, for example, referred to are the techniques disclosed in JP-A 56-143430, 56-143431, 58-62646, 56-120519, 11-84573, paragraphs [0040] to [0051]; U.S. Pat. No. 5,575,957; and JP-A 11-223898, paragraphs [0078] to [0084].

Preferably, the photothermographic material of the invention is of a monosheet type. The monosheet type does not require any additional sheet to receive images thereon, but may directly form images on itself.

The photothermographic material of the invention may optionally contain an antioxidant, a stabilizer, a plasticizer, a UV absorbent or a coating aid. Such additives may be in any of the photosensitive layers or the non-photosensitive layers of the material. For the additives, for example, referred to are W098/36322, EP 803764A1, JP-A 10-186567 and 10-18568.

<Fabrication of Photothermographic Material>

To fabricate the photothermographic material of the invention, the coating liquids may be applied onto a support in any desired manner. Concretely, various types of coating techniques are employable herein, including, for example, extrusion coating, slide coating, curtain coating, dipping, knife coating, and flow coating. Various types of hoppers for extrusion coating employable herein are described in U.S. Pat. No. 2,681,294. Preferred for the photothermographic material of the invention is extrusion coating or slide coating described in Stephen F. Kistler & Petert M. Schweizer's Liquid Film Coating (Chapman & Hall, 1997), pp. 399-536. More preferred is slide coating.

One example of the shape of a slide coater for slide coating is in FIG. 11b-1, on page 427 of that reference. If desired, two or more layers may be formed at the same time, for example, according to the methods described from page 399 to page 536 of that reference, or to the methods described in U.S. Pat. No. 2,761,791 and BP 837,095.

Preferably, the coating liquid for the organic silver salt-containing layer in the invention is a thixotropic flow. For it, referred to is the technique described in JP-A 11-52509.

Preferably, the coating liquid for the organic silver salt-containing layer in the invention has a viscosity falling between 400 mPa·s and 100,000 mPa·s, more preferably between 500 mPa·s and 20,000 mPa·s, at a shear rate of 0.1 sec⁻¹. Also preferably, the viscosity falls between 1 mPa·s and 200 mPa·s, more preferably between 5 mPa·s and 80 mPa·s, at a shear rate of 1000 sec⁻¹.

Other techniques applicable to the photothermographic material of the invention are, for example, in EP 803764A1, EP 883022A1, W098/36322; JP-A 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420; and Japanese Patent Application Nos. 2000-187298, 2000-10229, 2000-47345, 2000-206642, 2000-98530, 2000-98531, 2000-113059, 2000-112060, 2000-112104, 2000-112064, 2000-171936.

<Packaging Material for Photothermographic Material>

Preferably, the photothermographic material of the invention is wrapped with a material of low oxygen and/or moisture permeability for preventing its photographic properties from varying and for preventing it from curling or from having a curled habit while stored as raw films.

Preferred examples of the packaging material of low oxygen and/or moisture permeability for use herein are described, for example, in JP-A 8-254793, 2000-206653.

<Exposure and Thermal Development>

The photothermographic material of the invention may be developed in any manner. In general, after having been imagewise exposed, it is developed under heat. Preferably, the temperature for the development falls between 80 and 250° C., more preferably between 100 and 140° C. The time for the development preferably falls between 1 and 60 seconds, more preferably between 5 and 30 seconds, even more preferably between 10 and 20 seconds.

For thermal development for the material, preferred is a plate heater system. For the plate heater system for the material of the invention, preferred is the method described in JP-A 133572/1999. The plate heater system described therein is for thermal development of photothermographic materials, in which a photothermographic material having been exposed to have a latent image thereon is brought into contact with a heating unit in the zone for thermal development to thereby convert the latent image into a visible image. In this, the heating unit comprises a plate heater, and multiple presser rolls are disposed in series on one surface of the plate heater. The exposed photothermographic material is passed between the multiple pressure rolls and the plate heater, whereby it is developed under heat.

The plate heater is sectioned into 2 to 6 stages, and it is desirable that the temperature of the top stage is kept lower by 1 to 10° C. or so than that of the others. The system is also described in JP-A 54-30032. In the plate heater system, water and organic solvent that remain in the photothermographic material being processed can be removed out of the material. In this, in addition, the support of the photothermographic material rapidly heated is prevented from being deformed.

Laser rays are preferred for the light source to which the photothirmographic material of the forty-fifth embodiment of the invention is exposed. One problem with the high silver iodide emulsion which is preferably used in the invention is that its sensitivity is low. However, we, the present inventors have found that, when an image is written on the emulsion layer of the photothermographic material of the invention through exposure to high-intensity laser rays, the energy necessary for image formation thereon may be reduced. Accordingly, when an image is written on the layer through exposure to such strong light for a short period of time, the layer ensures the intended sensitivity.

On the surface of the photothermographic material, the quantity of light to which the material is exposed to form thereon an image having a maximum density preferably falls between 0.1 W/mm² and 100 W/mm², more preferably between 0.5 W/mm² and 50 W/mm², even more preferably between 1 W/mm² and 50 W/mm².

For the laser rays to which the material is exposed, preferred are gas lasers (Ar⁺, He—Ne), YAG lasers, color lasers, or semiconductor lasers. Also employable is a combination of semiconductor lasers and secondary harmonics generators. Above all, especially preferred for use in the invention are gas or semiconductor lasers for red to infrared emission.

Preferably, the peak wavelength of the laser rays falls between 600 nm and 900 nm, even more preferably between 620 nm and 850 nm.

Also preferred are laser rays of which the peak wavelength falls between 300 nm and 500 nm.

In addition, laser rays that multiply oscillate in the machine direction through high-frequency superimposition are also preferred for use in the invention.

One example of laser imagers for medical treatment equipped with an exposure unit and a thermal development unit that are applicable to the invention is Fuji Medical Dry Laser Imager FM-DP L. The system FM-DP L is described in Fuji Medical Review No. 8, pp. 39-55. Needless-to-say, the technique disclosed therein is applicable to laser imagers for the photothermographic material of the invention. In addition, the photothermographic material of the invention can be processed in the laser imager in the AD Network which Fuji Medical System has proposed for a network system under DICOM Standards.

The photothermographic material of the invention forms a monochromatic image based on silver, and is favorable for use in medical diagnosis, industrial photography, printing, and COM.

### EXAMPLES

Examples of First Embodiment

Hereinafter, a first embodiment of a photothermographic material according to the present invention will be explained in more detail with reference to examples. However, the first embodiment according to the invention is by no means limited to these examples.

### Example 1

Preparation of PET Support

PET with an intrinsic viscosity (IV) of 0.66 (measured in phenol/tetrachloroethane=6/4 (ratio by mass) at 25° C.) was obtained by a general procedure by using terephthalic acid and ethylene glycol. The thus-obtained PET was pelletized, dried at 130° C. for 4 hours, melted at 300° C., extruded from a T-die and rapidly cooled to obtain an unstretched film having a thickness of 175 μm on an after-heat-setting basis.

The film was then longitudinally stretched 3.3 times by using rollers which are different in a peripheral speed from each other and then transversely stretched 4.5 times by using a tenter. Temperatures applied in these cases were 110° C. and 130° C., respectively. Subsequently, the film was heat-set at 240° C. for 20 seconds, and then relaxed by 4% in the transverse direction at a same temperature. Thereafter, a portion chucked by the tenter was slit off and the film was knurled at both edges thereof and then taken up at a rate of 4 kg/cm² to obtain a rolled support having a thickness of 175 μm.

Surface Corona Treatment

Using a solid state corona treatment apparatus (model: 6KVA; available from Pillar Corporation), both surfaces of the support were subjected to a corona treatment at 20 m/minute at room temperature. Referring to read values of current and voltage, it was confirmed that the support was treated at 0.375 kVA·minute/m². Frequency for the treatment was 9.6 kHz and a gap clearance between an electrode and a dielectric roll was 1.6 mm.

Preparation of Undercoated Support

Preparation of Coating Liquid for Undercoat Layer

<Formulation 1: for Undercoat Layer on
Photosensitive Layer Side>

| | |
|---|---|
| “PESRESIN A-520” available from Takamatsu | 59 g |
| Oil & Fat Co., Ltd. (30 mass % solution) | |
| polyethylene glycol monononylphenyl ether | 5.4 g |
| (average ethylene oxide number: 8.5) 10 mass % solution | |
| “MP-1000” (polymer fine particles; average particle | 0.91 g |
| diameter: 0.4 μm) available from | |
| Soken Chemical & Engineering Co., Ltd.) | |
| distilled water | 935 ml |

<Formulation 2: for First Layer on Back Surface Side>

| | |
|---|---|
| styrene-butadiene copolymer latex (solid content: 40 mass %; | 158 g |
| a ratio of styrene/butadiene by mass: 68/32) | |
| 2,4-dichloro-6-hydroxy-S-triazine sodium salt | 20 g |
| (8 mass % aqueous solution) | |
| sodium laurylbenzene sulfonate (1 mass % aqueous solution) | 10 ml |
| distilled water | 854 ml |

<Formulation 3: for Second Layer on Back Surface Side>

| | |
|---|---|
| SnO₂/SbO (ratio by mass: 9/1; average particle dismeter: | 84 g |
| 0.038 μm; 17 mass % dispersion) | |
| gelatin (10 mass % aqueous solution) | 89.2 g |
| “METHOLLOSE TC-5” available from Shin-Etsu | 8.6 g |
| Chemical Co., Ltd. (2 mass % aqueous solution) | |
| “MP-1000” available from Soken Chemical & | 0.01 g |
| Engineering Co., Ltd. | |
| Sodium dodecylbenzene sulfonate (1 mass % aqueous solution) | 10 ml |
| NaOH (1 mass %) | 6 ml |
| “PROXEL” available from ICI Corporation | 1 ml |
| distilled water | 805 ml |

After both surfaces of the biaxially stretched polyethylene terephthalate film of 175 μm thick were individually subjected to the corona discharge treatment, the composition 1 of the coating liquid for undercoat was coated on one surface (photosensitive layer side) by using a wire bar in a wet coated amount of 6.6 ml/m² (for one side) and was allowed to dry at 180° C. for 5 minutes. The composition 2 of the coating liquid for undercoat was coated on a back surface by using a wire bar in a wet coated amount of 5.7 ml/m² and, then, allowed to dry at 180° C. for 5 minutes and, further, the composition 3 of the coating liquid for undercoat was coated on the back surface by using a wire bar in a wet coated amount of 7.7 ml/m² and, then, allowed to dry at 180° C. for 6 minutes, thereby to obtain an undercoated support.

Preparation of Coating Liquid for Back Surface

Preparation of Solid Fine Particle Dispersion (a) of Basic Precursor

1.5 kg of a basic precursor compound 1, 225 g of an surfactant (trade name: DEMOL-N; available from Kao Corporation), 937.5 g of diphenylsulfone and 15 g of parahydroxy benzoic acid butyl ester (trade name: Mekkinsu; available from Ueno Pharmaceutical Co., Ltd.) were mixed and, further, made up to be 5.0 kg in a total weight by being added with distilled water and, then, the resultant mixture was bead-dispersed by using a lateral sand mill (UVM-2; available from Aimex, Ltd.). As for a dispersion method, the mixture was fed to the UVM-2 filled with zirconia beads having an average diameter of 0.5 mm by using a diaphragm pump and dispersed under an inner pressure of 50 hPa or more until a desired average particle diameter was obtained.

Such dispersion processing has been performed until a dispersion in which, as a result of spectral absorption measurements, a ratio (D450/D650) of absorbance at 450 nm against that at 650 nm derived from spectral absorption of the dispersion was 2.2 or more was obtained. The thus-obtained dispersion was diluted with distilled water such that a concentration of the basic precursor was 20 mass %, filtered (using a filter made of polypropylene having an average pore diameter of 3 μm) to remove dust and put for practical use.

Preparation of Solid Fine Particle Dispersion of Dye 6.0 kg of a cyanine dye compound-1, 3.0 kg of sodium p-dodecylbenzene sulfonate, 0.6 kg of a surfactant DEMOL SNB available from Kao Corporation and 0.15 kg of an antifoaming agent (trade name: Surfynol 104E; available from Nissin Chemical Industry Co., Ltd.) were mixed and made up to be 60 kg in a total weight by being added with distilled water. The resultant mixture was dispersed by zirconia beads by using a lateral sand mill (UVM-2; available from Aimex, Limited).

Such dispersion processing has been performed until a dispersion in which, as a result of spectral absorption measurements, a ratio (D650/D750) of absorbance at 650 nm against that at 750 nm derived from spectral absorption of the dispersion was 5.0 or more was obtined. The thus-obtained dispersion was diluted with distilled water such that a concentration of the cyanine dye was 6 mass %, filtered (average pore diameter of filter: 1 μm) to remove dust and put for practical use.

Preparation of Coating Liquid for Anti-Halation Layer 30 g of gelatin, 24.5 g of polyacrylamide, 2.2 g of 1 mol/l caustic soda, 2.4 g of monodispersed polymethyl methacrylate fine particles (average particle size: 8 um; particle diameter standard deviation: 0.4), 0.08 g of benzoisothiazolinone, 35.9 g of the above-described solid fine particle dispersion of dye, 74.2 g of the above-described solid fine particle dispersion (a) of the basic precursor, 0.6 g of sodium polyethylenesulfonate, 0.21 g of a blue dye compound-1, 0.15 g of a yellow dye compound-1 and 8.3 g of acrylic acid/ethyl acrylate copolymerization latex (copolymerization ratio: 5/95) were mixed and made up to be 8183 ml in a total volume by being added with water, thereby to prepare a coating liquid for the anti-halation layer.

Preparation of Coating Liquid for Protective Layer on Back Surface

While keeping a temperature of a vessel at 40° C., 40 g of gelatin, 1.5 g of liquid paraffin emulsion in terms of liquid paraffin, 35 mg of benzoisothiazolinone, 6.8 g of 1 mol/l caustic soda, 0.5 g of sodium t-octylphenoxyethoxyethane sulfonate, 0.27 g of sodium polystyrene sulfonate, 37 mg of a fluorinated surfactant (F-1: N-perfluorooctylsulfonyl-N-propylalanine potassium salt), 150 mg of a fluorinated surfactant (F-2: polyethylene glycol mono(N-perfluorooctylsulfonyl-N-propyl-2-aminoethyl) ether [average degree of polymerization of ethylene oxide: 15], 64 mg of a fluorinated surfactant (F-3), 32 mg of a fluorinated surfactant (F-4), 6.0 g of acrylic acid/ethyl acrylate copolymer (copolymerization ratio by mass: 5/95) and 2.0 g of N,N-ethylenebis(vinyl sulfone acetamide) were mixed and made up to be 10 liter by being added with water, thereby to obtain a coating liquid for the protective layer on the back surface.

Preparation of Silver Halide Emulsion

<Preparation of Silver Halide Emulsion 1>

To 1,421 ml of water, added were 3.1 ml of a 1 mass % potassium bromide solution, 3.5 ml of a 0.5 mol/L concentration of sulfuric acid and 31.7 g of phthalized gelatin; while the resultant liquid was kept stirring in a stainless-steel reaction vessel at a constant liquid temperature of 35° C., was added thereto an entire volume of a solution A in which 22.22 g of silver nitrate was diluted by distilled water to be 195.6 ml and a solution B in which 13.7 g of potassium bromide and 2.6 g of potassium iodide were diluted by distilled water to be 218 ml at a constant flow rate over 45 seconds. Thereafter, the resultant solution was added with 10 ml of a 3.5 mass % aqueous hydrogen peroxide solution and, further, with 10.8 ml of a 10 mass % aqueous solution of benzoimidazole.

Further, was added thereto an entire volume of a solution C in which 51.86 g of silver nitrate was diluted with distilled water to be 317.5 ml and a solution D in which 31.9 g of potassium bromide and 6.1 g of potassium iodide were diluted with distilled water to be 600 ml such that an entire volume of the solution C was added thereto at a constant flow rate over 120 minutes and the solution D was added thereto by a controlled double jet method while a pAg thereof is kept at 8.1. Further, added thereto was an entire volume of potassium hexachloroiridate(III) 10 minutes after the solution C and the solution D started to be added so as to attain a concentration of 1×10⁻⁴ mol/mol of Ag. Furthermore, an entire volume of 3×10⁻⁴ mol/mol of Ag of an aqueous solution of potassium iron (II) hexacyanate was added 5 minutes after completion of such an addition of the solution C. At the point of time when the pH of the resultant mixture was adjusted to be 3.8 by using a 0.5 mol/L concentration of sulfuric acid, stirring is stopped and the resultant mixture was subjected to sedimentation/desalting/rinsing operations. Thereafter, the pH of the mixture was adjusted to be 5.9 by using a 1 mol/L concentration of sodium hydroxide to prepare a silver halide dispersion having a pAg of 8.0.

Subsequently, while the thus-prepared silver halide dispersion was kept stirring at 38° C., the dispersion was added with 5 ml of a 0.34 mass % methanol solution of 1,2-benzisothiazolin-3-one and, 40 minutes after such an addition, added with a methanol solution of mixture of a spectral sensitizing dye A and a spectral sensitizing dye B at a mixing ratio of 1:1 in an amount of 1.2×10⁻³ mol/mol of Ag and, one minute after the above addition, a temperature of the resultant dispersion was raised to 47° C. 20 minute after such temperature raising, the resultant dispersion was added with a methanol solution of sodium benzene thiosulfonate in an amount of 7.6×10⁻⁵ mol/mol of Ag and, further, 5 minutes after such an addition, added with a methanol solution of a tellurium sensitizer C in an amount of 2.9×10⁻⁴ mol/mol of Ag and, then, ripened for 91 minutes. Thereafter, the resultant dispersion was added with 1.3 ml of a 0.8 mass % methanol solution of N,N′-dihydroxy-N″-diethylmelamine and, 4 minutes after such an addition, added with a methanol solution of 5-methyl-2-mercaptobenzoimidazole in an amount of 4.8×10⁻³ mol/mol of Ag, a methanol solution of 1-phenyl-2-heptyl-5-mercapto-1,3,4-triazole in an amount of 5.4×10⁻³ mol/mol of Ag and an aqueous solution of a mercapto compound-2 in an amount of 1.5×10⁻² mol/mol of Ag, thereby to obtain a silver halide emulsion 1.

Particles contained in the thus-prepared silver halide emulsion were silver iodobromide particles uniformly containing 12 mol % of iodide having an average sphere-equivalent diameter of 0.042 μm and a sphere-equivalent coefficient of variation of 18%. On this occasion, a particle size and the like were determined based on an average of 1000 particles under an electron microscopic observation.

<Preparation of Mixed Emulsion A for Coating Liquid>

The silver halide emulsion 1 was dissolved and, then, added with a 1 mass % aqueous solution of benzothiazolium iodide in an amount of 7×10⁻³ mol/mol of Ag. Subsequently, the resultant emulsion was added with a compound expressed by a general formula (1) shown in Table 1 in an amount of 1×10⁻³ mol/mol of Ag and, further, added with water such that a content of silver halide becomes 38.2 g in terms of silver per kg of the mixed emulsion for coating liquid.

<Preparation of Fatty Acid Silver Dispersion>

87.6 kg of behenic acid (trade name: “Edenor C22-85R”; available from Henkel Corporation), 423 L of distilled water, 49.2 L of a 5 mol/L concentration of an aqueous NaOH solution and 120 L of t-butyl alcohol were mixed and, then, the resultant mixture was stirred at 75° C. for one hour to allow the mixture to react, thereby to obtain a sodium behenate solution. Separately, 206.2 L (pH 4.0) of an aqueous solution containing 40.4 kg of silver nitrate was prepared and kept at 10° C. A reaction vessel containing 635 L of distilled water and 30 L of t-butyl alcohol was kept at 30° C. and, then, was added with an entire volume of the thus-obtained sodium behenate solution and an entire volume of the aqueous silver nitrate solution each at a constant flow rate over 93 minutes and 15 seconds and over 90 minutes, respectively, while being thoroughly mixed.

On this occasion, only the aqueous silver nitrate solution was added in a first 11-minute period after the start of addition thereof and, then, the sodium behenate solution was started to be added and only the sodium behenate solution was added in a last 14-minute-and-15 second period after the end of addition of the aqueous silver nitrate solution. At this time, a temperature in the reaction vessel was kept at 30° C. and was controlled externally so as to keep the liquid temperature constant.

A piping in a feeding system of the sodium behenate solution was heated by circulating hot water in an outer portion of a double pipe and controlled such that an outlet liquid temperature at the end of the feed nozzle was 75° C. Further, A piping in a feeding system of the aqueous silver nitrate solution was cooled by circulating cold water in an outer portion of the double pipe. A point of addition of the sodium behenate solution and a point of addition of the aqueous silver nitrate solution were symmetrically arranged centered around a stirring axis and these points were adjusted high enough to prevent them from contacting the reaction solution.

After completion of such an addition of the sodium behenate solution, the resultant mixture was allowed to stand for 20 minutes under stirring with a temperature thereof unchanged, and, then, the temperature was elevated to 35° C. over 30 minutes and, thereafter, ripened for 210 minutes. Immediately after completion of such ripening, a solid content was separated by centrifugal filtration and, then, rinsed with water until electric conductivity of a filtrate became 30 μS/cm. Thus, a fatty acid silver salt was obtained. The thus-obtained solid content was stored in wet cake form without being dried.

When a state of the thus-obtained silver behenate particles was observed by a microscopic photographing, the obtained silver behenate particles were found to be a scaly crystal having average values of a=0.14 μm, b=0.4 μm and c=0.6 μm, an average aspect ratio of 5.2, an average sphere-equivalent diameter of 0.52 μm and a sphere-equivalent coefficient of variation of 15% (a, b and c being defined in this specification).

To the wet cake equivalent to dry weight of 260 kg, 19.3 kg of polyvinyl alcohol (trade name; “PVA-217”) was added and water was further added to make a total volume up to be 1000 kg and, then, the resultant mixture was changed into a slurry state by using a dissolver blade and, thereafter, preliminarily dispersed by using a pipeline mixer (“PM-10”; available from Mizuho Industrial Co., Ltd.).

Next, such a preliminarily dispersed stock solution was dispersed three times by using a dispersion apparatus (trade name: “Micro Fluidizer-M-610”; available from Micro Fluidex International Corporation) equipped with a Z type interaction chamber under a pressure of 1260 kg/cm², thereby to obtain a silver behenate dispersion. During the dispersion, cooling operation was performed such that coiled heat exchangers were attached each to an inlet and an outlet of the interaction chamber and a temperature of coolant was controlled to keep the dispersion temperature at 18° C.

Preparation of Reducing Agent Dispersion

<Preparation of Reducing Agent-1 Dispersion>

10 kg of a reducing agent-1, that is, 6,6′-di-t-butyl-4,4′-dimethyl-2,2′-butylidene diphenol and 16 kg of a 10 mass % aqueous solution of a modified polyvinylalcohol (“Poval MP203”; available from Kuraray Co., Ltd.) were added with 10 kg of water and, then, mixed thoroughly to prepare a slurry. The thus-prepared slurry was fed by using a diaphragm pump to a lateral sand mill (“UVM-2”; available from Aimex, Ltd.) filled with zirconia beads having an average diameter of 0.5 mm, dispersed for 3 hours and 30 minutes, added with 0.2 g of a benzoisothiazolinone sodium salt and water such that a concentration of the reducing agent was adjusted to be 25 mass %, thereby to obtain a reducing agent-2 dispersion. Reducing agent particles contained in the thus-obtained reducing agent dispersion were found to have a median diameter of 0.40 μm and a maximum particle diameter of 1.5 μm or less. The obtained reducing agent dispersion was filtered through a polypropylene filter having a pore diameter of 3.0 μm to separate dust or other foreign matters and then stored.

<Preparation of Hydrogen Bonding Type Compound-1 Dispersion>

10 kg of a hydrogen bonding type compound-1, that is, tri(4-t-butylphenyl)phosphine oxide and 16 kg of a 10 mass % aqueous solution of a modified polyvinylalcohol (“Poval MP203”; available from Kuraray Co., Ltd.) were added with 10 kg of water and, then, mixed thoroughly to prepare a slurry. The thus-prepared slurry was fed by using a diaphragm pump to a lateral sand mill (“UVM-2”; available from Aimex, Ltd.) filled with zirconia beads having an average diameter of 0.5 mm, dispersed for 3 hours and 30 minutes, added with 0.2 g of a benzoisothiazolinone sodium salt and water such that a concentration of the reducing agent was adjusted to be 25 mass %, thereby to obtain a hydrogen bonding type compound-1 dispersion. Reducing agent particles contained in the thus-obtained reducing agent dispersion were found to have a median diameter of 0.35 μm and a maximum particle diameter of 1.5 μm or less. The obtained hydrogen bonding type compound dispersion was filtered through a polypropylene filter having a pore diameter of 3.0 μm to separate dust or other foreign matters and then stored.

<Preparation of Development Accelerator-1 Dispersion>

10 kg of a development accelerator-1 and 20 kg of a 10 mass % aqueous solution of a modified polyvinylalcohol (Poval MP203; available from Kuraray Co., Ltd.) were added with 10 kg of water and, then, mixed thoroughly to prepare a slurry. The thus-prepared slurry was fed by using a diaphragm pump to a lateral sand mill (UVM-2; available from Aimex, Ltd.) filled with zirconia beads having an average diameter of 0.5 mm, dispersed for 3 hours and 30 minutes, added with 0.2 g of a benzoisothiazolinone sodium salt and water such that a concentration of the reducing agent was adjusted to be 20 mass %, thereby to obtain a development accelerator-1 dispersion. Reducing agent particles contained in the thus-obtained reducing agent dispersion were found to have a median diameter of 0.48 μm and a maximum particle diameter of 1.4 μm or less. The obtained reducing agent dispersion was filtered through a polypropylene filter having a pore diameter of 3.0 μm to separate dust or other foreign matters and then stored.

As for respective solid dispersions of a development accelerator-2, a development accelerator-3 and a color tone controlling agent-1, dispersion operations were performed in a same manner as in the development accelerator-1 to obtain respective 20 mass % dispersions.

Preparation of Polyhalogen Compound

<Preparation of Organic Polyhalogen Compound-1 Dispersion>

10 kg of an organic polyhalogen compoun-1, that is, tribromomethane sulfonylbenzene, 10 kg of a 20 mass % aqueous solution of a modified polyvinylalcohol (Poval MP203; available from Kuraray Co., Ltd.) and 0.4 kg of a 20 mass % aqueous solution of sodium triisopropylnaphthalene sulfonate were added with 14 kg of water and, then, mixed thoroughly to prepare a slurry. The thus-prepared slurry was fed by using a diaphragm pump to a lateral sand mill (UVM-2; available from Aimex, Ltd.) filled with zirconia beads having an average diameter of 0.5 mm, dispersed for 5 hours, added with 0.2 g of a benzoisothiazolinone sodium salt and water such that a concentration of an organic polyhalogen compound was adjusted to be 26 mass %, thereby to obtain an organic polyhalogen compound-1 dispersion. Organic polyhalogen compound particles contained in the thus-obtained polyhalogen compound dispersion were found to have a median diameter of 0.41 μm and a maximum particle diameter of 2.0 μm or less. The obtained organic polyhalogen compound dispersion was filtered through a polypropylene filter having a pore size of 3.0 μm to separate dust or other foreign matters and then stored.

<Preparation of Organic Polyhalogen Compound-2 Dispersion>

10 kg of an organic polyhalogen compound-2, that is, N-butyl-3-tribromomethane sulfonylbenzamide, 20 kg of a 10 mass % aqueous solution of a modified polyvinylalcohol (Poval MP203; available from Kuraray Co., Ltd.) and 0.4 kg of a 20 mass % aqueous solution of sodium triisopropylnaphthalene sulfonate were added to one another and, then, mixed thoroughly to prepare a slurry. The thus-prepared slurry was fed by using a diaphragm pump to a lateral sand mill (UVM-2; available from Aimex, Ltd.) filled with zirconia beads having an average diameter of 0.5 mm, dispersed for 5 hours, added with 0.2 g of a benzoisothiazolinone sodium salt and water such that a concentration of an organic polyhalogen compound was adjusted to be 30 mass %. The resultant dispersion was heated at 40° C. for 5 hours to obtain an organic polyhalogen compound-2 dispersion. Organic polyhalogen compound particles contained in the thus-obtained polyhalogen compound dispersion were found to have a median diameter of 0.40 μm and a maximum particle diameter of 1.3 μm or less. The obtained organic polyhalogen compound dispersion was filtered through a polypropylene filter having a pore size of 3.0 μm to separate dust or other foreign matters and then stored.

<Preparation of Phthalazine Compound-1 Solution>

8 kg of a modified polyvinyl alcohol MP203 (available from Kuraray Co., Ltd.) was dissolved in 174.57 kg of water and, then, added with 3.15 kg of a 20 mass % aqueous solution of sodium triisopropylnaphthalene sulfonate and 14.28 kg of a 70 mass % aqueous solution of a phthalazine compound-1, that is, 6-isopropylphthalazine, thereby to prepare a 5 mass % solution of the phthalazine compound-1.

Preparation of Mercapto Compound

<Preparation of Mercapto Compound-1 Aqueous Solution>

7 g of a mercapto compound-1, that is, a 1-(3-sufophehyl)-5-mercaptotetrazole sodium salt was dissolved in 993 g of water to prepare a 0.7 mass % aqueous solution.

<Preparation of Mercapto Compound-2 Aqueous Solution>

20 g of a mercapto compound-2, that is, a 1-(3-methylureido)-5-mercaptotetrazole sodium salt was dissolved in 980 g of water to prepare a 2.0 mass % aqueous solution.

<Preparation of Pigment-1 Dispersion>

64 g of C. I. Pigment Blue 60 and 6.4 g of DEMOL-N (available from Kao Corporation) were added with 250 g of water and, then, mixed thoroughly to prepare a slurry. The thus-prepared slurry was then fed into a vessel of a dispersion apparatus (1/4G Sand Grinder Mill; available from Aimex, Ltd.) together with 800 g of previously-prepared zirconia beads having an average diameter of 0.5 mm and, then, dispersed for 25 hours to obtain a pigment-1 dispersion. Pigment particles contained in the thus-obtained dispersion were found to have an average particle diameter of 0.21 μm.

<Preparation of SBR Latex Liquid>

SBR latex having a Tg of 22° C. was prepared in such a manner as described below.

70.0 mass of styrene, 27.0 mass of butadiene and 3.0 mass of acrylic acid were emulsion-polymerized by using ammonium persulfate as a polymerization initiator and an anionic surfactant as an emulsifier and, then, ripened at 80° C. for 8 hours. Thereafter, the resultant polymer solution was cooled down to 40° C., adjusted so as to have a pH of 7.0 by using ammonia water, added with Sandet-BL (available from Sanyo Chemical Industries) so as to attain a concentration of 0.22% and, then, further added with a 5% NaOH aqueous solution so as to adjust a pH of the solution to be 8.3 and, thereafter, with ammonia water so as to adjust a pH thereof to be 8.4. A molar ratio of Na⁺ ion: NH₄⁺ ion was 1: 2.3. Further, 0.15 ml of a 7% aqueous solution of a bonzoisothiazolinnone sodium salt, based on 1 kg of the resultant solution, was added to the resultant solution, thereby to prepare an SBR latex liquid.

SBR latex: -St(70.0)-Bu(27.0)-AA(3.0)-latex, Tg: 22° C.

an average particle diameter: 0.1 μm; a concentration: 43 mass %; an equilibrium water content at 25° C., 60%RH: 0.6 mass %; ion conductivity: 4.2 mS/cm (measured on a latex stock liquid (43 mass %) at 25° C. by using a conductometer CM-30S (available from Toa Electronics Ltd.); pH: 8.4.

An SBR latex having a different Tg can be prepared in a same manner as in the above-described preparation by appropriately changing a ratio of styrene and butadiene.

<Preparation of Coating Liquid-1 for Emulsion Layer (Photosensitive Layer)>

1000 g of the above-obtained fatty acid silver dispersion, 276 ml of water, 32.8 g of the pigment-1 dispersion, 21 g of the organinc polyhalogen compound-1 dispersion, 58 g of the organinc polyhalogen compound-2 dispersion, 173 g of the phthalazine compound-1 solution, 1082 g of the SBR latex (Tg: 20° C.) liquid; 155 g of the reducing agent-2 dispersion, 55 g of the hydrogen bonding type compound-1 dispersion, 6 g of the development accelerator-1 dispersion, 2 g of the development accelerator-2 dispersion, 3 g of the development accelerator-3 dispersion, 2 g of the color tone adjusting agent-1 dispersion, 9 ml of the mercapto compound-1 aqueous solution and 27 ml of the mercapto compound-2 aqueous solution were mixed in order of precedence and, then, 117 g of a silver halide mixed emulsion A was added to the resultant mixture just before it was applied and, thereafter, thoroughly mixed to obtain a coating liquid for the emulsion layer which was then directly fed to a coating die and applied.

Viscosity of the coating liquid for the emulsion layer was measured by using a B type viscometer (available from Tokyo Keiki K.K.) at 40° C. (with No. 1 rotor at 60 rpm) and found to be 40 mPa·s.

Viscosities of the coating liquid measured under shearing velocities of 0.1, 1, 10, 100 and 1,000 (1/second) at 25° C. by using RFS Fluid Spectrometer (available from Rheometrix Far East Inc.) were 530, 144, 96, 51 and 28 mPa·s, respectively.

A quantity of zirconium in the coating liquid was 0.25 mg based on 1 g of silver.

<Preparation of Coating Liquid for Intermediate Layer for Emulsion Surface>

A coating liquid for an intermediate layer was prepared by mixing 1000 g of polyvinyl alcohol PVA-205 (available from Kuraray Co., Ltd.), 272 g of a 5 mass % of a pigment, 4200 ml of a 19 mass % liquid of methyl methacrylate/styrene/butyl acrylate/hydroxyethyl methacrylate/acrylic acid copolymer (copolymerization ratio by mass of 64/9/20/5/2) latex and 27 ml of a 5 mass % aqueous solution of Aerosol OT (available from American Cyanamide Corporation), 135 ml of a 20 mass % aqueous solution of diammonium phthalate and, then, the thus-prepared coating liquid was added with water to make a total quantity thereof up to 10000 g and, thereafter, adjusting a pH of the thus-made up coating liquid to be 7.5 by NaOH. Then, the thus-prepared coating liquid for the intermediate layer was fed to a coating die so as to attain a coating amount of 9.1 ml/m².

Viscosity of the coating liquid measured at 40° C. using a B type viscometer (with No. 1 rotor at 60 rpm) was 58 mPa·s.

<Preparation of Coating Liquid for First Layer of Protective Layer for Emulsion Surface>

64 g of inert gelatin was dissolved in water and, then, added to the resultant solution were 80 g of a 27.5 mass % solution of methyl methacrylate/styrene/butylacrylate/hydroxyethyl methacrylate/acrylic acid copolymer (copolymerization ratio by mass of 64/9/20/5/2) latex, 23 ml of a 10 mass % methanol solution of phthalic acid, 23 ml of a 10 mass % aqueous solution of 4-methyl phthalic acid, 28 ml of a 0.5 mol/L concentration of sulfuric acid, 5 ml of a 5 mass % aqueous solution of Aerosol OT (available from American Cyanamide Corporation), 0.5 g of phenoxy ethanol and 0.1 g of benzoisothiazolinone, and, then, a total weight of the resultant coating liquid was made up to 750 g by adding water, thereby to prepare a coating liquid. The thus-prepared coating liquid was mixed with 26 ml of a 4 mass % chrome alum solution by using a static mixer immediately before the coating and fed to a coating die so as to attain a coating amount of 18.6 ml/m².

Viscosity of the coating liquid measured at 40° C. by using a B type viscometer (with No. 1 rotor at 60 rpm) was 20 mPa·s.

<Preparation of Coating Liquid for Second Layer of Protective Layer for Emulsion Surface>

80 g of inert gelatin was dissolved in water and, then, added to the resultant solution were 102 g of a 27.5 mass % solution of methyl methacrylate/styrene/butylacrylate/hydroxyethyl methacrylate/acrylic acid copolymer (copolymerization ratio by mass of 64/9/20/5/2) latex, 3.2ml of a 5 mass % solution of the fluorinated surfactant (F-1: N-perfluorooctylsulfonyl-N-propylalanine potassium salt), 32 ml of a 2 mass % aqueous solution of the fluorinated surfactant (F-2: polyethylene glycol mono(N-perfluorooctylsulfonyl-N-propyl-2-aminoethyl) ether [average degree of polymerization of ethylene oxide: 15], 23 ml of a 5 mass % solution of Aerosol OT (available from American Cyanamide Corporation), 4 g of polymethylmethacrylate fine particles (average particle diameter: 0.7 μm), 21 g of polymethylmethacrylate fine particles (average particle diameter: 4.5 μm), 1.6 g of 4-methylphthalic acid, 4.8 g of phthalic acid, 44 ml of a 0.5 mol/L concentration of sulfuric acid and 10 mg of benzoisothiazolinone, and, then, a total weight of the resultant coating liquid was made up to 650 g by adding water, thereby to prepare a coating liquid. The thus-prepared coating liquid was mixed with 445 ml of an aqueous solution containing 4 mass % of chrome alum solution and 0.67 mass % of phthalic acid by using a static mixer immediately before the coating and fed to a coating die so as to attain a coating amount of 8.3 ml/m².

Viscosity of the coating liquid measured at 40° C. by using a B type viscometer (with No. 1 rotor at 60 rpm) was 19 mPa·s.

<Preparation of Photothermographic Material-1>

On a back surface side of the above-described undercoated support, a coating liquid for an anti-halation layer and a coating liquid for a back surface protective layer were simultaneously applied in a stacked manner such that coating quantities of gelatin became 0.44 g/m² and 1.7 g/m², respectively and, then, dried to prepare a back surface layer.

On a surface opposite to the back surface, an emulsion layer, an intermediate layer, a first layer of a protective layer and a second layer of the protective layer were simultaneously coated in a stacked manner in this order as viewed from an undercoated surface by using a slide bead application method and dried, thereby to obtain a sample of the photothermographic material. At this time, temperatures of the emulsion layer and the intermediate layer were adjusted to be 31° C., while temperatures of the first layer of the protective layer and the first layer of the protective layer were adjusted to be 36° C. and 37° C., respectively.

Coated quantities (g/m²) of respective compounds in the emulsion layer are as follows:

| | |
|---|---|
| silver behenate | 5.55 |
| pigment (C. I. Pigment Blue 60) | 0.036 |
| polyhalogen compound-1 | 0.12 |
| polyhalogen compound-2 | 0.37 |
| phthalazine compound-1 | 0.19 |
| SBR latex | 9.97 |
| reducing agent-1 | 0.81 |
| hydrogen bonding type compound-1 | 0.30 |
| development accelerating agent-1 | 0.024 |
| development accelerating agent-2 | 0.010 |
| development accelerating agent-3 | 0.015 |
| color tone adjusting agent-1 | 0.010 |
| mercapto compound-1 | 0.002 |
| mercapto compound-2 | 0.012 |
| silver halide (in terms of Ag) | 0.091 |

Coating and drying conditions are as follows:

Coating was performed at a speed of 160 n/min while keeping a gap between an end of a coating die and a support to be from 0.10 mm to 0.30 mm and keeping a pressure in a reduced pressure chamber lower by from 196 Pa to 882 Pa than the atmospheric pressure. The support was blown with ion wind before the coating to cancel electricity.

Next, the coated liquid was cooled in a chilling zone by blowing wind having a dry-bulb temperature of from 10° C. to 20° C. and, then, transferred in a non-contact type manner and, thereafter, dried by a drying wind having a dry-bulb temperature of from 23° C. to 45° C. and a wet-bulb temperature of from 15° C. to 21° C. in a helical non-contact type drying apparatus.

After the coating liquid was dried, the thus-dried coating liquid was conditioned at 25° C., from 40% RH to 60% RH and, then, a surface of the resultant layer was heated up to from 70° C. to 90° C. and, subsequently, cooled down to 25° C.

A degree of matting expressed by Beck smoothness of the thus-prepared photothermographic material was found to be 550 seconds for the photosensitive layer side and 130 seconds for the back surface side. Further, a pH of the layer surface on a photosensitive layer side was measured and found to be 6.0.

Chemical structures of compounds used in embodiments according to the invention are shown below.

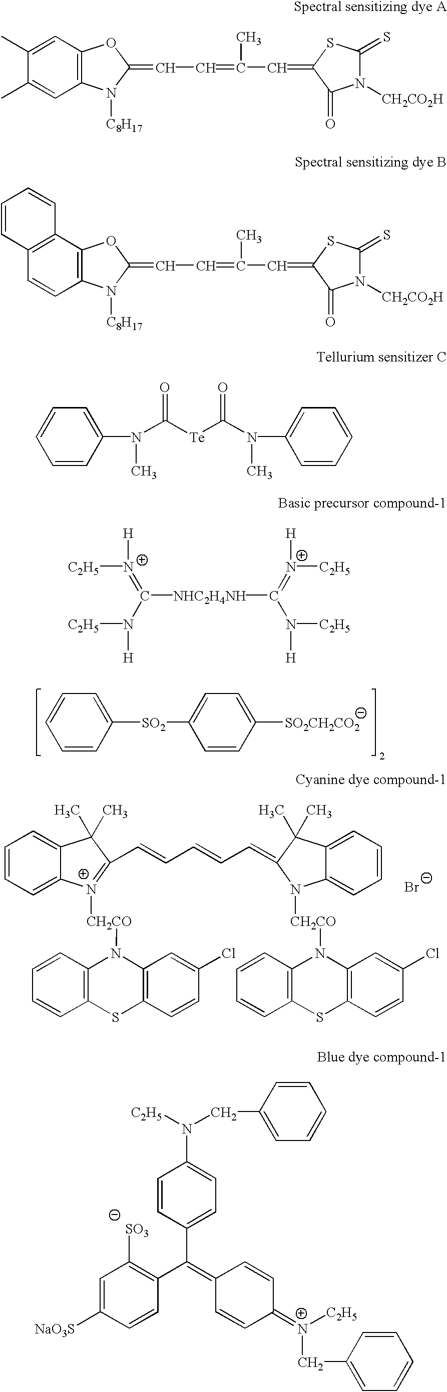

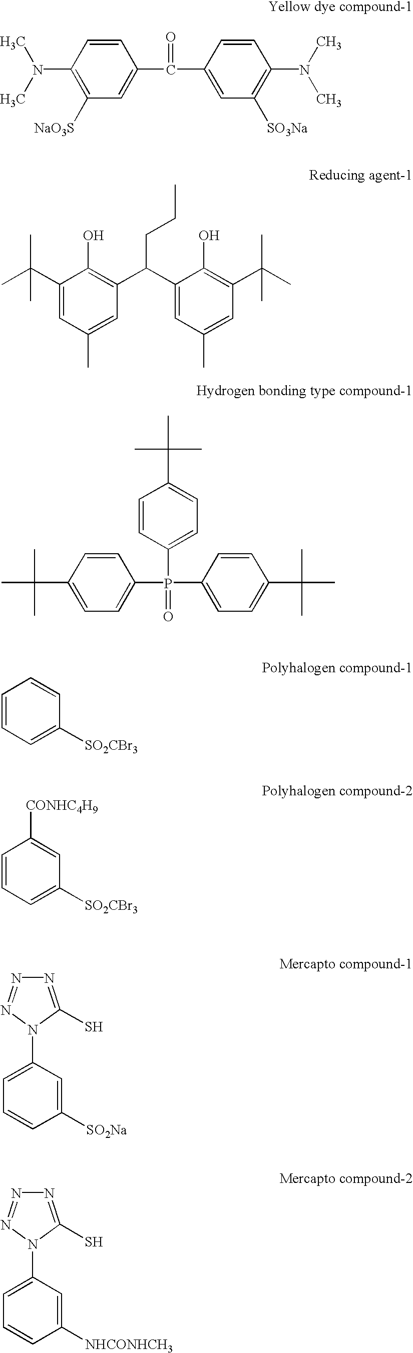

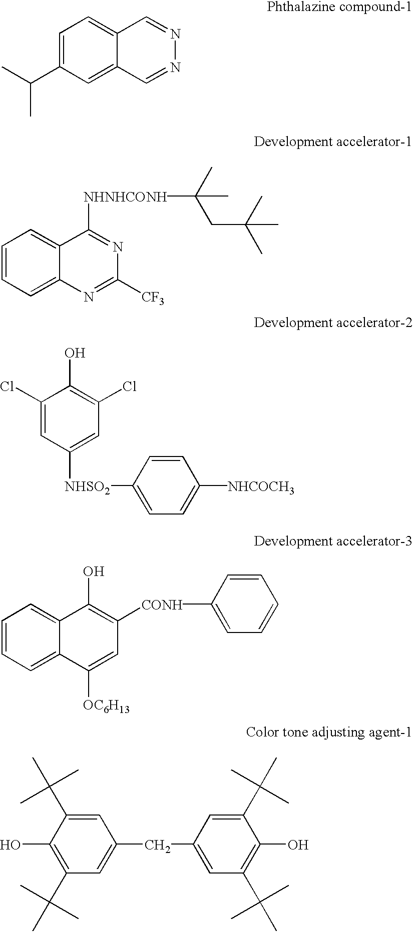

The obtained sample was cut into a half-cut size, packaged by a packaging material described below under an atmosphere of 25° C. and 50% RH and stored at normal temperature for 2 weeks.

Packaging Material

PET: 10 μm/PE: 12 μm/aluminum foil: 9 μm/Ny: 15 μm/polyethylene containing 3% of carbon: 50 μm;

oxygen permeability: 0.02 ml/atm·m²·25° C.·day; and water permeability: 0.10 g/atm·m²·25° C.·day.

<Preparation of photothermographic materials-2 to -8>

Silver halide emulsions-2 and -3 each having a uniform halogen composition as shown in Table 1 were prepared in a same manner as in preparation of silver halide emulsion 1 by changing respective halogen compositions to be added.

Silver halide having an average sphere-equivalent diameter of 0.040 μm as a particle size was prepared by changing a temperature at the time of particle formation.

The photothermographic materials-2 to -8 were prepared in a same manner as in the photothermographic material-1 except that compounds expressed by a general formula (1) were changed as shown in Table 1.

<Evaluation of Photothermographic Material>

The obtained samples were exposed by Fuji Medical Dry Laser Imager “FM-DPL” (equipped with a 660-nm semiconductor laser device having a maximum output of 60 mW (IIIB)) and thermally developed for 14 seconds in total by 4 panels constituting a panel heater in which respective temperatures were set to be 112° C., 119° C., 121° C. and 121° C., respectively.

Evaluation of Samples

Density measurements were performed on the obtained samples by using a densitometer to construct a characteristic curve of density against a logarithm of an exposure amount. An optical density of an unexposed portion was defined as fog and a reciprocal number of an exposure amount which can obtain an optical density of 3.0 was defined as sensitivity which was shown as a relative value when the sensitivity of the photothermographic material 1 was taken as 100. Further, an average contrast of an optical density of 1.5 and an optical density of 3.0 was measured. The results are shown in Table 1.

Evaluation of Print-Out Performance

The photothermographic material which has been subjected to development processing was left to stand in a room at 25° C. and 60% RH under a fluorescent lamp of 100 luxes for 30 days. A difference of a fog density just after the development processing and a fog density after such a 30-day left-over was defined as a print-out performance. It is preferable that the fog is increased to a small extent even after such left-over under these conditions. The results are shown in Table 1.

TABLE 1

| | | Average | | Compound of | | | | | |
|---|---|---|---|---|---|---|---|---|---|
| Photothermographic | Emulsion | Iodine | Particle | General | | | Average | Print- | |
| Material | No. | Content (%) | Size | Formula (I) | Sensitivity | Fog | Contrast | Out | Remarks |
| 1 | 1 | 12 | 40 nm | Chemical | 100 | 0.17 | 3.7 | 0.02 | Present |
| | | | | Formula I-1 | | | | | Invention |
| 2 | 1 | 12 | 40 nm | No | 25 | 0.17 | 3 | 0.02 | Comparison |
| 3 | 1 | 12 | 40 nm | Chemical | 97 | 0.18 | 3.5 | 0.02 | Present |
| | | | | Formula I-2 | | | | | Invention |
| 4 | 1 | 12 | 40 nm | Chemical | 95 | 0.17 | 3.3 | 0.02 | Present |
| | | | | Formula I-3 | | | | | Invention |
| 5 | 2 | 3.5 | 40 nm | No | 52 | 0.19 | 2.8 | 0.06 | Comparison |
| 6 | 2 | 3.5 | 40 nm | Chemical | 72 | 0.22 | 3.1 | 0.10 | Comparison |
| | | | | Formula I-1 | | | | | |
| 7 | 3 | 0 | 40 nm | No | 62 | 0.19 | 2.5 | 0.08 | Comparison |
| 8 | 3 | 0 | 40 nm | Chemical | 75 | 0.26 | 2.9 | 0.12 | Comparison |
| | | | | Formula I-1 | | | | | |

As is apparent from Table 1, it was found that the photothermographic material of the first embodiment according to the invention is excellent in print-out properties such that it has a high sensitivity, a low fog and a favorable gradation.

### Example 2

<Preparation of Silver Halide Emulsion 4>

To 1,421 ml of water, added were 4.3 ml of a 1 mass % potassium iodide solution, 3.5 ml of a 0.5 mol/L concentration of sulfuric acid and 36.7 g of phthalized gelatin; while the resultant liquid was kept stirring in a stainless-steel reaction vessel at a liquid temperature of 42° C., was added thereto an entire volume of a solution A in which 22.22 g of silver nitrate was diluted by distilled water to be 195.6 ml and a solution B in which 21.8 g of potassium iodide was diluted by distilled water to be 218 ml at a constant flow rate over 9 minutes.

Thereafter, the resultant solution was added with 10 ml of a 3.5 mass % aqueous hydrogen peroxide solution and, further, with 10.8 ml of a 10 mass % aqueous solution of benzoimidazole. Further, was added thereto an entire volume of a solution C in which 30.64 g of silver nitrate was diluted with distilled water to be 187.6 ml and a solution D in which 40.0 g of potassium bromide was diluted with distilled water to be 400 ml such that an entire volume of the solution C was added thereto at a constant flow rate over 12 minutes and the solution D was added by a controlled double jet method while pAg thereof is kept at 8.1.

Thereafter, was added thereto a solution E in which 22.2 g of silver nitrate was diluted with distilled water to be 130.0 ml and a solution Fto in which 21.7 g of potassium iodide was diluted with distilled water to be 217 ml by a controlled double jet method while a pAg is kept at 6.3.

Further, added thereto was an entire volume of potassium hexachloroiridate(III) 10 minutes after the solution C and the solution D started to be added so as to attain a concentration of 1×10⁻⁴ mol/mol of Ag. Furthermore, an entire volume of 3×10⁻⁴ mol/mol of Ag of an aqueous solution of potassium iron (II) hexacyanate was added thereto 5 seconds after completion of such an addition of the solution C.

Thereafter, a pH of the resultant mixture was adjusted to be 3.8 by using a 0.5 mol/L concentration of sulfuric acid, stirring was stopped and the resultant mixture was subjected to sedimentation/desalting/rinsing operations. Then, the pH of the mixture was adjusted to be 5.9 by using a 1 mol/L concentration of sodium hydroxide to prepare a silver halide dispersion having a pAg of 8.0.

While the thus-prepared silver halide dispersion was kept stirring at 38° C., the dispersion was added with 5 ml of a 0.34 mass % methanol solution of 1,2-benzisothiazolin-3-one and, one minute after the above addition, a temperature of the resultant dispersion was raised to 47° C. 20 minute after such temperature raising, the resultant dispersion was added with a methanol solution of sodium benzene thiosulfonate in an amount of 7.6×10⁻⁵ mol/mol of Ag and, further, 5 minutes after such an addition, added with a methanol solution of a tellurium sensitizer B in an amount of 2.9×10⁻⁴ mol/mol of Ag and, then, ripened for 91 minutes.

Thereafter, the resultant dispersion was added with 1.3 ml of a 0.8 mass % methanol solution of N,N′-dihydroxy-N″-diethylmelamine and, further 4 minutes after such an addition, added with a methanol solution of 5-methyl-2-mercaptobenzoimidazole in an amount of 4.8×10-³ mol/mol of Ag, a methanol solution of 1-phenyl-2-heptyl-5-mercapto-1,3,4-triazole in an amount of 5.4×10⁻³ mol/mol of Ag and an aqueous solution of a mercapto compound-2 in an amount of 1.5×10⁻² mol/mol of Ag to obtain a silver halide emulsion 1.

Particles contained in the thus-prepared silver halide emulsion were pure silver iodide particles having an average sphere-equivalent diameter of 0.042 μm and a sphere-equivalent coefficient of variation of 18%. On this occasion, a particle size and the like were determined based on an average of 1000 particles under an electron microscopic observation.

<Preparation of Silver Halide Emulsions 5 to 17>

Silver halide emulsions 5 to 17 each having a halogen structure as shown in Table 2 were prepared in a same manner as in <Preparation of Silver Halide Emulsion 4> except for a step of changing halogen compositions of the solutions B, D and F.

The silver halide was formed such that it has an average sphere-equivalent diameter of 0.04 μm as a particle size.

<Preparation of Silver Halide Emulsions 18 to 21>

Emulsions in each of which particles were formed in a same manner as in <Preparation of Silver Halide Emulsion 9> were added with an aqueous solution of potassium iodide such that they have respective average iodine compositions as shown in Table 2 and, then, subjected to sedimentation/desalting/rinsing operations to prepare silver halide emulsions 18 and 19. Silver halide emulsions 20 and 21 as shown in Table 2 were also prepared in a same manner as in <Preparation of Silver Halide Emulsion 6>.

Among these silver halide emulsions 5 to 21, emulsions which have a crystal structure of silver halide structure had an intense light absorption by direct transition.

TABLE 2

| | | | | | Direct Transition | |
|---|---|---|---|---|---|---|
| | Core | | | | Absorption | |
| | Iodine | First Shell | Second Shell | | Attributable to Silver | |
| Emulsion | Content | Iodine Content | Iodine Content | Average Iodine | Iodide Crystal | |
| No. | (%) | (%) | (%) | Quantity (%) | Structure | Particle Size |
| 4 | 100 | 100 | 100 | 100 | Yes | 40 nm |
| 5 | 95 | 95 | 95 | 95 | Yes | 40 nm |
| 6 | 40 | 40 | 40 | 40 | No | 40 nm |
| 7 | 10 | 10 | 10 | 10 | No | 40 nm |
| 8 | 3.5 | 3.5 | 3.5 | 3.5 | No | 40 nm |
| 9 | 0 | 0 | 0 | 0 | No | 40 nm |
| 10 | 0 | 0 | 100 | 30 | Yes | 40 nm |
| 11 | 0 | 100 | 0 | 40 | Yes | 40 nm |
| 12 | 0 | 100 | 100 | 70 | Yes | 40 nm |
| 13 | 100 | 0 | 0 | 30 | Yes | 40 nm |
| 14 | 100 | 100 | 0 | 70 | Yes | 40 nm |
| 15 | 0 | 0 | 40 | 8 | No | 40 nm |
| 16 | 0 | 40 | 0 | 12 | No | 40 nm |
| 17 | 40 | 0 | 0 | 8 | No | 40 nm |

| | | | | |
|---|---|---|---|---|
| 18 | Conversion Method | 10 | No | 40 nm |
| 19 | Conversion Method | 30 | No | 40 nm |
| 20 | Conversion Method | 60 | Yes | 40 nm |
| 21 | Conversion Method | 90 | Yes | 40 nm |

<Preparation of Photothermographic Materials-9 to -31>

Photothermographic materials-9 to -31 as shown in Table 3 were prepared in a same manner as in <Preparation of Photothermographic Materials-1> of Example 1 while compounds expressed by the general formula (1) are same as those in the photothermographic material-1.

The thus-prepared photothermographic materials were evaluated in such a manner as described below.

Exposure of Photothermographic material

The photothermographic materials obtained in Example 2 were subjected to exposure processing in such a manner as described below.

The photothermographic materials were exposed for 10⁻⁶ second by Fuji Medical Dry Laser Imager “FM-DPL” equipped with a semiconductor laser device “NLHV3000E” (available from Nichia Corporation) as a semiconductor laser beam supply in an exposure portion thereof while illuminance of laser beams on a surface of the photothermographic materials is allowed to change from 0 and 1 mW/mm² to 1000 mW/mm² by stopping down a beam diameter. An emission wavelength of the laser beams was 405 nm.

Development of Photothermographic Material

The thus-exposed photothermographic materials were subjected to thermal development processing in such a manner as described below.

In a thermal development portion of Fuji Medical Dry Laser Imager “FM-DPL”, temperatures of 4 panels which constitute a panel heater were set to be 112° C., 110° C., 110° C. and 110° C., respectively, and, then, the thermal development was performed such that a total thermal development time becomes 14 seconds by increasing a film transfer speed.

Evaluations of samples was performed in a same manner as in Example 1 and the results thereof are shown in Table 3.

TABLE 3

| | | | Direct Transition | | | | | | |
|---|---|---|---|---|---|---|---|---|---|
| | | Average | Absorption | | | | | | |
| | | Iodine | Attributable to | Compound of | | | | | |
| Photothermographic | Emulsion | Quantity | Silver Iodide | General | | | Average | Print- | |
| Material | No. | (%) | Crystal Structure | Formula (I) | Sensitivity | Fog | Contrast | out | Remarks |
| 9 | 4 | 100 | Yes | Chemical | 100 | 0.16 | 3.6 | 0.00 | Present |
| | | | | Formula I-1 | | | | | Invention |
| 10 | 4 | 100 | Yes | No | 25 | 0.17 | 3.0 | 0.00 | Comparison |
| 11 | 5 | 95 | Yes | Chemical | 98 | 0.17 | 3.5 | 0.01 | Present |
| | | | | Formula I-1 | | | | | Invention |
| 12 | 6 | 40 | No | Chemical | 64 | 0.17 | 3.4 | 0.02 | Present |
| | | | | Formula I-1 | | | | | Invention |
| 13 | 7 | 10 | No | Chemical | 42 | 0.18 | 3.3 | 0.03 | Present |
| | | | | Formula I-1 | | | | | Invention |
| 14 | 8 | 3.5 | No | Chemical | 36 | 0.25 | 3.0 | 0.10 | Comparison |
| | | | | Formula I-1 | | | | | |
| 15 | 8 | 3.5 | No | No | 22 | 0.18 | 2.8 | 0.06 | Comparison |
| 16 | 9 | 0 | No | Chemical | 41 | 0.26 | 2.8 | 0.12 | Comparison |
| | | | | Formula I-1 | | | | | |
| 17 | 10 | 30 | Yes | Chemical | 77 | 0.18 | 3.3 | 0.02 | Present |
| | | | | Formula I-1 | | | | | Invention |
| 18 | 11 | 40 | Yes | Chemical | 82 | 0.18 | 3.4 | 0.02 | Present |
| | | | | Formula I-1 | | | | | Invention |
| 19 | 12 | 70 | Yes | Chemical | 93 | 0.17 | 3.5 | 0.01 | Present |
| | | | | Formula I-1 | | | | | Invention |
| 20 | 12 | 70 | Yes | No | 37 | 0.17 | 3.0 | 0.01 | Comparison |
| 21 | 13 | 30 | Yes | Chemical | 74 | 0.18 | 3.3 | 0.02 | Present |
| | | | | Formula I-1 | | | | | Invention |
| 22 | 14 | 70 | Yes | Chemical | 92 | 0.17 | 3.5 | 0.01 | Present |
| | | | | Formula I-1 | | | | | Invention |
| 23 | 15 | 8 | No | Chemical | 42 | 0.19 | 3.2 | 0.03 | Present |
| | | | | Formula I-1 | | | | | Invention |
| 24 | 16 | 12 | No | Chemical | 52 | 0.18 | 3.3 | 0.03 | Present |
| | | | | Formula I-1 | | | | | Invention |
| 25 | 16 | 12 | No | No | 14 | 0.18 | 2.9 | 0.03 | Comparison |
| 26 | 17 | 8 | No | Chemical | 42 | 0.18 | 3.2 | 0.03 | Present |
| | | | | Formula I-1 | | | | | Invention |
| 27 | 18 | 10 | No | Chemical | 44 | 0.18 | 3.3 | 0.03 | Present |
| | | | | Formula I-1 | | | | | Invention |
| 28 | 19 | 30 | No | Chemical | 57 | 0.18 | 3.3 | 0.02 | Present |
| | | | | Formula I-1 | | | | | Invention |
| 29 | 20 | 60 | Yes | Chemical | 82 | 0.17 | 3.5 | 0.02 | Present |
| | | | | Formula I-1 | | | | | Invention |
| 30 | 21 | 90 | Yes | Chemical | 94 | 0.16 | 3.5 | 0.01 | Present |
| | | | | Formula I-1 | | | | | Invention |
| 31 | 21 | 90 | Yes | No | 28 | 0.17 | 3.5 | 0.01 | Comparison |

As is apparent from Table 3, it was found that the photothermographic materials according the invention shows an excellent performance also by a blue color laser exposure.

### Example 3

Pure silver halide emulsion 22 having an average particle size of 100 nm was prepared in a same manner as in <Preparation of Silver Halide Emulsion 4> of Example 2 except for a step of changing temperatures at the time of forming particles. Photothermographic materials 32, 33 and 34 as shown in Table 4 were prepared in a same manner as in the photothermographic material 9 of Example 2 except for a step of changing a quantity to be applied of the pure silver halide emulsion 22.

Photographic evaluations were performed in a same manner as in Example 2. On this occasion, a maximum optical density of samples after subjected to thermal development processing was designated as Dmax. The results are shown in Table 4.

TABLE 4

| | | | | | | Direct Transition | | | |
|---|---|---|---|---|---|---|---|---|---|
| | | | | Silver | Silver Halide | Absorption | | | |
| | | | | Halide | Quantity to be | Attributable to | | | |
| Photothermographic | Exposure | Iodine | Br | Particle | Applied | Silver Iodide | | | |
| Material | Condition | Content | Content | Size | (in terms of Ag) | Crystal Structure | Fog | Sensitivity | Dₘₐₓ |
| 1 | Laser | 100 | 0 | 40 nm | 0.091 mg/m² | Yes | 0.18 | 100 | 4.2 |
| | Exposure | | | | | | | | |
| | 405 nm | | | | | | | | |
| 32 | Laser | 100 | 0 | 100 nm | 0.091 mg/m² | Yes | 0.18 | Not Capable of | 2 |
| | Exposure | | | | | | | Performing | |
| | 405 nm | | | | | | | Evaluation Due | |
| | | | | | | | | to Absence of | |
| | | | | | | | | Density | |
| 33 | Laser | 100 | 0 | 100 nm | 0.18 mg/m² | Yes | 0.18 | 120 | 3.2 |
| | Exposure | | | | | | | | |
| | 405 nm | | | | | | | | |
| 34 | Laser | 100 | 0 | 100 nm | 0.36 mg/m² | Yes | 0.17 | 75 | 3.6 |
| | Exposure | | | | | | | | |
| | 405 nm | | | | | | | | |

As is apparent from Table 4, when an average particle size of the silver iodide emulsion was as low as 100 nm, the silver iodide emulsion can not attain a sufficient sensitivity, thereby to decrease Dmax. Ordinarily, since absorption of a silver halide is proportional to a third power of an average particle size, as a silver halide becomes larger in size, the silver halide is considered to have a higher sensitivity; however, it is not always true with a high silver iodide type emulsion according to the invention.

It is preferable that, by allowing the average particle size to be small, sensitivity is rather enhanced when a particle size is taken into consideration and, at the same time, Dmax is also enhanced.

### Example 4

A pure silver iodide emulsion 23 having an average particle size of 70 nm and a coefficient of variation of 8% was prepared in a same manner as in <Preparation of Silver Halide Emulsion 4> of Example 2 except for a step of elevating a temperature at the time of forming particles. In like manner, by changing temperatures at the time of forming particles, a pure silver iodide emulsion 24 having an average particle size of 28 nm and a coefficient of variation of 12% was prepared.

A photothermographic material 35 was prepared in a same manner as in Example 2 except that a mixture of the silver halide emulsions 4, 23 and 24 at a mixing ratio of 60:15:25 was added instead of the silver halide emulsion 4 in the photothermographic material-9. When same evaluations were performed as in Example 2, a favorable result was obtained. An average contrast of the photothermographic material 35 was 2.7.

In like manner, a photothermographic material 36 was prepared by mixing the silver halide emulsion 12 and the silver halide emulsion 23 at a mixing ratio of 85:15. Same evaluations as in Example 2 were performed. A favorable result was obtained.

Thus, the silver halide emulsions according to the first embodiment of the invention can be used by being mixed with each other at an arbitrary mixing ratio.

### Example 5

Silver halide emulsions 25 to 42 were prepared in a same manner as in <Preparation of Silver Halide Emulsions 4 to 21> of Example 2 except that, 3 minutes after the addition of the tellurium sensitizer, potassium iodooleate and potassium thiocyanate were added in amounts of 5×10⁻⁴ mol/mol of Ag and 2×10⁻³ mol/mol of Ag, respectively.

By using these emulsions, photothermographic materials 37 to 54 were prepared in a same manner as in the photothermographic material 9 of Example 2. As a result of performing same evaluations as those in Example 2, a favorable result that sensitivity was enhanced twofold while fog and print-out performances were not deteriorated was obtained.

### Example 6

A photothermographic material 55 was prepared in a same manner as in the photothermographic material 9 except that fluorine-type surfactants F-1, F-2, F-3 and F-4 in the protective layer for the back surface and the protective layer for the emulsion surface in the photothermographic material 9 of Example 2 were changed into F-5, F-6, F-7 and F-8.

When evaluations were performed in a same manner as in Example 2, a same favorable result as in the photothermographic material 9 was obtained.

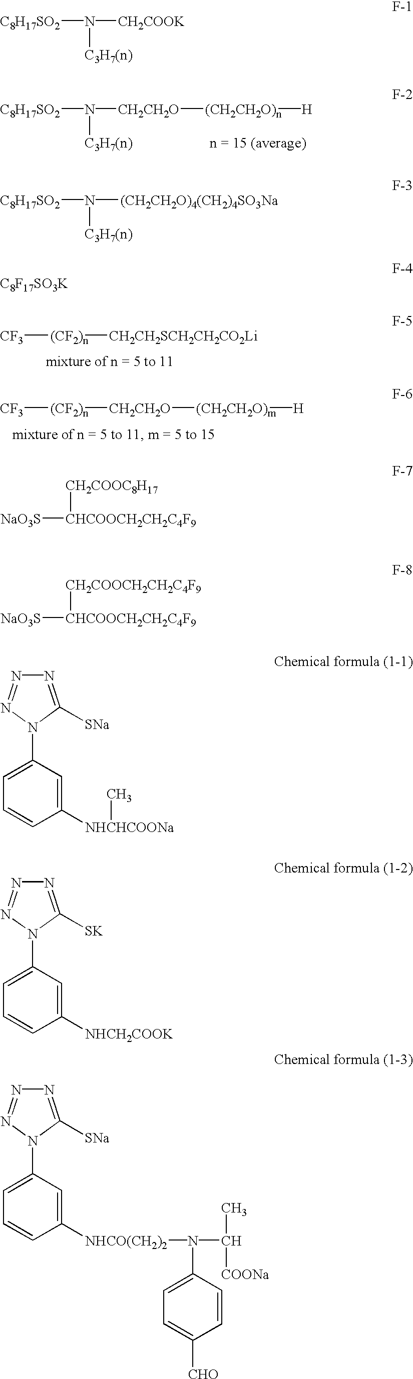

According to the present invention, the first embodiment of the photothermographic material, comprising a high silver iodide type photothermographic material, which has a high sensitivity and a high image quality, and a thermal development method using the photothermographic material can be provided.

Examples of Twelfth Embodiment

Next, a twelfth embodiment of a photothermographic material according to the present invention will be explained in more detail with reference to examples. However, the invention is by no means limited to these examples.

### Example 7

Preparation of Polyethylene terephthalate (PET) Support and Surface Corona Treatment

A polyethylene terephthalate (PET) support was prepared in a same manner as in Example 1 in the first embodiment of the photothermographic material according to the invention and the surface corona treatment was performed on the support in a same manner as in Example 1.

### Preparation of Undercoated Support

An undercoated support was prepared in a same manner and under same conditions as in Example 1.

Preparation of Coating Liquid for Back Surface

Preparation of Solid Fine Particle Dispersion (a) of Basic Precursor

A solid fine particle dispersion (a) of basic precursor was prepared in a same manner and under same conditions as in Example 1.

Preparation of Solid Fine Particle Dispersion of Dye

A solid fine particle dispersion of dye was prepared in a same manner and under same conditions as in Example 1.

Preparation of Coating Liquid for Anti-halation Layer

A coating liquid for an anti-halation layer was prepared in a same manner and under same conditions as in Example 1.

Preparation of Coating Liquid for Protective Layer for Back Surface

A coating liquid for a protective layer for a back surface was prepared in a same manner and under same conditions as in Example 1.

Preparation of Silver Halide Emulsion

<Preparation of Silver Halide Emulsion 1 a>

To 1,421 ml of water, added were 3.1 ml of a 1 mass % potassium bromide solution, 3.5 ml of a 0.5 mol/L concentration of sulfuric acid and 36.5 g of phthalized gelatin; while the resultant liquid was kept stirring in a stainless-steel reaction vessel at a constant liquid temperature of 30° C., was added thereto an entire volume of a solution A in which 22.22 g of silver nitrate was diluted with distilled water to be 95.4 ml and a solution B in which 15.3 g of potassium bromide and 0.8 g of potassium iodide were diluted with distilled water and made up to be 97.4 ml at a constant flow rate over 45 seconds. Thereafter, the resultant solution was added with 10 ml of a 3.5 mass % aqueous hydrogen peroxide solution and, further, with 10.8 ml of a 10 mass % aqueous solution of benzoimidazole. Further, was added thereto an entire volume of a solution C in which 51.86 g of silver nitrate was diluted with distilled water to be 317.5 ml and a solution D in which 44.2 g of potassium bromide and 2.2 g of potassium iodide were diluted with distilled water to be 400 ml such that an entire volume of the solution C was added thereto at a constant flow rate over 20 minutes and the solution D was added by a controlled double jet method while pAg thereof is kept at 8.1. At the point of time when the pH of the resultant mixture was adjusted to be 3.8 by using a 0.5 mol/L concentration of sulfuric acid, stirring is stopped and the resultant mixture was subjected to sedimentation/desalting/rinsing operations. Thereafter, the pH of the mixture was adjusted to be 5.9 by using a 1 mol/L concentration of sodium hydroxide to prepare a silver halide dispersion having a pAg of 8.0.

Subsequently, while the thus-prepared silver halide dispersion was kept stirring at 38° C., the dispersion was added with 5 ml of a 0.34 mass % methanol solution of 1,2-benzisothiazolin-3-one and, 20 minutes after such an addition, a temperature of the resultant dispersion was raised to 47° C. 20 minute after such temperature raising, the resultant dispersion was added with a methanol solution of sodium benzene thiosulfonate in an amount of 7.6×10⁻⁵ mol/mol of Ag and, further, 5 minutes after such an addition, added with a methanol solution of a tellurium sensitizer C in an amount of 3.5×10⁻⁴ mol/mol of Ag and, then, ripened for 91 minutes. The thus-ripened mixture was added with a methanol solution of mixture of a spectral sensitizing dye A and a spectral sensitizing dye B at a mixing ratio of 3:1 in an amount of 1.4×10⁻³ mol/mol of Ag as a total of the sensitizing dyes A and B. 5 minutes after such an addition, the resultant dispersion was added with 1.3 ml of a 0.8 mass % methanol solution of N,N′-dihydroxy-N″-diethylmelamine and, 4 minutes after such an addition, added with an aqueous solution of m-methylureido-3-phenyl-2-mercapto-1,3,4,5-tetrazole in an amount of 1.3×10⁻² mol/mol of Ag to obtain a silver halide emulsion 1a.

Particles contained in the thus-prepared silver halide emulsion 1a were silver iodobromide particles uniformly containing 3.5 mol % of iodine having an average sphere-equivalent diameter of 40 nm and a sphere-equivalent coefficient of variation of 20%. On this occasion, a particle size and the like were determined based on an average of 1000 particles under an electron microscopic observation. Such a particle had a {100} face proportion of 80% as determined by a Kubelka-Munk method.

<Preparation of Silver Halide Emulsions 2a>

A silver halide emulsion 2a was prepared in a same manner as in the silver halide emulsion 1a except that the liquid temperature of 30° C. at the time of forming particles in preparation of the silver halide emulsion 1a was changed into that of 35° C. and quantities of potassium bromide and potassium iodide were adjusted such that silver iodobromide particles uniformly contains 50 mol % of iodine. Particles contained in the thus-prepared silver halide emulsion 2 were such particles as have an average sphere-equivalent diameter of 40 nm and a sphere-equivalent coefficient of variation of 20%. Such a particle had a {100} face proportion of 82% as determined by the Kubelka-Munk method. A portion having a crystal structure of silver iodide had a light absorption by direct transition.

<Preparation of Silver Halide Emulsion 3a>

A silver halide emulsion 3a was prepared in a same manner as in the silver halide emulsion 1a except that the liquid temperature of 30° C. at the time of forming particles in preparation of the silver halide emulsion 1a was changed into that of 39° C. and quantities of potassium bromide and potassium iodide were adjusted such that silver iodobromide particles uniformly contains 85 mol % of iodine. Particles contained in the thus-prepared silver halide emulsion 3 were such particles as have an average sphere-equivalent diameter of 42 nm and a sphere-equivalent coefficient of variation of 20%. Such a particle had a {100} face proportion of 81% as determined by the Kubelka-Munk method. A portion having a crystal structure of silver iodide had a light absorption by direct transition.

<Preparation of Silver Halide Emulsion 4a>

When particles were prepared, such changes as described below were made in the preparation of silver halide emulsion la.

To 1,420 ml of distilled water, added were 4.3 ml of a 1 mass % potassium iodide solution, 3.5 ml of a 0.5 mol/L concentration of sulfuric acid and 36.5 g of phthalized gelatin; while the resultant liquid was kept stirring in a stainless-steel reaction vessel at a constant liquid temperature of 42° C., was added thereto an entire volume of a solution A in which 22.22 g of silver nitrate was diluted with distilled water to be 195.4 ml and a solution B in which 21.8 g of potassium iodide was diluted with distilled water to be 218 ml at a constant flow rate over 9 minutes. Thereafter, the resultant solution was added with 10 ml of a 3.5 mass % aqueous hydrogen peroxide solution and, further, with 10.8 ml of a 10 mass % aqueous solution of benzoimidazole. Further, was added thereto an entire volume of a solution C in which 51.86 g of silver nitrate was diluted with distilled water to be 317.5 ml and a solution D in which 60 g of potassium iodide was diluted with distilled water to be 600 ml such that an entire volume of the solution C was added thereto at a constant flow rate over 120 minutes and the solution D was added by a controlled double jet method while a pAg thereof is kept at 8.1. A silver halide emulsion 4a was prepared in a same manner as in the silver halide emulsion 1a except for the above-described changes. Particles contained in the thus-prepared silver halide emulsion 4a were pure silver iodide particles that have an average sphere-equivalent diameter of 41 nm and a sphere-equivalent coefficient of variation of 18%. Such a particle had a {100} face proportion of 81% as determined by the Kubelka-Munk method. A portion having a crystal structure of silver iodide had a light absorption by direct transition.

<Preparation of Silver Halide Emulsions 5a to 26a>

In the preparation of silver halide emulsions 1a to 4a, an aqueous solution of metal complex was previously added to the solution C such that a concentration as shown in Table 5 is prepared and, then, the resultant solution C and the solution D were added to form particles whereupon silver halide emulsions 5a to 26a were obtained.

A halogen composition, a quantity of the aqueous solution of the metal complex to be added and affirmative or negative (Yes or No) of direct transition absorption of a photosensitive silver halide are shown in Table 5.

TABLE 5
Table of Emulsions To Be Used

| | Halogen | | | Direct transition | |
|---|---|---|---|---|---|
| Emulsion | Composition | | Quantity to be Added | Absorption Attributable | |
| No. | AgBrIx X= | Metal | mol/molAg | to AgI Crystal Structure | Remarks |
| 1a | 3.5 | — | — | No | Comparative Example |
| 2a | 50 | — | — | Yes | Comparative Example |
| 3a | 85 | — | — | Yes | Comparative Example |
| 4a | 100 | — | — | Yes | Comparative Example |
| 5a | 3.5 | I′-1 | 1 × 10⁻³ | No | Comparative Example |
| 6a | 3.5 | I′-7 | 1 × 10⁻³ | No | Comparative Example |
| 7a | 50 | I′-1 | 1 × 10⁻³ | No | Present Invention |
| 8a | 50 | I′-7 | 1 × 10⁻³ | No | Present Invention |
| 9a | 85 | I′-1 | 1 × 10⁻³ | No | Present Invention |
| 10a | 85 | I′-7 | 1 × 10⁻³ | No | Present Invention |
| 11a | 100 | I′-1 | 1 × 10⁻³ | No | Present Invention |
| 12a | 100 | I′-1 | 1 × 10⁻⁶ | No | Present Invention |
| 13a | 100 | I′-7 | 1 × 10⁻³ | No | Present Invention |
| 14a | 100 | I′-7 | 1 × 10⁻⁶ | No | Present Invention |
| 15a | 100 | I′-22 | 1 × 10⁻³ | No | Present Invention |
| 16a | 100 | I′-22 | 1 × 10⁻⁶ | No | Present Invention |
| 17a | 100 | I′-36 | 1 × 10⁻³ | No | Present Invention |
| 18a | 100 | I′-36 | 1 × 10⁻⁶ | No | Present Invention |
| 19a | 100 | I′-27 | 1 × 10⁻³ | No | Present Invention |
| 20a | 100 | I′-27 | 1 × 10⁻⁶ | No | Present Invention |
| 21a | 100 | I′-55 | 1 × 10⁻³ | No | Present Invention |
| 22a | 100 | I′-55 | 1 × 10⁻⁶ | No | Present Invention |
| 23a | 100 | I′-82 | 1 × 10⁻³ | No | Present invention |
| 24a | 100 | I′-82 | 1 × 10⁻⁶ | No | Present invention |
| 25a | 100 | I′-95 | 1 × 10⁻³ | No | Present invention |
| 26a | 100 | I′-95 | 1 × 10⁻⁶ | No | Present invention |

<Preparation of Emulsion for Coating Liquid>

The silver halide emulsions 1a to 26a were dissolved and, then, added with a 1 mass % aqueous solution of benzothiazolium iodide in an amount of 7×10⁻³ mol/mol of Ag. Subsequently, the resultant emulsion was added water such that a content of silver halide becomes 38.2 g in terms of silver per kg of the emulsion for coating liquid for an emulsion layer.

<Preparation of Fatty Acid Silver Dispersion A>

87.6 kg of behenic acid (trade name: “Edenor C22-85R”; available from Henkel Corporation), 423 L of distilled water, 49.2 L of a 5 mol aqueous NaOH solution and 120 L of t-butyl alcohol were mixed and, then, the resultant mixture was stirred at 75° C. for one hour to allow the mixture to react, thereby to obtain a sodium behenate solution A. Separately, 206.2 L (pH 4.0) of an aqueous solution containing 40.4 kg of silver nitrate was prepared and kept at 10° C. A reaction vessel containing 635 L of distilled water and 30 L of t-butyl alcohol was kept at 30° C. and, then, was added with an entire volume of the sodium behenate solution A and an entire volume of the aqueous silver nitrate solution at constant flow rates over 93 minutes and 15 seconds and over 90 minutes, respectively. On this occasion, only the aqueous silver nitrate solution was added in a first 11-minute period after the start of the addition thereof and, then, the sodium behenate solution A was started to be added and only the sodium behenate solution A was added in a last 14-minute-and-15 second period after the end of addition of the aqueous silver nitrate solution. At this time, a temperature in the reaction vessel was kept at 30° C. and was controlled externally so as to keep the liquid temperature constant. Further, a piping in a feeding system of the sodium behenate solution A was heated by circulating hot water in an outer portion of a double pipe and controlled such that an outlet liquid temperature at the end of the feed nozzle was 75° C. Further, A piping in a feeding system of the aqueous silver nitrate solution was cooled by circulating cold water in an outer portion of the double pipe. A point of addition of the sodium behenate solution A and a point of addition of the aqueous silver nitrate solution were symmetrically arranged centered around a stirring axis and height of these points was adjusted so as to prevent them from contacting the reaction solution.

After completion of the addition of the sodium behenate solution A, the resultant mixture was allowed to stand for 20 minutes under stirring with a temperature thereof unchanged, and, then, the temperature was elevated to 35° C. over 30 minutes and, thereafter, the mixture was ripened for 210 minutes. Immediately after completion of such ripening, a solid content was separated by centrifugal filtration and, then, rinsed with water until electric conductivity of a filtrate became 30 μS/cm. Thus, a fatty acid silver salt was obtained. The thus-obtained solid content was stored in wet cake form without being dried.

When a state of the thus-obtained silver behenate particles was observed by a microscopic photographing, the obtained silver behenate particles were found to be a scaly crystal having average values of a=0.14 μm, b=0.4 μm and c=0.6 μm, an average aspect ratio of 5.2, an average sphere-equivalent diameter of 0.52 μm and a sphere-equivalent coefficient of variation of 15% (a, b and c being defined in this specification).

To the wet cake equivalent to dry weight of 260 kg, 19.3 kg of polyvinyl alcohol (trade name; “PVA-217”) was added and water was further added to make a total volume up to be 1000 kg and, then, the resultant mixture was changed into a slurry state by using a dissolver blade and, thereafter, preliminarily dispersed by using a pipeline mixer (“PM-10” type; available from Mizuho Industrial Co., Ltd.).

Next, such a preliminarily dispersed stock solution was treated three times by a dispersion apparatus (trade name: “Micro Fluidizer-M-610”; available from Micro Fluidex International Corporation) equipped with a Z type interaction chamber under a pressure of 1260 kg/cm², thereby to obtain a silver behenate dispersion. During the dispersion, cooling operation was performed such that coiled heat exchangers were attached each to an inlet and an outlet of the interaction chamber and a temperature of coolant was controlled to keep the dispersion temperature at 18° C.

Preparation of Reducing Agent Dispersion

<Preparation of Reducing Agent Complex-1 Dispersion>

10 kg of a reducing agent complex-1, that is, a 1:1 complex of 6,6′-di-t-butyl-4,4′-dimethyl-2,2′-butylidene diphenol and triphenyl phosphine oxide, 0.12 kg of triphenyl phosphine oxide and 16 kg of a 10 mass % aqueous solution of a modified polyvinylalcohol (“Poval MP203”; available from Kuraray Co., Ltd.) were added with 10 kg of water and, then, thoroughly mixed to prepare a slurry. The thus-prepared slurry was fed by using a diaphragm pump to a lateral sand mill (“UVM-2”; available from Aimex, Ltd.) filled with zirconia beads having an average diameter of 0.5 mm, dispersed for 4 hours and 30 minutes, added with 0.2 g of a benzoisothiazolinone sodium salt and water such that a concentration of the reducing agent was adjusted to be 22 mass %, thereby to obtain a reducing agent complex-1 dispersion. Reducing agent complex particles contained in the thus-obtained reducing agent complex dispersion were found to have a median diameter of 0.45 μm and a maximum particle diameter of 1.4 μm or less. The obtained reducing agent complex dispersion was filtered through a polypropylene filter having a pore diameter of 3 μm to separate dust or other foreign matters and then stored.

<Preparation of Development Accelerator-1 Dispersion>

A development accelerator-1 dispersion was prepared in a same manner and under same conditions as in Example 1.

As for respective solid dispersions of a development accelerator-2, a development accelerator-3 and a color tone controlling agent-1, dispersion operations were performed in a same manner as in the development accelerator-1 to obtain respective 20 mass % dispersions.

Preparation of Polyhalogen Compound

<Preparation of Organic Polyhalogen Compound-1 Dispersion>

An organic polyhalogen compound-1 dispersion was prepared in a same manner and under same conditions as in Example 1.

<Preparation of Organic Polyhalogen Compound-2 Dispersion>

An organic polyhalogen compound-2 dispersion was prepared in a same manner and under same conditions as in Example 1.

<Preparation of Phthalazine Compound-1 Solution>

A phthalazine compound-1 solution was prepared in a same manner and under same conditions as in Example 1.

Preparation of Mercapto Compound

<Preparation of Mercapto Compound-1 Aqueous Solution>

A mercapto compound-1 aqueous solution was prepared in a same manner and under same conditions as in Example 1.

<Preparation of Mercapto Compound-2 Aqueous Solution>

A mercapto compound-2 aqueous solution was prepared in a same manner and under same conditions as in Example 1.

<Preparation of Pigment-1 Dispersion>

A pigment-1 dispersion was prepared in a same manner and under same conditions as in Example 1.

<Preparation of SBR Latex Liquid>

An SBR latex liquid was prepared in a same manner and under same conditions as in Example 1.

<Preparation of Coating Liquid-1a for Emulsion Layer (Photosensitive Layer)>

1000 g of the above-obtained organic acid silver dispersion A, 276 ml of water, 33.2 g of the pigment-1 dispersion, 21 g of the organinc polyhalogen compound-1 dispersion, 58 g of the organinc polyhalogen compound-2 dispersion, 173 g of the phthalazine compound-1 solution, 1082 g of the SBR latex (Tg: 22° C.) liquid; 299 g of the reducing agent complex-1 dispersion, 6 g of the development accelerator-1 dispersion, 9 ml of the mercapto compound-1 aqueous solution and 27 ml of the mercapto compound-2 aqueous solution were mixed in order of precedence and, then, 117 g of silver halide emulsion 1a was added to the resultant mixture just before it was applied and, thereafter, thoroughly mixed to obtain a coating liquid for the emulsion layer which was then directly fed to a coating die, and a sample 7-1 was applied. Coating liquids in which emulsions 2a to 26a were used instead of the emulsion 1a respectively were provided for preparing samples 7-2 to 7-26.

Viscosity of the coating liquid for the emulsion layer was measured by using a B type viscometer (available from Tokyo Keiki K.K.) at 40° C. (with No. 1 rotor at 60 rpm) and found to be 25 mPa·s.

Viscosities of the coating liquid measured under shearing velocities of 0.1, 1, 10, 100 and 1,000 (1/second) at 25° C. by using RFS Fluid Spectrometer (available from Rheometrix Far East Inc.) were 230, 60, 46, 24 and 18 mPa·s, respectively.

A quantity of zirconium present in the coating liquid was 0.38 mg/g Ag.

<Preparation of Coating Liquid for Intermediate Layer on Emulsion Surface>

A coating liquid for an intermediate layer on an emulsion surface was prepared in a same manner and under same conditions as in Example 1.

<Preparation of Coating Liquid for First Layer of Protective Layer on Emulsion Surface>

A coating liquid for a first layer of a protective layer on an emulsion surface was prepared in a same manner and under same conditions as in Example 1.

<Preparation of Coating Liquid for Second Layer of Protective Layer on Emulsion Surface>

A coating liquid for a second layer of a protective layer on an emulsion surface was prepared in a same manner and under same conditions as in Example 1.

<Preparation of Photothermographic Material-1a>

On a back surface side of the above-described undercoated support, a coating liquid for an anti-halation layer and a coating liquid for a back surface protective layer were simultaneously applied in a stacked manner such that coating quantities of gelatin became 0.44 g/m² and 1.7 g/m², respectively and, then, dried to prepare a back layer.

On a surface opposite to the back surface, an emulsion layer, an intermediate layer, a first layer of a protective layer and a second layer of the protective layer were simultaneously coated in a stacked manner in this order as viewed from an undercoated surface by using a slide bead application method and dried, thereby to obtain a sample of the photothermographic material; on this occasion, a sample prepared by using the coating liquid-1a for the emulsion layer was designated as a sample 7-1 while samples prepared by using the coating liquid-1 for the emulsion layer but by changing the emulsion-1a contained therein into emulsions 2a to 26a respectively were designated as samples 7-2 to 7-26, respectively. At this time, temperatures of the emulsion layer and the intermediate layer were adjusted to be 31° C., and temperatures of the first layer of the protective layer and the first layer of the protective layer were adjusted to be 36° C. and 37° C., respectively.

Coated quantities (g/m²) of respective compounds in the emulsion layer are as follows:

| | |
|---|---|
| Silver behenate | 5.55 |
| Pigment (C. I. Pigment Blue 60) | 0.036 |
| Polyhalogen compound-1 | 0.12 |
| Polyhalogen compound-2 | 0.37 |
| Phthalazine compound-1 | 0.19 |
| SBR latex | 9.97 |
| Reducing agent complex-1 | 1.41 |
| Development accelerating agent-1 | 0.024 |
| Mercapto compound-1 | 0.002 |
| Mercapto compound-2 | 0.012 |
| Silver halide (in terms of Ag) | 0.091 |

Coating and drying conditions are as follows:

Coating was performed at a speed of 160 m/min while keeping a gap between an end of a coating die and a support at from 0.10 mm to 0.30 mm and keeping a pressure in a reduced pressure chamber lower by from 196 Pa to 882 Pa than the atmospheric pressure. The support was blown with ion wind before the coating to cancel electricity.

Next, the coating liquid was cooled in a chilling zone by blowing wind having a dry-bulb temperature of from 10° C. to 20° C. and, then, transferred in a non-contact type manner and, thereafter, dried by a dry wind having a dry-bulb temperature of from 23° C. to 45° C. and a wet-bulb temperature of from 15° C. to 21° C. in a helical non-contact type drying apparatus.

After the coating liquid was dried, the thus-dried coating liquid was conditioned at 25° C., from 40% RH to 60% RH and, then, a surface of the resultant layer was heated up to from 70° C. to 90° C. and, subsequently, cooled down to 25° C.

A degree of matting expressed by Beck smoothness of the thus-prepared photothermographic material was found to be 550 seconds for the photosensitive layer side and 130 seconds for the back surface side. Further, pH of the layer surface on a photosensitive layer side was measured and found to be 6.0.

Chemical structures of compounds used in embodiments according to the invention are shown below.

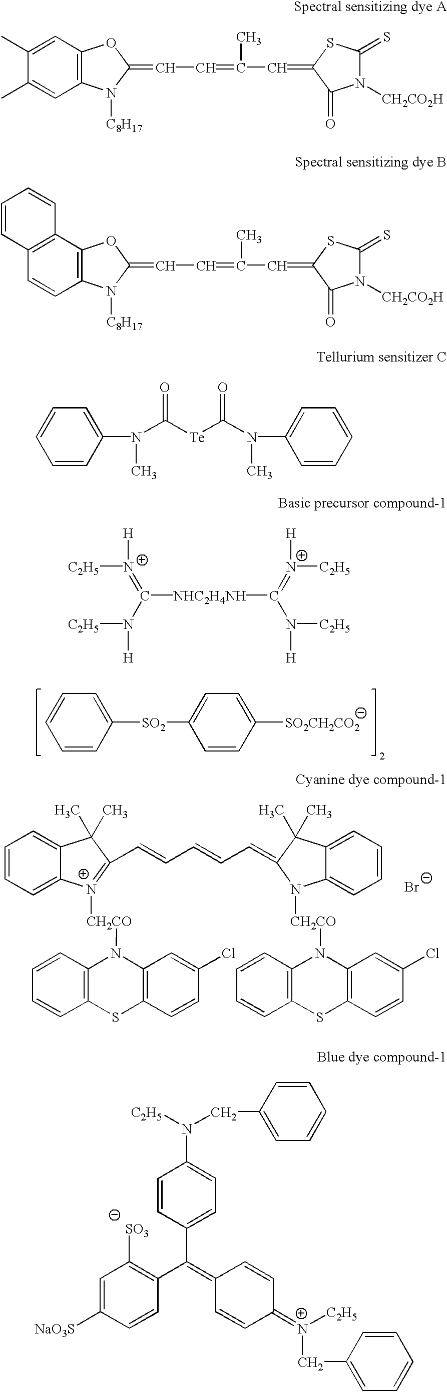

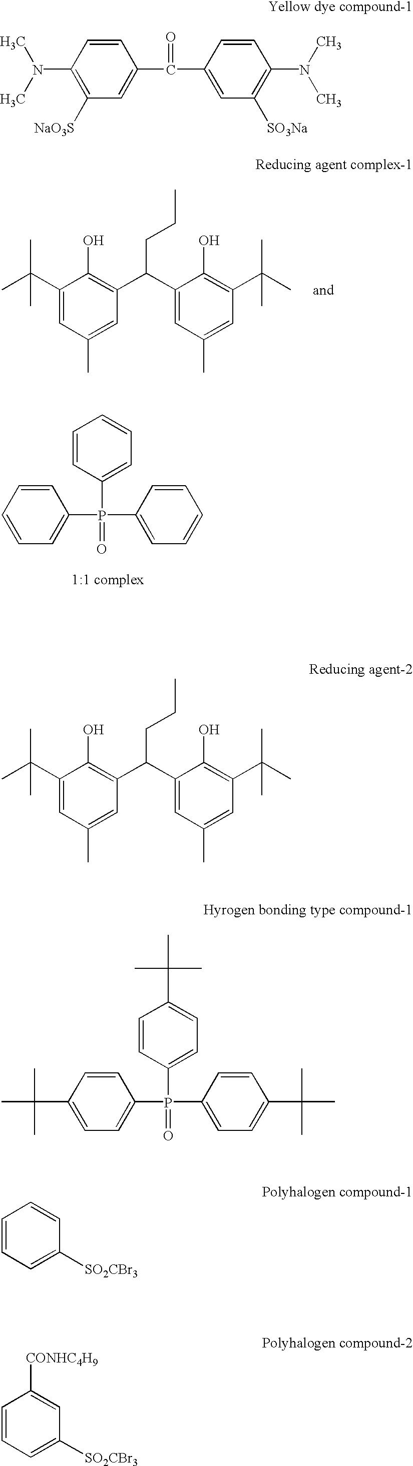

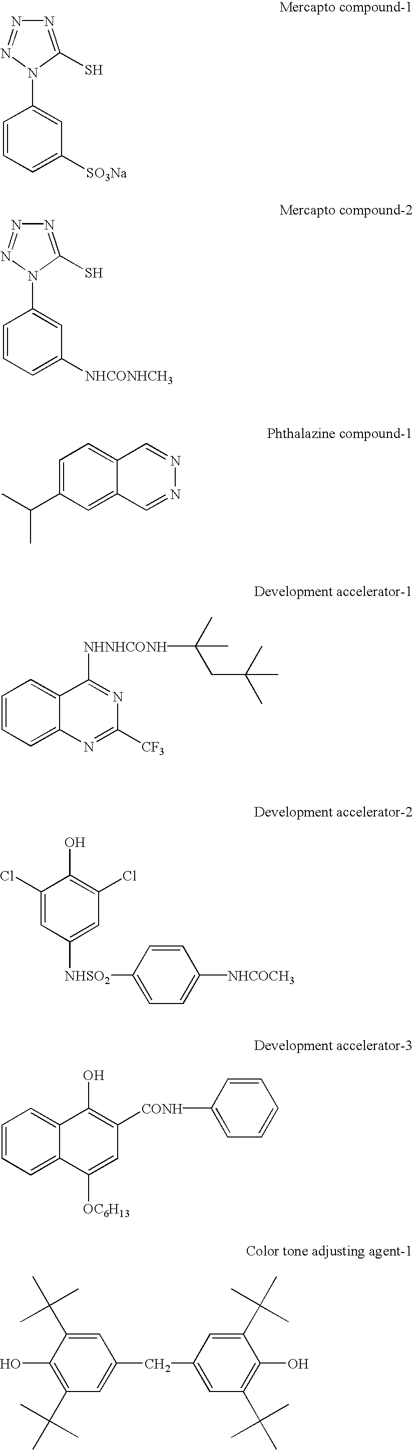

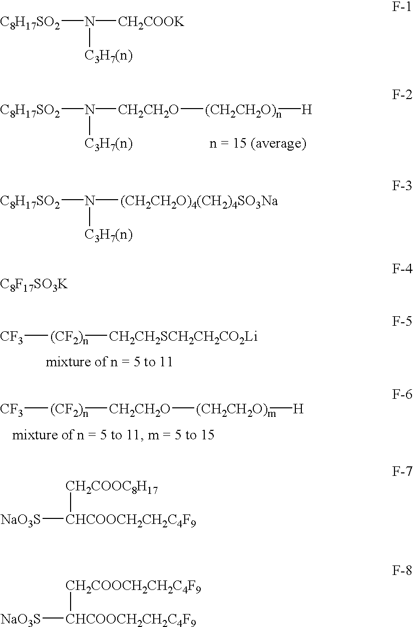

Evaluation of Photographic Performance

The obtained samples were each cut out to be a size of 515 mmx728 mm, packaged by a packaging material described below under an atmosphere of 25° C. and 50% RH, stored at normal temperature for 2 weeks and subjected to evaluations described below.

Packaging Material

PET: 10 μm/PE: 12 μm/aluminum foil: 9 μm/Ny: 15 μm/polyethylene containing 3% of carbon: 50 μm;

oxygen permeability: 0.02 ml/atm·m²·25° C.·day; and water permeability: 0.10 g/atm·m²·25° C.·day.

The obtained samples were exposed and thermally developed by a modified model of Fuji Medical Dry Laser Imager“FM-DPL”. Such exposure was performed by irradiating a photosensitive material with a semiconductor laser beam from a 660-nm semiconductor laser device having a maximum output of 60 mW (IIIB) provided in such a modified Fuji Medical Dry Laser Imager“FM-DPL” while stopping down a beam diameter to be 100 μm×100 μm. The exposure was performed by changing quantities of light exposure stepwise. Such development was performed by setting temperatures of 4 plates constituting a panel heater to be 112° C.-119° C.-121° C.-121° C. A time period of the exposure was 24 seconds. The evaluations of the samples obtained after being exposed and thermally developed were performed by measuring densities thereof by means of using a Macbeth-type densitometer and constructing a characteristic curve of density against quantity of exposing light.

In the thermally developed samples, density of a portion of each of the samples which has not been exposed to a laser beam was designated as Fog while density of a portion which has been exposed by a maximum quantity thereof was designated as Dmax. Further, a reciprocal number of the quantity of exposing light which can obtain the density of Fog+1.0 was designated as sensitivity which is expressed by a relative value against that of a reference photosensitive material.

Evaluation of Print-Out Performance

The sample which has been subjected to thermal development processing was left to stand in an atmosphere of 25° C. and 60% RH under a fluorescent lamp of 1000 luces for 30 days to measure changes of fog with time. The changes of fog are shown in Table 6 as a difference (ΔFog) between an initial fog density and that after being stored.

Storability on Unexposed, Time-Lapsing Basis

The obtained phtothermographic material was stored at 30° C. or 2 months and, then, subjected to thermal development processing. Thereafter, changes of fog with time was measured. Changes of this fog are shown in Table 6 as a difference (ΔFog) between that at the initial time and that after storage.

TABLE 6
Results of evaluation of Example 7

| Sample | Emulsion | | | Print-Out | Storability on Unexposed, | |
|---|---|---|---|---|---|---|
| No | No | Sensitivity | Dₘₐₓ | ΔFog | Time-Lapsing Basis ΔFog | Remarks |
| 7-1 | 1a | 120 | 3.8 | 0.08 | 0.06 | Comparative Example |
| 7-2 | 2a | 110 | 3.7 | 0.07 | 0.05 | Comparative Example |
| 7-3 | 3a | 105 | 3.9 | 0.06 | 0.05 | Comparative Example |
| 7-4 | 4a | 100 | 3.7 | 0.05 | 0.05 | Comparative Example |
| 7-5 | 5a | 102 | 3.7 | 0.06 | 0.04 | Comparative Example |
| 7-6 | 6a | 101 | 3.9 | 0.06 | 0.04 | Comparative Example |
| 7-7 | 7a | 102 | 4.1 | 0.03 | 0.03 | Present Invention |
| 7-8 | 8a | 103 | 4.2 | 0.04 | 0.03 | Present Invention |
| 7-9 | 9a | 102 | 4.1 | 0.02 | 0.02 | Present Invention |
| 7-10 | 10a | 104 | 4.2 | 0.03 | 0.02 | Present Invention |
| 7-11 | 11a | 102 | 4.2 | 0.04 | 0.02 | Present Invention |
| 7-12 | 12a | 103 | 4.1 | 0.04 | 0.03 | Present Invention |
| 7-13 | 13a | 103 | 4.2 | 0.03 | 0.03 | Present Invention |
| 7-14 | 14a | 101 | 4.1 | 0.02 | 0.03 | Present Invention |
| 7-15 | 15a | 102 | 4.2 | 0.04 | 0.04 | Present Invention |
| 7-16 | 16a | 102 | 4.1 | 0.04 | 0.03 | Present Invention |
| 7-17 | 17a | 104 | 4.2 | 0.03 | 0.03 | Present Invention |
| 7-18 | 18a | 102 | 4.2 | 0.02 | 0.02 | Present Invention |
| 7-19 | 19a | 102 | 4.3 | 0.02 | 0.03 | Present Invention |
| 7-20 | 20a | 103 | 4.1 | 0.03 | 0.02 | Present Invention |
| 7-21 | 21a | 102 | 4.2 | 0.02 | 0.02 | Present Invention |
| 7-22 | 22a | 103 | 4.2 | 0.03 | 0.03 | Present Invention |
| 7-23 | 23a | 102 | 4.3 | 0.02 | 0.02 | Present Invention |
| 7-24 | 24a | 102 | 4.3 | 0.02 | 0.02 | Present Invention |
| 7-25 | 25a | 103 | 4.2 | 0.03 | 0.03 | Present Invention |
| 7-26 | 26a | 102 | 4.2 | 0.03 | 0.02 | Present Invention |

From the results shown in Table 6, it is found that the photothermographic material according to the twelfth embodiment of the invention has a high sensitivity and high Dmax and is favorable in print-out fog and storability on an unexposed, time-lapsing basis.

### Example 8

<Preparation of Silver Halide Emulsion B>

A silver halide emulsion B was prepared in a same manner as in preparation of the silver halide emulsion 4a except that the liquid temperature of 42° C. at the time of forming particles was changed into that of 55° C. The sedimentation/desalting/rinsing/dispersion operations was conducted in a same manner as in the silver halide emulsion 4a. Further, a silver halide emulsion B was obtained by performing a spectral sensitizing and chemical sensitizing in a same manner as in the emulsion 4a except that a quantity of the methanol solution, comprising the spectral sensitizing dye A and the spectral sensitizing dye B at a ratio of 3:1 therebetween, to be added was changed into 9.0×10⁻⁴ mol/mol of Ag, a quantity of tellirium sensitizer C to be added was changed into 5.1×10⁻⁴ mol/mol of Ag and a quantity of m-methylureido-phenyl-2-mercapto-1,3,4,5-tetrazole to be added was changed into 4.7×10⁻³ mol/mol of Ag. Emulsion particles of the silver halide emulsion B were pure silver iodide cubic particles having an average sphere-equivalent diameter of 80 nm and a sphere-equivalent coefficient of variation of 20%.

<Preparation of Mixed Emulsion for Coating Liquid>

An emulsion 4a and an emulsion B were mix-dissolved at a mixing ratio of 8:2 instead of silver halide emulsion 4a and the resultant solution was added with a 1 mass % aqueous solution of N-methyl-benzothiazolium iodide in an amount of 7×10⁻³ mol/mol of Ag and, further, added with water such that a content of silver halide became 38.2 g (in terms of Ag)/kg of the mixed emulsion for the coating liquid to prepare an emulsion B 4a for the coating liquid.

Also with halogenated emulsions 11a to 26a, the emulsion B was mix-dissolved in a same manner as in the above to prepare mixed emulsions B 11a to B 26a for the coating liquid.

<Preparation of Photothermographic Material>

Photothermographic materials were prepared in a same manner as in Example 7 except that, in regard to photothermographic materials 7-4 and from 7-11 to 7-26 in Example 7, a mixed emulsion for the coating liquid was used, thereby to allow them to be named as sample Nos 8-4 and from 8-11 to 8-26.

Evaluation of Sample

Exposure to light and thermal development were performed in a same manner as in Example 7 and, then, density measurement was performed on the resultant image to construct a characteristic curve of the density against a logarithm of a quantity of exposing light. Evaluations were performed in a same manner as in Example 7 except that an optical density of an unexposed portion was designated as Fog and, then, an average contrast of optical densities (Fog+0.1 and Fog+0.5) was measured.

TABLE 7
Evaluation Results of Example 8.

| | | | | | Storability on | |
|---|---|---|---|---|---|---|
| Sam- | Emul- | | | Print- | Unexposed, | |
| ple | sion | Sensi- | Average | Out | Time-Lapsing | |
| No | No | tivity | Contrast | ΔFog | Basis ΔFog | Remarks |
| 7-4 | 4a | 100 | 1.8 | 0.05 | 0.05 | Comparative |
| | | | | | | Example |
| 8-4 | B4a | 102 | 1.0 | 0.05 | 0.05 | Comparative |
| | | | | | | Example |
| 8-11 | B11a | 104 | 1.1 | 0.04 | 0.02 | Present |
| | | | | | | Invention |
| 8-12 | B12a | 104 | 1.0 | 0.04 | 0.03 | Present |
| | | | | | | Invention |
| 8-13 | B13a | 105 | 1.1 | 0.03 | 0.03 | Present |
| | | | | | | Invention |
| 8-14 | B14a | 103 | 1.1 | 0.02 | 0.03 | Present |
| | | | | | | Invention |
| 8-15 | B15a | 104 | 1.0 | 0.04 | 0.04 | Present |
| | | | | | | Invention |
| 8-16 | B16a | 104 | 1.0 | 0.04 | 0.03 | Present |
| | | | | | | Invention |
| 8-17 | B17a | 106 | 1.1 | 0.03 | 0.03 | Present |
| | | | | | | Invention |
| 8-18 | B18a | 104 | 1.0 | 0.02 | 0.02 | Present |
| | | | | | | Invention |
| 8-19 | B19a | 104 | 1.0 | 0.02 | 0.03 | Present |
| | | | | | | Invention |
| 8-20 | B20a | 105 | 1.1 | 0.03 | 0.02 | Present |
| | | | | | | Invention |
| 8-21 | B21a | 104 | 1.0 | 0.02 | 0.02 | Present |
| | | | | | | Invention |
| 8-22 | B22a | 105 | 1.0 | 0.03 | 0.03 | Present |
| | | | | | | Invention |
| 8-23 | B23a | 104 | 1.0 | 0.02 | 0.02 | Present |
| | | | | | | Invention |
| 8-24 | B24a | 104 | 1.1 | 0.02 | 0.02 | Present |
| | | | | | | Invention |
| 8-25 | B25a | 105 | 1.0 | 0.03 | 0.03 | Present |
| | | | | | | Invention |
| 8-26 | B26a | 104 | 1.0 | 0.03 | 0.02 | Present |
| | | | | | | Invention |

From the results shown in Table 7, it is found that the photothermographic material according to the twelfth embodiment of the invention has a high sensitivity and is favorable in print-out fog and storability on an unexposed, time-lapsing basis and, further, has favorable image characteristics such that an average contrast in a low density portion is low and an image reproduction property in the low density portion.

### Example 9

Preparation of Fatty Acid Silver Dispersion B

<Preparation of Recrystallized Behenic Acid>

100 kg of behenic acid (trade name: “Edenor C22-85R”; available from Henkel Corporation) was mixed into 1200 kg of isopropyl alcohol, dissolved at 50° C., filtered through a filter of 10 μm, cooled down to 30° C. and recrystallized. A cooling speed at the time of recrystallization was controlled to be 3° C./hour. The resultant crystal was subjected to centrifugal filtration, rinsed with a shower of 100 kg of isopropyl alcohol and dried. The resultant crystal was esterified and, then, subjected to a GC-FID measurement to find that it contained 96% of silver behenate, 2% of lignoceric acid and 2% of arachidic acid.

<Preparation of Fatty Acid Silver Dispersion B>

88 kg of behenic acid, 422 L of distilled water, 49.2 L of a 5 mol/L concentration aqueous NaOH solution and 120 L of t-butyl alcohol were mixed and, then, the resultant mixture was stirred at 75° C. for one hour to allow the mixture to react, thereby to obtain a sodium behenate solution B. Separately, 206.2 L (pH 4.0) of an aqueous solution containing 40.4 kg of silver nitrate was prepared and kept at 10° C. A reaction vessel containing 635 L of distilled water and 30 L of t-butyl alcohol was kept at 30° C. and, then, was added with an entire volume of the sodium behenate solution B and an entire volume of the aqueous silver nitrate solution at constant flow rates over 93 minutes and 15 seconds and over 90 minutes, respectively. On this occasion, only the aqueous silver nitrate solution was added in a first 11-minute period after the start of the addition thereof and, then, the sodium behenate solution B was started to be added and only the sodium behenate solution B was added in a last 14-minute-and-15 second period after the end of addition of the aqueous silver nitrate solution. At this time, a temperature in the reaction vessel was kept at 30° C. and was controlled externally so as to keep the liquid temperature constant. Further, a piping in a feeding system of the sodium behenate solution B was heated by circulating hot water in an outer portion of a double pipe and controlled such that an outlet liquid temperature at the end of the feed nozzle was 75° C. Further, A piping in a feeding system of the aqueous silver nitrate solution was cooled by circulating cold water in an outer portion of the double pipe. A point of addition of the sodium behenate solution B and a point of addition of the aqueous silver nitrate solution were symmetrically arranged centered around a stirring axis and height of these points was adjusted so as to prevent them from contacting the reaction solution.

After completion of the addition of the sodium behenate solution B, the resultant mixture was allowed to stand for 20 minutes under stirring with a temperature thereof unchanged, and, then, the temperature was elevated to 35° C. over 30 minutes and, thereafter, the mixture was ripened for 210 minutes. Immediately after completion of such ripening, a solid content was separated by centrifugal filtration and, then, rinsed with water until electric conductivity of a filtrate became 30 μS/cm. A fatty acid silver salt was thus obtained. The thus-obtained solid content was stored in wet cake form without being dried.

When a state of the thus-obtained silver behenate particles was observed by a microscopic photographing, the obtained silver behenate particles were found to be a crystal having average values of a=0.21 μm, b=0.4 μm and c=0.4 μm, an average aspect ratio of 2.1, an average sphere-equivalent diameter of 0.51 μm and a sphere-equivalent coefficient of variation of 11% (a, b and c being defined in this specification).

To the wet cake equivalent to dry weight of 260 kg, 19.3 kg of polyvinyl alcohol (trade name; “PVA-217”) was added and water was further added to make a total volume up to be 1000 kg and, then, the resultant mixture was changed into a slurry state by using a dissolver blade and, thereafter, preliminarily dispersed by using a pipeline mixer (“PM-10” type; available from Mizuho Industrial Co., Ltd.).

Next, such a preliminarily dispersed stock solution was treated three times by a dispersion apparatus (trade name: “Micro Fluidizer-M-610”; available from Micro Fluidex International Corporation) equipped with a Z type interaction chamber under a pressure of 1.13×10⁵ kPa (1150 kg/cm²), thereby to obtain a silver behenate dispersion. During the dispersion, cooling operation was performed such that coiled heat exchangers were attached each to an inlet and an outlet of the interaction chamber and a temperature of coolant was controlled to keep the dispersion temperature at 18° C.

<Preparation of Reducing Agent-2 Dispersion>

10 kg of a reducing agent-2, that is, 6,6′-di-t-butyl-4,4′-dimethyl-2,2′-butylidene diphenol and 16 kg of a 10 mass % aqueous solution of a modified polyvinylalcohol (“Poval MP203”; available from Kuraray Co., Ltd.) were added with 10 kg of water and, then, thoroughly mixed to prepare a slurry. The thus-prepared slurry was fed by using a diaphragm pump to a lateral sand mill (“UVM-2”; available from Aimex, Ltd.) filled with zirconia beads having an average diameter of 0.5 mm, dispersed for 3 hours and 30 minutes, added with 0.2 g of a benzoisothiazolinone sodium salt and water such that a concentration of the reducing agent was adjusted to be 25 mass %, thereby to obtain a reducing agent-2 dispersion. Reducing agent particles contained in the thus-obtained reducing agent dispersion were found to have a median diameter of 0.40 μm and a maximum particle diameter of 1.5 μm or less. The obtained reducing agent dispersion was filtered through a polypropylene filter having a pore diameter of 3.0 μm to separate dust or other foreign matters and then stored.

<Preparation of Hydrogen Bonding Type Compound-1 Dispersion>

10 kg of a hydrogen bonding type compound-1, that is, tri(4-t-butylphenyl)phosphine oxide and 16 kg of a 10 mass % aqueous solution of a modified polyvinylalcohol (“Poval MP203”; available from Kuraray Co., Ltd.) were added with 10 kg of water and, then, thoroughly mixed to prepare a slurry. The thus-prepared slurry was fed by using a diaphragm pump to a lateral sand mill (“UVM-2”; available from Aimex, Ltd.) filled with zirconia beads having an average diameter of 0.5 mm, dispersed for 3 hours and 30 minutes, added with 0.2 g of a benzoisothiazolinone sodium salt and water such that a concentration of the hydrogen bonding type compound was adjusted to be 25 mass %, thereby to obtain a hydrogen bonding type compound-1 dispersion. Hydrogen bonding type compound particles contained in the thus-obtained dispersion were found to have a median diameter of 0.35 μm and a maximum particle diameter of 1.5 μm or less. The obtained hydrogen bonding type compound dispersion was filtered through a polypropylene filter having a pore diameter of 3.0 μm to separate dust or other foreign matters and then stored.

<Preparation of Coating Liquid-3a for Emulsion Layer (Photosensitive Layer)>

1000 g of the above-obtained fatty acid silver dispersion B, 276 ml of water, 32.8 g of the pigment-1 dispersion, 21 g of the organinc polyhalogen compound-1 dispersion, 58 g of the organinc polyhalogen compound-2 dispersion, 173 g of the phthalazine compound-1 solution, 1082 g of the SBR latex (Tg: 20° C.) liquid; 155 g of the reducing agent-2 dispersion, 55 g of the hydrogen bonding type compound-1 dispersion, 6 g of the development accelerator-1 dispersion, 2 g of the development accelerator-2 dispersion, 3 g of the development accelerator-3 dispersion, 2 g of the color tone adjusting agent-1 dispersion, 6 ml of the mercapto compound-2 aqueous solution were mixed in order of precedence and, then, 117 g of silver halide emulsion 1a for the coating liquid was added to the resultant mixture just before it was applied and, thereafter, thoroughly mixed to obtain a coating liquid for the emulsion layer which was then directly fed to a coating die and, then, a sample 9-1 was applied. Further, emulsions 2a to 26a were used in place of the emulsion 1a to prepare samples 9-2 to 9-26, respectively.

Viscosity of the coating liquid for the emulsion layer was measured by using a B type viscometer (available from Tokyo Keiki K.K.) at 40° C. (with No. 1 rotor at 60 rpm) and found to be 40 mPa·s.

Viscosities of the coating liquid measured under shearing velocities of 0.1, 1, 10, 100 and 1,000 (1/second) at 25° C. by using RFS Fluid Spectrometer (available from Rheometrix Far East Inc.) were 530, 144, 96, 51 and 28 mPa·s, respectively.

A quantity of zirconium in the coating liquid was 0.25 mg based on 1 g of silver.

<Preparation of Photothermographic Material-3a>

A photothermographic material-3a was prepared in a same manner as in the photothermographic material-1a except that the coating liquid-1a for the emulsion layer was changed into a coating liquid-3a for the emulsion layer, the yellow dye compound 1 was removed from the anti-halation layer and the fluorine-type surfactants in the protective layer on the back surface and the protective layer on the emulsion surface were changed from F-1, F-2, F-3 and F-4 into F-5, F-6, F-7 and F-8, respectively in the photothermographic material-1a and, then, the coating liquid-3a for the emulsion layer was designated as a sample 9-1 and, further, coating liquids in which the emulsion 1a in the coating liquid-3a for the emulsion layer was replaced by emulsions 2a to 26a which were, then designated as samples 9-2 to 9-26, respectively.

At this time, coated quantities (g/m²) of respective compounds in the emulsion layer are as follows:

| | |
|---|---|
| Silver behenate | 5.55 |
| Pigment (C. I. Pigment Blue 60) | 0.036 |
| Polyhalogen compound-1 | 0.12 |
| Polyhalogen compound-2 | 0.37 |
| Phthalazine compound-1 | 0.19 |
| SBR latex | 9.67 |
| Reducing agent-2 | 0.81 |
| Hydrogen bonding type compound-1 | 0.30 |
| Development accelerating agent-1 | 0.024 |
| Development accelerating agent-2 | 0.010 |
| Development accelerating agent-3 | 0.015 |
| Color tone adjusting agent-1 | 0.010 |
| Mercapto compound-2 | 0.002 |
| Silver halide (in terms of Ag) | 0.091 |

The obtained samples were exposed and thermally developed (for 12 seconds in total by 4 plates constituting a panel heater in which respective temperatures were set to be 112° C., 119° C., 121° C. and 121° C.) by Fuji Medical Dry Laser Imager “FM-DPL” (equipped with a 660-nm semiconductor laser device having a maximum output of 60 mW (IIIB); on this occasion, evaluations of the obtained image were performed by a densitometer.

The results obtained by performing in a same manner as in Example 7 are shown in Table 8.

TABLE 8
Evaluation Results of Example 9

| | | | | | Storability on | |
|---|---|---|---|---|---|---|
| Sam- | Emul- | | | Print- | Unexposed, | |
| ple | sion | Sensi- | | Out | Time-Lapsing | |
| No | No. | tivity | Dₘₐₓ | ΔFog | BasisΔFog | Remarks |
| 9-1 | 1a | 100 | 3.6 | 0.08 | 0.07 | Comparative |
| | | | | | | Example |
| 9-2 | 2a | 101 | 3.7 | 0.07 | 0.07 | Comparative |
| | | | | | | Example |
| 9-3 | 3a | 102 | 3.8 | 0.06 | 0.06 | Comparative |
| | | | | | | Example |
| 9-4 | 4a | 103 | 3.9 | 0.05 | 0.06 | Comparative |
| | | | | | | Example |
| 9-5 | 5a | 100 | 3.8 | 0.06 | 0.06 | Comparative |
| | | | | | | Example |
| 9-6 | 6a | 102 | 3.8 | 0.06 | 0.06 | Comparative |
| | | | | | | Example |
| 9-7 | 7a | 102 | 3.9 | 0.03 | 0.04 | Present |
| | | | | | | Invention |
| 9-8 | 8a | 101 | 3.9 | 0.04 | 0.05 | Present |
| | | | | | | Invention |
| 9-9 | 9a | 102 | 4.0 | 0.02 | 0.04 | Present |
| | | | | | | Invention |
| 9-10 | 10a | 102 | 4.1 | 0.03 | 0.03 | Present |
| | | | | | | Invention |
| 9-11 | 11a | 103 | 4.0 | 0.04 | 0.04 | Present |
| | | | | | | Invention |
| 9-12 | 12a | 104 | 4.0 | 0.04 | 0.04 | Present |
| | | | | | | Invention |
| 9-13 | 13a | 102 | 4.1 | 0.03 | 0.05 | Present |
| | | | | | | Invention |
| 9-14 | 14a | 102 | 4.1 | 0.02 | 0.04 | Present |
| | | | | | | Invention |
| 9-15 | 15a | 102 | 4.1 | 0.03 | 0.05 | Present |
| | | | | | | Invention |
| 9-16 | 16a | 103 | 4.0 | 0.03 | 0.04 | Present |
| | | | | | | Invention |
| 9-17 | 17a | 104 | 4.1 | 0.03 | 0.03 | Present |
| | | | | | | Invention |
| 9-18 | 18a | 103 | 4.1 | 0.02 | 0.04 | Present |
| | | | | | | Invention |
| 9-19 | 19a | 103 | 4.1 | 0.02 | 0.03 | Present |
| | | | | | | Invention |
| 9-20 | 20a | 103 | 4.1 | 0.03 | 0.03 | Present |
| | | | | | | Invention |
| 9-21 | 21a | 102 | 4.0 | 0.02 | 0.02 | Present |
| | | | | | | Invention |
| 9-22 | 22a | 103 | 4.0 | 0.03 | 0.03 | Present |
| | | | | | | Invention |
| 9-23 | 23a | 102 | 4.1 | 0.03 | 0.02 | Present |
| | | | | | | Invention |
| 9-24 | 24a | 102 | 4.0 | 0.03 | 0.02 | Present |
| | | | | | | Invention |
| 9-25 | 25a | 103 | 4.1 | 0.02 | 0.04 | Present |
| | | | | | | Invention |
| 9-26 | 26a | 102 | 4.1 | 0.02 | 0.03 | Present |
| | | | | | | Invention |

From the results shown in Table 8, it is found that the photothermographic material according to the twelfth embodiment of the invention has a high sensitivity and a high Dmax and is favorable in print-out fog and storability on a unexposed, time-lapsing basis and, further, more favorable when a content of AgI of a non-photosensitive silver halide is higher.

### Example 10

<Preparation of Photothermographic Material-4a>

A photothermographic material 4a was prepared in a same manner as in the photothermographic material 3a except that a yellow dye compound-1 was added in an anti-halation layer in the photothermographic material 3a such that absorbance at 405 nm became 0.3.

Exposure of Photothermographic Material

The obtained photothermographic materials were subjected to exposure processing in such a manner as described below.

The photothermographic materials were exposed for 10⁻⁶ second by Fuji Medical Dry Laser Imager “FM-DPL” equipped with a semiconductor laser device“NLHV3000E” (available from Nichia Corporation) as a semiconductor laser beam supply in an exposure portion thereof while illuminance of laser beams on a surface of the photothermographic materials is allowed to change from 0 and 1 mW/mm² to 1000 mW/mm² by stopping down a beam diameter. An emission wavelength of the laser beams was 405 nm.

Development of Photothermographic Material

The thus-exposed photothermographic materials were subjected to thermal development processing in such a manner as described below.

In a thermal development portion of Fuji Medical Dry Laser Imager “FM-DPL”, temperatures of 4 plates which constitute a panel heater were set to be 112° C., 115° C., 115° C. and 115° C. and, then, the thermal development was performed such that a total thermal development time became 12 seconds while increasing a film transferring speed.

Evaluations of samples were performed in a same manner as in Example 9 and the results thereof are shown in Table 9.

TABLE 9
Evaluation Results of Example 10

| | | | | | Storability on | |
|---|---|---|---|---|---|---|
| Sam- | Emul- | | | Print- | Unexposed, | |
| ple | sion | | | Out | Time-Lapsing | |
| No. | No. | Sensitivity | Dₘₐₓ | ΔFog | BasisΔFog | Remarks |
| 10-1 | 1a | 100 | 3.6 | 0.08 | 0.07 | Comparative |
| | | | | | | Example |
| 10-2 | 2a | 100 | 3.5 | 0.07 | 0.07 | Comparative |
| | | | | | | Example |
| 10-3 | 3a | 102 | 3.6 | 0.06 | 0.06 | Comparative |
| | | | | | | Example |
| 10-4 | 4a | 103 | 3.7 | 0.05 | 0.06 | Comparative |
| | | | | | | Example |
| 10-5 | 5a | 99 | 3.8 | 0.06 | 0.06 | Comparative |
| | | | | | | Example |
| 10-6 | 6a | 101 | 3.9 | 0.06 | 0.06 | Comparative |
| | | | | | | Example |
| 10-7 | 7a | 101 | 4.0 | 0.03 | 0.04 | Present |
| | | | | | | Invention |
| 10-8 | 8a | 101 | 4.1 | 0.04 | 0.05 | Present |
| | | | | | | Invention |
| 10-9 | 9a | 102 | 4.0 | 0.02 | 0.04 | Present |
| | | | | | | Invention |
| 10-10 | 10a | 102 | 4.1 | 0.03 | 0.03 | Present |
| | | | | | | Invention |
| 10-11 | 11a | 102 | 4.1 | 0.04 | 0.04 | Present |
| | | | | | | Invention |
| 10-12 | 12a | 103 | 4.1 | 0.04 | 0.04 | Present |
| | | | | | | Invention |
| 10-13 | 13a | 103 | 4.2 | 0.03 | 0.05 | Present |
| | | | | | | Invention |
| 10-14 | 14a | 101 | 4.1 | 0.02 | 0.04 | Present |
| | | | | | | Invention |
| 10-15 | 15a | 102 | 4.0 | 0.03 | 0.05 | Present |
| | | | | | | Invention |
| 10-16 | 16a | 102 | 4.0 | 0.03 | 0.04 | Present |
| | | | | | | Invention |
| 10-17 | 17a | 104 | 4.1 | 0.03 | 0.03 | Present |
| | | | | | | Invention |
| 10-18 | 18a | 102 | 4.2 | 0.02 | 0.04 | Present |
| | | | | | | Invention |
| 10-19 | 19a | 102 | 4.1 | 0.02 | 0.03 | Present |
| | | | | | | Invention |
| 10-20 | 20a | 103 | 4.2 | 0.03 | 0.03 | Present |
| | | | | | | Invention |
| 10-21 | 21a | 102 | 4.0 | 0.02 | 0.02 | Present |
| | | | | | | Invention |
| 10-22 | 22a | 103 | 4.0 | 0.03 | 0.03 | Present |
| | | | | | | Invention |
| 10-23 | 23a | 102 | 4.1 | 0.03 | 0.02 | Present |
| | | | | | | Invention |
| 10-24 | 24a | 102 | 4.0 | 0.03 | 0.02 | Present |
| | | | | | | Invention |
| 10-25 | 25a | 103 | 4.1 | 0.02 | 0.04 | Present |
| | | | | | | Invention |
| 10-26 | 26a | 102 | 4.1 | 0.02 | 0.03 | Present |
| | | | | | | Invention |

From the results shown in Table 9, it is found that the photothermographic material according to the twelfth embodiment of the present invention has a high sensitivity and a high Dmax and is favorable in print-out fog and storability on a unexposed, time-lapsing basis and, further, more favorable when a content of AgI of a non-photosensitive silver halide is higher.

### Example 11

Evaluations was performed in a same manner as in Example 10 except that, when the photothermographic materials Nos. 10-2 to 10-4 and 10-7 to 10-26 used in Example 10 were subjected to thermal development, temperatures of 4 plates of thermal development apparatus used in Example 10 were unanimously set to be 112° C. Favorable results similar to those in Example 10 were obtained.

It is found that the twelfth embodiment of photothermographic materials according to the present invention have a high sensitivity and a high Dmax and are favorable in print-out fog and storability on a unexposed, time-lapsing basis compared with conventional photothermographic materials.

Examples of Eighteenth Embodiment

Next, an eighteenth embodiment of a photothermographic material according to the present invention will be explained in more detail with reference to examples. However, the invention is by no means limited to these examples.

### Example 12

Preparation of PET Support and Undercoat

Film Forming

PET with an intrinsic viscosity (IV) of 0.66 (measured in phenol/tetrachloroethane=6/4 (ratio by mass) at 25° C.) was obtained by a general procedure by using terephthalic acid and ethylene glycol. The thus-obtained PET was pelletized, dried at 130° C. for 4 hours, melted at 300° C. and allowed to contain a dye BB having a structure described below in an amount of 0.04 wt %. The resultant mixture was extruded from a T-die and rapidly cooled to obtain an unstretched film having a thickness of 175 μm on an after-heat-setting basis.

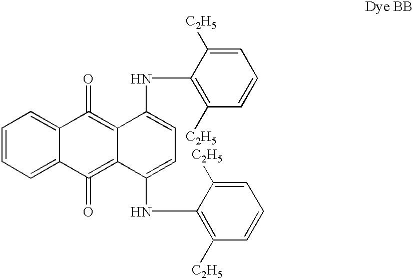

The film was then longitudinally stretched 3.3 times by using rollers which are different in a peripheral speed from each other and then transversely stretched 4.5 times by using a tenter. Temperatures applied in these cases were 110° C. and 130° C., respectively. Subsequently, the film was heat-set at 240° C. for 20 seconds, and then relaxed by 4% in the transverse direction at a same temperature. Thereafter, a portion chucked by the tenter was slit off and the film was knurled at both edges thereof and then taken up at a rate of 4 kg/cm² to obtain a rolled support having a thickness of 175 μm.

Surface Corona Treatment

Using a solid state corona treatment apparatus (model: 6KVA; available from Pillar Corporation), both surfaces of the support were treated at 20 m/minute at room temperature. Referring to read values of current and voltage, it was confirmed that the support was treated at 0.375 kVA·minute/m². Frequency for the treatment was 9.6 kHz and a gap clearance between an electrode and a dielectric roll was 1.6 mm.

Preparation of Undercoated Support

An undercoated support was prepared in a same manner and under same conditions as in Example 1.

Back Layer

(Preparation of Coating Liquid for Back Layer)

<Preparation of Solid Fine Particle Dispersion (a) of Basic Precursor>

64 g of a basic precursor compound-1, 10 g of DEMOL-N (trade name; available from Kao Corporation), 28 g of diphenylsulfone and 220 ml of distilled water were mixed and, then, the resultant mixture was bead-dispersed by using a 1/4G Sand Grinder Mill (available from Aimex, Ltd.) to obtain a solid fine particle dispersion (a′) of a basic precursor compound having an average particle diameter of 0.2 μm.

<Preparation of Solid Fine Particle Dispersion (a) of Dye>

9.6 g of a cyanine dye compound-1, 5.8 g of sodium p-dodecylbenzene sulfonate and 305 ml of distilled water were mixed and, then, the resultant mixture was bead-dispersed by using a 1/4G Sand Grinder Mill (available from Aimex, Ltd.) to obtain a solid fine particle dispersion (a) of dye having an average particle diameter of 0.2 μm.

<Preparation of Coating Liquid for Anti-halation Layer>

17 g of gelatin, 9.6 g of polyacrylamide, 70 g of the above-described solid fine particle dispersion (a′) of the basic precursor, 56 g of the above-described solid fine particle dispersion (a) of dye, 1.5 g of monodispersed polymethyl methacrylate fine particles (average particle size: 8 μm; particle diameter standard deviation: 0.4), 0.03 g of benzoisothiazolinone, 2.2 g of sodium polyethylenesulfonate, 0.2 g of a blue dye compound-1, 3.9 g of a yellow dye compound-1 and 44 ml of water were mixed to prepare a coating liquid for an anti-halation layer.

<Preparation of Coating Liquid for Back Surface Protective Layer>

While keeping a temperature of a vessel at 40° C., 50 g of gelatin, 0.2 g of sodium polystyrene sulfonate, 2.4 g of N,N-ethylenebis(vinylsulfone acetamide), 1 g of sodium t-octylphenoxyethoxyethane sulfonate, 30 mg of benzoisothiazolinone, 37 mg of a fluorinated surfactant (F-1b), 0.15 g of a fluorinated surfactant (F-2b), 64mg of a fluorinated surfactant (F-3b), 32 mg of a fluorinated surfactant (F-4b), 8.8 g of acrylic acid/ethyl acrylate copolymer (copolymerization ratio by mass: 5/95), 0.6 g of Aerosol 0T (available from American Cyanamide Corporation), 1.8 g of liquid paraffin emulsion in terms of liquid paraffin and 950 ml of water were mixed to prepare a coating liquid for a back surface protective layer.

(Coating of Back Layer)

On a back surface side of the above-described undercoated support, a coating liquid for an anti-halation layer and a coating liquid for a back surface protective layer were simultaneously applied in a stacked manner such that coating quantities of solid fine particle dye in a case of the former and gelatin in a case of the latter became 0.04 g and 1.7 g/m², respectively, and, then, dried to prepare a back layer.

Image Forming Layer, Intermediate Layer and Surface Protective Layer Preparation of Material for Coating

(Silver Halide Emulsion)

<Preparation of Silver Halide Emulsion>

To 1,420 ml of water, added were 4.3 ml of a 1 mass % potassium iodide solution, 3.5 ml of a 0.5 mol/L concentration of sulfuric acid and 36.7 g of phthalized gelatin; while the resultant liquid was kept stirring in a stainless-steel reaction vessel at a constant liquid temperature of 35° C., was added thereto an entire volume of a solution A in which 22.22 g of silver nitrate was diluted by distilled water to be 195.6 ml and a solution B in which 21.8 g of potassium iodide was diluted by distilled water to be 219 ml at a constant flow rate over 9 minutes. Thereafter, the resultant solution was added with 10 ml of a 3.5 mass % aqueous hydrogen peroxide solution and, further, with 10.8 ml of a 10 mass % aqueous solution of benzoimidazole. Further, were added to the resultant mixture a solution C in which 51.86 g of silver nitrate was diluted with distilled water to be 317.5 ml and a solution D in which 60 g of potassium iodide was diluted with distilled water to be 600 ml such that an entire volume of the solution C was added thereto at a constant flow rate over 120 minutes whereas the solution D was added thereto by a controlled double jet method while a pAg thereof is kept at 8.1.

To the resultant mixture, added was an entire volume of potassium hexachloroiridate(III) 10 minutes after the solution C and the solution D started to be added so as to attain a concentration of 1×10⁻⁴ mol/mol of Ag. Furthermore, an entire volume of 3×10⁻⁴ mol/mol of Ag of an aqueous solution of potassium iron (II) hexacyanate was added thereto 5 seconds after completion of such an addition of the solution C. At the point of time when a pH of the resultant mixture was adjusted to be 3.8 by using a 0.5 mol/L concentration of sulfuric acid, stirring is stopped and the resultant mixture was subjected to sedimentation/desalting/rinsing operations. Thereafter, a pH of the thus-subjected mixture was adjusted to be 5.9 by using a 1 mol/L concentration of sodium hydroxide to prepare a silver halide dispersion having a pAg of 8.0. Particles contained in the thus-prepared silver halide emulsion were pure silver iodide particles having an average sphere-equivalent diameter of 0.037 μm and a sphere-equivalent coefficient of variation of 17%. On this occasion, a particle size and the like were determined based on an average of 1000 particles under an electron microscopic observation.

Subsequently, while the thus-prepared silver halide dispersion was kept stirring at 38° C., the dispersion was added with 5 ml of a 0.34 mass % methanol solution of 1,2-benzisothiazolin-3-one and, 40 minutes after such an addition, added with a methanol solution of mixture of a spectral sensitizing dye A and a spectral sensitizing dye B at a mixing ratio of 1:1 in an amount of 1.2×10⁻³ mol/mol of Ag and, one minute after the above addition, a temperature of the resultant dispersion was raised to 47° C. 20 minute after such temperature raising, the resultant dispersion was added with a methanol solution of sodium benzene thiosulfonate in an amount of 7.6×10⁻⁵ mol/mol of Ag and, then, 5 minutes after a pAg of the resultant mixture was adjusted to be 5.5, added with a tellurium sensitizer (bis(N-phynyl-N-methylcarbamoyl)telluride) in an amount of 5.1×10⁻⁴ mol/mol of Ag and, then, ripened for 84 minutes. After a pAg of the resultant emulsion was adjusted to be 7.5, the emulsion was added with 1.3 ml of a 0.8 mass % methanol solution of N,N′-dihydroxy-N″-diethylmelamine and, 4 minutes after such an addition, added with a methanol solution of 5-methyl-2-mercaptobenzimidazole in an amount of 4.8×10⁻³ mol/mol of Ag and a methanol solution of 1-phenyl-2-heptyl-5-mercapto-1,3,4-triazole in an amount of 5.4×10⁻³ mol/mol of Ag, thereby to obtain a silver halide emulsion.

The thus-obtained emulsion was divided into small portions and added with compounds as shown in Table 10 to prepare silver halide emulsions 1b to 13b. On this occasion, a comparative compound (comparison-1) and a comparative compound (comparison-2) denote pyrogallol and hydroquinone, respectively; these compounds are halogen acceptors described in Journal of Photographic Science, Vol. 8, p. 119, 1960 and Journal of Photographic Science, Vol. 28, p. 163, 1980.

Preparation of Mixed Emulsion for Coating Liquid

Each of the thus-prepared silver halide emulsions was added with 1-m-(3-methylureido)phenyl-5-mercaptotetrazole in an amount of 5×10⁻³ mol/mol of Ag and, further, added with water to allow a content of silver halide/kg of the mixed emulsion for the coating liquid to be 38.2 g in terms of Ag.

<Preparation of Fatty Acid Silver Dispersion>

A fatty acid silver dispersion was prepared in a same manner and under same conditions as in Example 1.

<Preparation of Reducing Agent Dispersion (a)>

10 kg of a reducing agent complex-1′ (complex of 2,2′-methylenebis-(4-ethyl-6-tert-butylphenol) and triphenylphosphine oxide at a ratio of 1:1), 0.12 kg of triphenylphosphine oxide, 16 kg of a 10 mass % aqueous solution of a modified polyvinyl alcohol (Poval MP203; available from Kuraray Co., Ltd.) and 7.2 kg of water were mixed and thoroughly stirred to prepare a slurry. The thus-prepared slurry was fed by using a diaphragm pump to a lateral sand mill (UVM-2; available from Aimex, Ltd.) filled with zirconia beads having an average diameter of 0.5 mm, dispersed therein for 4 hours and 30 minutes, added with 0.2 g of a benzoisothiazolinone sodium salt and water such that a concentration of the reducing agent complex was adjusted to be 25 mass %, thereby to obtain a reducing agent dispersion (a). Reducing agent complex particles contained in the thus-obtained dispersion were found to have a median diameter of 0.46 μm and a maximum particle diameter of 1.6 μm or less. The obtained reducing agent complex dispersion was filtered through a polypropylene filter having a pore diameter of 3.0 μm to separate dust or other foreign matters and then stored.

<Preparation of Polyhalogen Compound>

Preparation of Organic Polyhalogen Compound Dispersion (a)

10 kg of an organic polyhalogen compoun-1, that is, tribromomethane sulfonylbenzene, 10 kg of a 20 mass % aqueous solution of a modified polyvinylalcohol and 0.4 kg of a 20 mass % aqueous solution of sodium triisopropylnaphthalene sulfonate were added with 14 kg of water and, then, mixed thoroughly to prepare a slurry. The thus-prepared slurry was fed by using a diaphragm pump to a lateral sand mill UVM-2 filled with zirconia beads having an average diameter of 0.5 mm, dispersed for 5 hours, added with 0.2 g of a benzoisothiazolinone sodium salt and water such that a concentration of an organic polyhalogen compound was adjusted to be 26 mass %, thereby to obtain an organic polyhalogen compound dispersion (a). Organic polyhalogen compound particles contained in the thus-obtained polyhalogen compound dispersion were found to have a median diameter of 0.41 μm and a maximum particle diameter of 2.0 μm or less. The obtained organic polyhalogen compound dispersion was filtered through a polypropylene filter having a pore size of 10.0 μm to separate dust or other foreign matters and then stored.

Preparation of Organic Polyhalogen Compound Dispersion (b)

10 kg of an organic polyhalogen compound-2, that is, N-butyl-3-tribromomethane sulfonylbenzamide, 20 kg of a 10 mass % aqueous solution of a modified polyvinylalcohol MP203, 0.4 kg of a 20 mass % aqueous solution of sodium triisopropylnaphthalene sulfonate and 8 kg of water were added to one another and, then, thoroughly mixed to prepare a slurry. The thus-prepared slurry was fed by using a diaphragm pump to a lateral sand mill UVM-2 filled with zirconia beads having an average diameter of 0.5 mm, dispersed for 5 hours, added with 0.2 g of a benzoisothiazolinone sodium salt and water such that a concentration of an organic polyhalogen compound was adjusted to be 25 mass %. The resultant dispersion was heated at 40° C. for 5 hours to obtain an organic polyhalogen compound-3 dispersion. Organic polyhalogen compound particles contained in the thus-obtained polyhalogen compound dispersion were found to have a median diameter of 0.36 μm and a maximum particle diameter of 1.5 μm or less. The obtained organic polyhalogen compound dispersion was filtered through a polypropylene filter having a pore size of 3.0 μm to separate dust or other foreign matters and then stored.

<Preparation of Phthalazine Compound-1 Solution>

A phthalazine compound-1 solution was prepared in a same manner and under same conditions as in Example 1.

<Preparation of Mercapto Compound-1 Aqueous Solution>

A mercapto compound-1 aqueous solution was prepared in a same manner and under same conditions as in Example 1.

<Preparation of Pigment-1 Dispersion>

A pigment-1 dispersion was prepared in a same manner and under same conditions as in Example 1.

<Preparation of SBR Latex Liquid>

SBR latex having a Tg of 23° C. was prepared in such a manner as described below.

70.5 parts by mass of styrene, 26.5 parts by mass of butadiene and 3 parts by mass of acrylic acid were emulsion-polymerized by using ammonium persulfate as a polymerization initiator and an anionic surfactant as an emulsifier and, then, subjected to aging at 80° C. for 8 hours. Thereafter, the resultant polymer solution was cooled down to 40° C., adjusted so as to have a pH of 7.0 by using ammonia water, added with Sandet-BL (available from Sanyo Chemical Industries) so as to attain a concentration of 0.22% and, then, further added with a 5% NaOH aqueous solution so as to adjust a pH of the solution to be 8.3 and, thereafter, with ammonia water so as to adjust a pH thereof to be 8.4. A molar ratio of Na⁺ ion: NH₄⁺ ion was 1:2.3. Further, 0.15 ml of a 7% aqueous solution of a bonzoisothiazolinnone sodium salt, based on 1 kg of the resultant solution, was added to the resultant solution, thereby to prepare an SBR latex liquid.

SBR latex: -St(70.5)-Bu(26.5)-AA(3)-latex

Tg: 23° C.; an average particle diameter: 0.1 μm; a concentration: 43 mass %; an equilibrium water content at 25° C., 60% RH: 0.6 mass %; ion conductivity: 4.2 mS/cm (measured on a latex stock liquid (43 mass %) at 25° C. by using a conductometer CM-30S (available from Toa Electronics Ltd.)); and pH: 8.4.

An SBR latex having a different Tg was prepared in a same manner as in the above by appropriately changing a ratio of styrene and butadiene.

(Preparation of Coating Liquid)

<Preparation of Coating Liquid for Image Forming Layer>

1000 g of the above-obtained fatty acid silver dispersion, 104 ml of water, 30 g of the pigment-1 dispersion, 6.3 g of the organinc polyhalogen compound dispersion (a), 20.7 g of the organinc polyhalogen compound dispersion (b), 173 g of the phthalazine compound-1 solution, 1082 g of the SBR latex (Tg: 23° C.) liquid; 258 g of the reducing agent dispersion (a) and 9 g of the mercapto compound-1 solution were mixed in order of precedence and, then, a silver halide mixed emulsion was added to the resultant mixture such that a quantity of the silver halide mixed emulsion became 6.6 mass % against organic acid silver just before it was applied and, thereafter, thoroughly mixed to obtain a coating liquid for the emulsion layer which was then directly fed to a coating die and applied.

<Preparation of Coating Liquid for Intermediate Layer for Emulsion Surface>

A coating liquid for an intermediate layer was prepared by mixing 772 g of a 10 mass % aqueous solution of polyvinyl alcohol PVA-205 (available from Kuraray Co., Ltd.), 5.3 g of a pigment-1 dispersion, 226 g of a 27.5 mass % liquid of methyl methacrylate/styrene/butyl acrylate/hydroxyethyl methacrylate/acrylic acid copolymer (copolymerization ratio by mass of 64/9/20/5/2) latex and 2 ml of a 5 mass % aqueous solution of Aerosol 0T, 10.5 ml of a 20 mass % aqueous solution of diammonium phthalate and, then, the thus-prepared coating liquid was added with water to make a total quantity thereof up to 880 g and, thereafter, a pH of the thus-made up coating liquid was adjusted to be 7.5 by NaOH, thereby to prepare a coating liquid for an intermediate layer, which was, then, fed to a coating die so as to attain a coating amount of 10 ml/m².

Viscosity of the coating liquid measured at 40° C. using a B type viscometer (with No. 1 rotor at 60 rpm) was 65 mPa·s.

<Preparation of Coating Liquid for First Layer of Protective Layer for Emulsion Surface>

A coating liquid for a first layer of a protective layer for an emulsion surface was prepared in a same manner and under same conditions as in Example 1.

<Preparation of Coating Liquid for Second Layer of Protective Layer for Emulsion Surface>

80 g of inert gelatin was dissolved in water and, then, added to the resultant solution were 102 g of a 27.5 mass % solution of methyl methacrylate/styrene/butylacrylate/hydroxyethyl methacrylate/acrylic acid copolymer (copolymerization ratio by mass of 64/9/20/5/2) latex, 3.2 ml of a 5 mass % solution of the fluorinated surfactant (F-1b: N-perfluorooctylsulfonyl-N-propylalanine potassium salt), 32 ml of a 2 mass % aqueous solution of the fluorinated surfactant (F-2b: polyethylene glycol mono (N-perfluorooctylsulfonyl-N-propyl-2-aminoethyl) ether [average degree of polymerization of ethylene oxide: 15], 23 ml of a 5 mass % solution of Aerosol 0T (available from American Cyanamide Corporation), 4 g of polymethylmethacrylate fine particles (average particle diameter: 0.7 μm), 21 g of polymethylmethacrylate fine particles (average particle diameter: 4.5 μm), 1.6 g of 4-methylphthalic acid, 4.8 g of phthalic acid, 44 ml of a 0.5 mol/L concentration of sulfuric acid and 10 mg of benzoisothiazolinone, and, then, a total weight of the resultant coating liquid was made up to 650 g by adding water, thereby to prepare a coating liquid. The thus-prepared coating liquid was mixed with 445 ml of an aqueous solution containing 4 mass % of chrome alum solution and 0.67 mass % of phthalic acid by using a static mixer immediately before the coating and fed to a coating die so as to attain a coating amount of 8.3 ml/m².

Viscosity of the coating liquid measured at 40° C. by using a B type viscometer (with No. 1 rotor at 60 rpm) was 19 mPa·s.

(Preparation of Photothermographic Material)

On a surface opposite to the back surface, an emulsion layer, an intermediate layer, a first layer of a protective layer and a second layer of the protective layer were simultaneously coated in a stacked manner in this order by using a slide bead application method, thereby to obtain a sample of a photothermographic material. At this time, temperatures of coating liquids of the emulsion layer and the intermediate layer were adjusted to be 31° C., while temperatures of the first layer of the protective layer and the second layer of the protective layer were adjusted to be 36° C. and 37° C., respectively.

Coated quantities (g/m²) of respective compounds in the emulsion layer are as follows:

| | |
|---|---|
| Silver behenate | 6.19 |
| Pigment (C. I. Pigment Blue 60) | 0.036 |
| Polyhalogen compound-1 | 0.04 |
| Polyhalogen compound-2 | 0.12 |
| Phthalazine compound-1 | 0.21 |
| SBR latex | 11.1 |
| Reducing agent complex-1′ | 1.54 |
| Mercapto compound-1 | 0.002 |
| Silver halide (in terms of Ag) | 0.10 |

Coating and Drying Conditions are as Follows:

Coating was performed at a speed of 160 m/min while keeping a gap between a leading end of a coating die and a support to be from 0.10 mm to 0.30 mm and keeping a pressure in a reduced pressure chamber lower by from 196 Pa to 882 Pa than the atmospheric pressure. The support was blown with ion wind before the coating to cancel electricity.

Next, the coated liquid was cooled in a chilling zone by blowing wind having a dry-bulb temperature of from 10° C. to 20° C. and, then, transferred into a helical non-contact type drying apparatus in a non-contact type manner and, thereafter, dried therein by a drying wind having a dry-bulb temperature of from 23° C. to 45° C. and a wet-bulb temperature of from 15° C. to 21° C. to obtain coating samples 21 to 27. After being dried, the thus-dried samples were conditioned at 25° C., from 40% RH to 60% RH and, then, a surface of the resultant layer was heated up to from 70° C. to 90° C. and, subsequently, cooled down to 25° C.

A degree of matting expressed by Beck smoothness of the thus-prepared photothermographic material was found to be 550 seconds for the photosensitive layer side and 130 seconds for the back surface side. Further, a pH of the layer surface on a photosensitive layer side was measured and found to be 6.0.

Chemical structures of compounds used in embodiments according to the invention are shown below.

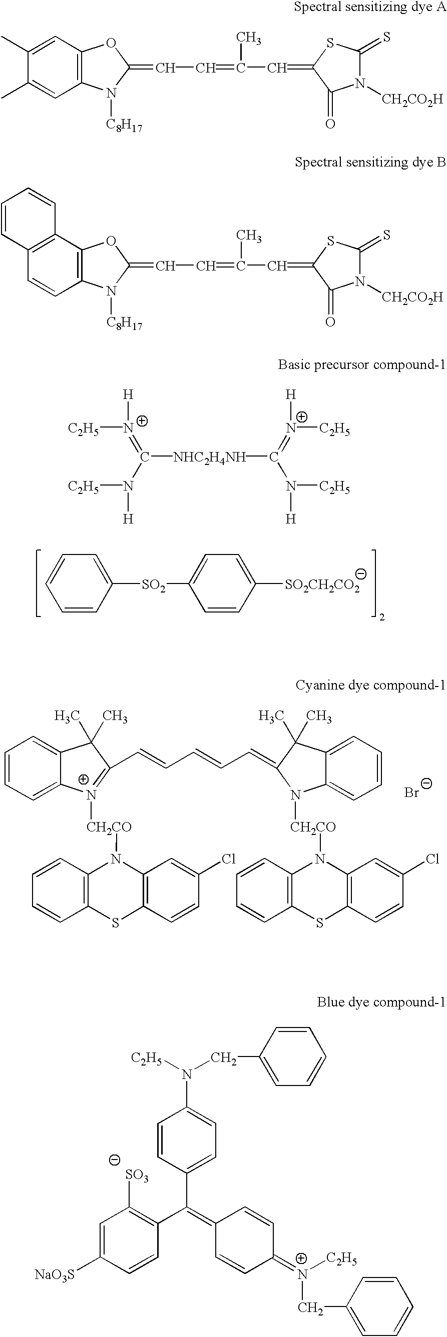

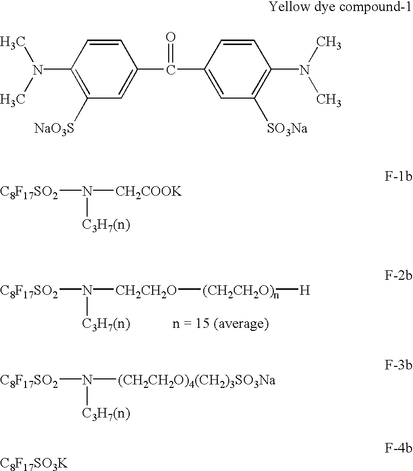

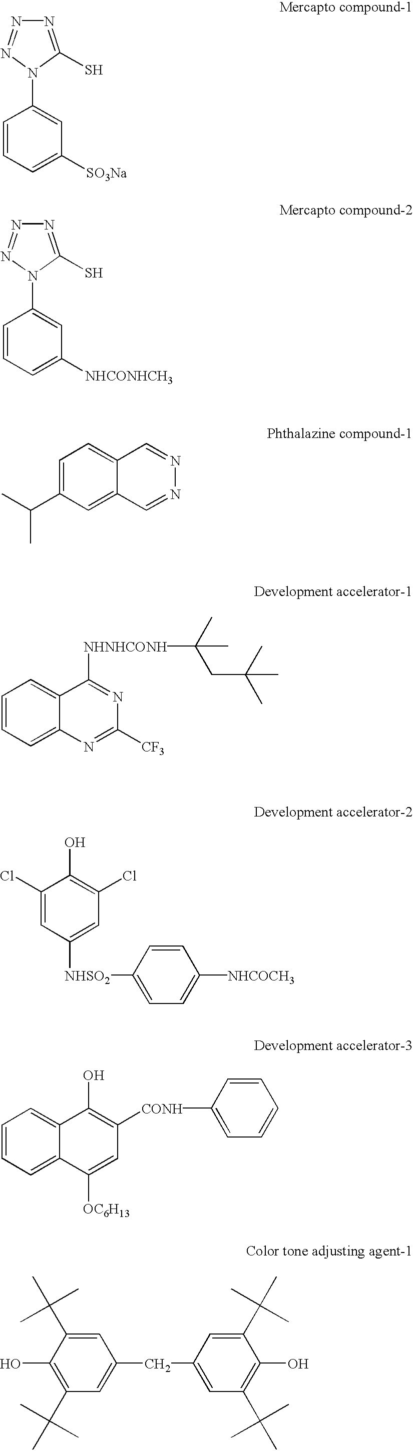

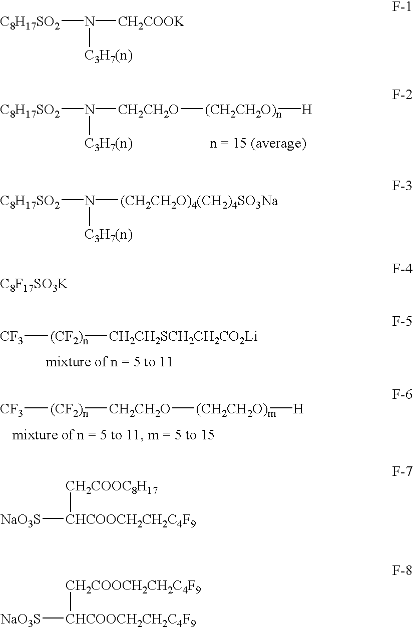

Evaluation of Photographic Performance

(Preparation)

The obtained samples were each cut out to be a size of 515 mm×728 mm, packaged by a packaging material described below under an atmosphere of 25° C. and 50% RH and stored at normal temperature for 2 weeks.

(Packaging Material)

PET: 10 μm/PE: 12 μm/aluminum foil: 9 μm/Ny: 15 μm/polyethylene containing 3% of carbon: 50 μm;

oxygen permeability: 0.02 ml/atm·m²·25° C.·day; and water permeability: 0.10 g/atm·m²·25° C.·day.

The above-described photothermographic material was evaluated in a manner as described below.

(Exposure of Photothermographic Material)

The photothermographic material was subjected to exposure processing in a manner as described below.

The obtained samples were exposed and thermally developed by a remodeled type of Fuji Medical Dry Laser Imager FM-DPL. Such exposure was performed by irradiating the photothermographic material with a semiconductor laser beam from a 660-nm semiconductor laser device having a maximum output of 60 mW (IIIB) provided in such a remodeled Fuji Medical Dry Laser Imager FM-DPL while stopping down a beam diameter to be 100 μm×100 μm. The exposure was performed by changing quantities of light exposure stepwise. Such development was performed by setting temperatures of 4 plates constituting a panel heater to be 112° C.-119° C.-121° C.-121° C. A time period of the exposure was 24 seconds in total.

(Evaluation of Sample)

The evaluations of obtained images were performed by measuring densities thereof by using a Macbeth-type densitometer and constructing a characteristic curve of density against a logarithm of a quantity of exposing light. Gamma which denotes gradation was measured by a method which was defined prior to construction of the characteristic curve. Further, a number of developed silver which contacted silver halide was measured in accordance with a previously defined method. As for sensitivity, an optical density of an unexposed portion was defined as fog (Dmin) while an optical density of an exposed portion which has been exposed to a largest amount of exposing light was defined as Dmax; on this occasion, a reciprocal number of an exposure amount which can obtain an optical density of Dmin+2.0 was defined as sensitivity. The thus-defined sensitivity was shown as a relative value against the sensitivity of a sample 1b which was taken as 100. It is found that, as the value is larger, the sensitivity is higher.

TABLE 10

| | Compound of | | | | | |
|---|---|---|---|---|---|---|
| | General Formula (I”) of | | | | | |
| | Present Invention | | | | | |
| Sample | | Quantity to be Added | | | Relative | |
| No. | | mol/mol Ag | Dₘᵢₙ | Dₘₐₓ | Sensitivity | Remarks |
| 1b | — | — | 0.18 | 4.0 | 100 | Comparative Example |
| 2b | 1 | 3 × 10⁻³ | 0.18 | 4.1 | 145 | Present Invention |
| 3b | 4 | 3 × 10⁻³ | 0.18 | 4.1 | 138 | Present Invention |
| 4b | 9 | 5 × 10⁻³ | 0.18 | 4.1 | 132 | Present Invention |
| 5b | 14 | 1 × 10⁻³ | 0.18 | 4.2 | 135 | Present Invention |
| 6b | 14 | 5 × 10⁻³ | 0.18 | 4.3 | 182 | Present Invention |
| 7b | 15 | 1 × 10⁻³ | 0.18 | 4.2 | 144 | Present Invention |
| 8b | 22 | 8 × 10⁻⁴ | 0.18 | 4.0 | 120 | Present Invention |
| 9b | 22 | 5 × 10⁻³ | 0.18 | 4.2 | 161 | Present Invention |
| 10b | 22 | 2 × 10⁻² | 0.19 | 4.3 | 194 | Present Invention |
| 11b | 26 | 3 × 10⁻³ | 0.18 | 4.1 | 148 | Present Invention |
| 12b | Comparative | 2 × 10⁻² | 0.19 | 4.0 | 110 | Comparative Example |
| | Compound-1 | | | | | |
| 13b | Comparative | 2 × 10⁻² | 0.21 | 4.0 | 105 | Comparative Example |
| | Compound-2 | | | | | |

As is apparent from the results, though sensitivity has increased to a small extent even when a known halogen acceptor was added to silver iodide, a remarkable increase of sensitivity was noticed by adding a compound according to the eighteenth embodiment of the invention. Further, Dmax has simultaneously increased in many cases. This was an unexpectedly favorable result.

### Example 13

A silver iodide emulsion was prepared in a same manner as in the silver halide emulsion 1b according to Example 12 except that a selenium sensitizer, that is, pentafluorophenyldiphenylphosphine selenide, was used in an amount of 5.1×10⁻⁴ mol/mol of Ag instead of tellurium sensitizer and, then, the thus-prepared silver iodide emulsion was divided to small portions which were then added with compounds as shown in Table 11; thereafter, coating samples 21b to 28b were prepared in a same manner as in Example 12. A comparative compound-1 and a comparative compound-2 are same compounds as those in Example 12, respectively. Subsequently, same processing was performed as in Example 12 to obtain results as shown in Table 11. The relative sensitivity was shown against that of sample 21b which was taken as 100.

TABLE 11

| | Compound of General Formula (I”) | | | | | |
|---|---|---|---|---|---|---|
| | of Present Invention | | | | | |
| Sample | | Quantity to be Added | | | Relative | |
| No. | | mol/mol Ag | Dₘᵢₙ | Dₘₐₓ | Sensitivity | Remarks |
| 21b | — | — | 0.18 | 3.8 | 100 | Comparative Example |
| 22b | 15 | 2 × 10⁻³ | 0.18 | 4.1 | 150 | Present Invention |
| 23b | 18 | 9 × 10⁻⁴ | 0.18 | 4.0 | 131 | Present Invention |
| 24b | 22 | 9 × 10⁻⁴ | 0.18 | 3.9 | 142 | Present Invention |
| 25b | 23 | 1 × 10⁻³ | 0.18 | 4.0 | 145 | Present Invention |
| 26b | 27 | 8 × 10⁻⁴ | 0.18 | 4.0 | 138 | Present Invention |
| 27b | Comparative | 2 × 10⁻² | 0.19 | 3.8 | 104 | Comparative Example |
| | Compound-1 | | | | | |
| 28b | Comparative | 2 × 10⁻³ | 0.18 | 3.8 | 100 | Comparative Example |
| | Compound-2 | | | | | |

As is apparent from Table 11, even in a silver iodide emulsion sensitized by selenium, a remarkable increase of sensitivity and, at the same time, an increase of Dmax were obtained by using the compound according to the eighteenth embodiment of the invention. On the other hand, only a small increase of sensitivity was noticed when a conventional compound was used.

### Example 14

A silver iodide emulsion was prepared in a same manner as in the silver halide emulsion according to Example 12 except that the sensitizing agents A and B and a tellurium sensitizer were not added to allow it to be in a non-chemically sensitized state and, then, divided into small portions and, thereafter, the resultant small portions were added with compounds as shown in Table 12 to obtain coating samples 31b to 39b in a same manner as in Example 12. Further, a comparative compound-1 and a comparative compound-2 are same compounds as those in Example 12, respectively. Subsequently, same processing was performed as in Example 12 except that a 405-nm blue laser beam was used. The results are shown in Table 12. On this occasion, a relative sensitivity was shown against that of the sample 31b which was taken as 100.

TABLE 12

| | Compound of General Formula (I”) | | | | | |
|---|---|---|---|---|---|---|
| | of present Invention | | | | | |
| Sample | | Quantity to be Added | | | Relative | |
| No. | | mol/mol Ag | Dₘᵢₙ | Dₘₐₓ | Sensitivity | Remarks |
| 31b | — | — | 0.18 | 3.3 | 100 | Comparative Example |
| 32b | 1 | 8 × 10⁻⁴ | 0.18 | 3.8 | 148 | Present Invention |
| 33b | 14 | 2 × 10⁻³ | 0.18 | 4.1 | 263 | Present Invention |
| 34b | 22 | 5 × 10⁻³ | 0.18 | 4.0 | 245 | Present Invention |
| 35b | 26 | 5 × 10⁻³ | 0.18 | 4.0 | 195 | Present Invention |
| 36b | 28 | 5 × 10⁻³ | 0.18 | 3.6 | 135 | Present Invention |
| 37b | 30 | 5 × 10⁻³ | 0.18 | 3.8 | 158 | Present Invention |
| 38b | Comparative | 5 × 10⁻³ | 0.18 | 3.4 | 108 | Comparative Example |
| | Compound-1 | | | | | |
| 39b | Comparative | 5 × 10⁻³ | 0.18 | 3.3 | 100 | Comparative Example |
| | Compound-2 | | | | | |

As is apparent from Table 12, when a silver iodide which was not chemically sensitized was used, a remarkable increase of sensitivity and an increase of Dmax were obtained by using a compound according to the invention. On the other hand, there was a small increase of sensitivity when a conventional compound was used.

### Example 15

As a result of performing thermal development for 14 seconds by changing a transfer speed of the thermal development apparatus, favorable increases in sensitivity and Dmax were obtained by using a compound according to the eighteenth embodiment of the invention in a same manner as in Example 14.

### Example 16

Image samples obtained by thermally developing samples 1b to 13b, samples 21b to 28b and samples 31b to 39b were exposed under a fluorescence light of 1000 luxes for 3 days and, as a result, none of the samples showed a printout phenomenon at all. All of the samples showed a high light fastness derived from the employment of silver iodide emulsion.

### Example 17

A photosensitive silver halide emulsion (pure silver iodide; average particle size: 0.029 μm) was prepared in a same manner as in the silver halide emulsion according to Example 12 except for changes described below.

(i) The addition time period of the solutions A and B was changed from 9 minutes to 3 minutes, while that of the solutions C and D was changed from 120 minutes to 40 minutes.

(ii) The quantity of the aqueous solution of potassium iron (II) hexacyanate to be added was changed from 3×10⁻⁴ mol/mol of Ag to 2×10⁻³ mol/mol of Ag.

(iii) The sensitizing dyes A and B were not added. (color sensitization not performed).

(iv) The tellurium sensitizer was not added. (chemical sensitization not performed).

The obtained silver halide emulsion was divided into small portions which were, then, added with components described in Table 13 and, thereafter, subjected to same procedures as those in Example 12 to obtain coating samples 41b to 50b.

The thus-obtained coating samples were thermally developed by being exposed by a 405-nm blue laser beam to examine photographic performance. The obtained results are shown in Table 13. As is apparent from Table 13, an increase of sensitivity and a remarkable increase of Dmax were obtained by adding the compound according to the invention to the silver iodide emulsion which has not been chemically sensitized.

TABLE 13

| | Compound of General Formula (I”) | | | | | |
|---|---|---|---|---|---|---|
| | of Present Invention | | | | | |
| Sample | Compound | Quantity to be Added | | | Relative | |
| No. | No. | mol/mol Ag | Dₘᵢₙ | Dₘₐₓ | Sensitivity | Remarks |
| 41b | — | — | 0.16 | 3.8 | 100 | Comparative Example |
| 42b | 1 | 6 × 10⁻³ | 0.16 | 4.4 | 141 | Present Invention |
| 43b | 4 | 3 × 10⁻³ | 0.16 | 4.3 | 152 | Present Invention |
| 44b | 17 | 3 × 10⁻³ | 0.16 | 4.6 | 150 | Present Invention |
| 45b | 39 | 8 × 10⁻³ | 0.16 | 4.6 | 184 | Present Invention |
| 46b | 42 | 3 × 10⁻³ | 0.16 | 4.6 | 161 | Present Invention |
| 47b | 44 | 8 × 10⁻³ | 0.16 | 4.6 | 173 | Present Invention |
| 48b | 47 | 8 × 10⁻³ | 0.16 | 4.6 | 178 | Present Invention |
| 49b | 48 | 8 × 10⁻³ | 0.16 | 4.3 | 140 | Present Invention |
| 50b | 57 | 3 × 10⁻³ | 0.16 | 4.4 | 144 | Present Invention |

### Example 18

A sample was prepared in a same manner as in Example 12 except that a reducing agent-2′ and a hydrogen bonding type compound-1 as described below were used instead of the reducing agent-1′ in the dispersions described below to evaluate photographic performance thereof in a same manner as in Example 12. On this occasion, the sample having a constitution according to the invention showed a same favorable result as in Example 12.

Preparation of Reducing agent-2′ Dispersion

A mixture of 10 kg of a reducing agent-2′ and 20 kg of a 10 mass % aqueous solution of a modified polyvinyl alcohol MP203 was added with 6 kg of water and thoroughly mixed therebetween to prepare a slurry. The thus-prepared slurry was fed by using a diaphragm pump to a lateral sand mill UVM-2 filled with zirconia beads having an average diameter of 0.5 mm, dispersed therein for 3 hours and 30 minutes, added with 0.2 g of a benzoisothiazolinone sodium salt and water such that a concentration of the reducing agent was adjusted to be 25 mass %, thereby to obtain a reducing agent-5′ dispersion. Reducing agent particles contained in the thus-obtained reducing agent dispersion were found to have a median diameter of 0.38 μm and a maximum particle diameter of 1.5 μm or less. The obtained reducing agent dispersion was filtered through a polypropylene filter having a pore diameter of 3.0 μm to separate dust or other foreign matters and then stored.

Preparation of Hydrogen Bonding Type Compound-1 Dispersion

A mixture of 10 kg of a hydrogen bonding type compound-1 and 20 kg of a 10 mass % aqueous solution of a modified polyvinyl alcohol MP203 was added with 10 kg of water and thoroughly mixed therebetween to prepare a slurry. The thus-prepared slurry was fed by using a diaphragm pump to a lateral sand mill UVM-2 filled with zirconia beads having an average diameter of 0.5 mm, dispersed therein for 3 hours and 30 minutes, added with 0.2 g of a benzoisothiazolinone sodium salt and water such that a concentration of the reducing agent was adjusted to be 22 mass %, thereby to obtain a hydrogen bonding type compound-1 dispersion. Hydrogen bonding type compound particles contained in the thus-obtained dispersion were found to have a median diameter of 0.35 μm and a maximum particle diameter of 1.5 um or less. The obtained reducing agent dispersion was filtered through a polypropylene filter having a pore diameter of 3.0 μm to separate dust or other foreign matters and then stored.

Coated quantities (g/m²) of respective compounds in the image forming layer are as follows:

| | |
|---|---|
| Silver behenate | 6.0 |
| Reducing agent-2′ | 0.76 |
| Hydrogen bonding type compound-1 | 0.59 |
| Pigment (C. I. Pigment Blue 60) | 0.032 |
| Polyhalogen compound-1 | 0.04 |
| Polyhalogen compound-2 | 0.12 |
| Phthalazine compound-1 | 0.21 |
| SBR latex | 11.1 |
| Mercapto compound-1 | 0.002 |
| Silver halide (in terms of Ag) | 0.09 |

### Example 19

A sample was prepared in a same manner as in Example 18 except that a reducing agent-3′ was used (added after being similarly changed into dispersion form) instead of the reducing agent-2′ and a dispersion of a development accelerator-1 as described below was added such that a quantity of the development accelerator is allowed to be 0.01 g/m².

When a feeding speed of a thermal development apparatus was changed such that a time period of thermal development was reduced to be 14 seconds to perform development processing, the sample having a constitution according to the invention showed a same favorable result as in Example 18.

Preparation of Development Accelerator-1 Dispersion

A development accelerator-1 dispersion was prepared in a same manner and under same conditions as in Example 1.

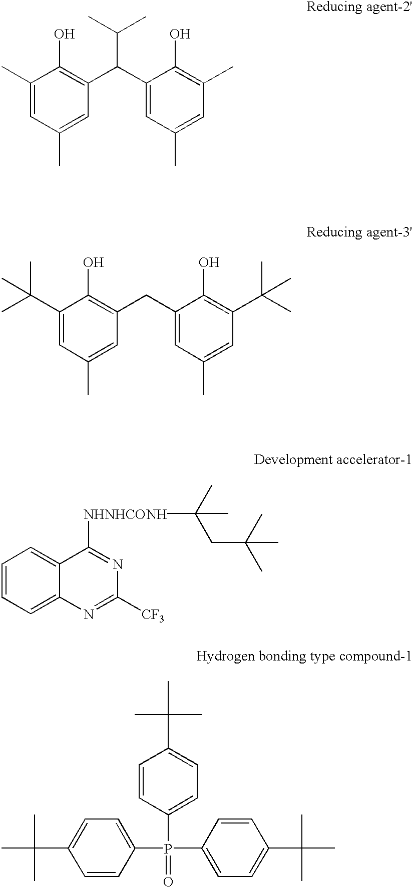

Thus, according to the present invention, the eighteenth embodiment of photothermographic materials having a high sensitivity, a low Dmin and a high Dmax can be provided.

Examples of Thirty-Sixth Embodiment

Then, the thirty-sixth embodiment of the photothermographic material according to this invention is to be described specifically by way of examples but the invention is not restricted to them.

### Example 20

Preparation and Surface Corona Treatment of PET Support

A PET support was prepared and applied with a surface corona treatment in the same manner and under the same conditions as those in Example 1 of the first embodiment of the photothermographic material according to this invention.

Preparation of Undercoated Support

An undercoated support was prepared by the same method and under the same conditions as those in Example 1.

Preparation of Coating Liquid for Back Surface

(Preparation of Solid fine particles dispersion (a″) of Basic Precursor)

64 g of a basic precursor compound 11, 28 g of diphenyl sulfone and 10 g of a surfactant DEMOL N manufactured by Kao Co. were mixed with 220 ml of distilled water and a liquid mixture was put to bead dispersion using a sand mill (¼ gallon sand grinder mill, manufactured by IMEX Co.) to obtain a solid fine particle liquid dispersion (a″) of a basic precursor compound with an average grain size of 0.2 μm.

(Preparation of Solid Fine Particle Dispersion of Dye)

9.6 g of a cyanine dye compound 13 and 5.8 g of sodium p-dodecylbenzene sulfonate were mixed with 305 ml of distilled water and the liquid mixture was put to bead dispersion by using a sand mill (¼ gallon sand grinder mill, manufactured by IMEX Co.) to obtain a solid fine particle dispersion of dye with an average grain size of 0.2 μm.

(Preparation of Coating Liquid for Anti-Halation Layer)

17 g of gelatin, 9.6 g of polyacrylamide, 70 g of solid fine particle liquid dispersion (a) of the basic precursor, 56 g of the solid fine particle dye liquid dispersion, 1.5 g of fine particle mono-dispersed polymethyl methacrylate (average grain size: 8 μm, grain size standard deviation: 0.4), 0.03 g of benzoisothiazolinone, 2.2 g of sodium polyethylene sulfonate, 0.2 g of a blue dye compound 14, 3.9 g of a yellow dye compound 15, and 844 ml of water were mixed to prepare an anti-halation layer coating liquid.

(Preparation of Coating Liquid for Protective Layer on Back Surface)

A vessel was kept at a temperature of 40° C., and 50 g of gelatin, 0.2 g of sodium polystyrene sulfonate, 2.4 g of N,N-ethylenebis(vinylsulfoneacetoamide), 1 g of sodium t-octylphenoxyethoxyethane sulfonate, 30 mg of benzoisothiazolinone, 37 mg of a fluoro-surfactant (F-1c: potassium N-perfluorooctylsulfonyl-N-propylalanine), 0.15 g of a fluoro-surfactant (F-2c: polyethylene glycol mono(N-perfluorooctylsulfonyl-N-propyl-2-aminoethyl) ether [ethylene oxide average polymerization degree 15]), 64 mg of a fluoro-surfactant (F-3c), 32 mg of a fluoro-surfactant (F-4c), 8.8 g of acrylic acid/ethyl acrylate copolymer (copolymer mass ratio 5/95), 0.6 g of aerosol OT (manufactured by American Cyanimide Co.), 1.8 g of liquid paraffin emulsion as liquid paraffin and 950 ml of water were mixed to obtain a back surface protective layer coating liquid.

Preparation of Silver Halide Emulsion

<Preparation of Silver Halide Emulsion 1c>

A solution formed by adding 4.3 ml of a 1 mass % potassium iodide solution and further adding 3.5 ml of sulfuric acid at 0.5 mol/L concentration and 36.7 g of gelatin phthalide to 1420 ml of distilled water was kept at a solution temperature of 42° C. while stirring in a stainless steel reaction pot, to which a solution A formed by adding distilled water to 22.22 g of silver nitrate to dilute to 195.6 ml and a solution B formed by diluting 21.8 g of potassium iodide with distilled water to 218 ml volume were added entirely at a constant flow rate for 9 min. Then, 10 ml of an aqueous 3.5 mass % solution of hydrogen peroxide was added and, further, 10.8 ml of an aqueous 10 mass % solution of benzimidazole were added. Further, a solution C formed by adding distilled water to 51.86 g of silver nitrate to dilute to 317.5 ml and a solution D formed by diluting 60 g of potassium iodide with distilled water to 600 ml volume were added in which the solution C was added entirely at a constant flow rate for 120 min, while the solution D was added by a controlled double jet method while keeping pAg at 8.1. Further, an aqueous solution of potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 sec after the completion of addition of the solution C. pH was adjusted to 3.8 by using sulfuric acid at 0.5 mol/L concentration, stirring was stopped and a precipitation/desalting/water washing step was conducted. pH was adjusted to 5.9 by using sodium hydroxide at 1 mol/L concentration to prepare a silver halide dispersion at pAg of 8.0.

The silver halide dispersion was kept at 38° C. while stirring, to which 5 ml of a methanol solution containing 0.34 mass % 1,2-benzoisothiazolin-3-one was added and, after 40 min, a methanol solution of a spectral sensitizer A and a sensitizer B at a 1:1 molar ratio was added by 1.2×10⁻³ mol as a total for the sensitizers A and B per 1 mol of silver and the temperature was elevated to 48° C. after one min. 20 min after the temperature elevation, a methanol solution of sodium benzenethiosulfonate was added by 7.6×10⁻⁵ mol per one mol of silver and, further five min after, sodium thiosulfate was added by 6.2×10⁻⁵ mol per one mol of silver and aged for 91 min. 1.3 ml of a methanol solution of 0.8 mass % N,N′-dihydroxy-N″-diethyl melamine was added and, further 4 min after, a methanol solution of 5-methyl-2-mercaptobenzimidazole was added by 4.8×10⁻³ mol per 1 mol of silver, and a methanol solution of 1-phenyl-2-heptyl-5-mercapto-1,3,4-triazole was added by 5.4×10⁻³mol per 1 mol of silver to prepare a silver halide emulsion 1c.

Particles in the silver halide emulsion that could be prepared were pure silver halide particles with an average sphere-equivalent diameter of 0.040 μm, and with 18% variation coefficient for the sphere-equivalent diameter. The particle size and the like were determined as an average for 1000 particles by using an electron microscope.

<Preparation of Mixed Emulsion for Coating Liquid>

A silver halide emulsion 1c was dissolved and benzothiazolium iodide was added as an aqueous 1 mass % solution by 7×10⁻³ mol per one mol of silver. Further, water was added such that the content of the silver halide per 1 kg of the emulsion mixture for coating liquid was 38.2 g as silver.

<Preparation of Fatty Acid Silver Dispersion>

A fatty acid silver dispersion was prepared in the same method and under the same conditions as those in Example 1.

(Preparation of Reducing Agent Dispersion)

<Preparation of Reducing Agent Complex-3c Dispersion>

7.2 kg of water was added to 10 kg of a reducing agent complex-3c (1:1 complex of 2,2′-methylenebis-(4-ethyol-6-tert-butylphenol) and triphenylphosphine oxide), 0.12 kg of triphenylphosphine oxide and 16 kg of an aqueous 10 mass % solution of modified polyvinyl alcohol (Poval MP203, manufactured by Kuraray Co.) and mixed thoroughly to prepare a slurry. After supplying the slurry by a diaphragm pump and dispersing the same by a lateral sand mill (UVM-2, manufactured by IMEX Co.) filled with zirconia beads of 0.5 mm in average diameter for 4 hours and 30 min, 0.2 g of benzothizolinone sodium salt and water were added such that the concentration of the reducing agent complex was 25 mass %, to obtain a reducing agent complex -3 dispersion. The reducing agent complex particles contained in the thus obtained reducing agent complex dispersion had an median diameter of 0.46 μm and a maximum grain size of 1.6 μm or less. The resultant reducing agent complex dispersion was filtered through a filter made of polypropylene with a pore size of 3.0 μm, to remove obstacles such as dusts and then stored.

(Preparation of Polyhalogen Compound)

<Preparation of Organic Polyhalogen Compound-2c Dispersion>

10 kg of an organic polyhalogen compound-2c (tribromomethane sulfonyl benzene), 10 kg of an aqueous 20 mass % solution of modified polyvinyl alcohol (Poval MP203, manufactured by Kuraray Co.), 0.4 kg of an aqueous 20 mass % solution of sodium triisopropyl naphtnalene sulfonate, and 14 kg of water were added and mixed thoroughly to form a slurry. After supplying the slurry by a diaphragm pump and dispersing the same in a lateral sand mill (UVM-2: manufactured by IMEX Co.) filled with zirconia beads of 0.5 mm in average diameter, 0.2 g of benzoisothazoline sodium salt and water were added such that the concentration of the organic polyhalogen compound was 26 mass %, to obtain an organic polyhalogen compound-2c dispersion. The organic polyhalogen compound particles contained in the polyhalogen compound dispersion thus obtained had 0.41 μm of a median diameter and 2.0 μm or less of a maximum grain size. The obtained dispersion of the organic polyhalogen compound was filtered through a polypropylene filter with a pore size of 10.0 μm to remove obstacles such as dusts and then stored.

<Preparation of Organic Polyhalogen Compound-3c Dispersion>

10 kg of an organic polyhalogen compound -3c (N-butyl-3-tribromomethane sulfonyl benzamide), 20 kg of an aqueous 20 mass % solution of modified polyvinyl alcohol (Poval MP203, manufactured by Kuraray Co.), 0.4 kg of an aqueous 20 mass % solution of sodium triisopropyl naphtnalene sulfonate, and 8 kg of water were added and mixed thoroughly to form a slurry. After supplying the slurry by a diaphragm pump and dispersing the same in a lateral sand mill (UVM-2: manufactured by IMEX Co.) filled with zirconia beads of 0.5 mm in average diameter, 0.2 g of sodium benzoisothazoline salt and water were added such that the concentration of the organic polyhalogen compound was 25 mass %. The liquid dispersion was warmed to 40° C. for 5 hours to obtain an organic polyhalogen compound-3c dispersion. The organic polyhalogen compound particles contained in the polyhalogen compound dispersion thus obtained had 0.36 μm of a median diameter and 1.5 μm or less of a maximum grain size. The obtained dispersion of the organic polyhalogen compound was filtered through a polypropylene filter with a pore size of 3.0 μm to remove obstacles such as dusts and then stored.

<Preparation of Phthalazine Compound-1c Solution>

8 kg of modified polyvinyl alcohol MP203 manufactured by Kuraray Co. was dissolved in 174.57 kg of water and then 3.15 kg of an aqueous 20 mass % solution of sodium triisopropyl naphthalene sulfonate and 14.28 kg of an aqueous 70 mass % solution of phthalazine compound-1c (6-isopropylphthalazine) were added to prepare a 5 mass % solution of a phthalazine compound-1c.

<Preparation of Aqueous Solution of Mercapto Compound-1 c>

7 g of mercapto compound-1c (1-(3-sulfophenyl)-5-sodium mercaptotetrazole) was dissolved in 993 g of water to form an aqueous 017 mass % solution.

<Preparation of Dye-1 Dispersion>

The dye-i dispersion was prepared by the same method and under the same conditions as those in Example 1 of this invention.

<Preparation of SBR Latex Liquid>

SBR latex with Tg=23° C. was prepared as described below.

After emulsion polymerization of 70.5 mass parts of styrene, 26.5 mass parts of butadiene and 3 mass parts of acrylic acid by using ammonium persulfate as a polymerization initiator and an anionic surfactant as an emulsifier, they were aged at 80° C. for 8 hours. Then they were cooled to 40° C. and adjusted to pH 7.0 with aqueous ammonia, and SANDET BL manufactured by Sanyo Kasei Co. was added so as to be 0.22%. Then, an aqueous 5% sodium hydroxide solution was added to adjust pH to 8.3 and, pH was further adjusted to 8.4 with aqueous ammonia. The molar ratio between Na⁺ ions and NH₄⁺ ions used herein was 1:2.3. Further, 0.15 ml of an aqueous 7% solution of sodium benzoisothiazolinone was added to 1 kg of the liquid to prepare an SBR latex liquid.

(SBR latex: St(70.5)-Bu(26.5)-AA(3)-latex)

Tg=23° C., average grain size: 0.12 μm, concentration: 43 mass %, equilibrium water content at 25° C., 60% RH: 0.6 mass %, ionic conductivity: 4.2 mS/cm (ionic conductivity was measured for a latex stock liquid (43 mass %) at 25° C. by using a conductivity meter CM-30S manufactured by Toa Denpa Industry Co.), pH: 8.4.

SBR latexes of different Tg were prepared by the same method while properly changing the styrene and butadiene ratio.

<Preparation of Emulsion Layer (Light Sensitive Layer (Image Forming Layer)) Coating Liquid-1c>

1000 g of the fatty acid silver dispersion obtained as described above, 104 ml of water, 30 g of dye-1 dispersion, 6.3 g of organic polyhalogen compound-2c dispersion, 20.7 g of organic polyhalogen compound-3c dispersion, 173 g of a phthalazine compound-1c solution, 1082 g of SBR latex (Tg=23° C.) liquid, 258 g of a reducing agent complex-3c dispersion and 9 g of mercapto compound-1c solution were added successively, and the silver halide mixed emulsion was added and mixed thoroughly such that the amount thereof to the organic acid silver salt as shown in Table 14 just before coating, and the emulsion layer coating liquid was supplied as it was to a coating die and coated.

<Preparation of Emulsion Surface Intermediate Layer Coating Liquid>

To 772 of an aqueous 10 mass % solution of polyvinyl alcohol PVA-205 (manufactured by Kuraray Co.), 4.3 g of 28 mass % dispersion of the dye, and 226 g of a liquid of 27.5 mass % of methyl methacrylate/styrene/butylacrylate/hydroxyethyl methacrylate/acrylic acid copolymer latex (copolymer mass ratio: 64/9/20/5/2), were added 2 ml of an aqueous 5 mass % solution of aerosol OT (manufactured by American Cyanamide Co.), 10.5 ml of an aqueous 20 mass % solution of 2-ammonium phthalate and water to make-up the total amount to 880 g, and pH was adjusted to 7.5 with NaOH to form a intermediate layer coating liquid, which was then supplied to a coating die so as to be 10 ml/m².

The viscosity of the coating liquid was 65[mPa·s] when measured by a B-type viscometer at 40° C. (No. 1 rotor, 60 rpm).

<Preparation of Coating Liquid For first Emulsion Surface Protective Layer>

The coating liquid for a first emulsion surface protective layer was prepared in the same manner and under the same conditions as those in Example 1 of this invention.

<Preparation of Coating Liquid for Second Emulsion Surface Protective Layer>

80 g of inert gelatin was dissolved in water, and water to make-up the total to 650 g was added to 102 g of 27.5 mass % methyl methacrylate/styrene/butylacrylate/hydroxyethyl methacrylate/acrylic acid copolymer (copolymerization mass ratio: 64/9/20/5/2) latex liquid, 3.2 ml of a 5 mass % solution of fluoro surfactant (F-1c: potassium N-perfluorooctylsulfonyl-N-propylaniline salt), 32 ml of an aqueous 2 mass % solution of fluoro surfactant (F-2c: polyethylene glycol mono(N-perfluorooctylsulfonyl-N-propyl-2-aminoethyl ether [ethylene oxide average polymerization degree=15]), 23 ml of a 5 mass % solution of aerosol OT (manufactured by American Cyanamide Co.), 4 g of fine polymethyl methacrylate particles (average grain size 0.7 μm), 21 g of fine polymethyl methacrylate particles (average grain size 4.5 μm), 1.6 g of 4-methyl phthalic acid, 4.8 g of phthalic acid, 44 ml of sulfuric acid at 0.5 mol/L concentration and 10 mg of benzoisothiazolinone, to which 445 ml of an aqueous solution containing 4 mass % of chromium alum and 0.67 mass % of phthalic acid were mixed by a static mixer just before coating to prepare a surface protective layer coating liquid and it was supplied to a coating die so as to be 8.3 ml/m².

The viscosity of the coating liquid was 19 [mPa·s] when measured by a B-type viscometer at 40° C. (No. 1 rotor, 60 rpm).

<Preparation of Photothermographic Material-1c>

An anti-halation layer coating liquid was coated such that the solid coating amount of fine solid dye particles was 0.04 g/m² and a back surface protection layer coating liquid was coated such that the gelatin coating amount was 1.7 g/m² simultaneously in stack on the back surface of the undercoated support, which were dried to prepare a back layer.

An emulsion layer, an intermediate layer, a first protective layer and a second protective layer were coated simultaneously in stack from the substratum surface on the side opposite to the back surface by a slide bead coating method to prepare a sample of a photothermographic material. In this case, the temperature was adjusted to 35° C. for the emulsion layer and the intermediate layer, to 36° C. for the first protective layer and to 37° C. for the second protective layer.

The coating amount for each of the compounds of the emulsion layer (g/m²) is as shown below.

| | |
|---|---|
| Silver behenate | 6.19 |
| Dye (C.I. Pigment Blue 60) | 0.036 |
| Polyhalogen compound-2c | 0.04 |
| Polyhalogen compound-3c | 0.12 |
| phthalazine compound-1c | 0.21 |
| SBR latex | 11.1 |
| Reducing agent complex-3c | 1.54 |
| Mercapto compound-1c | 0.002 |
| Silver halide (As Ag) | 0.10 |

The coating and drying conditions are as follows.

Coating was conducted at a speed of 160 m/min with the gap between the top end of the coating die and the support as 0.10-0.30 mm and the pressure in a depressurization chamber was set lower by 196-882 Pa relative to the atmospheric pressure. Static charges on the support were eliminated by an ionic blow before coating.

In the subsequent chilling zone, after cooling the coating liquid by a blow at a dry-bulb temperature of 10-20° C., it was conveyed in a contactless manner and dried in a helical contactless type drying apparatus by a drying blow at a dry-bulb temperature of 23 to 45° C. and a wet-bulb temperature of 15 to 21° C.

After drying and after controlling the humidity to 40-60% RH at 25° C., it was heated such that the film surface was at 70 to 90° C. After heating, the film surface was cooled to 25° C.

The degree of matte of the thus prepared photothermographic material was 550 sec on the side of the light sensitive layer and 130 sec on the back surface being expressed as the Beckmann smoothness. Further, pH at the film surface on the side of the light sensitive layer was measured to be 6.0.

Chemical structures of compounds used in examples of the invention are shown below.

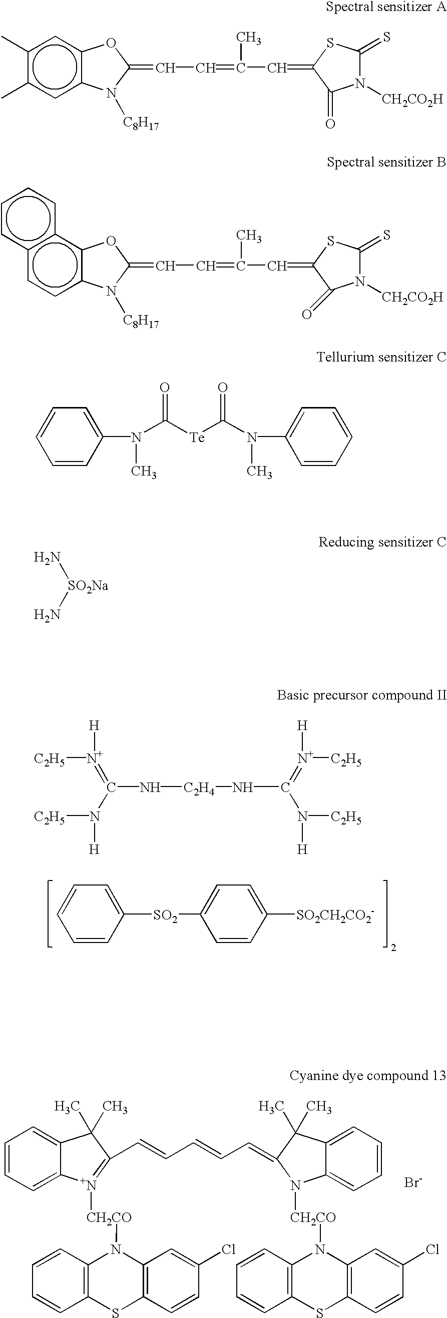

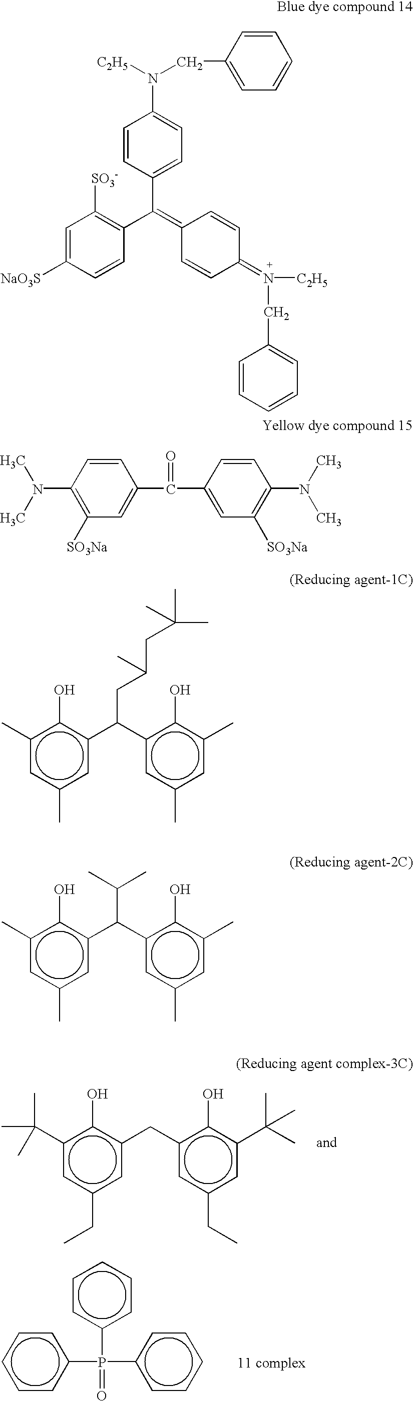

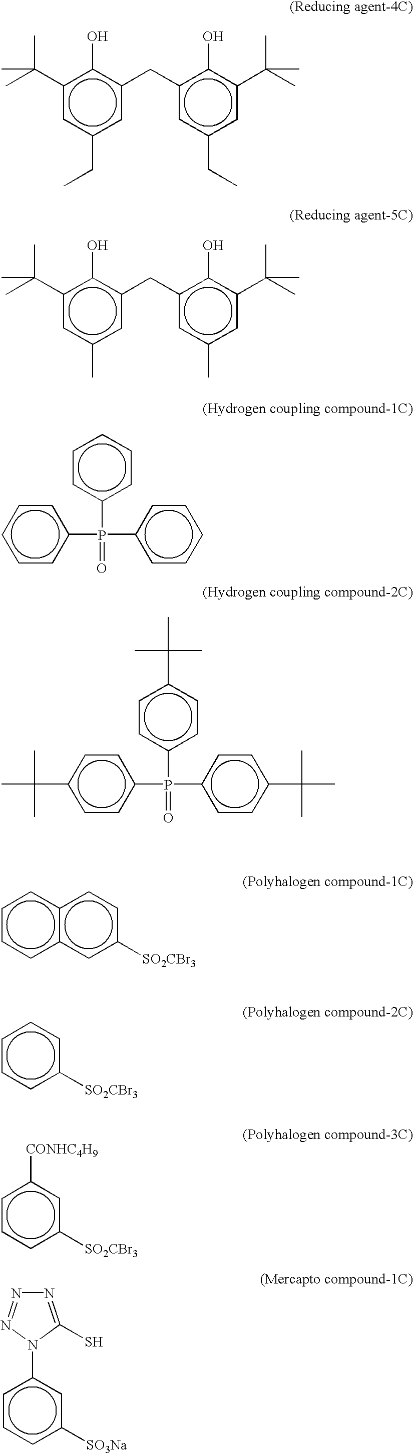

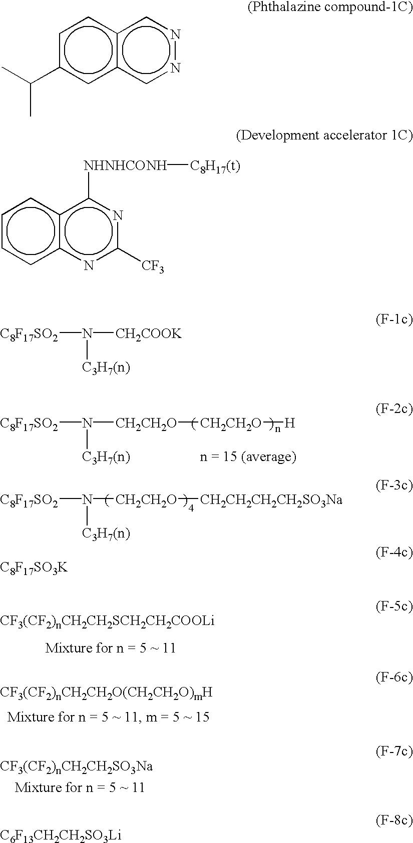

The obtained samples were cut each into a half-cut size, packaged by the following packaging material in an environment at 25° C., 50% RH, stored at a normal temperature for 2 hours and then evaluated as shown below.

(Packaging Material)

PET 10 μm/PE 12 μm/aluminum foil 9 μm/Ny 15 μm/3% carbon containing polyethylene 50 μm;

oxygen permeation rate: 0 ml/atm·m²·25° C.·day, water permeability: 0 g/atm·m²·25° C.·day

<Preparation of Silver Halide Emulsion 2c>

A silver halide emulsion 2c was prepared in the same manner as in the silver halide emulsion 1c except for adding triphenyl phosphine selenide by 1.2×10⁻⁴ mol per one mol of silver, instead of sodium thiosulfate in the silver halide emulsion lc.

<Preparation of Silver Halide Emulsion 3c>

A silver halide emulsion 3c was prepared in the same manner as in the silver halide emulsion 1c except for adding tellurium sensitizer B in a methanol solution by 2.9×10⁻⁴ mol per one mol of silver, instead of sodium thiosulfate in the silver halide emulsion 1c.

<Preparation of Silver Halide Emulsion 4c>

A silver halide emulsion 4c was prepared in the same manner as in the silver halide emulsion 1c except for adding chloroauric acid by 4×10⁻⁵ mol per one mol of silver, instead of sodium thiosulfate in the silver halide emulsion 1c.

<Preparation of Silver Halide Emulsion 5c>

A silver halide emulsion 5c was prepared in the same manner as in the silver halide emulsion 1c except for adding chloroauric acid by 4×10⁻⁵ mol and potassium thiocyanate by 8×10⁻⁴ mol per one mol of silver, instead of sodium thiosulfate in the silver halide emulsion 1c.

<Preparation of Silver Halide Emulsion 6c>

A silver halide emulsion 6c was prepared in the same manner as in the silver halide emulsion 1c except for adjusting pH to 10.5 by 1 N sodium hydroxide instead of sodium thiosulfate in the silver halide emulsion 1c, adding a reducing sensitizer C by 1.6×10⁻² per one mol of silver, aging for 91 min and then adjusting pH to 6.0 by 1 N sulfuric acid.

<Preparation of Silver Halide Emulsion 7c>

A silver halide emulsion 7c was prepared in the same manner as in the silver halide emulsion 1c except for adjusting pAg to 5.5 by 10 mass % silver nitrate instead of sodium thiosulfate in the silver halide emulsion 1c, adding the reducing sensitizer C by 1.6×10⁻² mol per one mol of silver, aging for 91 min. and then adjusting pAg to 9.0 by 10 mass % of potassium bromide.

<Preparation of Silver Halide Emulsion 8c>

A silver halide emulsion 8c was prepared in the same manner as in the silver halide emulsion 1c except for adjusting pH to 10.5 by 1 N sodium hydroxide, instead of sodium thiosulfate in the silver halide emulsion 1c, adjusting pAg to 5.5 by 10 mass % silver nitrate, adding the reducing sensitizer C by 1.6×10⁻² mol per one mol of silver, aging for 91 min, and then adjusting pH to 6.0 by 1 N sulfuric acid and pAg to 9.0 by 10 mass % potassium bromide.

<Preparation of Silver Halide Emulsion 9c>

A silver halide emulsion 9c was prepared in the same manner as in the silver halide emulsion 1c except for adding sodium thiosulfate, adjusting pH to 10.5 by 1 N sodium hydroxide, adjusting pH to 5.5 by 10 mass % silver nitrate, adding a reducing sensitizer C by 1.6×10⁻² mol per one mol of silver and aging for 91 min. and then adjusting pH to 6.0 by 1 N sulfuric acid and adjusting pAg to 9.0 by 10 mass % potassium bromide in the silver halide emulsion 1c.

Photothermographic materials 2c-9c were prepared in the same manner as in Example 20 except for using silver halide emulsions 2c-9c instead of the silver halide emulsion 1c.

### Comparative Example 1

<Preparation of Silver Halide Emulsion 10c>

A silver halide emulsion 10c was prepared in the same manner as in the silver halide emulsion 1c except for not adding sodium thiosulfate in the silver halide emulsion 1c. A photothermographic material 10c was prepared in the same manner as in Example 20 except for using the silver halide emulsion 10c instead of the silver halide emulsion 1c.

(Evaluation for Photographic Performance)

Samples were subjected to exposure and development by using a modified Fuji Medical dry laser imager FM-DPL.

In exposure, the light sensitive materials were irradiated while restricting a semiconductor laser at 660 nm with maximum 60 mW (111B) power mounted on FM-DPL to 100 lm×100 μm. Exposure was conducted while changing the exposure amount of the laser stepwise. Development was conducted by using a thermal developing station of FM-DPL while setting the temperature for four sheets of panel heaters to 112° C.→119° C.→121° C.→121° C. The developing time was set to 24 sec. For the evaluation of images obtained after exposure and development, density was measured by Macbeth densitometer to prepare characteristic curves of density relative to the exposure amount.

In the samples after the developing treatment, the density for a portion not exposed to the laser was defined as Dmin, while the density for a portion exposed to the maximum exposure amount was defined as Dmax. Further, the reciprocal to the exposure amount providing a density of Dmin+1.0 was defined as sensitivity, which was expressed by a relative value to a standard sensitive material.

(Evaluation for Print Out Performance)

Samples after the treatment were placed in a circumstance at 37° C., 70% RH and were left for three days under a fluorescent lamp with a luminosity of 1000 lux. Increase in the density for the fogged portion to that before the treatment was defined as the print out performance.

Table 14 shows the result for the measurement of samples 1c-10c as described above.

TABLE 14

| | | | | Silver halide | | | | | |
|---|---|---|---|---|---|---|---|---|---|
| | | | | Coating | | | | | |
| | | | | Amount | | | | | |
| | Silver halide emulsion | | | (Based on | | | | | |
| Sample | Emulsion | Halogen | Grain | Organic | | | Relative | Print- | |
| No. | No. | composition | size | Acid(mol %)) | Dₘᵢₙ | Dₘₐₓ | Sensitivity | out | Remarks |
| 1c | Emulsion 1c | AgI₁₀₀ | 40 nm | 6.6% | 0.18 | 4.0 | 110 | 0.01 | Present |
| | | | | | | | | | Invention |
| 2c | Emulsion 2c | AgI₁₀₀ | 40 nm | 6.6% | 0.19 | 4.2 | 112 | 0.01 | Present |
| | | | | | | | | | Invention |
| 3c | Emulsion 3c | AgI₁₀₀ | 40 nm | 6.6% | 0.19 | 3.9 | 108 | 0 | Present |
| | | | | | | | | | Invention |
| 4c | Emulsion 4c | AgI₁₀₀ | 40 nm | 6.6% | 0.20 | 4.1 | 140 | 0.02 | Present |
| | | | | | | | | | Invention |
| 5c | Emulsion 5c | AgI₁₀₀ | 40 nm | 6.6% | 0.19 | 4.3 | 131 | 0.02 | Present |
| | | | | | | | | | Invention |
| 6c | Emulsion 6c | AgI₁₀₀ | 40 nm | 6.6% | 0.18 | 3.9 | 115 | 0.01 | Present |
| | | | | | | | | | Invention |
| 7c | Emulsion 7c | AgI₁₀₀ | 40 nm | 6.6% | 0.18 | 4 | 150 | 0.01 | Present |
| | | | | | | | | | Invention |
| 8c | Emulsion 8c | AgI₁₀₀ | 40 nm | 6.6% | 0.19 | 4.2 | 174 | 0.02 | Present |
| | | | | | | | | | Invention |
| 9c | Emulsion 9c | AgI₁₀₀ | 40 nm | 6.6% | 0.18 | 4.1 | 203 | 0.01 | Present |
| | | | | | | | | | Invention |
| 10c | Emulsion | AgI₁₀₀ | 40 nm | 6.6% | 0.17 | 4 | 100 | 0.01 | Comparative |
| | 10c | | | | | | | | Example |

As apparent from the result, it can be seen that the samples of the thirty-sixth embodiment according to this invention have high sensitivity, excellent print out performance, low Dmin and high Dmax.

### Example 22

Silver halide emulsions 11c-14c were prepared in the same manner as ((preparation of silver halide emulsion 9c)) in Example 21 except for changing the grain size as described in Table 15 by changing the temperature upon formation of particles of the silver halide emulsion. In the same manner, emulsions 15c-20c of different halogen compositions described in Table 15 were prepared by changing the halogen composition. Thermophotografic materials 11c-20c described in Table 15 were prepared in the same manner as in Example 20 except for changing the coating amount of the silver halide.

Table 15 shows the result for the evaluation of samples 11c-20c in the same manner as in Examples 20 and 21.

TABLE 15

| | |
|---|---|
| | Silver halide |
| | Coating |
| | Amount |
| Silver halide emulsion | (Based on |

| Sample | Emulsion | Halogen | Grain | Organic | | | Relative | Print- | |
|---|---|---|---|---|---|---|---|---|---|
| No. | No. | composition | size | Acid(mol %)) | Dₘᵢₙ | Dₘₐₓ | Sensitivity | out | Remarks |
| 11c | Emulsion 11c | AgI₁₀₀ | 35 nm | 6.6% | 0.18 | 4.3 | 133 | 0.01 | Present |
| | | | | | | | | | Invention |
| 12c | Emulsion 12c | AgI₁₀₀ | 60 nm | 6.6% | 0.18 | 4.2 | 140 | 0.01 | Present |
| | | | | | | | | | Invention |
| 13c | Emulsion 13c | AgI₁₀₀ | 80 nm | 6.6% | 0.18 | 3.9 | 165 | 0.01 | Present |
| | | | | | | | | | Invention |
| 14c | Emulsion 14c | AgI₁₀₀ | 120 nm | 6.6% | 0.20 | 3.3 | 220 | 0.02 | Present |
| | | | | | | | | | Invention |
| 15c | Emulsion 15c | AgBr_{96.5}I_{3.5} | 40 nm | 6.6% | 0.19 | 4.3 | 105 | 0.22 | Comparative |
| | | | | | | | | | Example |
| 16c | Emulsion 16c | AgBr₆₅I₃₅ | 40 nm | 6.6% | 0.18 | 4.1 | 118 | 0.06 | Present |
| | | | | | | | | | Invention |
| 17c | Emulsion 17c | AgBr₁₀I₉₀ | 40 nm | 6.6% | 0.18 | 4 | 149 | 0.03 | Present |
| | | | | | | | | | Invention |
| 18c | Emulsion 18c | AgI₁₀₀ | 60 nm | 3.3% | 0.19 | 4.2 | 144 | 0.02 | Present |
| | | | | | | | | | Invention |
| 19c | Emulsion 19c | AgI₁₀₀ | 60 nm | 10% | 0.18 | 4.1 | 152 | 0.00 | Present |
| | | | | | | | | | Invention |
| 20c | Emulsion 20c | AgI₁₀₀ | 60 nm | 21% | 0.31 | 4.4 | 156 | 0.01 | Present |
| | | | | | | | | | Invention |

It can be seen that the particle size in the silver halide of this invention is preferably 90 nm or less for suppressing Dmin (fogging) and increasing Dmax and in view of image storability. Further, since Dmin is increased when silver halide exceeds 10 mol % relative to 1 mol of a non-light sensitive organic acid silver salt, it is preferably 10 mol % or less. Further, it can be seen that the silver iodide content in the halogen composition is preferably 5 mol % or more for improving the sensitivity of this invention.

### Example 23

A photothermographic material 21c was prepared in the same manner as the sample 11c in Example 22 except for using a mixture of emulsion 11c and emulsion 12c at 8:2 instead of emulsion 11c. As a result of evaluation in the same manner as in Example 21, a preferred result was obtained.

### Example 24

A photothermographic material was prepared in the same manner as the sample 3c in Example 21 except for using the following compounds instead of the reducing agent complex.

<Preparation of Reducing Agent-5c Dispersion>

6 kg of water was added to 10 kg of a reducing agent-5c (2,2′-methylene-bis(4-methyl-6-tart-butyl phenol)), and 20 kg of an aqueous 10 mass % solution of modified polyvinyl alcohol) Poval MP203 manufactured by Kuraray Co.) and stirred thoroughly to form a slurry. After supplying the slurry by a diaphragm pump and dispersing the same for 3 hours and 30 min in a lateral type sand mill (UVM-2: IMEX Co.) filled with zirconia beads having an average diameter of 0.5 mm, 0.2 g of sodium benzoisothiazolinone and water to adjust the concentration of the reducing agent was reduced to 25 mass % to obtain a reducing agent-5c dispersion product. The reducing agent particles contained in the thus obtained reducing agent dispersion had 0.38 μm of a medium diameter and 15 μm or less of a maximum grain size. The obtained reducing agent dispersion was filtered by using a polypropylene filter with a pore size of 3.0 μm to remove obstacles such as dust and then stored.

<Preparation of Hydrogen Coupling Compound-2c Dispersion>

10 kg of water was added to 10 kg of a hydrogen coupling compound-2c (tri(4-t-butylphenyl)phosphine oxide), and 20 kg of an aqueous 10 mass % solution of modified polyvinyl alcohol (Poval MP203, manufactured by Kuraray Co.) and thoroughly stirred to form a slurry. After supplying the slurry by a diaphragm pump and dispersing the same for 3 hours and 30 min in a lateral type sand mill (UVM-2: IMEX Co.) filled with zirconia beads having an average diameter of 0.5 mm, 0.2 g of sodium benzoisothiazolinone and water to adjust the concentration of the reducing agent was reduced to 22 mass % to obtain a hydrogen coupling compound-2c dispersion product. The reducing agent particles contained in the thus obtained reducing agent dispersion had 0.35 μm of a medium diameter and 1.5 μm or less of a maximum grain size. The obtained reducing agent dispersion was filtered by using a polypropylene filter with a pore size of 3.0 μm to remove obstacles such as dust and then stored.

<Preparation of Photothermographic Material 22c>

A photothermographic material 22c was prepared in the same manner as the sample 3c in Example 21 except for using the reducing agent-5c and the hydrogen coupling compound-2c instead of the reducing agent-3c.

The coating amount for each of the compounds of the emulsion layer (g/m²) is as shown below.

| | |
|---|---|
| Silver behenate | 6.0 |
| Reducing agent-5c | 0.76 |
| Hydrogen coupling compound-2c | 0.59 |
| Dye (C.I. Pigment Blue 60) | 0.032 |
| Polyhalogen compound-2c | 0.04 |
| Polyhalogen compound-3c | 0.12 |
| phthalazine compound-1c | 0.21 |
| SBR latex | 11.1 |
| Mercapto compound-1c | 0.002 |
| Silver halide (As Ag) | 0.09 |

As a result of evaluation in the same manner as in Example 21, a preferred result was obtained.

### Example 25

A photothermographic material 23c was prepared by preparing a dispersion in the same manner using the compound I-2 instead of the educing agent 5c in Example 24.

As a result of conducting development for a thermal development time of 14 sec by changing the conveying speed of a thermal developing machine, preferred sensitivity and gradation were obtained.

The thirty-sixth embodiment of the present invention can provide a photothermographic material having high sensitivity, low Dmin, high Dmax and excellent image storability to light irradiation after treatment.

Examples of Forty-Fourth Embodiment

Then, the forty-fourth embodiment of the photothermographic material according to this invention is to be described specifically by way of examples but the invention is not restricted to the forty-fourth embodiment.

### Example 26

Preparation of Photothermographic Materials 26A -26J

(Preparation and Surface Corona Treatment of PET Support)

A PET support was prepared and applied with a surface corona treatment in the same manner and under the same conditions as those in Example 1 in the first embodiment according to this invention.

(Preparation of Undercoated Support)

An undercoated support was prepared by the same method and under the same conditions as those in Example 1.

(Preparation of Back Surface Coating Liquid)

<Preparation of Anti-Halation Layer Coating Liquid>

17 g of gelatin, 9.6 g of polyacrylamide, 1.5 g of fine particle mono-dispersed polymethyl methacrylate (average grain size: 8 μm, grain size standard deviation: 0.4), 0.03 g of benzoisothiazolinone, 2.2 g of sodium polyethylene sulfonate, 0.1 g of a blue dye compound-1, 0.1 g of a yellow dye compound-1, and 844 ml of water were mixed to prepare an anti-halation layer coating liquid.

<Preparation of Back Surface Protective Layer Coating Liquid>

A vessel was kept at a temperature of 40° C., and 50 g of gelatin, 0.2 g of sodium polystyrene sulfonate, 2.4 g of N,N-ethylenebis(vinylsulfoneacetoamide), 1 g of sodium t-octylphenoxyethoxyethane sulfonate, 30 mg of benzoisothiazolinone, 37 mg of a fluoro-surfactant (F-1d: potassium N-perfluorooctylsulfonyl-N-propylalanine), 150 mg of a fluoro-surfactant (F-2d: polyethylene glycol mono(N-perfluorooctylsulfonyl-N-propyl-2-aminoethyl) ether [ethylene oxide average polymerization degree 15]), 64 mg of a fluoro-surfactant (F-3d), 32 mg of a fluoro-surfactant (F-4d), 10 mg of a fluoro-surfactant (F-7d), 5 mg of fluoro-surfactant (F-8d), 8.8 g of acrylic acid/ethyl acrylate copolymer (copolymer mass ratio 5/95), 0.6 g of aerosol OT (manufactured by American Cyanamide Co.), 1.8 g of liquid paraffin emulsion as liquid paraffin and 950 ml of water were mixed to obtain a back surface protective layer coating liquid.

(Image Forming Layer, Intermediate Layer and Surface Protective Layer)

Preparation of Silver Halide Emulsion

<Preparation of Silver Halide Emulsion 1d>

A solution formed by adding 4.3 ml of a 1 mass % potassium iodide solution and further adding 3.5 ml of sulfuric acid at 0.5 mol/L concentration and 36.7 g of gelatin phthalide to 1420 ml of distilled water was kept at a solution temperature of 42° C. while stirring in a stainless steel reaction pot, to which a solution A formed by adding distilled water to 22.22 g of silver nitrate to dilute to 195.6 ml and a solution B formed by diluting 21.8 g of potassium iodide with distilled water to 218 ml volume were added entirely at a constant flow rate for 9 min. Then, 10 ml of an aqueous 3.5 mass % solution of hydrogen peroxide was added and, further, 10.8 ml of an aqueous 10 mass % solution of benzimidazole was added. Further, a solution C formed by adding distilled water to 51.86 g of silver nitrate to dilute to 317.5 ml and a solution D formed by diluting 60 g of potassium iodide with distilled water to 600 ml volume were added in which the solution C was added entirely at a constant flow rate for 120 min, while the solution D was added by a controlled double jet method while keeping pAg at 8.1.

An aqueous solution of potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 sec after the completion of addition of the solution C. pH was adjusted to 3.8 by using sulfuric acid at 0.5 mol/L concentration, stirring was stopped and a precipitation/desalting/water washing step was conducted and pH was adjusted to 5.9 by using sodium hydroxide at 1 mol/L concentration to prepare a silver halide dispersion at pAg of 8.0.

The silver halide dispersion was kept at 38° C. while stirring, to which 5 ml of a methanol solution containing 0.34 mass % of 1,2-benzoisothiazolin-3-one was added and the temperature was elevated to 47° C. after one min. 20 min after the temperature elevation, a methanol solution of sodium benzenethiosulfonate was added by 7.6×10⁻⁵ mol per one mol of silver and, further five min after, a tellurium sensitizer was added by 2.9×10⁻⁴ mol per one mol of silver and aged for 91 min. 1.3 ml of a methanol solution of 0.8 mass % N,N′-dihydroxy-N″-diethyl melamine was added and, further 4 min after, a methanol solution of 5-methyl-2-mercaptobenzimidazole was added by 4.8×10⁻³ mol per 1 mol of silver, and a methanol solution of 1-phenyl-2-heptyl-5-mercapto-1,3,4-triazole was added by 5.4×10⁻³ mol per 1 mol of silver to prepare a silver halide emulsion 1d.

Particles in the silver halide emulsion that could be prepared were pure silver halide particles with an average sphere-equivalent diameter of 0.040 μm, and with 18% variation coefficient for the sphere-equivalent diameter. The particle size and the like were determined as an average for 1000 particles by using an electron microscope.

<Preparation of Silver Halide Mixed Emulsion A'for Coating Liquid>

A silver halide emulsion id was dissolved and benzothiazolium iodide was added as an aqueous 1 mass % solution by 7×10⁻³ mol per one mol of silver. Further, water was added such that the content of silver halide per 1 kg of the emulsion mixture for coating liquid was 38.2 g as silver.

Preparation of Fatty Acid Silver Dispersions A-J

<Purification of Behenic Acid-1>

100 kg of behenic acid manufactured by Henckel Co (trade name of products: Edenor C22-85R) was mixed with 1200 kg of isopropanol, dissolved at 50° C., filtered through a filter of 10 μm and then cooled to 30° C. and recrystallized. The cooling rate during recrystallization was controlled to 3° C./hr. The resultant crystals were centrifugally filtered and, after spray-washing with 100 kg of isopropanol, the recrystallization was further conducted repeatedly twice. Then, precipitates at the initial stage of recrystallization were filtered to remove lignoceric acid and drying was conducted. When the resultant crystals were esterified and put to GC-FID measurement, the behenic acid content was 99.99 mol %. Erucic acid was 10⁻⁶ mol % or less.

<Purification of Behenic Acid-2>

100 kg of behenic acid manufactured by Henckel Co (trade name of products: Edenor C22-85R) was mixed with 1200 kg of isopropanol, dissolved at 50° C., filtered through a filter of 10 μm and then cooled to 30° C. and recrystallized. The cooling rate during recrystallization was controlled to 3° C./hr. The resultant crystals were centrifugally filtered and after spray-washing with 100 kg of isopropanol, the recrystallization was further conducted repeatedly twice, and drying was conducted. When the resultant crystals were esterified and put to GC-FID measurement, the behenic acid content was 97.5 mol %, and lignoceric acid was 2 mol %. Erucic acid was 10⁻⁶ mol % or less.

<Purification of Arachidonic Acid>

100 kg of arachidonic acid manufactured by Tokyo Kasei Co. was mixed with 1200 kg of isopropanol, dissolved at 50° C., filtered through a filter of 10 μm and then cooled to 20° C. and recrystallized. The cooling rate during recrystallization was controlled to 3° C./hr. The resultant crystals were centrifugally filtered and, after spray-washing with 100 kg of isopropyl alcohol, the recrystallization was further conducted repeatedly twice. Then, precipitates at the initial stage of recrystallization were filtered to remove carboxylic acids with chain length longer than that of arachidonic acid and drying was conducted. When the resultant crystals were esterified and put to GC-FID measurement, the arachidonic acid content was 99.99 mol % and erucic acid was 10-6 mol % or less.

<Purification of Stearic Acid>

100 kg of stearic acid manufactured by Tokyo Kasei Co. was mixed with 1200 kg of isopropanol, dissolved at 50° C., filtered through a filter of 10 μm and then cooled to 20° C. and recrystallized. The cooling rate during recrystallization was controlled to 3° C./hr. The resultant crystals were centrifugally filtered and, after spray-washing with 100 kg of isopropanol, recrystallization was further conducted repeatedly twice. Then, precipitates at the initial stage of recrystallization were filtered to remove carboxylic acids with chain length longer than that of stearic acid and drying was conducted. When the resultant crystals were esterified and put to GC-FID measurement, the silver stearate content was 99.99 mol % and erucic acid was 10⁻⁶ mol % or less.

<Preparation of Organic Acid>

Each of purified products of stearic acid, arachidonic acid, behenic acid and lignoceric acid prepared as described above and erucic acid (products of Tokyo Kasei) were mixed so as to provide aimed compositions, which were used as the starting material for organic acid silver salts A-J.

TABLE 16

| | Kind and content of organic acid | | | | | |
|---|---|---|---|---|---|---|
| Organic | | | Behenic | Lignoceric | | |
| Acid | Stearic acid | Arachidonic | acid | acid | Erucic acid | |
| Silver | (mol %) | acid (mol %) | (mol %) | (mol %) | (mol %) | Remarks |
| A | 0 | 0 | 97.9 or | 2 | less than | Comparative |
| | | | more | | 10⁻⁶ | Example |
| B | 0 | 0 | 97.9 or | 2 | 2 × 10⁻⁴ | Present |
| | | | more | | | Invention |
| C | 0 | 0 | 97.9 or | 2 | 2 × 10⁻² | Present |
| | | | more | | | Invention |
| D | 0 | 0 | 97 | 2 | 1 | Present |
| | | | | | | Invention |
| E | 0 | 0 | 95 | 2 | 3 | Present |
| | | | | | | Invention |
| F | 0 | 0 | 83 | 2 | 15 | Comparative |
| | | | | | | Example |
| G | 0 | 0 | 99 | 0 | 1 | Present |
| | | | | | | Invention |
| H | 20 | 31 | 47 | 1 | 1 | Present |
| | | | | | | Invention |
| I | 15 | 23 | 59.5 | 1.5 | 1 | Present |
| | | | | | | Invention |
| J | 1 | 5 | 91 | 2 | 1 | Present |
| | | | | | | Invention |

Products by Tokyo Kasei Used for Erucic acid

<Preparation of Organic Acid Silver Dispersions>

258 mol of an organic acid of the composition in Table 16, 422 L of distilled water, 492 L of an aqueous NaOH solution at 5 mol/L concentration, and 120 L of t-butanol were mixed and reacted under stirring at 75° C. for 1 hr to obtain a solution of sodium organic acid salt. Separately, 296.2 L of an aqueous solution of 40.4 kg of silver nitrate (pH 4.0) was provided and kept at a temperature of 10° C. A reaction vessel containing 635 L of distilled water and 30 L of t-butanol was kept at a temperature of 30° C. and, while stirring sufficiently, the entire amount of the sodium organic acid salt and the entire amount of the aqueous solution of silver nitrate were added each for 93 min and 15 sec and 90 min at a constant flow rate. In this case, only the aqueous solution of silver nitrate was added for 11 min after starting the addition of the aqueous solution of silver nitrate and, subsequently, addition of the solution B of the sodium organic acid salt was started and only the solution of sodium organic acid salt was added for 14 min 15 sec after the completion for the addition of the aqueous solution of silver nitrate. The temperature in the reaction vessel was 30° C. and the external temperature was controlled such that the liquid temperature was constant. Further, the temperature of a pipeline for the addition system of the solution of the sodium organic acid salt was kept by circulating warm water to the outside of a double walled tube, and liquid temperature at the exit of the top of the addition nozzle was controlled to 75° C. Further, the temperature of the pipeline for the addition system of the aqueous solution of silver nitrate was kept by circulating cold water to the outside of the double-walled tube. The addition position for the solution of the sodium organic acid salt and the addition position for the aqueous solution of silver nitrate were disposed in symmetrical with respect to the stirring axis as the center and adjusted to such a height as not in contact with the reaction solution.

After the completion for the addition of the solution of the sodium organic acid salt, it was stirred for 20 min and then left at that temperature as it was, the temperature was elevated to 35° C. for 30 min and then aging was conducted for 210 min. After the completion of aging, solid contents were immediately filtered and separated by a centrifugal filtration and the solids were washed with water till the conductivity of water of filtration was 70 μS/cm. In this way, the silver salt of organic acid was obtained. The resultant solids were stored without drying as wet cakes.

The shape of the resultant particles of the organic acid silver salt was evaluated by electron microscopic photography. The results are shown in Table 17. A, B, C were as defined in the specification.

TABLE 17

| Organic | | | | | Fluctuation |
|---|---|---|---|---|---|
| Acid Silver | | | | Sphere-Equivalent | Coefficient |
| Salt | A | B | C | Diameter (μm) | of Size |
| A | 0.25 | 0.6 | 0.7 | 0.54 | 10 |
| B | 0.25 | 0.6 | 0.7 | 0.54 | 10 |
| C | 0.26 | 0.6 | 0.7 | 0.55 | 11 |
| D | 0.26 | 0.6 | 0.7 | 0.54 | 11 |
| E | 0.27 | 0.59 | 0.7 | 0.53 | 13 |
| F | 0.28 | 0.58 | 0.69 | 0.51 | 15 |
| G | 0.28 | 0.62 | 0.65 | 0.52 | 8 |
| H | 0.1 | 0.12 | 2.3 | 0.6 | 25 |
| I | 0.15 | 0.2 | 1.6 | 0.58 | 21 |
| J | 0.19 | 0.4 | 0.9 | 0.5 | 15 |

19.3 kg of polyvinyl alcohol (trade name of products: PVA-217) and water were added to wet cakes corresponding to 260 kg/dry solid content and after making the entire weight to 1000 kg, they were slurrified by a dissolver blade and further dispersed preliminarily by a pipeline mixer (model PM-10: manufactured by Mizuho Industry).

The stock solution after the preliminary dispersion was treated for three times by a dispersing machine (trade name of products: Micro Fluidizer M-610, manufactured by Micro-Fluidex International Corporation, Z-type interaction chamber used) while adjusting the pressure to 1150 kg/m² to obtain silver behenate dispersions. For cooling operation, bellows type heat exchangers were attached to front and back of an interaction chamber and the temperature of the coolant was controlled to set the dispersion temperature to 18° C.

Organic acid silver dispersions A-J were obtained as described above.

Preparation of Reducing Agent Dispersion

<Reducing Agent Complex-1 Dispersion>

A reducing agent complex-1 dispersion was prepared by the same method and under the same conditions as those in Example 7.

<Reducing Agent Complex-2 Dispersion>

A reducing agent complex-2 dispersion was prepared by the same method and under the same conditions as those in Example 8.

Preparation of Hydrogen Coupling Compound Dispersion

<Hydrogen Coupling Compound-1 Dispersion>

A hydrogen coupling compound-1 dispersion was prepared by the same method and under the same conditions as those in Example 1.

Preparation of Development Accelerator Dispersion, & Tone Controller Dispersion

<Developement Accelerator-1 Dispersion>

A development accelerator-1 dispersion was prepared by the same method and under the same conditions as those in Example 1.

<Development Accelerator-2′ Dispersion, & Tone controller-1 Dispersion>

Each of solid dispersions of development accelerator-2′ dispersion and tone controller-1 dispersion was also dispersed in the same manner as the development accelerator-1, to obtain 20 mass % liquid dispersion.

Preparation of Polyhalogen Compound Dispersion

<Organic Polyhalogen Compound-1 and -2 Dispersions>

Organic polyhalogen compound-1 dispersion and organic polyhalogen compound-2 dispersion were prepared by the same method and under the same conditions as those in Example 1.

Preparation of Phthalazine Compound Solution

<Phthalazine Compound-1 Solution>

A phthalazine compound-1 solution was prepared by the same method and under the same conditions as those in Example 1.

Preparation of Mercapto Compound Solution

<Mercapto Compound-1 and Mercapto compound-2 Aqueous Solutions>

A mercapto compound-1 aqueous solution and a mercapto compound-2 aqueous solution were prepared by the same method and under the same conditions as those in Example 1.

Preparation of Dye Dispersion

<Dye-1 Dispersion>

A dye-1 dispersion was prepared by the same method and under the same conditions as those in Example 1.

Preparation of SBR Latex Liquid

An SBR latex liquid was prepared by the same method and under the same conditions as those in Example 1.

(Preparation of Coating Liquid)

Preparation of Emulsion Layer (Light Sensitive Layer) Coating Liquid

1000 g of the organic acid silver salt dispersion obtained as described above, 276 ml of water, 33.2 g of dye-1 dispersion, 21 g of organic polyhalogen compound-1 dispersion, 58 g of organic polyhalogen compound-2 dispersion, 173 g of a phthalazine compound-1 solution, 1082 g of SBR latex (Tg=22° C.) liquid, 299 g of a reducing agent complex-3 dispersion, 6 g of reducing development accelerator-1 dispersion, 9 ml of a mercapto compound-1 solution, and 27 ml of a mercapto compound-2 aqueous solution were added successively, and 117 g of the silver halide mixed emulsion A′ was added and mixed thoroughly just before coating, and the emulsion layer coating liquid was supplied as it was to a coating die and coated.

The viscosity of the emulsion layer coating liquid was 25 [mPa·s] at 40° C. when measured by a B-type viscometer (No. 1 rotor, 60 rpm).

The viscosity of the coating liquid at 25° C. measured by using an RFS field spectrometer manufactured by Rheometric Far East Co. was 230, 60, 46, 24 and 18 [mPa·s], respectively, at a shearing rate of 0.1, 1, 10, 100 and 1000 [1/sec].

The amount of zirconium in the coating liquid was 0.38 mg per 1 g of silver.

Preparation of Intermediate Layer Coating Liquid on Emulsion Surface

An emulsion surface intermediate layer coating liquid was prepared by the same method and under the same conditions as those in Example 1.

Preparation of Coating Liquid for First Emulsion Surface Protective Layer

The coating liquid for first emulsion surface protective layer was prepared in the same manner and under the same conditions as those in Example 1.

Preparation of Coating Liquid for Second Emulsion Surface Protective Layer

80 g of inert gelatin was dissolved in water, and water to make-up the total to 650 g was added to 102 g of a 27.5 mass % solution of methylmethacrylate/styrene/butylacrylate/hydroxyethyl methacrylate/acrylic acid copolymer (copolymerization mass ratio: 64/9/20/5/2) latex, 3.2 ml of a 5 mass % solution of fluoro surfactant (F-1d: potassium N-perfluorooctylsulfonyl-N-propylaniline salt), 32 ml of an aqueous 2 mass % solution of fluoro surfactant (F-2d: polyethylene glycol mono(N-perfluorooctylsulfonyl-N-propyl-2-aminoethyl ether [ethylene oxide average polymerization degree=15]), 23 ml of a 5 mass % solution of aerosol OT (manufactured by American Cyanamide Co.), 4 g of fine polymethyl methacrylate particles (average grain size 0.7 μm), 21 g of polymethyl methacrylate fine particles (average grain size 4.5 μm), 1.6 g of 4-methyl phthalic acid, 4.8 g of phthalic acid, 44 ml of sulfuric acid at 0.5 mol/L concentration and 10 mg of benzoisothiazolinone, to which 445 ml of an aqueous solution containing 4 mass % of chromium alum and 0.67 mass % of phthalic acid were mixed by a static mixer just before coating to prepare a surface protective layer coating liquid and it was supplied to a coating die so as to be 8.3 ml/m².

The viscosity of the coating liquid was 19 [mPa·s] when measured by a B-type viscometer at 40° C. (No. 1 rotor, 60 rpm). (Preparation of Photothermographic Material 26A-26J)

An anti-halation layer coating liquid was coated such that the solid coating amount of gelation was 0.04 g/m² and a back surface protection layer coating liquid was coated such that the coating amount of gelation was 1.7 g/m² simultaneously in stack on the back surface of the undercoated support, which were dried to prepare a back layer.

An emulsion layer, an intermediate layer, a first protective layer and a second protective layer were simultaneously coated in stack from the substratum surface on the side opposite to the back surface by a slide bead coating method successively to prepare a sample of a photothermographic material. In this case, the temperature was adjusted to 38° C. for the emulsion layer and the intermediate layer, to 37° C. for the first protective layer and to 37° C. for the second protective layer.

The coating amount for each of the compounds of the emulsion layer (g/m²) is as shown below.

| | |
|---|---|
| Organic acid silver salt(As Ag) | 1.34 |
| Dye (C.I. Pigment Blue 60) | 0.036 |
| Polyhalogen compound-1 | 0.12 |
| Polyhalogen compound-2 | 0.37 |
| Phthalazine compound-1 | 0.19 |
| SBR latex | 9.67 |
| Reducing agent complex-1 | 1.41 |
| Development accelerator-1 | 0.024 |
| Mercapto compound-1 | 0.002 |
| Mercapto compound-2 | 0.012 |
| Silver halide emulsion 1d (As Ag) | 0.091 |

The coating and drying conditions are as follows.

Coating was conducted at a speed of 160 m/min with the gap between the top end of the coating die and the support as 0.10-0.30 mm and the pressure in a depressurization chamber was set lower by 196-882 Pa relative to the atmospheric pressure. Static charges on the support were eliminated by an ionic blow before coating.

In the subsequent chilling zone, after cooling the coating liquid by a blow at a dry-bulb temperature of 10-20° C., it was conveyed in a contactless manner and dried in a helical contactless type drying apparatus by a drying blow at a dry-bulb temperature of 23 to 45° C. and a wet-bulb temperature of 15 to 21° C.

After drying and after controlling the humidity to 40-60% RH at 25° C., it was heated such that the film surface was at 70 to 90° C. After heating, the film surface was cooled to 25° C.

The degree of matte of the thus prepared photothermographic material was 550 sec on the side of the light sensitive layer and 130 sec on the back surface being expressed as the Beckmann smoothness. Further, pH at the film surface on the side of the light sensitive layer was measured to be 6.0.

### Example 27

(Preparation of Photothermographic Materials 27A-27J)

Photothermographic materials 27A-27J were prepared in the same manner as in Example 26 except for using the following silver halide emulsion 2d instead of the silver halide emulsion 1d in Example 26.

<Preparation of Silver Halide Emulsion 2d>

A silver halide emulsion 2d having a halogen composition with a ionide content of 3.5 mol % was prepared in the same manner as in Example 26 except for changing the halogen composition to be added. A silver halide with a grain size having a sphere-equivalent diameter of 0.040 μm in average was prepared by changing the temperature upon forming the particles.

### Example 28

(Preparation of Photothermographic Materials 28A-28J)

Photothermographic materials 28A-28J were prepared in the same manner as in Example 26 except for using the following silver halide emulsion 3d instead of the silver halide emulsion 1d in Example 26.

<Preparation of Silver Halide Emulsion 3d>

A solution formed by adding 3.1 ml of a 1 mass % potassium bromide solution and further adding 3.5 ml of sulfuric acid at 0.5 mol/L concentration and 31.7 g of gelatin phthalide to 1421 ml of distilled water was kept at a solution temperature of 32° C. while stirring in a stainless steel reaction pot, to which a solution A formed by adding distilled water to 22.22 g of silver nitrate to dilute to 95.4 ml and a solution B formed by diluting 15.3 g of potassium bromide and 0.8 g of potassium iodide with distilled water to 97.4 ml volume were added entirely at a constant flow rate for 45 sec. Then, 10 ml of an aqueous 3.5 mass % solution of hydrogen peroxide was added and, further, 10.8 ml an aqueous 10 mass % solution of benzimidazole was added. Further, a solution C formed by adding distilled water to 30.64 g of silver nitrate to dilute to 187.6 ml and a solution D formed by diluting 44.2 g of potassium bromide and 2.2 g of potassium iodide with distilled water to 400 ml volume were added in which the solution C was added entirely at a constant flow rate for 12 min, while the solution D was added by a controlled double jet method while keeping pAg at 8.1. Then, a solution E formed by adding 130 ml of distilled water to 22.2 g of silver nitrate and a solution F formed by diluting 21.7 of potassium iodide with distilled water to 217 ml of volume were added while keeping pAg at 6.3 by a controlled double jet method.

Potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 sec after the completion of addition of the solution C. pH was adjusted to 3.8 by using sulfuric acid at 0.5 mol/L concentration, stirring was stopped and a precipitation/desalting/water washing step was conducted. pH was adjusted to 5.9 by using sodium hydroxide at 1 mol/L concentration to prepare a silver halide dispersion at pAg of 8.0.

The silver halide dispersion was kept at 38° C. while stirring, to which 5 ml of a methanol solution containing 0.34 mass % of 1,2-benzoisothiazolin-3-one was added and, after 40 min, a methanol solution of a spectral sensitizer A and a sensitizer B at a 1:1 molar ratio was added by 1.2×10⁻³ mol as a total for the sensitizers A and B per 1 mol of silver and the temperature was elevated to 47° C. after one min. 20 min after the temperature elevation, a methanol solution of sodium benzenethiosulfonate was added by 7.6×10⁻⁵ mol per one mol of silver and, further five min after, a methanol solution of tellurium sensitizer was added by 2.9×10⁻⁵ mol per one mol of silver and aged for 91 min. 1.3 ml of a methanol solution of 0.8 mass % N,N′-dihydroxy-N″-diethyl melamine was added and, further 4 min after, a methanol solution of 5-methyl-2-mercaptobenzimidazole was added by 4.8×10⁻³ mol per 1 mol of silver, and a methanol solution of 1-phenyl-2-heptyl-5-mercapto-1,3,4-triazole was added by 5.4×10⁻³mol per 1 mol of silver to prepare a silver halide emulsion 3d.

Particles in the silver halide emulsion that could be prepared were particles in which 30 mol % of the silver iodide layer was joined with 70 mol % of silver bromide layer with an average sphere-equivalent diameter of 0.040 μm and 20% variation coefficient for the sphere-equivalent diameter. The portion having the crystal structure of the silver iodide structure has light absorption by direct transition.

### Example 29

(Preparation of Photothermographic Materials 29A -29J)

Photothermographic materials 29A-29J were prepared in the same manner as in Example 20 except for using the following silver halide emulsion 4d instead of the silver halide emulsion 1d in Example 20.

<Preparation of silver halide emulsion 4d>

A solution formed by adding 3.1 ml of a 1 mass % potassium bromide solution and further adding 3.5 ml of sulfuric acid at 0.5 mol/L concentration and 31.7 g of gelatin phthalide to 1421 ml of distilled water was kept at a solution temperature of 34° C. while stirring in a stainless steel reaction pot, to which a solution A formed by adding distilled water to 22.22 g of silver nitrate to dilute to 95.4 ml and a solution B formed by diluting 15.3 g potassium bromide and 0.8 g of potassium iodide with distilled water to 97.4 ml volume were added entirely at a constant flow rate for 45 sec. Then, 10 ml of an aqueous 3.5 mass % solution of hydrogen peroxide was added and, further, 10.8 ml an aqueous 10 mass % solution of benzimidazole was added. Further, a solution C formed by adding distilled water to 51.86 g of silver nitrate to dilute to 317.5 ml and a solution D formed by diluting 60 g of potassium iodide with distilled water to 600 ml volume were added in which the solution C was added entirely at a constant flow rate for 120 min, while the solution D was added by a controlled double jet method while keeping pAg at 6.3.

An aqueous solution of potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 see after the completion of addition of the solution C. pH was adjusted to 3.8 by using sulfuric acid at 0.5 mol/L concentration, stirring was stopped and a precipitation/desalting/water washing step was conducted. pH was adjusted to 5.9 by using sodium hydroxide at 1 mol/L concentration to prepare a silver halide dispersion at pAg of 8.0.

Silver halide emulsion 4d was prepared in the same manner for other conditions as in Example 28. Particles in the silver halide emulsion that could be prepared were particles in which 30 mol % of the silver iodide layer was joined with 70 mol % of silver bromide layer with an average sphere-equivalent diameter of 0.040 μm and 18% variation coefficient for the sphere-equivalent diameter. The portion having the crystal structure of the silver iodide structure has light absorption by direct transition.

Chemical structures of compounds used in the examples of the forty-fourth embodiment according to this invention are shown below.

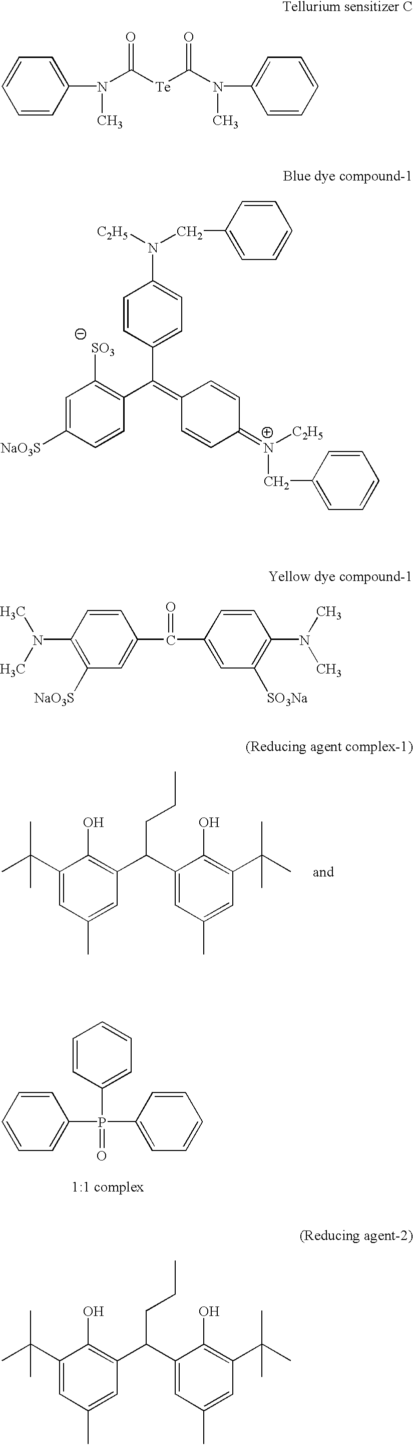

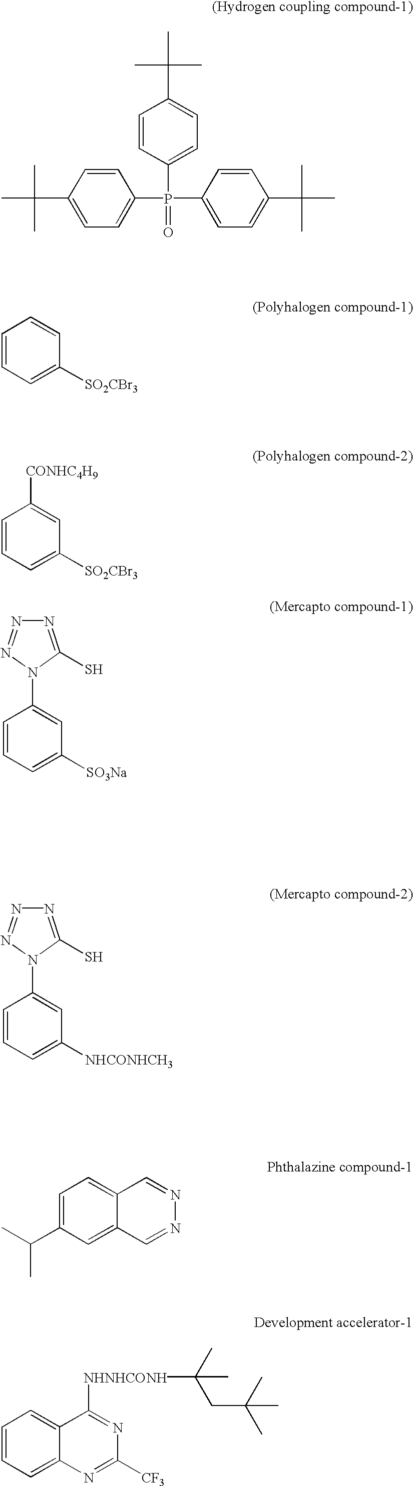

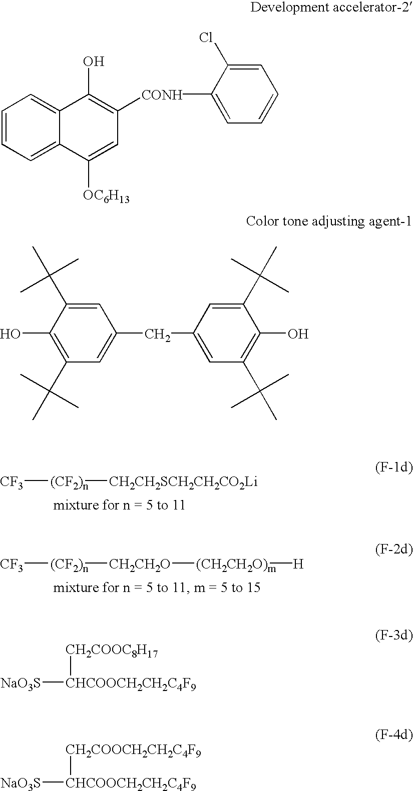

Evaluation for Photographic Performance

For each of the samples for the photothermographic materials (26A-26J, 27A-27J, 28A-28J and 29A-29J) evaluation was made as below.

(Preparation)

The obtained samples were cut each into a half-cut size, packaged by the following packaging material in an environment at 25° C., 50% RH, stored at a normal temperature for 2 weeks and then evaluated as shown below.

(Packaging Material)

PET 10 μm/PE 12 μm/aluminum foil 9 μm/Ny 15 μm/3% carbon containing polyethylene 50 μm;

oxygen permeation rate: 0 ml/atm·m²·25° C.·day;

water permeability: 0 g/atm·m²·25° C.·day

(Exposure of Photothermographic Material)

Each of the thus obtained photothermographic materials was exposed as below.

In the exposure station of a Fuji Medical Dry Laser Imager FM-DPL, an NLHV 3000E semiconductor laser manufactured by Nichia Chemical Industry was mounted as a semiconductor laser light source, and the light sensitive material was exposed while changing the amount of the laser light between 1 mW/mm²-1000 mW/mm².

The emission wavelength of the laser light was 405 nm.

(Development of Photothermographic Material)

The exposed photothermographic materials were put to thermal development as described below.

Thermal development was conducted by setting the temperature for four sheets of panel heaters to 112° C.-115° C.-115° C.-115° C. in the thermal developing station of Fuji Medical Dry Laser Imager FM-DPL while setting the total thermal developing time to 14 sec by increasing the film conveying speed.

(Evaluation for the Photographic Property of Photothermographic Material)

The density of the obtained images was measured by a densitometer to prepare characteristic curves of the density to the logarithm of the exposure amount. While defining the optical density in a not exposed portion as the fogging and the reciprocal to the exposure amount capable of providing optical density of 1.0 as the sensitivity, the performance was expressed by a relative value based on the sensitivity of the photothermographic material-26A being assumed as 100. The result is shown in Table 18.

(Evaluation for Print Out Performance)

Each of the photothermographic materials after the development was placed in a room at 26° C., 60% RH and left for ten days under the irradiation of 500 lux of fluorescent lamps. A difference between the fogging density just after development and the fogging density after left for ten days under the conditions described above was defined as the print out performance.

The obtained results are shown in Table 18.

TABLE 18

| | Silver Halide, | | | | | |
|---|---|---|---|---|---|---|
| | Silver Iodide | | Photographic | | Print out | |
| Photothermographic | Content | Erucic Acid | Property | Photographic | Performance | |
| material | (mol %) | Content (mol %) | Fog | Sensitivity | ΔD | Remarks |
| 26A | 100 | Less than 10⁻⁶ | 0.160 | 100 | 0.08 | Comparative |
| | | | | | | Example |
| 26B | 100 | 2 × 10⁻⁴ | 0.6 | 110 | 0.08 | Present |
| | | | | | | Invention |
| 26C | 100 | 2 × 10⁻² | 0.16 | 120 | 0.08 | Present |
| | | | | | | Invention |
| 26D | 100 | 1 | 0.162 | 130 | 0.09 | Present |
| | | | | | | Invention |
| 26E | 100 | 3 | 0.164 | 140 | 0.15 | Present |
| | | | | | | Invention |
| 26F | 100 | 15 | 0.25 | 145 | 0.30 | Comparative |
| | | | | | | Example |
| 26G | 100 | 1 | 0.16 | 130 | 0.08 | Present |
| | | | | | | Invention |
| 26H | 100 | 1 | 0.18 | 140 | 0.09 | Present |
| | | | | | | Invention |
| 26I | 100 | 1 | 0.17 | 140 | 0.09 | Present |
| | | | | | | Invention |
| 26J | 100 | 1 | 0.165 | 140 | 0.08 | Present |
| | | | | | | Invention |
| 27A | 3.5 | Less than 10⁻⁶ | 0.24 | 60 | 0.31 | Comparative |
| | | | | | | Example |
| 27B | 3.5 | 2 × 10⁻⁴ | 0.24 | 65 | 0.32 | Comparative |
| | | | | | | Example |
| 27C | 3.5 | 2 × 10⁻² | 0.26 | 70 | 0.32 | Comparative |
| | | | | | | Example |
| 27D | 3.5 | 1 | 0.27 | 80 | 0.34 | Comparative |
| | | | | | | Example |
| 27E | 3.5 | 3 | 0.30 | 90 | 0.45 | Comparative |
| | | | | | | Example |
| 27F | 3.5 | 15 | 0.40 | 95 | 0.55 | Comparative |
| | | | | | | Example |
| 27G | 3.5 | 1 | 0.25 | 80 | 0.33 | Comparative |
| | | | | | | Example |
| 27H | 3.5 | 1 | 0.33 | 90 | 0.34 | Comparative |
| | | | | | | Example |
| 27I | 3.5 | 1 | 0.31 | 90 | 0.35 | Comparative |
| | | | | | | Example |
| 27J | 3.5 | 1 | 0.30 | 90 | 0.31 | Comparative |
| | | | | | | Example |
| 28A | 30 | Less than 10⁻⁶ | 0.18 | 70 | 0.12 | Comparative |
| | | | | | | Example |
| 28B | 30 | 2 × 10⁻⁴ | 0.18 | 75 | 0.12 | Present |
| | | | | | | Invention |
| 28C | 30 | 2 × 10⁻² | 0.18 | 80 | 0.12 | Present |
| | | | | | | Invention |
| 28D | 30 | 1 | 0.185 | 90 | 0.14 | Present |
| | | | | | | Invention |
| 28E | 30 | 3 | 0.19 | 100 | 0.22 | Present |
| | | | | | | Invention |
| 28F | 30 | 15 | 0.30 | 105 | 0.40 | Comparative |
| | | | | | | Example |
| 28G | 30 | 1 | 0.18 | 90 | 0.16 | Present |
| | | | | | | Invention |
| 28H | 30 | 1 | 0.20 | 100 | 0.15 | Present |
| | | | | | | Invention |
| 28I | 30 | 1 | 0.19 | 100 | 0.14 | Present |
| | | | | | | Invention |
| 28J | 30 | 1 | 0.185 | 100 | 0.12 | Present |
| | | | | | | Invention |
| 29A | 70 | Less than 10⁻⁶ | 0.17 | 85 | 0.09 | Comparative |
| | | | | | | Example |
| 29B | 70 | 2 × 10⁻⁴ | 0.17 | 90 | 0.09 | Present |
| | | | | | | Invention |
| 29C | 70 | 2 × 10⁻² | 0.17 | 100 | 0.09 | Present |
| | | | | | | Invention |
| 29D | 70 | 1 | 0.175 | 110 | 0.10 | Present |
| | | | | | | Invention |
| 29E | 70 | 3 | 0.18 | 120 | 0.18 | Present |
| | | | | | | Invention |
| 29F | 70 | 15 | 0.28 | 125 | 0.35 | Comparative |
| | | | | | | Example |
| 29G | 70 | 1 | 0.17 | 110 | 0.09 | Present |
| | | | | | | Invention |
| 29H | 70 | 1 | 0.19 | 120 | 0.10 | Present |
| | | | | | | Invention |
| 29I | 70 | 1 | 0.18 | 120 | 0.10 | Present |
| | | | | | | Invention |
| 27J | 70 | 1 | 0.175 | 120 | 0.09 | Present |
| | | | | | | Invention |

As apparent from Table 18, it can be seen that the photothermographic materials of the thirty-sixth embodiment according to this invention have high sensitivity and less fogging and are excellent in the print out performance.

### Example 30

When the same evaluation was made on photothermographic materials which are similar with the photothermographic materials 29A-29J except for changing the laser emission wavelength to 395 nm, similar preferred result could be obtained also in this example.

The forty-fourth embodiment of present invention can provide a photothermographic material excellent in image storability after output, having high sensitivity and high image quality while using a light sensitive silver halide of high silver iodide content.

Examples of Forty-Fifth Embodiment

Then, the forty-fifth embodiment of the photothermographic material according to this invention is to be described specifically by way of examples but the forty-fifth embodiment of the invention is not restricted to them.

### Example 31

Preparation of PET Support

A PET support was prepared in the same manner as those in Example 1 in the first embodiment of the photothermographic material according to this invention and applied with a surface corona treatment by the same method as in Example 1.

Preparation of Undercoated Support

An undercoated support was prepared by the same method and under the same conditions as those in Example 1.

Preparation of Coating Liquid for Back Surface

<Preparation of Solid Fine Particle Dispersion (a″) of Basic Precursor>

A file solid particle liquid dispersion (a″) was prepared by the same method and under the same conditions as those in Example 20.

<Preparation of Solid Fine Particle Dispersion of Dye>

A solid fine particle dispersion of dye was prepared in the same method and under the same conditions as those in Example 20.

<Preparation of Anti-Halation Layer Coating Liquid>

An anti-halation layer coating liquid was prepared by the same method and under the same conditions as those in Example 20.

<Preparation of Back Surface Protective Layer Coating Liquid>

A vessel was kept at a temperature of 40° C., and 50 g of gelatin, 0.2 g of sodium polystyrene sulfonate, 2.4 g of N,N-ethylenebis(vinylsulfoneacetoamide), 1 g of sodium t-octylphenoxyethoxyethane sulfonate, 30 mg of benzoisothiazolinone, 37 mg of a fluoro-surfactant (F-1e: potassium N-perfluorooctylsulfonyl-N-propylalanine), 0.15 g of a fluoro-surfactant (F-2e: polyethylene glycol mono(N-perfluorooctylsulfonyl-N-propyl-2-aminoethyl) ether [ethylene oxide average polymerization degree 15]), 64 mg of a fluoro-surfactant (F-3e), 32 mg of a fluoro-surfactant (F-4e), 8.8 g of acrylic acid/ethyl acrylate copolymer (copolymer mass ratio 5/95), 0.6 g of aerosol OT (manufactured by American Cyanimide Co.), 1.8 g of liquid paraffin emulsion as liquid paraffin and 950 ml of water were mixed to obtain a back surface protective layer coating liquid.

Preparation of Each of Ingredients Contained in Emulsion Layer (Image Forming Layer) Coating Liquid

<Preparation of Silver Halide Emulsion 1e>

A solution formed by adding 4.3 ml of a 1 mass % potassium iodide solution and further adding 3.5 ml of sulfuric acid at 0.5 mol/L concentration and 36.7 g of gelatin phthalide to 1420 ml of distilled water was kept at a solution temperature of 42° C. while stirring in a stainless steel reaction pot, to which a solution A formed by adding distilled water to 22.22 g of silver nitrate to dilute to 195.6 ml and a solution B formed by diluting 11.1 g of potassium bromide and 6.6 g of potassium iodide with distilled water to 103 ml volume were added entirely at a constant flow rate for 3 min. Then, 10 ml of an aqueous 3.5 mass % solution of hydrogen peroxide was added and, further, 10.8 ml an aqueous 10 mass % solution of benzimidazole were added. Further, a solution C formed by adding distilled water to 51.86 g of silver nitrate to dilute to 317.5 ml and a solution D formed by diluting 32.04 g of potassium bromide and 19.16 g of potassium iodide with distilled water to 400 ml volume were added in which the solution C was added entirely at a constant flow rate for 50 min, while the solution D was added by a controlled double jet method while keeping pAg at 9.1. Then, a solution E prepared by diluting 10 g of potassium iodide with distilled water to 400 ml volume was added entirely at a constant flow rate for 5 min. An aqueous solution of potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 sec after the completion of addition of the solution C. pH was adjusted to 3.8 by using sulfuric acid at 0.5 mol/L concentration, stirring was stopped and a precipitation/desalting/water washing step was conducted. pH was adjusted to 5.9 by using sodium hydroxide at 1 mol/L concentration to prepare a silver halide dispersion at pAg of 9.6.

The silver halide dispersion was kept at 38° C. while stirring, to which 5 ml of a methanol solution containing 0.34 mass % of 1,2-benzoisothiazolin-3-one was added and, after 40 min, a methanol solution of a spectral sensitizer A′ and a sensitizer B′ at a 1:1 molar ratio was added by 1.2×10⁻³ mol as a total for the sensitizers A′ and B′ per 1 mol of silver and the temperature was elevated to 47° C. after one min. 20 min after the temperature elevation, a methanol solution of sodium benzenethiosulfonate was added by 7.6×10⁻⁵ mol per one mol of silver and, further five min after, a tellurium sensitizer C was added by 2.9×10⁻⁴ mol per one mol of silver and aged for 91 min. 1.3 ml of a methanol solution of 0.8 mass % N,N′-dihydroxy-N″-diethyl melamine was added and, further 4 min after, a methanol solution of 5-methyl-2-mercaptobenzimidazole was added by 4.8×10⁻³ mol per 1 mol of silver, and a methanol solution of 1-phenyl-2-heptyl-5-mercapto-1,3,4-triazole was added by 5.4×10⁻³ mol per 1 mol of silver to prepare a silver halide emulsion 1e.

Particles in the silver halide emulsion that could be prepared were silver iodobromide particles with an average sphere-equivalent diameter of 0.040 μm, with 18% variation coefficient for the sphere-equivalent diameter and with an average silver iodide content of 44%. The particle size and the like were determined as an average for 1000 particles by using an electron microscope.

<Preparation of Mixed Emulsion for Coating Liquid>

A silver halide emulsion 1e was dissolved and benzothiazolium iodide was added as an aqueous 1 mass % solution by 7×10⁻³ mol per one mol of silver. Further, water was added such that the content of silver halide per 1 kg of the emulsion mixture for coating liquid was 38.2 g as silver.

<Preparation of Organic Acid Silver Salt Dispersion>

A organic acid silver salt dispersion, that is, a organic acid silver salt was prepared in the same method and under the same conditions as those in Example 1.

<Preparation of Reducing Agent Complex-3e Dispersion>

7.2 kg of water was added to 10 kg of a reducing agent complex-3e (1:1 complex of 2,2′-methylenebis-(4-ethyol-6-tert-butylphenol) and triphenylphosphine oxide), 0.12 kg of triphenylphosphine oxide and 16 kg of an aqueous 10 mass % solution of modified polyvinyl alcohol (Poval MP203, manufactured by Kuraray Co.) and mixed thoroughly to prepare a slurry. After supplying the slurry by a diaphragm pump and dispersing the same by a lateral sand mill (UVM-2, manufactured by IMEX Co.) filled with zirconia beads of 0.5 mm in average diameter for 4 hours and 30 min, 0.2 g of benzothizolinone sodium salt and water were added such that the concentration of the reducing agent complex was 25 mass %, to obtain a reducing agent complex-3 dispersion. The reducing agent complex particles contained in the thus obtained reducing agent complex dispersion had a median diameter of 0.46 μm and a maximum grain size of 1.6 μm or less. The resultant reducing agent complex dispersion was filtered through a filter made of polypropylene with a pore size of 3.0 μm, to remove obstacles such as dusts and then stored.

<Preparation of Organic Polyhalogen Compound-2e Dispersion>

10 kg of an organic polyhalogen compound-2e (tribromomethane sulfonyl benzene), 10 kg of an aqueous 20 mass % solution of modified polyvinyl alcohol (Poval MP203, manufactured by Kuraray Co.), 0.4 kg of an aqueous 20 mass % solution of sodium triisopropyl naphtnalene sulfonate, and 14 kg of water were added and mixed thoroughly to form a slurry. After supplying the slurry by a diaphragm pump and dispersing the same in a lateral sand mill (UVM-2: manufactured by IMEX Co.) filled with zirconia beads of 0.5 mm in average diameter, 0.2 g of benzoisothazoline sodium salt and water were added such that the concentration of the organic polyhalogen compound was 26 mass %, to obtain an organic polyhalogen compound-2e dispersion. The organic polyhalogen compound particles contained in the polyhalogen compound dispersion thus obtained had 0.41 μm of a median diameter and 2.0 μm or less of a maximum grain size. The obtained dispersion of the organic polyhalogen compound was filtered through a polypropylene filter with a pore size of 10.0 μm to remove obstacles such as dusts and then stored.

<Preparation of Organic Polyhalogen Compound-3e Dispersion>

10 kg of an organic polyhalogen compound-3e (N-butyl-3-tribromomethane sulfonyl benzamide), 20 kg of an aqueous 20 mass % solution of modified polyvinyl alcohol (Poval MP203, manufactured by Kuraray Co.), 0.4 kg of an aqueous 20 mass % solution of sodium triisopropyl naphtnalene sulfonate, and 8 kg of water were added and mixed thoroughly to form a slurry. After supplying the slurry by a diaphragm pump and dispersing the same in a lateral sand mill (UVM-2: manufactured by IMEX Co.) filled with zirconia beads of 0.5 mm in average diameter, 0.2 g of sodium benzoisothazoline salt and water were added such that the concentration of the organic polyhalogen compound was 25 mass %. The liquid dispersion was warmed to 40° C. for 5 hours to obtain an organic polyhalogen compound-3e dispersion. The organic polyhalogen compound particles contained in the polyhalogen compound dispersion thus obtained had 0.36 μm of a median diameter and 1.5 μm or less of a maximum grain size. The obtained dispersion of the organic polyhalogen compound was filtered through a polypropylene filter with a pore size of 3.0 μm to remove obstacles such as dusts and then stored.

<Preparation of Phthalazine Compound-1e Solution>

8 kg of modified polyvinyl alcohol MP203 manufactured by Kuraray Co. was dissolved in 174.57 kg of water and then 3.15 kg of an aqueous 20 mass % solution of sodium triisopropyl naphthalene sulfonate and 14.28 kg of an aqueous 70 mass % solution of phthalazine compound-1e (6-isopropylphthalazine) were added to prepare a 5 mass % solution of a phthalazine compound-1e.

<Preparation of Aqueous Solution of Mercapto Compound-1e>

7 g of mercapto compound-1e (sodium 1-(3-sulfophenyl)-5-mercaptotetrazole) was dissolved in 993 g of water to form an aqueous 0.7 mass % solution.

<Preparation of Dye-1 Dispersion>

A dye-1 dispersion was prepared by the same method and under the same conditions as those in Example 1 of this invention.

<Preparation of SBR Latex Liquid>

An SBR latex liquid was prepared by the same method and under the same conditions as those in Example 20 of this invention.

<Preparation of Emulsion Layer (Image Forming Layer) Coating Liquid-1e>

1000 g of the fatty acid silver dispersion obtained as described above, 104 ml of water, 30 g of dye-1 dispersion, 6.3 g of an organic polyhalogen compound-2e dispersion, 20.7 g of an organic polyhalogen compound-3e dispersion, 173 g of a phthalazine compound-1e solution, 1082 g of an SBR latex (Tg=23° C.) liquid, 258 g of a reducing agent complex-3e dispersion and 9 g of a mercapto compound-le solution were added successively, and a silver halide mixed emulsion was added and mixed thoroughly such that the amount thereof to the organic acid silver salt as shown in Table 19 just before coating, and the emulsion layer coating liquid was supplied as it was to a coating die and coated.

<Preparation of Intermediate Layer Coating Liquid on Emulsion Surface>

An intermediate layer coating liquid on emulsion surface was prepared by the same method and under the same conditions as those in Example 20.

<Preparation of Coating Liquid for First Emulsion Surface Protective Layer>

A coating liquid for first emulsion surface protective layer was prepared by the same method and under the same conditions as those in Example 1.

<Preparation of Second Layer Coating Liquid for Emulsion Surface Protective Layer>

80 g of inert gelatin was dissolved in water, and water to make-up the total to 650 g was added to 102 g of a 27.5 mass % of methyl methacrylate/styrene/butylacrylate/hydroxyethyl methacrylate/acrylic acid copolymer (copolymerization mass ratio: 64/9/20/5/2) latex liquid, 3.2 ml of a 5 mass % solution of fluoro surfactant (F-1e: potassium N-perfluorooctylsulfonyl-N-propylaniline salt), 32 ml of an aqueous 2 mass % solution of fluoro surfactant (F-2e: polyethylene glycol mono(N-perfluorooctylsulfonyl-N-propyl-2-aminoethyl ether [ethylene oxide average polymerization degree=15]), 23 ml of a 5 mass % solution of aerosol OT (manufactured by American Cyanamide Co.), 4 g of fine polymethyl methacrylate particles (average grain size 0.7 μm), 21 g of fine polymethyl methacrylate particles (average grain size, 4.5 μm), 1.6 g of 4-methyl phthalic acid, 4.8 g of phthalic acid, 44 ml of sulfuric acid at 0.5 mol/L concentration and 10 mg of benzoisothiazolinone, to which 445 ml of an aqueous solution containing 4 mass % of chromium alum and 0.67 mass % of phthalic acid were mixed by a static mixer just before coating to prepare a surface protective layer coating liquid and it was supplied to a coating die so as to be 8.3 ml/m².

The viscosity of the coating liquid was 19 [mPa·s] when measured by a B-type viscometer at 40° C. (No. 1 rotor, 60 rpm).

<Preparation of Photothermographic Material-1e>

An anti-halation layer coating liquid was coated such that the solid coating amount of fine solid dye particles was 0.04 g/m² and a back surface protection layer coating liquid was coated such that the gelatin coating amount was 1.7 g/m² simultaneously in stack on the back surface of the undercoated support, which were dried to prepare a back layer.

An emulsion layer, an intermediate layer, a first protective layer and a second protective layer were simultaneously coated in stack in this order from the substratum surface on the side opposite to the back surface by a slide bead coating method to prepare a sample of a photothermographic material. In this case, the temperature was adjusted to 35° C. for the emulsion layer and the intermediate layer, to 36° C. for the first protective layer and to 37° C. for the second protective layer.

The coating amount for each of the compounds of the emulsion layer (g/m²) is as shown below.

| | |
|---|---|
| Silver behenate | 5.55 |
| Dye (C.I. Pigment Blue 60) | 0.036 |
| Polyhalogen compound-2e | 0.02 |
| Polyhalogen compound-3e | 0.06 |
| Phthalazine compound-1e | 0.15 |
| SBR latex | 11.1 |
| Reducing agent complex-3e | 1.54 |
| Mercapto compound-1e | 0.002 |
| Silver halide (As Ag) | 0.09 |

The coating and drying conditions are as follows.

Coating was conducted at a speed of 160 m/min with the gap between the top end of the coating die and the support as 0.10-0.30 mm and the pressure in a depressurization chamber was set lower by 196-882 Pa relative to the atmospheric pressure. Static charges on the support were eliminated by an ionic blow before coating.

In the subsequent chilling zone, after cooling the coating liquid by a blow at a dry-bulb temperature of 10-20° C., it was conveyed in a contactless manner and dried in a helical contactless type drying apparatus by a drying blow at a dry-bulb temperature of 23 to 45° C. and a wet-bulb temperature of 15 to 21° C.

After drying and after controlling the humidity to 40-60% RH at 25° C., it was heated such that the film surface was at 70 to 90° C. After heating, the film surface was cooled to 25° C.

The degree of matte of the thus prepared photothermographic material was 550 sec on the side of the light sensitive layer and 130 sec on the back surface being expressed as the Beckmann smoothness. Further, pH at the film surface on the side of the light sensitive layer was measured to be 6.0.

The obtained samples were cut each into a half-cut size, packaged by the following packaging material in an environment at 25° C., 50% RH, stored at a normal temperature for 2 weeks and then evaluated as shown below.

(Packaging Material)

As the packaging material for packaging the forty-fifth embodiment of the photothermographic materials according to this invention, those having the following layer constitution, the oxygen permeability and water permeability were used.

Layer constitution:

PET (polyethylene terephthalate) 10 μm/

PE (polyethylene) 12 μm/aluminum foil 9 μm/Ny 15 μm/

3% carbon containing polyethylene 50 μm;

Oxygen permeability: 0 ml/atm·m²·25° C.·day;

Water permeability: 0 g/atm·m²·25° C.·day

### Example 32

<Preparation of Silver Halide Emulsion 2e>

A silver halide emulsion 2e was prepared by the same method as that for the silver halide emulsion 1e except for using a solution F formed by diluting 20 g of potassium iodide with distilled water to 400 m volume instead of the solution E in the preparation of the silver halide emulsion 1e in Example 31.

The particles that could be prepared were silver iodobromide particles with an average sphere-equivalent diameter of 0.041 μm, a fluctuation coefficient for sphere-equivalent diameter of 20% and an average silver iodide content of 58%. The particle size and the like were determined from 1000 particles in average by using an electron microscope.

<Preparation of Silver Halide Emulsion 3e>

A silver halide emulsion 3e was prepared by the same method as that for the silver halide emulsion 1e except for using a solution F formed by diluting 30 g of potassium iodide with distilled water to 400 m volume instead of the solution E in the preparation of the silver halide emulsion 1e in Example 31.

The particles that could be prepared were silver iodobromide particles with an average sphere-equivalent diameter of 0.039 μm, a fluctuation coefficient for sphere-equivalent diameter of 19% and an average silver iodide content of 72%. The particle size and the like were determined from 1000 particles in average by using an electron microscope.

<Preparation of Silver Halide Emulsion 4e>

A silver halide emulsion 4e was prepared by the same method as that for the silver halide emulsion 1e except for using a solution F formed by diluting 40 g of potassium iodide with distilled water to 400 m volume instead of the solution E in the preparation of the silver halide emulsion 1e in Example 31.

The particles that could be prepared were silver iodobromide particles with an average sphere-equivalent diameter of 0.042 μm, a fluctuation coefficient for sphere-equivalent diameter of 23% and an average silver iodide content of 86%. The particle size and the like were determined from 1000 particles in average by using an electron microscope.

<Preparation of Silver Halide Emulsion 5e>

A solution formed by adding 4.3 ml of a 1 mass % potassium iodide solution and further adding 3.5 ml of sulfuric acid at 0.5 mol/L concentration and 36.7 g of gelatin phthalide to 1420 ml of distilled water was kept at a solution temperature of 42° C. while stirring in a stainless steel reaction pot, to which a solution A formed by adding distilled water to 22.22 g of silver nitrate to dilute to 195.6 ml and a solution B formed by diluting 21.8 g of potassium iodide with distilled water to 218 ml volume were added entirely at a constant flow rate for 9 min. Then, 10 ml of an aqueous 3.5 mass % solution of hydrogen peroxide was added and, further, 10.8 ml of an aqueous 10 mass % solution of benzimidazole was added.

Further, a solution C formed by adding distilled water to 51.86 g of silver nitrate to dilute to 317.5 ml and a solution D formed by diluting 60 g of potassium iodide with distilled water to 600 ml volume were added in which the solution C was added entirely at a constant flow rate for 120 min, while the solution D was added by a controlled double jet method while keeping pAg at 8.1. An aqueous solution of potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 sec after the completion of addition of the solution C. pH was adjusted to 3.8 by using sulfuric acid at 0.5 mol/L concentration, stirring was stopped and a precipitation/desalting/water washing step was conducted. pH was adjusted to 5.9 by using sodium hydroxide at 1 mol/L concentration to prepare a silver halide dispersion at pAg of 8.0.

The silver halide dispersion was kept at 38° C. while stirring, to which 5 ml of a methanol solution containing 0.34 mass % of 1,2-benzoisothiazolin-3-one was added, spectral sensitizer A′ and sensitizer B′ in a methanol solution were added after 40 min at a 1:1 molar ratio by 1.2×10⁻³ mol as a total for the sensitizers A′ and B′ per one mol of silver, and the temperature was elevated to 47° C. after one min. 20 min after the temperature elevation, a methanol solution of sodium benzenethiosulfonate was added by 7.6×10⁻⁵ mol per one mol of silver and, further five min after, a tellurium sensitizer C was added by 2.9×10⁻⁴ mol per one mol of silver and aged for 91 min. 1.3 ml of a methanol solution of 0.8 mass % N,N′-dihydroxy-N″-diethyl melamine was added and, further 4 min after, a methanol solution of 5-methyl-2-mercaptobenzimidazole was added by 4.8×10⁻³ mol per 1 mol of silver, and a methanol solution of 1-phenyl-2-heptyl-5-mercapto-1,3,4-triazole was added by 5.4×10⁻³ mol per 1 mol of silver to prepare a silver halide emulsion 5e.

Particles in the silver halide emulsion that could be prepared were silver iodobromide particles with an average sphere-equivalent diameter of 0.040 μm, a 18% variation coefficient for the sphere-equivalent diameter and an average silver iodobromide content of 44%. The particle size and the like were determined as an average for 1000 particles by using an electron microscope.

Preparation of Photothermographic Materials 2e-5e

Photothermographic materials 2e -5e were prepared by the same method as in Example 31 except for changing the silver halide emulsion 1e to the silver halide emulsions 2e -5e in the preparation of the photothermographic material in Example 31.

### Comparative Example 2

<Preparation of Silver Halide Emulsion 6e>

A solution formed by adding 3.1 ml of a 1 mass % potassium bromide solution and further adding 3.5 ml of sulfuric acid at 0.5 mol/L concentration and 31.7 g of gelatin phthalide to 1421 ml of distilled water was kept at a solution temperature of 30° C. while stirring in a stainless steel reaction pot, to which a solution A formed by adding distilled water to 22.22 g of silver nitrate to dilute to 95.4 ml and a solution B formed by diluting 15.3 g of potassium bromide and 0.8 g of potassium iodide with distilled water to 97.4 ml volume were added entirely at a constant flow rate for 45 sec. Then, 10 ml of an aqueous 3.5 mass % solution of hydrogen peroxide was added and, further, 10.8 ml an aqueous 10 mass % solution of benzimidazole was added. Further, a solution C formed by adding distilled water to 51.86 g of silver nitrate to dilute to 317.5 ml and a solution D formed by diluting 44.2 g of potassium bromide and 2.2 g of potassium iodide with distilled water to 400 ml volume were added in which the solution C was added entirely at a constant flow rate for 20 min, while the solution D was added by a controlled double jet method while keeping pAg at 8.1. Potassium hexachloroiridate (III) was added entirely so as to be 1×10⁻⁴ mol per one mol of silver 10 min after starting addition of the solution C and the solution D. Further, an aqueous solution of potassium iron (II) hexacyanide was added entirely so as to be 3×10⁻⁴ mol per one mol of silver 5 see after the completion of addition of the solution C. pH was adjusted to 3.8 by using sulfuric acid at 0.5 mol/L concentration, stirring was stopped and a precipitation/desalting/water washing step was conducted. pH was adjusted to 5.9 by using sodium hydroxide at 1 mol/L concentration to prepare a silver halide dispersion at pAg of 8.0.

The silver halide dispersion was kept at 38° C. while stirring, to which 5 ml of a methanol solution containing 0.34 mass % of 1,2-benzoisothiazolin-3-one was added and, after 40 min, a methanol solution of spectral sensitizer A′ and sensitizer B′ at a 1:1 molar ratio was added by 1.2×10⁻³ mol as a total for the sensitizers A′ and B′ per 1 mol of silver and the temperature was elevated to 47° C. after one min. 20 min after the temperature elevation, a methanol solution of sodium benzenethiosulfonate was added by 7.6×10⁻⁵ mol per one mol of silver and, further five min after, a methanol solution of tellurium sensitizer was added by 2.9×10⁻⁴ mol per one mol of silver and aged for 91 min. 1.3 ml of a methanol solution of 0.8 mass % N,N′-dihydroxy-N″-diethyl melamine was added and, further 4 min after, a methanol solution of 5-methyl-2-mercaptobenzimidazole was added by 4.8×10⁻³ mol per 1 mol of silver, and a methanol solution of 1-phenyl-2-heptyl-5-mercapto-1,3,4-triazole was added by 5.4×10⁻³ mol per 1 mol of silver to prepare a silver halide emulsion 6e.

Particles in the silver halide emulsion that could be prepared were silver iodobromide particles homogeneously containing 3.5 ml of iodine an average sphere-equivalent diameter of 0.042 μm, and with 20% variation coefficient for the sphere-equivalent diameter. The particle size and the like were determined as an average for 1000 particles by using an electron microscope. The (100) face ratio of the particles was determined as 80% by using a Kubelka-Munk method.

Preparation of Photothermographic Material 6e

Photothermographic material 6e was prepared by the same method as in Example 31 except for changing the silver halide emulsion 1e to the silver halide emulsions 6e in the preparation of the photothermographic material 1e in Example 31.

Evaluation for Photographic Performance

Exposure and developing treatment were conducted to the photothermographic materials prepared in Examples 31 and 32 and Comparative Example 2 by using a modified Fuji Medical Dry Laser Imager FM-DPL.

In exposure, the photothermographic materials were irradiated while restricting a semiconductor laser at 660 nm with maximum 60 mW (111B) power mounted on FM-DPL to 100 μm×100 μm. Exposure was conducted while changing the exposure amount of the laser stepwise.

Development was conducted by using a thermal developing station of FM-DPL while setting the temperature for four sheets of panel heaters to 112° C.-119° C.-121° C.-121° C. The developing time was set to 24 sec. For the evaluation of images obtained after exposure and development, density was measured by a Macbeth densitometer to prepare a characteristic curve of the density relative to the exposure amount.

In the samples after the developing treatment, the density for a portion not exposed to the laser was defined as Dmin, while the density for a portion exposed to the maximum exposure amount was defined as Dmax. Further, the reciprocal to the exposure amount providing a density of Dmin+1.0 was defined as the sensitivity, which was expressed by a relative value to a photothermographic material as the reference (reference sensitive material).

[Evaluation for the Development Progressiveness]

Then, developing treatment was conducted such that the developing time was 16 sec by changing the conveying speed of a thermal developing machine (thermal developing station in FM-DPL) to prepare a characteristic curve in the same manner as the evaluation for the photographic performance described above. As in the case of development for 24 sec, a reciprocal to the exposure amount required for obtaining a sensitivity of Dmin+1.0 was defined as the sensitivity. The value calculated in accordance with the following equation was evaluated as the development progressiveness based on the sensitivity in development for 24 sec and development for 16 sec.

Development Progressiveness=Log (sensitivity to 24 sec development/sensitivity to 16 sec development)

Since a larger value for the development progressiveness means that the developability is slow and not stable to the change of the processing time, a smaller value for the development progressiveness is preferred.

(Evaluation for Print Out Performance)

A sample after the treatment was placed in an environment as 30° C., 70% RH and left for three days under fluorescent lamps with luminosity of 1000 lux. Increase in the density for the fogging portion relative to that before the treatment was defined as the print out performance.

The photothermographic materials 1e-6e were evaluated for the photographic performance, the development progressiveness and the print out performance. The results are shown in Table 19.

TABLE 19

| | | | | Silver | | | | | | |
|---|---|---|---|---|---|---|---|---|---|---|
| | | | | Halide | | | | | | |
| | | | | Coating | | | | | | |
| | Silver halide emulsion | | | Amount | | | | | | |
| | | Silver | | (based on | | | | | | |
| Photothermographic | | Iodide | | mol % of | | | | | | |
| Material | | Average | Grain | Organic | | | Relative | Development | Print- | |
| Sample No. | Emulsion No. | Content | Size | Acid | Dₘᵢₙ | Dₘₐₓ | Sensitivity | Progressiveness | out | Remarks |
| 1e | Emulsion 1e | 44 mol % | 40 nm | 7% | 0.18 | 4.0 | 150 | 0.12 | 0.09 | Present |
| | | | | | | | | | | Invention |
| 2e | Emulsion 2e | 58 mol % | 41 nm | 7% | 0.19 | 4.2 | 131 | 0.10 | 0.05 | Present |
| | | | | | | | | | | Invention |
| 3e | Emulsion 3e | 72 mol % | 39 nm | 7% | 0.19 | 4.2 | 124 | 0.07 | 0.05 | Present |
| | | | | | | | | | | Invention |
| 4e | Emulsion 4e | 86 mol % | 42 nm | 7% | 0.20 | 4.1 | 120 | 0.14 | 0.02 | Present |
| | | | | | | | | | | Invention |
| 5e | Emulsion 5e | 100 mol % | 40 nm | 7% | 0.19 | 4.3 | 110 | 0.12 | 0.00 | Present |
| | | | | | | | | | | Invention |
| 6e | Emulsion 6e | 3.5 mol % | 42 nm | 7% | 0.34 | 3.8 | 100 | 0.08 | 0.66 | Comparative |
| | | | | | | | | | | Example |

As apparent from the results in Table 1, it can be seen that the photothermographic materials according to this invention have high sensitivity, excellent print out performance, low Dmin and high Dmax.

### Example 33

<Preparation of Silver Halide Emulsions 7e-10e>

Silver halide emulsions 7e-10e were prepared in the same manner as in the preparation of the silver halide emulsion 4e except for changing the grain size as described in Table 20 by changing the temperature upon formation of particles of the silver halide emulsion in <preparation of Silver Halide Emulsion 4e>.

Preparation and Evaluation of Photothermographic Materials 7e-12e

Photothermographic materials 7e-12e described in Table 20 were prepared by the same method as in Example 31 except for using the silver halide emulsions 7e-10e and changing the coating amount of the silver halide.

Then, evaluation was made on the obtained photothermographic materials 7e-12e in the same manner as in Examples 31, 32 and Comparative Example 2. The following Table 20 shows the results.

TABLE 20

| | | | | Silver | | | | | | |
|---|---|---|---|---|---|---|---|---|---|---|
| | | | | Halide | | | | | | |
| | | | | Coating | | | | | | |
| | Silver Halide Emulsion | | | Amount | | | | | | |
| | | Silver | | (based on | | | | | | |
| Photothermographic | | Iodide | | Organic | | | | | | |
| Material | | Average | Grain | Acid | | | Relative | Development | Print- | |
| Sample No. | Emulsion No. | Content | Size | (mol %)) | Dₘᵢₙ | Dₘₐₓ | Sensitivity | Progressiveness | out | Remarks |
| 7e | Emulsion 7e | 86 mol % | 34 nm | 7% | 0.18 | 4.3 | 120 | 0.14 | 0.01 | Present |
| | | | | | | | | | | Invention |
| 8e | Emulsion 8e | 86 mol % | 55 nm | 7% | 0.18 | 4 | 140 | 0.11 | 0.01 | Present |
| | | | | | | | | | | Invention |
| 9e | Emulsion 9e | 86 mol % | 90 nm | 7% | 0.18 | 3.3 | 165 | 0.10 | 0.05 | Present |
| | | | | | | | | | | Invention |
| 10e | Emulsion 10e | 86 mol % | 120 nm | 7% | 0.20 | 2.6 | 220 | 0.08 | 0.09 | Present |
| | | | | | | | | | | Invention |
| 11e | Emulsion 4e | 86 mol % | 42 nm | 15% | 0.19 | 4.3 | 105 | 0.41 | 0.04 | Present |
| | | | | | | | | | | Invention |
| 12e | Emulsion 4e | 86 mol % | 42 nm | 9% | 0.18 | 4.1 | 118 | 0.20 | 0.03 | Present |
| | | | | | | | | | | Invention |

From the results in Table 20, it has been confirmed that each of the performances is further preferred in the photothermographic materials in the forty-fifth embodiment according to this invention when the grain size of the high silver iodide emulsion is 90 nm or less.

Further, it has been confirmed that each of the performances is further preferred in the photothermographic materials of the forty-fifth embodiment according to this invention when the coating amount of the high silver iodide emulsion is 9 mol % or less based on one mol of the non-light sensitive silver organic salt.

### Example 34

Preparation and Evaluation of Photothermographic Material 13e

A photothermographic material 13e according to this invention was prepared by the same method as for the photothermographic material 1e in Example 33 except for changing the silver halide emulsion 7e to a 8:2 mixture of silver halide emulsions 7e and 9e in the preparation of the photothermographic material 7e in Example 33. When evaluation was made in the same manner as in Examples 31-32, preferred results were obtained for each of the performances.

### Example 35

<Preparation of Reducing Agent-5e Dispersion>

6 kg of water was added to 10 kg of a reducing agent-5e (2,2′-methylene-bis(4-methyl-6-tart-butyl phenol)), and 20 kg of an aqueous 10 mass % solution of modified polyvinyl alcohol) Poval MP203 manufactured by Kuraray Co.) and stirred thoroughly to form a slurry. After supplying the slurry by a diaphragm pump and dispersing the same for 3 hours and 30 min in a lateral type sand mill (UVM-2: IMEX Co.) filled with zirconia beads having an average diameter of 0.5 mm, 0.2 g of sodium benzoisothiazolinone and water were added to adjust the concentration of the reducing agent to 25 mass % to obtain a reducing agent-5e dispersion product.

The reducing agent particles contained in the thus obtained reducing agent dispersion had 0.38 μm of a median diameter and 15 μm or less of a maximum grain size. The obtained reducing agent dispersion was filtered by using a polypropylene filter with a pore size of 3.0 μm to remove obstacles such as dusts and then stored.

<Preparation of Hydrogen Coupling Compound-2e Dispersion>

10 kg of water was added to 10 kg of a hydrogen coupling compound-2e (tri(4-t-butylphenyl)phosphine oxide), and 20 kg of an aqueous 10 mass % solution of modified polyvinyl alcohol (Poval MP203, manufactured by Kuraray Co.) and thoroughly stirred to form a slurry. After supplying the slurry by a diaphragm pump and dispersing the same for 3 hours and 30 min in a lateral type sand mill (UVM-2: IMEX Co.) filled with zirconia beads having an average diameter of 0.5 mm, 0.2 g of sodium benzoisothiazolinone and water were added to adjust the concentration of the reducing agent to 22 mass % to obtain a hydrogen coupling compound-2e dispersion product.

The reducing agent particles contained in the thus obtained reducing agent dispersion had 0.35 μm of a median diameter and 1.5 μm or less of a maximum grain size. The obtained hydrogen coupling compound dispersion was filtered by using a polypropylene filter with a pore size of 3.0 μm to remove obstacles such as dusts and then stored.

<Preparation and Evaluation of Photothermographic Material 14e>

A photothermographic material 14e according to this invention was prepared by the same method as the photothermographic material 3e in Example 32 except for changing the reducing agent complex-3e dispersion to the reducing agent-5e dispersion and, further, using the hydrogen coupling compound-2e, 3e dispersion in the preparation of the photothermographic material 3e in Example 32.

The coating amount for each of the compounds of the emulsion layer (g/m²) is as shown below.

| | |
|---|---|
| Silver behenate | 6.65 |
| Reducing agent 5e | 0.76 |
| Hydrogen coupling compound 2e | 0.59 |
| Dye (C.I. Pigment Blue 60) | 0.032 |
| Polyhalogen compound-2e | 0.02 |
| Polyhalogen compound-3e | 0.06 |
| phthalazine compound-1e | 0.21 |
| SBR latex | 11.1 |
| Mercapto compound-1e | 0.002 |
| Silver halide (As Ag) | 0.10 |

When the obtained photothermographic material 14e was evaluated in the same manner as in Examples 31 and 32, preferred results were obtained for each of the performances.

### Example 36

Preparation of Photothermographic Material 15e

A photothermographic material 15e was prepared by the same method as the photothermographic material 14e in Example 35 except for changing the reducing agent complex-5e dispersion to the reducing agent (R″-2) dispersion in the preparation of the photothermographic material 14e in Example 35.

When the development processing was conducted for the obtained photothermographic material 15e in the thermal developing time of 14 sec by changing the conveying speed of the thermal developing machine, it has been confirmed that preferred sensitivity and gradation are obtained.

Chemical structures of compounds used in Examples 31-36 of the forty-fifth embodiment according to the present invention are shown below.

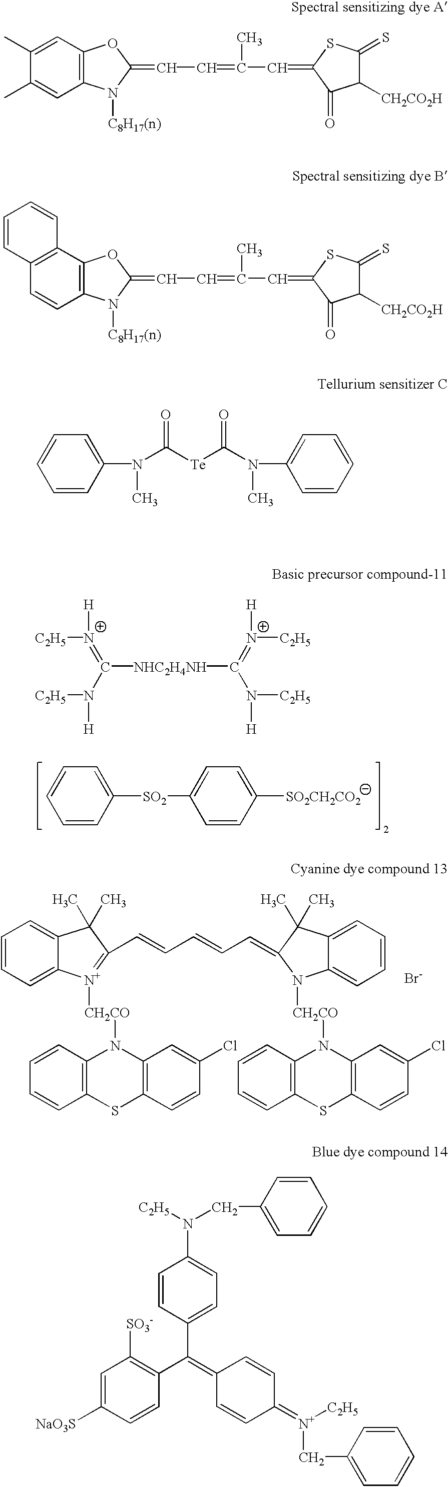

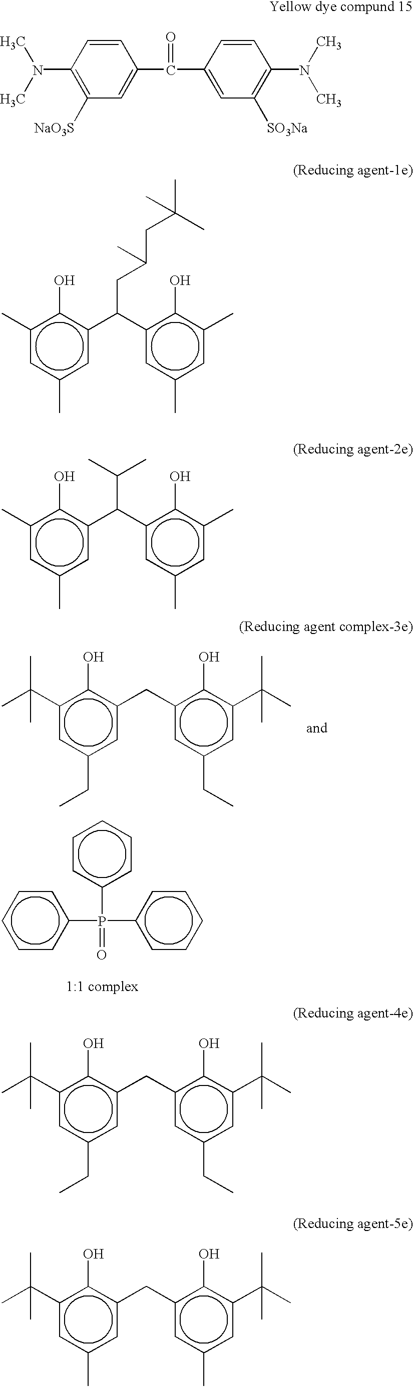

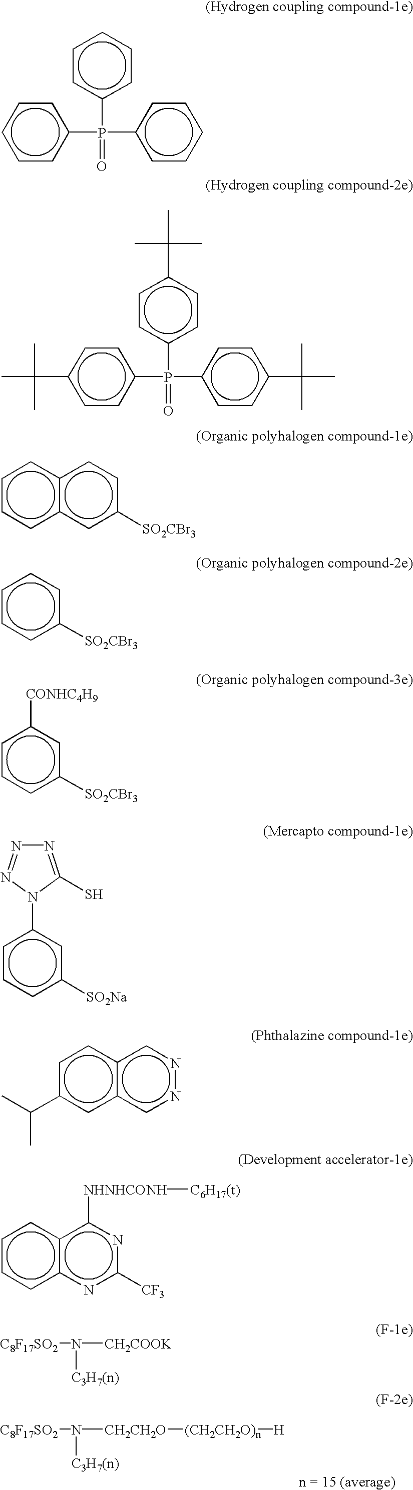

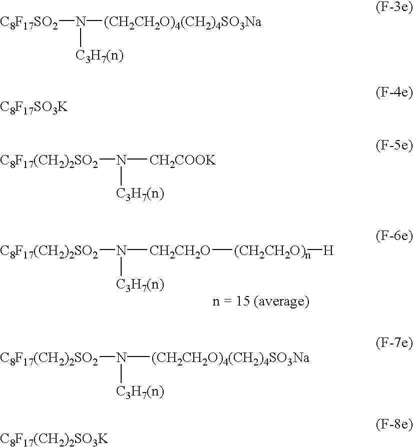

The forty-fifth embodiment of the present invention can provide a silver halide photothermographic material having high sensitivity, low Dmin and high Dmax, showing rapid progressiveness of development, stable to the change of the developing time, excellent in the print out performance and also excellent in the image storability after the developing treatment.

What is claimed is:

1. A photothermographic material comprising a support having thereon a layer including at least a non-photosensitive organic silver salt, a photosensitive silver halide, a reducing agent and a binder;
wherein the photosensitive silver halide has a mean silver iodide content of 5 to 100 mol %
and further comprising at least one compound of the following general formula (I):
(X)ₖ—(L)ₘ—(A—B)ₙ General formula (I)
wherein X represents a silver halide-adsorbing group or a light-absorbing group that has at least one atom each of N, S, P, Se and Te; L represents a (k+n)-valent linking group having at least one atom each of C, N, S and O; A represents an electron-donating group; B represents a leaving group or a hydrogen group; A—B is oxidized and then cleaved or deprotonated to generate a radical A; k represents an integer from 0 to 3; m represents 0 or 1; n represents 1 or 2; and when k=0 and n=1, then m=0.

2. The photothermographic material according to claim 1, wherein the mean silver iodide content of the silver halide is 10 to 100 mol %.

3. The photothermographic material according to claim 1, wherein the mean silver iodide content of the silver halide is 40 to 100 mol %.

4. The photothermographic material according to claim 1, wherein the photosensitive silver halide comprises a mean grain size of 5 to 80 nm.

5. The photothermographic material according to claim 1, wherein the mean grain size of the silver halide is 5 to 70 nm.

6. The photothermographic material according to claim 1, wherein the silver halide grains have a direct transition absorption derived from the high silver iodide crystal structure therein.

7. A method of thermal development of a photothermographic material, which comprises a support having thereon a layer including at least a non-photosensitive organic silver salt, a photosensitive silver halide, a reducing agent and a binder; wherein the photosensitive silver halide has a mean silver iodide content of 5 to 100 mol %, and which further comprises at least one compound of the following general formula (I),
wherein the highest temperature at thermal development of the photothermographic material is 100 to 120° C.
(X)ₖ—(L)ₘ—(A—B)ₙ General formula (I)
wherein X represents a silver halide-adsorbing group or a light-absorbing group that has at least one atom each of N, S, P, Se and Te; L represents a (k+n)-valent linking group having at least one atom each of C, N, S and O; A represents an electron-donating group; B represents a leaving group or a hydrogen group; A—B is oxidized and then cleaved or deprotonated to generate a radical A; k represents an integer from 0 to 3; m represents 0 or 1; n represents 1 or 2; and when k=0 and n=1, then m=0;

8. The method of thermal development of the photothermographic material according to claim 7, wherein the highest temperature when thermally developing the photothermographic material is 105 to 115° C.

9. The method of thermal development of the photothermographic material according to claim 7, wherein the photothermographic material is thermally developed by being conveyed through a thermal development zone that comprises from 2 to 6 plate heaters for thermal development and by being kept in contact with the plate heaters in that zone.

10. The method of thermal development of the photothermographic material according to claim 7, wherein the mean grain size of the silver halide is 5 to 80 nm.

11. The method of thermal development of the photothermographic material according to claim 7, wherein the mean grain size of the silver halide is 5 to 70 nm.

12. A photothermographic material comprising a support having thereon a photosensitive silver halide, a non-photosensitive organic silver salt, a thermal-developing agent and a binder;
wherein the photosensitive silver halide has a silver iodide content of 40 to 100 mol % and includes a metal selected from the elements of Groups 3 to 10 of the Periodic Table.

13. The photothermographic material according to claim 12, wherein the metal is selected from the group consisting of iron, nickel, cobalt, ruthenium, rhodium, rhenium, osmium, iridium, palladium, platinum, gold, silver, copper and zinc.

14. The photothermographic material according to claim 12, wherein the metal comprises a metal complex.

15. The photothermographic material according to claim 14, wherein the metal complex is a quadridentate metal complex having 4 ligands.

16. The photothermographic material according to claim 14, wherein the metal complex is a quadridentate metal complex with a metal selected from the group consisting of iron, nickel, cobalt, ruthenium, rhodium, rhenium, osmium, iridium, palladium, platinum, gold, silver, copper and zinc.

17. The photothermographic material according to claim 12, wherein the iodide content of the photosensitive silver halide is 90 to 100 mol %.

18. A photothermographic material comprising a support having thereon an image-forming layer including at least a non-photosensitive organic silver salt, a photosensitive silver halide, a reducing agent and a binder;
and further comprising a compound having a silver halide-adsorbing group and a reducing group or a precursor thereof.

19. The photothermographic material according to claim 18, wherein the compound having a silver halide-adsorbing group and a reducing group is represented by the following general formula (I″):
A—(W)n—B General formula (I″)
wherein A represents an atomic group that contains a silver halide-adsorbing group; W represents a divalent linking group; n indicates 0 or 1; and B represents a reducing group.

20. The photothermographic material according to claim 19, wherein the adsorbing group in general formula (I″) is selected from the group consisting of a mercapto group, a thione group and an imino silver forming group.

21. The photothermographic material according to claim 19, wherein the reducing group in general formula (I″) is selected from the group consisting of a formyl group, an amino group, an acetylene group, a propargyl group, an alkylmercapto group and an arylmercapto group.

22. The photothermographic material according to claim 19, wherein the reducing group in general formula (I″) is any one selected from the following groups represented by (B₁) to (B₃): 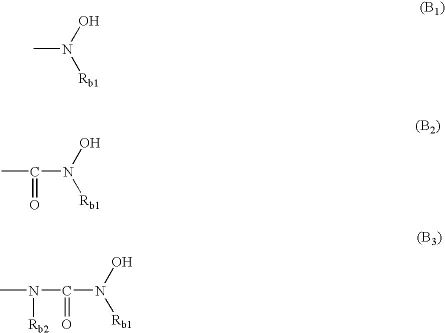
wherein R_{b1} and R_{b2} each independently represent a hydrogen atom, an alkyl group, an alkenyl group, an alkynyl group, an aryl group or a heterocyclic group.

23. The photothermographic material according to claim 19, wherein the reducing group in general formula (I″) is derived from any one of reductones, phenols, naphthols, phenylenediamines, and 1-phenyl-3-pyrazolidones.

24. The photothermographic material according to claim 18, wherein the precursor comprises a compound that generates a mercapto group.

25. The photothermographic material according to claim 18, wherein the precursor is selected from the group consisting of thiazoliums, thiazolines, thiazolidines and disulfides.

26. The photothermographic material according to claim 18, wherein the silver halide emulsion is chemically sensitized through at least any one of chalcogen sensitization, gold sensitization and reduction sensitization.

27. The photothermographic material according to claim 26, wherein the silver halide is chemically sensitized at pAg of not more than 7.

28. The photothermographic material according to claim 26, wherein the chalcogen sensitization is at least one selected from the group consisting of tellurium sensitization, selenium sensitization and sulfur sensitization.

29. The photothermographic material according to claim 18, wherein the silver iodide content of the silver halide photographic emulsion is 80 mol % to 100 mol %.

30. The photothermographic material according to claim 18, wherein the silver iodide content of the silver halide photographic emulsion is 90 mol % to 100 mol %.

31. The photothermographic material according to claim 18, wherein the silver halide grains have an epitaxially-formed part, and the part includes any of silver bromide and silver chloride.

32. The photothermographic material according to claim 18, wherein the silver halide grains have any one of dislocation lines and lattice defects.

33. The photothermographic material according to claim 18, wherein the grain size of the silver halide grains is 5 nm to 0.1 μm.

34. The photothermographic material according to claim 18, wherein the grain size of the silver halide grains is 5 nm to 0.055 μm.

35. The photothermographic material according to claim 18, wherein the photothermographic material is exposed to laser rays.

36. A photothermographic material comprising a support having thereon at least one image-forming layer including at least a non-photosensitive organic silver salt, a photosensitive silver halide, a reducing agent and a binder;
and further comprising at least one non-image-recording protective layer on the far side of the support relative to the image-forming layer;
wherein the silver halide comprises a silver iodide content of 5 mol % to 100 mol % and is chemically sensitized through at least any one of gold sensitization, chalcogen sensitization and reduction sensitization.

37. The photothermographic material according to claim 36, wherein the silver iodide content of the photosensitive silver halide is 40 mol % to 100 mol %.

38. The photothermographic material according to claim 36, wherein the silver iodide content of the photosensitive silver halide is 90 mol % to 100 mol %.

39. The photothermographic material according to claim 36, wherein the grain size of the photosensitive silver halide is 5 nm to 90 nm.

40. The photothermographic material according to claim 36, wherein the coating amount of the photosensitive silver halide is at most 10 mol % relative to one mol of the non-photosensitive organic silver salt therein.

41. The photothermographic material according to claim 36, wherein the photosensitive silver halide grains are formed and chemically sensitized in the absence of the organic silver salt.

42. The photothermographic material according to claim 36, for which the peak wavelength of the laser rays is 600 nm to 900 nm.

43. The photothermographic material according to claim 36, for which the peak wavelength of the laser rays is 300 nm to 500 nm.

44. A photothermographic material comprising a support having thereon at least a photosensitive silver halide, a non-photosensitive organic silver salt, a reducing agent and a binder;
wherein the mean silver iodide content of the photosensitive silver halide is 5 mol % to 100 mol %,
wherein the non-photosensitive organic silver salt is prepared from an organic acid including at least behenic acid and erucic acid,
and the erucic acid content of the non-photosensitive organic silver salt is 1×10⁻⁶ mol % to 10 mol % relative to the number of mols of the whole organic acid.

45. A photothermographic material comprising a support having thereon at least one image-forming layer including at least one organic silver salt and at least one silver halide, and having thereon at least one non-image-recording protective layer on the far side of the support relative to the image-forming layer, which is exposed to laser rays;
wherein the mean silver iodide content of the silver halide is 40 mol % to 100 mol %.

46. The photothermographic material according to claim 45, wherein the grain size of the silver halide is 5 nm to 90 nm.

47. The photothermographic material according to claim 45, wherein the silver halide grains have a core/shell structure, the silver iodide content of the shell is higher than that of the core, and the silver iodide content of the shell is 80 mol % to 100 mol %.

48. The photothermographic material according to claim 45, wherein the silver halide grains are formed and chemically sensitized in the absence of the organic silver salt.

49. The photothermographic material according to claim 45, wherein the coating amount of the silver halide in the image-forming layer is 0.5 mol % to 12 mol % relative to the organic silver salt therein.

50. The photothermographic material according to claim 45, for which the peak wavelength of the laser rays is 600 nm to 900 nm.

51. The photothermographic material according to claim 45, for which the peak wavelength of the laser rays is 300 nm to 500 nm.

52. The photothermographic material according to claim 45, wherein the image-forming layer is formed by applying a coating liquid onto the support,
and the coating liquid for the image-forming layer includes at least 30% by weight of water and a polymer dispersed to be latex therein.

53. A photothermographic material according to claim 12, wherein the support further having thereon an organic polyhalogen compound.

54. A photothermographic material according to claim 18, wherein the silver iodide content of the silver halide is 40 mol % to 100 mol %.

55. A photothermographic material according to claim 36, wherein the support further having thereon an organic polyhalogen compound.
